(19) United States
(12) Patent Application Publication
(10) Pub. No.: US 2024/0375959 A1
(43) Pub. Date: Nov. 14, 2024

(54) SCALABLE SYNTHESIS OF PERIMORPHIC MATERIALS

(71) Applicant: Dickinson Corporation, Novato, CA (US)

(72) Inventors: Matthew Bishop, Novato, CA (US); Abhay Thomas, Mill Valley, CA (US)

(73) Assignee: Dickinson Corporation, Novato, CA (US)

(21) Appl. No.: 18/613,221

(22) Filed: Mar. 22, 2024

Related U.S. Application Data
(63) Continuation of application No. 18/129,282, filed on Mar. 31, 2023.
Application No. 18/129,282 is a continuation of application No. PCT/US2021/053316, filed on Oct. 4, 2021.
(60) Provisional application No. 63/086,760, filed on Oct. 2, 2020.

(51) Int. Cl. C01B 32/184; C01B 32/05

(52) U.S. Cl. CPC C01B 32/184; C01B 32/05; C01P 2006/12

(57) ABSTRACT

The present disclosure is directed to the scalable synthesis of novel perimorphic materials, including stratified perimorphic frameworks, on recyclable templates, and using recyclable process liquids. Using these methods, three-dimensional architectures constructed from two-dimensional molecular structures can be produced economically and with reduced waste.

### CROSS-REFERENCE TO RELATED APPLICATIONS

This application is a continuation of U.S. patent application Ser. No. 18/129,282 filed on Mar. 31, 2023, which is a bypass continuation of PCT/US2021/053316 filed Oct. 4, 2021, which claims priority to U.S. Provisional Patent Application No. 63/086,760 filed Oct. 2, 2020 entitled “SCALABLE SYNTHESIS OF PERIMORPHIC MATERIALS.” The following applications are hereby incorporated by reference in their entirety for all purposes: PCT/US21/49195 (the '49195 Application); U.S. Provisional Patent Application 63/075,918 (the '918 Application); U.S. Provisional Patent No. 63/086,760 (the '760 Application); U.S. Provisional Patent Application 63/121,308 (the '308 Application); U.S. Utility application Ser. No. 16/758,580 (the '580 Application); U.S. Utility application Ser. No. 16/493,473 (the '473 Application); PCT/US17/17537 (the '17537 Application); PCT/US21/37435 (the '37435 Application); U.S. Provisional Patent Application 63/129,154 (the '154 Application) and U.S. Pat. No. 10,717,843 B2 (the '843B2 Patent).

### FIELD OF DISCLOSURE

This disclosure relates to a method for the scalable production of diverse perimorphic materials, including stratified perimorphic materials comprising two or more perimorphic strata. More particularly, this disclosure relates to a low-cost, waste-reducing method for producing novel perimorphic materials wherein process materials may be recycled.

### BACKGROUND

Compared to bulk materials, nanostructured materials may possess superior properties. Three-dimensional, ordered architectures constructed from nanostructured building blocks may facilitate the realization of these superior properties in bulk forms of the materials. These “architected” materials may be produced by synthesizing and arranging nanoscopic or microscopic building blocks into fine assemblies. In particular, porous materials with architected pore structures are appealing due to their low density, high specific surface area, and potential mechanical properties.

The '49195 Application teaches a scalable method (the “General Method”) of synthesizing carbon perimorphic frameworks using surface replication, or conformal replication of a templating surface, to direct the formation of the perimorphic architecture. By engineering the template materials, carbon frameworks possessing a variety of rationally engineered substructural and superstructural features have been synthesized. In some variants of the General Method, such as the “Preferred Method” taught in the '49195 Application, the template materials employed comprise magnesium oxide (MgO) templates derived from magnesium carbonate (MgCO3·xH₂O) template precursor materials.

While the applications for carbonaceous perimorphic frameworks are numerous, it would be desirable to develop other perimorphic materials via template-directed surface replication procedures similar to those described in the '49195 Application. In particular, it would be desirable to synthesize perimorphic frameworks constructed from a range of materials that are stable in atomic monolayer or few-layer configurations. Examples of potentially useful framework compositions include sp²-hybridized boron nitride (BN), borophene (B), silicene (Si), boron carbonitride (BCₓN), and various other ceramic compounds. In particular, it would be desirable to generate perimorphic frameworks comprising either electrically insulating or semiconducting elements or compounds, and likewise to generate these elements of compounds with the rational, architected morphologies that can be achieved via surface replication.

It would also be desirable to create three-dimensional frameworks comprising heterogeneous chemical compositions. In this way, different phases of the framework could fulfill different functions. As an example, carbonaceous frameworks might be shielded from thermal oxidation by sandwiching them between or encapsulating them within non-carbonaceous ceramic strata. As another example, carbonaceous frameworks might be coated by and serve as a functional support for a catalytic stratum. In particular, a perimorphic wall comprising multiple, distinct perimorphic strata would be desirable. Myriad useful heterostructured compositions have been identified in the graphene and graphene oxide literature, and it would be useful to be able to generate perimorphic frameworks from these diverse compositions, as well as new stratigraphically organized compositions that might be readily envisioned.

Additionally, it would be desirable to produce perimorphic materials, including perimorphic frameworks, using an approach that recycled both the template and the process liquids. Additionally, in certain variants, it would be desirable to recycle process gases. As described in the '49195 Application, conserving and reusing process materials can reduce the material inputs and outputs required for producing perimorphic materials, reducing cost and waste. If the General Method or the Preferred Method could be more generally employed to produce perimorphic materials that were not exclusively carbonaceous in composition, this would make the manufacture of these novel perimorphic materials more scalable and efficient.

### SUMMARY

The present disclosure demonstrates a method for synthesizing novel perimorphic materials of a number of chemical composition using surface replication techniques. The exemplary surface replication techniques demonstrated herein may be incorporated in the General Method. Therefore, these surface replication techniques expand the applicability of the General Method to include the scalable production of perimorphic frameworks of diverse chemical compositions. These novel perimorphic materials may be synthesized directly on MgO templates, or onto other perimorphic materials synthesized on MgO templates, and may be synthesized using the Preferred Method.

The present disclosure also demonstrates a method for synthesizing two-dimensional materials or arbitrary chemical composition directly on non-metallic templates, porous templates, and recyclable templates. In particular, a method is disclosed for synthesizing two-dimensional materials directly on thermally stable metal oxide compounds such as MgO, making it possible to engineer these two-dimensional materials in a variety of three-dimensional architectures. To demonstrate this, sp²-hybridized BN and BCₓN perimorphic frameworks are synthesized via template-directed CVD on porous MgO templates. Analysis presented herein shows that these perimorphic frameworks comprises crosslinked, layered networks similar to the synthetic anthracitic carbon networks described in the '37435 Application. Other methods of deposition, including physical vapor deposition, and other gases may be used to deposit other two-dimensional materials on these highly stable, versatile templates. These other materials include monoelemental Xenes (such as borophene, silicene, germanene, stanene, phospherene, arsenene, antimonene, bismuthene, and tellurene) and compounds (such as various transition metal dischalcogenides), as well as doped variants.

The present disclosure also demonstrates a method for encapsulating a perimorphic framework by forming a gas-impermeable barrier phase around it. This barrier may be utilized to shield the encapsulated perimorphic framework from an external reactant, such as O₂, or to seal the framework in a gas-evacuated internal state.

The present disclosure also demonstrates examples of novel perimorphic materials constructed from two-dimensional molecular structures such as sp²-hybridized BN and BCₓN. These two-dimensional materials can therefore be fabricated into the same engineerable perimorphic architectures that have previously been demonstrated with graphenic carbon, including perimorphic architectures with controllably compact, ordered substructures and elongated, thin, equiaxed, hierarchical and hollow superstructures. Similar to the controllably flexible perimorphic frameworks that may be generated from graphenic carbon, controllably flexible perimorphic frameworks may also be generated from these other two-dimensional materials.

This disclosure also demonstrates examples of novel perimorphic materials constructed from two or more distinct perimorphic strata in order to obtain new functionality. These strata may comprise materials arranged in atomic monolayers, like graphenic carbon or sp²-hybridized BN, or materials with three-dimensional bonding structures, like silica or sp³-hybridized BN. The combination of carbon with other strata may also provide enhanced functionality. In particular, a practical example of shielding a graphenic perimorphic stratum from thermal oxidation via the addition of one or more thermally inert perimorphic strata is demonstrated in this disclosure. A supporting graphenic stratum may also be usefully combined with a catalytic stratum, such as a metallic or metal oxide adsorbate, to provide a high surface area catalyst, or to prevent charge carrier recombination (as in graphenic/TiO₂ composites). Numerous applications for stratified perimorphic frameworks, which are analogous to three-dimensional architectures of two-dimensional/van der Waals heterostructures, will be readily apparent to those skilled in that art.

This disclosure also demonstrates examples of novel perimorphic materials that are either electrically insulating or semiconducting. Examples of electrically insulating perimorphic materials include silica-like and sp²-hybridized BN perimorphic frameworks. An example of a semiconducting perimorphic material is BCₓN perimorphic frameworks, in which bandgaps can be varied by varying the carbon content.

This disclosure, in general, demonstrates examples of ceramics that are much lighter and varied in mechanical properties than their conventional bulk counterparts. In particular, these ceramics may be engineered to be flexible, and even crumpled or collapsed reversibly, like the carbon perimorphic frameworks that have previously been demonstrated. A wide range of ceramic alloys may be designed by performing thermal treatments of preceramics.

It is an object of this disclosure to render the previously disclosed General Method and Preferred Method more versatile. The ability to manufacture perimorphic materials with a variety of chemistries, while also conserving and reusing process materials, renders these methods and their variants more powerful and more broadly applicable. For example, there are a variety of mesoporous silicas made via sol-gel procedures using cetyl-trimethylammonium bromide (CTAB), n-dodecyl-trimethylammonium bromide (DTAB), or other consumable template materials; the present disclosure offers an alternative pathway that allows mesoporous silica-like materials to be made using recyclable template materials and process liquids. In particular, it is an object of this disclosure to provide a scalable means of creating three-dimensional, controllably compact architectures that are either noncarbonaceous or comprise multiple phases with distinct chemistries.

It is another object of this disclosure to demonstrate how a variety of elements and compounds, as well as stratified heterostructures of these elements and compounds, can be synthesized with templated, porous morphologies that have hitherto only been demonstrated for carbons. This includes mesoporous and macroporous substructures with engineerable cellular subunit geometries, as well as a variety of superstructural geometries. In particular, microscopic superstructures with elongated, flat, equiaxed, or hierarchical geometries can be synthesized.

It is another object of this disclosure to demonstrate how flexible perimorphic frameworks can be constructed from noncarbonaceous, two-dimensional materials. This is achieved via rational design of the superstructure and compactness of the perimorphic frameworks, as well as the thickness of the perimorphic walls.

It is another object of this disclosure to demonstrate how graphenic perimorphic frameworks can be modified by addition of other perimorphic strata. This may take the form of an overall encapsulation of the graphenic perimorphic framework, at the superstructural level, or a finer encapsulation of the perimorphic wall at the substructural level. These modifications can be utilized to shield graphenic carbons from thermal oxidation, enabling them to resist burning in high-temperature oxidizing environments, such as those that would be encountered in the presence or proximity of flames or at high velocities in the atmosphere.

It is another object of this disclosure to demonstrate how conventional and advanced ceramics, including ceramic alloys and composites, can be synthesized with engineered mesoporous or macroporous substructures and a variety of superstructural geometries. This may useful for applications that benefit from weight reduction, rapid mass transfer, high surface area, or increased toughness, as these properties may all be achievable via engineered porosity.

### BRIEF DESCRIPTION OF FIGURES

FIG. 1A is an illustration of a stratified perimorphic framework comprising an AB stratigraphic arrangement. FIG. 1B is an illustration of a stratified perimorphic framework comprising a BAB stratigraphic arrangement, wherein the A stratum is stratigraphically occluded. FIG. 1C is an illustration of a stratified perimorphic framework comprising an AB stratigraphic arrangement, wherein the B stratum stratigraphically encapsulates the framework.

FIG. 2 illustrates how pre-extraction replication and post-extraction replication can be utilized to synthesize a stratified perimorphic framework.

FIG. 3 is an illustration of the General Method. The Template Cycle and Liquid Cycle are labeled.

FIG. 4 is an illustration of the General Method with a Gas Cycle. A process gas is utilized to generate the extractant in the Separation Stage and is recaptured during the Precursor Stage and/or Template Stage.

FIG. 5 is an illustration of the Preferred Method. In the Preferred Method, the stock solution comprises Mg(HCO₃)₂ solution, the template precursor comprises magnesium carbonate, the template comprises MgO, and the perimorphic material is carbonaceous.

FIG. 6 is an illustration of an AEAPTMS ((3-(2-aminoethylamino)propyl)trimethoxysilane) functionalized carbon surface.

FIG. 7A is a photograph of a P₂₄-type stratified perimorphic material wherein the frameworks comprise a graphenic stratum and an SiOₓC_{y} stratum. FIG. 7B is a photograph of a P₂₅-type silica-like perimorphic material.

FIG. 8A is an SEM micrograph of P₂₅-type silica-like perimorphic frameworks. These frameworks are derived from creating a BAB-stratified perimorphic framework, where A comprises a carbonaceous stratum and B comprises organosilane strata, then eliminating the carbonaceous A stratum and the carbon component of the B strata. Despite deformation of the superstructure, the resemblance to the template precursor's prismatic, equiaxed superstructure can still be discerned, as shown with the dashed lines.

FIG. 8B is an SEM micrograph of porous MgO template particles with prismatic superstructures.

FIG. 9 is a pore size distribution chart showing the different pore size distributions for the P₂₃-type carbon, the AEAPTMS-functionalized P₂₃-type carbon, and the P₂₅-type silica-like material.

FIG. 10A shows two SEM micrographs of an elongated silica-like perimorphic material. In some particles, as shown by the spectrum generated via energy-dispersive x-ray spectroscopy in FIG. 10B, the silica-like material stratigraphically encapsulates a carbon perimorphic material, preventing it from being thermally oxidized. FIG. 10B is the energy-dispersive x-ray spectrum of the silica-like material stratigraphically encapsulating the carbon.

FIG. 11A is an SEM micrograph of a hollow-spheroidal silica-like perimorphic material. FIG. 11B and FIG. 11C are higher-magnification SEM micrographs of the silica-like perimorphic material in FIG. 11A.

FIG. 12A includes an optical micrograph of P₂₆-type perimorphic material. This material comprises a stratified perimorphic frameworks comprising a BAB stratigraphic arrangement of disordered BN (the B phase) and carbon (the A phase). The Raman spectrum of the P₂₆-type perimorphic material is also shown in FIG. 12A. FIG. 12B includes an optical micrograph of P₂₇-type perimorphic material. This material comprises disordered BN perimorphic frameworks. The Raman spectrum of the P₂₇-type perimorphic material is also shown in FIG. 12B. FIG. 12C is the Raman spectrum of the P₇-type carbon material utilized in Examples P₂₆ and P₂₇.

FIG. 13A is an image of the light brown powder comprising the P₂₈-type perimorphic material. FIG. 13B is an optical micrograph of an elongated P₂₈-type framework derived from endomorphic extraction of the N₂T₁-type template material.

FIG. 13C is a TEM micrograph showing the 50-400 nm cellular subunits of the P₂₈-type frameworks. FIG. 13D is an HR-TEM micrograph of the BN synthetic anthracitic network comprising the perimorphic wall. Y-dislocations are circled and traced. FIG. 13E is an HR-TEM micrograph of the BN synthetic anthracitic network comprising the perimorphic wall, within which a screw dislocation is traced.

FIG. 14A is an overlay of the Raman spectra of the P₂₈-type BN frameworks and the P₂₇-type BN frameworks. FIG. 14B is an overlay of the Raman spectra of the P₂₈-type BN frameworks and the BN@MgO PC material from which the P₂₈-type BN frameworks are derived. FIG. 14C is an overlay of the Raman spectra of the BN@MgO PC material, gathered using 0.5 mW and 2.0 mW laser power.

FIG. 15A is an optical micrograph of both collapsed and uncollapsed, hollow BN frameworks. Many of these frameworks crumpled during drying, but remained intact, as shown in the magnified inset of FIG. 15A, where the folds in the crumpled shell can be observed. FIG. 15B is a TEM micrograph of an uncollapsed hollow BN framework. From this, and from the magnified TEM micrograph of FIG. 15C, the rounded and spheroidal cellular subunits and the thin perimorphic walls can be discerned.

FIG. 16 is a photograph of the powder upon removal from the furnace in Example P₂₉. Multiple phases can be distinguished, including a dark phase and a light phase.

FIG. 17A is an optical micrograph of a PC material comprising perimorphic BCₓN grown on endomorphic MgO. The square indicator in the optical micrograph is positioned on the light phase of particles and indicates the position where the Raman spectrum in FIG. 17A was gathered. The Raman spectrum reveals a broad BN peak and a G peak positioned at approximately 1595 cm⁻¹. FIG. 17B is an optical micrograph of a PC material comprising perimorphic carbon grown on endomorphic MgO. The square indicator in the optical micrograph is positioned on the dark phase of particles and indicates the position where the Raman spectrum in FIG. 17B was gathered.

FIG. 18 is a cross-sectional diagram illustrating surface replication and the formation of a perimorphic framework.

FIG. 19 is a cross-sectional diagram illustrating the formation of a perimorphic framework using a porous template.

FIG. 20 is a cross-sectional diagram illustrating the difference between a perimorphic framework in native and non-native morphological states.

FIG. 21A is a cross-sectional diagram illustrating the synthesis of a labyrinthine framework. FIG. 21B is an SEM micrograph of a labyrinthine framework.

FIG. 22A is a TEM micrograph of (at the top) a PC particle, comprising a layered carbonaceous perimorphic phase and an MgO endomorphic phase, and (at the bottom) the perimorphic framework after endomorphic extraction. FIG. 22B is a HRTEM micrograph showing the disordered, nematically aligned graphenic layers of a synthetic anthracitic network comprising a section of the perimorphic wall.

FIG. 23 is a cross-sectional diagram illustrating different types of superstructural shapes that may be formed. The crosshatching represents the cellular substructure at a smaller scale.

FIG. 24A is a cross-sectional diagram illustrating the formation of a labyrinthine framework under restricted and unrestricted diffusion conditions. FIG. 24B is a cross-sectional diagram illustrating the creation of a density-reducing exocellular space within a perimorphic framework via a porous template precursor material having an internal cavity. FIG. 24C is a cross-sectional diagram illustrating the creation of a density-reducing exocellular space within a perimorphic framework via a porous template precursor material formed around a sacrificial material that is subsequently removed.

FIG. 25 is a cross-sectional diagram that depicts four perimorphic frameworks with similar overall volumes but varying compactness.

FIG. 26 is an illustration of a shuttling technique, wherein dissolution of an endomorph, generation of a stock solution, and precipitation from the stock solution outside of the perimorphic framework are shown to be happening concurrently.

FIG. 27A is an illustration of a sequence incorporating shuttling, perimorphic separation and concentration of a stock solution via increased CO₂ pressure, and solventless precipitation via reducing CO₂ pressure. FIG. 27B is an illustration of the use of a pressurized reactor being utilized to obtain endomorphic extraction and the formation of a concentrated Mg(HCO₃)₂ stock solution.

FIG. 28 includes SEM micrographs of template precursor particles (N₁) comprising nesquehonite particles with elongated superstructures derived from an aqueous Mg(HCO₃)₂ stock solution.

FIG. 29 includes SEM micrographs of template precursor particles (H₁) comprising hydromagnesite particles with equiaxed, hierarchical-equiaxed superstructures derived from an aqueous Mg(HCO₃)₂ stock solution.

FIG. 30A is an SEM micrograph of template precursor particles (H₂) comprising hydromagnesite particles with elongated, hierarchical superstructures derived from an aqueous Mg(HCO₃)₂ stock solution. FIG. 30B is an SEM micrograph revealing the finer features of the template precursor particles in FIG. 30A.

FIG. 31 is an SEM micrograph of template precursor particles (H₃) comprising hydromagnesite particles with thin, platelike superstructures derived from an aqueous Mg(HCO₃)₂ stock solution.

FIG. 32 is an SEM micrograph of template precursor particles (L₁) comprising lansfordite particles with equiaxed superstructures derived from an aqueous Mg(HCO₃)₂ stock solution.

FIG. 33 is an SEM micrograph of template precursor particles (M₁) comprising magnesite particles with equiaxed superstructures.

FIG. 34 is an SEM micrograph of template precursor particles (M₂) comprising magnesite particles with equiaxed superstructures.

FIG. 35 includes SEM micrographs of template precursor particles (A₁) comprising non-crystalline magnesium carbonate particles with hollow, hierarchical-equiaxed superstructures derived from an aqueous Mg(HCO₃)₂ stock solution. Some particles comprise thin fragments of hollow, spherical shells.

FIG. 36A is an SEM micrograph of A₂-type template precursor particles with a hollow, hierarchical-equiaxed superstructure. FIG. 36B is a higher-magnification SEM micrograph of an A₂-type template precursor particle. FIG. 36C is an SEM micrograph of A₃-type template precursor particles with a hollow, hierarchical-equiaxed superstructure. FIG. 36D is a higher-magnification SEM micrograph of an A₃-type template precursor particle. FIG. 36E is a TEM micrograph of carbon perimorphic frameworks synthesized on templates derived from A₂-type particles.

FIG. 37 includes SEM micrographs of template precursor particles (C₁) comprising magnesium citrate particles with hollow, hierarchical-equiaxed superstructures derived from a stock solution of aqueous magnesium citrate.

FIG. 38 is an optical micrograph of template precursor particles (E₁) comprising epsomite (magnesium sulfate heptahydrate) particles with elongated superstructures derived from a stock solution of aqueous magnesium sulfate.

FIG. 39A is an SEM micrograph of template precursor particles (H₄) comprising hydromagnesite particles derived from an aqueous Mg(HCO₃)₂ stock solution with dissolved lithium carbonate present at a concentration of 2.71·10⁻³ mol kg⁻¹ Li. FIG. 39B is an SEM micrograph of the H₄-type template precursor particles at higher magnification.

FIG. 40A is an SEM micrograph of template precursor particles (H₅) comprising hydromagnesite particles with hierarchical-equiaxed superstructures derived from an aqueous Mg(HCO₃)₂ stock solution with dissolved lithium carbonate present at a concentration of 2.74·10⁻² mol kg⁻¹ Li. FIG. 40B is an SEM micrograph of the H₅-type template precursor particles at higher magnification.

FIG. 41A-41C includes SEM micrographs of template precursor particles comprising magnesite particles with equiaxed superstructures derived from an aqueous Mg(HCO₃)₂ stock solution. FIG. 41A is an SEM micrograph of M₃-type precursor particles. FIG. 41B is an SEM micrograph of M₄-type precursor particles. FIG. 41C is an SEM micrograph of M₅-type precursor particles.

FIG. 42 includes optical micrographs of template precursor particles (N₂) comprising nesquehonite particles with elongated superstructures. This precursor material was derived from an aqueous Mg(HCO₃)₂ stock solution, which was used first to precipitate lansfordite. The lansfordite was then recrystallized into nesquehonite.

FIG. 43 includes optical micrographs of template precursor particles (N₃) comprising nesquehonite particles with elongated superstructures. This precursor material was derived from an aqueous Mg(HCO₃)₂ stock solution, which was used first to precipitate lansfordite. The lansfordite was then recrystallized into nesquehonite in the presence of a sodium dodecyl sulfate which is a surfactant.

FIG. 44A-44B are optical micrographs of template precursor particles comprising nesquehonite particles precipitated from lansfordite. FIG. 44A is a micrograph of nesquehonite particles precipitated without surfactant. FIG. 44B is a micrograph of nesquehonite particles precipitated in the presence of sodium dodecyl sulfate surfactant.

FIG. 45A is an SEM micrograph of template precursor particles (Li₁) comprising lithium carbonate particles with hollow, hierarchical-equiaxed superstructures derived from a stock solution of aqueous Li₂CO₃. The arrows indicate the varied features such as pin-holes, breaches and crumpled spheres that may be observed. FIG. 45B is an SEM micrograph of the Lit-type particles at higher magnification.

FIG. 46 includes SEM micrographs of porous MgO template particles (N₁T₁) made from N₁ template precursor particles. The template particles have inherited the precursors' elongated superstructure.

FIG. 47 includes SEM micrographs of porous MgO template particles (H₁T₁) made from H₁ template precursor particles. The template particles have inherited the precursors' hierarchical-equiaxed superstructure.

FIG. 48 includes SEM micrographs of porous MgO template particles (H₂T₁) made from H₂ template precursor particles. The template particles have inherited the precursors' hierarchical-equiaxed superstructure.

FIG. 49 includes SEM micrographs of porous MgO template particles (H₁T₂) made from H₁ template precursor particles. The precursors' hierarchical-equiaxed superstructure has been mostly lost due to sintering.

FIG. 50 includes SEM micrographs of porous MgO template particles (M₁T₁) made from M₁ template precursor particles. The template particles have inherited the precursors' equiaxed superstructure.

FIG. 51 includes SEM micrographs of porous MgO template particles (M₁T₂) made from M₁ template precursor particles. The template particles have inherited the precursors' equiaxed superstructure.

FIG. 52 includes SEM micrographs of porous MgO template particles (M₁T₃) made from M₁ template precursor particles. The template particles have inherited the precursors' equiaxed superstructure.

FIG. 53 includes SEM micrographs of porous MgO template particles (M₁T₄) made from M₁ template precursor particles. The template particles have inherited the precursors' equiaxed superstructure.

FIG. 54A is an optical micrograph of porous MgSO₄ template particles (E₁T₁) made from E₁ template precursor particles. The template particles have inherited the precursors' elongated superstructure. FIG. 54B is an SEM micrograph of the E₁T₁P₁₆-type PC particles formed from the E₁T₁-type template particles. FIG. 54C is an SEM micrograph of the P₁₆-type perimorphic frameworks formed from the E₁T₁P₁₆-type PC particles. FIG. 54D is an SEM micrograph of a P₁₆-type perimorphic framework at higher magnification and shows the cellular substructure of the perimorphic framework.

FIG. 55A is an SEM micrograph of porous MgO template particles made from undoped hydromagnesite particles. The conjoined subunits average 50 nm to 60 nm.

FIG. 55B is an SEM micrograph of porous MgO template particles (H₄T₁) made from Li-doped hydromagnesite particles. The conjoined subunits average 80 to 100 nm, with some subunits as large as 200 nm. The template particles have inherited the precursors' thin, plate-like morphology. FIG. 55C is an SEM micrograph of porous MgO template particles (H₅T₁) made from Li-doped hydromagnesite particles. The conjoined subunits average 100 nm to 300 nm. The template particles have inherited the precursors' thin, plate-like morphology.

FIG. 56 includes SEM micrographs of porous MgO template particles (H₆T₁) made from H₆ template precursor particles. The template particles have inherited the precursors' elongated superstructure.

FIG. 57A is an SEM micrograph of perimorphic frameworks of type P₁, which are made from M₃T₁P₁ PC particles. FIG. 57B is an SEM micrograph of perimorphic frameworks of type P₁₉, which are made from M₄T₁P₁₉ PC particles. FIG. 57C is an SEM micrograph of perimorphic frameworks of type P₂₀, which are made from M₅T₁P₂₀ PC particles.

FIG. 58A is an SEM micrograph of porous MgO template particles (M₁T₄) made from M₁ template precursor particles. The template particles have inherited the precursors' equiaxed superstructure. FIG. 58B and FIG. 58C are each SEM micrographs of the M₁T₄-type template particles at higher magnifications.

FIG. 59 includes SEM micrographs of PC particles (N₂T₁P₂₁). The template particles (N₂T₁) were made by treating N₂ template material with heat and water vapor.

FIG. 60A shows the TGA rate of mass loss (%/° C.) for the N₂ template precursor material. The rate of mass loss is shown for a sample heating rate of 5° C. per minute and a sample heating rate of 20° C. per minute under 100 sccm flowing Ar. FIG. 60B shows the TGA rate of mass loss for the N₂-type template precursor material at a sample heating rate of 5° C. per minute and a sample heating rate of 20° C. per minute under 100 sccm flowing CO₂.

FIG. 61A is an SEM micrograph of porous MgO template particles (N₂T₄) made from N₂ template precursor particles. The N₂ template precursor material was heated under flowing Ar at a rate of 5° C. per minute. FIG. 61B is an SEM micrograph of an N₂T₄-type template particle at higher magnification.

FIG. 62A is an SEM micrograph of porous MgO template particles (N₂T₅) made from N₂ template precursor particles. The N₂ template precursor material was heated under flowing Ar at a rate of 20° C./min. The arrows indicate swollen regions of the elongated superstructure typical of these template particles. The swollen regions are associated with internal macropores created during the heat treatment. FIG. 62B is an SEM micrograph showing an internal macropore within a N₂T₅-type porous MgO template particle.

FIG. 63A is an SEM micrograph of porous MgO template particles (N₂T₆) made from N₂ template precursor particles. The N₂ template precursor material was heated under flowing CO₂ at a heating rate of 20° C./minute to a temperature of 350° C., then further heated at a heating rate of 5° C. per minute. FIG. 63B is an SEM micrograph of the N₂T₆-type template particles at higher magnification.

FIG. 64A is an SEM micrograph of porous MgO template particles (N₂T₇) made from N₂ template precursor particles. Arrows indicate failures associated with the formation and swelling of internal macropores in the template particles. FIG. 64B is an SEM micrograph of the N₂T₇-type particles at higher magnification.

FIG. 65 includes SEM micrographs of carbon perimorphic frameworks made on porous MgO template particles (L₂T₁). The frameworks comprise both elongated and thin features due to uncontrolled, localized recyrstallization during the Template Stage. The elongated and thin features are indicated by arrows.

FIG. 66 includes SEM micrographs of PC structures and carbon perimorphic frameworks made on porous MgO template particles (L₃T₁).

FIG. 67A is an SEM micrograph of PC particles derived from L₃T₁ template particles. FIG. 67A shows the typical superstructure associated with the PC structures.

FIG. 67B is an SEM micrograph of this superstructure at higher magnification. FIG. 67C is an SEM micrograph of the magnified surface of a particle like those shown in FIG. 67A-67B.

FIG. 68 includes SEM micrographs of porous MgO template particles (A₁T₁) made from A₁ template particles. The magnified inset of the right-hand micrograph demonstrate the porous substructure of the shell of the hollow-spherical particles.

FIG. 69A is an SEM micrograph of porous MgO template particles (A₃T₁) made from A₃ template particles. FIG. 69B is an SEM micrograph of an exemplary shell of the porous MgO template particles (A₃T₁) made from A₃-type template particles. The shell contains macropores, which are an inherited feature also present in the A₃ template precursor's superstructure. Several macropores are circled with a dashed line. Additionally, the shell contains mesopores created by decomposition of the A₃ template precursor.

FIG. 70 is an SEM micrograph of carbon perimorphic frameworks (P₁₇) produced from endomorphic extraction of the Ca₁T₁P₁₇ PC material. The frameworks mostly retain their native morphology and mirror the templating surfaces of the template material Ca₁T₁.

FIG. 71 is an SEM micrograph of a carbon perimorphic framework (P₁₈), produced from endomorphic extraction of the Li₁T₁P₁₈ PC material. The framework has retained its native morphology and mirrors the templating surface of the displaced template particle.

FIG. 72A is an optical micrograph of a mixture created by endomorphic extraction via a shuttling technique. The micrograph in FIG. 72A reveals two distinct phases: nesquehonite particles and carbon perimorphic frameworks. The frameworks are sometimes deformed, as indicated by the arrows in FIG. 72A. FIG. 72B is an optical micrograph of one of the carbon perimorphic frameworks. FIG. 72C is a magnified optical micrograph of the region in the square of FIG. 72B.

FIG. 73A is an SEM micrograph of spray-dried MgSO₄ template precursors.

FIG. 73B is an SEM micrograph of carbon perimorphic frameworks derived from these precursor particles. FIG. 73C is an SEM micrograph of the cellular substructure of the frameworks, which indicates the formation of a porous template from the MgSO₄ precursors during the Template Stage.

FIG. 74 is a photograph of the result of a liquid-liquid separation, wherein hexane was blended into an aqueous mixture of carbon perimorphic frameworks and nesquehonite. The carbon perimorphic frameworks migrate into the black hexane phase at the top of the scintillation vial, while the nesquehonite remains in the aqueous phase at the bottom, which appears mostly white (albeit with some carbon particles mixed in and adhered to the sides of the scintillation vial).

FIG. 75 shows an initial mixture of carbon perimorphic frameworks and their subsequent flotation when the flask is placed under partial vacuum.

FIG. 76A is an SEM micrograph at 250,000× magnification of a carbon perimorphic framework generated from surface replication on an ex-nesquehonite template particle followed by endomorphic extraction. The substructure comprises mesoporous cellular subunits that possess a consistent, equiaxed morphology and size throughout the superstructure. FIG. 76B is an SEM micrograph at 100,000× magnification showing the same particle as FIG. 76A. FIG. 76C is an SEM micrograph at 25,000× showing the same particle as FIG. 76A-76B.

FIG. 77A is an SEM micrograph of a carbon perimorphic framework generated from an ex-nesquehonite, porous MgO template particle. This type of framework comprises a fibroidal, elongated superstructure. FIG. 77B is a magnification of the boxed region of FIG. 77A that shows the framework's cellular substructure, which comprises conjoined, mesoporous and macroporous subunits. FIG. 77C is an SEM micrograph showing another example of a carbon perimorphic framework generated from an ex-nesquehonite, porous MgO template particle. The framework has an elongated and tubular superstructure.

FIG. 78A is an SEM micrograph of carbon perimorphic frameworks generated from ex-hydromagnesite, porous MgO template particles. The frameworks comprise both thin and hierarchical-equiaxed superstructures. FIG. 78B is an SEM micrograph showing the cellular substructure of the boxed region of FIG. 78A. FIG. 78C is an SEM micrograph showing a labyrinthine framework generated on a hierarchical-equiaxed hydromagnesite template.

FIG. 79 is an SEM micrograph of permorphic carbon frameworks generated from ex-hydromagnesite template particles. Mechanical agitation during endomorphic extraction has created individualized, thin particles that stack with one another.

FIG. 80 is an SEM micrograph of carbon perimorphic frameworks generated from ex-hydromagnesite template particles. A prolonged thermal treatment in the Template Stage and mechanical agitation during endomorphic extraction have created smaller clusters of subunits with no clear higher-order organization.

FIG. 81 is an SEM micrograph of carbon perimorphic frameworks generated from ex-hydromagnesite, sintered MgO template particles. The frameworks comprise quasi-polyhedral cellular subunits larger than 100 nm in diameter.

FIG. 82 includes optical micrographs of carbon perimorphic frameworks springing back to their native architecture from a non-native, shrunken state created by evaporative drying.

FIG. 83A is an SEM micrograph of carbon perimorphic frameworks generated from elongated template particles (N₂T₄). These carbon frameworks comprise flexible, porous carbon fibers. FIG. 83B is an SEM micrograph of the cellular substructure of the carbon perimorphic frameworks in FIG. 83A. The cellular substructure is indistinct due to deformation of the thin perimorphic wall.

FIG. 84 includes SEM micrographs of carbon perimorphic frameworks generated from elongated template particles (N₂T₈). These carbon frameworks showed damage and fraying.

FIG. 85 includes SEM micrographs of carbon perimorphic frameworks (P₂₁) produced from endomorphic extraction of the N₂T₁P₂₁ PC particles. The frameworks are crumpled and cohered to one another via van der Waals interactions between the perimorphic walls. The N₂T₁ template particles were made by treating N₂ template material with heat and water vapor.

FIG. 86A is an SEM micrograph of carbon perimorphic frameworks produced on porous MgO template particles (N₂T₄). FIG. 86B shows frameworks produced on porous MgO template particles (N₂T₁). The N₂T₁ template particles were generated after treatment with heat and water vapor, increasing the size of the subunits relative to the N₂T₄ subunits. This difference in the templates can be observed after endomorphic extraction based on the smoother appearance of the frameworks in FIG. 86A vs. the crumpled appearance of the frameworks in FIG. 86B.

FIG. 87A is an SEM micrograph of carbon perimorphic frameworks derived from precipitated calcium carbonate (CaCO₃) template precursor particles. FIG. 87B is an SEM micrograph of the precipitated calcium carbonate (CaCO₃) template precursor particles from which the carbon perimorphic frameworks in FIG. 87B are derived.

FIG. 88A is a drawing of “Scheme A” in the Furnace Schemes discussed in the '49195 Application and Reference A. FIG. 88B is a drawing of “Scheme B” in the Furnace Schemes discussed in the '49195 Application and Reference A.

FIG. 89 is a classification chart showing how graphenic networks are classified in the current disclosure. Synthetic anthracitic networks comprising x-carbon and z-carbon are diagonally pattern-filled. Each of these classes is subcategorized as either sp^{x} networks, intermediate networks, or helicoidal networks, which are formed via maturation of sp^{x} networks.

FIG. 90 is a model of a schwarzite network, which is an example of a non-layered graphenic network with a gyroidal geometry. The Schwarz surface is shown next to the model.

FIG. 91 illustrates a curved, two-dimensional surface and identifies a tangent xy-plane and an orthogonal z-axis. The spaces above and below the curved surface comprises z-spaces.

FIG. 92 is a molecular model of a curved, ring-disordered graphenic structure. The structure is illustrated in various states of rotation in the illustration of FIG. 92, as indicated by the arrows, in order to provide multiple perspectives. A magnified inset shows regions of positive and negative Gaussian curvature. The edge located in the foreground is pattern-filled, and a magnified inset is shown of its undulating geometry.

FIG. 93A is an illustration of a tectonic encounter between two ring-ordered graphenic structures. FIG. 93B is an illustration of a scenario in which a subduction event results in an edge dislocation. The subducted lattice is marked with an ‘x’. FIG. 93C is an illustration of a scenario in which an sp² grafting event results in edge coalescence to form a new graphenic structure, with some slight ring-disorder and curvature resulting.

FIG. 94A-94E are illustrations of 5 model systems that are used to clarify definitions and concepts related to graphenic structures and systems.

FIG. 95A-95D are illustrations used to clarify definitions and concepts related to graphenic structures and Y-dislocations. The crosshatched region of FIG. 95D is the diamondlike seam in a Y-dislocation.

FIG. 96A-96C are photographs of various equipment utilized in the procedures demonstrated in the present disclosure.

FIG. 97 is an SEM micrograph of the perimorphic frameworks of Sample A1. Translucent regions of the perimorphic wall are circled.

FIG. 98A-98C are TEM micrographs of Sample A1 at various magnification levels. In the highest magnification level, the nematic alignment of the perimorphic wall is shown. Parallel lines are used to trace nematically aligned layers. A magnified inset demonstrates a Y-dislocation.

FIG. 99 is a TEM micrograph of another perimorphic framework to demonstrate further the concept of nematic alignment.

FIG. 100A-100D are illustrations showing different structural dislocations and their associated appearances in TEM micrographs.

FIG. 101 is a portion of a single point Raman spectrum for sample A1 indicating with dashed circles the regions of interest such as the unfitted G band (Gᵤ), unfitted Tr band (Trᵤ), unfitted D band (Dᵤ) and the unfitted shoulder between 1100-1200 cm⁻¹. The inset shows the entire Raman spectrum for sample A1. Spectrum was taken using 532 nm laser at 2 mW power setting.

FIG. 102 shows the two fitted peaks (f-1, f-2), the fitted profile, the actual profile, and the residual representing the difference between the fitted profile and the actual profile for the Raman profile of Sample A1. Also shown in tabular form are the peak-type, peak position, peak height, peak fwhm and peak area for the fitted peaks.

FIG. 103 shows the three fitted peaks (f-1, f-2, f-3), the fitted profile, the actual profile, and the residual representing the difference between the fitted profile and the actual profile for the Raman profile of Sample A1. Also shown in tabular form are the peak-type, peak position, peak height, peak fwhm and peak area for the fitted peaks.

FIG. 104 shows the four fitted peaks (f-1, f-2, f-3, f-4), the fitted profile, the actual profile, and the residual representing the difference between the fitted profile and the actual profile for the Raman profile of Sample A1. Also shown in tabular form are the peak-type, peak position, peak height, peak fwhm and peak area for the fitted peaks.

FIG. 105 shows the two fitted peaks (f-1, f-2, f-3, f-4), the fitted profile, the actual profile, and the residual representing the difference between the fitted profile and the actual profile for the Raman profile of Sample A1 after annealing. Also shown in tabular form are the peak-type, peak position, peak height, peak fwhm and peak area for the fitted peaks.

FIG. 106 is the XRD profile of Sample A1 with the three fitted peaks labelled I, II and III.

FIG. 107 is the thermal oxidation profile of Samples A1, A2 and A3 obtained from thermogravimetric analysis (TGA) run in air at heating ramp-rate of 20° C./min. The plot shows the derivative of the sample's mass loss with respect to temperature.

FIG. 108 is an SEM micrograph of Sample A2 showing perimorphic frameworks that appear to be fragmented and damaged during processing.

FIG. 109A-109C are TEM micrographs of Sample A2 at various magnifications. In FIG. 109A, the damaged perimorphic frameworks can be observed. In FIG. 109B, a section of a perimorphic wall is shown. In FIG. 109C, the perimorphic wall's graphitic layering is shown. Dark fringe lines are traced.

FIG. 110 shows a single point Raman spectrum for Sample A2 taken using 532 nm laser at 2 mW power setting.

FIG. 111 is an SEM micrograph of Sample A1 post-compression, showing perimorphic frameworks retaining three-dimensional, macroporous morphology with linear features in the wall due to buckling. The magnified inset shows a buckled wall.

FIG. 112 is an SEM micrograph of Sample A2 post-compression, showing a paper-like assembly of broken, flattened frameworks.

FIG. 113A-113C are SEM micrographs of perimorphic frameworks in Sample A3. FIG. 113A shows their polyhedral morphology and large atomically flat facets. FIG. 113B shows the transparent windows and more opaque framing. Two windows of the wall are circled. FIG. 113C shows the concave curvature of the transparent window extending across the framing.

FIG. 114 is an SEM micrograph of the polyhedral MgO template used to generate Sample A3.

FIG. 115A-115C are TEM micrographs of Sample A3 at various magnifications. In FIG. 115A, the cuboidal shape of the perimorphic framework's macroporous subunits is shown. The cube's edges are traced with dashed lines. Dashed lines also trace the more electron transparent windows. FIG. 115B shows a section of the perimorphic wall. The magnified inset shows an example of a Y-dislocation found within the fringes. FIG. 115C shows the uniformly thick walls even in the transparent “window” regions found over the flat regions. This indicates electron transparency is related to a lack of local sp³ states.

FIG. 116 shows a portion of a single point Raman spectrum for Sample A3. Features of interest are circled. Features include the unfitted G band (Gᵤ), unfitted Tr feature (Trᵤ), unfitted D band (Dᵤ) and the unfitted shoulder between 1100-1200 cm⁻¹. The customary G peak position at 1585 cm⁻¹ is marked with a dashed line, revealing the blue-shifting of the Gᵤ peak for Sample A3. The inset shows the entire Raman spectrum for Sample A3. The spectrum was taken using 532 nm laser at 2 mW power setting.

FIG. 117 is an illustration of a hypothetical zigzag-zigzag tectonic interface formed between two ring-disordered primordial domains (G₁ and G₂). The participating edge segments are labeled E₁ and E₂. The E₁-E₂ interface comprises three distinct interfacial zones—Offset Zone I, Offset Zone II and Level Zone. Labelled and unlabeled vertical (V) and horizontal (H1 and H2) perspectives are shown for ease of visual inspection. In the V and H1 perspectives, the same edge is traced with a dashed line for reference.

FIG. 118 illustrates sp² grafting across the level zone of the E₁-E₂ interface. The resulting sp² ring forms a ring-connection between G₁ and G₂, thus creating a new graphenic structure G₃. Labelled and unlabeled vertical (V) and horizontal (H1 and H2) perspectives are shown for ease of visual inspection. In the V and H1 perspectives, the same edge is traced with a dashed line for reference.

FIG. 119 illustrates sp³ grafting across the offset zones of the E₁-E₂ interface. New sp² atoms are represented as pattern-filled circles. New sp³ atoms are represented as white circles. The resulting sp^{x} rings comprise 4 rings (R₁, R₃, R₅, R₆) in the chair conformation and 2 chiral rings (R_{2-C}, R_{4-C}) associated with the tectonic zone transitions. The chiral chains within the 2 chiral rings are indicated with black arrows, and the 5 sp³-sp³ bonds are indicated with dashed lines. The point-reflected orientation of the rings in the chair conformation and the 2 sp³-sp³ bond lines is shown. Elevated tertiary radicals created by sp³ grafting across offset zones are labeled. The structure of the chiral ring R₂-c is shown, with its chiral ring indicated by a solid arrow and its sp³-sp³ bond being indicated by a dashed line. Labelled and unlabeled vertical (V) and horizontal (H1 and H2) perspectives are shown for ease of visual inspection. In the V and H1 perspectives, the same edge is traced with a dashed line for reference.

FIG. 120 is an illustration of the continued z-directional growth that occurs at the 5 elevated tertiary radicals from FIG. 119. New sp³ atoms are represented as white circles. The 4 rings (R₁, R₃, R₅, R₆) in the chair conformation and 2 chiral rings (R_{2-C}, R_{4-c}) are labeled. Labelled and unlabeled vertical (V) and horizontal (H1 and H2) perspectives are shown for ease of visual inspection. A second tier of sp³-sp³ bonds created are represented by dashed lines. Labelled and unlabeled vertical (V) and horizontal (H1 and H2) perspectives are shown for ease of visual inspection. In the V and H1 perspectives, the same edge is traced with a dashed line for reference.

FIG. 121 is an illustration after continued radical addition over the base layer. New sp² atoms are represented as pattern-filled circles. New sp³ atoms are represented as white circles. There are 3 new sp^{x} rings (R₇, R₈, R₉) in the chair conformation and 2 chiral rings (R_{2-C}, R_{4-C}) are labeled. The addition of the sp^{x} rings in the chair conformation has created 2 diamondlike seams, as shown in isolation in the inset of the H1 perspective. These 2 diamondlike seams form the intersection of 2 Y-dislocations, as shown by the circled Y-shapes in the inset of the H1 perspective. Labelled and unlabeled vertical (V) and horizontal (H1 and H2) perspectives are shown for ease of visual inspection. In the V and H1 perspectives, the same edge is traced with a dashed line for reference.

FIG. 122 is an illustration after continued radical addition over the base layer. New sp² atoms are represented by pattern-filled circles, and new sp³ atoms represented by white circles. A third tier of sp³-sp³ bonds are represented by dashed lines. There are 3 new sp^{x} rings (R₁₀, R₁₃, R₁₄) in the chair conformation and 1 new chiral ring (R_{11-C}) that have been labeled. The chiral ring R_{11-C} is located over the chiral ring R_{4-C}, creating a chiral column. The chiral column is illustrated in isolation. The chiral chains 1 to 6 and 7 to 12 are indicated with bolded arrows. Labelled and unlabeled vertical (V) and horizontal (H1 and H2) perspectives are shown for ease of visual inspection. In the V and H1 perspectives, the same edge is traced with a dashed line for reference.

FIG. 123 is an illustration after continued radical addition over the base layer. The rings above the base have coalesced, and a second layer has been nucleated. There are now 4 chiral rings (R_{2-C}, R_{4-C}, R_{11-C}, R_{12-C}), comprising 2 chiral columns. Labelled and unlabeled vertical (V) and horizontal (H1 and H2) perspectives are shown for ease of visual inspection. In the V and H1 perspectives, the same edge is traced with a dashed line for reference.

FIG. 124 is an illustration after continued radical addition over the base layer. A third layer has been nucleated. One of the cubic diamondlike seams is shown in a magnified inset. The other diamondlike seam is shown in a second magnified inset, where the rings are diagonally pattern-filled. The chiral column representing the lateral terminus of the seam is patterned (the bonds in the chiral chains are densely pattern-filled, while the bonds in the z-directional sp³-sp³ chain are less densely pattern-filled). Vertical (V) and horizontal (H1 and H2) perspectives are shown for ease of visual inspection.

FIG. 125A is a magnification of the horizontal perspective (H2) of FIG. 124. The chiral columns are traced. The bonds in the chiral chains in the chiral rings are indicated by solid lines with dashed tracing, while the bonds in the z-directional chains of sp³-sp³ bonds connecting the z-adjacent chiral rings are indicated by dash-dotted lines with dashed tracing. In FIG. 125B, the chiral column structure is represented in simplified, diagrammatic form. In FIG. 125C, the sp^{x} helix within each chiral column is isolated.

FIG. 126A is an SEM micrograph of the C@MgO PC structures that are typical of Samples B1 to B3. The MgO can be observed as the bright, charged areas. In the SEM micrograph of FIG. 126B, the endomorphic MgO templates have been removed, leaving behind a perimorphic framework typical of Samples B1 to B3. In the SEM micrograph of FIG. 126C, the sheets-of-cells perimorphic frameworks typical of Sample B4 are shown.

FIG. 127A-127D are Raman spectral features for Samples B1-B4. FIG. 127B indicates spectral trends observed with decreasing temperature.

FIG. 128 illustrates a zigzag-zigzag tectonic interface that is grafted via an interstitial line of atoms, creating sp^{x} rings in the boat conformation.

FIG. 129 illustrates a zigzag-armchair tectonic interface that is grafted via two z-adjacent lines of 5-member and 7-member sp^{x} rings.

FIG. 130 illustrates a zigzag-armchair tectonic interface that is grafted via an interstitial line of atoms, creating sp^{x} rings in the boat conformation.

FIG. 131 is a diagram representing the growth of multiple primordial domains over a common substrate surface, their grafting, and the nucleation and growth of higher layers. The “X” structures represent diamondlike seams. Some diamondlike seams are propagated vertically, while others are not. New diamondlike seams are illustrated as being formed due to higher-layer tectonic activity.

FIG. 132 is the XRD profile of Sample B4.

FIG. 133 is an illustration of Samples C1 and C2, illustrating the bright brown color of the hydrogenated carbons formed at 400° C.

FIG. 134A is the FTIR of Sample C2. The hydrogenation of this brown coal-like sample is indicated. FIG. 134B shows the peak assignments of the FTIR peaks in FIG. 134A.

FIG. 135 is the Raman spectra of Samples C1 and C2. In each case, a minor peak at ˜600 cm⁻¹ that has been attributed to non-hydrogenated nanodiamond is observed. This is an indication of a non-hydrogenated phase of Samples C1 and C2.

FIG. 136 is a photograph of equivalent masses of Samples E1 and E1A, demonstrating the more granular consistency of Sample E1 and the finer, more voluminous nature of Sample E1A.

FIG. 137A-137C are SEM micrographs of Sample E1 (unannealed), and FIG. 137D-137F are SEM micrographs of Sample E1A (annealed). Comparison of FIG. 137A with FIG. 137D indicates the greater densification and granulation that occurred in Sample E1 vs. Sample E1A. Comparison of FIG. 137B with FIG. 137E shows the greater flexibility and tissue-like curvature of the perimorphic frameworks in Sample E1 and the greater rigidity of Sample E1A's perimorphic frameworks. Comparison of FIG. 137C with FIG. 137F shows the less distinct substructure of the perimorphic frameworks in Sample E1 vs. the more distinct substructure of the rigidified Sample E1A frameworks.

FIG. 138A-138C are SEM micrographs of Sample E2, and FIG. 139D-139F are SEM micrographs of Sample E2A. Comparison of FIG. 138A with FIG. 138D indicates the greater densification and granulation that occurred in Sample E2 vs Sample E2A. Comparison of FIG. 138B with FIG. 138E shows the greater flexibility and tissue-like curvature of the perimorphic frameworks in Sample E2 and the greater rigidity of Sample E2A's perimorphic frameworks. Comparison of FIG. 138C with FIG. 138F shows the less distinct substructure of the perimorphic frameworks in Sample E2 vs. the more distinct substructure of the rigidified Sample E2A frameworks. FIG. 138E-138F also indicate fusing of the stacked plates in Sample E2A.

FIG. 139 is an SEM micrograph of the MgO template utilized to generate the sheets-of-cells frameworks utilized in Study E.

FIG. 140 illustrates the Raman spectral effects associated with maturation of an sp^{x} precursor.

FIG. 141 illustrates the maturation-induced disintegration of a singleton structure comprising a cubic diamondlike seam.

FIG. 142 illustrates the role of chiral rings and columns in preserving vertical crosslinking during maturation.

FIG. 143 is a diagram illustrating the transformation of an sp^{x} helix into an sp² helix.

FIG. 144 is a diagram illustrating the formation of an sp² helicoid around an sp² helix.

FIG. 145 illustrates the maturation of the sp^{x} precursor of FIG. 124 into a helicoidal singleton.

FIG. 146 provides another perspective to facilitate visual discernment of the ring-connectedness of the helicoidal singleton illustrated in FIG. 145.

FIG. 147 is the XRD profile of Sample B4A.

FIG. 148 illustrates an alternative scenario of the E₁-E₂ interface in which the edges of G₁ and G₂ do not crisscross. It is shown that the chiral rings R_{2-C} and R_{4-C} in this scenario have opposite chirality, as indicated by the arrows.

FIG. 149 illustrates the progressive growth of an sp^{x} precursor over the E₁-E₂c tectonic interface, which mirrors the E₁-E₂ interface modeled in FIG. 117, but assumes that no sp² grafting is possible, and that instead of a level zone, the E₁-E₂ interface comprises a crossover point.

FIG. 150 illustrates the double helicoid formed by the disintegration of the sp^{x} precursor constructed over the E₁-E₂^{c} tectonic interface in FIG. 149.

FIG. 151 demonstrates the complete unzipping of the base layer due to unzipping of the sp³-sp³ bond lines formed across the E₁-E₂^{C} tectonic interface. The 2 chiral chains in the chiral ring R_{3-C} are indicated with dashed arrows, and the sp³-sp³ bonds are traced with dashed lines. The chiral chains are shown to be point-reflected. Sp² atoms are indicated by pattern-filled circles, while sp³ atoms are indicated by white circles.

FIG. 152 demonstrates the formation of the double helicoid modeled in FIG. 150 and the maturation-induced disintegration of the sp^{x} precursor constructed over the E₁-E₂^{C} tectonic interface in FIG. 149. The chiral column constructed over R_{3-C} is shown to contain an sp^{x} double helix that, upon maturation, is transformed into an sp² double helix.

FIG. 153A-153C illustrate how the absence or presence of a level zone, and associated sp² grafting, affects the ring-connectedness of the resulting helicoidal system after maturation.

FIG. 154A-154D illustrate individual helicoids and conjoined helicoids, including conjoined helicoids of common and opposite chirality.

FIG. 155 illustrates how a monolayer precursor, if disintegrated during maturation, forms a truncated double helicoid that does not interlock.

FIG. 156 illustrates how a bilayer precursor, if disintegrated during maturation, forms a sufficiently elongated double helicoid for the helicoids to be interlocked.

FIG. 157A is a graph theoretic representation of a singleton-to-singleton maturation. FIG. 157B is a graph theoretic representation of a singleton-to-assembly maturation.

FIG. 158 illustrates how two higher-layer pathways extending up from a base layer may reconnect, forming a closed loop.

FIG. 159A is a TEM micrograph of a macroporous perimorphic framework from an annealed sp^{x} precursor. FIG. 159B is a TEM micrograph of the perimorphic wall. The fringe lines exhibit a distinctive “sliced” pattern, as indicated by the dashed lines, corresponding to the z-displacement of a helicoidal graphenic lattice over each 180° turn around the dislocation line. In FIG. 159C, a helicoid stretches across more than 10 layers of the helicoidal network, as indicated by the dashed guideline. In FIG. 159D, a loop of conjoined helicoids from the cell wall is magnified. By analyzing the HRTEM image in FIG. 159D, we can see that the sp² helices at the centers of these two nearby helicoids were less than 1 nm apart.

FIG. 160A is a TEM micrograph of a helicoidal x-network comprising a perimorphic framework with an equiaxed, cuboidal morphology. In FIG. 160B, the controlled mesoporous architecture of the perimorphic framework is shown, with a highly consistent perimorphic wall thickness. In FIG. 160B, the perimorphic wall is shown at higher magnification. It averages 2-3 layers and appears more kinked than thicker walls because of its increased flexibility.

FIG. 161 is an illustration of three perimorphic frameworks demonstrating the concept of mesoscale crosslinking. The crosshatching of structures I, II, and III indicate that their molecular-scale crosslinking is the same. However, their mesoscale crosslinking varies, with I having the highest mesoscale crosslinking and III having the lowest.

FIG. 162A is an illustration of a hydroxylated edge formed by the vertical terminus of two conjoined helicoids. FIG. 162B is an illustration of a mouth, representing an entrance into the network's interlayer labyrinth. These mouths offer ubiquitous access points for infiltration or exfiltration of fluids, as indicated in FIG. 162B.

FIG. 163A-163C are SEM micrographs of an epoxy nanocomposite's fracture surface. The nanocomposite comprises a 0.5% weight loading of an sp^{x} network. Each embedded perimorphic framework comprises a sheet-of-cells morphology, as indicated by the circle in FIG. 163C, and an sp^{x} network.

FIG. 164A-164C are SEM micrographs of an epoxy nanocomposite's fracture surface. The surface is covered with debris produced by explosive failure of the cured epoxy nanocomposite in the vicinity of the perimorphic frameworks. In FIG. 164B, we can see the result of one such explosive failure. In FIG. 164C, we can observe that the debris are fragments of epoxy that are physically embedded in the surface.

FIG. 165 is an illustration of two sp^{x} networks being pressed together to form non-native bilayers that may be crosslinked during maturation.

FIG. 166 is an illustration of a radical addition reaction between two sp^{x} networks in static vdW contact, G_{A} and G_{B}. This is represented in Frame I. The geometry of the underlying helicoids pushes G_{B}'s sp² radicals toward G_{A}, as illustrated in Frame II of FIG. 166, where the radicals are circled. A radical cascade reaction bonds G_{B}'s lines of sp² radicals with z-adjacent atoms in G_{A}, forming sp² rings. This reaction extends the helicoids across the non-native bilayer, as shown in Frame III of FIG. 166, and pushes radical-terminated edge dislocations to surfaces.

FIG. 167A is a photograph of the Sample F1 granules. FIG. 167B is a photograph of the Sample F2 pellet.

FIG. 168A-168D are the N₂ adsorption-desorption isotherms for Samples F1-F4.

FIG. 169 is the pore distribution chart for Samples F1-F4.

FIG. 170A-170D are the Raman spectra for Samples F1-F4.

FIG. 171 illustrates the Raman spectral changes associated with maturation of the Sample F2 pellet into the Sample F3.

FIG. 172A is a photograph of a buckypaper. FIG. 172B is a photograph of a cutting of the buckypaper.

FIG. 173A is an SEM micrograph of the buckypaper's cross-section. FIG. 173B is an SEM micrograph showing the collapsed perimorphic frameworks comprising the buckypaper. FIG. 173C is an SEM micrograph of the K₂CO₃ template.

FIG. 174A-174D are photographs depicting a solvent immersion test of an unannealed buckypaper.

FIG. 175A-175D are photographs depicting a solvent immersion test of an annealed buckypaper.

FIG. 176A-176B are the Raman spectra of Samples F5 and F6. FIG. 176C is a chart showing the peak positions of Sample F5 and F6.

FIG. 177 is a fibrous buckypaper made from elongated sp^{x} microforms.

FIG. 178A is an SEM micrograph of the fibrous buckypaper. FIG. 178B is an SEM micrograph of the flexible, elongated sp^{x} microforms.

FIG. 179A-179B are SEM micrographs of hollow spheroidal frameworks.

FIG. 180A-180B are SEM micrographs of equiaxed frameworks.

FIG. 181 is a photograph of Sample G1 undergoing resistive heating at 1 atm.

FIG. 182 is sequence of photograph showing Sample G1 exhibiting the Meissner Effect.

FIG. 183A-183D are photographs of various disordered carbon samples undergoing resistive heating at 1 atm.

FIG. 184A-184B are photographs of disordered carbon samples exhibiting the Meissner Effect.

FIG. 185A-185B are photographs of disordered carbon samples exhibiting flux pinning in the presence of neodymium magnets.

FIG. 186A is a TEM micrograph showing a typical perimorphic framework in Sample G1. FIG. 186B is the XRD profile of Sample G1. FIG. 186C is the Raman spectrum of Sample G1.

FIG. 187 is a model illustrating an sp^{x} layer within an sp^{x} network grown to completion around an underlying templating surface. This can be thought of as a lateral cross-section of an sp^{x} network.

FIG. 188A is a photograph of the pelletized MgO template utilized in Study H. FIG. 188B is a photograph of the porous PC structure formed on the MgO pellet.

FIG. 189 is a drawing of the contact made between the 4-point probe and the PC material in Study H.

FIG. 190 is a chart of the sample sheet resistance vs. chamber pressure in Study H.

FIG. 191 is the Raman spectrum of the sample used in Study H. The Raman spectrum was unchanged after the tests performed in Study H.

FIG. 192 is a schematic representing an approach to forming an ambient superconducting article, such as a filament, by evacuating internal gas, applying an impermeable barrier phase, and then returning the article to ambient external pressure.

FIG. 193 is a photograph of the probe tip showing melted areas of the plastic housing where probe tip heating occurred. The melted areas are circled.

FIG. 194: Illustration representing the process of surface replication, starting with defect-catalyzed nucleation on the templating surface, followed by conformal growth over the templating surface.

FIG. 195: SEM images of the K₂SO₄ oxyanionic template precursor powder.

FIG. 196: SEM images of PC structures created by growing perimorphic carbon on oxyanionic templates.

FIG. 197: SEM images of crumpled perimorphic frameworks comprising graphenic carbon.

FIG. 198: Optical micrograph of MgSO₄·7H₂O template precursor crystals.

FIG. 199: SEM images of PC structures created by growing perimorphic carbon on oxyanionic templates.

FIG. 200: SEM images of carbonaceous perimorphic frameworks synthesized on porous, oxyanionic templates.

FIG. 201: Average Raman spectra of carbonaceous perimorphic frameworks generated in Experiments 1-5.

FIG. 202: Unsmoothed and smoothed average Raman spectrum of carbonaceous perimorphic frameworks generated in Experiment 3.

FIG. 203: SEM image of PC structures synthesized in Experiment 3.

FIG. 204: SEM images buckypaper and sheet-like, crumpled perimorphic fragments produced via growth on Li₂CO₃ template.

FIG. 205: TEM images of sheet-like, crumpled perimorphic fragments produced via growth on Li₂CO₃ template. Individual graphenic lattices within the perimorphic wall are traced.

FIG. 206 is a table summarizing the exemplary samples P₂₄ through P₂₉ discussed in Sections I through IV.

FIG. 207A-207B are together a table summarizing exemplary types of template precursor materials, template materials, PC materials, and perimorphic materials.

FIG. 208 is a table summarizing the expected Raman peak positions and TGA mass losses of several MgCO3 xH₂O template precursor materials.

FIG. 209 is a table summarizing the N₂ gas adsorption analysis of the template materials M₃T₁, M₄T₁, M₅T₁, M₃T₂, M₄T₂ and M₅T₂.

FIG. 210 is a table summarizing the N₂ gas adsorption analysis of the template materials N₂T₁ and N₂T₂.

FIG. 211 is a table showing the template precursor material, carrier gas, furnace scheme, heating rate, temperature setting, and isotherm duration of each thermal treatment segment for template materials N₂T₃, N₂T₄, N₂T₅, and N₂T₆.

FIG. 212A-212B are together a table summarizing of all of the template materials utilized in the following exemplary Replication Stage procedures. The table includes the basic parameters utilized to make the template materials, including the template precursor material, the furnace scheme utilized for the Template Stage treatment, and the temperatures, times, heating rates, carrier gases and gas flow rates pertaining to the Template Stage treatments.

FIG. 213A-213C are together a table summarizing the surface replication parameters used in exemplary Replication Stage procedures.

FIG. 214A-214B are together a table summarizing the Raman metrics and yields of exemplary carbonaceous perimorphic frameworks.

FIG. 215 summarizes the conditionals associated with classifications of “minimally grafted,” “partially grafted,” and “highly grafted” carbonaceous sp^{x} networks.

FIG. 216 presents the XRD peak angles, d-spacings, areas, area percentages, and FWHM values of Sample A1.

FIG. 217 presents the XRD peak angles, d-spacings, areas, area percentages, and FWHM values of Sample A2.

FIG. 218 presents the Raman spectral information for Samples B1-B4.

FIG. 219 presents the XRD peak angles, d-spacings, areas, area percentages, and FWHM values of Sample B4.

FIG. 220 presents the Raman spectral information for Samples C1 and C2.

FIG. 221 presents the Raman spectral information and the approximate yield of carbon for Samples D1 and D2.

FIG. 222 presents the Raman spectral information for Samples E1, E1A, E2, and E2A.

FIG. 223 presents the XRD peak angles, d-spacings, areas, area percentages, and FWHM values of Sample B4A.

FIG. 224 shows the BET surface area and BJH pore volume data for Samples F1-F4.

FIG. 225 shows the Raman spectral information for Samples F5 and F6.

FIG. 226 presents the XRD peak angles, d-spacings, areas, area percentages, and FWHM values of Sample G1.

FIG. 227 presents basic information about the synthesis of the exemplary template precursors in Reference C.

FIG. 228 is a summary of the surface replication parameters used in exemplary Replication Stage procedures.

FIG. 229 presents the Raman spectral information for the perimorphic materials obtained in Experiments 1-5.

### DETAILED DESCRIPTION

The Detailed Description of the present disclosure is organized according to the following sections:
I. Terms and Concepts
II. Description of the General Method and Variants
III. Furnace Schemes, Analytical Techniques and Material Naming
IV. Perimorphic Framework Examples
V. Reference A: Detailed Description from the '49195 Application
VI. Reference B: Detailed Description from the '37435 Application
VII. Reference C: Detailed Description from the '154 Application

### Notes on References a Through C

Our objective in including References A through C in the present disclosure is to enable quick reference to the Detailed Descriptions of these related patent applications and to keep the exposition in the exposition of Sections I through IV as focused as possible.

Section V, or “Reference A,” is the Detailed Description from the specification of the '49195 Application, which teaches the scalable synthesis of carbonaceous perimorphic materials-a subset of the larger category of perimorphic materials. The Detailed Description included in Reference A has been modified in certain ways to harmonize its presence within the present disclosure and to avoid confusion that might otherwise arise from its inclusion. For example, where figures are cited in Reference A, their original numbering in the '49195 Application has been changed as needed to avoid redundancy. The designations of specific Furnace Schemes originally presented in the '49195 Application have been renamed in Reference A to avoid redundancy with the designated Furnace Schemes in other sections of the present disclosure. Measurements and data reported in Reference A were measured according to the analytical techniques specified in Reference A, not necessarily according to analytical techniques specified in other sections of the present disclosure. Lastly, sections in Reference A that were originally numbered with Roman numerals are designated with a single asterisk (e.g. what was originally designated Section I of the '49195 Application is designated Section I* in Reference A).

Section VI, or “Reference B,” is the Detailed Description from the specification of the '37435 Application, which teaches the synthesis of graphenic networks-a subset of the larger category of perimorphic materials. The Detailed Description included in Reference B has been modified in certain ways to harmonize its presence within the present disclosure and to avoid confusion that might otherwise arise from its inclusion. For example, where figures are cited in Reference B, their original numbering in the '37435 Application has been changed as needed to avoid redundancy. The designations of specific Furnace Schemes originally presented in the '37435 Application have been renamed in Reference B to avoid redundancy with the designated Furnace Schemes in other sections of the present disclosure. Measurements and data reported in Reference B were measured according to the analytical techniques specified in Reference B, not necessarily according to analytical techniques specified in other sections of the present disclosure. Lastly, sections in Reference B that were originally numbered with Roman numerals are designated with a double asterisk (e.g. what was originally designated Section I of the '37435 Application is designated Section I** in Reference B).

Section VII, or “Reference C,” is the Detailed Description from the specification of the '154 Application, which teaches surface replication on certain soluble templates a subset of the larger category of templates that might be used according to the General Method. The Detailed Description included in Reference C has been modified in certain ways to harmonize its presence within the present disclosure and to avoid confusion that might otherwise arise from its inclusion. For example, where figures are cited in Reference C, their original numbering in the '154 Application has been changed as needed to avoid redundancy. The designations of specific Furnace Schemes originally presented in the '154 Application have been renamed in Reference C to avoid redundancy with the designated Furnace Schemes in other sections of the present disclosure. Measurements and data reported in Reference C were measured according to the analytical techniques specified in Reference C, not necessarily according to analytical techniques specified in other sections of the present disclosure. Lastly, sections in Reference C that were originally numbered with Roman numerals are designated with a triple asterisk (e.g. what was originally designated Section I of the '154 Application is designated Section I*** in Reference C).

We additionally note that the materials naming scheme that was utilized in the '49195 Application is adopted again in Sections I through IV of the present disclosure, and the numbering in the present disclosure is continued where the numbering in the '49195 Application left off. This has been done to facilitate easy reference to previously described materials and procedures and to avoid confusion. The continuity of the numbering does not imply that the present disclosure is a continuation or is supplemental to any previous disclosure.

The compatibility and combinability of many exemplary techniques, procedures, and materials set forth in Sections I through VII will be evident to knowledgeable practitioners of the art. For example, the Raman spectral features pertaining to an exemplary x-carbon demonstrated in Section VI might be readily obtained in a perimorphic framework comprising a hollow superstructure demonstrated in Section V. Taken together, Sections I through VII disclose a versatile and industrially scalable approach to producing architected, nanostructured materials, and they describe a diverse category of perimorphic materials.

### I. Terms and Concepts

In any cases where a contradiction may exist between the definition or description of a term or concept in References A through C and the definition or description of the same term or concept in Sections I through IV, the definition or description of that term or concept set forth in Sections I through IV should be understood as authoritative within the present disclosure. In any cases where a term or concept is defined or described in Sections A through C and is not contradicted by a corresponding definition or description in Sections I through IV, the definition or description set forth in Sections A through C should be understood as authoritative within the present disclosure.

A “stratified” perimorphic framework, as defined herein, comprises a multiphase framework in which the two or more distinct perimorphic strata can be identified within the perimorphic wall. When describing a stratigraphic pattern, the present disclosure describes the pattern with a string of letters in which each distinct stratum is represented by a letter, the position of a stratum in relation to other strata is represented by the position of its letter with respect to the other letters in the string, and compositionally similar strata are designated by the same letter. Hence, the string AB represents a perimorphic wall comprising two distinct and compositionally dissimilar strata, while the string BAB represents a perimorphic wall comprising three distinct strata, wherein one inner stratum is sandwiched between two outer strata, the outer strata being compositionally similar.

A “perimorphic stratum” (or “stratum”), as defined herein, comprises a distinct phase within a stratigraphically organized perimorphic wall. A perimorphic stratum typically shares a general alignment and topological similarity with the other perimorphic strata and with the perimorphic wall itself. As an example, a perimorphic wall might comprise a graphenic stratum positioned above or below a silica stratum. Even an all-carbon perimorphic wall may comprise distinct carbon strata, as described in the '580 Application.

“Pre-extraction replication,” as defined herein, comprises a surface replication technique that is performed prior to endomorphic extraction. Pre-extraction replication may be utilized to adsorb an adsorbate exclusively to one side of an existing perimorphic material, resulting in an A→*AB→*ABC buildup of the perimorphic wall (where A is synthesized on the templating surface, then B is synthesized on A, then C is synthesized on B, and then endomorphic extraction is performed).

“Post-extraction replication,” as defined herein, comprises a surface replication technique that is performed after endomorphic extraction. Post-extraction replication may be utilized to adsorb an adsorbate to both sides of an existing perimorphic material, resulting in an A→*BAB→*CBABC buildup of the perimorphic wall (where A is synthesized on the templating surface, then endomorphic extraction is performed, then the B strata are synthesized on both sides of A, and then the C strata are synthesized on both sides of the BAB stratigraphic arrangement).

Pre-extraction and post-extraction replication strategies can be combined. For example, an ABC stratification may be obtained via sequential pre-extraction replications. Subsequently, a post-extraction replication may be utilized to obtain a DABCD stratification.

“Stratigraphic occlusion,” as defined herein, comprises the use of one or more perimorphic strata to occlude another perimorphic stratum in a conformal configuration. One way to achieve stratigraphic occlusion is to use a post-extraction replication technique to obtain a BAB-type stratification, where a perimorphic stratum (A) is occluded via two conformally configured perimorphic strata (B).

“Stratigraphic encapsulation,” as defined herein, comprises the use of one or more perimorphic strata to encapsulate a perimorphic framework. One way to achieve stratigraphic encapsulation is to apply a perimorphic stratum around the periphery of an existing perimorphic framework.

A “two-dimensional” material, as defined herein, comprises a material with a bonding configuration that result in an atomic monolayer structure over small distances.

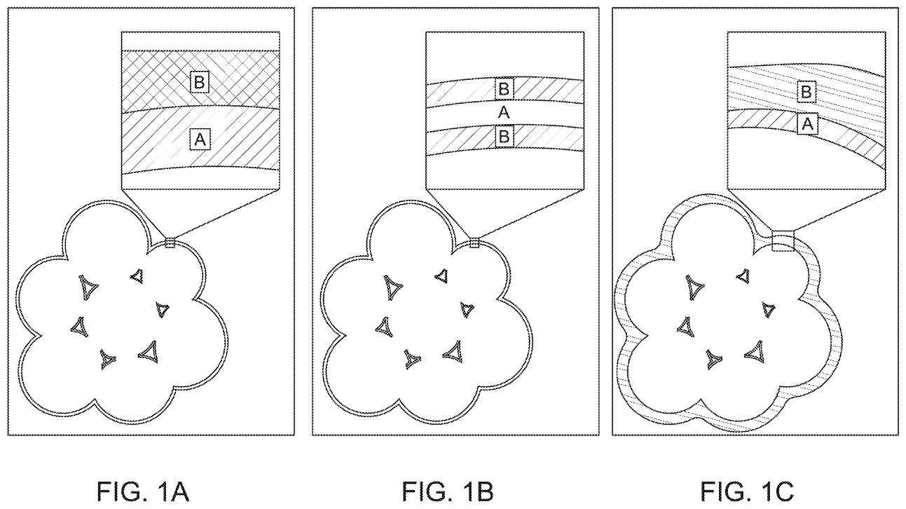

FIG. 1A illustrates an AB stratigraphic arrangement. In this illustration, both A and B are substantially present throughout the framework and share a common topology imparted by the templating surface. FIG. 1B illustrates a BAB stratigraphic arrangement, in which A is stratigraphically occluded by the two conformal B strata, which share a common topology with A. FIG. 1C illustrates another AB stratigraphic arrangement. In this illustration, B is not present throughout the framework and does not share a common topology with A. Instead, B is only present around the periphery of the framework. It encapsulates the entire framework without being present throughout the perimorphic wall. This stratigraphic encapsulation may be facilitated by applying a B stratum that does not everywhere conform to the A stratum and may in some places cover or plug the framework's exocellular pores.

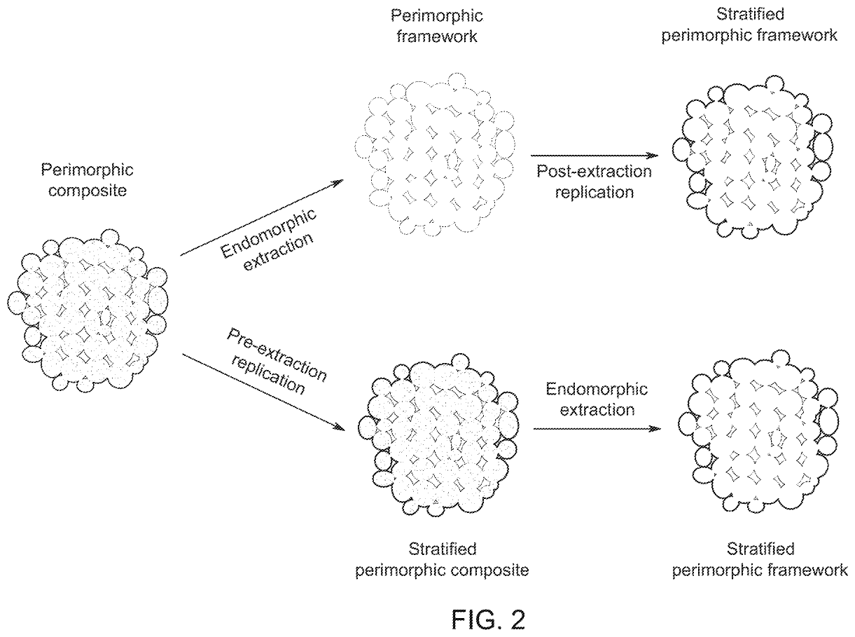

FIG. 2 illustrates two potential pathways that might be used to synthesize a stratified perimorphic framework. A hypothetical PC structure synthesized via pre-extraction replication is shown. From this point, a stratified perimorphic framework can be synthesized via two pathways. In the upper pathway, the PC is first subjected to endomorphic extraction, then a post-extraction replication technique is used to adsorb a new perimorphic stratum to the existing perimorphic framework, resulting in a stratified perimorphic framework. In the lower pathway, the PC is first subjected to a second pre-extraction replication technique, creating a stratified PC structure, then endomorphic extraction is used to remove the endomorphic template material, resulting in a stratified perimorphic framework.

### II. Description of the General Method and Variants

The “General Method” is the most basic form of the method and applies to the synthesis of perimorphic products of any chemical composition. It comprises a method for synthesizing a perimorphic product wherein substantial portions of the template material and the process liquid are conserved and may be reused. As such, the General Method may be performed cyclically. All variants of the method disclosed in the present disclosure comprise some variant of the General Method.

The General Method comprises a series of steps that is herein presented, for ease of description, in 4 stages (i.e. the Precursor Stage, Template Stage, Replication Stage, and Separation Stage). Each stage is defined according to one or more steps, as described below:
Precursor Stage: A precursor material is derived from a stock solution via solventless precipitation. A portion of the process liquid is conserved.
Template Stage: The precursor material formed in the Precursor Stage is modified by one or more treatments to form a template material.
Replication Stage: An adsorbate material is adsorbed to the templating surface of the template material to form a perimorphic material, the perimorphic material and endomorphic template material together forming a PC material.
Separation Stage: Endomorphic extraction and perimorphic separation are performed. A stock solution is derived from endomorphic extraction. Perimorphic separation separates the perimorphic product from conserved process materials.

In practice, each step within these stages may itself comprise multiple, subsidiary steps. Additionally, each of the steps may occur concurrently with steps from another stage, such that in practice different stages may overlap in chronology. This can especially be expected in variants employing one-pot techniques. As a hypothetical example of this, a stock solution might be continuously sprayed alongside an adsorbate material into a furnace. In this hypothetical furnace, precursor particles might be precipited from the stock solution, template particles might be formed by heating of the precursor particles, and perimorphic material might be adsorbed to the template particles continuously and concurrently. This would correspond to steps assigned herein to the Precursor Stage, Template Stage, and Replication Stage, respectively.

Similarly, it is anticipated that in practice, many variants of the General Method may incorporate the steps described in the 4 Stages in different sequences. Also, in some variants, a step assigned by definition to one of the four stages herein might instead occur in a different stage. Such variants are anticipated herein and do not deviate from the inventive method, which is only presented herein as a discrete sequence of 4 stages for the sake of describing the overall cycle.

Ancillary processing steps (e.g. rinsing, drying, blending, condensing, spraying, agitating, etc.) may also be incorporated into the method at each stage. As a hypothetical example of this, a Replication Stage might involve coating a template material with a perimorphic material via a liquid-phase adsorption procedure, then filtering, rinsing and drying the resulting PC material. The incorporation of these processing steps in many variants will be obvious to those skilled in the art and, as such, they are not enumerated herein.

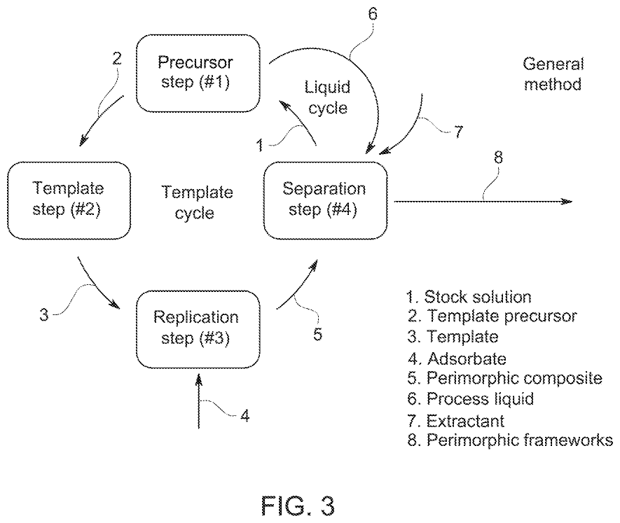

The inputs and outputs of the General Method are illustrated in FIG. 3. The General Method comprises a Template Cycle, by which a template material may be conserved and reused, and a Liquid Cycle, by which a process liquid may be conserved and reused.

### Variants of the General Method

The following discussion enumerates a number of ways in which the General Method may be variously implemented. The omission of variants from this discussion should not be interpreted as limiting, since an exhaustive list of ways in which the General Method may be implemented is not practical.

The General Method is intended to offer a means for cyclical production of perimorphic products while conserving process materials. In each cycle of the General Method, some portion of the process materials utilized are conserved and reused. In some variants, substantially all of the process materials utilized may be conserved and reused. In other variants, a portion of the process materials may be lost. One hypothetical example of this would be evaporative losses of process liquids from open tanks or wet filters.

In some variants of the General Method, process steps may correspond to batch processes. In other variants, process steps may correspond to continuous processes.

In some variants of the General Method, the solventless precipitation may comprise at least one of the following techniques: heating or cooling the stock solution to change the solubility of a solute in the stock solution; volatilizing a dissolved gas within the stock solution; depressurizing the stock solution; atomization of the stock solution; spray-drying the stock solution or spray pyrolysis.

In some variants of the General Method, a precursor structure may comprise at least one of the following: an elongated, thin, equiaxed, or hierarchical-equiaxed superstructure; an elongated superstructure with a length-to-diameter ratio greater than 200:1; an elongated superstructure with a length-to-diameter ratio between 50:1 and 200:1; a spheroidal or spherical superstructure; a hollow superstructure; a fragmentary superstructure comprising fragments of some other parent superstructure; a curved, fragmentary superstructure comprising fragments of a hollow superstructure.

In some variants of the General Method, a precursor structure may be precipitated around one or more other sacrificial structures, which may be present as inclusions in the precursor structure after its precipitation. In some variants, these inclusions in the precursor structure may be subsequently removed, resulting in voids.

In some variants of the General Method, a precursor structure may measure less than 1 m along its major axis. In some variants, the precursor may measure between 1 m and 100 m along its major axis. In some variants, the precursor may measure between 100 m and 1,000 m along its major axis.

In some variants of the General Method, the precursor material may comprise at least one of the following: a hydrate; a metal hydroxide; a metal bicarbonate or carbonate; a Group I or Group II metal bicarbonate or carbonate; a mixture of salts. In some variants, the precursor may comprise MgCO₃·xH₂O in the form of at least one of: a hexahydrate, lansfordite, nesquehonite, hydromagnesite, dypingite, magnesite, and a nanocrystalline or amorphous structure.

In some variants of the General Method, the stock solution may comprise at least one of the following: metal cations and oxyanions; an aqueous metal bicarbonate solution; a Group I or Group II metal bicarbonate; an organic salt; Mg(HCO₃)₂. In some variants, the stock solution may comprise at least one of a dissolved gas, acid, and base. In some variants, the stock solution may be metastable.

In some variants of the General Method, the process liquid conserved in the Precursor Stage may comprise a distillate. In some variants, the distillate may be formed by condensing the process liquid vapor formed during spray-drying or spray-pyrolysis. In some variants, a process liquid conserved in the Precursor Stage may host solvated ions, the process liquid and ions together comprising a mother liquor.

In some variants of the General Method, the treatment performed on a precursor material in the Template Stage may comprise at least one of the following: heating the precursor, decomposing the precursor; partially or locally decomposing the precursor; decomposing the precursor surface; thermally decomposing the precursor; and oxidizing an organic phase present within the precursor structure. In some variants, the treatment may comprise at least one of flash-drying, spray-drying, spray pyrolysis, vacuum drying, rapid heating, slow heating, and sublimation. In some variants, a vapor released during the treatment may be conserved. In some variants, the vapor released may comprise at least one of CO₂ and H₂O. In some variants, treatment may comprise at least one of: coarsening the grain structure of the precursor or a decomposition product of the precursor; exposing to a reactive vapor; exposing to water vapor; sintering; and sintering with the assistance of dopants.

In some variants of the General Method, a template material may comprise at least one of the following: a metal hydroxide, a metal sulfate, a metal carbonate, a metal nitrate, a metal oxide, a Group I or II metal oxide, a transition metal, and MgO. In some variants, a template structure may comprise at least one of the following: macropores, mesopores, hierarchical porosity, subunits larger than 100 nm, subunits between 20 nm and 100 nm, and subunits between 1 nm and 20 nm.

In some variants of the General Method, a template structure may comprise at least one of the following: an elongated, thin, equiaxed, or hierarchical-equiaxed superstructure; an elongated superstructure with a length-to-diameter ratio greater than 200:1; an elongated superstructure with a length-to-diameter ratio between 50:1 and 200:1; a spheroidal or spherical superstructure; a hollow superstructure; a fragmentary superstructure comprising fragments of some other parent superstructure; and a curved, fragmentary superstructure comprising fragments of a hollow superstructure.

In some variants of the General Method, adsorbing the perimorphic material to the templating surface may comprise at least one of the following: liquid-phase application of the adsorbate, aerosolization of the adsorbate, physical vapor deposition, chemical vapor deposition, application of a liquid-state adsorbate, and application of a solid-state adsorbate. In some variants, vapor deposition of the adsorbate may comprise pyrolytic decomposition of a vapor at a temperature between 350° C. and 950° C.

In some variants, the adsorbate may comprise at least one of: an organic compound, a hydrocarbon compound, an organosilicon compound, an organometallic compound, a metalorganic compound, an organoboron compound, an organic nitrogen compound, a preceramic compound, a polymer, a graphenic network, a synthetic anthracitic network, an sp^{x} network, a helicoidal network, a carbonaceous material, an x-carbon, a z-carbon, a boron nitride, a boron carbonitride, an electrical conductor, an electrical insulator, and an electrical semiconductor. In some variants, the preceramic compound may comprise a silicon-bearing molecule, which may include at least one of polysiloxane, polysilsesquioxane, polycarbosiloxane, polycarbosilane, polysilylcarbodiimide, polysilsesquicarbodiimide, polysilsesquiazane, polysilazane, and metal-containing variants of these molecules, as well as others.

In some variants, the adsorbate may be altered after adsorption to the templating surface by at least one of the following processes: crystallization, sintering, grain growth, coalescence, decomposition, pyrolysis, polymerization, chemical functionalization, molecular grafting, chemical etching, activation, passivation, orbital rehybridization, maturation, and formation of a helicoidal network.

In some variants, the PC structure formed by adsorption of the adsorbate may comprise at least one of a single perimorphic phase, two or more distinct perimorphic phases, and two or more perimorphic phases arranged in distinct perimorphic strata. In some variants, the distinct strata may be applied via multiple, sequential surface replication procedures occurring prior to or following endomorphic extraction. In some variants, a perimorphic stratum may be sandwiched between two z-adjacent strata.

In some variants of the General Method, endomorphic extraction may utilize an extractant solution comprising a weak acid as an extractant. In some variants, an extractant solution may be formed by dissolving a process gas in process water. In some variants, the extractant solution may be an aqueous solution of H₂CO₃ formed by dissolving liquid or gaseous CO₂ in process water. In some variants, endomorphic extraction may comprise a shuttling technique. In some variants, endomorphic extraction may be performed under conditions of elevated pressure or temperature.

In some variants of the General Method, the perimorphic separation may comprise at least one of decantation, hydrocyclones, settling, sedimentation, flotation, froth flotation, centrifugal separation, filtration, and liquid-liquid extraction. In some variants, the perimorphic separation may separate the perimorphic product from substantially all of the process liquid. In some variants, the perimorphic product may retain a residual portion of the process liquid. In some variants, the perimorphic product may be naturally buoyant due to its retention of internal gas. In some variants, the perimorphic product's internal gas may be expanded by reducing pressure of the surrounding process liquid, increasing the buoyancy of the perimorphic product and causing flotation. In some variants, a portion of the perimorphic product's internal gas may be exfiltrated by reducing pressure of the surrounding process liquid, followed by re-pressurizing the surround process liquid, such that hydrostatic pressure causes the process liquid to infiltrate the perimorphic product.

In some variants of the General Method, the stock solution generated by endomorphic extraction may be concentrated by dissolving additional solute(s) in the stock solution. In some variants, an additional solute may comprise at least one of a solid precipitated from stock solution and a process gas. In some variants, dissolution of the additional solute(s) in the stock solution may be dissolved by changing the temperature or pressure of the stock solution. In some variants, a concentrated aqueous Mg(HCO₃)₂ stock solution may be formed by precipitating a dilute stock solution to form an MgCO₃

In some variants of the General Method, the perimorphic product may comprise a perimorphic framework. In some variants, the morphology of the perimorphic framework may comprise at least one of a native morphology, a non-native morphology, a crumpled morphology, a hollow morphology, a hierarchical morphology, macropores, mesopores, micropores, a spheroidal superstructural geometry, a prismatic superstructural geometry, a shell, a shell fragment, a noncellular space, and a labyrinthine pore structure.

In some variants, the perimorphic framework may comprise at least one of a hydrophobic material, a hydrophilic material, an amphiphilic material, and a Janus material comprising hydrophobic and hydrophilic surfaces. In some variants, the perimorphic framework may comprise at least one of a flexible, rigid, and elastic. In some variants, the perimorphic framework may contain an internal gas and may float when immersed in a liquid.

In some variants, the major axis of the perimorphic framework may measure at least one of less than 1 m, between 1 m and 100 m, and between 100 m and 1,000 m. In some variants, the framework may comprise a BET surface area of at least one of 1,500 to 3,000 m²/g and between 10 to 1,500 m²/g. In some variants, the framework may comprise an elongated, thin, or equiaxed superstructure. In some variants, an elongated framework may comprise a length-to-diameter ratio between 50:1 and 200:1.

In some variants of the General Method, the perimorphic framework may comprise a carbonaceous phase comprising at least one of a carbonaceous material, a pyrolytic carbon, a graphenic network of carbon, n anthracitic network of carbon, an sp^{x} network of carbon, and a helicoidal network of carbon, an x-carbon, and a z-carbon. In some variants, the perimorphic framework may comprise functional groups including at least one of a carbon atom, an oxygen atom, a halogen atom, a metal atom, a boron atom, a sulfur atom, a phosphorus atom, and a nitrogen atom.

In some variants of the General Method, under 532 nm excitation, a carbonaceous phase of a perimorphic framework may comprise at least one of a Raman spectral I_{D}/I_{G} ratio of between 4.0 and 1.5; a Raman spectral I_{D}/I_{G} ratio between 1.5 and 1.0; a Raman spectral I_{D}/I_{G} ratio between 1.0 and 0.1; a Raman spectral I_{Tr}/I_{G} ratio between 0.0 and 0.1; a Raman spectral I_{Tr}/I_{G} ratio between 0.1 and 0.5; a Raman spectral I_{Tr}/I_{G} ratio between 0.5 and 1.0; a Raman spectral I_{2D}/I_{G} ratio between 0 and 0.15; a Raman spectral I_{2D}/I_{G} ratio between 0.15 and 0.3; and a Raman spectral I_{2D}/I_{G} ratio between 0.30 and 2.0.

In some variants of the General Method, under 532 nm excitation, a carbonaceous phase of a perimorphic framework may comprise at least one of an unfitted Raman spectral D peak positioned between 1345 and 1375 cm⁻¹; an unfitted Raman spectral D peak positioned between 1332 and 1345 cm⁻¹; an unfitted Raman spectral D peak positioned between 1300 and 1332 cm⁻¹; an unfitted Raman spectral G peak positioned between 1520 cm⁻¹ and 1585 cm⁻¹; an unfitted Raman spectral G peak positioned between 1585 cm⁻¹ and 1600 cm⁻¹; and an unfitted Raman spectral G peak positioned between 1600 cm⁻¹ and 1615 cm⁻¹.

In some variants of the General Method, the perimorphic framework may comprise a non-carbonaceous phase comprising a ceramic. In some variants, the ceramic phase may comprise at least one of: one or more post-transition metals, one or more metalloids, one or more reactive nonmetals, and a decomposition product of one or more preceramics. In some variants, the ceramic phase may comprise at least one of the following: silicon oxycarbide (Si—O—C), silicon carbide (Si—C), silicon nitride (Si—N), silicon boride (Si—B), silicon carbonitride (Si—C—N), and silicon boron carbonitride (Si—B—C—N), as well as metal-modified and various stoichiometric compositions of these.

In some variants, the ceramic phase of a perimorphic framework may comprise a nanostructured BN phase comprising at least one of sp²-hybridized states, sp³-hybridized states, a mixture of sp²- and sp³-hybridized states, a layered architecture, and structural dislocations that provide internal crosslinking between layers. In some variants, the BN phase of a perimorphic framework may comprise a synthetic anthracitic network, an sp^{x} network, and a helicoidal network.

In some variants, the substantially sp²-hybridized BN phase of a perimorphic framework may comprise one or more atomic monolayers. In some variants, two or more atomic BN monolayers may exhibit nematic alignment. In some variants, the BN phase, under 532 nm excitation, may comprise a single broad, unfitted Raman spectral band between 500 and 2500 cm⁻¹. In some variants, the peak position of this band may be located between in at least one of the following ranges: 1300 cm⁻¹ to 1400 cm⁻¹, 1400 cm⁻¹ to 1500 cm⁻¹, and 1500 cm⁻¹ to 1600 cm⁻¹.

In some variants, the ceramic phase of a perimorphic framework may comprise a nanostructured BCₓN phase comprising at least one of sp²-hybridized states, sp³-hybridized states, a mixture of sp²- and sp³-hybridized states, a layered architecture, and structural dislocations that provide internal crosslinking between layers. In some variants, the BCₓN phase of a perimorphic framework may comprise a synthetic anthracitic network, an sp^{x} network, and a helicoidal network. In some cases, the BCₓN phase of a perimorphic framework may comprise an engineerable electronic bandgap based on its fractional composition of carbon.

In some variants, the substantially sp²-hybridized BCₓN phase may comprise one or more atomic monolayers. In some variants, two or more atomic BCₓN monolayers may exhibit nematic alignment. In some variants, the BCₓN phase, under 532 nm excitation, may comprise at least one of a G peak positioned between 1500 cm⁻¹ and 1650 cm⁻¹, a broad, unfitted Raman spectral band between 500 cm⁻¹ and 2500 cm⁻¹, a G peak associated with sp² carbon and an underlying broad band associated with BN, and a substantially absent D peak associated with sp² carbon rings.

In some variants, the nanostructured ceramic phase may comprise at least one of the following monoelemental atomic monolayers: borophene, silicene, germanene, stanene, phospherene, arsenene, antimonene, bismuthene, and tellurene. In some variants, the nanostructured ceramic phase may comprise substantially two-dimensional transition metal dischalcogenides.

In some variants, the nanostructured ceramic phase may comprise a metal oxide, or the oxide of a metalloid or reactive nonmetal. In some variants, the metal oxide may comprise a layered transition metal oxide. In some variants, the metal oxide may comprise a mixed metal oxide. In some variants, the metal oxide may comprise at least one of a catalyst and a photocatalyst.

In some variants, the perimorphic wall may comprise a nanostructured metallic phase. In some variants, the nanostructured metallic phase may comprise at least one of a Group I metal, a Group II metal, a transition metal, a transition metal alloy, Ni, Ni—Mo, a reduced decomposition product of a metallocene, an electroless coating, and a catalyst.

In some variants, the perimorphic wall may comprise two or more nanostructured phases. In some variants, the two or more phases may comprise distinct perimorphic strata. In some variants, electrically insulating, conducting, or semiconducting perimorphic strata may be alternated. In some variants, a perimorphic stratum may be sandwiched between two other perimorphic strata to shield it. In some variants, a carbonaceous perimorphic stratum may be shielded from thermal oxidation by one or more other perimorphic strata.

In some variants of the General Method, the perimorphic product may be subjected to further treatment after perimorphic separation. In some variants, the further treatment after perimorphic separation may comprise at least one of flash-drying, spray-drying, spray-pyrolysis, decomposition, chemical reaction, annealing, sintering, and chemical functionalization.

In some variants of the General Method, the Liquid Cycle may also incorporate the recapture and conservation of process liquid released or evaporated during the Template Stage, although this is not reflected as an output in FIG. 3. It is not reflected because in most (but not all) of the variants of the General Method envisioned, the quantity of process liquid conserved during the Template Stage would be significantly smaller than the quantity of process liquid conserved in the Precursor Stage.

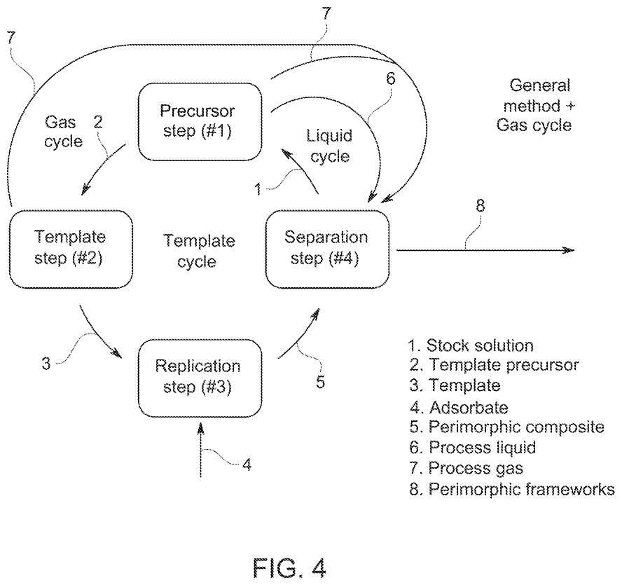

In some variants of the General Method, a Gas Cycle may be incorporated into the method. The inputs and outputs of the General Method with a Gas Cycle are illustrated in FIG. 4. In a Gas Cycle, a process gas is released during the Precursor Stage and/or the Template Stage. This released gas is conserved. Then, during the Separation Stage, the conserved process gas may be dissolved into conserved process liquid in order to generate an extractant solution.

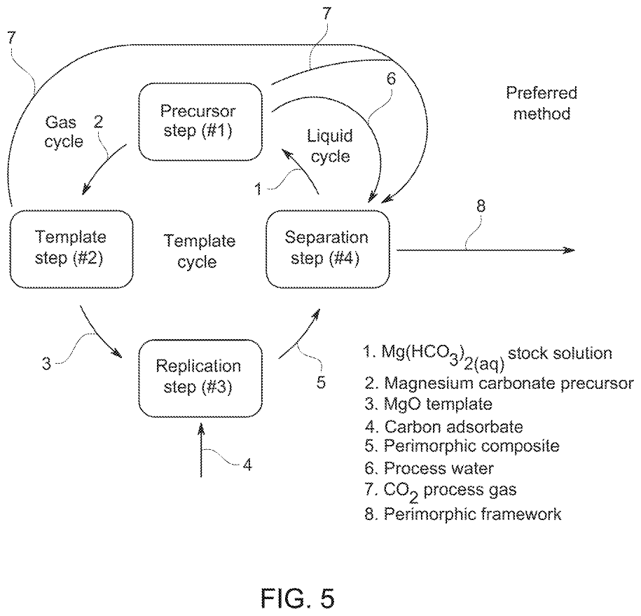

The Preferred Method, described below, comprises variants of the General Method in which a MgCO₃·xH₂O template precursor material is derived from an aqueous Mg(HCO₃)₂ stock solution and a portion of the CO₂ process gas is conserved via a Gas Cycle. The inputs and outputs of the Preferred Method are shown in FIG. 5. The Preferred Method comprises:
Precursor Stage: MgCO₃·xH₂O precursor material is derived from an aqueous Mg(HCO₃)₂ stock solution, wherein the derivation comprises a solventless precipitation of MgCO₃·xH₂O and an emission of CO₂ process gas. A portion of released CO₂ process gas is conserved. The MgCO₃·xH₂O precursor material and process water are separated. Process water is conserved.
Template Stage: The MgCO₃·xH₂O precursor material formed in the Precursor Stage is thermally decomposed in one or more procedures to form a porous MgO template material. Released CO₂ process gas may be conserved.
Replication Stage: A perimorphic material is adsorbed to the templating surface of the porous MgO template to form a PC material.
Separation Stage: Conserved CO₂ process gas is dissolved into conserved process water to form an aqueous H₂CO₃ extractant solution. Endomorphic extraction comprises a reaction between endomorphic MgO and the aqueous H₂CO₃ extractant solution, from which an Mg(HCO₃)₂ stock solution is derived. Perimorphic separation may comprise techniques that displace process water from the perimorphic product, minimizing residual process water. Froth flotation, liquid-liquid separation, or other techniques that separate the perimorphic framework from the process water may be used.

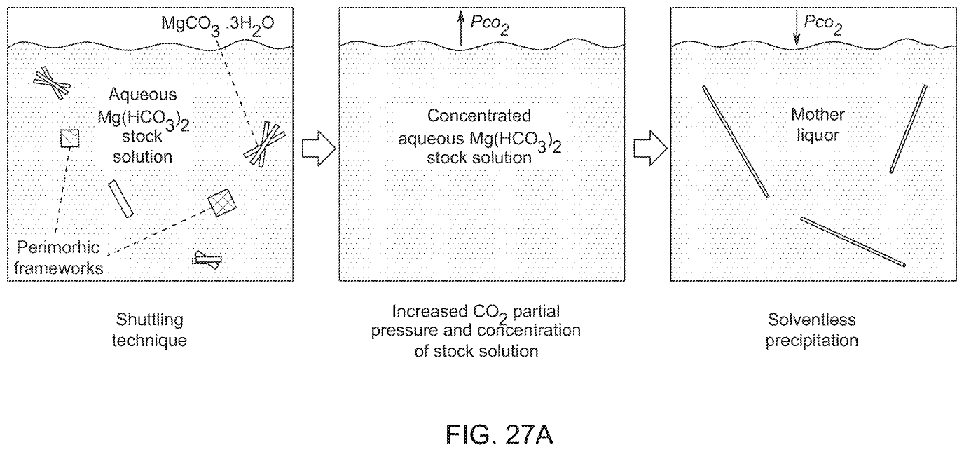

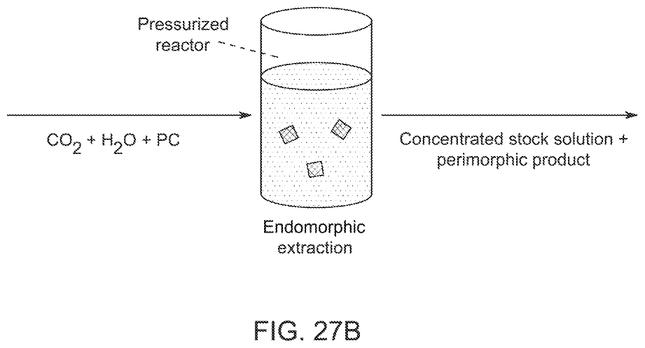

Certain variants of the Preferred Method may employ pressure modulations in order to form concentrated stock solutions and improve precipitation processes. Concentrated stock solutions may be associated with many benefits, including superior precipitation kinetics, reduced process water volumes, smaller vessels, and improved energy efficiency. Two exemplary ways that this can be done are illustrated in FIG. 27A-27B and described below.

In the first frame of FIG. 27A, a shuttling technique has been used to obtain endomorphic extraction. The shuttling technique results in a mixture comprising aqueous Mg(HCO₃)₂ stock solution, perimorphic framework(s), and the MgCO₃·xH₂O precipitate. This precipitate is represented in the first frame of FIG. 27A as a mixture of nesquehonite rods and acicular nesquehonite agglomerates. Next, the perimorphic product is separated from the other process liquids and solids. Following this, the MgCO₃·xH₂O precipitate is dissolved by increasing the CO₂ pressure, which increases the concentration of dissolved CO₂, H₂CO₃ and HCO₃⁻, forming a concentrated stock solution, as shown in the second frame of FIG. 27A. Finally, as shown in the third frame, the MgCO₃·xH₂O precursor may be rapidly nucleated and precipitated from the concentrated stock solution by reducing the CO₂ pressure (and optionally the total pressure).

Another way that a concentrated stock solution may be obtained is by performing the endomorphic extraction in a pressurized reactor. A schematic showing this is illustrated in FIG. 27B. Similar to the procedure illustrated in FIG. 27A, the procedure illustrated in FIG. 27B employs increased CO₂ pressure to increase the concentration of dissolved CO₂, H₂CO₃ and HCO₃⁻. In FIG. 27B, PC material, CO₂, and H₂O (possibly an aqueous Mg(HCO₃)₂ mother liquor) are fed into a pressurized reactor. Endomorphic extraction and the formation of a concentrated stock solution occur within the pressurized reactor. The mixture of the perimorphic product and concentrated stock solution is discharged from the pressurized reactor, where perimorphic separation can then occur. Separation may be beneficially accomplished using a liquid-liquid separation that eliminates rinsing requirements. The MgCO₃·xH₂O precursor may be rapidly nucleated and precipitated from the concentrated stock solution by reducing the CO₂ pressure (and optionally the total pressure).

### III. Furnace Schemes, Analytical Techniques and Material Naming

In the course of describing procedures to generate the exemplary materials described in the subsequent sections, certain furnace schemes have been detailed. These schemes may be used for the exemplary Template Stage procedures detailed in Section V and for the exemplary Replication Stage procedures detailed in Section VI.

Scheme A: In Scheme A, a Thermcraft tube furnace modified to be a rotary furnace may be employed with a quartz tube. The furnace has a clam shell design with a cylindrical heating chamber of 160 mm diameter and 610 mm heated length. The furnace has a wattage of 6800 W with a maximum operating temperature of 1100° C. The quartz tube may be a 60 mm OD quartz tube containing an expanded middle section of 130 mm OD tube (the “belly”) positioned within the furnace's heating zone. The tube may be rotated. Quartz baffles inside the belly may facilitate agitation of the a powder sample during rotation. The furnace may be kept level (i.e. not tilted). The template powder sample may be placed inside the belly in the heating zone, with ceramic blocks inserted outside the belly on each side of the furnace's heating zone. Glass wool may be used to fix the position of the ceramic blocks.

For exemplary procedures performed using Scheme A, a material sample may be placed inside the belly, such that it agitated within the reactor. Loose fitting ceramic blocks located outside the belly section on each side of the furnace's heating zone allowing for gas flow and powder containment. Packed glass wool may be used to affix the position of the ceramic blocks while acting as a gas permeable layer. The ends of the tube may be fitted with two stainless-steel flanges to allow for gas to flow for the system.

Scheme B: An MTI rotary tube furnace with a quartz tube may be used. The furnace has a clam shell design with a cylindrical heated chamber having dimensions of 120 mm diameter and 440 mm heated length. The furnace has a wattage of 2500W with a maximum operating temperature of 1150° C. The quartz tube may be 60 mm in OD. The tube may be substantially level. For exemplary procedures performed using Scheme B, a material sample may be placed within a ceramic boat. This may then be placed inside the quartz tube within the heating zone prior to the initialization of heating. Loose fitting ceramic blocks located outside the furnace's heating zone allow for gas flow. Packed glass wool may be used to affix the position of the ceramic blocks while acting as a gas permeable layer. The ends of the tube may be fitted with two stainless-steel flanges. If ammonia borane (H₃NBH₃) is used, the solid H₃NBH₃ may be placed in a ceramic boat just outside the upstream side of the furnace heating zone, enabling it to reach a temperature between 130° C. and 170° C. when the furnace reaches the set temperature.

Scheme C: A Lindberg Blue-M tube furnace with a quartz tube may be used. The quartz tube may be 150 mm in OD. The furnace has a clam shell design with a cylindrical heated chamber having dimensions of 190 mm diameter and 890 mm heated length. The furnace has a wattage of 11,200 W with a maximum operating temperature of 1200° C. The tube may be substantially level. For exemplary procedures performed using Scheme C, a sample may be placed within a ceramic boat. This may then be placed inside the quartz tube within the heating zone prior to the initialization of heating. Loose fitting ceramic blocks located outside the furnace's heating zone allow for gas flow. The ends of the tube may be fitted with two aluminum flanges to allow for gas flow through the system.

Scheme D: A Vulcan 3-550 Muffle furnace may be used. The furnace has a rectangular heated chamber having dimensions of 190 mm×240 mm×228 mm. The furnace has a wattage of 1440W with a maximum operating temperature of 1100° C. For exemplary procedures performed using Scheme D, a material sample may be placed within a ceramic boat. This may then be placed inside the muffle furnace prior to the initialization of heating.

Scheme E: A TA Instruments Q600 TGA/DSC may be used. For exemplary procedures performed using Scheme E, a 90 μL alumina pan may be used to hold a material sample. Gas flow may be 100 sccm of a specified gas unless otherwise noted. The heating rate may be mentioned in the exemplary procedures where Scheme E is used.

A number of analytical techniques were utilized to characterize the procedures and materials presented herein. These are detailed below.

Solution concentrations were measured using electrolytic conductivity (“conductivity”). The conductivity is a measured response of a solution's electrical conductance. The electrical response of a solution may be correlated to the concentration of ions dissolved in the solution, and as ions in solution are precipitated, the conductivity value decreases. An analog to this measurement is total dissolved solids (“TDS”) which relates the conductivity measurement to a referenced ion concentration (typically potassium chloride), dependent on the salt compound dissolved.

Raman spectroscopy was performed using a ThermoFisher DXR Raman microscope equipped with a 532 nm excitation laser. For each sample analyzed, 16 point spectra were generated using measurements taken over a 4×4 point rectangular grid with point-to-point intervals of 5 m. The 16 point spectra were then averaged to create an average spectrum. The Raman peak intensity ratios and Raman peak positions reported for each sample all derive from the sample's average spectrum. No profile fitting software was utilized, so the reported peak intensity ratios and peak positions relate to the unfitted peaks pertaining to the overall Raman profile.

Gas adsorption measurements were made using a Micromeritics Tristar II Plus. Nitrogen adsorption was measured at a temperature of 77 K across a range of pressure (p) values, where

$$0.005 < \frac{p}{{p}^{0}} < 0.30 .$$

Increments of pressure ranged from

$$\frac{p}{{p}^{0}} = 0.009$$

up to

$$\frac{p}{{p}^{0}} = 0.05 .$$

Micromentics MicroActive software was used to calculate the BET specific surface area derived from the BET monolayer capacity assuming the cross-sectional area σₘ(N₂, 77 K)=0.162 nm². Samples were preconditioned by degassing with continuously flowing dry nitrogen gas at 100° C. prior to analysis.

The pore size distribution (PSD) and cumulative volume of pores is another technique that may be performed from gas adsorption data to lend insight into the sintering behavior of particles. The data was collected by a Micromeritics Tristar II Plus, measuring nitrogen adsorption and desorption at 77 K between pressures of

$$0.009 < \frac{p}{{p}^{0}} < 0.99 ,$$

with increments ranging from

$$\frac{p}{{p}^{0}} = 0.009$$

up to

$$\frac{p}{{p}^{0}} = 0.05 .$$

Samples were preconditioned by degassing with continuously flowing dry nitrogen gas at 100° C. prior to analysis.

Micromeritics MicroActive software was used to calculate adsorption-desorption PSD and cumulative volume of pores by applying the Barrett, Joyner and Halenda (BJH) method. This method provides a comparative assessment of mesopore size distributions for gas adsorption data. For all BJH data, the Faas correction and Harkins and Jura thickness curve may be applied. The cumulative volume of pores, V_{PORE} (cm³/g), may be measured for both adsorption and desorption portions of the isotherm.

There are a number of exemplary materials described in the present disclosure. To aid in identification and tracking of these exemplary materials, a material naming system has been adopted and is described below. All names of exemplary materials are bolded; N₂ herein describes an exemplary material, while N₂ refers to nitrogen gas.

Exemplary types of template precursor materials are denoted Sₓ, where S designates the first one or two letters of the template precursor (i.e. N for nesquehonite, L for lansfordite, Li for lithium carbonate, C for magnesium citrate, A for amorphous MgCO₃·xH₂O, H for hydromagnesite, M for magnesite, E for epsomite, and Ca for calcium carbonate) and where x designates different types of the precursor compound (e.g. H₁ and H₂ designate two different types of hydromagnesite precursors).

Exemplary types of template materials are named in the format SₓT_{y}. The Sₓ name component designates the precursor type that was utilized to create the template type SₓT_{y}, and the T_{y} name component designates a specific treatment that was utilized to create the template type SₓT_{y}. For example, N₁T₁ and N₁T₂ indicate two different template types formed from two different treatments on the precursor type N₁. We note that while the full SₓT_{y} name denotes a specific template type, the T_{y} name component by itself is only specific with respect to a given Sₓ precursor type. For example, the treatments utilized to make the template types N₁T₁ and N₂T₁ were different, despite these template types sharing the same T₁ name component.

Exemplary types of PC materials are named in the format SₓT_{y}P_{z}, where the SₓT_{y} name component designates the template type and the P_{z} name component designates a specific type of perimorphic material. For example, M₃T₁P₁ and M₃T₁P₂ indicate two different PC materials formed from the same M₃T₁ template material. The P_{z} name component within the SₓT_{y}P_{z} name is unique—i.e. each P_{z} name component specifies a unique type of perimorphic material, irrespective of the SₓT_{y} template type utilized to make the perimorph.

Exemplary types of perimorphic frameworks (i.e. the porous perimorphic product resulting from endomorphic extraction) are named in the format P_{z}, where the P_{z} name component is not prefaced with an SₓT_{y} template type. The P_{z} name component utilized by itself to designate a framework type matches the P_{z} name component of the SₓT_{y}P_{z} PC material from which the framework type was derived.

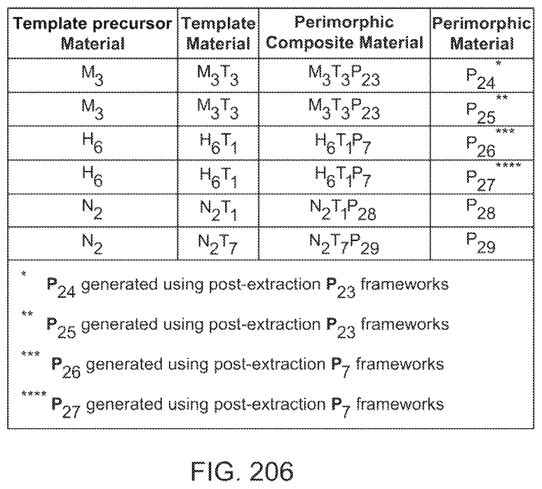

The exemplary types of template precursor materials, template materials, PC materials, and perimorphic materials in this disclosure are enumerated in FIG. 206. FIG. 206 is arranged to show the progression of the materials synthesized, starting from the template precursor material.

### IV. Perimorphic Framework Examples

This section details the generation of exemplary perimorphic materials at small scales using exemplary procedures. A full implementation of the General Method is not described in connection with every exemplary procedure, although such an implementation would be possible with every exemplary procedure. Additionally, it should be understood that many techniques or materials utilized in these exemplary procedures are merely intended to demonstrate the effects or properties of techniques or materials that might be utilized in larger-scale industrial implementations.

The '49195 Application teaches the synthesis of a number of exemplary types of template precursor materials, template materials, PC materials, and perimorphic frameworks. Taken together, these materials demonstrate the breadth of carbonaceous perimorphic products that can be synthesized, as well as the breadth of template precursor materials and template materials that may be utilized. In this section, we demonstrate how the General Method can also be used to create stratified perimorphic frameworks and perimorphic frameworks that are not strictly carbonaceous. The procedures and materials presented in this section are meant to be exemplary, since a wide variety of procedures and materials may be readily envisioned and used without deviating from the invention. The types of perimorphic materials synthesized in the below examples are summarized in FIG. 206.

Examples P₂₄, P₂₅: In two exemplary procedures, a stratified perimorphic material (P₂₄) and a silica-like perimorphic material (P₂₅) may be synthesized, depending on the choice of atmosphere during a final thermal treatment performed after surface replication.

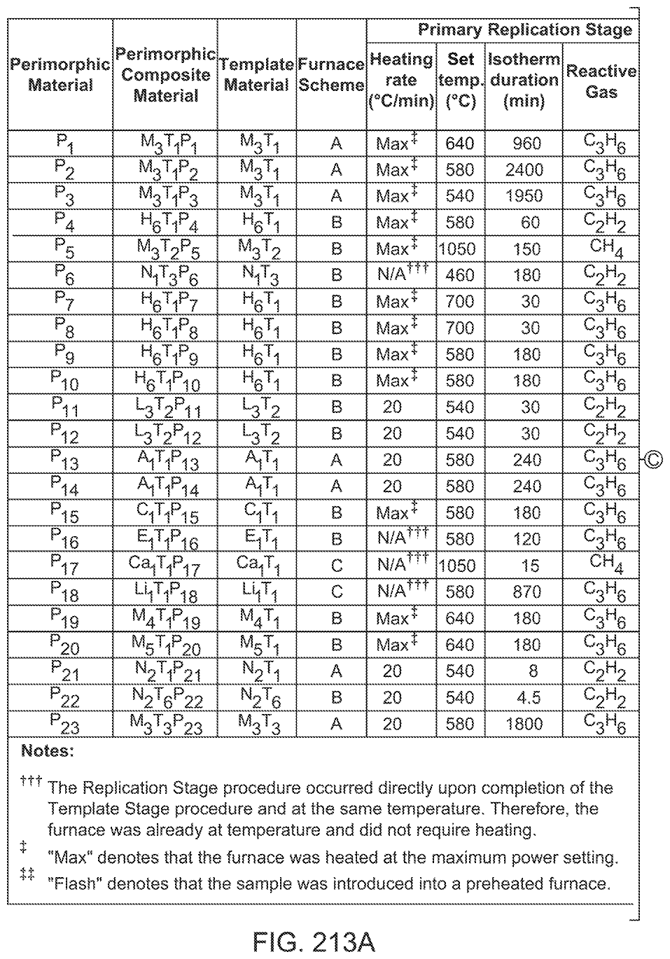

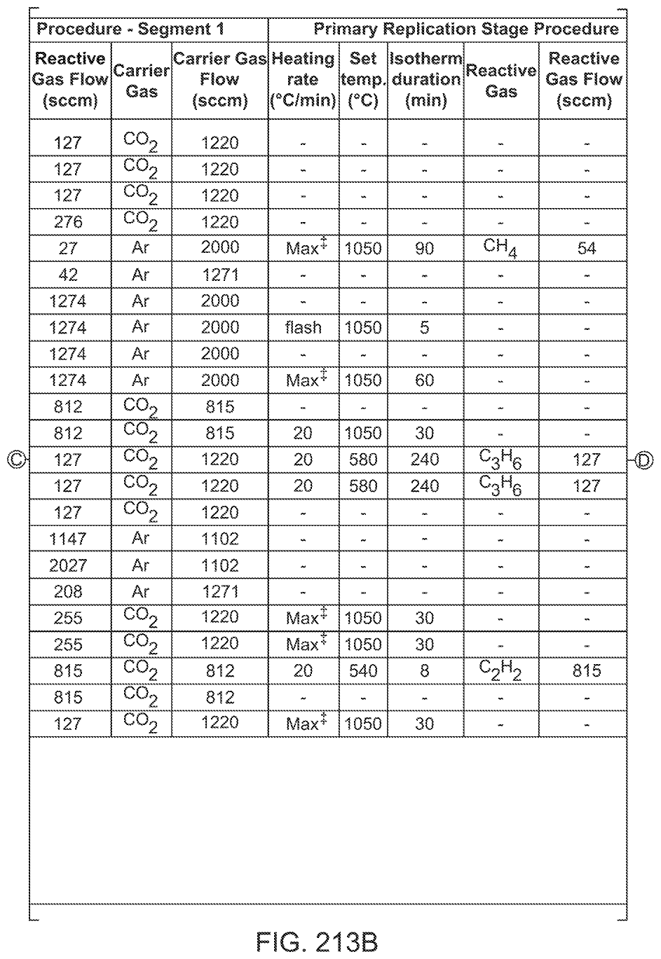

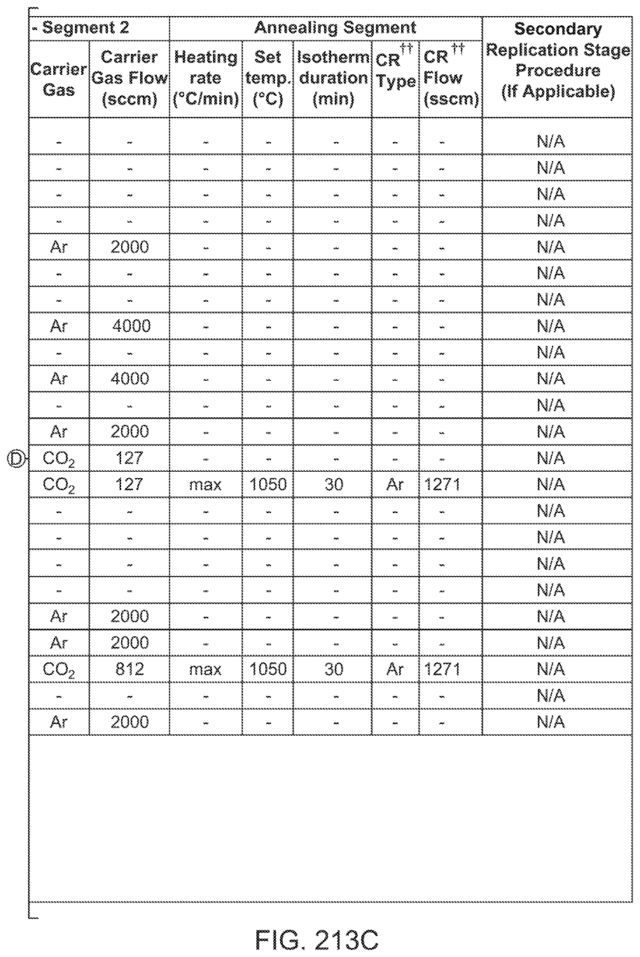

For the purpose of demonstration, a P₂₃-type carbonaceous perimorphic material may first be synthesized via surface replication on porous, ex-magnesite MgO template structures in a way consistent with the General Method (and the Preferred Method). This Precursor Stage and Template Stage procedures are described in the '49195 Application and Reference A, and the surface replication parameters may be found in FIG. 213. The P₂₃-type carbonaceous perimorphic frameworks comprise synthetic anthracitic networks comprising helicoidal networks; this helicoidal network classification is based on their synthesis including exposure of sp^{x} precursor networks to temperatures (>1000° C.) at which maturation occurs. As described in the '37435 Application, helicoidal networks are formed by maturation of sp^{x} precursor networks.

Next, the P₂₃-type carbon may be chemically functionalized. To do this, an aqueous paste containing a P₂₃-type carbon content of approximately 13% by weight may be made. A 144 g quantity of the paste, containing approximately 18.7 g of carbon, may be added to 500 g deionized water in a beaker and stirred using an overhead Cowles blade mixer to suspend the carbon. This mixture may then be transferred from the beaker into the reservoir of a high-shear rotor-stator homogenization processor (IKA Magic Lab, or “ML”). The mixture in the reservoir may be mixed using an overhead Cowles blade mixer to keep the particles adequately suspended in the reservoir. Residuals in the beaker may be rinsed with 50 g deionized water, and the residuals and rinsate may be added to the ML reservoir. The external thermal control system on the ML may be used to maintain the mixture at a temperature of 5° C., and the rotor-stator speed may be set to 15,000 RPM. Using these settings, the mixture may be circulated for 30 minutes, maintaining the mixture temperature at 5° C. The mixture may have a pH of approximately 10. At this point, 2.5 g of aqueous HCl may be added over 15 seconds. Then, 15.5 g of aqueous NaOCl (14.5% concentration) may be added over 15 seconds. The mixture may have a pH of approximately 2.35. The mixture may be run for an additional 15 minutes at a temperature of 5° C. At this point, 2 g of aqueous H₂O₂ (35% concentration) may be added. Next, the mixture may be removed from the ML. Residuals in the ML may be rinsed with deionized water, and the residuals and rinsate may be added to the mixture. The mixture may then be filtered, rinsed with deionized water, then rinsed with ethanol, resulting in an ethanol paste of oxidized carbon perimorphic material.

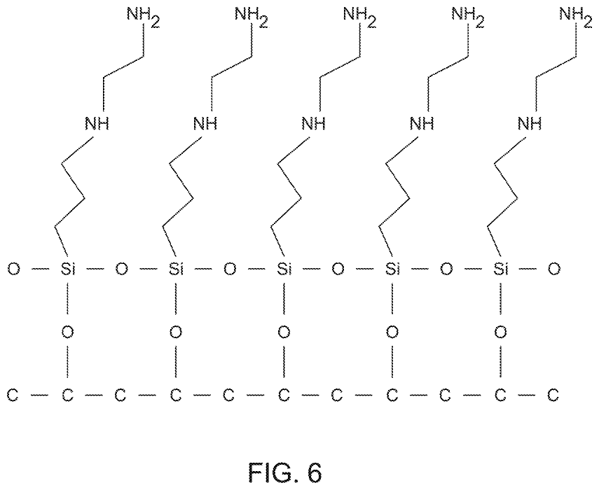

Next, a 92 g quantity of the ethanol paste containing a carbon content of approximately 15.9 g may be diluted with 400 g of ethanol in a beaker and stirred using an overhead Cowles blade mixer to suspend the carbon. This mixture may then be transferred from the beaker into the ML reservoir. The mixture in the reservoir may be mixed using an overhead Cowles blade mixer to keep the particles adequately suspended in the reservoir. The rotor-stator speed may be set to 15,000 RPM and the mixture may be allowed to remain at approximately room temperature. A 15.8 g quantity of 3-[2-(2-aminoethyl)amino]propyl trimethoxysilane (AEAPTMS) may be added to the reservoir over 1 minute. This may be followed by the addition of 95 g of deionized water and 1.6 g of NaOH, bringing the pH to approximately 10.6. The mixture may be circulated for 30 min, then removed from the ML and transferred to a beaker. Residuals in the ML may be rinsed with 100 g deionized water, then 50 g of ethanol, and the residuals and rinsate may be added to the mixture. The beaker may be magnetically stirred and heated for the next 150 minutes, its temperature ranging from approximately 78° C. to 93° C. During this time, the inner sides of the beaker may be rinsed twice, using 50 g of deionized water each time and raising the mixture's boiling point. At this point, the heating may be turned off. The mixture may then be filtered and rinsed with ethanol, resulting in an ethanol paste. The paste may be dried at 60° C. to form a powder, the frameworks comprising AEAPTMS-functionalized carbon. FIG. 6 is a diagram illustrating the attachment of AEAPTMS molecules to a carbon surface.

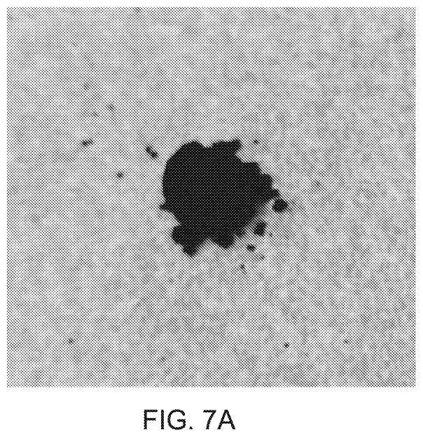

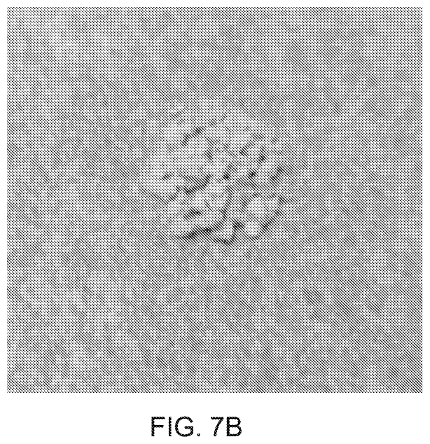

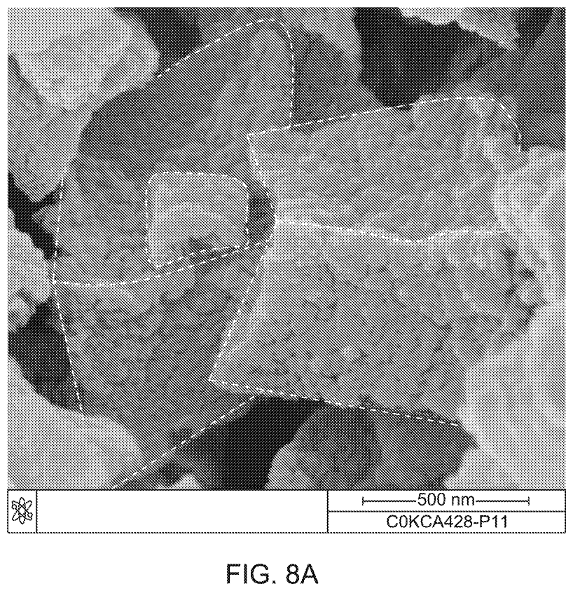

Next, the powder of AEAPTMS-functionalized carbon may be subjected to a post-replication thermal treatment. In both Example P₂₄ and Example P₂₅, the treatment may be performed in a TGA instrument, as described in Furnace Scheme E detailed in Section III. In Example P₂₄, the treatment may be performed under flowing Ar, while in Example P₂₅ the treatment may be performed under flowing air. In each treatment, the powder sample may be heated from room temperature to a final temperature of 900° C. at a heating rate of 20° C./min. Upon reaching 900° C., the sample may be cooled back down to room temperature. The oxidizing atmosphere of the thermal treatment utilized in Example P₂₅ causes the carbon perimorphic stratum and the organic phase of the polysiloxane to be completely oxidized, resulting in a silica-like perimorphic material, which is the brownish-white powder shown in FIG. 7B. On the other hand, the inert atmosphere of the thermal treatment utilized in Example P₂₄ preserves the carbon perimorphic stratum and results in SiOₓC_{y} strata, arranged in a BAB stratigraphic arrangement where the A stratum is carbon and the B strata comprise SiOₓC_{y}. The resulting stratified perimorphic material is the black powder shown in FIG. 7A.

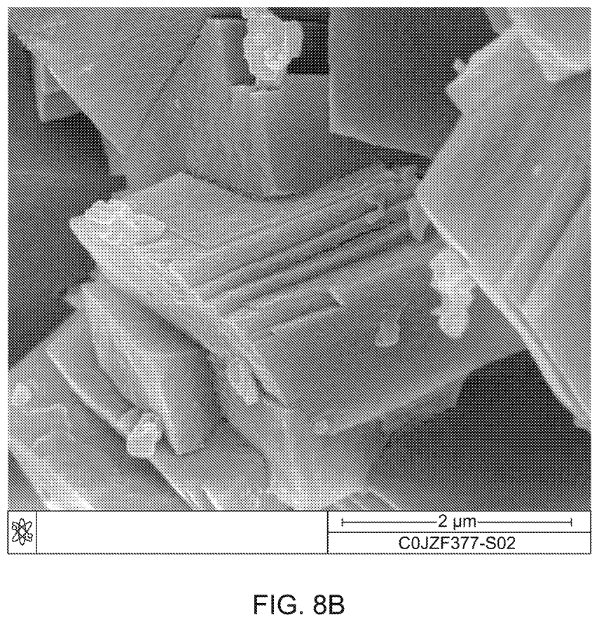

An SEM micrograph of silica-like P₂₅-type frameworks are shown in FIG. 8A. While deformation of the native superstructural geometry has occurred upon eliminating the underlying carbon stratum, the superstructures of the silica-like frameworks still resemble the superstructures of the template precursor particles (FIG. 8B). The corners and edges of the native prisms can still be discerned, as indicated by the dashed lines in FIG. 8A.

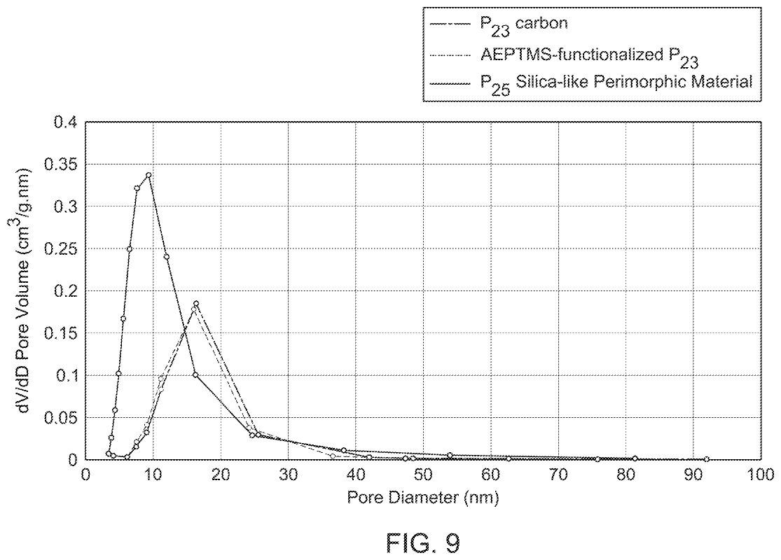

N₂ desorption analysis shows that the silica-like P₂₅-type frameworks possess a non-native cellular substructure. In FIG. 9, the BJH pore size distributions of the P₂₃-type perimorphic carbon, the AEAPTMS-functionalized P₂₃-type perimorphic carbon, and the silica-like P₂₅-type perimorphic material are shown. All three materials possess a cellular substructure of N₂-accessible mesopores. Comparison of the three pore size distributions shows that the cellular substructures of the P₂₃-type frameworks and the AEAPTMS-functionalized frameworks are similar, but the cellular substructure of the silica-like P₂₅-type frameworks comprises smaller mesopores. This densification explains the somewhat shrunken, deformed superstructural geometry observed in the silica-like frameworks in FIG. 8A.

The N₂ adsorption analysis also reveals that the silica-like frameworks have an average surface area of 1273 m²/g. This is a considerably higher than the P₂₃-type carbon frameworks' average surface area of 461 m²/g and the AEAPTMS-functionalized frameworks' average surface area of 463 m²/g. This reflects the elimination of the carbonaceous perimorphic stratum in Example P₂₅, in which an oxidizing thermal treatment was employed. The silica-like perimorphic stratum remaining after the thermal treatment is thinner than the eliminated carbon stratum.

Similar procedures may be used to create stratified or silica-like perimorphic frameworks with other engineered features. Other exemplary templates and procedures described in References A and B may be readily utilized in concert with the approach described in Example P₂₄ and Example P₂₅. Also, similar procedures may be used to obtain stratigraphic encapsulation of a perimorphic material. One way of obtaining this result is to form a preceramic stratum such as an inorganic polymer on an existing perimorphic stratum, to pyrolyze the preceramic stratum in order to form a ceramic stratum, and then to sinter or melt the ceramic stratum, such that a continuous ceramic phase is formed around the underlying perimorphic material. Stratigraphic encapsulation may be used, for example, to shield a carbonaceous perimorphic framework from oxidation in high-temperature oxidizing environments.

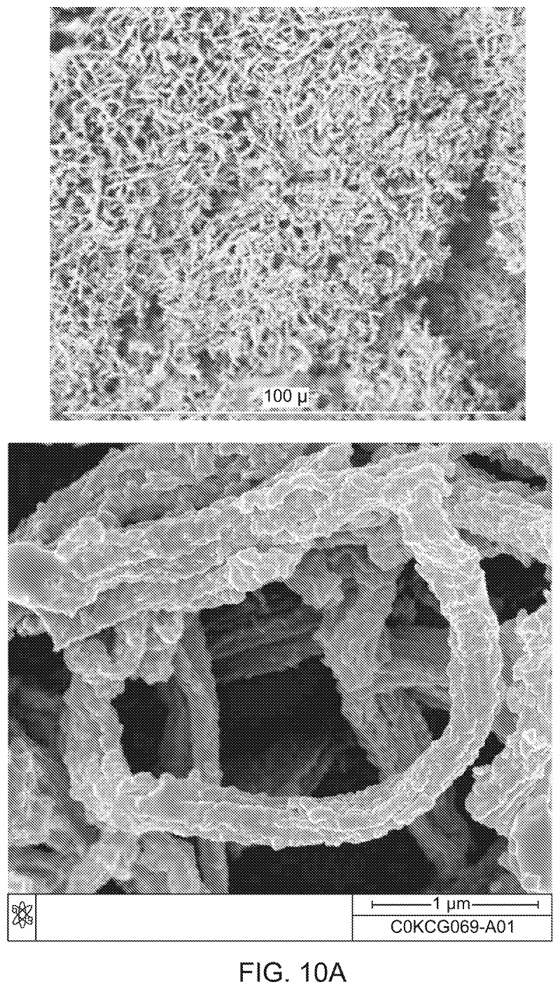

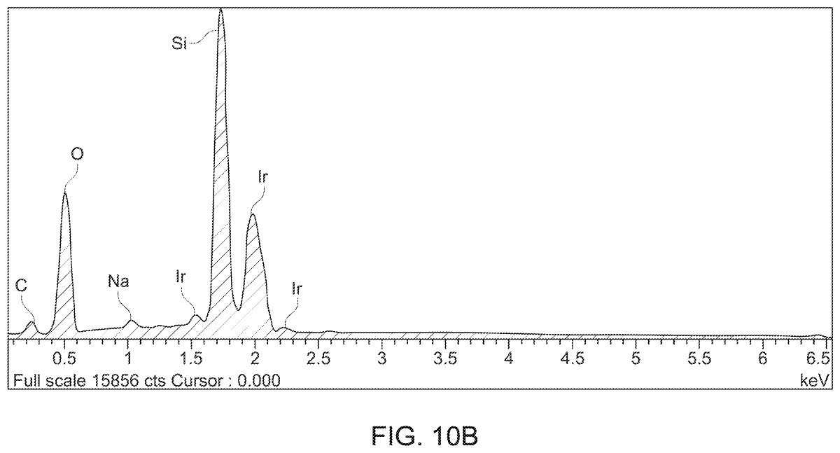

As an example, elongated perimorphic materials are shown in FIG. 10A-10B, which show SEM micrographs and a spectrum generated via energy-dispersive x-ray spectroscopy. These elongated perimorphic frameworks were made with a procedure similar in principle to Example P₂₅, but in this case elongated perimorphic carbons were utilized and functionalization was with a dipodal organosilane. The functionalized perimorphic carbons were then exposed to the oxidizing thermal treatment. In FIG. 10A, some sintering of the silica-like encapsulating phase is evident within and between the originally discrete frameworks. The spectrum shown in FIG. 10B indicates C, O, and Si atomic percentages of approximately 20%, 52%, and 27%, respectively, indicating the silica-like phase and carbon associated with the aromatic carbon frameworks utilized. While the sample fluoresced strongly under 532 nm excitation, the aromatic character of the carbon phase was confirmed via Raman spectral analysis, which, in addition to revealing a G peak associated with sp² carbon, further revealed a D peak associated with radial breathing mode phonons in sp² carbon rings. From its survival of the thermal treatment in an oxidizing atmosphere, we can conclude that the perimorphic carbon material remained due to its encapsulation with a gas-impermeable silica-like phase.

Based on this demonstrated impermeability to O₂ gas, we can conclude that if pyrolysis and sintering had been performed in a vacuum, the framework would have been encapsulated in an internally evacuated state, and would then have been sealed with respect to surrounding air. In certain perimorphic architectures, especially hierarchical superstructures with large central cavities, where the mass of an encapsulated gas becomes significant in relation to the mass of the framework, the framework's apparent density may be reduced by evacuating the gas from the framework's internal pores, then encapsulating the entire framework in this state of vacuum or partial vacuum. Hence, obtaining encapsulation of the perimorphic material in a vacuum may be useful.

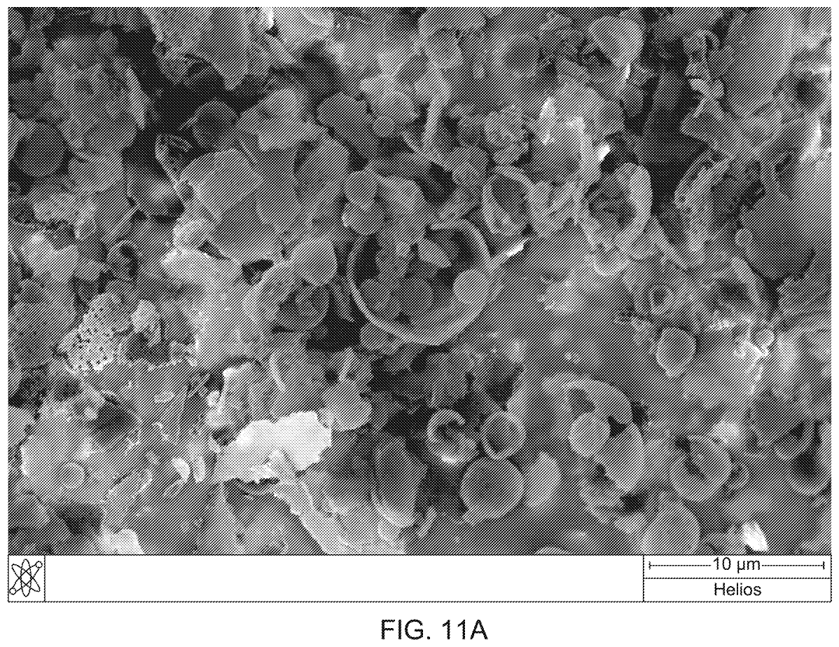

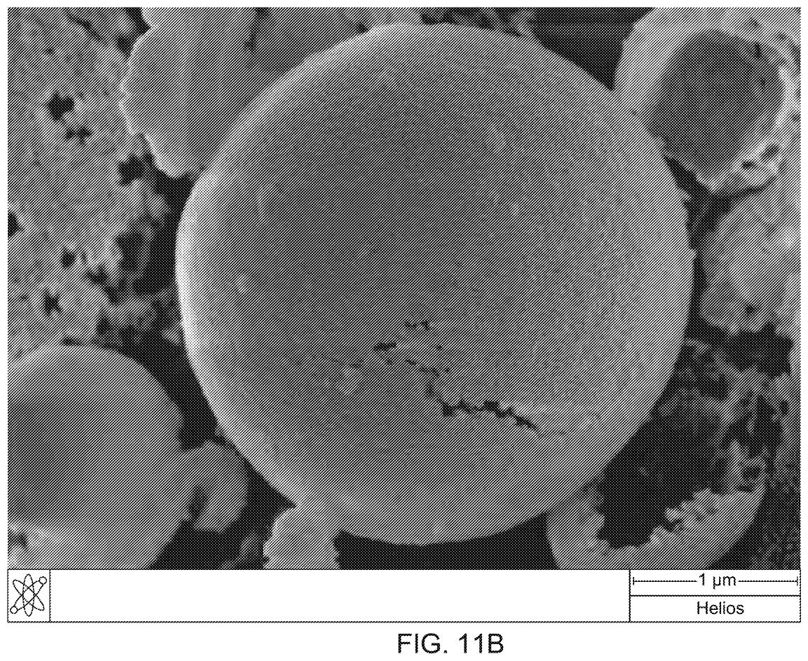

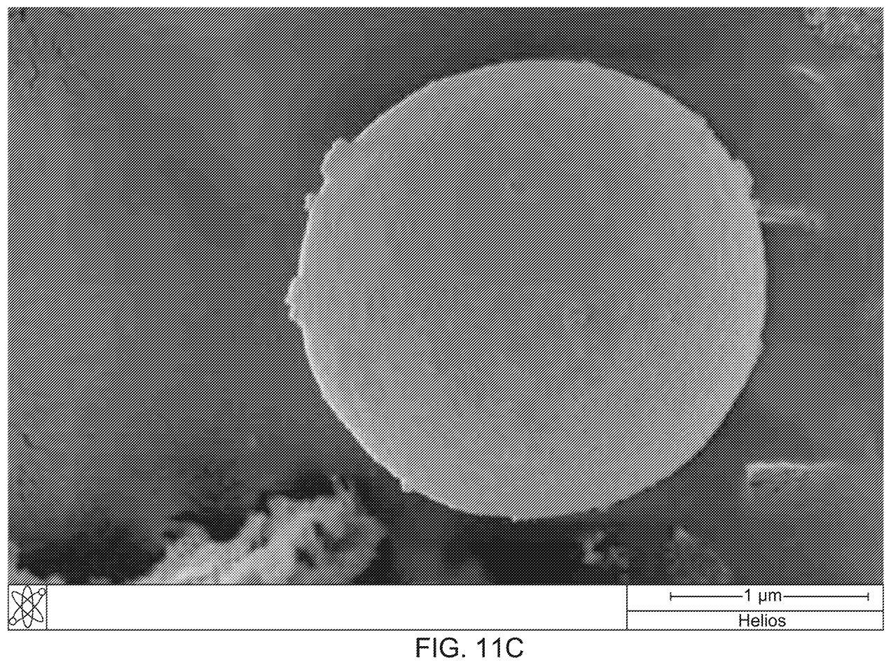

Perimorphic frameworks and strata with a variety of morphologies and polymer-derived ceramic compositions may be readily obtained using pathways similar to those described in Example P₂₄ and Example P₂₅. FIG. 11A-11C, for example, are SEM micrographs that show silica-like perimorphic frameworks with a hollow superstructure. These were derived from hollow MgCO3 xH₂O template precursor particles, such as those described in Reference A. Some of the frameworks have been broken by pressing them into the tape used for imaging. Polymer-derived ceramics like this may be derived from silicon-based preceramic polymers such as polysiloxanes, polysilsesquioxanes, polycarbosiloxanes, polycarbosilanes, polysilylcarbodiimides, polysilsesquicarbodiimides, polysilsesquiazanes, polysilazanes, and metal-containing variants of these molecules, as well as others. Using this pathway, a variety of engineered ceramic chemistries, including metal-modified ceramics, may be derived.

Examples P₂₆, P₂₇: In another exemplary procedure, boron nitride (BN) perimorphic materials and stratified perimorphic materials comprising BN and carbon strata may be synthesized.

For the purpose of demonstration, a P₇-type carbonaceous perimorphic material may first be synthesized via surface replication on porous, ex-hydromagnesite MgO template structures in a way consistent with the General Method (and the Preferred Method). The Precursor Stage and Template Stage procedures are described in the '49195 Application and Reference A, and the surface replication parameters may be found in FIG. 213. The P₇-type carbonaceous perimorphic frameworks comprise synthetic anthracitic networks of the z-sp^{x} classification, as indicated by the sample's interpolated Raman D peak position of 1334 cm⁻¹ under 532 nm excitation. As described in the '37435 Application, a red-shifted D peak position in this range reflects the presence of Y-dislocations and C(sp³)-C(sp³) bonds between the graphenic domain edges.

Next, BN perimorphic strata may be adsorbed to each side of the P₇-type carbon perimorphic frameworks, creating a BAB stratigraphic arrangement. To do this, a 40 mg quantity of P₇-type carbon frameworks may be placed in a ceramic boat, which may be placed in a tube furnace, according to Scheme B, as detailed in Section III. A ceramic boat containing 2 g of ammonia borane complex (H₃NBH₃) may be placed in the quartz tube just outside the furnace's heated zone, such that when the furnace reaches a temperature of 700° C., the H₃NBH₃ reaches a temperature between 130° C. and 170° C. The furnace may then be heated to a temperature of 700° C. at a heating rate of 20° C./min under Ar flowing at 2000 sccm. Upon reaching 700° C., the furnace may be maintained at 700° C. for 60 minutes, then allowed to cool to room temperature under continued Ar flow.

Next, the powder may be placed in a muffle furnace, according to Scheme D, as detailed in Section III. The furnace may be heated to a temperature setting of 800° C. under air and then held at this temperature for 1 hour, then allowed to cool to room remperature.

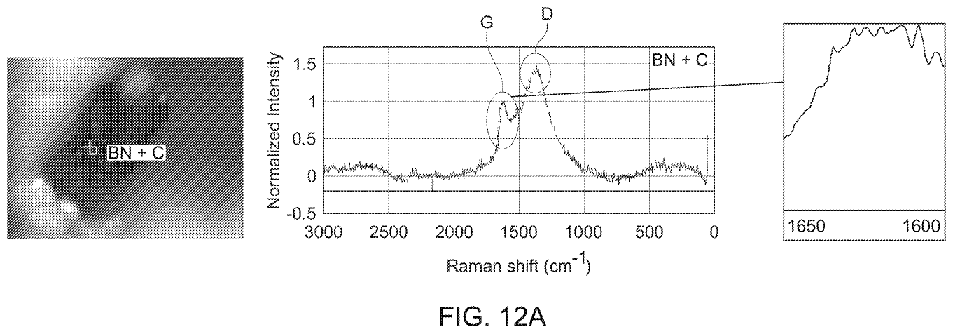

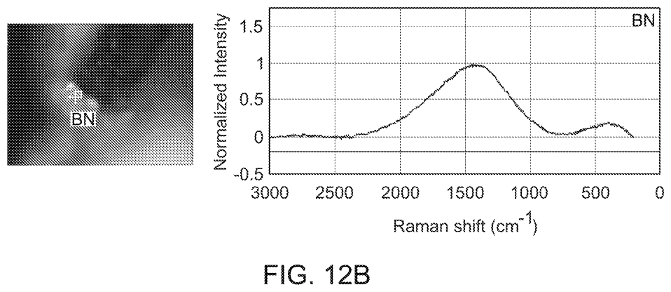

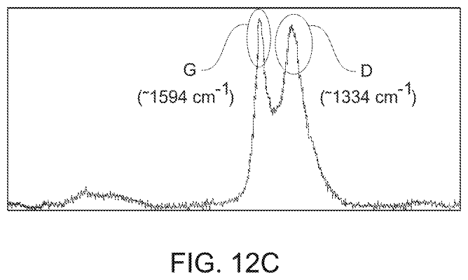

The resulting powder may comprise two phases. The first phase comprises stratified perimorphic frameworks comprising a BAB stratigraphic arrangement, where B represents the outer strata of BN and A represents the inner stratum of carbon, and this phase comprises a type of perimorphic material identified herein as P₂₆. The P₂₆-type phase is optically black, as shown in the optical micrographs in FIG. 12A-12B. The P₂₆-type perimorphic frameworks comprise a thin, sheet-like superstructural morphology that is unchanged from the P₇-type frameworks upon which the BN was adsorbed. The outer strata of the BAB arrangement stratigraphically occlude the inner carbon stratum from thermal oxidation under conditions where unoccluded carbon would be completely thermally oxidized. This indicates that the BN adsorbate completely covered a substantial portion of the perimorphic walls of these carbon frameworks and shielded them from thermal oxidation at 800° C.

This stratigraphic arrangement is further confirmed via Raman spectroscopy. Each spectrum in FIG. 12A-12C is an average spectrum generated from a multipoint spectral analysis under 532 nm excitation. Each analysis employed a 2 mW laser power setting. In FIG. 12A, the Raman spectrum of the P₂₆-type stratified frameworks that resisted thermal oxidation is shown. The D peak of the preserved sp² carbon is located at 1362 cm⁻¹ under 532 nm excitation, which is blue-shifted from the D peak position of 1334 cm⁻¹. At least some portion of this blue-shift is attributable to the higher-temperature exposure of the P₂₆-type carbon stratum compared to the P₇-type carbon. The position of the P₂₆-type carbon's G peak is also blue-shifted from the P₇-type carbon's G peak position of approximately 1594 cm⁻¹. Additionally, the G peak appears broadened-possibly at least in part because of conflation with the D′ peak at 1620 cm⁻¹, which is where the peak is centered, or possibly at least in part because of a proliferation of compressive strain states after the sp² carbon's stratigraphic occlusion by the BN strata. The peak, which is magnified in the inset of FIG. 12A, ranges from 1600 cm⁻¹ to 1630 cm⁻¹.

Overall, comparing the lineshape of this P₂₆ spectrum to that of the P₇-type carbon alone (FIG. 12C) reveals a broad, underlying peak in the P₂₆ spectrum that elevates the D peak above the G peak. The attribution of this underlying peak is clarified by comparing the spectrum of the P₂₆-type stratified frameworks to the second, optically white phase of material observable in the optical micrographs in FIG. 12A-12B. The type of perimorphic material in this second phase is identified herein as P₂₇, which comprises disordered BN frameworks that are left behind after complete removal of the carbon stratum by thermal oxidation. In addition to the change in the particles' color from black to white, the elimination of the carbon from the P₂₇-type frameworks is further confirmed by the Raman spectrum of this phase, as shown in FIG. 12B. The broad peak centered at approximately 1410 cm⁻¹ indicates a disordered BN and resembles the lineshape of Raman spectra of amorphous BN in the literature. Hence, the spectrum of the P₂₆-type frameworks in FIG. 12A represents a composite of the P₇ spectrum shown in FIG. 12C and the P₂₇ spectrum shown in FIG. 12B—i.e. a composite of the carbon and disordered BN phases. The presence of all three peaks—the carbon's G and D peaks, and the disordered BN's broad peak-reveals that both the carbon and BN phases are present in these stratified frameworks.

The formation of the distinct P₂₆ and P₂₇ powder phases is due to the static-bed CVD procedure used to grow the BN in Examples P₂₆ and P₂₇. With no agitation to facilitate solid-gas mixing, the carbon frameworks near the surface of the static bed were substantially covered with the BN adsorbate on both sides of the perimorphic wall during surface replication. This resulted in the stratigraphic occlusion of the carbon, which was sandwiched between two BN strata, and the formation of a stratified perimorphic material near the surface of the static bed. However, the carbonaceous perimorphic frameworks farther from the surface of the static bed were incompletely covered with the BN adsorbate during surface replication due to gas diffusion constraints. These unoccluded carbonaceous frameworks were then completely thermally oxidized during the 800° C. treatment.

Because of the ability to grow BN on carbon substrates, and vice-versa, a multistage replication procedure can be utilized to create various stratigraphic arrangements of BN and carbon. For example, if the BN growth procedure were performed in a pre-extraction replication procedure (i.e. prior to endomorphic extraction), the resulting stratigraphic arrangement would have been AB, as opposed to BAB. Another pre-extraction replication step growing carbon on the BN stratum could have been performed to create an ABA stratigraphic arrangement. Any number of steps, chemistries, and stratigraphic arrangements are possible, and it may be useful to create alternating electrically conducting, semiconducting and insulating strata.

Perimorphic frameworks with various chemical compositions and phases may be of interest for weight-sensitive ceramic applications, ceramic applications in which unusual mechanical properties, such as flexibility or pseudoelasticity, are desired, and ceramic applications in which high thermal stability or thermal shock resistance is desired. Retention of a carbon stratum within the perimorphic wall may be desired not only for its own functionality in applications, but also because it may stabilize the perimorphic architecture of other ceramic strata during high-temperature production and service. Exposed carbon strata may be easily chemically functionalized, whereas certain ceramics may be more difficult to functionalize, so carbon strata may be used for functionalization purposes, also. This is similar to the concept presented in the '580 Application, in which a disordered, easily oxidized perimorphic stratum or “skin” is formed over a less disordered, graphitic perimorphic stratum that is not as easily oxidized.

Other perimorphic compositions that will be desirable include transition metal dichalcogenides (“TMDCs”) and stratified perimorphic materials including multiple TMDCs or carbon and TMDCs. Also, stratified compositions involving carbon and metal oxides such as TiO₂ would be desirable for a number of applications, such as photoanodes. The General Method may be used to generate these compositions in the form of controllably compact, perimorphic frameworks with engineered superstructural and substructural architectures. Hence, the method is not limited to carbon perimorphic frameworks, or even single-phase frameworks, but may be used to synthesize perimorphic materials comprising diverse chemistries and combinations of chemistries. It may be applied to numerous heterostructures and composites known in the art and/or described herein. It also may apply to structures not yet known or discovered.

Example P₂₈: In another exemplary procedure, BN perimorphic materials comprising synthetic anthracitic networks may be synthesized directly on a template material via chemical vapor deposition. This synthesis demonstrates that, in a way that is analogous to the formation of synthetic anthracitic networks from graphenic carbon, BN anthracitic networks may be synthesized from graphenic BN via surface defect-catalyzed BN lattice nucleation and free radical-driven BN lattice growth. Hence, BN perimorphic frameworks can be synthesized via template-directed surface replication procedures in a way that is analogous to the template-directed synthesis of carbonaceous perimorphic frameworks. This being the case, the General Method (and the Preferred Method) can be utilized to synthesize these perimorphic materials and other perimorphic materials that are formed according to analogous nucleation and growth mechanics.

Additionally, like free radical-driven carbon growth processes, the formation of BN sp^{x} networks via free radical-driven BN growth processes should be optimized by modulating the amount of hydrogen gas in the gas medium during growth. This will prevent hydrogen from being too rapidly released from the growing BN domains and enable the tectonic interfaces to rearrange into configurations that maximize the edge-to-edge sp² and sp³ grafting of BN domains. Maturation of these BN sp^{x} precursor networks via annealing can then be utilized to transform them into BN helicoidal networks that are substantially sp²-hybridized-again according to mechanics analogous to the maturation of carbonaceous sp^{x} precursor networks and the formation of carbonaceous helicoidal networks.

For the purpose of demonstration, N₂T₁-type porous MgO template structures may first be synthesized via thermal decomposition of N₂-type nesquehonite template precursor structures in a way consistent with the General Method (and the Preferred Method). This synthesis is described in the '49195 Application and Reference A.

Next, in an exemplary Replication Stage procedure, the N₂T₁-type template material may be utilized to direct the chemical vapor deposition of a disordered BN. To do this, a 176 mg quantity of N₂T₁-type template structures may be placed in a ceramic boat, which may be placed in a tube furnace, according to Scheme B, as detailed in Section III. A ceramic boat containing 1.0 g of ammonia borane complex (H₃NBH₃) may be placed in the quartz tube just outside the furnace's heated zone, such that when the furnace reaches a temperature of 900° C., the H₃NBH₃ reaches a temperature between 130° C. and 170° C. The furnace may initially be purged with Ar flowing at 2000 sccm for 30 minutes at room temperature. This may be followed by heating to a temperature of 900° C. at a heating rate of 20° C./min under Ar flowing at 2000 sccm. Upon reaching 900° C., the furnace may be maintained at 900° C. for 60 minutes, then allowed to cool to room temperature under continued Ar flow.

Next, endomorphic extraction may be performed, as it would be in the Separation Stage of the General Method or Preferred Method. This may be done in an aqueous H₂CO₃ extractant solution. After dissolution of the endomorphic MgO, the BN perimorphic frameworks may be filtered, rinsed and dried. In a full implementation of the General Method, the aqueous H₂CO₃ solution may be generated using the retained process water from the Precursor Stage precipitation, and the aqueous Mg(HCO₃)₂ solution may be utilized as the solution stock for precipitating an MgCO₃ xH₂O template precursor material like N₂-type nesquehonite. In this way, both the template material and process liquid are conserved for cyclical use. CO₂ process gas may also be beneficially conserved and utilized to regenerate the extractant solution. The type of BN perimorphic frameworks resulting from this process is identified herein as P₂₈.

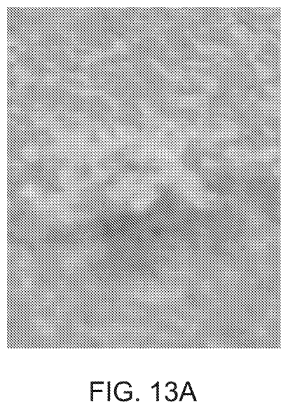

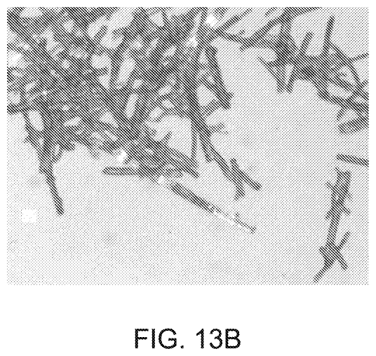

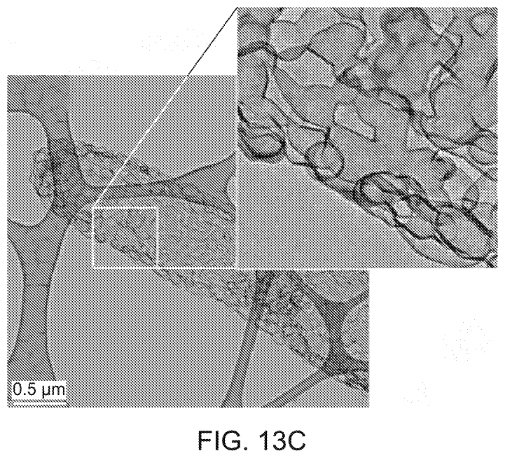

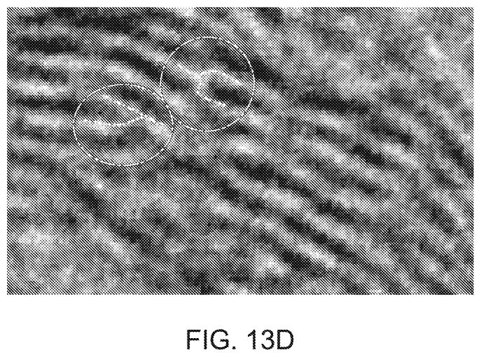

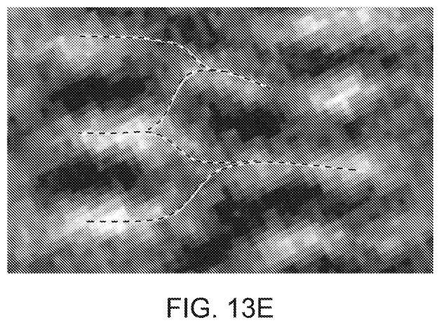

FIG. 13A is a photograph of the light brown powder comprising the P₂₈-type perimorphic material. FIG. 13B is an optical micrograph of the elongated BN frameworks derived from endomorphic extraction of the N₂T₁-type template material. The BN frameworks are elongated, having inherited the elongated superstructure of the N₂-type (nesquehonite) template precursor particles. This is shown in the optical micrograph of FIG. 13B. The cellular substructure of the BN frameworks is shown in FIG. 13C, a TEM micrograph showing the 50-400 nm cellular subunits. From this, we can clearly infer the displaced template's substructure of rounded subunits-no wrinkling or collapse of the BN perimorphic wall is evident. Hence, the framework can be concluded to have retained a substantially native substructural morphology. The adsorption of the BN perimorphic phase to the templating surface appears to have been highly conformal, resulting in a uniformly 4-5 nm thick perimorphic wall of nematically aligned atomic monolayers. This layering is shown in FIG. 13D, an HR-TEM micrograph of the BN perimorphic wall. The layering reflects the prevalence of sp²-hybridized bonding, which produces atomic monolayers. Y-dislocations are circled and traced in FIG. 13D.

FIG. 13E shows the layering of the BN perimorphic wall at yet higher magnification. In this cross-section of the BN perimorphic wall, a screw dislocation providing three-dimensional crosslinking of the nematically aligned BN layers is evident. A tracing of the intralayer and interlayer connectedness of this non-carbonaceous anthracitic network is shown in FIG. 13E. This screw dislocation mirrors the screw dislocations in TEM micrographs of carbonaceous helicoidal networks synthesized in the '37435 Application. Like carbonaceous anthracitic networks, BN anthracitic networks are crosslinked via structural dislocations, and these structural dislocations can be discerned in the helicoidal network pattern in FIG. 13E.

The native or near-native morphological state of the P₂₈-type BN perimorphic frameworks, as shown in FIG. 13C, is another indication of the molecular-scale three-dimensional crosslinking throughout the perimorphic wall. Without the interlayer crosslinking afforded by structural dislocations in anthracitic networks, the van der Waals cohesion between the two-dimensional layers would be too weak to prevent shear yielding and shear-related mechanical failure of these microscopic fibers, which are superstructurally intact, as shown in FIG. 13B. Their substructures are also intact and undeformed after evaporative drying. Without crosslinking between the layers of the anthracitic network, the stresses associated with evaporative drying-namely the stresses caused by the surface tension of the endomorphic water-would have collapsed the cellular subunits (shown in the magnified region of FIG. 13C) of the perimorphic frameworks.

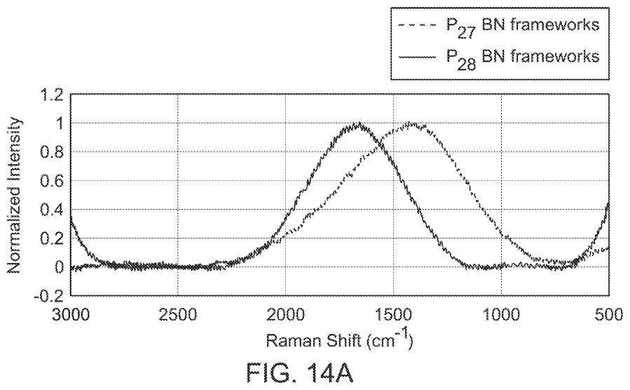

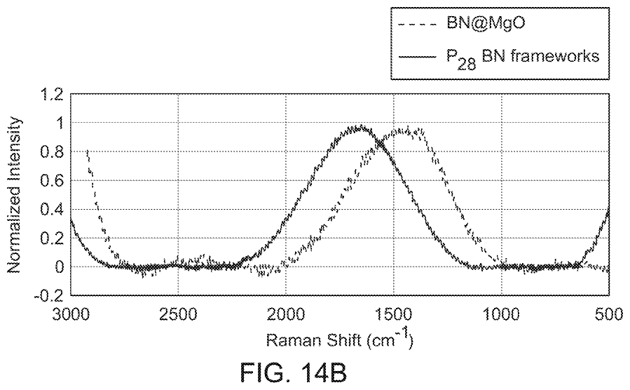

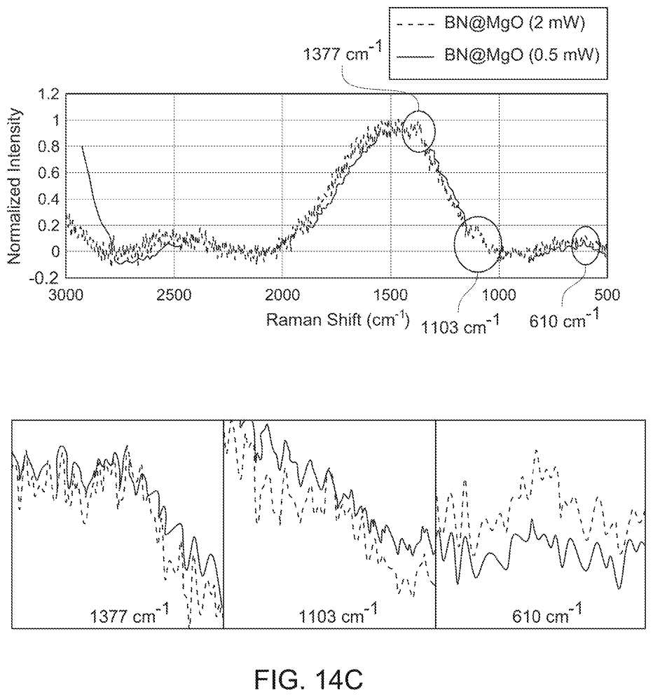

FIG. 14A is an overlay of the Raman spectra of the P₂₈-type and P₂₇-type BN frameworks. Each spectrum is an average spectrum generated from a multipoint spectral analysis under 532 nm excitation. To avoid sample heating and fluorescence in the P₂₈-type frameworks, a 0.5 mW laser power setting and 60 2-second exposures were employed. The Raman spectrum of the P₂₈-type BN frameworks comprises a single, broad peak stretching from approximately 1100 to 2300 cm⁻¹ and centered at approximately 1655 cm⁻¹. Compared to the broad peak associated with the P₂₇-type BN frameworks, the broad peak associated with the P₂₈-type BN frameworks is narrower and blue-shifted by approximately 245 cm⁻¹. To confirm the discrepancy is not simply attributable to the different laser powers and exposure settings, the P₂₇-type frameworks were re-analyzed using a 0.5 mW laser power setting and 60 2-second exposures. While the Raman signal was far lower at the lower power setting, making the precise peak position difficult to discern, the peak appeared to be centered near 1410 cm⁻¹.

FIG. 14B is an overlay of the Raman spectra of the P₂₈-type frameworks and the BN@MgO PC material from which P₂₈-type frameworks are derived. Each spectrum is an average spectrum generated from a multipoint spectral analysis under 532 nm excitation. To avoid sample heating and fluorescence, a 0.5 mW laser power setting and 60 2-second exposures were employed. Compared to the spectrum of the P₂₈-type frameworks, the spectrum of the BN@MgO PC material is red-shifted to 1470 cm⁻¹. The peak widths are similar. From this it appears that there is an interaction between the BN perimorphic walls and the underlying templating surfaces. The Raman spectrum of the BN@MgO PC material, when gathered at 2 mW, reveals features at approximately 610 cm⁻¹, 1103 cm⁻¹ and 1377 cm⁻¹, which are present weakly in the 0.5 mW spectrum, as shown in the overlay of these two BN@MgO spectra in FIG. 14C. The feature at 1377 cm⁻¹ is characteristic of sp²-hybridized BN and may reveal that the laser at the 2 mW power setting is heating the sample to the point of annealing it.

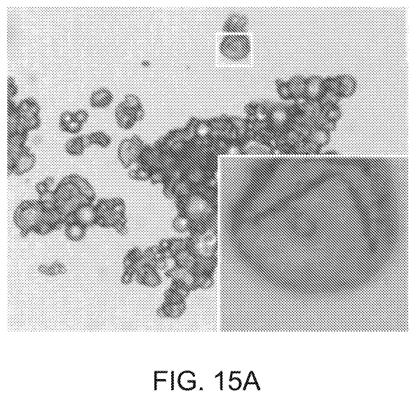

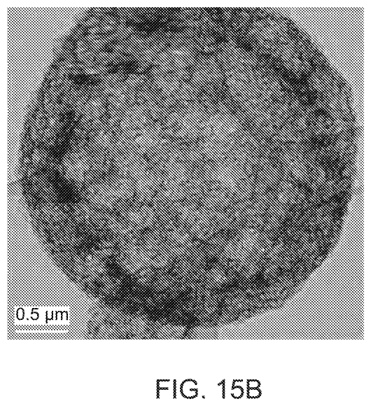

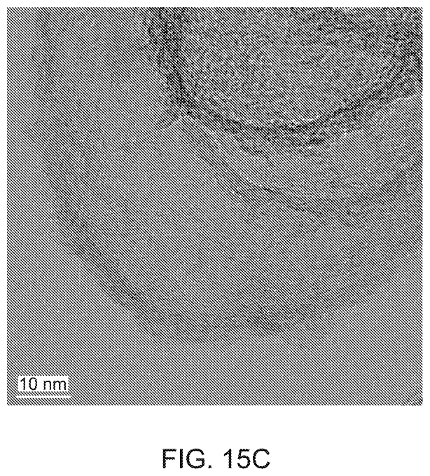

Similar to perimorphic walls constructed from deposition of carbonaceous graphene, perimorphic walls constructed from the deposition of other two-dimensional molecular structures like sp²-hybridized BN may be thinned or thickened via a shorter or longer CVD procedure, respectively. Thinning them results in a more flexible framework, as shown in FIG. 15A, an optical micrograph of both collapsed and uncollapsed, hollow BN perimorphic frameworks. These were made using the A₂-type template precursor described in '49195 Application and Reference A and a steam-assisted calcination to generate the template structures. Many of these frameworks crumpled during drying, but remained intact, as shown in the magnified inset of FIG. 15A, where the folds in the crumpled shell can be observed.

FIG. 15B is a TEM micrograph of an uncollapsed hollow BN framework. From this, and from the magnified TEM micrograph of FIG. 15C, the rounded and spheroidal cellular subunits can be discerned. The more curved cellular geometry likely contributes to the flexibility of these BN frameworks, whereas a more angular cellular geometry may have corners and regions that are more resistant to crumpling and bending. Like the elongated BN frameworks shown in FIG. 13A-13E, the hollow frameworks in FIG. 15A-15C exhibit a degree of mechanical robustness and elasticity that require the crosslinking present in an anthracitic network.

Example P₂₉: In another exemplary procedure, boron carbonitride (BCₓN) perimorphic materials comprising synthetic anthracitic networks may be synthesized directly on a template material via chemical vapor deposition. This synthesis demonstrates that, in a way that is analogous to the formation of synthetic anthracitic networks from graphenic carbon and graphenic BN, BCₓN anthracitic networks may be synthesized from graphenic BCₓN via surface defect-catalyzed BCₓN lattice nucleation and free radical-driven BCₓN lattice growth. Hence, BCₓN perimorphic frameworks can be synthesized via template-directed surface replication procedures in a way that is analogous to the template-directed synthesis of carbonaceous perimorphic frameworks. This being the case, the General Method (and the Preferred Method) can be utilized to synthesize these perimorphic materials and other perimorphic materials that are formed according to analogous nucleation and growth mechanics.

Additionally, like free radical-driven carbon growth processes, the formation of BCₓN sp^{x} networks via free radical-driven BCₓN growth processes should be optimized by modulating the amount of hydrogen gas in the gas medium during growth. This will prevent hydrogen from being too rapidly released from the growing BCₓN domains and enable the tectonic interfaces to rearrange into configurations that maximize the edge-to-edge sp² and sp³ grafting of BCₓN domains. Maturation of these BN sp^{x} precursor networks via annealing can then be utilized to transform them into BN helicoidal networks that are substantially sp²-hybridized-again according to mechanics analogous to the maturation of carbonaceous sp^{x} precursor networks and the formation of carbonaceous helicoidal networks.

For the purpose of demonstration, an N₂-type template precursor material may first be synthesized in a way consistent with the General Method (and the Preferred Method). This synthesis is described in the '49195 Application and Reference A.

Next, the template precursor material may be thermally treated. This may be performed according to Scheme B in a tube furnace, as detailed in Section III. For this treatment, approximately 7.88 g of the N₂-type powder may be placed in the tube furnace. A ceramic boat containing 1.30 g of ammonia borane complex (H₃NBH₃) may be placed in the quartz tube just outside the furnace's heated zone, such that when the furnace reaches a temperature of 700° C., the H₃NBH₃ reaches a temperature between 130° C. and 170° C. After sealing the tube, an Ar gas flow of 2000 sccm may be initiated. Under flowing Ar, the furnace may be heated from room temperature to a temperature setting of 700° C. at a heating rate of 20° C./min. During this thermal treatment, CO₂ gas may be released. In a full implementation of the General Method, the CO₂ process gas released during the decomposition of the template precursor material may be recaptured and conserved using conventional techniques. The type of porous MgO template material resulting from this thermal process is identified herein as N₂T₇. The elongated superstructures of these porous templates are derived from N₂-type nesquehonite template precursor particles, which are also elongated.

Approximately 2 minutes after the furnace reaches the temperature setting of 700° C., white fumes may be evolved and observed in the tube and in the exhaust. This indicates the initial vaporization of the H₃NBH₃. Approximately 5 minutes after the furnace reaches the temperature setting of 700° C., a 64 sccm flow of C₃H₆ may be initiated, and this condition may be maintained for 5 min, such that H₃NBH₃ and C₃H₆ are flowing simultaneously. The C₃H₆ gas flow may then be terminated and the H₃NBH₃ flow may continue for an additional 5 minutes. The furnace may then be allowed to cool to room temperature under continued Ar flow.

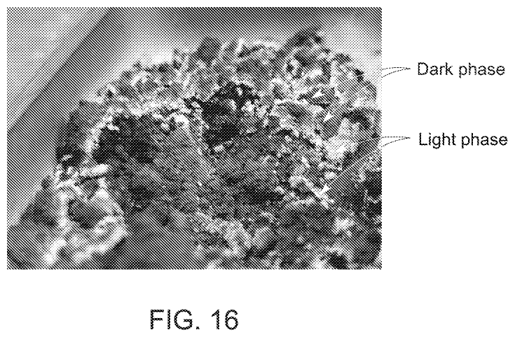

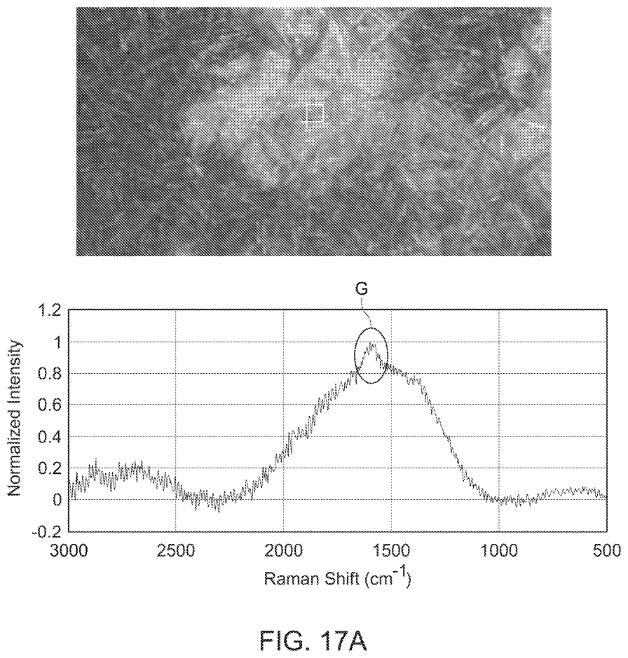

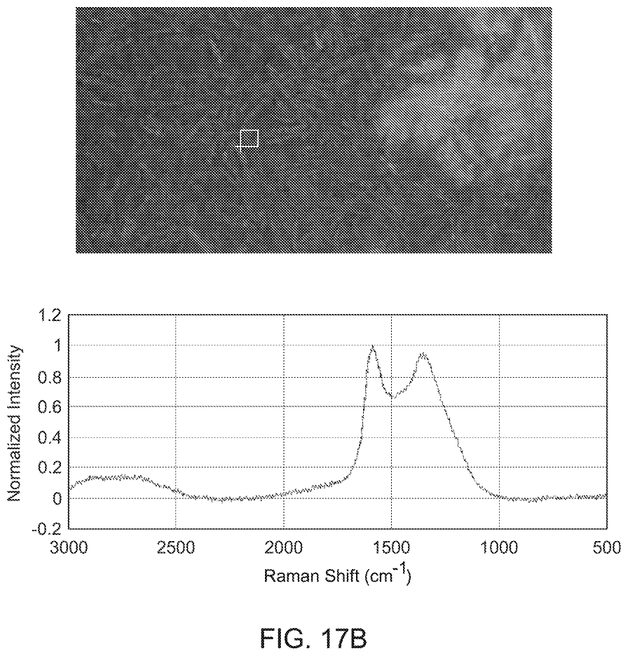

The bed of powder resulting from this procedure comprises a light phase and a dark phase on the surface. The bed of powder in the boat, as retrieved from the furnace, is shown in FIG. 16. The light and dark phases are labeled in FIG. 16; these phases correspond to the light and dark phases found in the optical micrographs of the powder in FIG. 17A-17B. The Raman spectrum of the light phase, as shown in FIG. 17A, reveals a broad peak between 1000 and 2300 cm⁻¹, consistent with a disordered BN. A second, minor peak can be observed at approximately 1595 cm⁻¹. This feature comprises the G peak associated with sp²-hybridized carbon bonding. This indicates that both carbon and BN are present in the light phase. Meanwhile, the absence of the D peak, which is associated with the radial breathing mode of sp² carbon rings, indicates that the carbon is not present in the form of polyatomic carbon rings—i.e. as a graphenic phase present alongside a BN phase but rather its presence is distributed throughout a BCₓN molecular structure. This phase of the powder in the boat is herein identified as N₂T₇P₂₉.

Next, endomorphic extraction of the N₂T₇P₂₉ phase may be performed, as it would be in the Separation Stage of the General Method (or Preferred Method). This may be done in an aqueous H₂CO₃ extractant solution. After dissolution of the endomorphic MgO, the BN perimorphic frameworks may be filtered, rinsed and dried. In a full implementation of the General Method, the aqueous H₂CO₃ solution may be generated using the retained process water from the Precursor Stage precipitation, and the aqueous Mg(HCO₃)₂ solution may be utilized as the stock solution for precipitating an MgCO₃ xH₂O template precursor material like N₂-type nesquehonite. In this way, both the template material and process liquid are conserved for cyclical use. CO₂ process gas may also be beneficially conserved and utilized to regenerate the extractant solution. The type of BCₓN perimorphic frameworks resulting from this process is identified herein as P₂₉.

The Raman spectrum of the light phase associated with BCₓN perimorphic material can be contrasted with the dark phase, as shown in FIG. 17B, which has a more typical disordered sp² carbon spectrum comprising both D and G peaks. This phase, which appeared brown, may comprise a BCₓN with a higher x value than the light phase.

V. Reference A: Detailed Description from the '49195 Application

The Detailed Description begins with initial section of “Terms and Concepts” that provides language and concepts for describing and understanding the invention. Subsequent sections are organized according to the following four stages of the method: the “Precursor Stage,” the “Template Stage,” the “Replication Stage,” and the “Separation Stage.” A number of exemplary procedures and materials pertaining to each of the 4 stages are demonstrated. Many potential variants of each stage might be readily conceived by those knowledgeable in the art and combined to form numerous variants without deviating from the method.

The Detailed Description is organized according to the following sections:

I*. Terms and Concepts

| | |
|---|---|
| I*. | Terms and Concepts |
| II*. | Description of the General Method and Variants |
| III*. | Furnace Schemes, Analytical Techniques and Material Naming |
| IV*. | Precursor Stage - Examples |
| V*. | Template Stage - Examples |
| VI*. | Replication Stage - Examples |
| VII*. | Separation Stage - Examples |
| VIII*. | Perimorphic Framework Examples |

A “template,” as defined herein, is a potentially sacrificial structure that imparts a desired morphology to another material formed in or on it. Of relevance for surface replication techniques are the template's surface (i.e. the “templating surface”), which is positively replicated, and its bulk phase (i.e. the “templating bulk”), which is negatively replicated. The template may also perform other roles, such as catalyzing the formation of the perimorphic material. A “templated” structure is one that replicates some feature of the template.

A “perimorph” or “perimorphic” material is a material formed in or on a solid-state or “hard” template material.

“Surface replication,” as defined herein, comprises a templating technique in which a template's surface is used to direct the formation of a thin, perimorphic wall of adsorbed material, the wall substantially encapsulating and replicating the templating surface upon which it is formed. Subsequently, upon being displaced, the templating bulk is replicated, in negative, by an endocellular space within the perimorphic wall. Surface replication creates a perimorphic framework with a templated pore-and-wall architecture.

A “perimorphic framework” (or “framework”), as defined herein, is the nanostructured perimorph formed during surface replication. A perimorphic framework comprises a nanostructured “perimorphic wall” (or “wall”) that may range from less than 1 nm to 100 nm in thickness but is preferably between 0.6 nm and 5 nm. Insomuch as it substantially encapsulates and replicates the templating surface, the perimorphic wall can be described as “conformal.” Perimorphic frameworks may be made with diverse architectures, ranging from simple, hollow architectures formed on nonporous templates to labyrinthine architectures formed on porous templates. They may also comprise different chemical compositions. A typical framework may be constructed from carbon and may be referred to as a “carbon perimorphic framework.”

An “endomorph,” as defined herein, comprises a template as it exists within a substantially encapsulating perimorphic phase. Therefore, after the perimorphic phase has been formed around it, the template may be described as an endomorph, or as “endomorphic.”

A “perimorphic composite,” or “PC” material, as defined herein, is a composite structure comprising an endomorph and a perimorph. A PC material may be denoted x@y, where x is the perimorphic element or compound and y is the endomorphic element or compound. For example, a PC structure comprising a carbon perimorph on an MgO endomorph might be denoted C@MgO.

The term “positive” is used herein to describe a space that is occupied by a solid mass. The space occupied by the endomorph (i.e. the “endomorphic space”) in a perimorphic composite is an example of positive space. A nonporous template comprises only positive space. Exempting the space occupied by its thin wall, a perimorphic framework comprises no positive space.

The term “negative” is used herein to describe a space that is unoccupied by a solid or liquid mass. A negative space may be empty, gas-filled, or liquid-filled. The pores inside an unimpregnated, porous template comprise negative space. A porous template comprises both positive and negative space. Exempting the space occupied by its thin wall, a perimorphic framework comprises only negative space.

The term “cellular” is used herein to describe the pore-and-wall morphology associated with perimorphic frameworks. A “cell” or “cellular subunit” comprises a specified endocellular pore and region of the perimorphic wall around the pore.

The term “endocellular” is used herein to describe a negative space in a perimorphic framework that is formed by the displacement of the endomorph from the perimorphic composite. Like the endomorph whence it derives, the endocellular space is substantially encapsulated by the perimorphic wall.

The term “exocellular” is used herein to describe a negative space in a perimorphic framework that is inherited from the pore space of the perimorphic composite, which is in turn inherited from the pore space of a porous template. We note that an exocellular space, despite the “exo-” prefix, maybe located substantially inside a perimorphic framework.

A perimorphic framework's endocellular and exocellular spaces are substantially separated by the perimorphic wall. However, the ability to displace the endomorph from the template composite implies that the wall is somewhere open or an incomplete barrier, since a perfectly encapsulated endomorph could not be displaced. Therefore, while a perimorph is herein described as substantially encapsulating a templating surface, the encapsulation may nevertheless be incomplete or subject to breach.

The term “native” is used herein to describe the morphological state of a perimorphic structure in the perimorphic composite. A “native” feature comprises a feature that is substantially in its native state, and we may refer to a structure as “natively” possessing some feature (e.g. a perimorphic wall that is natively 1 nm thick). After displacement of the endomorph from the perimorphic composite, the perimorph may either substantially retain its native characteristics, or it may be altered.

The term “non-native” is used herein to describe a morphological state of a perimorphic structure that is substantially altered from its native morphological state (i.e. its original state in the perimorphic composite). This alteration may occur at the substructural or superstructural levels. For example, during evaporative drying of an internal liquid, a perimorphic wall may be pulled inward by the liquid, collapsing a portion of the endocellular space. A framework's deformation into a non-native, collapsed morphology may be reversible—i.e. the framework may be able to substantially recover its native morphology.

The term “labyrinth” or “labyrinthine” is used herein to describe a network of interconnected pores in a template or a perimorphic framework. A labyrinth may be endocellular or exocellular. A perimorphic framework formed on a porous template may natively comprise endocellular and exocellular labyrinths; therefore, a framework formed on porous templates may be described as a “labyrinthine framework.” The endocellular and exocellular labyrinths of a labyrinthine framework, while not overlapping, may be interwoven. Labyrinthine frameworks comprise a preferred class of perimorphic frameworks.

A “template precursor,” or “precursor,” as defined herein, is a material from which a template is derived via some treatment that may comprise decomposition, grain growth, and sintering. A template may retain a pseudomorphic resemblance to the template precursor; therefore, engineering the precursor may offer a way to engineer the template. The precursor is formed within a process liquid and is derived from a stock solution.

The term “superstructure” is herein defined as the overall size and geometry of a porous template or perimorphic framework. A perimorphic framework's superstructure may be inherited from the morphology of the template precursor. The superstructure of a perimorphic framework is important because the overall size and geometry of a framework will influence its properties, including how it interacts with other particles. Some superstructures may facilitate the drying of a wet paste of perimorphic frameworks into a fine powder, whereas other superstructures may cause a wet paste to dry into macroscopic granules, which may require subsequent grinding. Superstructures may comprise the following shapes:
“Equiaxed,” herein defined as a shape that is similar in size (less than 5× difference in size) along its major axis, intermediate axis, and minor axis.
“Elongated,” herein defined as a shape that is significantly larger (5× up to 50×) in size along its major axis than along its intermediate and minor axes.
“Thin,” herein defined as a shape that is more than 5× larger along its major axis and intermediate axis than it is along its minor axis.
“Hierarchical,” herein defined as an equiaxed or elongated shape with thin features.

The term “substructure” is herein defined as the localized morphology—i.e. the internal architecture—of a porous template or perimorphic framework. Certain porous templates or perimorphic frameworks have a substructure comprising repeating, conjoined substructural units, or “subunits.” Different substructures may be characterized by subunits of different shapes, sizes, and spacings from one another.

The term “noncellular” is used herein to describe a negative space inside that is not considered herein to be templated, nor to be part of a perimorphic framework, but that is nevertheless substantially surrounded by and located within a framework. Noncellular space is not templated space because it does not correspond strictly to a template's positive space, negative space, or surface, and it is only present when surface replication is not able to occur on some portion-typically an inaccessible interior region—of a templating surface.

Noncellular space may be desirable for density reduction in certain applications and may be engineered using a combination of rational template engineering and diffusion-limited synthesis techniques. In particular, large template precursors may be used to create large templates, which with minimal sintering may combine long diffusion pathways with small pores. Rational design of the surface replication parameters may also help. For instance, during CVD, low concentrations of the carbonaceous vapor may be more easily scavenged by reactive sites and prevented from penetrating throughout the porous substructure of the porous template.

Another way density reduction can be achieved is via the use of porous template precursor materials. This results in an exocellular internal porosity that is preferable to noncellular space because it is more engineerable and does not require diffusion constraints. Porous template precursors may be made with the use of blowants (e.g. hollow microspheres produced during spray-drying) or via the use of sacrificial materials when making the template precursors (e.g. synthesizing the template precursor around sacrificial micelles or polymers).

The concept of “compactness” herein relates to the area of perimorphic wall contained within a given volume of a perimorphic framework—i.e. a volumetric surface area. A framework with a more compact substructure will possess a finer, denser arrangement of perimorphic wall within a given volume, whereas a framework with a less compact substructure will possess a coarser, more spatially diffuse arrangement of perimorphic wall within a given volume. Porous templates, and the labyrinthine frameworks formed on them, may be engineered to have different levels of compactness. Compactness comprises a measure of a framework's mesoscale crosslinking—i.e. crosslinking not at the molecular scale, but at a higher scale, where crosslinking is derived from the topology of the templating surface.

A perimorphic framework's compactness and pore phases may be modulated by engineering the template's positive and negative spaces. For example, a porous MgO structure produced by decomposing a magnesium carbonate precursor has a positive space comprising a network of conjoined, MgO crystallites. Its negative space comprises a porous network running between the MgO crystallites and throughout the structure. It is well-known that the crystallites may grow at elevated temperatures, coarsening the grain structure. The same process may also lead to growth and coarsening of the pores. This coarsening of the positive and negative spaces will reduce the porous MgO template's surface area, and therefore reduce the compactness of a perimorphic framework formed on the template. At the same time that the template is coarsening, it will be densifying, and its densification will reduce the amount of exocellular space in a perimorphic framework formed on the template.

The coarseness of a template may be important for many reasons. For example, enlarging a templte's pores and reducing its surface area may permit faster, deeper diffusion of a reactive vapor throughout the template's pores during CVD. The perimorphic walls synthesized in such processes may be more uniform in thickness if adequate diffusion kinetics can be achieved.

A perimorphic framework's compactness and pore phases may also be modulated by selecting different template precursors. Different precursors will have different fractions of labile mass. A template's negative space will depend on how much of the template precursor's starting mass is lost during its decomposition. Calcining template precursors that contain large fractions of labile species—for instance, highly hydrated salts—may result in porous templates with high specific porosity that are more open to diffusive flows during CVD. Such templates may also be desired if more exocellular space is desired in the perimorphic framework.

The term “recycled” is used herein to describe process materials being utilized in a given step of the production process that have previously been utilized for that step. Since practical losses of process materials (e.g. process liquid losses from evaporation or filtration) during production of a perimorphic product may occur, virgin process materials may be used to replenish these losses, and a “recycled” process material may partially comprise virgin material.

“Process materials,” as defined herein, comprise potentially recyclable non-perimorphic materials utilized to generate perimorphic materials. Process materials may comprise process liquids, process gases, extractants, template precursor materials, and template materials.

A “stock solution,” as defined herein, comprises solvated cations and anions and a process liquid, the solvated ions being hosted by the process liquid (which may be referred to in this context as the “host”). A stock solution is formed in the Separation Stage. A precursor is derived from a stock solution through one or more precipitation, dissolution, or decomposition reactions.

A “process liquid,” as defined herein, is a feedstock of either liquid water (“process water”) or solvent (“process solvent”) utilized in the Precursor Stage and the Separation Stage. The process liquid may play a number of different roles in these stages. In the Precursor Stage, the formation of a template precursor is hosted by the process liquid, and the precursor may incorporate the process liquid into its crystal—for instance, a hydrous salt may be formed in process water and incorporate some of the process water into its crystal structure. In the Separation Stage, an extractant is hosted by the process liquid, and the solvated ions produced by reactions between the template, process liquid, and extractant are hosted by the process liquid. The process liquid may be involved in the production of the extractant and may itself react with the template during the Separation Stage.

A “residual liquid,” as defined herein, is a portion of process liquid, which may or may not host solvated ions, that remains unseparated from a solid (e.g. a precursor or a perimorphic product) upon separation of the solid from the main portion of the process liquid. Residual liquid may be contained within a perimorphic product or wetted to its surface. Residual liquid may comprise a very small fraction of the overall process liquid. A solid's retention of residual liquid may require further separation if a dry solid is desired.

An “extractant,” as defined herein, comprises an acid hosted by a process liquid, the two phases together comprising an “extractant solution.” The extractant may be present in the extractant solution in very dilute concentrations. In some cases, the extractant may be produced from (and within) the process liquid. For example, a carbonic acid (H₂CO₃) extractant may be produced from (and within) a process water, according to the reaction H₂O₍ₜ₎+CO_{2(aq)}→H₂CO_{3(aq)}.

“Endornorphic extraction,” as defined herein, comprises the selective removal of a portion of an endomorph from a perimorphic composite Endomorphic extraction comprises a reaction between an endomorph and an extractant solution that produces solvated ions that are exfiltrated from the surrounding perimorph, resulting in concurrent displacement of the endomorph, consumption of the extractant from the extractant solution, and generation of a stock solution. Generally, the removal of substantially all of an endomorph's mass is desired. Occasionally, the partial removal of an endomorph's mass may be desired, or only partial removal of an endomorph's mass may be achievable.

“Perimorphic separation,” as defined herein, comprises the separation of a perimorphic product after endomorphic extraction from non-perimorphic, conserved process materials. Conserved, non-perimorphic phases may comprise process liquid, stock solution, and precipitates of the stock solution. Perimorphic separation may comprise many different industrial separation techniques, (e.g. filtration, centrifugation, froth flotation, solvent-based separations, etc.).

A “solventless precipitation,” as defined herein, comprises the precipitation of a template precursor in the Precursor Stage, wherein the precipitation is substantially driven by a solution destabilization mechanism that does not require the introduction of a miscible antisolvent into the process liquid. As a first example of a solventless precipitation technique, a stock solution may be spray-dried. As a second example of a solventless precipitation technique, a metastable metal bicarbonate stock solution may be depressurized to reduce CO₂ solubility, causing CO₂ gas to be released and a metal carbonate to be precipitated. We note that the term “solventless precipitation” does not imply the absolute absence of a miscible liquid or solvent during precipitation, but rather indicates that precipitation is not principally driven by mixing a miscible liquid into the stock solution. One scenario that could be envisioned is a miscible liquid mixed with the process liquid that remains at substantially the same concentration throughout the Liquid Cycle.

“Shuttling” as defined herein, comprises an endomorphic extraction technique that may be used during the Separation Stage, wherein, concurrently: (i) an extractant is generated via reaction of a process gas with a process liquid: (ii) an endomorph is reacted with the extractant solution; (iii) the extractant is consumed; (iv) the solvated ions in the stock solution are exfiltrated from a perimorph; and (v) a precipitate is formed from the stock solution outside of the perimorph. For example, shuttling may comprise, concurrently: (i) forming H₂CO₃ extractant via dissolving CO₂ into process water; (ii) reacting an MgO endomorph with the H₂CO₃ extractant solution; (iii) consuming H₂CO₃; (iv) forming Mg²⁺ and (HCO₃)⁻ ions that are exfiltrated from a perimorph; and (v) precipitating magnesium carbonate in the surrounding process water.

“MgCO₃·xH₂O” is herein used to describe a magnesium carbonate. It may comprise any hydrous or anhydrous magnesium carbonate, as well as basic magnesium carbonates such as hydromagnesite.

A “Template Cycle,” as defined herein, comprises a cyclical loop in which a template is constituted, utilized, and reconstituted.

A “Liquid Cycle,” as defined herein, comprises a cyclical loop in which a process liquid is utilized for liquid-phase extraction of the endomorph and liquid-phase formation of the precursor.

A “Gas Cycle,” as defined herein, comprises a cyclical loop in which a process gas is dissolved into a process liquid to create an extractant solution, then subsequently released and recaptured. The release may be associated with the formation of either a template precursor or a template.

The “yield” of a perimorphic material, or of a procedure used to make the perimorphic material, is defined herein as the perimorphic mass divided by the sum of the endomorphic and perimorphic masses. The yield can be used to understand how much template material is required to create a given amount of perimorphic material.

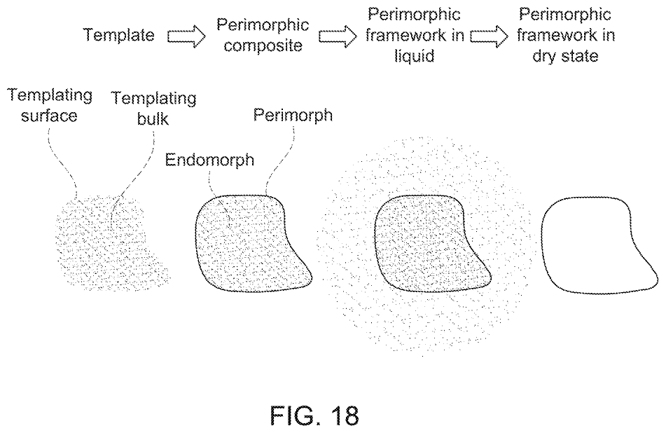

FIG. 18 is a cross-sectional diagram that illustrates surface replication. The first structure in the sequence represents a simple, nonporous template, comprising a templating bulk and templating surface. The second structure in the sequence represents a PC structure comprising an endomorph and perimorph. This composite is formed by application of a conformal perimorphic wall on the templating surface. The third structure in the sequence comprises a perimorphic framework in a liquid. This represents the framework after displacement of the endomorph via liquid-phase extraction. The fourth structure in the sequence represents the framework in its native state after drying. The perimorphic framework's wall substantially replicates the templating surface and its pore substantially replicates the templating bulk.

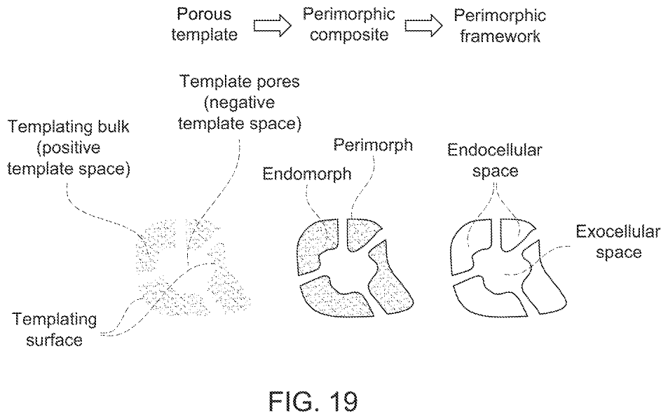

FIG. 19 is a cross-sectional diagram that illustrates the formation of a perimorphic framework using a porous template. The first structure in the sequence represents a template with several pores leading to a central pore. The entire pore space is unoccupied by a solid or liquid mass and comprises a negative space. The second structure in the sequence represents a PC structure comprising an endomorph and perimorph. This composite is formed by application of a conformal perimorph on the templating surface. The PC structure comprises a positive space associated with the endomorph and a negative space associated with the pores of the porous template. The third structure in the sequence represents a perimorphic framework formed by displacement of the endomorph. The framework comprises a negative, endocellular space, corresponding to the PC structure's endomorph, and a negative, exocellular space, corresponding to the PC structure's pores. The endocellular and exocellular spaces are both located inside the perimorphic framework.

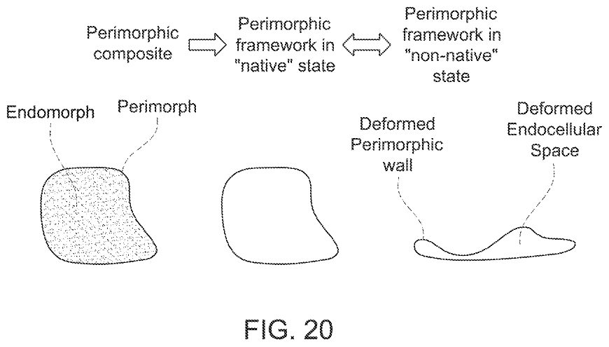

FIG. 20 is a cross-sectional diagram that illustrates the difference between a perimorphic framework in native and non-native morphological states. The first structure in the sequence represents a PC structure comprising an endomorph and perimorph. The morphology of the perimorph in the PC structure represents its native morphology. The second structure in the sequence represents a perimorphic framework formed by displacement of the endomorph. Its morphology is substantially unaltered from its original morphology in the PC structure, and therefore it is in its native state. The third structure in the sequence represents a perimorphic framework that has been deformed and collapsed. In this non-native state, the wall no longer represents a replica of the templating surface, nor does the endocellular space represent a negative replica of the endomorph. If elastically deformed, the framework might be reversibly deformed back into its native morphology.

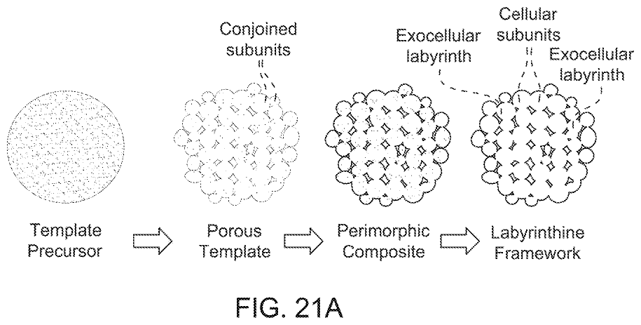

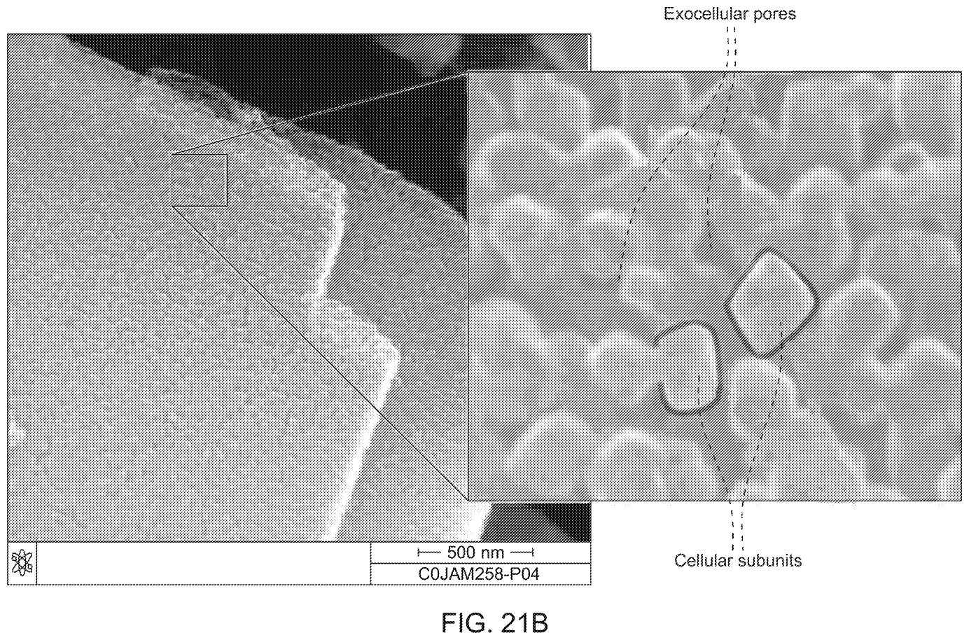

FIG. 21A is a cross-sectional diagram that illustrates the synthesis of a labyrinthine framework. From left to right, the first structure in the sequence represents a template precursor. The second structure represents a porous template. The porous template comprises a labyrinth of connected template pores (although their connectedness is not represented in cross-section). The surface of this porous structure directs the formation of the perimorph. The third structure in the sequence represents a PC structure comprising an endomorph and perimorph. The labyrinth of template pores in the template is inherited by the PC structure. The fourth structure in the sequence represents a labyrinthine framework formed by displacement of the endomorph. The framework natively comprises an endocellular labyrinth, mirroring the template's positive space, as well as an exocellular labyrinth, mirroring its negative space. The endocellular and exocellular labyrinths, while not overlapping, are interwoven throughout the framework's volume.

FIG. 21B is an SEM micrograph of a labyrinthine carbon framework synthesized on a porous MgO template. The endomorph has been displaced and the framework has retained its native morphology. From the main image, we can discern that the framework comprises a rhombohedral superstructure. This superstructure is inherited from a rhombohedral magnesite precursor. From the magnified inset, we can discern the cellular substructure of conjoined cellular subunits. Two such subunits are outlined and labeled in the magnified inset. Each cellular subunit comprises an endocellular pore and an encapsulating portion of the perimorphic wall. We can also discern exocellular pores in the magnified inset, and two such pores are labeled. Exocellular labyrinths traverse the interior of the framework, interwoven with the endocellular labyrinth.

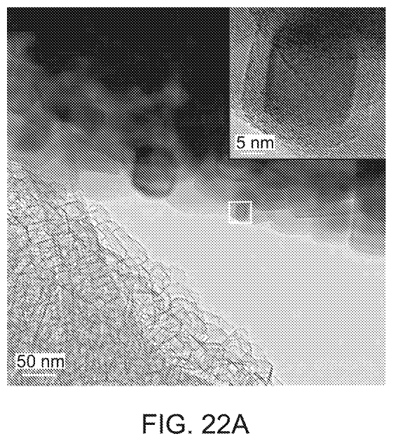

FIG. 22A is a TEM micrograph of (at the top) a PC particle, comprising a graphenic perimorphic phase and an MgO endomorphic phase, and (at the bottom) a graphenic perimorphic framework after endomorphic extraction. FIG. 22B is a HRTEM micrograph showing the disordered, nematically aligned graphenic layers comprising a section of the perimorphic wall.

FIG. 23 is a cross-sectional diagram that illustrates the four categories of superstructural shapes: elongated, thin, equiaxed, and hierarchical-equiaxed. The crosshatching represents the smaller-scale cellular substructure present throughout the superstructure. The exemplary “hierarchical-equiaxed” superstructure shown in FIG. 23 is a hollow sphere with a thin shell.

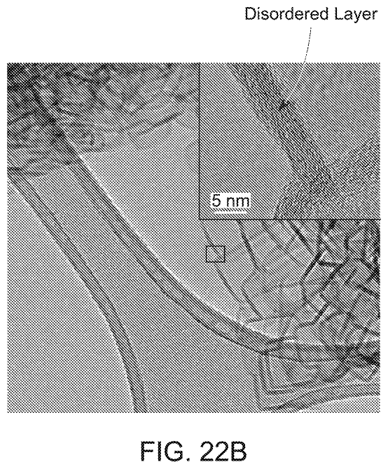

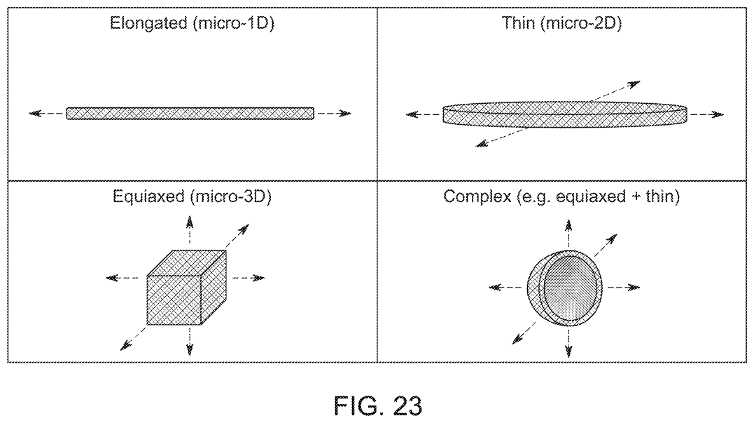

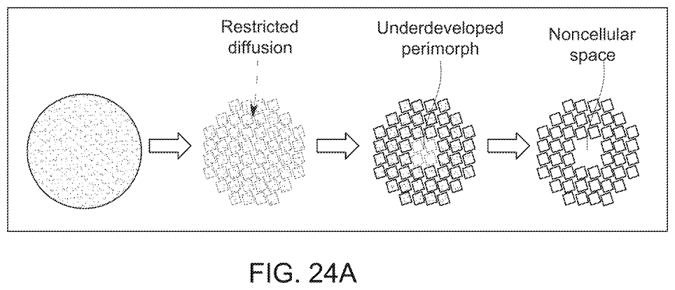

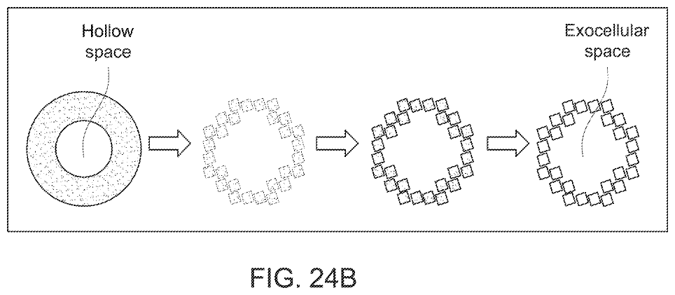

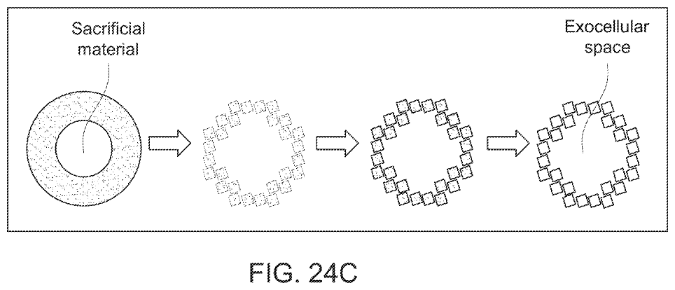

FIG. 24A-24C illustrate how density reduction of a perimorphic framework can be achieved via hierarchical pore engineering. This is a cross-sectional representation, so the template subunits, while appearing disconnected, are connected. FIG. 24A illustrates the creation of a density-reducing noncellular space within a perimorphic framework via a diffusion-limited surface replication procedure. In this case, the template precursor can be nonporous. Diffusion limitations may prevent the uniform distribution of an adsorbate material throughout the porous substructure. This may favor the creation of a perimorphic wall with some gradient of thickness and completeness, and in some instances, this may even result in a hollow, noncellular space inside the perimorphic framework, as illustrated in FIG. 24A. FIG. 24B illustrates the creation of a density-reducing exocellular space within a perimorphic framework via a porous template precursor material created around a trapped region of gas. This may occur due to the effects of an internal blowant or due to formation around a bubble. FIG. 24C illustrates the creation of a density-reducing exocellular space within a perimorphic framework via a porous template precursor material created around a sacrificial material that is subsequently removed.

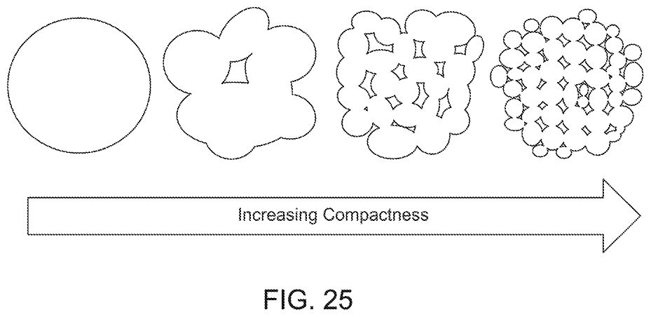

FIG. 25 is a cross-sectional diagram that illustrates three labyrinthine frameworks with different substructures. The substructure represented on the left of the diagram is the least compact of the three. Its volume is similar to the volume of the others, but it contains less perimorphic area within this volume. The substructure represented in the center of the diagram is somewhat more compact than the left-hand substructure, because its volume contains more perimorphic area. The substructure represented on the right of the diagram is the most compact-its volume, though similar to the volume of the other two substructures, contains the most perimorphic area. This diagram demonstrates that a perimorphic framework's compactness is imparted by the volume-specific surface area of the porous template—i.e. the total amount of internal and external surface area per unit of template volume, where the template volume includes the template's positive and negative spaces.

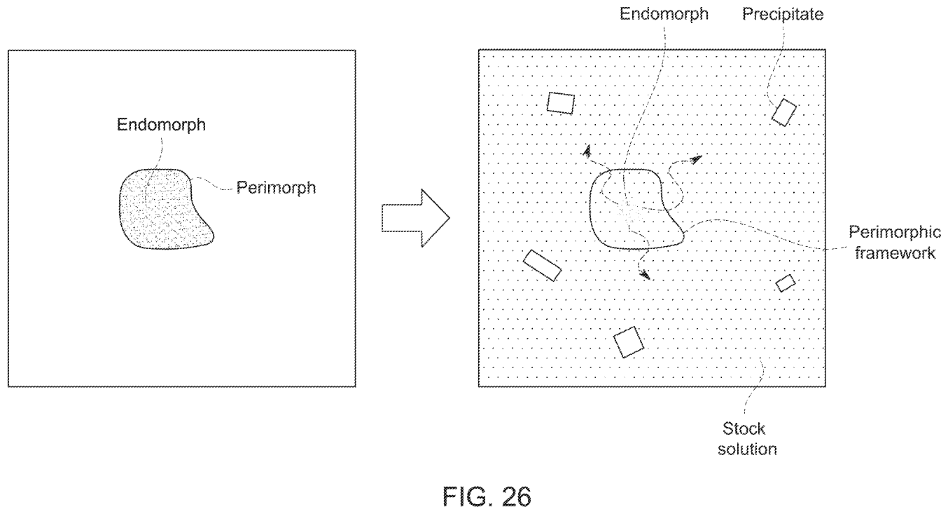

FIG. 26 is a cross-sectional diagram that illustrates shuttling. The first frame in the sequence represents a PC material immersed in an extractant solution. The second frame in the sequence represents a perimorphic framework containing an incompletely extracted endomorph. The endomorph's reaction with the extractant solution is ongoing in this second frame. The solvated ions formed from this reaction are being diffusively exfiltrated from the perimorphic framework, as indicated by the arrows, and are being precipitated in the surrounding process liquid. In other words, the endomorphic mass is being “shuttled” out of the perimorph in the form of solvated ions, a portion of which are then re-precipitated outside the framework. We note that the precipitate and the endomorph may not comprise the same compound.

### II*. Description of the General Method and Variants

The “General Method” is the most basic form of the method. It comprises a method for synthesizing a perimorphic product wherein substantial portions of the template material and the process liquid are conserved and may be reused. As such, the General Method may be performed cyclically. All variants of the method disclosed in the present disclosure comprise some variant of the General Method.

The General Method comprises a series of steps that is herein presented, for ease of description, in 4 stages (i.e. the Precursor Stage, Template Stage, Replication Stage, and Separation Stage). Each stage is defined according to one or more steps, as described below:
Precursor Stage: A precursor material is derived from a stock solution via solventless precipitation. A portion of the process liquid is conserved.
Template Stage: The precursor material formed in the Precursor Stage is treated in one or more procedures to form a template material.
Replication Stage: An adsorbate material is adsorbed to the templating surface of the template to form a PC material.
Separation Stage: Endomorphic extraction and perimorphic separation are performed. Endomorphic extraction produces a stock solution. Perimorphic separation separates the perimorphic product from conserved process materials.

In practice, each step within these stages may itself comprise multiple, subsidiary steps. Additionally, each of the steps may occur concurrently with steps from another stage, such that in practice different stages may overlap in chronology. This can especially be expected in variants employing one-pot techniques. As a hypothetical example of this, a stock solution might be continuously sprayed alongside an adsorbate material into a furnace. In this hypothetical furnace, precursor particles might be precipited from the stock solution, template particles might be formed by heating of the precursor particles, and perimorphic material might be adsorbed to the template particles continuously and concurrently. This would correspond to steps assigned herein to the Precursor Stage, Template Stage, and Replication Stage, respectively.

Similarly, it is anticipated that in practice, many variants of the General Method may incorporate the steps described in the 4 Stages in different sequences. Also, in some variants, a step assigned by definition to one of the four stages herein might instead occur in a different stage. Such variants are anticipated herein and do not deviate from the inventive method, which is only presented herein as a discrete sequence of 4 stages for the sake of describing the overall cycle.

Ancillary processing steps (e.g. rinsing, drying, blending, condensing, spraying, agitating, etc.) may also be incorporated into the method at each stage. As a hypothetical example of this, a Replication Stage might involve coating a template material with a perimorphic material via a liquid-phase adsorption procedure, then filtering, rinsing and drying the resulting PC material. The incorporation of these processing steps in many variants will be obvious to those skilled in the art and, as such, they are not enumerated herein.

The inputs and outputs of the General Method are illustrated in FIG. 3. The General Method comprises a Template Cycle, by which a template material may be conserved and reused, and a Liquid Cycle, by which a process liquid may be conserved and reused.

### Variants of the General Method

The following discussion enumerates a number of ways in which the General Method may be variously implemented. The omission of variants from this discussion should not be interpreted as limiting, since an exhaustive list of ways in which the General Method may be implemented is not practical.

The General Method is intended to offer a means for cyclical production of perimorphic products while conserving process materials. In each cycle of the General Method, some portion of the process materials utilized are conserved and reused. In some variants, substantially all of the process materials utilized may be conserved and reused. In other variants, a portion of the process materials may be lost. One hypothetical example of this would be evaporative losses of process liquids from open tanks or wet filters.

In some variants of the General Method, process steps may correspond to batch processes. In other variants, process steps may correspond to continuous processes.

In some variants of the General Method, the solventless precipitation may comprise at least one of the following techniques: heating or cooling the stock solution to change the solubility of a solute in the stock solution; volatilizing a dissolved gas within the stock solution; depressurizing the stock solution; atomization of the stock solution; spray-drying the stock solution or spray pyrolysis.

In some variants of the General Method, a precursor structure may comprise at least one of the following: an elongated, thin, equiaxed, or hierarchical-equiaxed superstructure; an elongated superstructure with a length-to-diameter ratio greater than 200:1; an elongated superstructure with a length-to-diameter ratio between 50:1 and 200:1; a spheroidal or spherical superstructure; a hollow superstructure; a fragmentary superstructure comprising fragments of some other parent superstructure; a curved, fragmentary superstructure comprising fragments of a hollow superstructure.

In some variants of the General Method, a precursor structure may be precipitated around one or more other sacrificial structures, which may be present as inclusions in the precursor structure after its precipitation. In some variants, these inclusions in the precursor structure may be subsequently removed, resulting in voids.

In some variants of the General Method, a precursor structure may measure less than 1 m along its major axis. In some variants, the precursor may measure between 1 m and 100 m along its major axis. In some variants, the precursor may measure between 100 m and 1,000 m along its major axis.

In some variants of the General Method, the precursor material may comprise at least one of the following: a hydrate; a metal bicarbonate or carbonate; a Group I or Group II metal bicarbonate or carbonate; a mixture of salts. In some variants, the precursor may comprise MgCO₃·xH₂O in the form of at least one of: hexahydrate, lansfordite, nesquehonite, hydromagnesite, dypingite, magnesite, nanocrystalline or non-crystalline MgCOrxH₂O.

In some variants of the General Method, the stock solution may comprise at least one of the following: metal cations and oxyanions; an aqueous metal bicarbonate solution; a Group I or Group II metal bicarbonate; an organic salt; Mg(HCO₃)₂. In some variants, the stock solution may comprise at least one of a dissolved gas, acid, and base. In some variants, the stock solution may be metastable.

In some variants of the General Method, the process liquid conserved in the Precursor Stage may comprise a distillate. In some variants, the distillate may be formed by condensing the process liquid vapor formed during spray-drying or spray-pyrolysis. In some variants, a process liquid conserved in the Precursor Stage may host solvated ions, the process liquid and ions together comprising a mother liquor.

In some variants of the General Method, the treatment performed on a precursor material in the Template Stage may comprise at least one of the following: decomposing the precursor; partially or locally decomposing the precursor; decomposing the precursor surface; thermal decomposition; and oxidizing an organic phase present within a precursor structure. In some variants, the treatment may comprise flash-drying, spray-drying, spray pyrolysis, vacuum drying, rapid heating, slow heating, sublimation. In some variants, a vapor released during the treatment may be conserved. In some variants, the vapor released may comprise at least one of CO₂ and H₂O. In some variants, treatment may comprise at least one of: coarsening the grain structure of the precursor or a decomposition product of the precursor; exposing to a reactive vapor; exposing to water vapor; sintering; sintering with the assistance of dopants.

In some variants of the General Method, a template material may comprise at least one of the following: a metal carbonate, a metal oxide, a Group I or II metal oxide, a transition metal, and MgO. In some variants, a template structure may comprise at least one of the following: macropores, mesopores, hierarchical porosity, subunits larger than 100 nm, subunits between 20 nm and 100 nm, and subunits between 1 nm and 20 nm.

In some variants of the General Method, a template structure may comprise at least one of the following: an elongated, thin, equiaxed, or hierarchical-equiaxed superstructure; an elongated superstructure with a length-to-diameter ratio greater than 200:1; an elongated superstructure with a length-to-diameter ratio between 50:1 and 200:1; a spheroidal or spherical superstructure; a hollow superstructure; a fragmentary superstructure comprising fragments of some other parent superstructure; and a curved, fragmentary superstructure comprising fragments of a hollow superstructure.

In some variants of the General Method, adsorbing the perimorphic material to the templating surface may comprise at least one of the following: a coating technique, physical vapor deposition, and chemical vapor deposition. In some variants, the coating technique may comprise coating a liquid or solid organic coating onto the templating surface, then forming a derivative carbon coating from the parent coating. In some variants, deposition may comprise pyrolytic decomposition of a vapor-phase organic compound at a temperature between 350° C. and 950° C. In some variants, a perimorphic carbon may be annealed after being adsorbed to the templating surface.

In some variants of the General Method, endomorphic extraction may utilize an extractant solution comprising a weak acid as an extractant. In some variants, an extractant solution may be formed by dissolving a process gas in process water. In some variants, the extractant solution may be an aqueous solution of H₂CO₃ formed by dissolving liquid or gaseous CO₂ in process water. In some variants, endomorphic extraction may comprise a shuttling technique. In some variants, endomorphic extraction may be performed under conditions of elevated pressure or temperature.

In some variants of the General Method, the perimorphic separation may comprise at least one of decantation, hydrocyclones, settling, sedimentation, flotation, froth flotation, centrifugal separation, filtration, and liquid-liquid extraction. In some variants, the perimorphic separation may separate the perimorphic product from substantially all of the process liquid. In some variants, the perimorphic product may retain a residual portion of the process liquid. In some variants, the perimorphic product may be naturally buoyant due to its retention of internal gas. In some variants, the perimorphic product's internal gas may be expanded by reducing pressure of the surrounding process liquid, increasing the buoyancy of the perimorphic product and causing flotation. In some variants, a portion of the perimorphic product's internal gas may be exfiltrated by reducing pressure of the surrounding process liquid, followed by re-pressurizing the surround process liquid, such that hydrostatic pressure causes the process liquid to infiltrate the perimorphic product.

In some variants of the General Method, the perimorphic framework may comprise at least one of a carbonaceous material, a pyrolytic carbon, an anthracitic network of carbon, an sp^{x} network of carbon, and a helicoidal network of carbon.

In some variants of the General Method, under 532 nm excitation, the carbonaceous perimorphic framework may comprise at least one of a Raman spectral I_{D}/I_{G} ratio of between 4.0 and 1.5; a Raman spectral I_{D}/I_{G} ratio between 1.5 and 1.0; a Raman spectral I_{D}/I_{G} ratio between 1.0 and 0.1; a Raman spectral I_{Tr}/I_{G} ratio between 0.0 and 0.1; a Raman spectral I_{Tr}/I_{G} ratio between 0.1 and 0.5; a Raman spectral I_{Tr}/I_{G} ratio between 0.5 and 1.0; a Raman spectral I_{2D}/I_{G} ratio between 0 and 0.15; a Raman spectral I_{2D}/I_{G} ratio between 0.15 and 0.3; and a Raman spectral I_{2D}/I_{G} ratio between 0.30 and 2.0.

In some variants of the General Method, under 532 nm excitation, the carbonaceous perimorphic framework may comprise at least one of an unfitted Raman spectral D peak positioned between 1345 and 1375 cm⁻¹; an unfitted Raman spectral D peak positioned between 1332 and 1345 cm⁻¹; an unfitted Raman spectral D peak positioned between 1300 and 1332 cm⁻¹; an unfitted Raman spectral G peak positioned between 1520 cm⁻¹ and 1585 cm⁻¹; an unfitted Raman spectral G peak positioned between 1585 cm⁻¹ and 1600 cm⁻¹; and an unfitted Raman spectral G peak positioned between 1600 cm⁻¹ and 1615 cm⁻¹.

In some variants of the General Method, the perimorphic product may comprise a perimorphic framework. In some variants, the perimorphic framework may comprise at least one of a native morphology, a non-native morphology, internal gas, a hydrophobic surface, a hydrophilic surface, mesopores, one or more macropores, hierarchical porosity.

In some variants of the General Method, the perimorphic framework may measure less than 1 m along its major axis. In some variants, the perimorphic framework may measure between 1 m and 100 m along its major axis. In some variants, the perimorphic framework may measure between 100 m and 1,000 m along its major axis. In some variants, the perimorphic framework may comprise an elongated, thin, equiaxed, or hierarchical-equiaxed superstructure. In some variants, an elongated perimorphic framework may comprise a length-to-diameter ratio between 50:1 and 200:1. In some variants, the perimorphic framework's equiaxed superstructure may be spheroidal or spherical. In some variants, the perimorphic framework's equiaxed superstructure may be hollow. In some variants, the perimorphic framework may comprise fragments of a hollow shell. In some variants, the perimorphic framework may comprise a noncellular space.

In some variants of the General method, the perimorphic framework may comprise a BET surface area of 1,500 to 3,000 m²/g. In some variants, the perimorphic framework may comprise a BET surface area of 10 to 1,500 m²/g.

In some variants of the General Method, the perimorphic product may be subjected to further treatment after perimorphic separation. In some variants, the further treatment after perimorphic separation may comprise at least one of flash-drying, spray-drying, spray-pyrolysis, decomposition, chemical reaction, annealing, and chemical functionalization.

In some variants of the General Method, the Liquid Cycle may also incorporate the recapture and conservation of process liquid released (possibly in vapor phase) during the Template Stage, although this is not reflected as an output in FIG. 3. It is not reflected because in most (but not all) of the variants of the General Method envisioned, the quantity of process liquid conserved during the Template Stage would be significantly smaller than the quantity of process liquid conserved in the Precursor Stage.

In some variants of the General Method, a Gas Cycle may be incorporated into the method. The inputs and outputs of the General Method with a Gas Cycle are illustrated in FIG. 4. In a Gas Cycle, a process gas is released during the Precursor Stage and/or the Template Stage. This released gas is conserved. Then, during the Separation Stage, the conserved process gas may be dissolved into conserved process liquid in order to generate an extractant solution.

The Preferred Method, described below, comprises variants of the General Method in which a MgCO₃·xH₂O template precursor material is derived from an aqueous Mg(HCO₃)₂ stock solution and a portion of the CO₂ process gas is conserved via a Gas Cycle. The inputs and outputs of the Preferred Method are shown in FIG. 5. The Preferred Method comprises:
Precursor Stage: MgCO₃·xH₂O precursor material is derived from an aqueous Mg(HCO₃)₂ stock solution, wherein the derivation comprises a solventless precipitation of MgCO₃·xH₂O and an emission of CO₂ process gas. A portion of released CO₂ process gas is conserved. The MgCO₃·xH₂O precursor material and process water are separated. Process water is conserved.
Template Stage: The MgCO₃·xH₂O precursor material formed in the Precursor Stage is thermally decomposed in one or more procedures to form a porous MgO template material. Released CO₂ process gas may be conserved.
Replication Stage: An organic or carbonaceous perimorphic material is adsorbed to the templating surface of the porous MgO template to form a PC material.
Separation Stage: Conserved CO₂ process gas is dissolved into conserved process water to form an aqueous H₂CO₃ extractant solution. Endomorphic extraction comprises a reaction between endomorphic MgO and the aqueous H₂CO₃ extractant solution, generating an aqueous Mg(HCO₃)₂ stock solution. Perimorphic separation may comprise techniques that displace process water from the perimorphic product, minimizing residual process water. Froth flotation, liquid-liquid separation, or other techniques that separate the carbon perimorphic based on hydrophobicity may be used.

Certain variants of the Preferred Method may employ pressure modulations in order to form concentrated stock solutions and improve precipitation processes. Concentrated stock solutions may be associated with many benefits, including superior precipitation kinetics, reduced process water volumes, smaller vessels, and improved energy efficiency. Two exemplary ways that this can be done are illustrated in FIG. 27A-FIG. 27B and described below.

In the first frame of FIG. 27A, a shuttling technique has been used to obtain endomorphic extraction. The shuttling technique results in a mixture comprising aqueous Mg(HCO₃)₂ stock solution, perimorphic framework(s), and the MgCO₃·xH₂O precipitate. This precipitate is represented in the first frame of FIG. 27A as a mixture of nesquehonite rods and acicular nesquehonite agglomerates. Next, the perimorphic product is separated from the other process liquids and solids. Following this, the MgCO₃·xH₂O precipitate is dissolved by increasing the CO₂ pressure, which increases the concentration of dissolved CO₂, H₂CO₃ and HCO₃⁻, forming a concentrated stock solution, as shown in the second frame of FIG. 27A. Finally, as shown in the third frame, the MgCO₃·xH₂O precursor may be rapidly nucleated and precipitated from the concentrated stock solution by reducing the CO₂ pressure (and optionally the total pressure).

Another way that a concentrated stock solution may be obtained is by performing the endomorphic extraction in a pressurized reactor. A schematic showing this is illustrated in FIG. 27B. Similar to the procedure illustrated in FIG. 27A, the procedure illustrated in FIG. 27B employs increased CO₂ pressure to increase the concentration of dissolved CO₂, H₂CO₃ and HCO₃⁻. In FIG. 27B, PC material, CO₂, and H₂O (possibly an aqueous Mg(HCO₃)₂ mother liquor) are fed into a pressurized reactor. Endomorphic extraction and the formation of a concentrated stock solution occur within the pressurized reactor. The mixture of the perimorphic product and concentrated stock solution is discharged from the pressurized reactor, where perimorphic separation can then occur. Separation may be beneficially accomplished using a liquid-liquid separation that eliminates rinsing requirements. The MgCO₃·xH₂O precursor may be rapidly nucleated and precipitated from the concentrated stock solution by reducing the CO₂ pressure (and optionally the total pressure).

### III*. Furnace Schemes, Analytical Techniques and Material Naming

In the course of describing procedures to generate the exemplary materials described in the subsequent sections, certain furnace schemes have been detailed. These schemes may be used for the exemplary Template Stage procedures detailed in Section V and for the exemplary Replication Stage procedures detailed in Section VI.

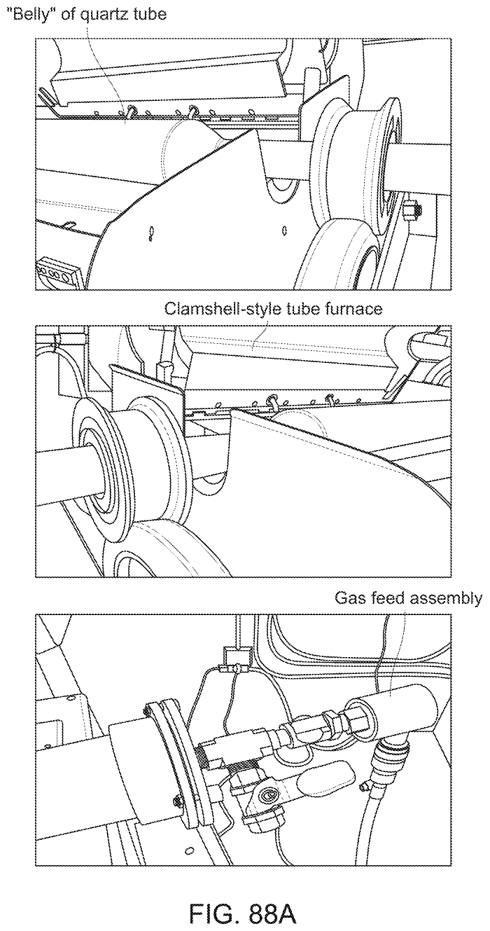

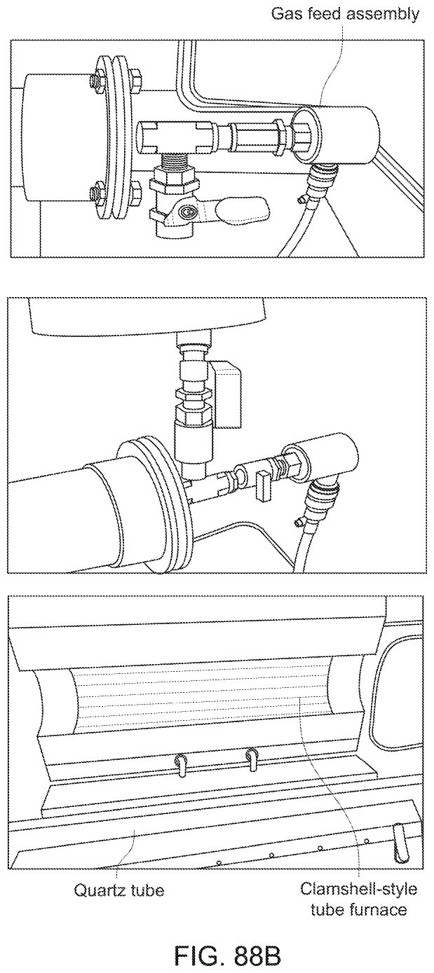

Scheme A: In Scheme A, a Thermcraft tube furnace modified to be a rotary furnace may be employed with a quartz tube (FIG. 88A). The furnace has a clam shell design with a cylindrical heating chamber of 160 mm diameter and 610 mm heated length. The furnace has a wattage of 6800 W with a maximum operating temperature of 1100° C. The quartz tube may be a 60 mm OD quartz tube containing an expanded middle section of 130 mm OD tube (the “belly”) positioned within the furnace's heating zone. The tube may be rotated. Quartz baffles inside the belly may facilitate agitation of the a powder sample during rotation. The furnace may be kept level (i.e. not tilted). The template powder sample may be placed inside the belly in the heating zone, with ceramic blocks inserted outside the belly on each side of the furnace's heating zone. Glass wool may be used to fix the position of the ceramic blocks.

For exemplary procedures performed using Scheme A, a material sample may be placed inside the belly, such that it agitated within the reactor. Loose fitting ceramic blocks located outside the belly section on each side of the furnace's heating zone allowing for gas flow and powder containment. Packed glass wool may be used to affix the position of the ceramic blocks while acting as a gas permeable layer. The ends of the tube may be fitted with two stainless-steel flanges to allow for gas to flow for the system.

Scheme B: An MTI rotary tube furnace with a quartz tube (FIG. 88B) may be used. The furnace has a clam shell design with a cylindrical heated chamber having dimensions of 120 mm diameter and 440 mm heated length. The furnace has a wattage of 2500 W with a maximum operating temperature of 1150° C. The quartz tube may be 60 mm in OD. The tube may be substantially level. For exemplary procedures performed using Scheme B, a material sample may be placed within a ceramic boat. This may then be placed inside the quartz tube within the heating zone prior to the initialization of heating. Loose fitting ceramic blocks located outside the furnace's heating zone allow for gas flow. Packed glass wool may be used to affix the position of the ceramic blocks while acting as a gas permeable layer. The ends of the tube may be fitted with two stainless-steel flanges.

Scheme C: A Lindberg Blue-M tube furnace with a quartz tube may be used. The quartz tube may be 150 mm in OD. The furnace has a clam shell design with a cylindrical heated chamber having dimensions of 190 mm diameter and 890 mm heated length. The furnace has a wattage of 11,200 W with a maximum operating temperature of 1200° C. The tube may be substantially level. For exemplary procedures performed using Scheme C, a sample may be placed within a ceramic boat. This may then be placed inside the quartz tube within the heating zone prior to the initialization of heating. Loose fitting ceramic blocks located outside the furnace's heating zone allow for gas flow. The ends of the tube may be fitted with two aluminum flanges to allow for gas flow through the system.

Scheme D: A Vulcan 3-550 Muffle furnace may be used. The furnace has a rectangular heated chamber having dimensions of 190 mm×240 mm×228 mm. The furnace has a wattage of 1440 W with a maximum operating temperature of 1100° C. For exemplary procedures performed using Scheme D, a material sample may be placed within a ceramic boat. This may then be placed inside the muffle furnace prior to the initialization of heating.

Scheme E: A TA Instruments Q600 TGA/DSC may be used. For exemplary procedures performed using Scheme E, a 90 μL alumina pan may be used to hold a material sample. Gas flow may be 100 sccm of a specified gas unless otherwise noted. The heating rate may be mentioned in the exemplary procedures where Scheme E is used.

A number of analytical techniques were utilized to characterize the procedures and materials presented herein. These are detailed below.

Solution concentrations were measured using electrolytic conductivity (“conductivity”). The conductivity is a measured response of a solution's electrical conductance. The electrical response of a solution may be correlated to the concentration of ions dissolved in the solution, and as ions in solution are precipitated, the conductivity value decreases. An analog to this measurement is total dissolved solids (“TDS”) which relates the conductivity measurement to a referenced ion concentration (typically potassium chloride), dependent on the salt compound dissolved.

Thermogravimetric analysis (TGA) was used to analyze the thermal stability and composition of materials. All TGA characterization was performed on a TA Instruments Q600 TGA/DSC. A 90 μL alumina pan was used to hold the sample during TGA analysis. All analytical TGA procedures were performed at 20° C. per min unless otherwise mentioned. Either air or Ar (Ar) was used as the carrier gas during analytical TGA procedures unless otherwise mentioned.

Raman spectroscopy was performed using a ThermoFisher DXR Raman microscope equipped with a 532 nm excitation laser. For each sample analyzed, 16 point spectra were generated using measurements taken over a 4×4 point rectangular grid with point-to-point intervals of 5 m. The 16 point spectra were then averaged to create an average spectrum. The Raman peak intensity ratios and Raman peak positions reported for each sample all derive from the sample's average spectrum. No profile fitting software was utilized, so the reported peak intensity ratios and peak positions relate to the unfitted peaks pertaining to the overall Raman profile.

Gas adsorption measurements were made using a Micromeritics Tristar II Plus. Nitrogen adsorption was measured at a temperature of 77 K across a range of pressure (p) values, where

$$0.005 < \frac{p}{{p}^{0}} < 0.3 .$$

Increments of pressure ranged from

$$\frac{p}{{p}^{0}} = 0.009$$

up to

$$\frac{p}{{p}^{0}} = 0.05 .$$

Micromeritics MicroActive software was used to calculate the BET specific surface area derived from the BET monolayer capacity assuming the cross-sectional area σₘ(N₂, 77 K)=0.162 nm². Samples were preconditioned by degassing with continuously flowing dry nitrogen gas at 100° C. prior to analysis.

The pore size distribution (PSD) and cumulative volume of pores is another technique that may be performed from gas adsorption data to lend insight into the sintering behavior of particles. The data was collected by a Micromeritics Tristar II Plus, measuring nitrogen adsorption and desorption at 77 K between pressures of

$$0.009 < \frac{p}{{p}^{0}} < 0.99 ,$$

with increments ranging from

$$\frac{p}{{p}^{0}} = 0.009$$

up to

$$\frac{p}{{p}^{0}} = 0.05 .$$

Samples were preconditioned by degassing with continuously flowing dry nitrogen gas at 100° C. prior to analysis.

Micromeritics MicroActive software was used to calculate adsorption-desorption PSD and cumulative volume of pores by applying the Barrett, Joyner and Halenda (BJH) method. This method provides a comparative assessment of mesopore size distributions for gas adsorption data. For all BJH data, the Faas correction and Harkins and Jura thickness curve may be applied. The cumulative volume of pores, V_{PORE} (cm³/g), may be measured for both adsorption and desorption portions of the isotherm.

There are a number of exemplary materials described in the present disclosure. To aid in identification and tracking of these exemplary materials, a material naming system has been adopted and is described below. All names of exemplary materials are bolded; N₂ herein describes an exemplary material, while N₂ refers to nitrogen gas.

Exemplary types of template precursor materials are denoted Sₓ, where S designates the first one or two letters of the template precursor material (i.e. N for nesquehonite, L for lansfordite, Li for lithium carbonate, C for magnesium citrate, A for amorphous/non-crystalline MgCO₃·xH₂O, H for hydromagnesite, M for magnesite, E for epsomite, and Ca for calcium carbonate) and where x designates different types of the precursor compound (e.g. H₁ and H₂ designate two different types of hydromagnesite precursors).

Exemplary types of template materials are named in the format SₓT_{y}. The Sₓ name component designates the precursor type that was utilized to create the template type SₓT_{y}, and the T_{y} name component designates a specific treatment that was utilized to create the template type SₓT_{y}. For example, N₁T₁ and N₁T₂ indicate two different template types formed from two different treatments on the precursor type N₁. We note that while the full SₓT_{y} name denotes a specific template type, the T_{y} name component by itself is only specific with respect to a given Sₓ precursor type. For example, the treatments utilized to make the template types N₁T₁ and N₂T₁ were different, despite these template types sharing the same T₁ name component.

Exemplary types of PC materials are named in the format SₓT_{y}P_{z}, where the SₓT_{y} name component designates the template type and the P_{z} name component designates a specific type of carbon perimorph. For example, M₃T₁P₁ and M₃T₁P₂ indicate two different PC materials formed from the same M₃T₁ template material. The P_{z} name component within the SₓT_{y}P_{z} name is unique—i.e. each P_{z} name component specifies a unique type of perimorph, irrespective of the SₓT_{y} template type utilized to make the perimorph.

Exemplary types of perimorphic frameworks (i.e. the porous perimorphic product resulting from endomorphic extraction) are named in the format P_{z}, where the P_{z} name component is not prefaced with an SₓT_{y} template type. The P_{z} name component utilized to name a framework type matches the P_{z} name component of the SₓT_{y}P_{z} PC material type from which the framework type was derived.

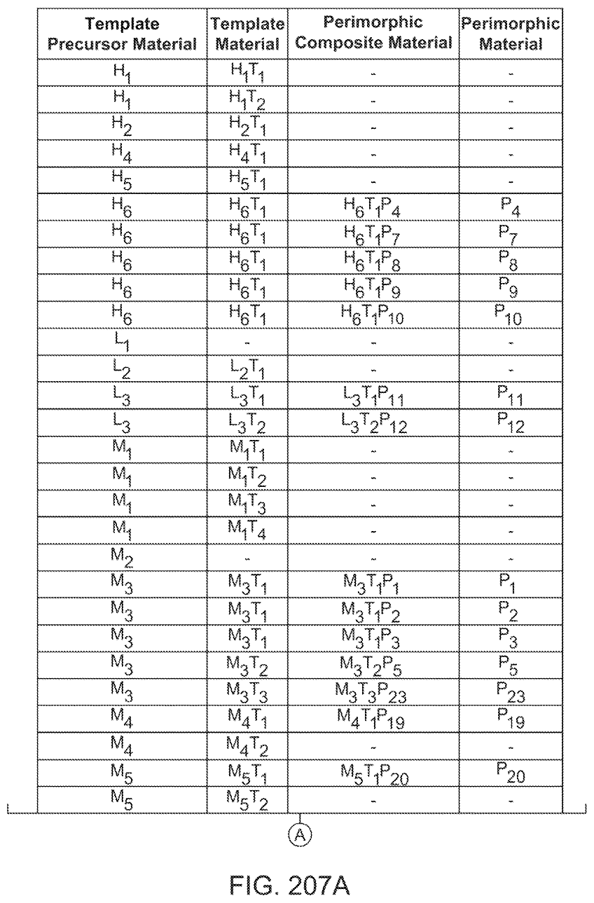

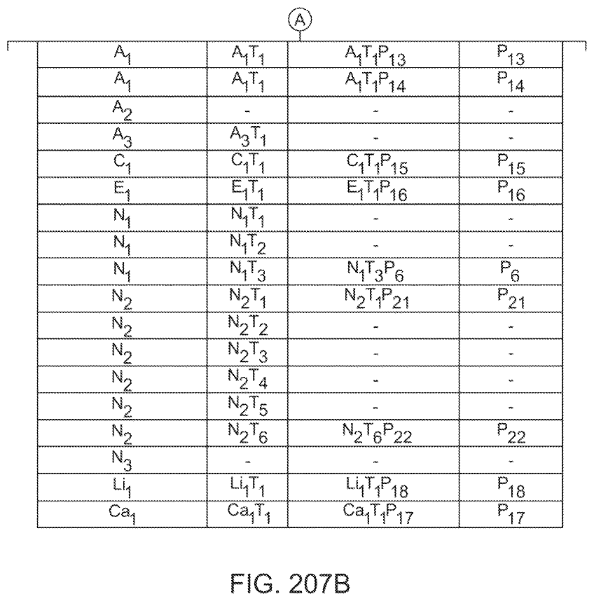

The exemplary types of template precursor materials, template materials, perimorphic composite materials, and perimorphic materials in this disclosure are enumerated in FIG. 207. FIG. 207 is arranged to show the progression of the materials synthesized, starting from the template precursor material. While not every exemplary material was tracked through all four stages, it is understood that any of the exemplary materials might be, if desired. FIG. 207 also follows the material naming system described above.

### IV*. Precursor Stage—Examples

This Section details the generation of exemplary template precursor materials at small scales using exemplary procedures. As such, these procedures comprise partial implementations of the General Method. It should be therefore understood that these procedures must be coupled with other procedures in a full implementation of the General Method. Additionally, it should be understood that these procedures are merely demonstrative of analogous, larger-scale procedures that would be used for industrial-scale manufacturing.

Various techniques may be utilized in the precipitation of precursor materials. For example, the stock solution may be heated to evaporate the process liquid, causing the stock solution to become supersaturated and to precipitate a precursor material. This may be combined with techniques to control the shape and size of the precipitated template precursor particles. For example, the stock solution may be spray-dried to create discrete spheres or hollow spheres. Other techniques may be utilized that will be obvious to those skilled in the art.

Example N₁: In an exemplary Precursor Stage procedure, an elongated nesquehonite (MgCO₃·3H₂O) template precursor material may be derived from a stock solution of aqueous Mg(HCO₃)₂.

To demonstrate this derivation at a small scale, a representative stock solution may first be prepared. This stock solution represents the stock solution that might be generated during the Separation Stage of a full implementation of the General Method. For this example, a representative aqueous Mg(HCO₃)₂ stock solution may be generated using water, CO₂ gas, and MgO.

First, a 0.24 mol kg⁻¹ Mg mixture comprising deionized water and Akrochem Elastomag 170, a commercial magnesium oxide (MgO) product, may be made. This mixture may be carbonated in a circulation tank with a sparge tube bubbling CO₂ to generate carbonic acid. The CO₂ bubbling may be discontinued after the MgO is completely dissolved to form the stock solution. The stock solution may be approximately 14.5° C.

Next, air bubbling may be initiated through a sparge tube through the stock solution in the circulation tank at an approximate flow rate of 12 scfmₐᵢᵣ. This bubbling may cause precipitation of nesquehonite particles and an associated emission of CO₂ process gas. Bubbling and circulation may be continued until the conductivity of the solution stabilizes. At this point, the aqueous mixture of nesquehonite particles may be filtered, separating the particles from the aqueous Mg(HCO₃)₂ filtrate. This filtrate comprises a mother liquor and substantially all of the process water. In a full implementation of the General Method, the separated process water may be conserved for reuse, as shown in FIG. 3. Additionally, in a full implementation of the General Method, the emitted CO₂ process gas may also be conserved for reuse using conventional techniques.

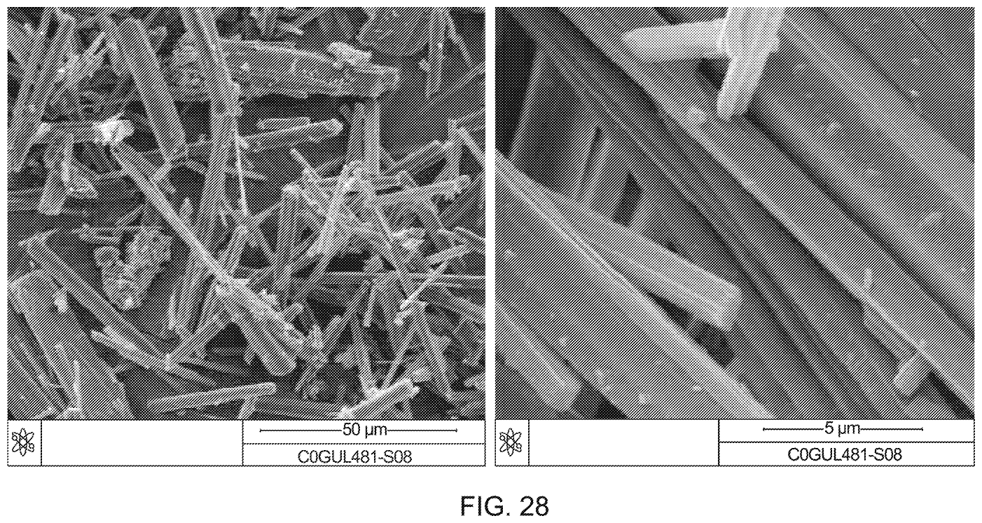

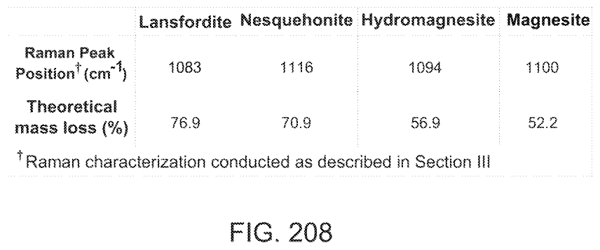

Nesquehonite template precursor particles of the type generated by this procedure may be identified herein as N₁ and may be seen in the SEM micrograph in FIG. 28. The template precursor may be confirmed as nesquehonite via the elongated morphology and TGA mass loss of 70.4%, which is in good agreement with the expected nesquehonite mass loss of 70.9%, as shown in FIG. 208.

Aside from the presence of some minor debris, the crystals have smooth, thin surfaces. The elongated morphology of these crystals may be valuable. In applications requiring interlocking particles, such as filtration membranes, an elongated morphology may be useful. In applications requiring the assembly of a percolative network, such as for electron transport, elongated particles may achieve percolation with fewer particles than more equiaxed particle morphologies. In applications requiring mechanical reinforcement, elongated particles may provide superior tensile properties.

Example H₁: In another exemplary Precursor Stage procedure, a hierarchical-equiaxed hydromagnesite (Mg₅(CO3)₄(OH)₂·4H₂O) template precursor material may be derived from a stock solution of aqueous Mg(HCO₃)₂.

To demonstrate this derivation at a small scale, a representative stock solution may first be prepared. This stock solution represents the stock solution that might be generated in the Separation Stage of a full implementation of the General Method. For this example, an aqueous Mg(HCO₃)₂ stock solution with an approximate molality of 0.14 mol kg⁻¹ Mg (aq) may first be prepared as the representative stock solution.

Next, the stock solution may be placed in a 1 L Buchi rotary evaporator vessel, which may then be rotated at 280 RPM in a 100° C. water bath. Crystallization may be allowed to proceed until most of the Mg ions have been precipitated as hydromagnesite precursor particles. Associated with this precipitation, CO₂ process gas may be emitted. In a full implementation of the General Method, the CO₂ process gas released during precipitation may be conserved using conventional techniques.

The resulting hydromagnesite mixture may then be filtered to separate the solids from the aqueous Mg(HCO₃)₂ filtrate. This filtrate comprises a mother liquor and substantially all of the process water. In a full implementation of the General Method, the separated mother liquor may be conserved for reuse.

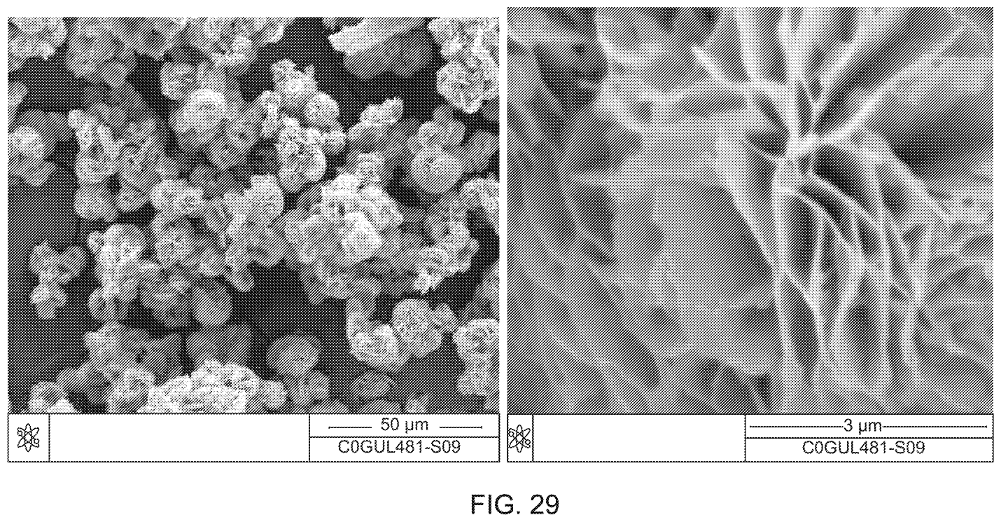

Hydromagnesite template precursor particles of the type generated by this procedure are identified herein as H₁ and may be seen in the representative SEM micrographs in FIG. 29. TGA mass loss of these particles is 56.6%, which is in good agreement with the expected hydromagnesite mass loss of 56.9% (FIG. 208). The thin (<100 nm thick) hydromagnesite plates are arranged in a hierarchical-equiaxed superstructure. This template precursor morphology is of interest due to the combination of thin and equiaxed morphological features. In applications requiring high surface area, the hierarchical-equiaxed morphology may prevent the surfaces of the thin crystals from being occluded, whereas simple planar particles may tend to stack against one another and occlude one another's surfaces.

Example H₂: In another exemplary Precursor Stage procedure, an elongated, hierarchical hydromagnesite (Mg₅(CO3)₄(OH)₂·4H₂O) template precursor material may be derived from a stock solution of aqueous Mg(HCO₃)₂.

To demonstrate this derivation at a small scale, nesquehonite may first be precipitated from a representative aqueous Mg(HCO₃)₂ stock solution. This stock solution represents the stock solution that might be generated during the Separation Stage of a full implementation of the General Method. For this example, a representative stock solution and an aqueous mixture of precipitated nesquehonite may be obtained using the procedure described in Example N₁. Associated with this nesquehonite precipitation, CO₂ process gas may be emitted. In a full implementation of the General Method, the released CO₂ process gas may be conserved using conventional techniques.

Next, the nesquehonite mixture may be heated to 100° C. and maintained at that temperature until recrystallization into hydromagnesite is complete. In this exemplary procedure, the process water may be completely evaporated, separating it from the solid residue of elongated hydromagnesite particles. In a full implementation of the General Method, the separated process water may be conserved using conventional techniques.

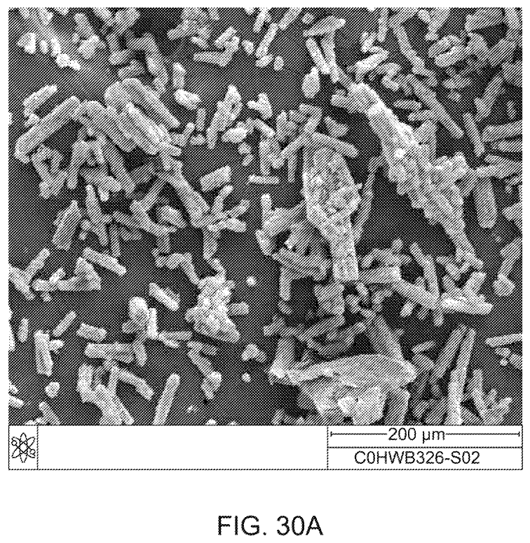

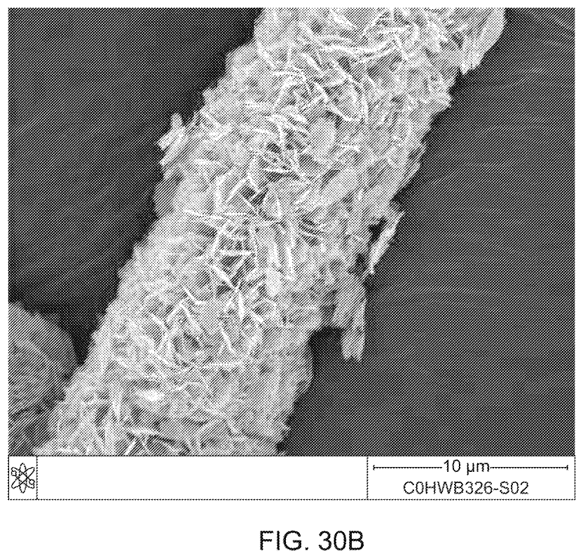

Hydromagnesite template precursor particles of the type generated by this procedure are identified herein as H₂ and may be seen in the representative SEM micrographs in FIG. 30A-30B. This template precursor material may combine the aforementioned virtues of elongated and thin morphologies.

Example H₃: In another exemplary Precursor Stage procedure, a plate-like hydromagnesite (Mg₅(CO3)₄(OH)₂·4H₂O) template precursor material may be derived from a stock solution of aqueous Mg(HCO₃)₂.

To demonstrate this derivation at a small scale, a hierarchical hydromagnesite may first be derived from a representative aqueous Mg(HCO₃)₂ stock solution. This stock solution represents the stock solution that might be generated during the Separation Stage of a full implementation of the General Method. For this example, a representative stock solution and precipitated hydromagnesite particles may be obtained using the procedure described in Example H₂. Associated with the precipitation, CO₂ process gas may be emitted. In a full implementation of the General Method, the released CO₂ process gas may be conserved using conventional techniques. Additionally, separated process water may be conserved in a full implementation of the General Method.

Next, the hierarchical hydromagnesite particles may be mechanically broken. This might be accomplished in a number of ways using known milling techniques. For the purpose of demonstration, the particles may be slurried in process water. The mixture may then be agitated using high-shear techniques to break the delicate, hierarchical hydromagnesite particles into their constituent, individualized plates. The plate-like hydromagnesite particles may then be filtered from the process water. In a full implementation of the General Method, the separated process water may be conserved for reuse.

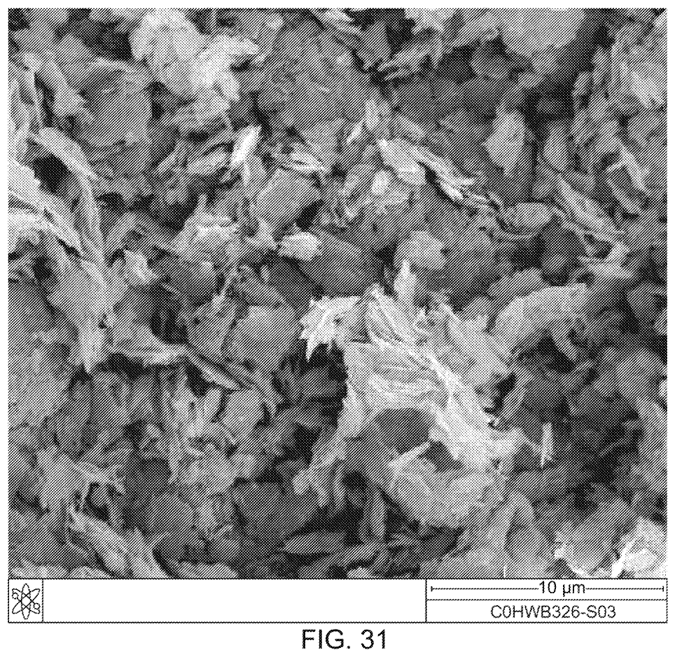

Hydromagnesite template precursor particles of the type generated by this procedure are identified herein as H₃ and may be seen in the representative SEM micrograph FIG. 31. TGA mass loss of these particles is 56.6%, which is in good agreement with the expected hydromagnesite mass loss of 56.9%, as seen in FIG. 208.

Example L₁: In another exemplary Precursor Stage procedure, an equiaxed lansfordite (MgCO3·5H₂O) template precursor material may be derived from a stock solution of aqueous Mg(HCO₃)₂.

To demonstrate this derivation at a small scale, a representative stock solution may first be prepared. This stock solution represents the stock solution that might be generated in the Separation Stage of a full implementation of the General Method. For this example, a representative aqueous Mg(HCO₃)₂ stock solution with a concentration of approximately 0.25 mol kg⁻¹ Mg (aq) may be prepared and chilled to 2° C.

The chilled stock solution may then be subjected to N₂ bubbling at a flow rate of 4 scfhₐᵢᵣ. The resulting precipitation may cause CO₂ process gas to be emitted. In a full implementation of the General Method, CO₂ process gas released during precipitation may be conserved using conventional techniques.

After 67 minutes, N₂ bubbling may be discontinued. The crystals formed may be allowed to stir for an additional 50 minutes after discontinuation of N₂ bubbling, and the mixture may then be filtered to separate the solids from the mother liquor. The solids may be rinsed with 5° C. deionized water. In a full implementation of the General Method, the separated mother liquor may be conserved for reuse.

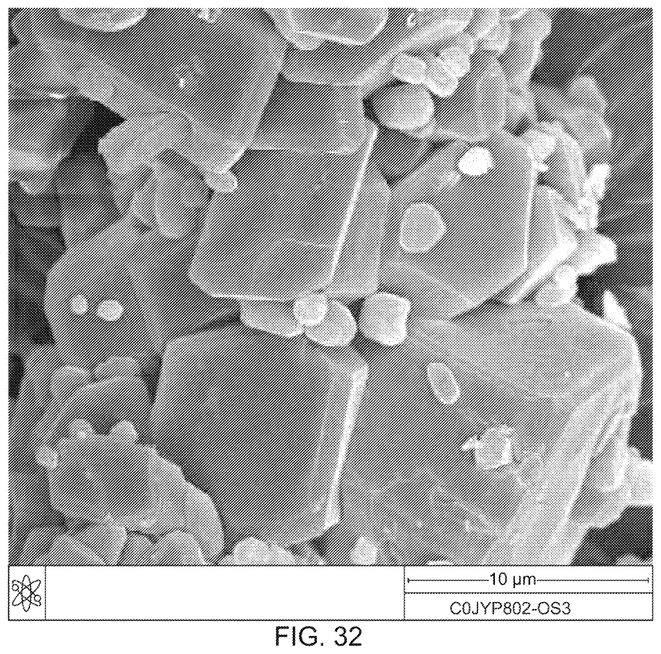

Lansfordite template precursor particles of the type generated by this procedure are identified herein as Li and may be seen in the representative SEM micrograph FIG. 32. The template precursor particles have the prismatic, equiaxed morphology typical of lansfordite, and the TGA mass loss of these particles is 76.4%, which is in good agreement with the expected lansfordite mass loss of 76.9%. as seen in FIG. 208. The prismatic, equiaxed morphology may be desirable for applications in which perimorphic products must be integrated with liquids and viscosity effects must be minimized. Additionally, due to lansfordite's relatively high state of hydration, more template precursor volume is generated for a given mass of Mg than is obtainable with less hydrated MgCO₃·xH₂O, and more template pore volume may be obtained upon decomposition of the precursor material. This can be used to create perimorphic frameworks with more exocellular space.

Raman spectroscopy may be used to characterize the chemical composition of the template precursor materials. Applying this Raman spectroscopy method results in a match of peak positions consistent with lansfordite at 1083 cm⁻¹, as seen in FIG. 208.

Example L₂: In another exemplary Precursor Stage procedure, an equiaxed lansfordite (MgCO3.5H₂O) template precursor material may derived from a stock solution of aqueous Mg(HCO₃)₂.

To demonstrate this derivation at a small scale, a representative stock solution may first be prepared. This stock solution represents the stock solution that might be generated in the Separation Stage of a full implementation of the General Method. For this example, a representative stock solution may be obtained as follows. First, an aqueous mixture of precipitated nesquehonite may be obtained using the procedure described in Example N₁. The concentration of this mixture may be adjusted to 0.62 mol kg⁻¹ Mg. The mixture may then be added to a high-pressure baffled reactor outfitted with a gas inducing impeller. The system may be stirred at 700 RPM and cooled to 5° C. while injecting CO₂ process gas into the reactor's headspace up to a pressure of 850 psi, or until all solids have been dissolved, resulting In the representative, pressurized stock solution.

Upon depressurizing the stock solution to atmospheric pressure, the stirring rate may be reduced to 500 RPM and the solution may be maintained at 12° C. while air is flowed through the headspace. The resulting precipitation of lansfordite particles may cause CO₂ process gas to be emitted. In a full implementation of the General Method, CO₂ process gas released during precipitation may be conserved using conventional techniques.

After 228 minutes, the mixture of lansfordite particles may be discharged from the reactor and then filtered to separate the lansfordite solids from the mother liquor. In a full implementation of the General Method, the separated mother liquor may be conserved for reuse. For analytical purposes, the lansfordite solids may be rinsed with deionized water, re-suspended in ethanol, filtered again, and dried in a vacuum oven up to 29 inHg at room temperature.

Lansfordite template precursor particles of the type generated by this procedure are identified herein as L₂. Raman spectral analysis confirms that the product of this reaction matches that of lansfordite, as seen in FIG. 208.

Compared to other equiaxed MgCO₃·xH₂O-type precursors (e.g. magnesite), lansfordite may be significantly more industrially scalable and less costly. The prismatic, equiaxed morphology may be desirable for applications in which perimorphic products must be integrated with liquids and viscosity effects must be minimized. Additionally, due to lansfordite's relatively high state of hydration, more template precursor volume is generated for a given mass of Mg than is obtainable with less hydrated MgCO₃·xH₂O, and more template pore volume may be obtained upon decomposition of the precursor material. This can be used to create perimorphic frameworks with more exocellular space.

Example L₃: In another exemplary Precursor Stage procedure, an equiaxed, partially dehydrated template lansfordite (MgCO₃·5H₂O) template precursor material may be derived from a stock solution of aqueous Mg(HCO₃)₂.

To demonstrate this derivation at small scale, an aqueous lansfordite mixture may first be derived from a representative aqueous Mg(HCO₃)₂ stock solution. This stock solution represents the stock solution that might be generated during the Separation Stage of a full implementation of the General Method. For this example, a representative stock solution and aqueous lansfordite mixture may be obtained using the procedure described in Example L₂. As described in Example L₂, the precipitation of lansfordite particles may cause CO₂ process gas to be emitted. In a full implementation of the General Method, CO₂ process gas released during precipitation may be conserved using conventional techniques.

The concentration of the lansfordite mixture may be adjusted to a 7 wt % concentration of solids. The mixture may then be spray-dried, causing a partial dehydration of the lansfordite material. To demonstrate this at small scale, a Sinoped LPG-5 spray dryer may be used for spray-drying. The lansfordite particles in the 7 wt % mixture may kept continuously suspended via stirring in a vessel. The mixture may be pumped from the vessel at a rate ranging between 116 mL/min and 162 mL/min into the spray dryer's BETE XAER250 air atomizing nozzle. Compressed air may also be delivered into the nozzle at a flow rate ranging between 1.2 scfmₐᵢᵣ at 20 psig and 3.6 scfmₐᵢᵣ at 59 psig. The inlet temperature of the spray dryer may be set to 300° C., producing an outlet temperature ranging between 111° C. and 123° C.

The dry, partially dehydrated lansfordite particles may be collected by a cyclonic particle separator. In a full implementation of the General Method, the process water vapor generated by spray-drying may be conserved using conventional techniques.

The partially dehydrated lansfordite template precursor particles of the type generated by this procedure are identified herein as L₃. Process liquids and gases may be recovered through typical industrial methods for reuse in Separation Stage.

The TGA mass loss of 67.1% for an L₃ template precursor material generated according to the procedure described above confirms that partial dehydration occurred (the theoretical mass loss for lansfordite is 76.9%, as shown in FIG. 208). This partial dehydration is due to the elevated temperatures experienced during the spray drying process.

Example M₁: In another exemplary Precursor Stage procedure, an equiaxed magnesite (MgCO₃) template precursor material may be derived from a stock solution of aqueous Mg(HCO₃)₂.

To demonstrate this derivation at a small scale, a representative stock solution may first be prepared. This stock solution represents the stock solution that might be generated in the Separation Stage of a full implementation of the General Method. For this example, a representative aqueous Mg(HCO₃)₂ stock solution with a concentration of 0.25 mol kg⁻¹ Mg (aq) may be prepared. This stock solution may then be slurried with additional MgO to provide more Mg ions. In a full implementation of the General Method, MgCO₃·xH₂O precipitated from a stock solution might be utilized to provide more Mg ions. However, for the purpose of this demonstration, the additional MgO may comprise a commercial MgO product (Elastomag 170) that has been calcined at 1050° C. for 1 hour. With this additional loading of Mg ions, the total Mg present in the stock solution-mixture may be 1.5 mol kg⁻¹ Mg.

Next, this stock solution-mixture may be placed in a pressure vessel with magnetic stirring, a high-pressure gas inlet, and a purging needle valve. CO₂ may be flowed for 2 minutes to purge the vessel of air, after which it may be fully sealed and pressurized with CO₂ to 725 psi at 14.4° C. The vessel may be heated on a heating stir plate. Under magnetic stirring and heating, after 291 minutes, the vessel may reach 193.7° C. and 975 psi. Inside the vessel, magnesite is precipitated During this thermal treatment, and CO₂ process gas may be emitted into the vessel's headspace. The vessel may then be depressurized and allowed to cool over the course of 30 minutes, releasing steam and CO₂ continuously. In a full implementation of the General Method, the CO₂ process gas released during precipitation and subsequent depressurization may be conserved using conventional techniques.

The mixture of magnesite particles may then be discharged from the vessel and then filtered to separate the magnesite solids from the mother liquor. In a full implementation of the General Method, the separated mother liquor may be conserved for reuse in the Separation Stage. The magnesite may be dried at 100° C.

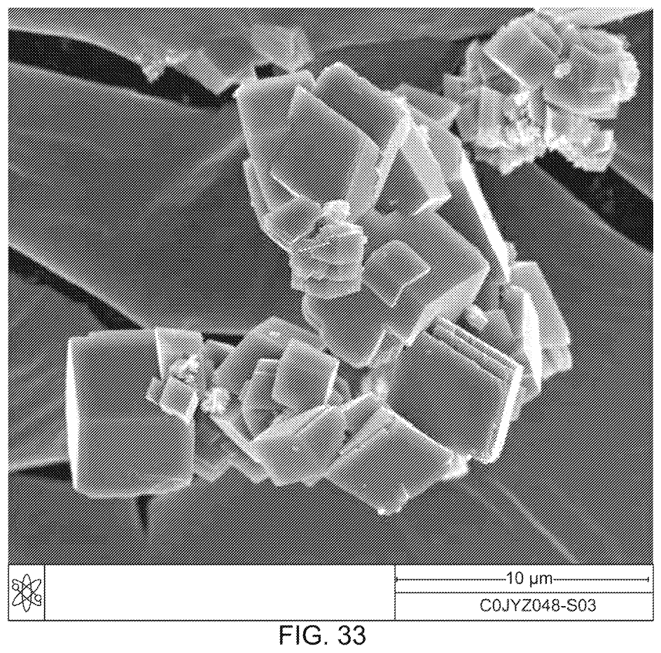

The magnesite template precursor material of the type generated by this procedure are identified herein as M₁. The particles display an equiaxed rhombohedral morphology and are shown in the SEM micrograph in FIG. 33. Thermogravimetric analysis of the sample may demonstrate a magnesite composition due to the lack of any thermal decomposition prior to the decarboxylation stage occurring of 400° C. The TGA mass loss of these particles is 52.2% which matches the expected magnesite mass loss of 52.2% as seen in FIG. 208. Raman spectral analysis also confirms that the particles are magnesite, as seen in FIG. 208. This experiment demonstrates production of equiaxed magnesite template precursor particles utilizing a Mg(HCO₃)₂ stock solution enriched with an additional Mg²⁺ and HCO₃⁻ ions via MgO and CO₂ gas, respectively.

Example M₂: In another exemplary Precursor Stage procedure, an equiaxed magnesite (MgCO₃) template precursor material may be derived from a stock solution of aqueous Mg(HCO₃)₂.

To demonstrate this derivation at small scale, nesquehonite may be generated from a stock solution of aqueous Mg(HCO₃)₂ using the procedure described in Example N₁. This precipitation may cause CO₂ process gas to be emitted. In a full implementation of the General Method, the CO₂ process gas released during precipitation may be conserved using conventional techniques. Likewise, the separated mother liquor may be conserved in a full implementation of the General Method.

In this exemplary procedure, the nesquehonite may then be combined with water to make a mixture with a concentration of 1.5 mol kg⁻¹ Mg. The mixture may be placed in a pressure vessel with magnetic stirring, a high-pressure gas inlet, and a purging needle valve. The headspace of the pressure vessel may contain ambient pressure air, with no additional gas input. The pressure vessel may then be sealed.

The mixture may be magnetically stirred in the vessel for 10 minutes. Then, the vessel may be heated to 175° C. over 68 minutes. The reaction temperature may fluctuate During this thermal treatment, reaching a maximum temperature of 180° C. and a maximum pressure of 1190 psi, at which condition any CO₂ liberated from nesquehonite in the reaction may be rendered supercritical. The pressure vessel may be then be allowed to cool for 199 minutes.

The resulting mixture of magnesite particles may be discharged from the vessel and then filtered to separate the magnesite solids from the mother liquor. In a full implementation of the General Method, the separated mother liquor may be conserved for reuse in the Separation Stage. The magnesite may be dried at 100° C.

The magnesite template precursor material of the type generated by this procedure are identified herein as M₂. The particles display an equiaxed rhombohedral morphology and are shown in the SEM micrograph in FIG. 34. Raman spectral analysis confirms that the product of this reaction matches that of magnesite, as shown in FIG. 208.

Example A₁: In another exemplary Precursor Stage procedure, a hollow non-crystalline MgCO₃·xH₂O template precursor material may be derived from a stock solution of aqueous Mg(HCO₃)₂.

To demonstrate this derivation at a small scale, a representative stock solution may first be prepared. This stock solution represents the stock solution that might be generated in the Separation Stage of a full implementation of the General Method. For this example, a representative aqueous Mg(HCO₃)₂ stock solution with a concentration of 0.43 mol kg⁻¹ Mg (aq) may be prepared. This may be done by mixtureing a commercial MgCO₃·xH₂O product (“Light Magnesium Carbonate” supplied by Akrochem Corporation) in water at a solids concentration equivalent to 0.43 mol kg⁻¹ Mg. This mixture may be carbonated using pressurized CO₂ gas in a circulated pressure vessel. The system may be pressurized by injecting CO₂ gas into the vessel to a total pressure of 555 psi. This may be maintained for 2 hours and 13 minutes at 34° C. or until all solids are dissolved. At this point, the vessel may be depressurized and stored under atmospheric pressure at 4° C.

The chilled stock solution may then be spray-dried. To demonstrate this, the stock solution may be pumped at a rate of 35 mL/min through a BETE XAER150 air atomizing nozzle of a Sinoped LPG-5 spray dryer. Compressed air may be delivered into the nozzle at a flow rate of 2.8 scfmₐᵢᵣ at 45 psig. The inlet temperature of the spray dryer may be set to 165° C., resulting in an outlet temperature of 110° C.

The particles resulting from spray-drying the stock solution may be collected by a cyclonic particle separator. In a full implementation of the General Method, both the process water vapor and the CO₂ process gas emitted by spray-drying may be conserved using conventional techniques.

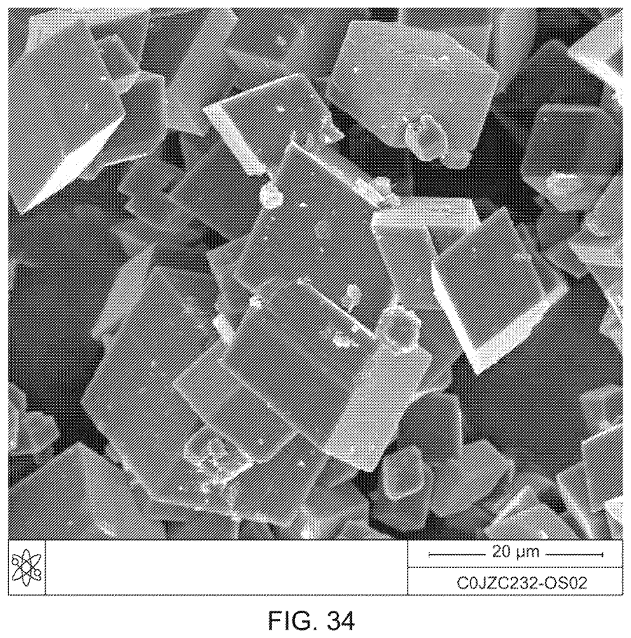

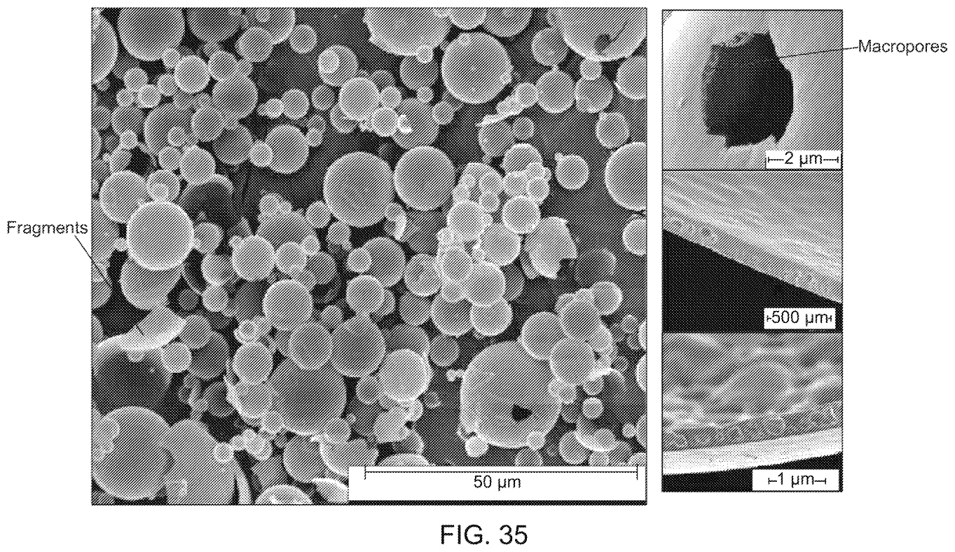

The type of MgCO₃·xH₂O template precursor material resulting from this process is identified herein as A₁. SEM image analysis of A₁ particles, as shown in the SEM micrographs in FIG. 35, reveals that the non-crystalline MgCO₃·xH₂O particles produced by spray-drying comprise generally hollow, hierarchical-equiaxed particles with smooth outer surfaces. There are also fragments of shells. The shell fragments show there are macropores present within the shell.

Raman spectral analysis showed that the product of this reaction does have a Raman peak that may be associated with crystalline carbonate, located at 1106 cm⁻¹. However, it does not match with any of the typical MgCO₃·xH₂O peaks (FIG. 208). Additionally, TGA analysis of the template precursor fails to match with the common crystalline forms of MgCO₃·xH₂O with a mass loss of 66.3%, as seen in FIG. 208. Therefore, it is deemed non-crystalline.

Example A₂: In another exemplary Precursor Stage procedure, a hollow, hierarchical-equiaxed, non-crystalline MgCO₃·xH₂O template precursor material may be derived from a stock solution of aqueous Mg(HCO₃)₂.

To demonstrate this derivation at a small scale, a representative stock solution may first be prepared. This stock solution represents the stock solution that might be generated in the Separation Stage of a full implementation of the General Method. For this example, a representative aqueous Mg(HCO₃)₂ stock solution with a concentration of 1.39 mol kg⁻¹ Mg (aq) may be prepared. This may be done by mixtureing a commercial Mg(OH)₂ product (“Versamag” supplied by Akrochem Corporation) in water at a solids concentration equivalent to 1.49 mol kg⁻¹ Mg. This mixture may be carbonated using pressurized CO₂ gas in a circulated pressure vessel. The system may be pressurized by injecting CO₂ gas into the vessel to a total pressure between 700-800 psig. This may be maintained for 2 hours at 10° C. or until substantially all (i.e. >90%) solids are dissolved. At this point, the contents may be depressurized and stored under atmospheric pressure between 4-10° C.

The stock solution may then be spray-dried. To demonstrate this, the stock solution may be pumped at a rate of 2.7 mL/min through a 0.7 mm Buchi B-290 two fluid air atomizing nozzle in a Buchi B-191 spray drying system. Compressed air may be delivered into the nozzle at a flow rate of 0.6 scfmₐᵢᵣ at 88 psig. The inlet temperature of the spray dryer may be set to 130° C., resulting in an outlet temperature between 85-89° C. The aspirator may be set to 18 scfmₐᵢᵣ.

The particles resulting from spray-drying the stock solution may be collected by a cyclonic particle separator. In a full implementation of the General Method, both the process water vapor and the CO₂ process gas emitted by spray-drying may be conserved using conventional techniques.

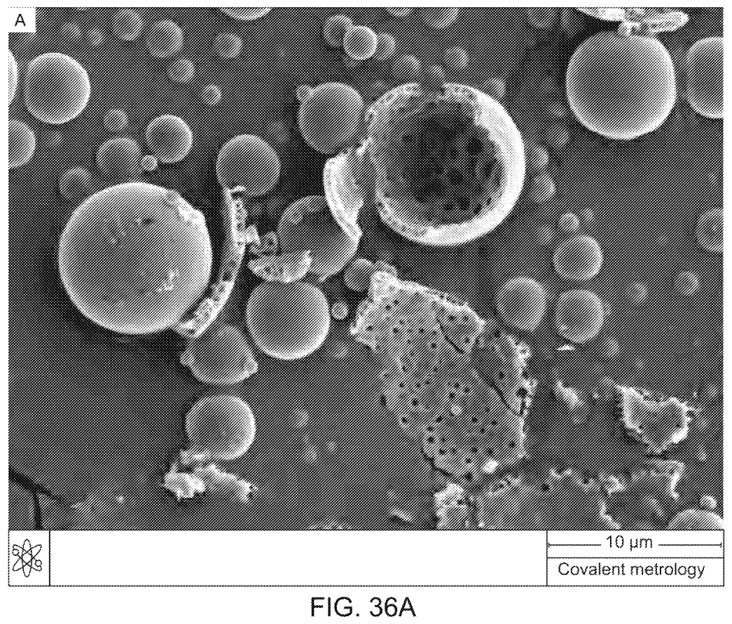

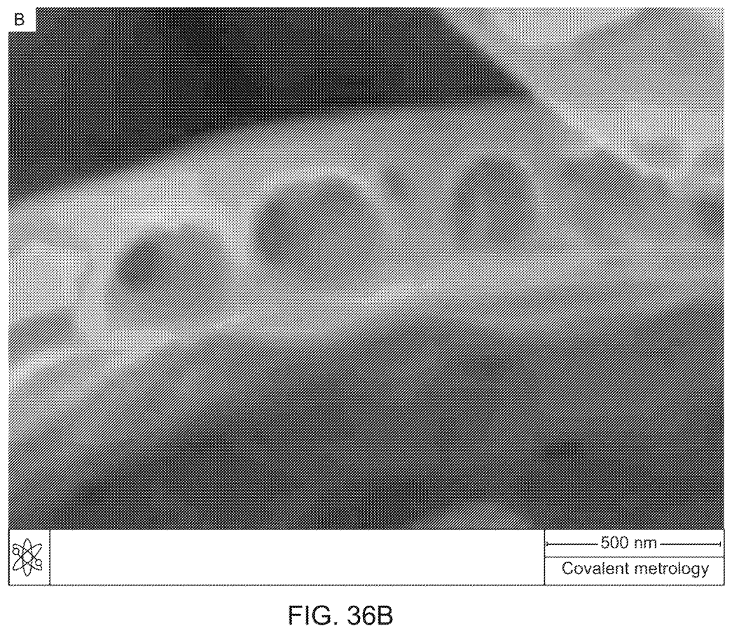

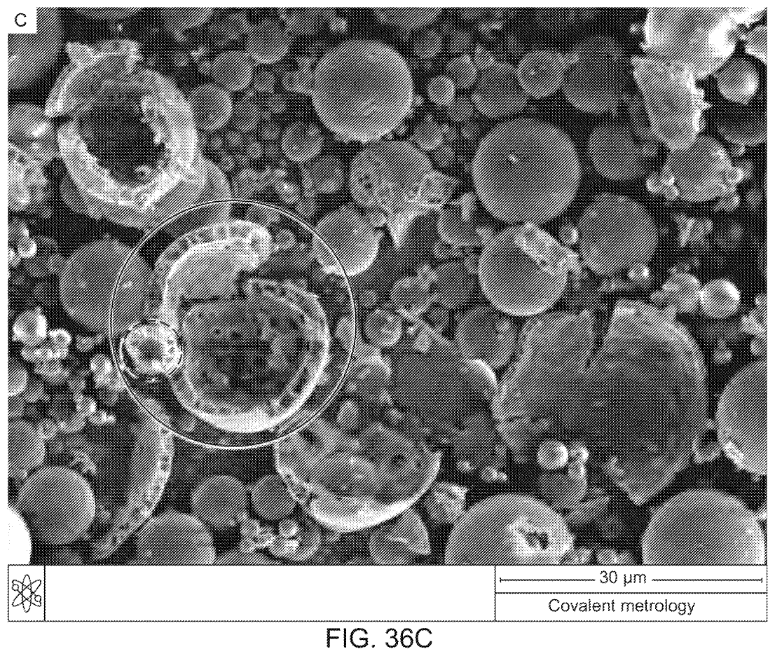

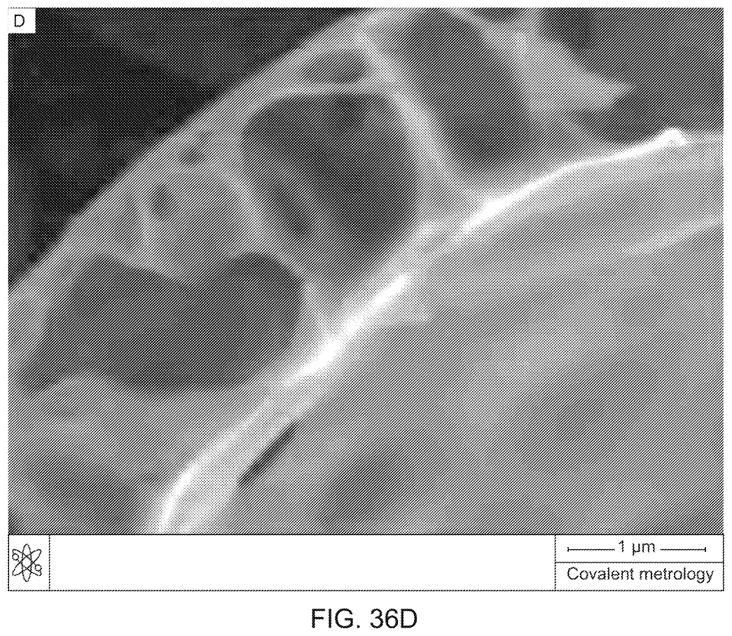

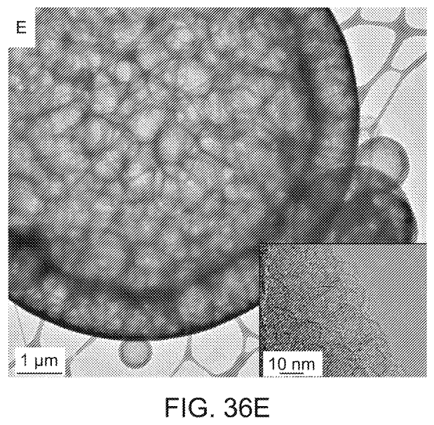

The type of MgCO₃·xH₂O template precursor material resulting from this process is identified herein as A₂. SEM image analysis of A₂ particles, as shown in the SEM micrographs in FIG. 36A-36B, reveals that the non-crystalline MgCO₃·xH₂O particles produced by spray-drying comprise generally hollow, hierarchical-equiaxed particles with smooth outer surfaces. There are also fragments of shells. The shell fragments show that, in addition to the central cavity, the shells also have a closed-cell, macroporous structure. Compared to the shells of the A₁ particles, the shells of the A₂ particles are thicker due to their increased shell porosity. The spheres are also smaller, with 95% or more of the population possessing a diameter of less than 10 m.

Raman spectral analysis showed that the MgCO₃·xH₂O spheres have no distinct Raman peak that may be associated with crystalline carbonate. Additionally, TGA analysis of the template precursor fails to match with the common crystalline forms of MgCO₃·xH₂O with a mass loss of 68.4%, as seen in FIG. 208. Therefore, it is deemed non-crystalline.

Example A₃: In another exemplary Precursor Stage procedure, a hollow, hierarchical-equiaxed, non-crystalline MgCO₃·xH₂O template precursor material may be derived from a stock solution of aqueous Mg(HCO₃)₂.

To demonstrate this derivation at a small scale, a representative stock solution may first be prepared. This stock solution represents the stock solution that might be generated in the Separation Stage of a full implementation of the General Method. For this example, a representative aqueous Mg(HCO₃)₂ stock solution with a concentration of 1.08 mol kg⁻¹ Mg (aq) may be prepared. This may be done by mixtureing a commercial Mg(OH)₂ product (“Versamag” supplied by Akrochem Corporation) in water at a solids concentration equivalent to 1.12 mol kg⁻¹ Mg. This mixture may be carbonated using pressurized CO₂ gas in a circulated pressure vessel. The system may be pressurized by injecting CO₂ gas into the vessel to a total pressure between 700-800 psig. This may be maintained for 2 hours at 10° C. or until substantially all solids (i.e. >90%) are dissolved. At this point, the contents may be depressurized and stored under atmospheric pressure between 4-10° C.

The stock solution may then be spray-dried. To demonstrate this, the stock solution may be pumped at a rate of 2.7 mL/min through a 0.7 mm Buchi B-290 two fluid air atomizing nozzle in a Buchi B-191 spray drying system. Compressed air may be delivered into the nozzle at a flow rate of of 0.6 scfmₐᵢᵣ at 88 psig. The inlet temperature of the spray dryer may be set to 90° C., resulting in an outlet temperature between 56-58° C. The aspirator may be set to 18 scfmₐᵢᵣ.

The particles resulting from spray-drying the stock solution may be collected by a cyclonic particle separator. In a full implementation of the General Method, both the process water vapor and the CO₂ process gas emitted by spray-drying may be conserved using conventional techniques.

The type of MgCO₃·xH₂O template precursor material resulting from this process is identified herein as A₃. SEM image analysis of A₃ particles, as shown in the SEM micrographs in FIG. 36C-36D, reveals that the non-crystalline MgCO₃·xH₂O particles produced by spray-drying comprise generally hollow, hierarchical-equiaxed particles with smooth outer surfaces. There are also fragments of shells. The shell fragments show that, in addition to the central cavity, the shells also have a closed-cell, macroporous structure. Compared to the shells of the A₁ and A₂ particles, the A₃ are thicker due to their increased shell porosity. Their average aspect ratio, representing the ratio of the particle radius to the shell thickness, is also lower. In FIG. 36C, the particle circled with the solid line has an aspect ratio of approximately 5:1, whereas the particle circled with the dashed line has an aspect ratio of approximately 2:1.

The macropores are located throughout the shell, which can be seen in the carbon perimorphic frameworks grown on them. FIG. 36E is a TEM image of carbon perimorphic frameworks grown on templates derived from A₃ particles. The mottled appearance of the shell, corresponding to its porosity, extends throughout the shell. The shell's macropores are sandwiched between two skins—an outer and an inner skin, which represent the inner and outer surfaces of the shells. These skins appear darker in TEM. The macroporous shell is part of the perimorphic superstructure; the cellular substructure is much finer, as shown in the inset of FIG. 36E, a TEM micrograph showing the mesoporous cellular substructure.

Raman spectral analysis showed that the MgCO₃·xH₂O spheres have no distinct Raman peak that may be associated with crystalline carbonate. Additionally, TGA analysis of the template precursor fails to match with the common crystalline forms of MgCO₃·xH₂O with a mass loss of 72.9%, as seen in FIG. 208. Therefore, it is deemed non-crystalline.

Example C₁: In another exemplary Precursor Stage procedure, a hollow, hierarchical-equiaxed magnesium citrate template precursor material may be derived from a stock solution of aqueous magnesium citrate.

To demonstrate this derivation at a small scale, a representative stock solution may first be prepared. This stock solution represents the stock solution that might be generated in the Separation Stage of a full implementation of the General Method. For this example, a representative aqueous magnesium citrate stock solution with a concentration of 0.52 mol kg⁻¹ Mg (aq) may be prepared by reacting citric acid (supplied by Sigma Aldrich) with a 0.52 mol kg⁻¹ aqueous mixture of Mg(OH)₂ (Versamag, supplied by Akrochem).

The stock solution may then be spray-dried. To demonstrate this, the stock solution may be pumped at a rate of 3.75 mL/min through a Buchi B-290 two-fluid nozzle of a Buchi B-191 spray dryer. Compressed air may be delivered into the nozzle at a flow rate of 0.6 scfmₐᵢᵣ at 88 psig with the aspirator airflow set to 18 scfmₐᵢᵣ. The inlet temperature may be set to 220° C., resulting in an outlet temperature of 110° C.

The particles resulting from spray-drying the stock solution may be collected by a cyclonic particle separator. In a full implementation of the General Method, the process water vapor emitted by spray-drying may be conserved using conventional techniques.

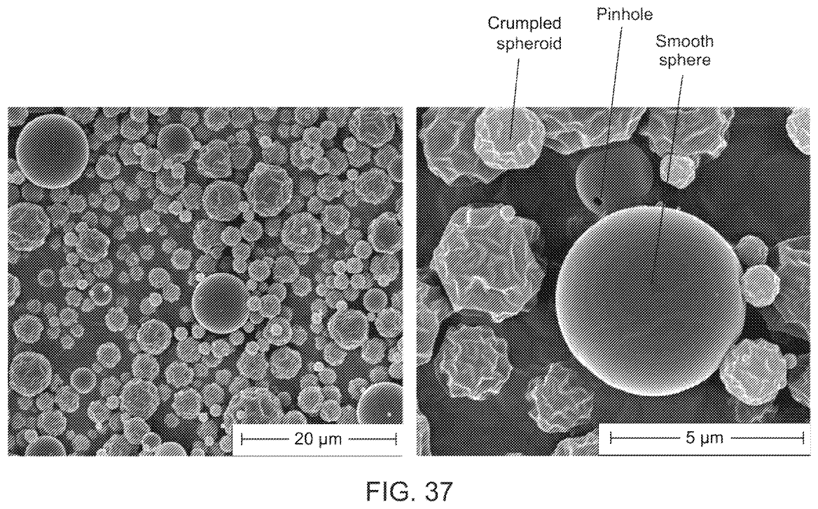

The type of magnesium citrate template precursor material resulting from this process is identified herein as C₁. SEM analysis of C₁ particles, as shown in the SEM micrographs in FIG. 37, reveals that the magnesium citrate particles produced by spray-drying comprise generally hollow, hierarchical-equiaxed particles. A majority comprise a solid shell and a hollow interior, with a crumpled, spherical superstructure, as seen in FIG. 37. Some particles comprise smooth, un-crumpled spherical superstructures; these particles may possess thicker, more rigid shells than the crumpled particles. The spray-dried magnesium citrate precursor particles are rarely fragmented or broken, although pinholes can be found, as indicated in FIG. 37.

Raman spectral analysis confirms that the product of this reaction matches that of magnesium citrate, as shown in FIG. 208.

Example E₁: In another exemplary Precursor Stage procedure, an elongated template precursor material of epsomite (magnesium sulfate heptahydrate, MgSO₄·7H₂O) may be derived from an aqueous stock solution of magnesium sulfate.

To demonstrate this derivation at a small scale, a representative stock solution may first be prepared. This stock solution represents the stock solution that might be generated in the Separation Stage of a full implementation of the General Method. For this example, a representative aqueous magnesium sulfate stock solution with a concentration of 4.06 mol kg⁻¹ Mg (aq) may be prepared by dissolving epsomite in water at room temperature. This may be done in a glass beaker magnetically stirred at 700 RPM.

Once dissolved, 410.86 g of acetone may be added dropwise by a separatory funnel, which may result in immediate crystal formation in the solution. While this represents an antisolvent precipitation, which is generally undesirable, solventless precipitation of epsomite could easily be accomplished by chilling or spray-drying the stock solution. Moreso than demonstrating an engineered precursor morphology or demonstrating scalable procedure, the purpose of the Example E₁ procedure was moreso just to precipitate epsomite, so that the template materials and perimorphic materials derived from an epsomite precursor compound might be demonstrated and analyzed in subsequent sections of the current disclosure. In a full implementation of the General Method, the mother liquor separated after a solventless precipitation may be conserved for reuse in the Separation Stage.

After 22 minutes, the precipitation of the epsomite may be complete. The resulting mixture may be collected and filtered. The particles may be dried.

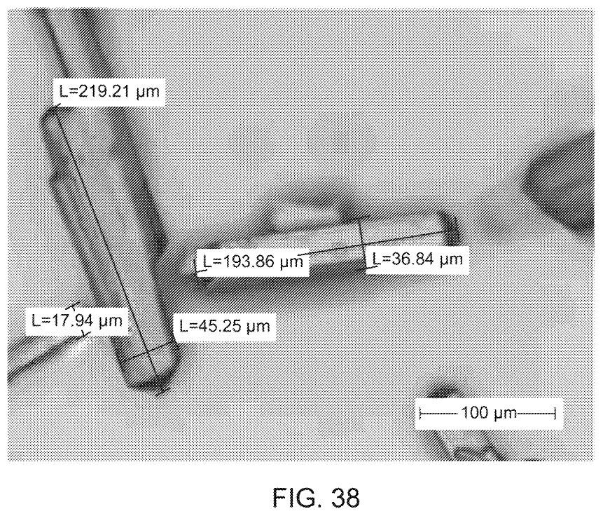

The type of epsomite template precursor material resulting from this process is identified herein as E₁. The particles may be observed via optical microscope as elongated rods with hexagonal cross sections, as shown in FIG. 38.

Raman spectral analysis confirms that the product of this reaction matches that of epsomite, as seen in FIG. 208.

Example H₄: In another exemplary Precursor Stage procedure, a Li-doped

hydromagnesite (Mg₅(CO3)₄(OH)₂·4H₂O) template precursor material may be derived from an aqueous stock solution of Mg(HCO₃)₂ that also contains a small concentration of aqueous Li₂CO₃.

To demonstrate this derivation at a small scale, a representative stock solution may first be prepared. This stock solution represents the stock solution that might be generated in the Separation Stage of a full implementation of the General Method. For this example, a representative aqueous Mg(HCO₃)₂ stock solution may be prepared, with the additional step of adding lithium carbonate (Li₂CO₃). This may be done as follows. First, an MgO powder (Akrochem Elastomag 170 calcined at 1050° C. for 1 hour) may be slurried into water at a solids concentration of 0.23 mol kg⁻¹ Mg (s). This may be done in a glass beaker with magnetic stirring. To this mixture, Li₂CO₃ (Sigma Aldrich) may be added at a solids concentration of 2.71·10⁻³ mol kg⁻¹ Li (s). The mixture may be carbonated with a sparge tube bubbling CO₂ gas to generate aqueous H₂CO₃. The CO₂ flow may be discontinued after the MgO and Li₂CO₃ are completely dissolved. The Mg(HCO₃)₂ stock solution may then be filtered to remove any residual undissolved impurities.

Next, the stock solution may be heated to 100° C. in an uncovered glass beaker with magnetic stirring. This condition may be maintained for 2 hours, during which hydromagnesite particles may be precipitated. After 2 hours, the resulting mixture may be filtered, and the solid hydromangesite may be dried in a forced air circulation at 100° C.

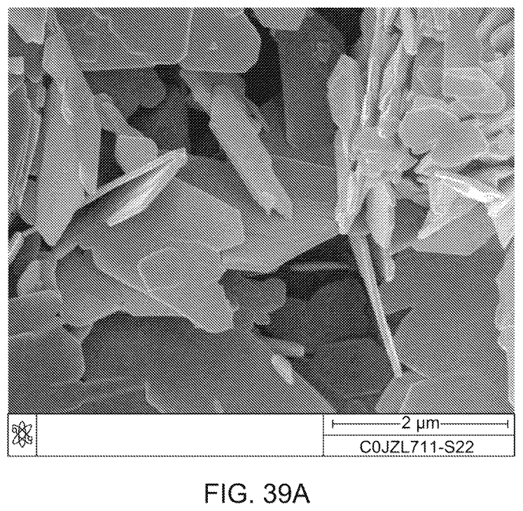

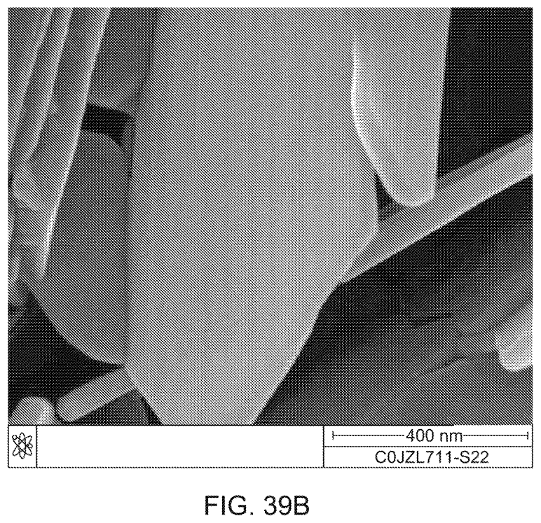

The type of Li-doped hydromagnesite template precursor material resulting from this process is identified herein as H₄. The particles are shown in the SEM micrographs of FIG. 39A-39B. Their plates are thin (<100 nm along their minor axis) and flat, with smooth surfaces.

Example H₅: In an exemplary Precursor Stage procedure, a Li-doped hydromagnesite (Mg₅(CO3)₄(OH)₂·4H₂O) template precursor material may be derived from an aqueous stock solution of Mg(HCO₃)₂ that also contains a moderate concentration of Li₂CO₃.

To demonstrate this derivation at a small scale, a representative stock solution may first be prepared. This stock solution represents the stock solution that might be generated in the Separation Stage of a full implementation of the General Method. For this example, a representative aqueous Mg(HCO₃)₂ stock solution may be prepared, with the additional step of adding lithium carbonate (Li₂CO₃). This may be done as follows.

First, an MgO powder (Akrochem Elastomag 170 calcined at 1050° C. for 1 hour) may be slurried into water at a solids concentration of 0.23 mol kg⁻¹ Mg (s). This may be done in a glass beaker with magnetic stirring. To this mixture, Li₂CO₃ (Sigma Aldrich) may be added at a solids concentration of 2.74·10⁻² mol kg⁻¹ Li (s). The mixture may be carbonated with a sparge tube bubbling CO₂ gas to generate aqueous H₂CO₃. The CO₂ flow may be discontinued after the MgO and Li₂CO₃ are completely dissolved. The Mg(HCO₃)₂ stock solution may then be filtered to remove any residual undissolved impurities.

Next, the stock solution may be heated to 100° C. in an uncovered glass beaker with magnetic stirring. This condition may be maintained for 1 hour, during which hydromagnesite particles may be precipitated. After 1 hour, the resulting mixture may be filtered, and the solid hydromangesite may be dried in a forced air circulation at 100° C.

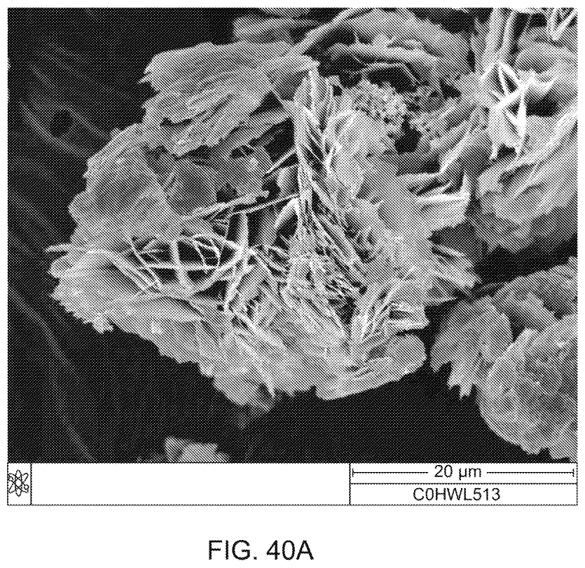

The type of Li-doped hydromagnesite template precursor material resulting from this process is identified herein as H₅. The particles are shown in the SEM micrographs of FIG. 40A-40B. Their plates are thin (<120 nm along their minor axis) and the surfaces are rougher than the surfaces of the plates shown in FIG. 39A-39B. This roughness may indicate an increased Li dopant level resulting from the higher concentration of Li₂CO₃ in the aqueous stock solution.

Example M₃: In another exemplary Precursor Stage procedure, an equiaxed magnesite (MgCO₃) template precursor material may be derived from a stock solution of aqueous Mg(HCO₃)₂.

To demonstrate this derivation at a small scale, a representative stock solution may first be prepared. This stock solution represents the stock solution that might be generated in the Separation Stage of a full implementation of the General Method. For this example, the stock solution may be generated in a high-pressure reactor. First, a commercial hydromagnesite product (Akrochem Light Magnesium Carbonate) may be slurried in water at a solids concentration of 0.74 mol kg⁻¹ Mg (s). This mixture may be placed in a circulated pressure vessel. The sealed vessel may then be heated to 145° C., at which temperature ˜800 psi of gaseous CO₂ may be introduced into the system. This reaction may continue to recirculate at 145° C. for a duration of 139 minutes, reaching a maximum pressure of 900 psi. During this thermal treatment, the hydromagnesite may be dissolved, forming aqueous Mg(HCO₃)₂, and magnesite may be precipitated from the Mg(HCO₃)₂. At this point, the vessel may be depressurized, releasing CO₂ process gas. In a full implementation of the General Method, the CO₂ process gas released during precipitation and subsequent depressurization may be conserved using conventional techniques.

The resulting mixture of magnesite particles may be discharged from the vessel and then filtered to separate the magnesite solids from the mother liquor. In a full implementation of the General Method, the separated mother liquor may be conserved for reuse in the Separation Stage. The magnesite may be dried at 100° C.

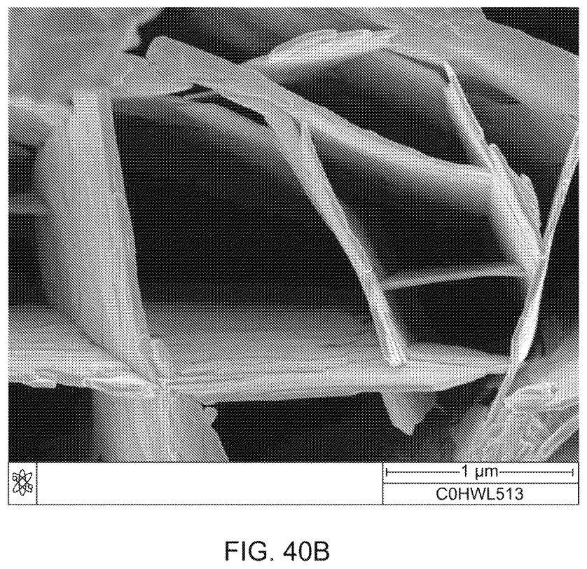

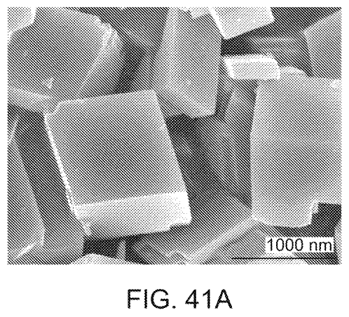

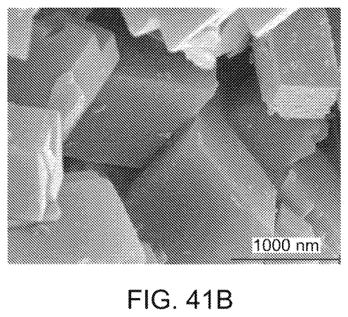

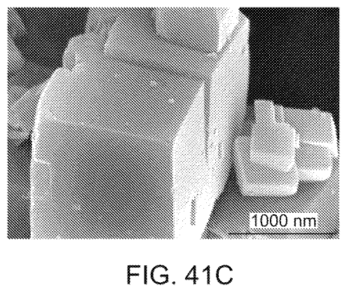

The type of magnesite template precursor material resulting from this process is identified herein as M₃. The equiaxed magnesite particles may be seen in the SEM micrograph of FIG. 41A. The structures are indicative of magnesite based on a TGA mass loss of 51.7% which closely matches the theoretical expected 52.2% in FIG. 208.

Example M₄: In another exemplary Precursor Stage procedure, an equiaxed magnesite (MgCO₃) template precursor material may be derived from a stock solution of aqueous, Na-rich Mg(HCO₃)₂.

To demonstrate this derivation at a small scale, a representative stock solution may first be prepared. This stock solution represents the stock solution that might be generated in the Separation Stage of a full implementation of the General Method. For this example, the stock solution may be generated in a high-pressure reactor. First, a commercial hydromagnesite product (Akrochem Light Magnesium Carbonate) may be slurried in water at a solids concentration of 0.74 mol kg⁻¹ Mg. To this mixture, a commercial NaHCO₃ product (Arm & Hammer) may be added at a concentration of 2.17·10⁻³ mol kg⁻¹ Na. This mixture may be placed in a circulated pressure vessel. The sealed vessel may then be heated to 145° C. upon which ˜800 psi of gaseous CO₂ may be introduced into the system. This reaction may continue to recirculate at 145° C. for a duration of 135 minutes, reaching a maximum pressure of 840 psi. During this thermal treatment, the hydromagnesite may be dissolved, forming aqueous Mg(HCO₃)₂, and magnesite may be precipitated from the aqueous Mg(HCO₃)₂. At this point, the vessel may be depressurized, releasing CO₂ process gas. In a full implementation of the General Method, the CO₂ process gas released during precipitation and subsequent depressurization may be conserved using conventional techniques.

The resulting mixture of magnesite particles may be discharged from the vessel and then filtered to separate the magnesite solids from the mother liquor. In a full implementation of the General Method, the separated mother liquor may be conserved for reuse in the Separation Stage. The magnesite may be dried at 100° C.

The type of magnesite template precursor material resulting from this process is identified herein as M₄. The equiaxed magnesite particles may be seen in the SEM micrograph of FIG. 41B. The structures are indicative of magnesite based on a TGA mass loss of 51.6% which closely matches the theoretical expected 52.2% in FIG. 208.

Example M₅: In another exemplary Precursor Stage procedure, an equiaxed magnesite (MgCO₃) template precursor material may be derived from a stock solution of aqueous, Na-rich Mg(HCO₃)₂.

To demonstrate this derivation at a small scale, a representative stock solution may first be prepared. This stock solution represents the stock solution that might be generated in the Separation Stage of a full implementation of the General Method. For this example, the stock solution may be generated in a high-pressure reactor. First, a commercial hydromagnesite product (Akrochem Light Magnesium Carbonate) may be slurried in water at a solids concentration of 0.74 mol kg⁻¹ Mg. To this mixture, a commercial NaHCO₃ product (Arm & Hammer) may be added at a concentration of 0.19 mol kg⁻¹ Na. This mixture may be placed in a circulated pressure vessel. The sealed vessel may then be heated to 145° C. upon which ˜800 psi of gaseous CO₂ may be introduced into the system. This reaction may continue to recirculate at 145° C. for a duration of 137 minutes, reaching a maximum pressure of 850 psi. During this thermal treatment, the hydromagnesite may be dissolved, forming aqueous Mg(HCO₃)₂, and magnesite may be precipitated from the aqueous Mg(HCO₃)₂. At this point, the vessel may be depressurized, releasing CO₂ process gas. In a full implementation of the General Method, the CO₂ process gas released during precipitation and subsequent depressurization may be conserved using conventional techniques.

The resulting mixture of magnesite particles may be discharged from the vessel and then filtered to separate the magnesite solids from the mother liquor. In a full implementation of the General Method, the separated mother liquor may be conserved for reuse in the Separation Stage. The magnesite may be dried at 100° C.

The type of magnesite template precursor material resulting from this process is identified herein as M₅. The equiaxed magnesite particles may be seen in the SEM micrograph of FIG. 41C to be rhombohedral crystals of magnesite. The structures are indicative of magnesite based on a TGA mass loss of 51.9% which closely matches the theoretical expected 52.2% in FIG. 208.

Comparing M₃, M₄, and M₅, there are no appreciable morphological differences that can be readily identified based on SEM analysis.

Example N₂: In another exemplary Precursor Stage procedure, an elongated nesquehonite (MgCO₃·3H₂O) template precursor material may be derived from an aqueous stock solution of Mg(HCO₃)₂.

To demonstrate this derivation at small scale, lansfordite may first be generated from a stock solution of aqueous Mg(HCO₃)₂ using the procedure described in Example L₂. This precipitation may cause CO₂ process gas to be emitted. In a full implementation of the General Method, the CO₂ process gas released during precipitation may be conserved using conventional techniques. Likewise, the separated mother liquor may be conserved in a full implementation of the General Method.

Next, water may be heated to 35° C. in a glass beaker. Once the water has reached temperature, the lansfordite may be added to produce a mixture with a concentration of 0.74 mol kg⁻¹ Mg. The mixture may be magnetically stirred at 600 RPM and maintained at 35° C. for 100 minutes. During this thermal treatment, the lansfordite may be dissolved and nesquehonite may be precipitated. The mixture may then be filtered to separate the mother liquor from the lansfordite. In a full implementation of the General Method, the separated mother liquor may be conserved.

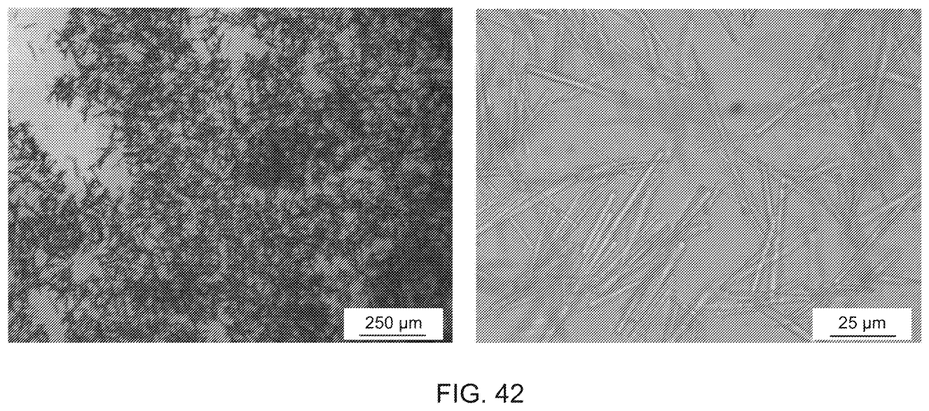

The type of nesquehonite template precursor material resulting from this process is identified herein as N₂. Optical micrographs are shown in FIG. 42. The nesquehonite particles are mostly individualized, resulting in a fine powder.

Example N₃: In another exemplary Precursor Stage procedure, an elongated nesquehonite (MgCO₃·3H₂O) template precursor material may be derived from an aqueous stock solution of Mg(HCO₃)₂.

To demonstrate this derivation at small scale, lansfordite may first be generated from a stock solution of aqueous Mg(HCO₃)₂ using the procedure described in Example L₂. This precipitation may cause CO₂ process gas to be emitted. In a full implementation of the General Method, the CO₂ process gas released during precipitation may be conserved using conventional techniques. Likewise, the separated mother liquor may be conserved in a full implementation of the General Method.

Next, a 10.84 mM aqueous solution of SDS (TCI Chemical) may be heated to 35° C. in a glass beaker. Once the water has reached temperature, the lansfordite may be added to produce a mixture with a concentration of 0.74 mol kg⁻¹ Mg. The mixture may be magnetically stirred at 600 RPM and maintained at 35° C. for 100 minutes. During this thermal treatment, the lansfordite may be dissolved and nesquehonite may be precipitated. The mixture may then be filtered to separate the mother liquor from the lansfordite. In a full implementation of the General Method, the separated mother liquor may be conserved.

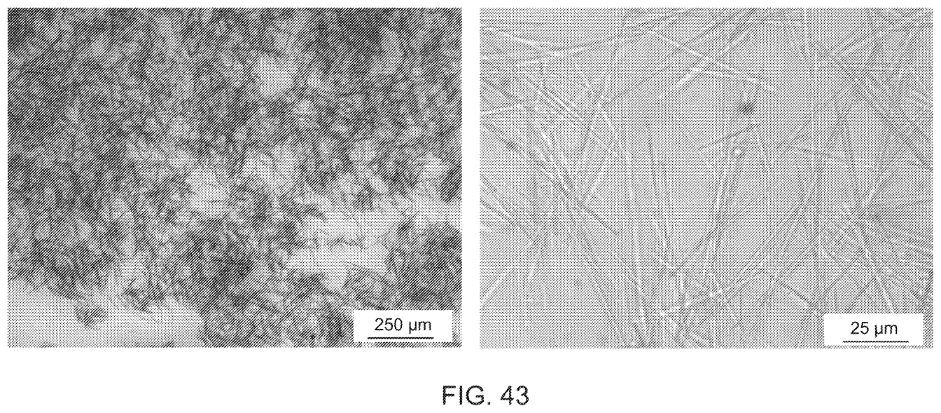

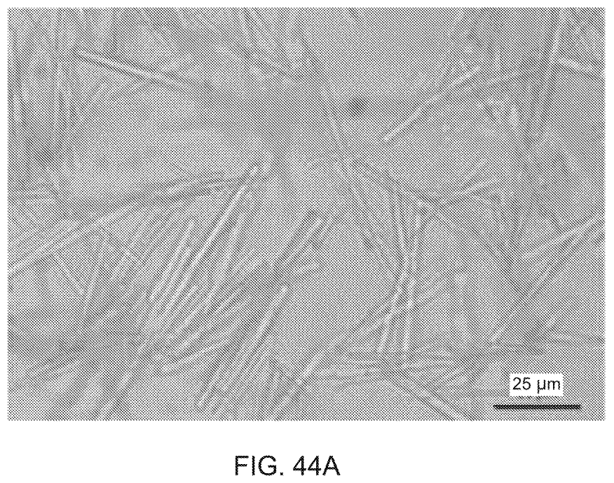

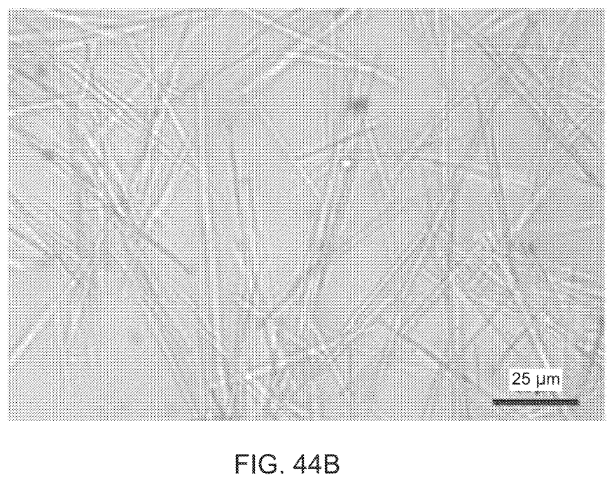

The type of nesquehonite template precursor material resulting from this process is identified herein as N₃. Optical micrographs are shown in FIG. 43. Comparison of the optical micrographs of N₂ and N₃ in FIG. 44A and FIG. 44B, respectively, reveals that the N₃ particles, on average, are longer and have smaller diameters. This demonstrates that the presence of a surfactant during precipitation may be used to control the dimensions of template precursor particles.

Example Li₁: In another exemplary Precursor Stage procedure, a hollow, hierarchical-equiaxed Li₂CO₃ template precursor material may be derived from a stock solution of aqueous Li₂CO₃.

To demonstrate this derivation at a small scale, a representative stock solution may first be prepared. This stock solution represents the stock solution that might be generated in the Separation Stage of a full implementation of the General Method. For this example, a representative aqueous Li₂CO₃ stock solution may be prepared as follows. First, a commercial Li₂CO₃ product (supplied by FMC) may be slurried in water at a concentration of 0.54 mol kg⁻¹ Li. This mixture may be carbonated in an overhead stirred reactor fitted with a gas dispersing blade and a sparge tube. CO₂ gas may be flowed into the mixture through the sparge tube at a rate of 9 sfchₐᵢᵣ for 175 minutes or until the solids are completely dissolved. At this point, the solution may be diluted with water to adjust the concentration to 0.27 mol kg⁻¹ Li (aq).

This representative stock solution may then be spray-dried. To demonstrate this, the stock solution may be pumped at a rate of 7 mL/min through a Buchi B-290 two-fluid nozzle of a Buchi B-191 spray dryer. Compressed air may be delivered into the nozzle at a flow rate of 0.6 scfmₐᵢᵣ at 88 psig with the aspirator airflow set to 18 scfmₐᵢᵣ. The inlet temperature may be set to 170° C., resulting in an outlet temperature of 100° C.

The particles resulting from spray-drying the stock solution may be collected by a cyclonic particle separator. In a full implementation of the General Method, the CO₂ process gas and process water vapor emitted by spray-drying may be conserved using conventional techniques.

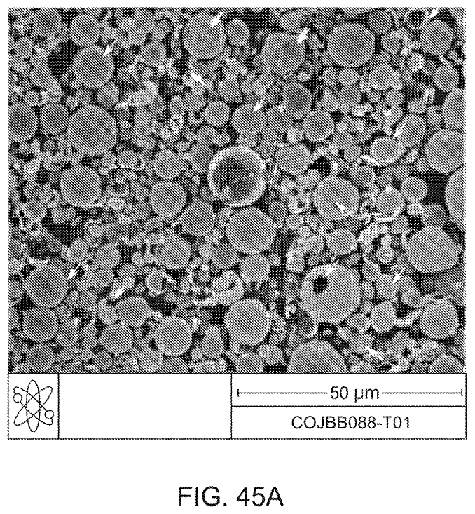

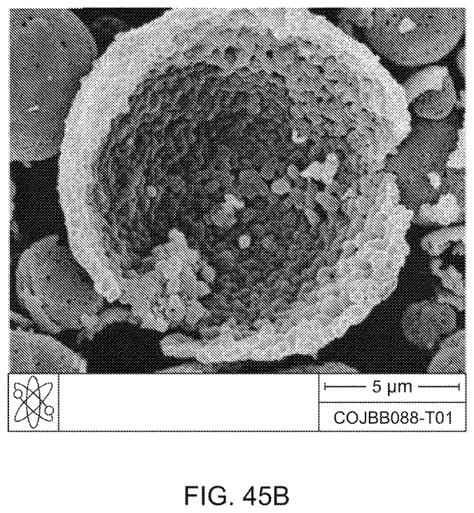

The type of lithium carbonate template precursor material resulting from this process is identified herein as Li₁. The particles are hollow, hierarchical-equiaxed structures, as seen in the SEM micrographs of FIG. 45A-45B. The hollow structures can be identified in varying stages of survival. The shells exhibit pinholes between the Li₂CO₃ subunits, indicated by arrows in FIG. 45A. In some shells, fragmentation and bigger holes or breaches can be observed (indicated by arrows in FIG. 45A). Crumpled shells are present in the sample (indicated by arrows in FIG. 45A). In FIG. 45B, the particles' substructure of loosely packed subunits can be discerned. These are mostly between 200 and 700 nm in size, with larger particles apparently comprising larger subunits. Raman peaks around 1091 cm⁻¹, 195 cm⁻¹ and 158 cm⁻¹ confirm the structures are Li₂CO₃.

### V*. Template Stage—Examples

This Section details the generation of exemplary template materials at small scales using exemplary procedures. As such, these procedures comprise partial implementations of the General Method. It should be therefore understood that these procedures must be coupled with other procedures in a full implementation of the General Method. Additionally, it should be understood that these procedures are merely demonstrative of analogous, larger-scale procedures that would be used for industrial-scale manufacturing.

A number of exemplary procedures for making template materials are described in this section. In some exemplary procedures, template precursor materials may be treated to form template materials in a separate and distinct Template Stage procedure, and the resulting template materials may then be utilized in a separate and distinct Replication Stage procedure. In other instances, the Template Stage and the Replication Stage procedures may both be performed in the same reactor. Some of these exemplary Template Stage procedures utilize template precursor materials previously named and described in Section V. Additionally, new template precursor materials have been utilized.

Example N₁T₁: In an exemplary Template Stage procedure, a nesquehonite template precursor material may be thermally treated to form a porous MgO template material.

To demonstrate this, N₁-type nesquehonite particles may first be generated using the procedure described in Example N₁. This material represents the template precursor material that might be generated in the Precursor Stage of a full implementation of the General Method.

Next, the template precursor material may be thermally treated. This may be performed in a TGA instrument under an inert gas flow of Ar as described in Scheme E in Section III. The sample of N₁-type nesquehonite particles may be heated under Ar gas from room temperature to a final temperature of 1,000° C. at a rate of 10° C./min. During this thermal treatment, CO₂ gas may be released. In a full implementation of the General Method, the CO₂ process gas released during the decomposition of the template precursor material may be conserved using conventional techniques. Upon reaching 1,000° C., the sample may be cooled back down to room temperature.

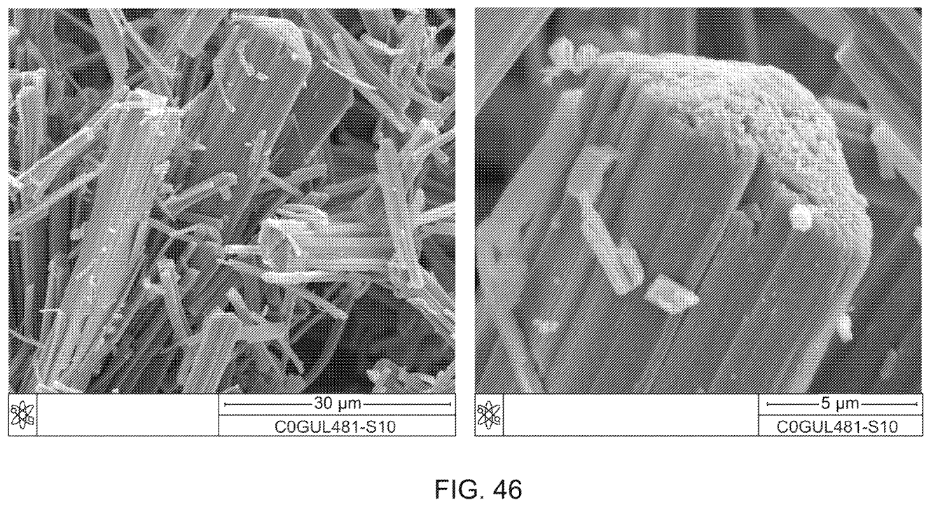

The type of porous MgO template material resulting from this process is identified herein as N₁T₁. The template particles retain the precursor particles' elongated superstructure, as shown in the SEM micrographs of FIG. 46. The particles range from 20 μm to 100+ μm in length. Unbroken rods may exhibit an average length to diameter ratio of approximately 15:1. The ends of the particles have a crumbly appearance, due to the porous substructure of nanocrystalline MgO subunits.

Example H₁T₁: In another exemplary Template Stage procedure, a hydromagnesite template precursor material may be thermally treated to form a porous MgO template material.

To demonstrate this, H₁-type hydromagnesite particles may first be generated using the procedure described in Example H₁. This material represents the template precursor material that might be generated in the Precursor Stage of a full implementation of the General Method.

Next, the template precursor material may be thermally treated. This may be performed in a TGA instrument under an inert gas flow of Ar as described in Scheme E in Section III. The sample of H₁-type hydromagnesite particles may be heated under Ar gas from room temperature to a final temperature of 1,000° C. at a rate of 10° C./min. During this thermal treatment, CO₂ gas may be released. In a full implementation of the General Method, the CO₂ process gas released during the decomposition of the template precursor material may be conserved using conventional techniques. Upon reaching 1,000° C., the sample may be allowed to cool to room temperature.

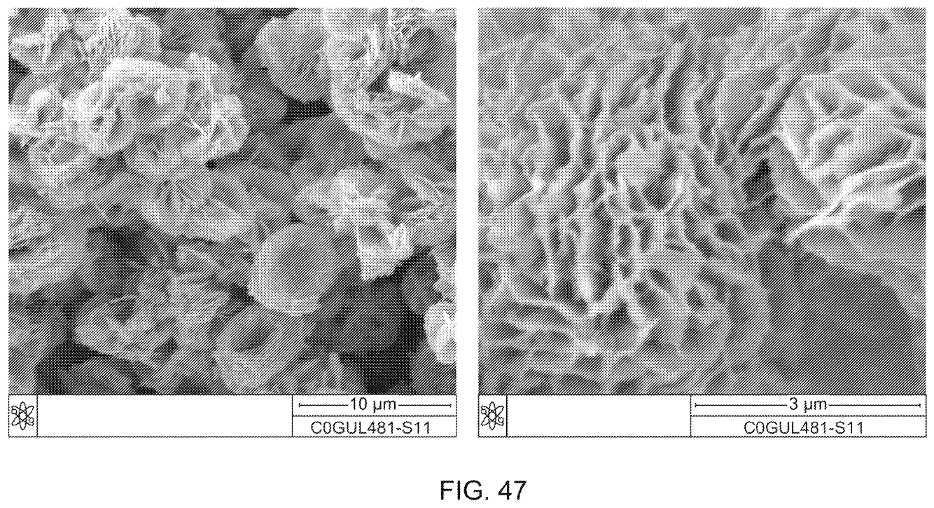

The type of porous MgO template material resulting from this process is identified herein as H₁T₁. The template particles retain the precursor particles' hierarchical-equiaxed, rosette superstructure, as shown in the SEM micrographs of FIG. 47. The individual plates generally range from 1 μm to 3 μm in diameter, with an average size between these values. The particles generally range from 4 μm to 10 μm in diameter, with an average size between these values. The average plate thickness is less than 100 nm and corresponds structurally to a single layer of the laterally networked nanocrystalline subunits. Plates exhibits high uniformity in thickness. The crumbly appearance at the edges of the plates reflects the porous substructure of nanocrystalline MgO subunits.

Example H₂T₁: In another exemplary Template Stage procedure, a hydromagnesite template precursor material may be thermally treated to form a porous MgO template material.

To demonstrate this, H₂-type hydromagnesite particles may first be generated using the procedure described in Example H₂. This material represents the template precursor material that might be generated in the Precursor Stage of a full implementation of the General Method.

Next, the template precursor material may be thermally treated. This may be performed according to Scheme B in a tube furnace as detailed in Section III. The sample of H₂-type hydromagnesite particles may be placed in a ceramic boat and introduced into a tube furnace at room temperature. The furnace may then be heated under Ar flow of 2000 sccm to 1050° C. at a heating rate of 20° C./min. During this thermal treatment, CO₂ gas may be released. In a full implementation of the General Method, the CO₂ process gas released during the decomposition of the template precursor material may be conserved using conventional techniques. The sample may then be maintained at 1050° C. for two hours, after which the furnace may be allowed to cool to room temperature.

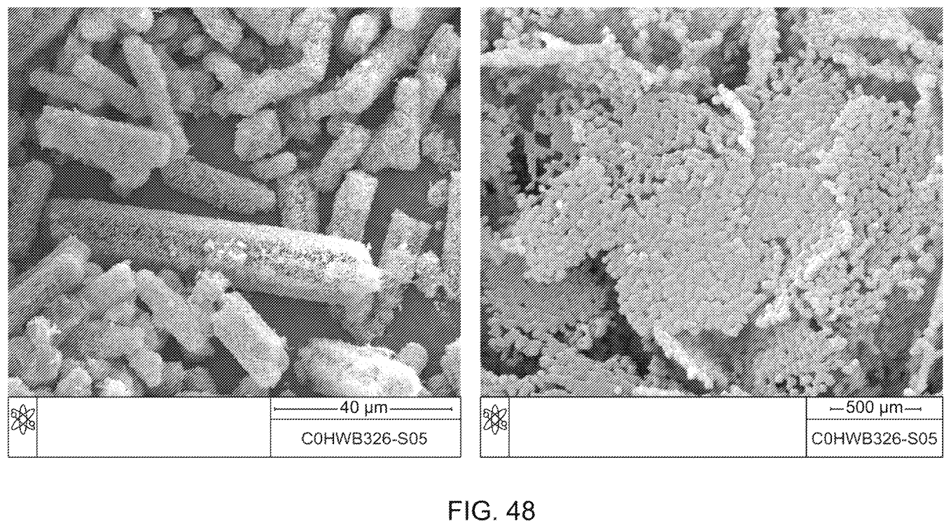

The type of porous MgO template material resulting from this process is identified herein as H₂T₁. The template particles retain the precursor particles' elongated, rosette superstructure, as shown in the SEM micrographs of FIG. 48. The particles range from 10 μm to 100 μm in length, with some having a length to diameter ratio of over 5:1. The plates range from 0.5 μm to 1.5 μm in diameter. Compared to the H₁T₁ plates, the H₂T₁ plates have a coarser substructure, comprising more discretized subunits and larger pores between them. The subunits comprise cuboidal or polyhedral nanocrystals ranging from ˜40 nm to ˜100 nm in size, with an average size between these values. The coarsening of the substructure may be attributed to the more intensive thermal treatment used to prepare the H₂T₁ template material.

Some of the subunits observed in FIG. 48 are conjoined laterally to their adjacent neighbors without any visible interstitial pores. These junctions may comprise grain boundaries. Other subunits are more discretized, and while still conjoined to the overall network, they are separated from their neighbors by pores. Since the plates are generally only one subunit in thickness, the interstitial pores between subunits penetrate through the thickness of the plate. These penetrating holes are an important and desirable structural feature in thin template structures because they create more crosslinking in the perimorphic framework formed via the template.

During the thermal treatment in Example H₂T₁, the porous MgO template material derived from decomposition of the template precursor may undergo grain growth and sintering due to atomic diffusion. The distance over which diffusion may occur may be a function of the temperature. Hence, modulating the temperature and duration of the Template Stage treatment may be useful for fine engineering of a template's substructure (and accordingly of a perimorphic framework's substructure).

During coarsening, the porous substructure of the template materials may also be densified. This may affect the fractional composition of positive and negative template space. Taken to an extreme, densification of the porous substructure may continue until the negative space—i.e. the template's pore structure—is eliminated. As particles sinter to one another, higher-order porosity may be obtained via the pores between these formerly discrete particles. This technique has been utilized by workers to create template structures comprising macroscopic, porous networks of sintered metal oxide particles. Macroscopic, monolithic template structures like this can be formed in Template Stage and recycled using the General Method.

Example H₁T₂: In another exemplary Template Stage procedure, a hydromagnesite template precursor material may be thermally treated to form an MgO template material.

To demonstrate this, H₁-type hydromagnesite particles may first be generated using the procedure described in Example H₁. This material represents the template precursor material that might be generated in the Precursor Stage of a full implementation of the General Method.

Next, the template precursor material may be thermally treated. This may be performed in a TGA according to Scheme E as detailed in Section III. The sample of H₁-type hydromagnesite particles may be heated under Ar gas from room temperature to a final temperature of 1200° C. at a heating rate of 10° C./min, during which CO₂ gas may be released. In a full implementation of the General Method, the CO₂ process gas released during the decomposition of the template precursor material may be conserved using conventional techniques. The sample may be held at 1200° C. for 10 minutes, then allowed to cool.

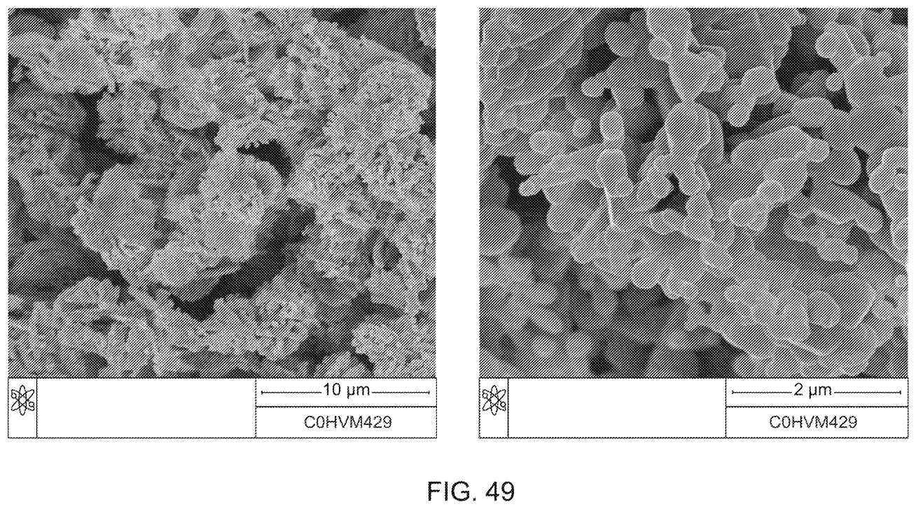

The type of MgO template material resulting from this process is identified herein as H₁T₂. The template particles resulting from this procedure are shown in the SEM micrographs of FIG. 49. The thermal treatment has transformed not only the subunits, but additionally the template superstructure, which no longer appears hierarchical. The progressive coalescence of the nanoscopic subunits and pores at the substructural level may therefore ultimately transform a template's superstructure, and individual particles may be sintered together to form larger (up to macroscopic) template structures.

Example N₁T₂: In another exemplary Template Stage procedure, a nesquehonite template precursor material may be thermally treated to form an MgO template material.

To demonstrate this, N₁-type nesquehonite particles may first be generated using the procedure described in Example N₁. This material represents the template precursor material that might be generated in the Precursor Stage of a full implementation of the General Method.

Next, the template precursor material may be thermally treated. This may be performed in a TGA according to Scheme E under an Ar flow from room temperature to a final temperature of 1200° C. at a heating rate of 10° C./min. During this thermal treatment, CO₂ gas may be released. In a full implementation of the General Method, the CO₂ process gas released during the decomposition of the template precursor material may be conserved using conventional techniques. The sample may be held at 1200° C. for 10 minutes, then allowed to cool.

The type of MgO template material resulting from this process is identified herein as N₁T₂. The template particles have lost the porous substructure evolved during thermal decomposition due to progressive sintering at high temperature.

Example N₁T₃: In another exemplary Template Stage procedure, a nesquehonite template precursor material may be thermally treated to form a porous MgO template material.

To demonstrate this, N₁-type nesquehonite particles may first be generated using the procedure described in Example N₁. This material represents the template precursor material that might be generated in the Precursor Stage of a full implementation of the General Method.

Next, the template precursor material may be thermally treated. This may be performed in a tube furnace according to Scheme B, as detailed in Section III. The sample may be heated from room temperature to 460° C. under Ar gas flow of 1271 sccm. At this point, acetylene (C₂H₂) gas may be introduced into the system to begin depositing carbon the templating surface. During this Replication Stage procedure, the template, which may not have completed its thermal decomposition, may continue decomposing in the high temperature environment and CO₂ gas may be released. In a full implementation of the General Method, the CO₂ process gas released during the decomposition of the template precursor material may be conserved using conventional techniques. This condition may be maintained for 3 hours. Acetylene flow may be terminated and the furnace may then be allowed to cool to room temperature under sustained Ar flow.

The type of porous MgO template material resulting from this process is identified herein as N₁T₃.

Example M₁T₁: In another exemplary Template Stage procedure, a magnesite template precursor material may be thermally treated to form a porous MgO template material.

To demonstrate this, M₁-type magnesite particles may first be generated using the procedure described in Example M₁. This material represents the template precursor material that might be generated in the Precursor Stage of a full implementation of the General Method.

Next, the template precursor material may be thermally treated. This may be performed in a TGA according to Scheme E as detailed in Section III. The sample may be heated from room temperature to 1050° C. at a rate of 50° C./min under Ar flow. During this thermal treatment, CO₂ gas may be released. In a full implementation of the General Method, the CO₂ process gas released during the decomposition of the template precursor material may be conserved using conventional techniques. The sample may be held at 1050° C. for 1 minute, then allowed to cool.

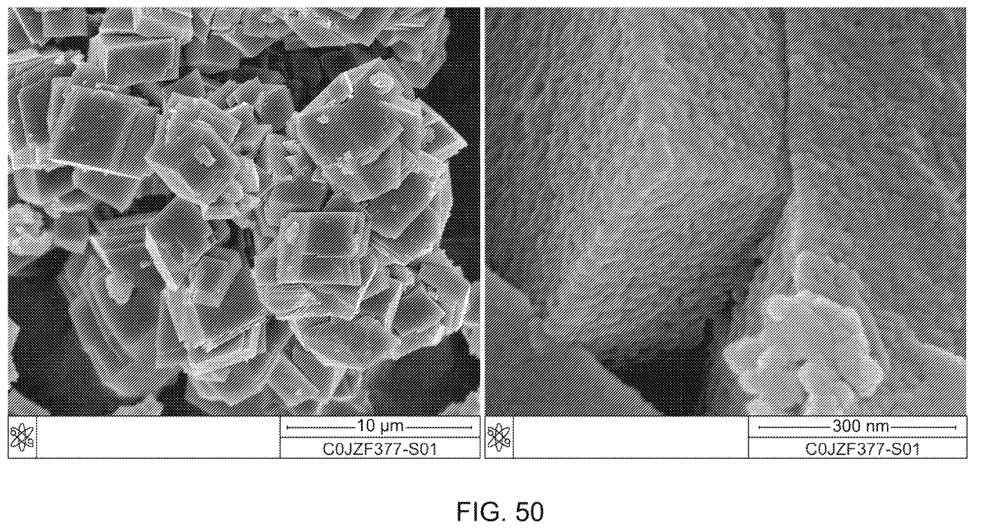

The type of porous MgO template material resulting from this process is identified herein as M₁T₁. The template particles retain the precursor particles' equiaxed superstructure, as shown in the SEM micrographs of FIG. 50. The template particles range from 5 μm to 20 μm in diameter. The surfaces appear substantially smooth and continuous at lower magnifications. At higher magnifications, the surfaces appear rougher due to the porous substructure. Clear resolution of the precise, nanoscopic substructure is difficult due to the ˜5 nm iridium particles used to coat the surface for imaging, however the regular, bumpy appearance indicates the underlying MgO subunits.

Example M₁T₂ In another exemplary Template Stage procedure, a magnesite template precursor material may be thermally treated to form a porous MgO template material.

To demonstrate this, M₁-type magnesite particles may first be generated using the procedure described in Example M₁. This material represents the template precursor material that might be generated in the Precursor Stage of a full implementation of the General Method.

Next, the template precursor material may be thermally treated. This may be performed in a tube furnace according to Scheme B, as detailed in Section III. The sample may be heated from room temperature to a final temperature of 1050° C. at a heating rate of 20° C./min and under an Ar flow of 2360 sccm. During this thermal treatment, CO₂ gas may be released. In a full implementation of the General Method, the CO₂ process gas released during the decomposition of the template precursor material may be conserved using conventional techniques. The sample may then be held at 1050° C. for 4 hours, then allowed to cool.

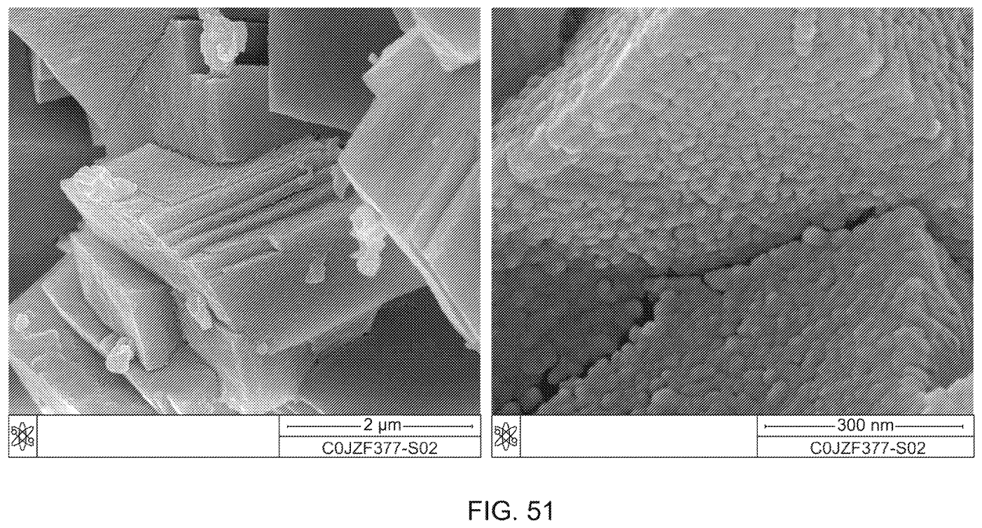

The type of MgO template material resulting from this process is identified herein as M₁T₂. The template particles retain the precursor particles' equiaxed superstructure, as shown in the SEM micrographs of FIG. 51. The template particles range from 5 μm to 20 μm in diameter. The surfaces appear substantially smooth and continuous at low magnification. At higher magnifications, the surface appears rougher due to the porous substructure. Clear resolution of the precise, nanoscopic substructure is difficult due to the ˜5 nm iridium particles used to coat the surface required for imaging, however the regular, bumpy appearance indicates the underlying MgO subunits.

Example M₁T₃: In another exemplary Template Stage procedure, a magnesite template precursor material may be thermally treated to form a porous MgO template material.

To demonstrate this, M₁-type magnesite particles may first be generated using the procedure described in Example M₁. This material represents the template precursor material that might be generated in the Precursor Stage of a full implementation of the General Method.

Next, the template precursor material may be thermally treated. This may be performed in a TGA according to Scheme E, as detailed in Section III. The sample may be heated from room temperature to a final temperature of 1200° C. at a rate of 50° C./min under flowing Ar. During this thermal treatment, CO₂ gas may be released. In a full implementation of the General Method, the CO₂ process gas released during the decomposition of the template precursor material may be conserved using conventional techniques. The sample may then be held at 1200° C. for 1 minute, then allowed to cool.

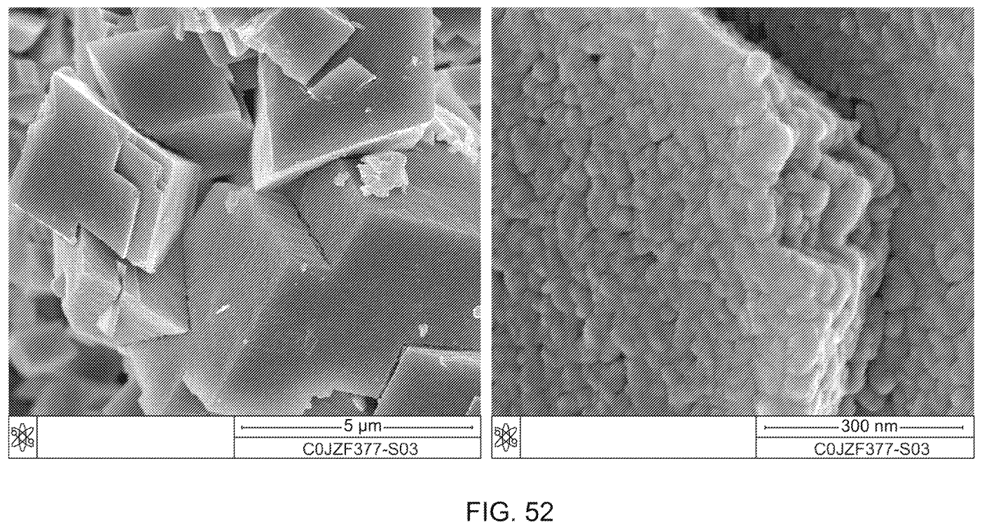

The type of MgO template material resulting from this process is identified herein as M₁T₃. The template particles retain the precursor particles' equiaxed superstructure, as shown in the SEM micrographs of FIG. 52. The template particles in the template sample range from 5 μm to 20 μm in diameter. The surfaces appear substantially smooth and continuous at low magnification. At higher magnification, the surface appears rougher due to the porous substructure. Clear resolution of the precise, nanoscopic substructure is difficult due to the ˜5 nm iridium particles used to coat the surface; however its regular, bumpy appearance indicates the underlying MgO subunits. Although the substructure cannot easily be distinguished from a comparable sample treated at only 1050° C. (described in Example M₁T₁ and shown in FIG. 51), it appears that the subunits may be starting to coalesce via sintering.

Example M₁T₄: In another exemplary Template Stage procedure, a magnesite template precursor material may be thermally treated to form a porous MgO template material.

To demonstrate this, M₁-type magnesite particles may first be generated using the procedure described in Example M₁. This material represents the template precursor material that might be generated in the Precursor Stage of a full implementation of the General Method.

Next, the template precursor material may be thermally treated. This may be performed in a tube furnace according to Scheme B, as detailed in Section III. The sample may be heated from room temperature to a final temperature of 1200° C. at a heating rate of 20° C./min under an Ar flow of 2000 sccm. During this thermal treatment, CO₂ gas may be released. In a full implementation of the General Method, the CO₂ process gas released during the decomposition of the template precursor material may be conserved using conventional techniques. The sample may then be held at 1200° C. for 4 hours, then allowed to cool.

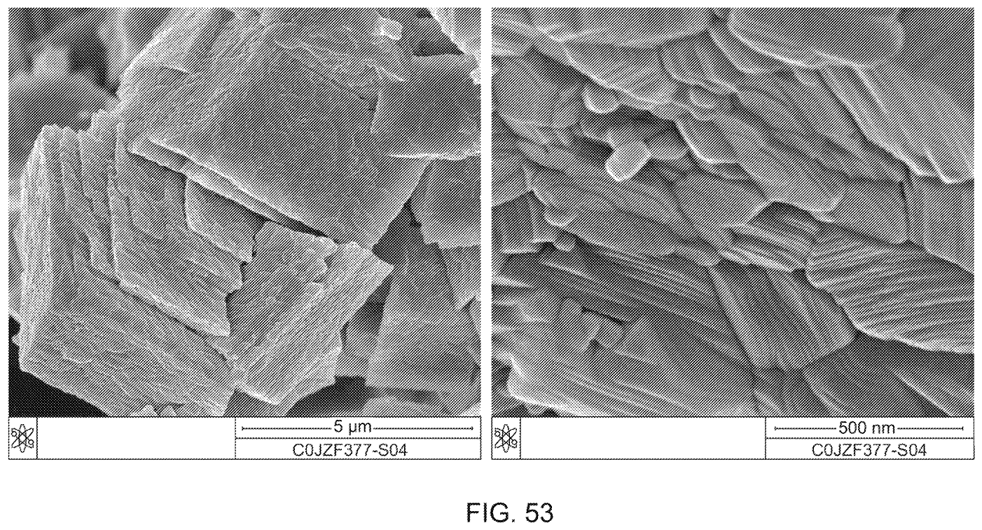

The type of MgO template material resulting from this process is identified herein as M₁T₄. The template particles retain the precursor particles' equiaxed superstructure, as shown in the SEM micrographs of FIG. 53. The template particles range from 5 μm to 20 μm in diameter. Compared to a comparable sample treated at 1050° C. (as described in Example M₁T₁ and shown in FIG. 51) or to a comparable sample treated at 1200° C. for only 1 minute (as described in Example M₁T₂ and shown in FIG. 52), the sample's particles appear to have rougher surfaces at low magnification. At higher magnification, the grains can be seen to have grown substantially during the 1200° C. isotherm. The pores evolved during thermal decomposition also appear to have been eliminated, similar to other exemplary template samples treated at 1200° C. for extended periods (e.g. H₁T₂ and N₁T₂).

Example E₁T₁: In another exemplary Template Stage procedure, an epsomite template precursor material may be thermally treated to form a dehydrated, basic MgSO₄ template material.

To demonstrate this, epsomite particles may first be generated. The epsomite particles used in this exemplary procedure are generated as described in Example E₁. This material represents the template precursor material that might be generated in the Precursor Stage of a full implementation of the General Method.

Next, the template precursor material may be thermally treated. This may be performed in a forced air circulation oven. The sample may be heated from room temperature to a final temperature of 215° C. During this thermal treatment, the hydrous epsomite particles may be dehydrated. The sample may be held at 215° C. for 2 hours, then allowed to cool.

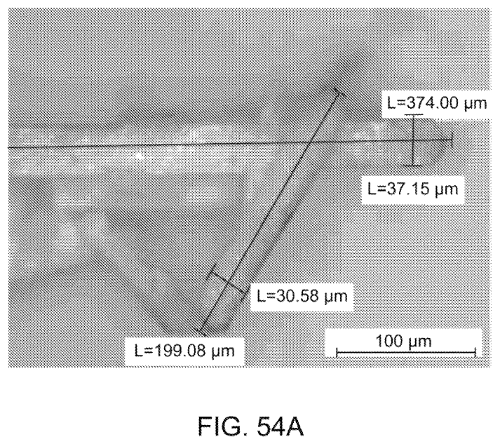

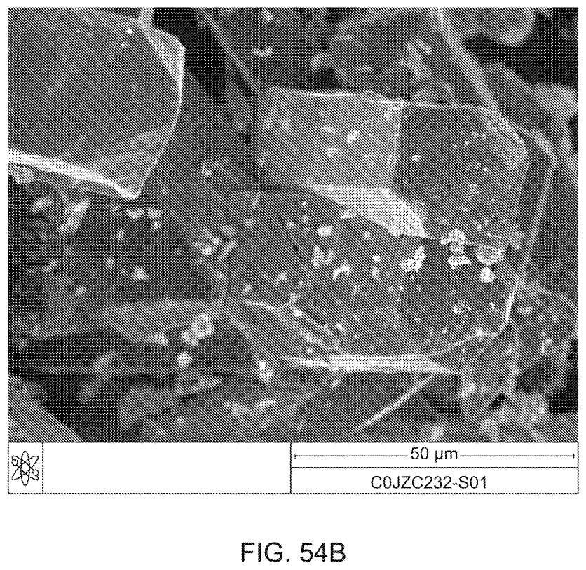

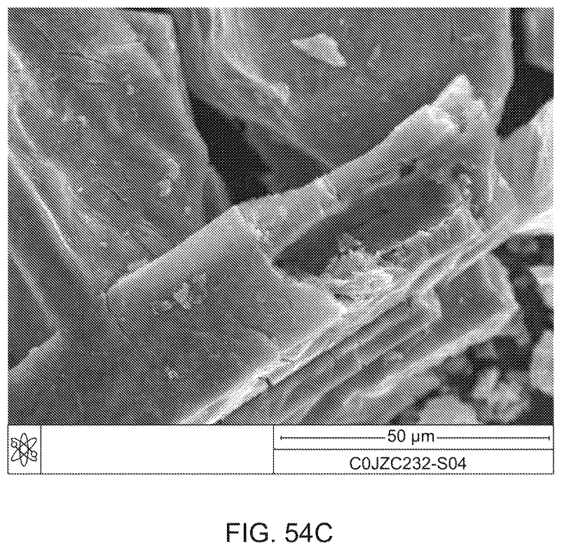

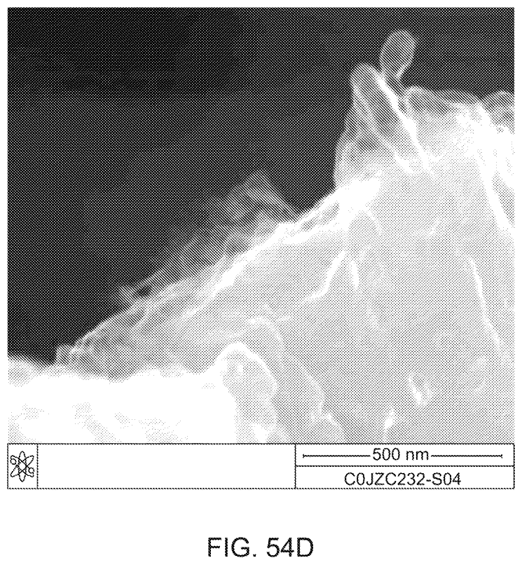

The resulting porous, dehydrated MgSO₄ sample is shown in FIG. 54A, which is an optical micrograph. The smooth facets observable in E₁ crystals (FIG. 38) have been replaced by rougher surfaces in FIG. 54A due to the evacuation of crystalline H₂O.

If the dehydrated MgSO₄ material is used in a high-temperature Replication Stage procedure, the MgSO₄ may initially experience further thermal effects and sintering, and this may be considered as a part of the thermal treatment used to generate the template material. Such a procedure may be performed according to Scheme B in a tube furnace, as detailed in Section III. This portion of the thermal treatment may comprise heating a sample of the dehydrated MgSO₄ material from room temperature to 580° C. under Ar gas flowing at 1102 sccm. During this thermal treatment, the MgSO₄ may continue coarsening, and a portion may decompose to MgO.

The type of MgSO₄ template material resulting from this process is identified herein as E₁T₁. Next, propylene (C₃H₆) gas may be introduced into the furnace, commencing surface replication. To the extent that the MgSO₄ template material is still coarsening, the Template Stage and Replication Stage may overlap. At some point, the pyrolytic formation of the carbon perimorphic material over the E₁T₁ template material may stabilize the latter, preventing further coarsening and representing the true completion of the Template Stage. CVD may be continued for 2 hours, then the furnace may then be allowed to cool under sustained Ar flow.

After the furnace has cooled to room temperature, the PC material (E₁T₁P₁₆) is collected. This PC material is shown in the SEM micrograph of FIG. 54B. From it, we can discern that the E₁T₁-type template particles retained the epsomite precursor particles' superstructure, although cracking can be observed. FIG. 54C and FIG. 54D are SEM micrographs of the P₁₆-type carbon perimorphic frameworks formed on the E₁T₁-type template particles. In FIG. 54D the cellular substructure is indicative of the template's porous substructure.

Example H₄T₁: In another exemplary Template Stage procedure, a Li-doped hydromagnesite precursor material may be thermally treated to form a porous MgO template material.

To demonstrate this, H₄-type hydromagnesite particles may first be generated using the procedure described in Example H₄. This material represents the template precursor material that might be generated in the Precursor Stage of a full implementation of the General Method.

Next, the template precursor material may be thermally treated. This may be performed in a tube furnace according to Scheme B under an Ar flow of 2000 sccm, as detailed in Section III. The sample may be heated from room temperature to a temperature of 1050° C. at a heating rate of 20° C./min. During this thermal treatment, CO₂ gas may be released. In a full implementation of the General Method, the CO₂ process gas released during the decomposition of the template precursor material may be conserved using conventional techniques. The sample may be held at 1050° C. for 20 minutes, after which the furnace may be allowed to cool.

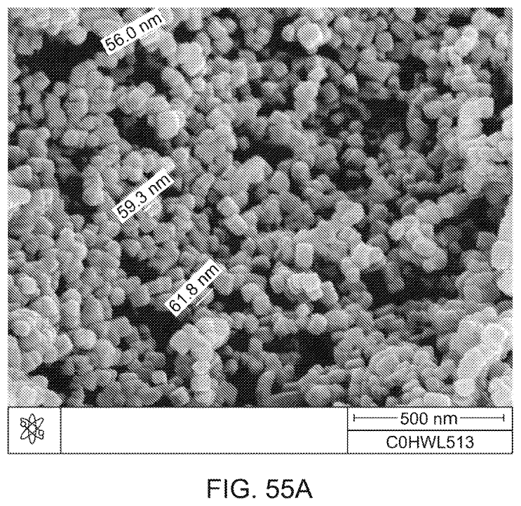

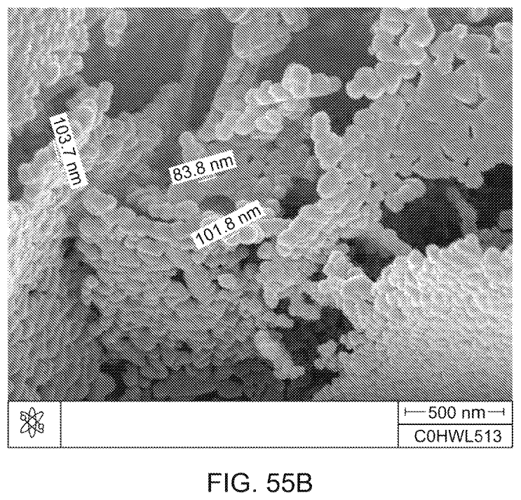

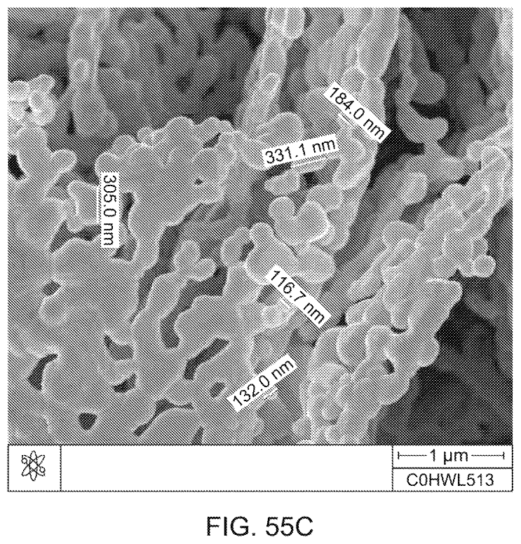

The type of porous MgO template material resulting from this process is identified herein as H₄T₁. The template particles retain the precursor particles' plate-like superstructure, as shown in the SEM micrograph of FIG. 55B. The individual plates range from approximately submicron to several microns in diameter, with an average size of around 1 m. The average plate thickness ranges from approximately 80 nm to 100 nm and corresponds structurally to a single layer of laterally networked subunits that average between 80 nm and 100 nm in diameter. The plates exhibit high uniformity in thickness from particle to particle. The subunits are discretized with numerous pores separating the individual nanocrystals.

At 80 nm to 100 nm in diameter, the subunits of the template particles in H₄T₁ are considerably larger than the 50 nm to 60 nm subunits shown in the SEM micrograph of FIG. 55A. These were derived from undoped hydromagnesite particles subjected to the same Template Stage procedure. As an approximation, a 90 nm subunit is 1.5× larger diametrically and over 3× larger volumetrically than a 60 nm subunit.

Example H₅T₁: In another exemplary Template Stage procedure, a Li-doped hydromagnesite precursor material may be thermally treated to form a porous MgO template material.

To demonstrate this, H₅-type hydromagnesite particles may first be generated using the procedure described in Example H₅. This material represents the template precursor material that might be generated in the Precursor Stage of a full implementation of the General Method.

Next, the template precursor material may be thermally treated. This may be performed in a tube furnace according to Scheme B under an Ar flow of 2000 sccm, as detailed in Section III. The sample may be heated from room temperature to a temperature of 1050° C. at a heating rate of 20° C./min. During this thermal treatment, CO₂ gas may be released. In a full implementation of the General Method, the CO₂ process gas released during the decomposition of the template precursor material may be conserved using conventional techniques. The sample may be held at 1050° C. for 20 minutes, after which the furnace may be allowed to cool.

The type of porous MgO template material resulting from this process is identified herein as H₅T₁. The template particles retain the precursor particles' plate-like superstructure, but with much larger interstitial gaps between the subunits, as shown in the SEM micrograph of FIG. 55C. The plate particles range from 2 μm to 8 μm laterally and from 100 nm to 300 nm in thickness. Like other Li-doped and pure hydromagnesite-derived MgO templates, the plates are generally a single subunit in thickness.

Compared to 114T₁-type template particles (FIG. 55B) created via the same thermal treatment, H₅T₁-type template particles exhibit much larger subunits, which range between 150 nm and 500 nm in lateral diameter. The subunits may be 1 to 2 OOM larger volumetrically than the subunits of an undoped, ex-hydromagnesite MgO template (FIG. 55A). Additionally, the subunits are not as cuboidal as the undoped subunits and show increased elongation along the plane of the plate. This shows that increasing the dopant concentration may increase coarsening effects during thermal treatments and also change the geometry of the subunits. Given these results, doping with a variety of heteroatoms may be expected to be useful for template engineering.

Example H₆T₁: In another exemplary Template Stage procedure, a hydromagnesite template precursor material may be thermally treated to form a porous MgO template material.

To demonstrate this, a commercial hydromagnesite product (“Light Magnesium Carbonate” supplied by Akrochem Corporation) comprised predominately of plate-like particles may be employed. This commercial product was selected as it may provide similar chemical and morphological properties to that of a hydromagnesite template precursor; for this reason, this precursor material is described herein as H₆. It represents the template precursor material that might be generated in the Precursor Stage of a full implementation of the General Method.

Next, the template precursor material may be thermally treated. This may be performed in a muffle furnace according to Scheme D, as detailed in Section III. The sample may be placed in a ceramic boat within the muffle furnace. The sample may be heated from room temperature to 750° C. at a heating rate of 5° C./min. During this thermal treatment, CO₂ gas may be released. In a full implementation of the General Method, the CO₂ process gas released during the decomposition of the template precursor material may be conserved using conventional techniques. The sample may then be held at 750° C. for 1 hour, then allowed to cool to room temperature.

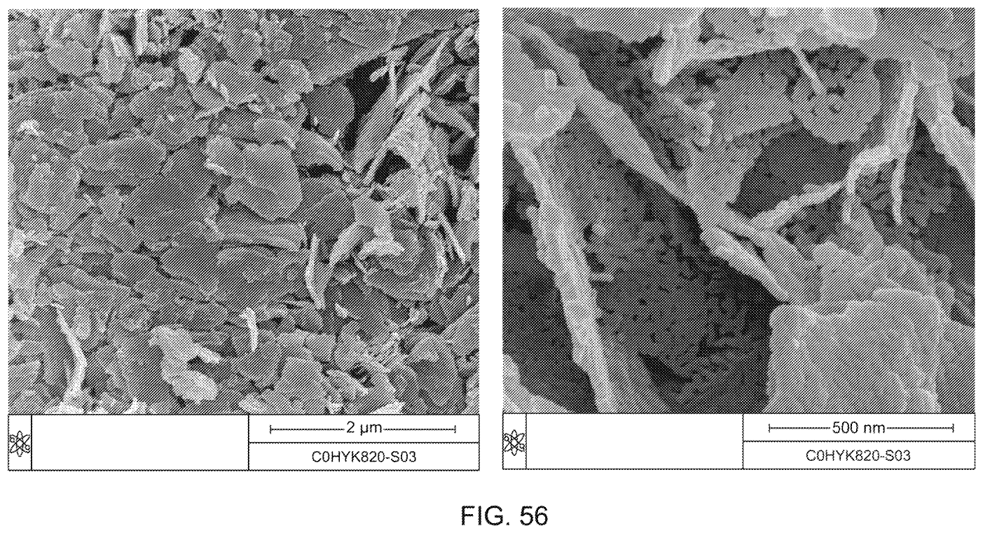

The type of porous MgO template material resulting from this process is identified herein as H₆T₁. The template particles retain the precursor particles' plate-like superstructure, as shown in the SEM micrographs of FIG. 56. The individual plates range from approximately 0.5 μm to 2 μm along their major and intermediate axes, with an average diameter between these values. The average plate thickness is less than 100 nm and corresponds structurally to a single layer of laterally networked subunits. Plates exhibits high uniformity in thickness across particles.

Examples M₃T₁, M₄T₁, M₅T₁: In another set of exemplary Template Stage procedures, magnesite template precursor materials may be thermally treated to form porous MgO template materials.

To demonstrate this, M₃-type magnesite particles may first be generated using the procedure described in Example M₃, M₄, and M₅. This material represents the template precursor material that might be generated in the Precursor Stage of a full implementation of the General Method.

Next, the template precursor material may be thermally treated. This may be performed in a muffle furnace according to Scheme D, as detailed in Section III. The sample (M₃, M₄ or M₅) may be placed in a ceramic boat within the muffle furnace. The sample may be heated from room temperature to 580° C. at a heating rate of 5° C./min. The sample may then be maintained at to 580° C. for 1 hour. During this thermal treatment, CO₂ gas may be released. In a full implementation of the General Method, the CO₂ process gas released during the decomposition of the template precursor material may be conserved using conventional techniques. Next, the sample may be heated from 580° C. to 1050° C. at a heating rate of 5° C./min, with the sample maintained at this temperature for 3 hours. Then, it may be allowed to cool to room temperature.

The types of porous MgO template material resulting from this process are identified herein as M₃T₁, M₄T₁, and M₅T₁ (corresponding to variants based on M₃, M₄, and M₅ template precursor materials). The M₃T₁, M₄T₁, and M₅T₁ template materials may be compared to demonstrate the use of dopants to increase coarsening effects during a thermal treatment. It is instructive to look at carbon perimorphic frameworks formed on these templates, since the frameworks in their native morphology are replicas of the templating surfaces (and negative replicas of the templating bulk). Additionally, carbon frameworks are also partially electron-transparent, allowing visualization of the templates' internal substructure.

The PC materials made using the M₃T₁, M₄T₁, and M₅T₁ template materials are identified herein as M₃T₁P₂, M₄T₁P₁₉ and M₅T₁P₂₀, respectively (these exemplary Replication Stage procedures are described in Section VI). The endomorphic MgO in these PC materials may then be extracted with an aqueous H₂CO₃ extractant solution, leaving behind the carbon perimorphic products P₁, P₁₉ and P₂₀. These perimorphic materials may be examined in order to determine the templates' substructure.

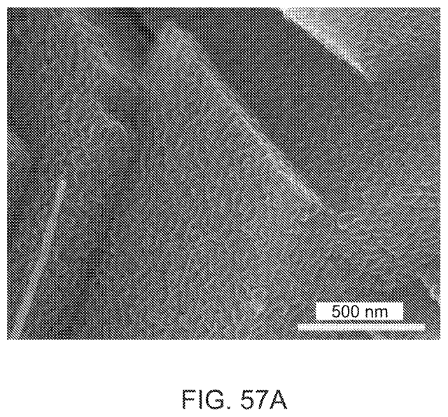

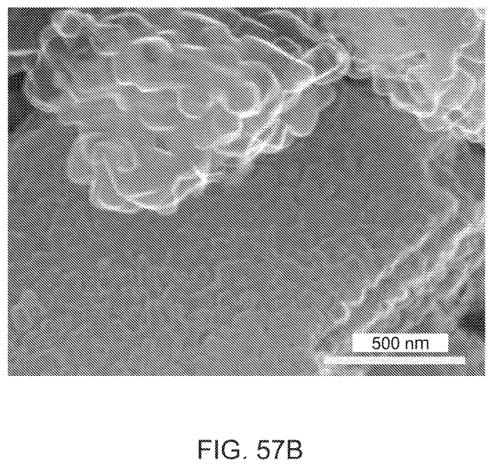

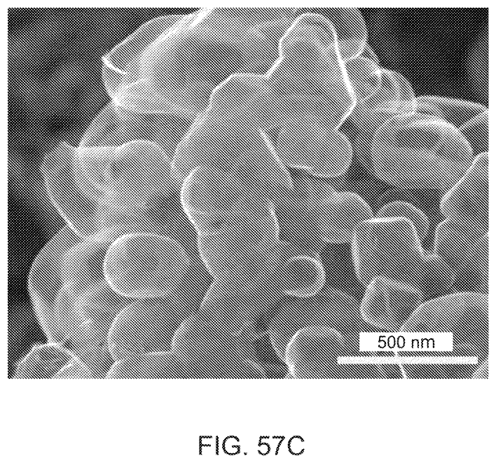

The P₁, P₁₉ and P₂₀ perimorphic materials are shown in the SEM micrographs of FIG. 57A, FIG. 57B, and FIG. 57C, respectively. The cellular subunits of the carbon perimorphic frameworks (P₂₀) that were made on the most heavily Na-doped template material (M₅T₁) may be 1 to 2 OOM larger volumetrically than the cellular subunits of the frameworks (P₁) that were made on the undoped template material (M₃T₁). As a result, the frameworks made on the doped template materials are dramatically less compact than the frameworks made on the undoped template.

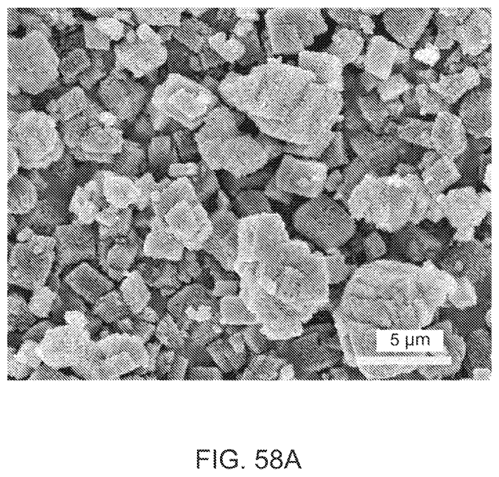

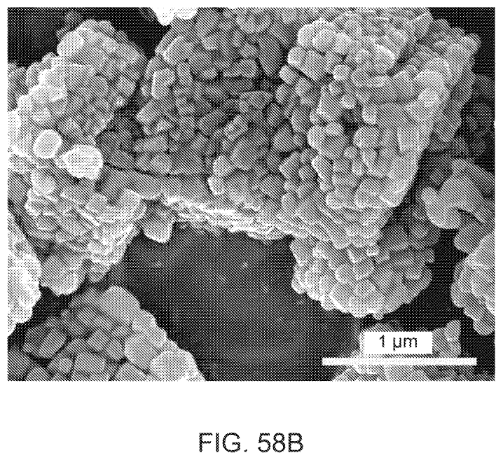

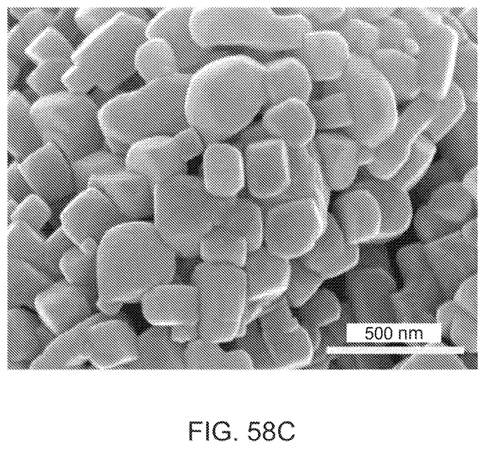

The PC materials (M₅T₁P₂₀) made from M₅T₁ are shown in FIG. 58A-58C. The particles retain the precursor particles' equiaxed superstructure, with particles generally measuring approximately 1 μm to 5 μm. The substructure of the particles are very coarse, comprising subunits ranging from 100 nm to 400 nm.

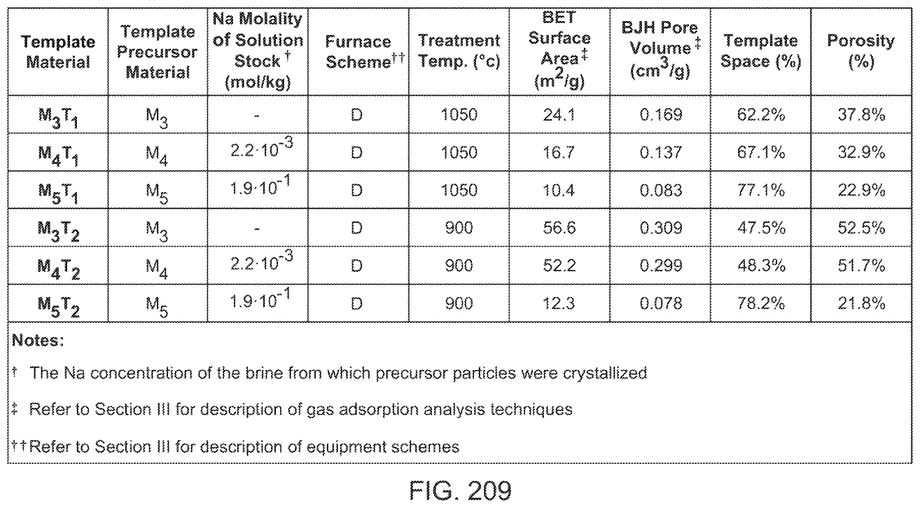

FIG. 209 summarizes the N₂ gas adsorption analysis of the template materials M₃T₁, M₄T₁ and M₅T₁. After the 1050° C. thermal treatments applied to M₃T₁, M₄T₁ and M₅T₁, the Na-doped template materials' BET surface area is reduced by 31% (M₄T₁) and 57% (M₅T₁) compared to the undoped template material (M₃T₁). Also, the Na-doped samples have 13% (M₄T₁) and 30% (M₅T₁) lower porosity than the undoped template material (M₃T₁) after the 1050° C. thermal treatment. As the level of dopant in the template material increases, coarsening and densification increase.

Similar to the observations made for Li-doped magnesite template precursors, this shows that Na-doping may aid in coarsening the template and reducing the compactness of the perimorphic frameworks. Other dopants may have similar effects.

Examples M₃T₂, M₄T₂, and M₅T₂: In another set of exemplary Template Stage procedures, magnesite template precursor materials may be thermally treated to form porous MgO template materials.

To demonstrate this, M₃-type, M₄-type, and M₅-type magnesite particles may first be generated using the procedure described in Examples M₃, M₄, and M₅. This material represents the template precursor material that might be generated in the Precursor Stage of a full implementation of the General Method.

Next, the template precursor material may be thermally treated. This may be performed in a muffle furnace according to Scheme D, as detailed in Section III. The sample (M₃, M₄ or M₅) may be placed in a ceramic boat within the muffle furnace. The sample may be heated from room temperature to 580° C. at a heating rate of 5° C./min. The sample may then be maintained at to 580° C. for 1 hour. During this thermal treatment, CO₂ gas may be released. In a full implementation of the General Method, the CO₂ process gas released during the decomposition of the template precursor material may be conserved using conventional techniques. Next, the sample may be heated from 580° C. to 900° C. at a heating rate of 5° C./min, with the sample maintained at this temperature for 1 hour. Then, it may be allowed to cool to room temperature.

The types of porous MgO template material resulting from this process are identified herein as M₃T₂, M₄T₂, and M₅T₂ (corresponding to variants based on M₃, M₄, and M₅ template precursor materials).

FIG. 209 summarizes the N₂ gas adsorption analysis of the template materials M₃T₂, M₄T₂ and M₅T₂. After the 900° C. thermal treatment, the Na-doped template materials' surface area is reduced by 8% (M₄T₂) and 78% (M₅T₂) compared to the undoped template material (M₃T₁). Their reduced surface area is consistent with the relatively coarser substructures of the Na-doped template materials vs. the undoped template materials.

Results for BJH are limited to a pore size range of 1.70 nm and 300 nm for this N₂ gas adsorption method. Using the calculated BJH cumulative pore volume it may be possible to determine the porosity of the template particles. The porosity may be defined as the ratio of specific pore volume to the specific template volume and can be thought of as the percentage of total space occupied by pores with respect to the total particle. The BJH desorption cumulative pore volume (V_{PORE}) may be used as a measure of the specific pore volume of the template particles. The specific MgO volume (V_{M}go) may be the specific volume of the MgO component of the porous MgO template—i.e. the reciprocal of the theoretical density of MgO. The specific template volume (V_{TEM}) may be the sum of specific pore volume and specific MgO volume. Using the formula shown below, the porosity of the template particles may be determined:

$$Porosity ( \% ) = \frac{{V}_{PORE}}{{V}_{TEM}} = \frac{{V}_{PORE}}{( {V}_{PORE} + {V}_{MgO} )} \\ Template Space ( \% ) = 1 - Porosity ( \% )$$

After the 900° C. thermal treatment, the doped samples have 1.5% (M₄T₂) and 58% (M₅T₂) lower porosity than the undoped template material (M₃T₂). This demonstrates, as in previous exemplary procedures, that the level of dopant in the template material can be used to influence coarsening and densification effects. Taken in tandem with the results of Li-doping that have been described, this demonstrates the ability to tune a perimorphic framework's compactness, the size and morphology of its cellular subunits, and its ratio of endocellular vs. exocellular space.

Example M₃T₃: In another exemplary Template Stage procedure, magnesite template precursor materials may be thermally treated to form porous MgO template materials.

To demonstrate this, M₃-type magnesite particles may first be generated using the procedure described in Example M₃. This material represents the template precursor material that might be generated in the Precursor Stage of a full implementation of the General Method.

Next, the template precursor material may be thermally treated. This may be performed in a muffle furnace according to Scheme D, as detailed in Section III. The template precursor sample may be placed in a ceramic boat within the muffle furnace. The sample may be heated from room temperature to 580° C. at a heating rate of 5° C./min. The sample may then be maintained at to 580° C. for 13.5 hr. During this thermal treatment, CO₂ gas may be released. In a full implementation of the General Method, the CO₂ process gas released during the decomposition of the template precursor material may be conserved using conventional techniques. Next, the sample may be heated from 580° C. to 1050° C. at a heating rate of 5° C./min, with the sample maintained at this temperature for 1 hr. Then, it may be allowed to cool to room temperature.

The type of porous MgO template material resulting from this process are identified herein as M₃T₃.

Example N₂T₁: In another exemplary Template Stage procedure, a nesquehonite template precursor material may be thermally treated to form a porous MgO template material.

To demonstrate this, N₂-type nesquehonite particles may first be generated using the procedure described in Example N₂. This material represents the template precursor material that might be generated in the Precursor Stage of a full implementation of the General Method.

Next, the template precursor material may be thermally treated using steam as a coarsening aid. This may be performed in a rotary tube furnace according to Scheme A, as detailed in Section III. The quartz tube may be rotated at 1 rpm. Under dry Ar flow, an N₂ sample may be heated from room temperature to 450° C. at a heating rate of 5° C./min in the furnace. Once the furnace reaches 450° C., Ar flow through a bubbler may be started at a flow rate of 2360 sccm. The chamber of the bubbler may be maintained at slight positive pressure of 0.23 psig and an external temperature of 100° C. may be maintained to saturate the bubbler headspace with water vapor. The furnace may be maintained at 450° C. for 1 hour, after which it may then be heated at a heating rate of 5° C./min to 500° C. After 1 hour at 500° C., the furnace may be heated at a heating rate of 5° C./min to the final temperature of 1000° C. and held at 1000° C. for 1 hour. During this thermal treatment, CO₂ gas may be released. In a full implementation of the General Method, the CO₂ process gas released during the decomposition of the template precursor material may be conserved using conventional techniques. At this point, dry Ar flow may be resumed and the sample may be cooled to room temperature under flowing, dry Ar.

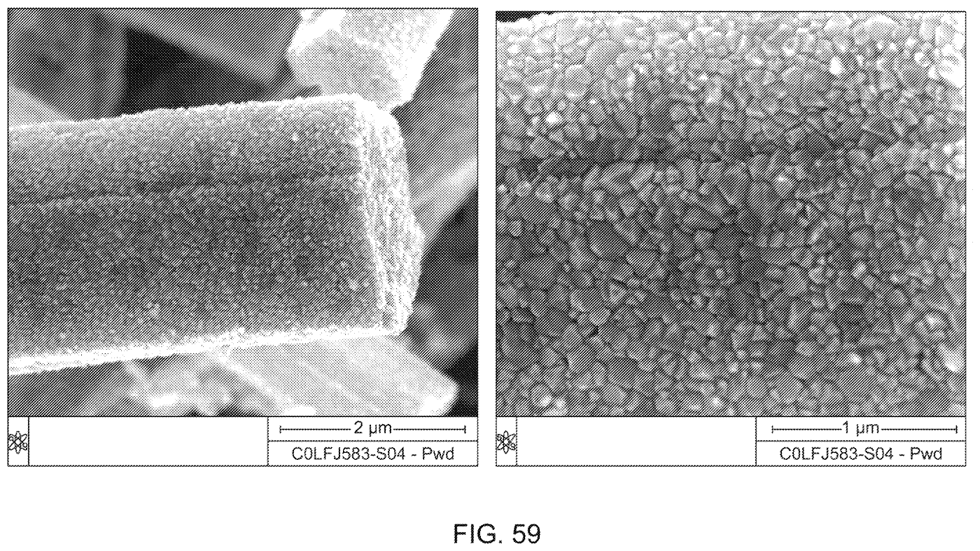

The type of porous MgO template material resulting from this process is identified herein as N₂T₁. The template particles retain the precursor particles' elongated superstructure. This can be observed in SEM micrographs of an exemplary PC material (N₂T₁P₂₁) made via surface replication on the N₂T₁ template particles. The N₂T₁P₂₁ PC material, comprising a thin, electron-transparent carbon perimorphic phase and an N₂T₁ endomorphic phase, is shown in the SEM micrographs of FIG. 59. Provided the carbon perimorphic walls are sufficiently thin, imaging the PC material is a good way to understand the template substructure and superstructure, since the PC material comprises the endomorphic template particles coated with a conformal, conductive layer.

In FIG. 59, it is evident that the N₂T₁ template materials are coarser than a the N₁T₁ template materials (FIG. 46). The subunits range in size from 50 and 400 nm. This demonstrates the use of water vapor during a heat treatment to increase coarsening during the Template Stage. Of particular note, the template's porosity appears to be substantially decreased, and the small slit-like morphology of the pores between the subunits is notable.

Example N₂T₂: In another exemplary Template Stage procedure, a nesquehonite template precursor material may be thermally treated to form a porous MgO template material.

To demonstrate this, N₂-type nesquehonite particles may first be generated using the procedure described in Example N₂. This material represents the template precursor material that might be generated in the Precursor Stage of a full implementation of the General Method.

Next, the template precursor material may be thermally treated. This may be performed in a rotary tube furnace according to Scheme A, as detailed in Section III. The quartz tube may be rotated at 1 rpm. Under dry Ar flow, an N₂-type sample may be heated from room temperature to 450° C. at a heating rate of 5° C./min in the furnace. Once the furnace reaches 450° C., dry Ar flow through a bubbler may be started at a flow rate of 2360 sccm. The furnace may be maintained at 450° C. for 1 hour, after which it may then be heated at a heating rate of 5° C./min to 500° C. After 1 hour at 500° C., the furnace may be heated at a heating rate of 5° C./min to the final temperature of 1000° C. and held at 1000° C. for 1 hour. During this thermal treatment, CO₂ gas may be released. In a full implementation of the General Method, the CO₂ process gas released during the decomposition of the template precursor material may be conserved using conventional techniques. At this point, dry Ar flow may be resumed and the sample may be cooled to room temperature under flowing, dry Ar.

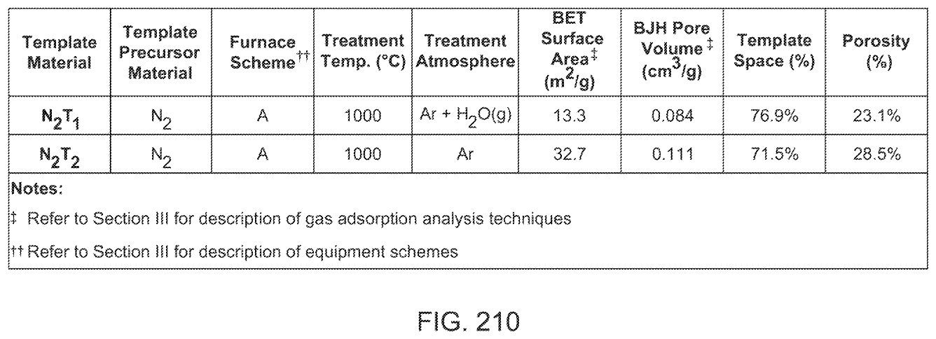

The type of porous MgO template material resulting from this process is identified herein as N₂T₂. N₂ gas adsorption may be performed on these templates, applying methods described previously. As seen in FIG. 210, compared to the N₂T₂ template material generated via a dry treatment of N₂-type precursor material at 1000° C., the N₂T₁ template material generated via a steam-assisted treatment of N₂-type precursor material at 1000° C. resulted in a 59% reduction in surface area. This shows that coarsening may be increased by utilizing water vapor.

Examples N₂T₃, N₂T₄, N₂T₅, and N₂T₆: In another set of exemplary Template Stage procedures, nesquehonite template precursor materials may be thermally treated to form porous MgO template materials.

To demonstrate this, N₂-type nesquehonite particles may first be generated using the procedure described in Example N₂. This material represents the template precursor material that might be generated in the Precursor Stage of a full implementation of the General Method.

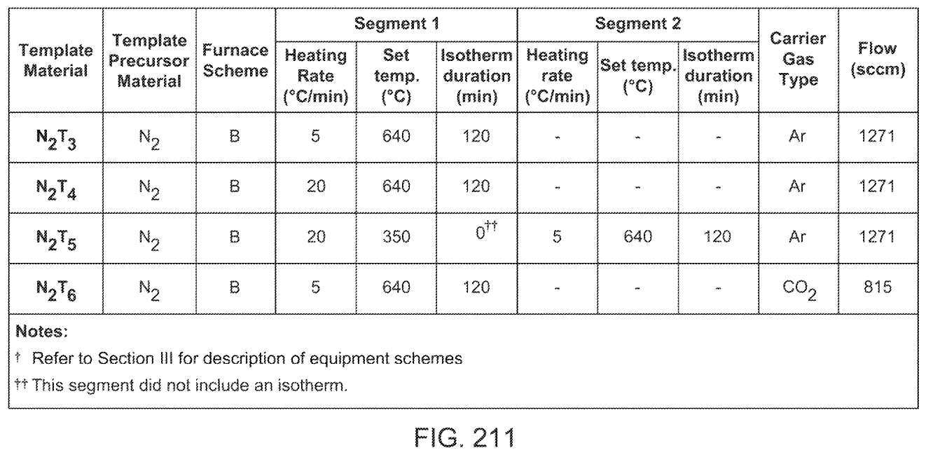

Next, the template precursor material may be thermally treated in several ways summarized in FIG. 211. Each of these thermal treatments may be performed in a tube furnace according to Scheme B, as detailed in Section III. Briefly, all procedures involve initiating a desired flow of carrier gas and treating the template precursor samples under a desired thermal conditions. Each thermal treatment may involve either a single isothermal segment or multiple isothermal segments. During this thermal treatment, CO₂ gas may be released. In a full implementation of the General Method, the CO₂ process gas released during the decomposition of the template precursor material may be conserved using conventional techniques. The template precursor material, carrier gas, furnace scheme, heating rate, temperature setting, and isotherm duration of each segment are specified in FIG. 211. After all of the segments pertaining to a thermal treatment have elapsed, the furnace may be allowed to cool to room temperature under sustained flow of the carrier gas.

The type of porous MgO template materials resulting from the processes are identified herein as N₂T₃, N₂T₄, N₂T₅, and N₂T₆. These variants were performed to test how thermal treatment parameters affect the resulting template morphology.

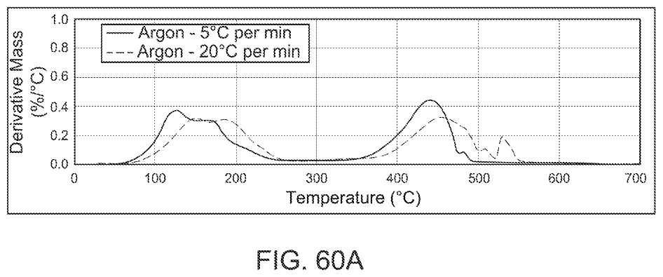

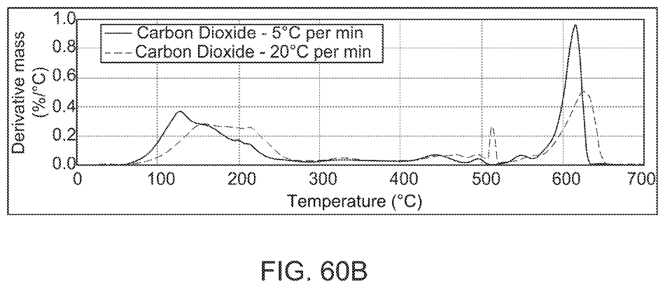

During thermal treatment of hydrated NgCOrxI20 template precursor materials, H₂O and CO₂ are the two primary gases released. The thermogravimetric mass loss profiles for N₂-type template precursor material in Ar is shown in FIG. 60A. This chart shows the derivative of mass loss (%/° C.) for an N₂-type template precursor material at heating rates of 5° C./min and 20° C./min. Dehydration may be substantially complete by 300-350° C. Decarboyxlation may be substantially complete by 500-550° C., producing MgO. With the faster 20° C./min heating rate, the mass loss profile is shifted to higher temperatures. FIG. 60B shows the thermogravimetric mass loss profiles for N₂-type template precursor material in CO₂. Compared to the mass loss in Ar, the mass loss CO₂ is delayed until higher temperatures and occurs more suddenly, as shown by the height of the derivative curve.

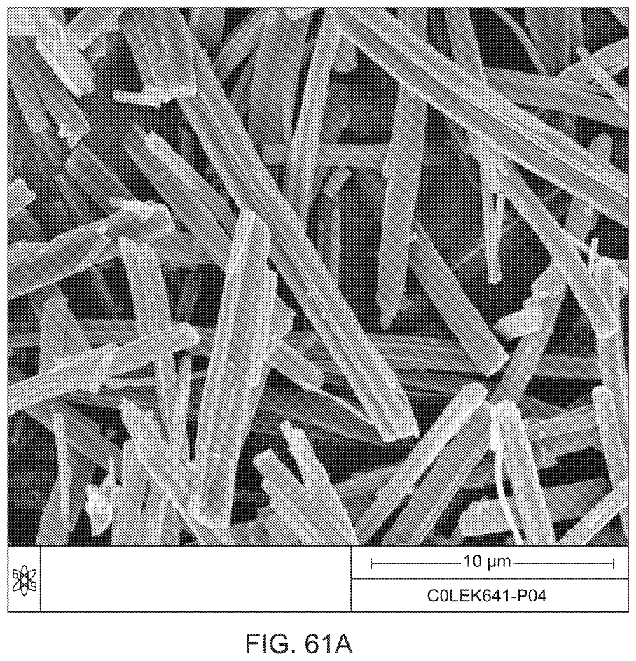

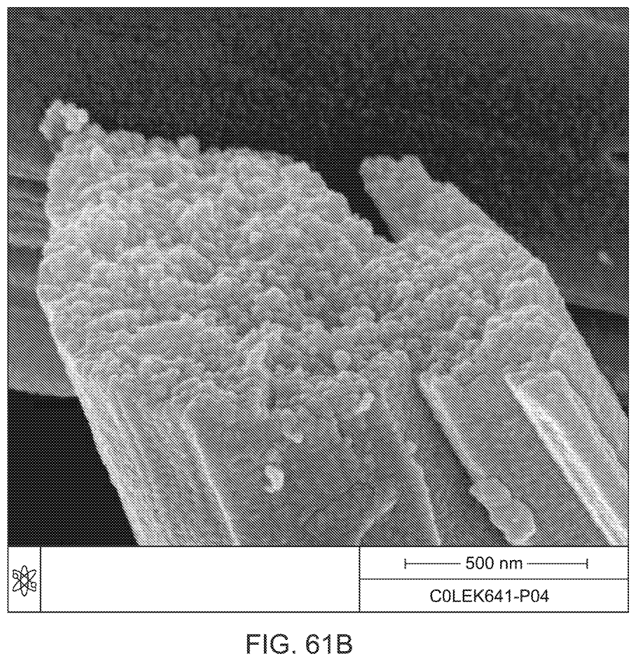

The N₂T₃-type template material is shown in the SEM micrographs of FIG. 61A-61B. This template material, generated under Ar flow at a heating rate of 5° C./min from room temperature to 640° C., retains the elongated superstructure of the N₂-type precursor particles. The porous substructure comprises uniform, repeating subunits, and no macropores are apparent.

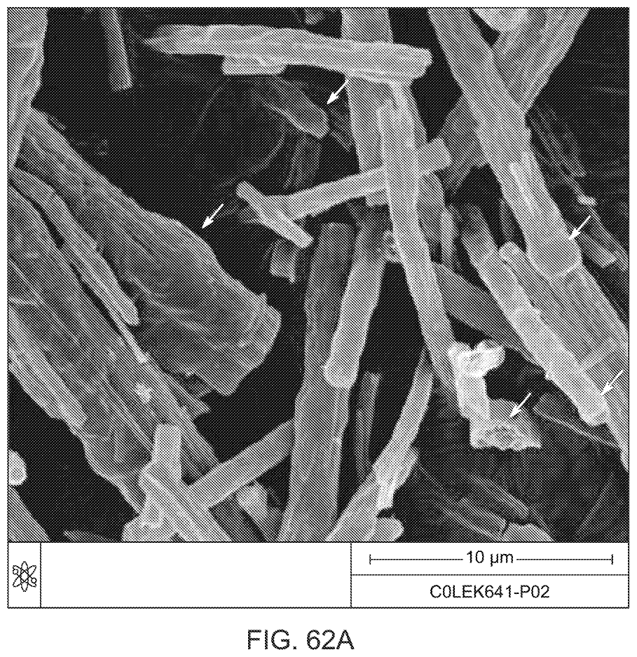

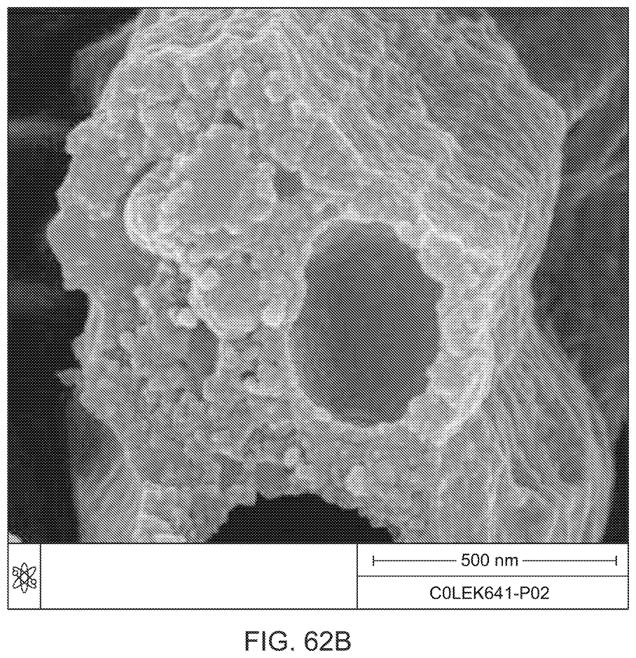

The N₂T₄-type template material is shown in the SEM micrographs of FIG. 62A-62B. This template material, generated under Ar flow at a heating rate of 20° C./min from room temperature to 640° C., retains the elongated superstructure of the N₂-type precursor particles. The porous substructure comprises macropores in addition to the mesopores between the subunits. These macropores are internal and only visible as bulbous protrusions except at places where the template particles are broken, which allows the interior to be seen. These protrusions result in an undulating surface, as marked with arrows in FIG. 62A. These cavities are formed via expansion of volatilized CO₂ gas produced during thermal decomposition. This gas acts as a blowant, creating macropores (FIG. 62B) and plastically deforming the surrounding phase of non-crystalline MgCO₃·xH₂O.

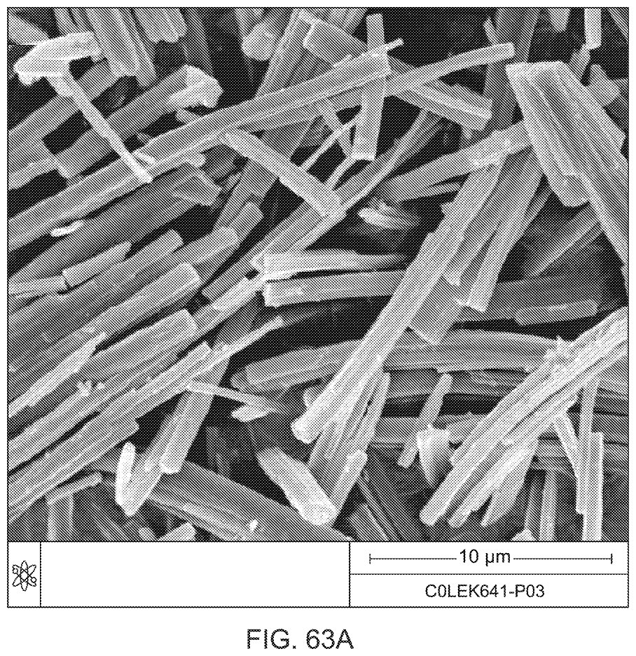

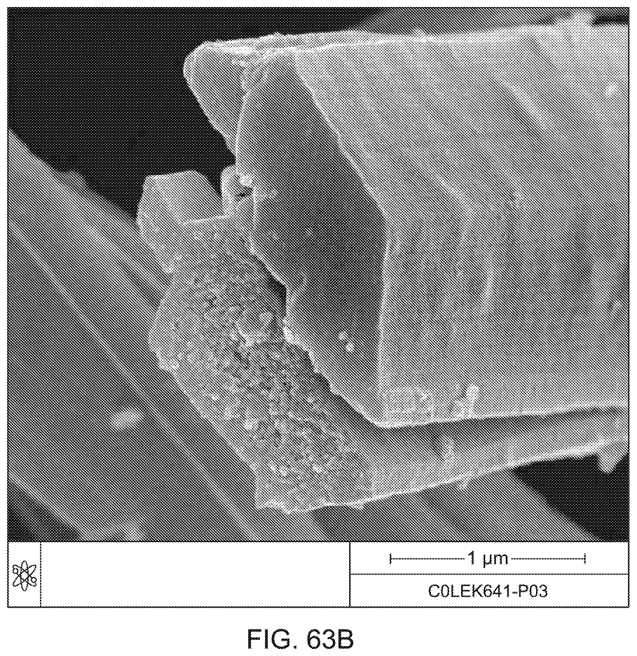

The N₂T₅-type template material is shown in the SEM micrographs of FIG. 63A-63B. This template material, generated under Ar flow at a heating rate of 20° C./min from room temperature to 350° C., followed by a heating rate of 5° C./min from 350° C. to 640° C., does not form internal macropores and the associated bulbous protrusions. Instead, the prismatic superstructure of the elongated nesquehonite precursor particles is retained by the template particles. The substructure comprises regular repeating subunits and mesopores. The absence of macropores indicates that the increased heating rate during decarboxylation exacerbates the build-up of CO₂ trapped in the particles' bulk.

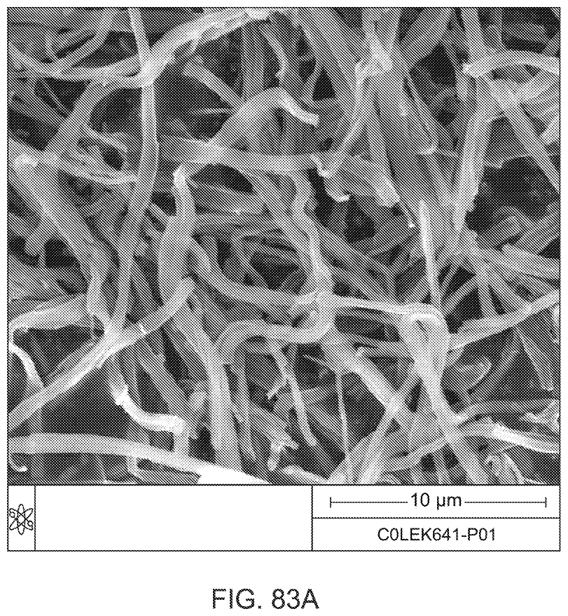

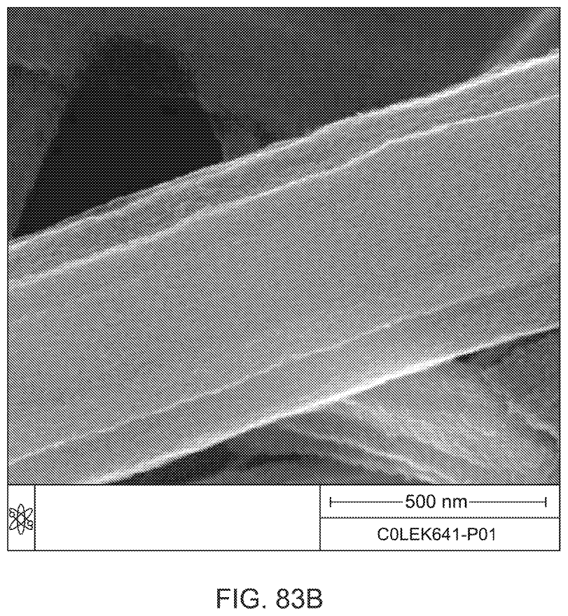

The template particles' internal macropores are inherited by the PC particles produced in the Replication Stage and the perimorphic frameworks produced in the Separation Stage. These internal macropores can be clearly observed in Cui's mesoporous graphene fibers. Elimination of these macropores in the template material results in their absence in the perimorphic material, as shown in the SEM micrographs of FIG. 83A-83B. The presence of these uncontrolled macropores may be undesirable in many applications; therefore the N₂T₃-type and N₂T₅-type template materials without these internal macropores represent a preferred variant of the nesquehonite-derived class of porous MgO template materials.

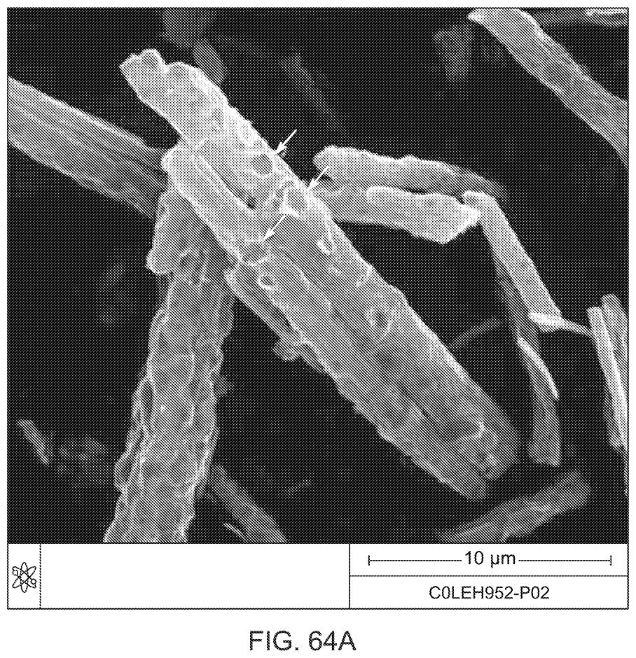

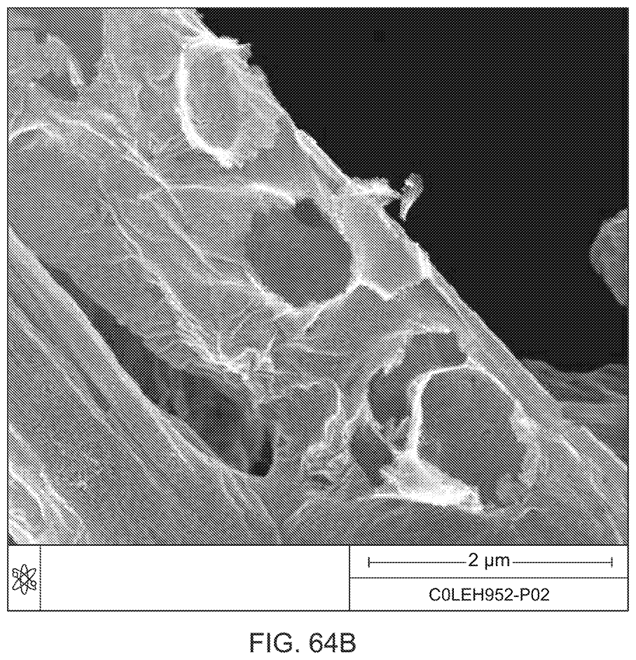

A PC material (N₂T₆P₂₂) made on N₂T₆-type template material is shown in the SEM micrographs of FIG. 64A-64B. Provided the carbon perimorphic walls are sufficiently thin, imaging the PC material provides a good representation of the template morphology, since the PC material comprises the endomorphic template particles coated with a conformal, conductive layer. Based on this, it can be concluded that the N₂T₆-type template particles, generated under CO₂ flow at a heating rate of 5° C./min from room temperature to 640° C., were catastrophically ruptured during the Template Stage. These ruptures are indicated by the arrows in FIG. 64A. This example highlights the role that heating rates and gas environments may have during Template Stage processes.

Example L₂T₁: In another exemplary Template Stage procedure, a lansfordite template precursor material may be thermally treated to form a porous MgO template material.

To demonstrate this, L₂-type lansfordite particles may first be generated using the procedure described in Example L₂. This material represents the template precursor material that might be generated in the Precursor Stage of a full implementation of the General Method.

Next, the template precursor material may be thermally treated. This may be performed in a tube furnace according to Scheme B, as described in Section III. An L₂-type sample may be placed in the tube furnace. Under an Ar flow of 1220 sccm, the furnace may be heated from room temperature to 640° C. at a heating rate of 20° C./min and maintained at 640° C. for 2 hours. During this thermal treatment, CO₂ gas may be released. In a full implementation of the General Method, the CO₂ process gas released during the decomposition of the template precursor material may be conserved using conventional techniques. The furnace may then be allowed to cool to room temperature under sustained Ar flow.

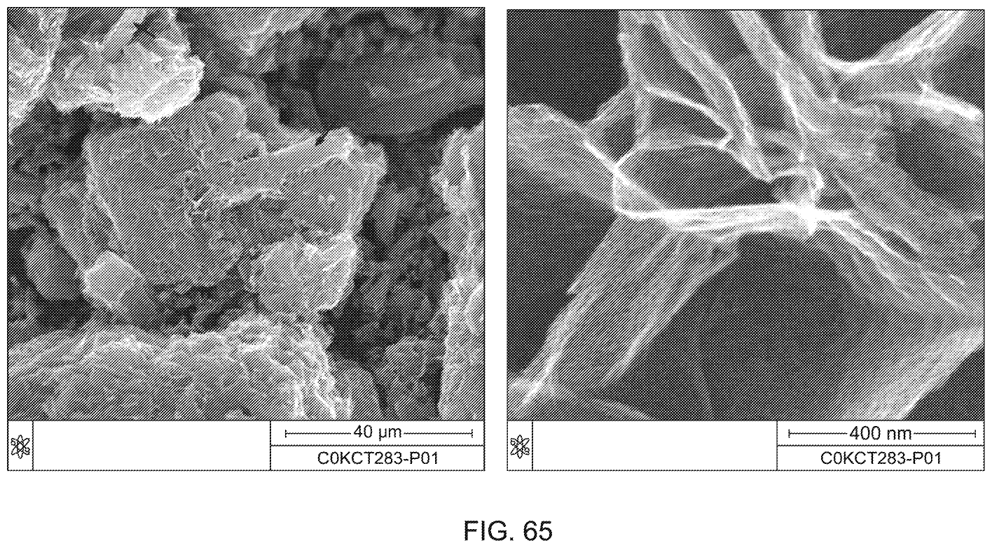

The type of porous MgO template material resulting from this process is identified herein as L₂T₁. The morphology of L₂T₁-type template particles can be discerned from the native morphology of carbon perimorphic frameworks synthesized on them. Such frameworks are shown in the SEM micrographs of FIG. 65. The carbon frameworks reveal that the lansfordite template precursor material underwent recrystallization during the Template Stage procedure, forming both hydromagnesite and nesquehonite phases prior to formation of the L₂T₁ template material. The recrystallization of the precursor during may be due to the large quantity of water released in the early stages of the thermal treatment.

Example L₃T₁: In another exemplary Template Stage procedure, a partially dehydrated lansfordite template precursor material may be thermally treated to form a porous MgO template material.

To demonstrate this, L₃-type partially dehydrated lansfordite particles may first be generated using the procedure described in Example L₃. This material represents the template precursor material that might be generated in the Precursor Stage of a full implementation of the General Method.

Next, the template precursor material may be thermally treated. This may be performed in a tube furnace according to Scheme B, as described in Section III. The L₃-type template precursor material may be placed in the tube furnace. While under an Ar flow of 1220 sccm, the furnace may be heated from room temperature to 640° C. at 20° C./min and maintained at 640° C. for 2 hours. During this thermal treatment, CO₂ gas may be released. In a full implementation of the General Method, the CO₂ process gas released during the decomposition of the template precursor material may be conserved using conventional techniques. After this thermal treatment, the furnace may be allowed to cool to room temperature under sustained Ar flow. The furnace may then be allowed to cool to room temperature under sustained Ar flow.

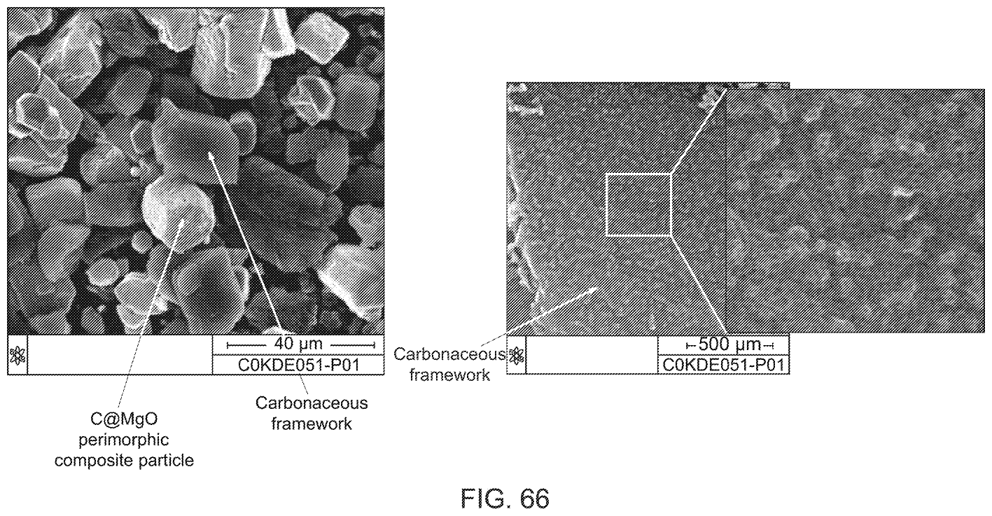

The type of porous MgO template material resulting from this process is identified herein as L₃T₁. The morphology of the L₃T₁-type template particles can be discerned from the native morphology of carbon perimorphic frameworks synthesized on them. In FIG. 66, an SEM micrograph of a mixture of C@MgO PC particles and carbon perimorphic frameworks made from L₃T₁-type template particles is shown. These particles show no signs of recrystallization into hydromagnesite or nesquehonite, from which we can infer that the L₃ template precursor material did not undergo sufficiently extensive recrystallization during the thermal treatment detailed above. This demonstrates that the superstructure of lansfordite and other highly hydrated template precursor materials may be better preserved if, like the L₃ template precursor material, they can be partially or completely dehydrated using rapid techniques such as flash-drying or spray-drying.

Example L₃T₂: In another exemplary Template Stage procedure, a partially dehydrated lansfordite template precursor material may be thermally treated to form a porous MgO template material.

To demonstrate this, L₃-type partially dehydrated lansfordite particles may first be generated using the procedure described in Example L₃. This material represents the template precursor material that might be generated in the Precursor Stage of a full implementation of the General Method.

Next, the template precursor material may be thermally treated. This may be performed in a tube furnace according to Scheme B, as described in Section III, with a few modifications. While under a CO₂ flow of 815 sccm, the furnace may be heated to 540° C. and maintained at that temperature. An L₃-type sample may be staged inside the quartz tube but outside of the heating zone prior to the thermal treatment. Then, the template precursor material may be rapidly introduced into the preheated zone by a pushing mechanism and maintained at 540° C. for 30 minutes. During this thermal treatment, CO₂ gas may be released. In a full implementation of the General Method, the CO₂ process gas released during the decomposition of the template precursor material may be conserved using conventional techniques. Finally, the treated template may be removed from the heat zone and allowed to cool to room temperature under sustained CO₂ flow.

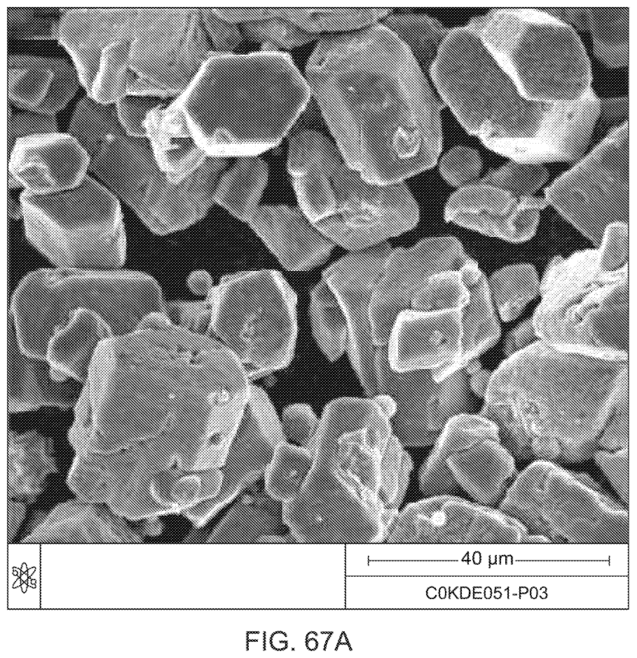

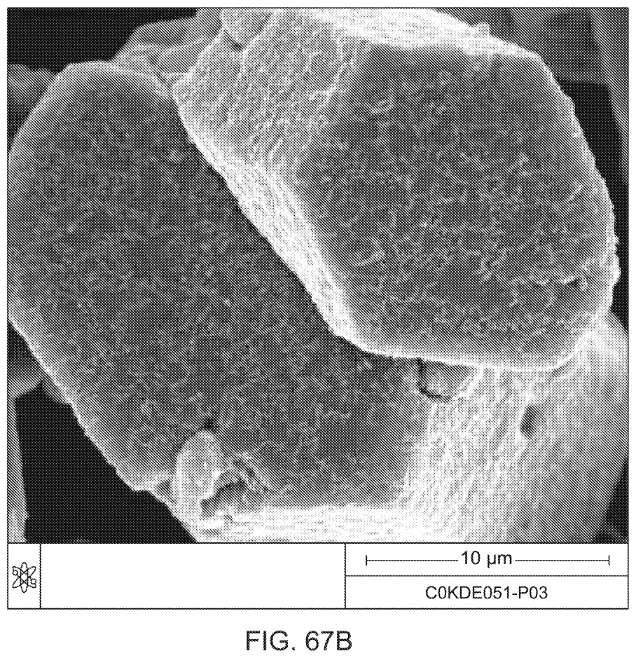

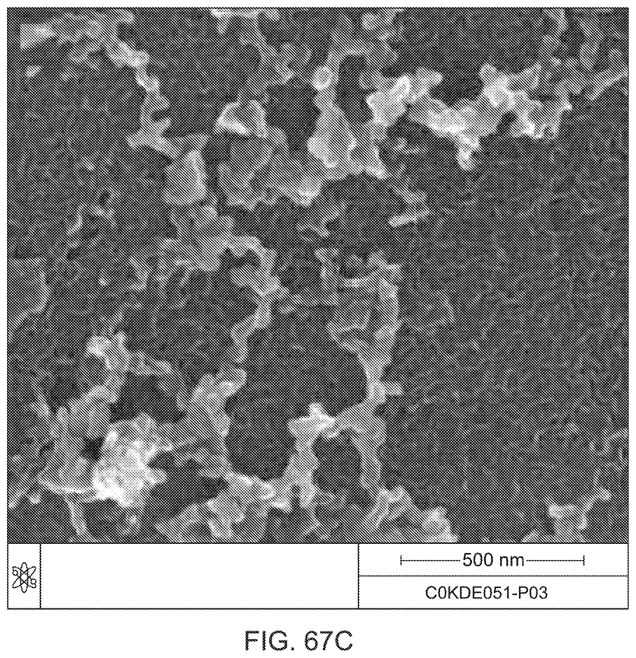

The type of porous MgO template material resulting from this process is identified herein as L₃T₂. A C@MgO PC material made by forming a thin carbon perimorph on the L₃T₂-type template material is shown in the SEM micrographs of FIG. 67A-67C. Provided the carbon perimorphic walls are sufficiently thin, imaging the PC material provides a good representation of the template morphology, since the PC material comprises the endomorphic template particles coated with a conformal, conductive layer. Based on this, it can be concluded that the L₃T₂-type template particles did not undergo sufficiently extensive recrystallization during the thermal treatment to degrade their superstructure.

Example A₁T₁: In another exemplary Template Stage procedure, a spray-dried MgCO₃·xH₂O template precursor material comprising hollow, spherical particles may be thermally treated to form a porous MgO template material.

To demonstrate this, A₁-type spray-dried MgCO₃·xH₂O particles may first be generated using the procedure described in Example A₁. This material represents the template precursor material that might be generated in the Precursor Stage of a full implementation of the General Method.

Next, the template precursor material may be thermally treated. This may be performed in a tube furnace according to Scheme A with a tube rotation speed of 1 RPM, as detailed in Section III. The sample may be placed in the tube furnace. While under an Ar flow of 1271 sccm, the furnace may be heated from room temperature to 100° C. at a heating rate of 20° C./min and maintained at 100° C. for 1 hour. The furnace may then be heated to 500° C. at a heating rate of 20° C./min and maintained at 500° C. for 1 hour. Finally, the furnace may be heated to 640° C. at a heating rate of 20° C./min and maintained at 640° C. for 3 hours. During this thermal treatment, CO₂ gas may be released. In a full implementation of the General Method, the CO₂ process gas released during the decomposition of the template precursor material may be conserved using conventional techniques. The furnace may then be allowed to cool to room temperature under sustained Ar flow.

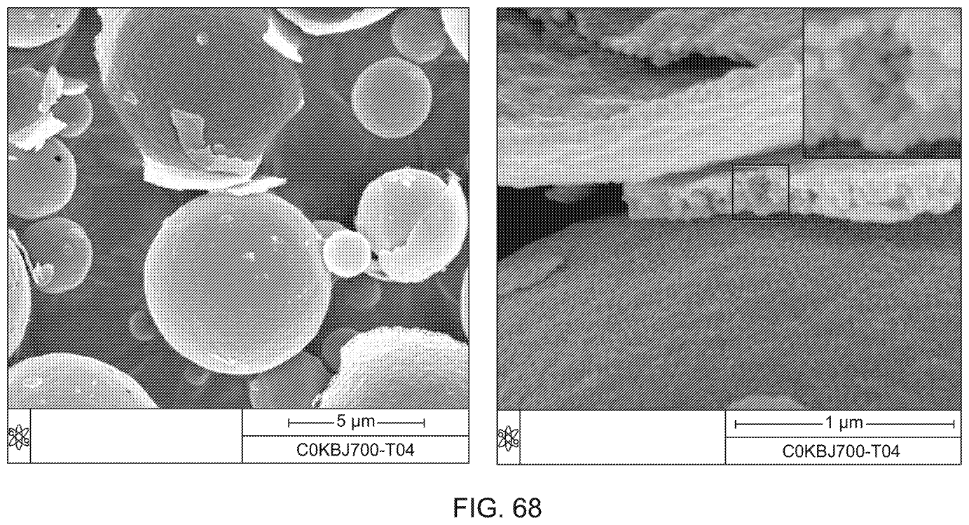

The type of porous MgO template material resulting from this process is identified herein as A₁T₁. The template particles retain the precursor particles' hollow, hierarchical-equiaxed superstructure, with some particles comprising fragments of the shells, as shown in the SEM micrographs of FIG. 68. At higher magnifications, the porous MgO substructure comprising conjoined subunits can be discerned. This porous substructure is clear in the magnified inset of FIG. 68.

Example A₃T₁: In another exemplary Template Stage procedure, a spray-dried MgCO₃·xH₂O template precursor material comprising hollow, spherical particles may be thermally treated to form a porous MgO template material.

To demonstrate this, A₃-type spray-dried MgCO₃xH₂O particles may first be generated using the procedure described in Example A₃. This material represents the template precursor material that might be generated in the Precursor Stage of a full implementation of the General Method.

Next, the template precursor material may be thermally treated. This may be performed in a tube furnace according to Scheme A, as detailed in Section III. The sample may be placed in a ceramic boat in the tube furnace. While under an N₂ flow of 2408 sccm, the furnace may be heated from room temperature to 200° C. at a heating rate of 20° C./min and maintained at 200° C. for 1 minute. The furnace may then be heated to 500° C. at a heating rate of 5° C./min and maintained at 500° C. for 1 minute. Finally, the furnace may be heated to 900° C. at a heating rate of 20° C./min and maintained at 900° C. for 15 minutes. During this thermal treatment, CO₂ gas may be released. In a full implementation of the General Method, the CO₂ process gas released during the decomposition of the template precursor material may be conserved using conventional techniques. The furnace may then be allowed to cool to room temperature under sustained N₂ flow.

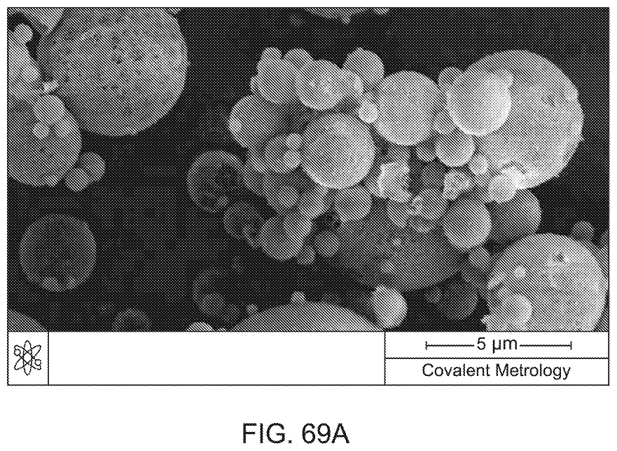

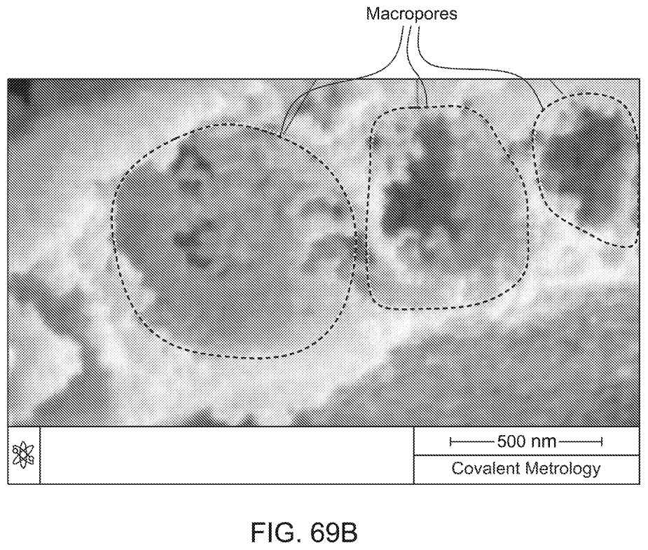

The type of porous MgO template material resulting from this process is identified herein as A₃T₁. The template particles retain the precursor particles' hollow, hierarchical-equiaxed superstructure, as shown in FIG. 69A, as well as their macroporous shell structure, as shown in FIG. 69B. At higher SEM magnifications, the porous MgO substructure comprising the conjoined subunits can be discerned.

Example C₁T₁: In another exemplary Template Stage procedure, a spray-dried template precursor material comprising hollow, hierarchical-equiaxed particles may be thermally treated to form a porous MgO template material.

To demonstrate this, Ct-type spray-dried particles may first be generated using the procedure described in Example A₁. This material represents the template precursor material that might be generated in the Precursor Stage of a full implementation of the General Method.

Next, the template precursor material may be thermally treated. This may be performed in a muffle furnace according to Scheme D, as detailed in Section III. The C₁-type template precursor material may be placed in a ceramic boat within the muffle furnace. The sample may then be heated from room temperature to 650° C. at a heating rate of 5° C./min. The sample may be maintained at 650° C. for 3 hours. During this thermal treatment, CO₂ gas may be released. In a full implementation of the General Method, the CO₂ process gas released during the decomposition of the template precursor material may be conserved using conventional techniques. Then, the furnace may then be allowed to cool to room temperature.

The type of porous MgO template material resulting from this process is identified herein as C₁T₁.

Example Ca₁T₁: In another exemplary Template Stage procedure, a precipitated CaCO₃ template precursor material (Albafil), herein described as Ca₁, may be thermally treated to form a porous MgO template material.

The precipitated Ca₁-type particles represent the template precursor material that might be generated in the Precursor Stage of a full implementation of the General Method.

Next, the template precursor material may be thermally treated. This may be performed in a tube furnace according to Scheme C, as detailed in Section III. The Ca₁-type sample may be placed in a ceramic boat within the tube furnace. The furnace may be heated to 1050° C. under flowing Ar at 1102 sccm. During this thermal treatment, CO₂ gas may be released. In a full implementation of the General Method, the CO₂ process gas released during the decomposition of the template precursor material may be conserved using conventional techniques. When the furnace reaches 1050° C., methane (CH₄) gas may be introduced into the system to begin forming a carbon perimorph on the templating surfaces. While this surface replication step may be thought of as part of the Replication Stage, the template material may continue coarsening concurrently until stabilized by the carbon perimorph. The system may be maintained at 1050° C. for 15 minutes under flowing CH₄ and Ar, then CH₄ flow may be discontinued and te furnace may be allowed to cool to room temperature under sustained Ar flow.

The type of calcium oxide (CaO) template material resulting from this process is identified herein as Ca₁T₁, and the PC material made using the Ca₁T₁ template material is identified herein as Ca₁T₁P₁₇. It is instructive to look at the P₁₇-type carbon perimorphic material after extraction of the endomorphic Ca₁T₁ template material, since the frameworks in their native morphology are replicas of the templating surfaces (and negative replicas of the templating bulk). Additionally, carbon frameworks are also partially electron-transparent, allowing visualization of the templates' internal substructure.

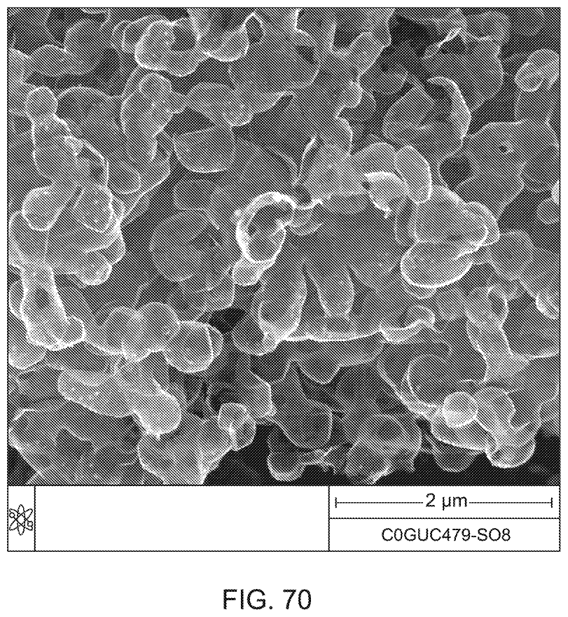

FIG. 70 is an SEM micrograph of the P₁₇-type carbon perimorphic material after extraction of the endomorphic Ca₁T₁ template material. The thermal decomposition at 1050° C. may have caused individual CaCO₃ or CaO particles to sinter together, resulting in the formation of a template with a cluster-like morphology. The P₁₇-type carbon perimorphic frameworks, which aside from some breakage appear to be substantially in their native morphology, retain this cluster-like geometry.

Example Li₁T₁: In another exemplary Template Stage procedure, spray dried lithium carbonate template precursor material comprising hollow, hierarchical-equiaxed particles may be thermally treated to form a porous Li₂CO₃ template material.

To demonstrate this, Lit-type spray-dried particles may first be generated using the procedure described in Example Li₁. This material represents the template precursor material that might be generated in the Precursor Stage of a full implementation of the General Method.

Next, the template precursor material may be thermally treated. This may be performed in a tube furnace according to Scheme C, as detailed in Section III. The Lit-type sample may be placed in a ceramic boat within the tube furnace. The furnace may be heated to 580° C. under flowing Ar at 1271 sccm. At this point, C₃H₆ gas may be introduced into the system to begin forming a carbon perimorph on the templating surfaces. While this surface replication step may be thought of as part of the Replication Stage, the template material may continue coarsening concurrently until stabilized by the carbon perimorph. The system may be maintained at 580° C. for 870 minutes under flowing C₃H₆ and Ar, then C₃H₆ flow may be discontinued and the furnace may be allowed to cool to room temperature under sustained Ar flow.

The type of Li₂CO₃ template material resulting from this process is identified herein as Li₁T₁, and the PC material made using the Li₁T₁ template material is identified herein as Li₁T₁P₁₈. It is instructive to look at the P₁₈-type carbon perimorphic material after extraction of the endomorphic Li₁T₁ template material, since the frameworks in their native morphology are replicas of the templating surfaces (and negative replicas of the templating bulk). Additionally, carbon frameworks are also partially electron-transparent, allowing visualization of the templates' internal substructure.

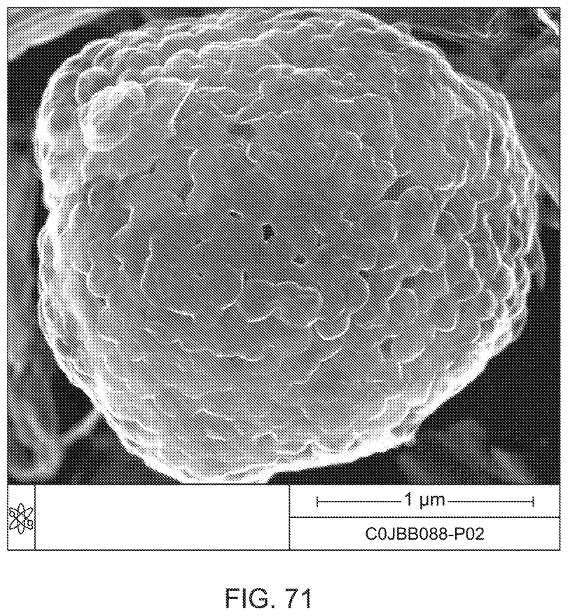

FIG. 71 is the SEM micrograph of a P₁₈-type carbon perimorphic framework generated on a Li₁T₁ template particle. The porous carbon framework has substantially retained its native morphology. In addition to the intact cellular subunits, exocellular pores can be discerned, indicating that the Li₁T₁ template particles, like the Li₁ precursor particles shown in FIG. 45A-45B, comprised porous shells. Typical liquid-phase precipitations of crystalline Li₂CO₃ may produce nonporous, anhydrous crystals. However, the spray-drying procedure facilitates the creation of a porous template precursor, and these pores can be retained by the template.

### VI*. Replication Stage—Examples

In order to demonstrate the general applicability of the Replication Stage to a variety of template materials, a number of exemplary Replication Stage procedures are presented below. For purposes of demonstration, each exemplary procedure comprises CVD growth of carbon perimorphs on selected template particles. However, it should be noted that other procedures, and perimorphs of alternative compositions, will be obvious to those knowledgeable in the art.

In some exemplary Replication Stage procedures, template materials may been formed from template precursor materials in a separate and distinct Template Stage that occurred in a different reactor. In other instances, the Template Stage procedure and the Replication Stage procedure may both be performed in the same reactor.

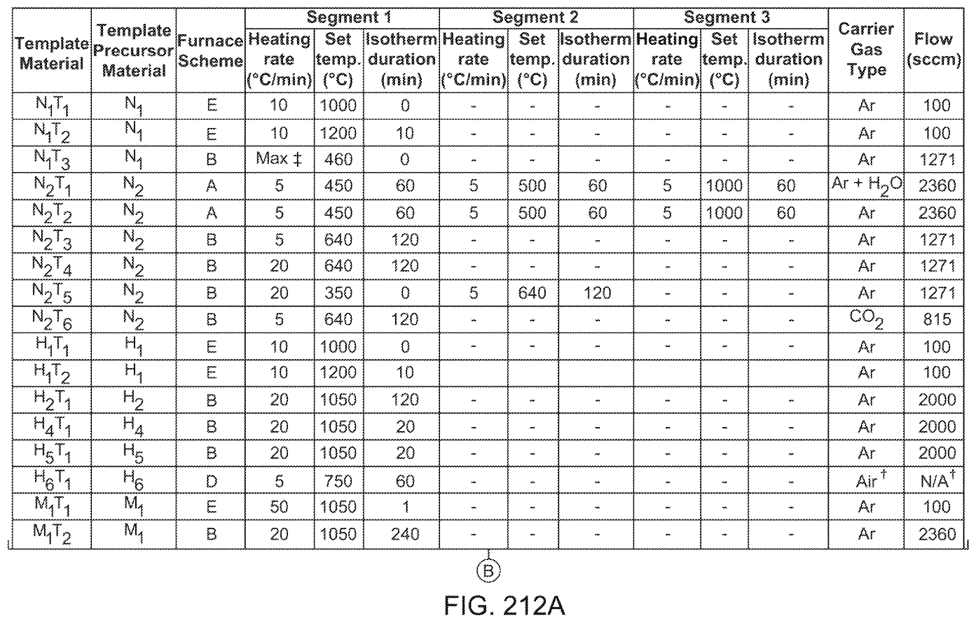

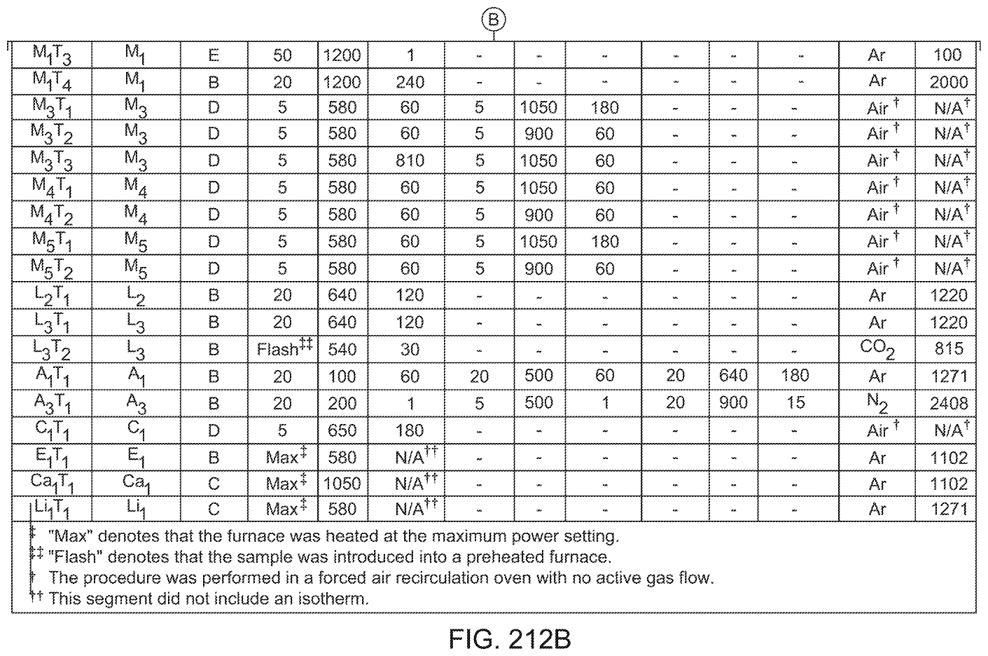

Some of the exemplary Replication Stage procedures presented in this section utilize previously named and described template materials. Additionally, new template materials are described in some of the exemplary Template Stage procedures, and for this reason, we describe the synthesis of these new templates in this section. FIG. 212 is a summary of all of the template materials utilized in the following exemplary Replication Stage procedures. FIG. 212 includes the basic parameters utilized to make the template materials, including the template precursor material, the furnace scheme utilized for the Template Stage treatment, and the temperatures, times, heating rates, carrier gases and gas flow rates pertaining to the Template Stage treatments. Some of the treatments comprised multiple segments, as shown in FIG. 212. There is a special scenario where the heating rate is described as “Max” in FIG. 212, indicating that the furnace did not heat at a fixed rate, but rather heated at the furnace's maximum power setting. Typically, the heating rate for such cases was around 40° C./min. There is another special scenario where the heating rate is described as “Flash” in FIG. 212, indicating that the template precursor material was introduced into the pre-heated furnace, such that it was heated extremely rapidly.

FIG. 213 is a summary of the CVD parameters used in the exemplary Replication Stage procedures. FIG. 213 lists the templates that may be used to demonstrate various Replication Stage procedures. FIG. 213 also lists the furnace schemes, as described previously in Section III, that may be used for each Replication Stage procedure. Each Replication Stage procedure summarized in FIG. 213 may consist of one or more segments. Each segment has a target temperature associated with that segment. The target temperature is denoted by Tₙ in FIG. 213, where ‘n’ represents the segment number. Each segment also has a target hold time at the target temperature Tₙ. The hold time is denoted by tₙ in FIG. 213, where ‘n’ again represents the segment number. Each segment also has a target heating time to reach Tₙ. The heating time is denoted by Rₙ in FIG. 213, where ‘n’ again represents the segment number. There is a special scenario where Rₙ is described as ‘max’ in FIG. 213. This indicates that the furnace did not ramp at a fixed rate, but rather heated at a fixed maximum power setting. Typically, the heating rate for such cases was around 40° C./min.

In some procedures, the Replication Stage immediately follows the Template Stage. In this scenario the Rₙ is described as ‘N/A’ in FIG. 213. This indicates that the heating rate is not applicable since the Replication Stage is initiated immediately after the Template Stage and continues from the same temperature used in the Template Stage procedure.

FIG. 213 lists the hydrocarbon gas (“HC Type”) and flow rate (“HC Flow”) used in the Replication Stage. FIG. 213 also lists the carrier gas type and flow rate used in the CVD Replication Stage which is denoted by ‘CR Type’ and ‘CR Flow’ respectively for each segment.

### VII*. Separation Stage—Examples

The Separation Stage comprises endomorphic extraction and perimorphic separation. In some variants, this may occur in an integrated, one-pot technique. In other variants, the Separation Stage may occur in two or more separate and distinct stages. For example, endomorphic extraction may involve mixtureing the PC material in the conserved process liquid and dissolving the endomorphic material inside the perimorphic material. Then, the perimorphic material may be separated from the stock solution. The stock solution may then be precipitated at atmospheric pressure. The precipitate may then be slurried into the process water at a higher solids concentration. By modulating temperature or pressure, the solids in this concentrated mixture may then be re-dissolved at higher concentrations to create a concentrated stock solution that may be utilized in Precursor Stage.

Example VIIa: In an exemplary endomorphic extraction procedure, MgO endomorphs may be extracted from carbon perimorphs may be obtained by dissolving the MgO in an extractant solution comprising aqueous H₂CO₃.

First, about 12.5 grams of a C@MgO PC powder comprising approximately 94.75% MgO endomorph and 5.25% carbon perimorph (grown via CVD) by weight may be slurried into 2.5 L of deionized water in a 3 L round-bottom flask. This water represents a conserved process water that would be derived from the Precursor Stage in a full implementation of the General Method. A gas line fitted with a 0.5 m diffusion stone (to decrease CO₂ bubble size and increase reaction efficiency) may be fed into the bottom of the flask, and the water may be stirred with a magnetic stir plate. CO₂ gas may be continuously bubbled into the tank over 141 minutes at a flow rate of 4 scfhₐᵢᵣ. This CO₂ represents a conserved process gas that would be derived from the Precursor Stage or Template Stage in a full implementation of the General Method. Dissolution of the CO₂ and reaction with the process water generates an aqueous H₂CO₃ extractant solution. The reaction of the aqueous H₂CO₃ extractant solution with the endomorphic MgO results in endomorphic extraction and the generation of a new aqueous Mg(HCO₃)₂ stock solution outside of the carbon perimorphic frameworks.

Perimorphic separation of the carbon perimorphic frameworks from the aqueous Mg(HCO₃)₂ stock solution may be obtained by filtering the mixture. The carbon perimorphic frameworks may be rinsed and dried, and an ash test may be performed. The carbon perimorphic frameworks may contain approximately 9.49% MgO, representing a 99.5% removal efficiency of the MgO template material. The remainder of unextracted MgO may be hermetically encapsulated within certain carbon frameworks. Higher extraction efficiencies may be gained with higher-energy agitation techniques, which may facilitate the breaching of sealed perimorphic walls.

In a full implementation of the General Method, the separated aqueous Mg(HCO₃)₂ stock solution may then be conserved to be utilized in the Precursor Stage.

Example VIIb: In another exemplary endomorphic extraction procedure, MgO endomorphs may be extracted from carbon perimorphs via a shuttling technique.

First, 500 mL of water may be magnetically stirred in a 1 L glass beaker at 700 RPM. This water represents a conserved process water that would be derived from the Precursor Stage in a full implementation of the General Method. Next, CO₂ process gas may be continuously bubbled at 3-5 scfhₐᵢᵣ through the process water from a dip tube, forming an aqueous H₂CO₃ extractant solution. This CO₂ represents a conserved process gas that would be derived from the Precursor Stage or Template Stage in a full implementation of the General Method. Approximately 10 g of a C@MgO PC material (yield 3.5%) comprising elongated particles may gradually be introduced into the extractant solution. Upon complete integration of the C@MgO PC material into the solution, the mixture may appear black and possess a pH of 9. The beaker may be covered to maintain a CO₂-rich atmosphere.

After 24 hours of reaction, the conductivity of the mixture may be 19.7 mS/cm measured at 19.6° C., have a pH of 8, and the mixture may appear gray. This mixture comprises the perimorphic product and a new aqueous Mg(HCO₃)₂ stock solution that might be used in the Precursor Stage in a full implementation of the General Method. The solids may then be separated from the stock solution using conventional techniques.

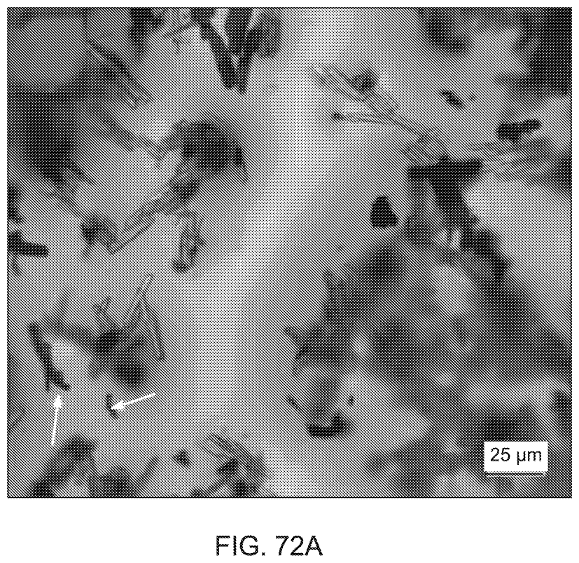

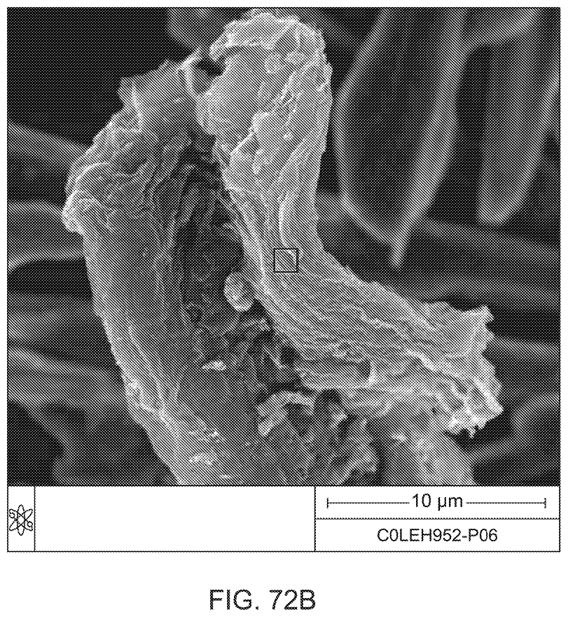

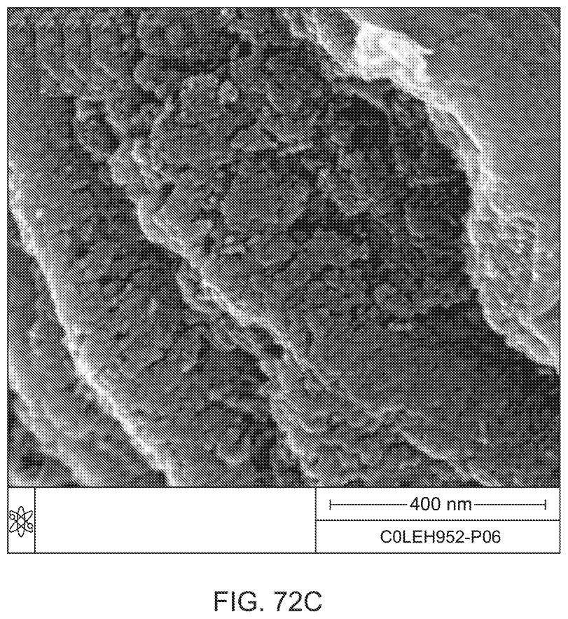

The solids from this mixture may be seen in the optical micrograph FIG. 72A and the SEM micrographs of FIG. 72B and FIG. 72C. Two distinct phases are present in the sample. The first phase comprises precipitated nesquehonite particles, which appear as transparent, elongated crystals in FIG. 72A. The second phase comprises the perimorphic product, comprising carbon perimorphic frameworks, which appear as black particles in FIG. 72A. Some of the frameworks appear curved, indicating their flexibility upon extraction of the rigid endomorph. The extractant solution of aqueous H₂CO₃ reacted with the endomorphic MgO, forming solvated Mg²⁺ and HCO₃⁻ ions, which were exfiltrated from the carbon perimorphs. Upon exfiltration from the carbon perimorphs, a portion of these ions precipitate as nesquehonite. The dissolution and precipitation mechanisms are concurrent.

In FIG. 72B, a carbonaceous perimorphic framework is shown. The framework has been deformed into a non-native morphology, showing both its flexibility and the extraction of the rigid, endomorphic MgO. FIG. 72C is a magnification of the boxed region of FIG. 72B and shows an endomorphic solid is clearly present, but it is not the original MgO endomorph. Instead, it is endomorphic MgCO₃·xH₂O that has precipitated from the residual aqueous Mg(HCO₃)₂ stock solution inside the un-rinsed framework during drying of the high-porosity perimorphic framework. In other words, prior to drying, the framework was substantially devoid of endomorphic solids. The residual stock solution could be displaced using liquid-liquid separation techniques, in which case this shuttling technique would result in displacing 10 g of MgO from the frameworks using only 500 mL of water. This is approximately double the maximum concentration of MgO that can be dissolved into an aqueous H₂CO₃ extractant solution at atmospheric pressure.

The mechanism for this may be the preferential adsorption and nucleation of CO₂ nanobubbles in the hydrophobic carbon framework, increasing the internal CO₂ pressure within the framework and therefore the solubility of Mg(HCO₃)₂ within the framework. This creates a concentration gradient that drives the solvated ions into the surrounding process water, where they precipitate due to the lower external CO₂ pressure. Hence, shuttling reduces the volume of process water needed for endomorphic extraction, as well as the required vessel size.

Example VIIc: Endomorphic extraction of certain metal oxide or metal carbonate compounds may be facilitated by rendering the CO₂ supercritical. In an exemplary procedure, 3.007 g of MgO (Elastomag 170 calcined at 1050° C. for 1 hour) may be slurried with 100.00 g DI water, resulting in a solution conductivity of 340 S/cm at 12.4° C. This translates to a mixture concentration of 30 g/L MgO. The mixture may be poured into a 1 L pressure vessel with magnetic stirring and a heating mantle. Approximately 600 g of dry ice (solid CO₂) may be added to the reactor, and the reactor then sealed. After 101 minutes of heating, the minimum conditions for supercritical CO₂ conditions may be surpassed at 31.4° C. and 1,125 psi. After a total 144 minutes, the reactor conditions may reach 36.2° C. and 1200 psi. The reactor may then be actively chilled with a cooling coil for 74 minutes, after which its conditions may reach 18.3° C. and 675 psi. The pressure in the reactor may then be slowly released, and after 6 minutes the reactor may have equilibrated to atmospheric pressure with a temperature probe reading of −5.0° C., due to the pressure release. Approximately 23 minutes after the pressure release, a sample may be taken from the solution, which may have a conductivity of 30.2 mS/cm at 4.5° C. The solution may be clear, with no signs of particles or precipitation. This higher concentration solution may then be utilized for crystallization of the template precursor material.

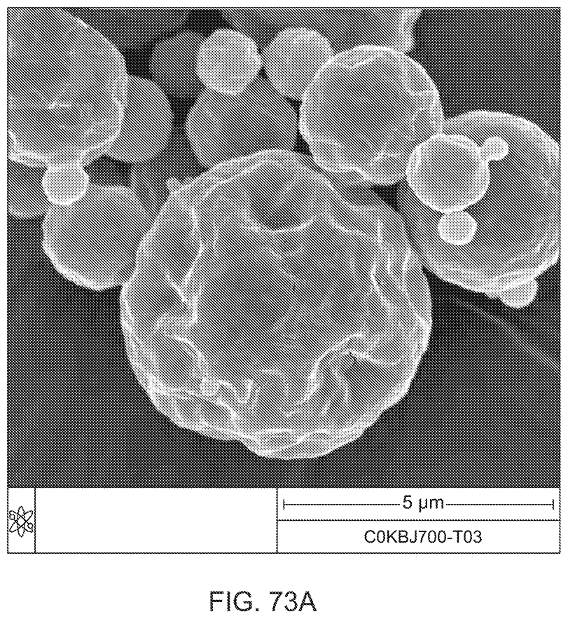

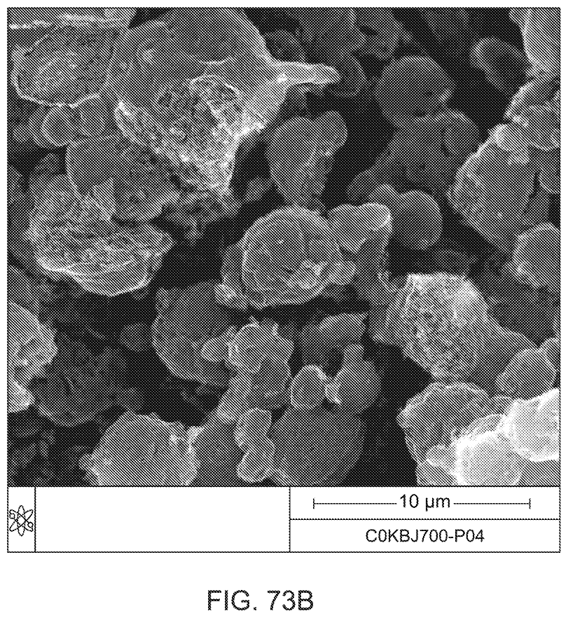

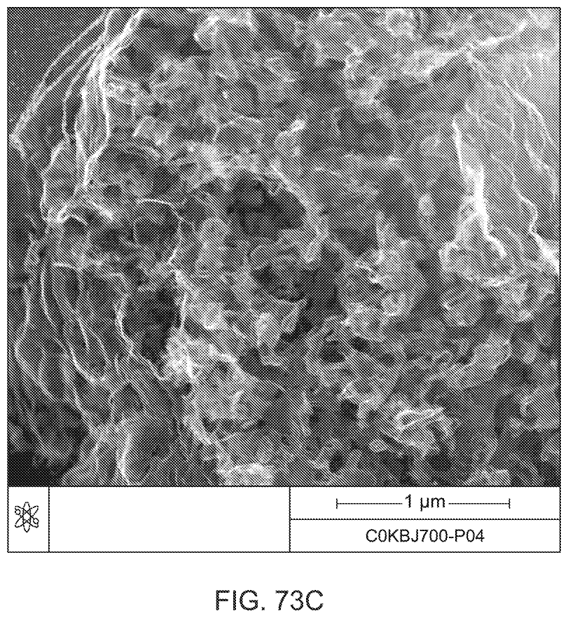

Example VIId: In another exemplary Separation Stage procedure, endomorphic extraction of a water-soluble endomorphic template material may be obtained via simple dissolution in water. This may be demonstrated by mixtureing a C@MgSO₄ PC material, as shown in the SEM micrograph of FIG. 73A, in process water. In a full implementation of the General Method, this process water may comprise the conserved process water from the Precursor Stage. The MgSO₄ endomorphic mass may be dissolved in the process water at room temperature. Endomorphic extraction may be confirmed via SEM image analysis, as shown in FIG. 73B-73C. The new aqueous stock solution of solvated Mg²⁺ and SO₄²⁻ ions may then be utilized for crystallization of hydrous MgSO₄ template precursor material in a full implementation of the General Method. The resulting solution may be basic, indicating a minor level of decomposition of the MgSO₄ to MgO during the Template Stage or Replication Stage. The basic stock solution may be neutralized with a small amount of sulfuric acid (H₂SO₄). The perimorphic product may then be separated via filtration or some other separation technique. In a full implementation of the General Method, the stock solution may be conserved for reuse in the Precursor Stage.

### Perimorphic Separations

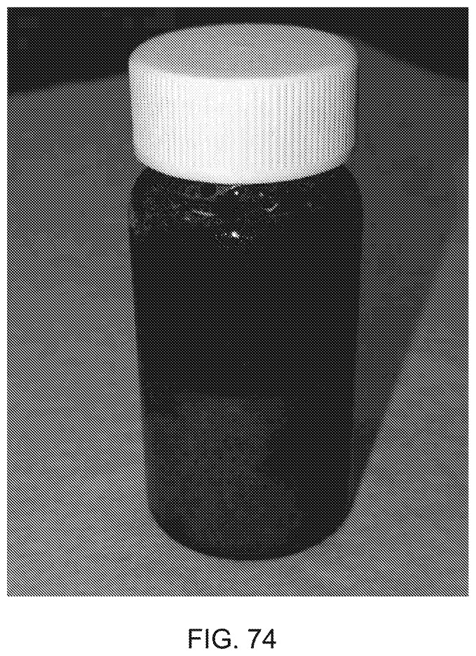

Perimorphic products may be separated using a number of conventional techniques. In one technique, a liquid-liquid separation may be utilized. This may be demonstrated by taking the mixture produced by the shuttling process described above and blending it with an immiscible solvent, like hexane. The carbon perimorphic frameworks migrate into the solvent phase, while the nesquehonite remains in the aqueous phase. This results in phase separation and two distinct slurries, as shown in FIG. 74, which is a photograph taken after blending hexane into the mixture produced by the shuttling process described above. The black mixture comprises solvent and carbon perimorphic frameworks. The mixture below comprises water and nesquehonite, and appears to comprise mostly white nesquehonite particles (albeit with some carbon particles mixed in and adhered to the sides of the scintillation vial).

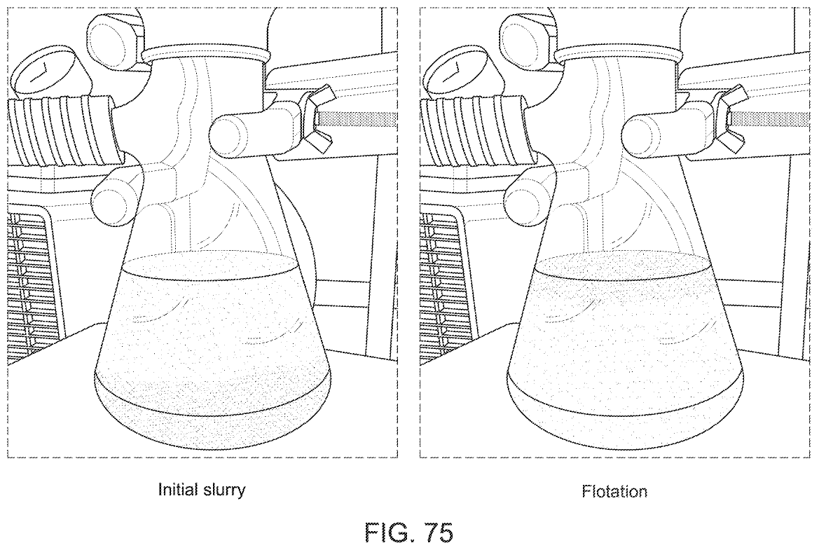

Separation of the carbon perimorphic frameworks may also be obtained simply using flotation. In some carbon perimorphic frameworks, air bubbles may remain trapped in the exocellular pores during the liquid-phase endomorphic extraction. This may render the frameworks buoyant or quasi-buoyant upon endomorphic extraction. Furthermore, subjecting a mixture of these bubble-infused frameworks to a partial vacuum increases their buoyancy, as internal bubbles expand and extrude water from the porous framework. The progressive flotation and separation of carbon perimorphic frameworks under partial vacuum is shown in FIG. 75. This flotation under partial vacuum was obtained without the use of bubbling or solvents utilized in typical froth flotation procedures.

A number of variants and improvements of these separation techniques may be readily envisioned. Flotation may be improved with the use of a solvent, as would be typical in a conventional froth flotation process. Frameworks made on template materials with greater particle porosity may retain more air and be more buoyant. Hollow spheres, in particular, may contain more trapped air and be more buoyant.

### Concentrating Stock Solutions

In some cases, it may be desirable to create a concentrated stock solution after separating the perimorphic product. A mixture of precipitated particles, such as the nesquehonite precipitated in the shuttling procedure described above, may be re-dissolved under conditions that allow higher solution concentrations. For example, an aqueous mixture of precipitated MgCO₃·xH₂O particles may be subjected to higher CO₂ pressure in order to make a concentrated stock solution, as illustrated in FIG. 27A. This concentrated stock solution may be utilized in the Precursor Stage.

Example VIIe: In one exemplary procedure, endomorphic MgO may be dissolved at higher concentrations under pressure. To demonstrate this, 15 g of MgO (Elastomag 170) template may be slurried with 750 g of deionized water, which may represent a conserved process water retained from the Precursor Stage. The water may be chilled to 5° C. The solids concentration of the mixture may be 20 g/L MgO, or approximately double the maximum concentration of MgO that can be dissolved into an aqueous H₂CO₃ extractant solution at atmospheric pressure. The mixture may have a solution pH of approximately 10.5 and a resulting solution conductivity of 146 S/cm. The mixture may be poured into a 1 L pressure vessel with magnetic stirring, a high-pressure gas inlet, and a purging needle valve. The reactor may be sealed and purged through a purging needle valve by opening the high-pressure gas inlet, allowing pressurized CO₂ gas, representing conserved CO₂ process gas recaptured in the Precursor Stage and Template Stage, to flow into the vessel for 2 minutes to displace any air. The purge valve may then be closed, and the reactor pressurized with CO₂ to 125 psi. After 65 minutes, the conductivity may be approximately 15.6 mS/cm measured at 16.3° C. and a pH of 8.5. This conductivity represents an Mg(HCO₃)₂ solution concentration equivalent to 10 g/L of dissolved MgO, which at atmospheric pressure may require an order of magnitude longer reaction time to achieve. At the 290 minute mark, the conductivity may be approximately 27.8 mS/cm measured at 19.5° C. and a pH of 7.5. The conductivity value and pH measurements at 290 minutes may signify Mg(HCO₃)₂ solubilities greater than the approximately 10 g/L MgO possible at atmospheric pressure.

Increased CO₂ pressure may likewise be used to create concentrated stock solutions from MgCO₃·xH₂O solutes, such as those produced via shuttling procedures. These concentrated stock solutions may be produced via multistep Separation Stage procedures, in which stock solutions are used to precipitate solids that are re-dissolved under conditions allowing higher solubility. Alternatively, endomorphic extractions utilizing aqueous H₂CO₃ extractant solutions might be performed under increased CO₂ pressure, such that higher concentrations are obtained without precipitation and re-dissolution under increased CO₂ pressure.

### VIII*. Perimorphic Framework Examples

In the Preferred Method, carbon perimorphic frameworks are synthesized using MgO templates derived from MgCO₃·xH₂O precursors. While coarsening may reduce the fine structuring of these MgO templates, a typical MgO template comprises a porous substructure of conjoined nanocrystals. This creates a labyrinthine framework with endocellular and exocellular labyrinths. This labyrinthine structure is not specific to carbon frameworks formed on these templates-any framework will have the same native morphology. However, carbon frameworks with thin, conformal perimorphic walls can be utilized to study these architectures due to their ability to create fine, electron-translucent replicas of the template.

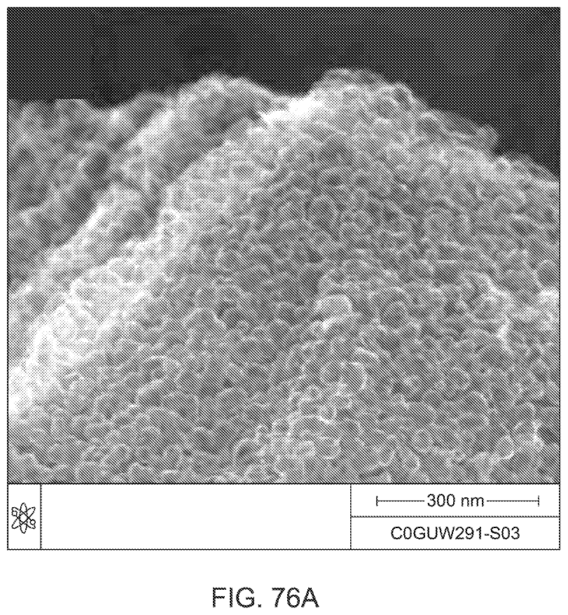

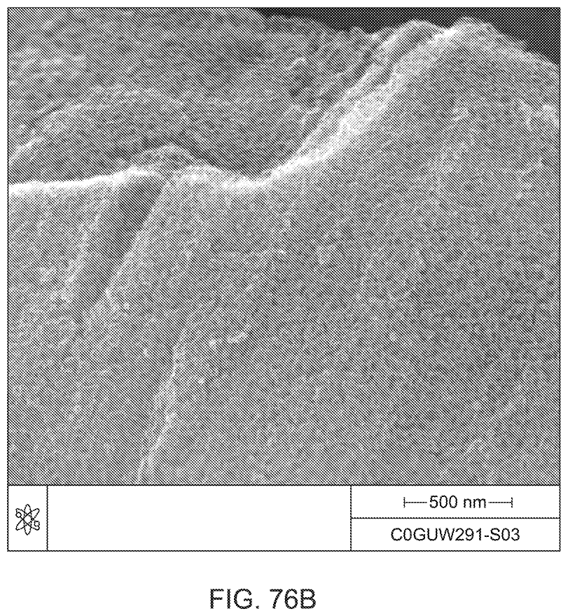

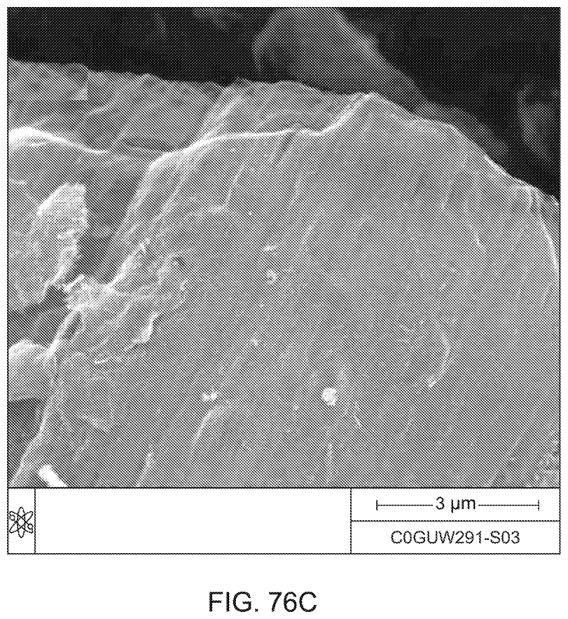

As an example, FIG. 76A is an SEM micrograph taken at high magnification showing a labyrinthine carbon framework that has retained its native morphology. The nanocellular subunits are quasi-discretized, but conjoined to one another. The cells, like the discretized MgO subunits upon which they were synthesized, are monodisperse, possessing a consistent, equiaxed morphology and size throughout the superstructure. This consistency, as well as the regularity of their packing, can be best observed at different scales of magnification. FIG. 76A-76C includes SEM micrographs of the same carbon framework imaged at 25,000× (FIG. 76A), 100,000× (FIG. 76B) and 250,000× (FIG. 76C) magnifications. The highly regular cell morphology and compactness is observable throughout the framework. The labyrinthine framework in FIG. 76A-76C was constructed on an ex-nesquehonite MgO template.

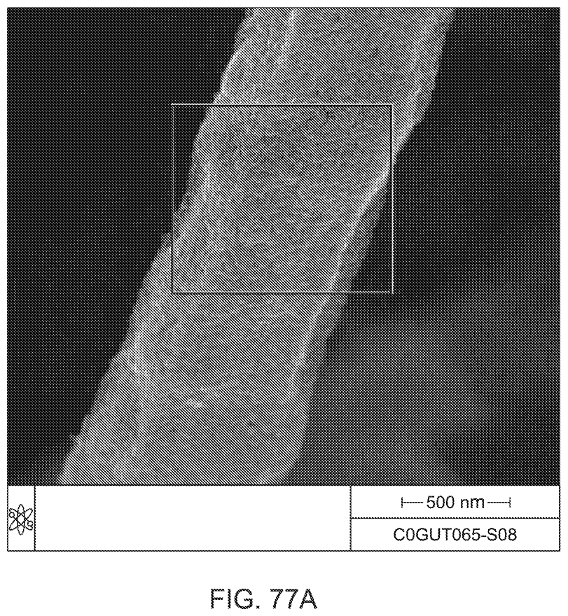

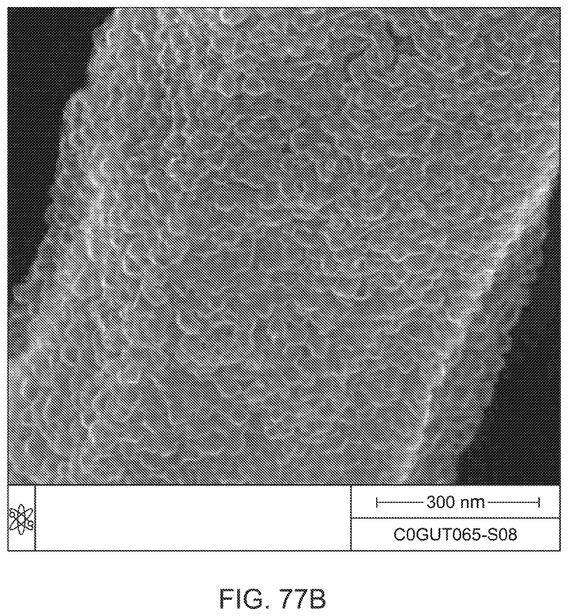

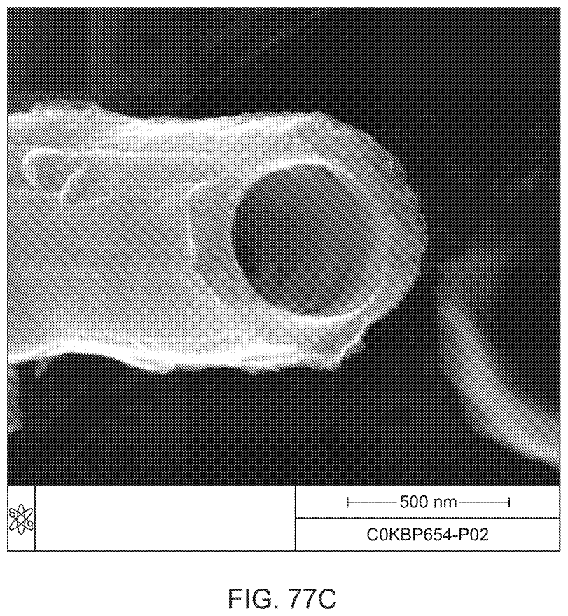

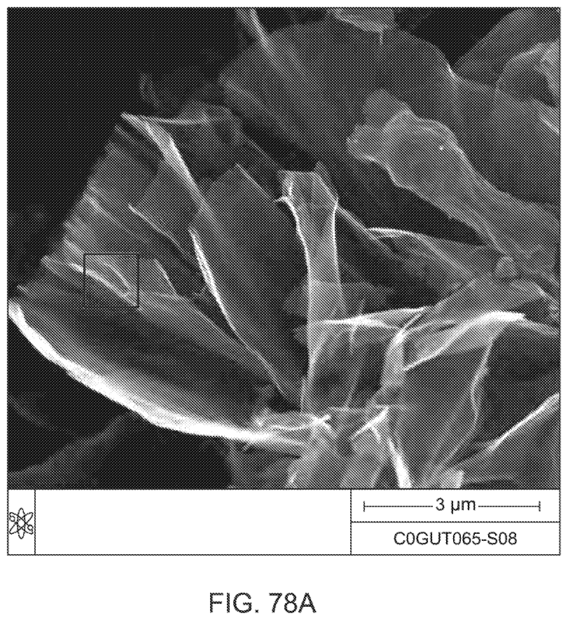

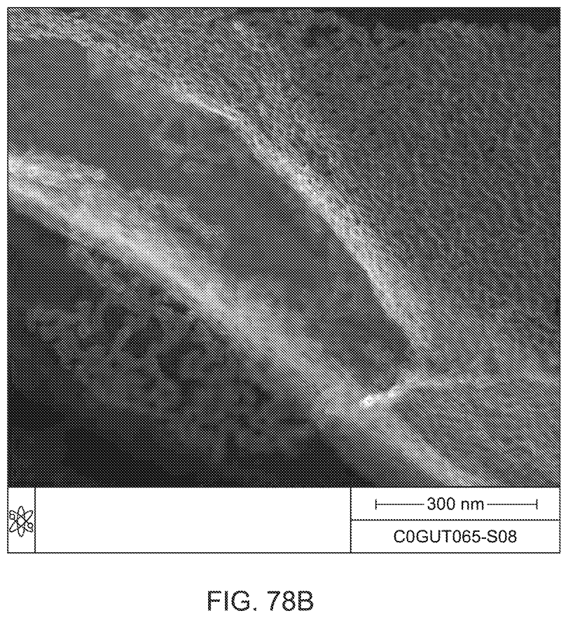

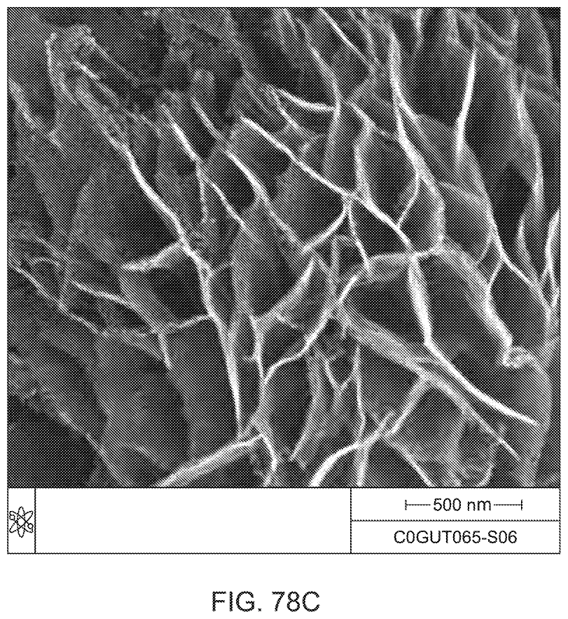

While the subunits are uniformly equiaxed, the superstructures of frameworks derived from porous MgO templates have diverse geometries to the variety of precursors from which MgO templates can be derived. For example, frameworks generated on MgO templates made from nesquehonite template precursor impart elongated, fibroidal superstructures, as shown by the labyrinthine framework in FIG. 77A-77C. Frameworks generated on templates made from hydromagnesite or dypingite template precursors impart thin (FIG. 78A-78B, where FIG. 78B represents a magnification of the region indicated by the boxed region in FIG. 78A) or hierarchical (FIG. 78C) superstructures. The labyrinthine framework shown in FIG. 78C was generated on a hierarchical-equiaxed hydromagnesite template.

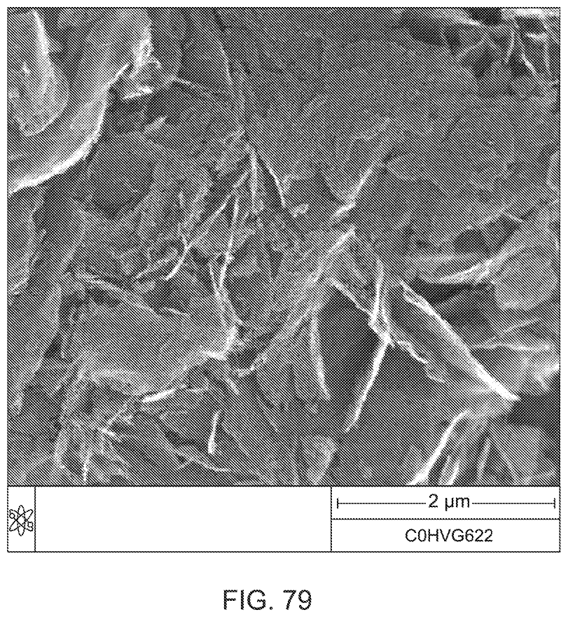

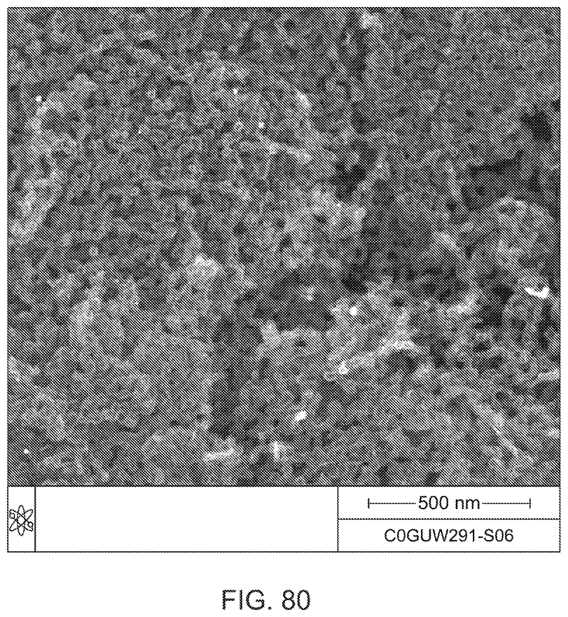

In addition to these diverse architectures, fragmentation and deformation of the frameworks may result from mechanical agitation, such as the multilayer stack of thin pseudomorphs shown in FIG. 79. Stacks of these thin, mesoporous porous, unlike stacks of monolayers materials (e.g. graphene), should possess high specific porosity, retain much of their surface area, and be comparatively easier to exfoliate due to the limited contact area between their surfaces. Agitation may also be used to create small clusters of subunits. FIG. 80 is an SEM image showing a carbon framework that has been broken up via agitation, forming smaller multicellular clusters.

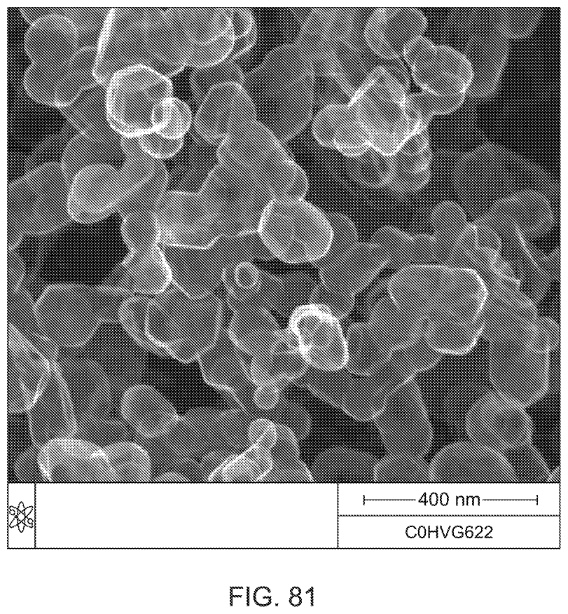

If the template precursor, or some decomposition product of a template precursor, is coarsened during the Template Stage, the resulting perimorphic frameworks become less compact. In one experiment, MgO templates were sintered for 2 hours at 1,000° C. prior to a Replication Stage. The resulting MgO templates were quasi-polyhedral and generally larger than 100 nm in diameter. FIG. 81 is an SEM image of the less compact frameworks formed on these coarsened templates. Coarsening via sintering and coalescence of particles may degrade the inherited superstructures, creating particles of irregular geometry in place of particles with regular, pseudomorphic geometries.

While these less compact, less regular frameworks are not as ordered as more compact frameworks with more regular geometries, they may still be assembled into multicellular clusters with attractive functional properties like those described in U.S. Patent Application 62/448,129. One benefit of less compact frameworks with flexible perimorphic walls is their increased pseudoelasticity—i.e. a collapsed framework that is natively coarse, despite being densified by its collapse, may retain the ability to expand back to its native dimensions without covalent failure.

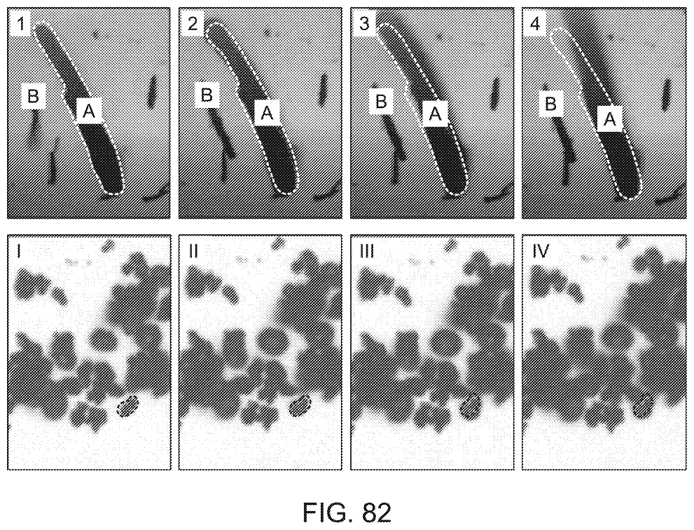

Elasticity is shown in the sequences of optical images in FIG. 82. In the first sequence (1-4), elongated carbon perimorphic frameworks are shown drying on a glass slide. These frameworks first shrink and deform, as the surface tension of the receding residual water inside them deforms the flexible perimorphic walls, then re-expand to their native geometry as the deformed walls locally spring back to their native morphology. This elastic response ultimately restores the native superstructural geometry. In the first sequence, two frameworks (labeled A and B) progress from their most shrunken, non-native state back to their native, expanded state. The outline of framework A is traced in Frame 1, and this outline is applied to Frames 2-4 for comparison. Ultimately, both Framework A and Framework B are restored to their straight, native superstructure. In the second sequence (I-IV), hollow-spherical carbon perimorphic frameworks are shown drying on a glass slide. These frameworks progress from their most shrunken, non-native state back to their native, expanded state. The outline of a representative framework is traced in Frame I, and this outline is applied to Frames II-IV for comparison.

FIG. 83A-83B includes SEM micrograph micrographs of carbon perimorphic frameworks grown on elongated templates (N₂T₄) described in Section V. The frameworks are flexible (FIG. 83A) but survive high-shear agitation relatively undamaged. The surfaces of the porous carbon particles look uniform and indistinct due to the fine, collapsed cellular substructure (FIG. 83B).

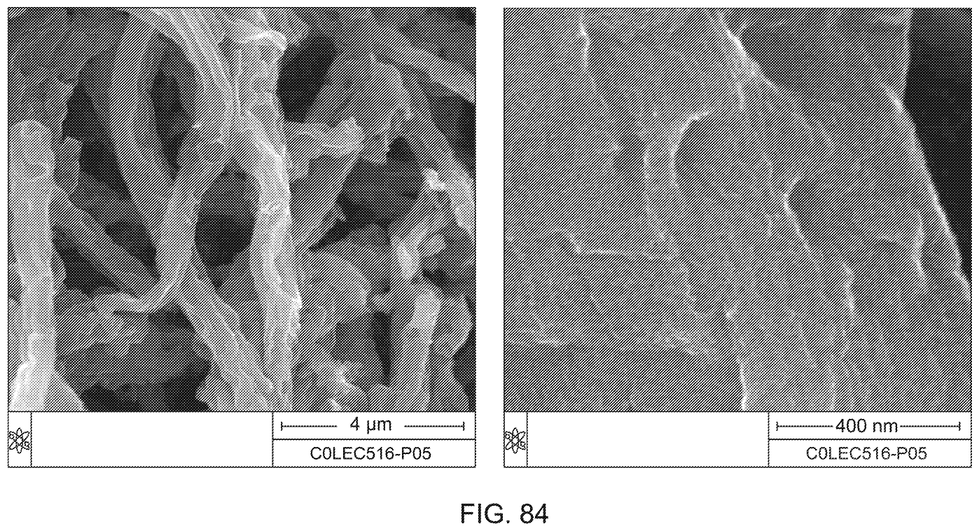

FIG. 84 includes SEM micrographs of carbon perimorphic frameworks grown on elongated templates (N₂T₈) described in Section V. Templates N₂T₄ and N₂T₈ were generated from the same sample template precursor material (N₂) but via different treatments during the Template Stage. The carbon frameworks in FIG. 84 are still flexible, but after high-shear agitation they appear damaged and gouged compared to the frameworks shown in FIG. 83A-83B.

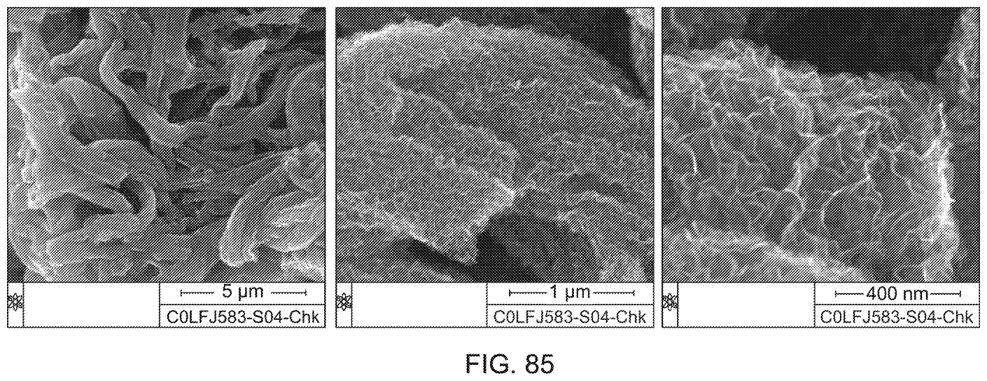

FIG. 85 includes SEM micrograph of carbon perimorphic frameworks grown on elongated templates (N₂T₁) described in Section V. These frameworks represent the perimorphic product generated from endomorphic extraction and perimorphic separation of the N₂T₁P₂₁ PC material.

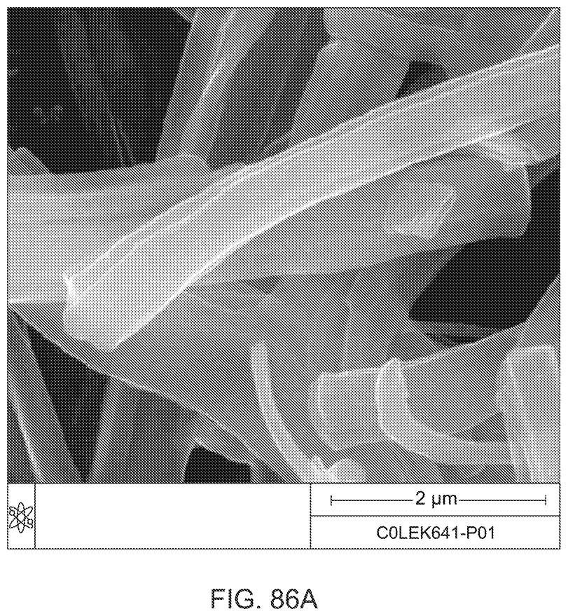

FIG. 86A is an SEM micrograph showing the more compact carbon perimorphic frameworks synthesized on N₂T₄-type templates (vs. the less compact cellular substructure of frameworks synthesized on N₂T₁-type templates). By changing the treatment procedure in the Template Stage, frameworks of different compactness can be derived from a common template precursor material.

FIG. 86B is an SEM micrograph showing the less compact carbon perimorphic frameworks synthesized on N₂T₁-type templates (vs. the more compact cellular substructure of frameworks synthesized on N₂T₄-type templates). By changing the treatment procedure in the Template Stage, frameworks of different compactness can be derived from a common template precursor material.

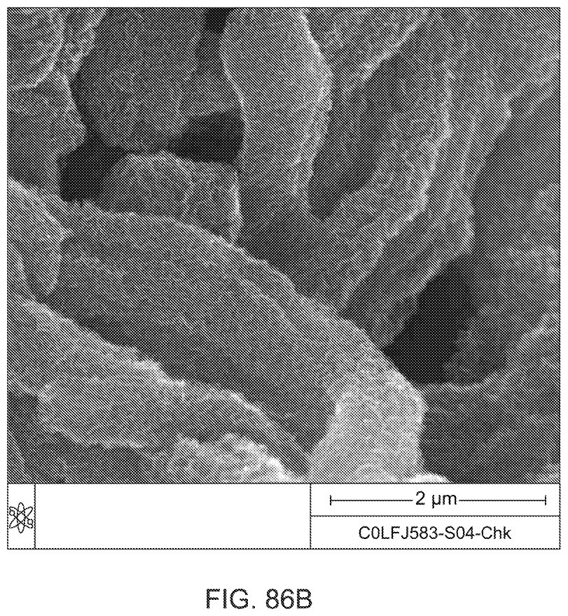

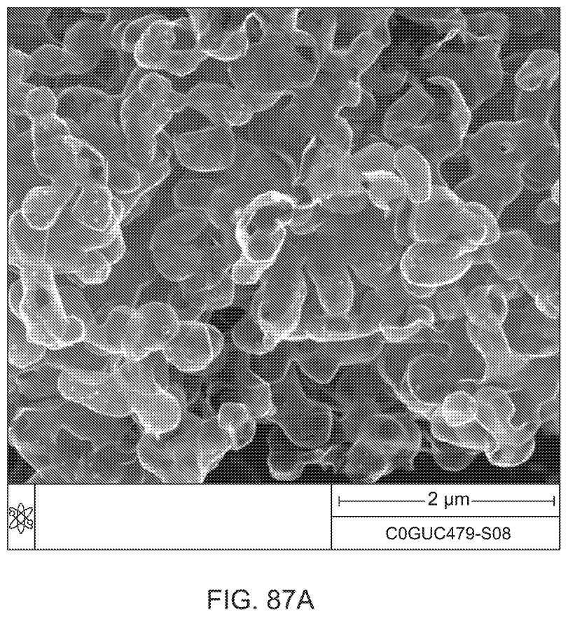

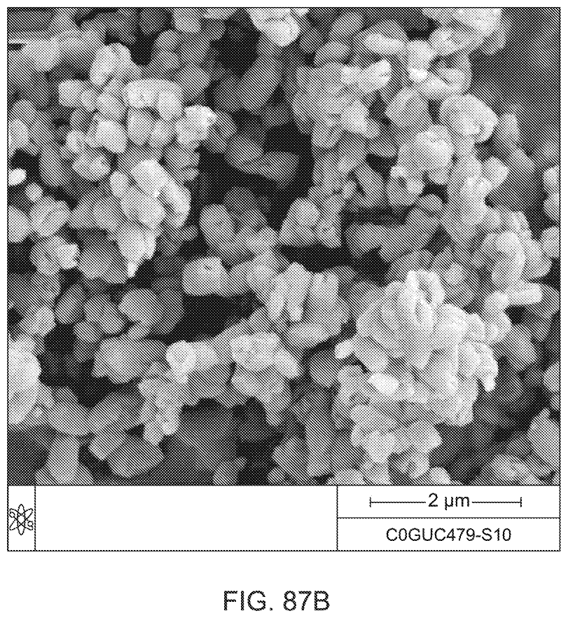

FIG. 87A is an SEM micrograph of carbon perimorphic frameworks (P₁₇) derived from a PC material (Ca₁T₁P₁₇) made on calcium oxide (CaO) template material (Ca₁T₁). The Replication Stage is discussed in Section V. While some breakage could be observed, the frameworks have largely retained their native morphology after endomorphic extraction and separation. FIG. 87B is an SEM micrograph of the template precursor material (Ca₁), a precipitated calcium carbonate (CaCO₃) commercial product (Albafil), that was used to make the CaT₁ template material. The average size of the precursor particles is 0.7 microns. These precursor particles were heated to 1050° C., decomposing them to CaO and sintering the individual particles.

Raman spectroscopy is commonly used to characterize carbons and is a critical tool used to characterize the lattice structure of the exemplary carbon perimorphic materials in this disclosure. The details regarding the equipment and techniques used for Raman analysis are detailed in Section III.

Three main spectral features are typically associated with sp²-bonded carbon: the “G band” (typically at or around 1585 cm⁻¹), the “2D band” (typically between 2500 and 2800 cm⁻¹), and the “D band” (typically between 1200 and 1400 cm⁻¹). The G band is associated with sp²-hybridized carbon. The D band is associated with radial breathing mode phonons in polycyclic sp²-hybridized carbon and is activated by defects. Therefore, the D band is associated with disorder and the peak intensity ratio of the D and G bands provides a measure of disorder. Another feature associated with disorder is an interband region located between the D and G bands. The presence of broad peaks within this interband range increases the height of the trough between the D and G bands, and this height may therefore be used as a measure of disorder, where higher troughs are associated with greater disorder. For this reason, the present disclosure utilizes the height of this trough to characterize disorder. The trough height is defined herein as the local minimum intensity value occurring between the wavenumber associated with the D peak and the wavenumber associated with the G peak. The intensity value at this wavenumber is then compared to the G peak intensity to characterize disorder.

In order to avoid resorting to subjective profile-fitting judgments, the present disclosure analyzes the unfitted Raman spectra of the carbon perimorphic materials presented herein. All references to peak positions and peak intensities therefore relate to unfitted peak positions and are derived without profile fitting. Additionally, all peak positions and peak intensities reported are measured under 532 nm excitation. The intensities of the G, 2D, D, and trough are designated herein as I_{G}, I_{2D}, I_{D}, and I_{Tr}, respectively.

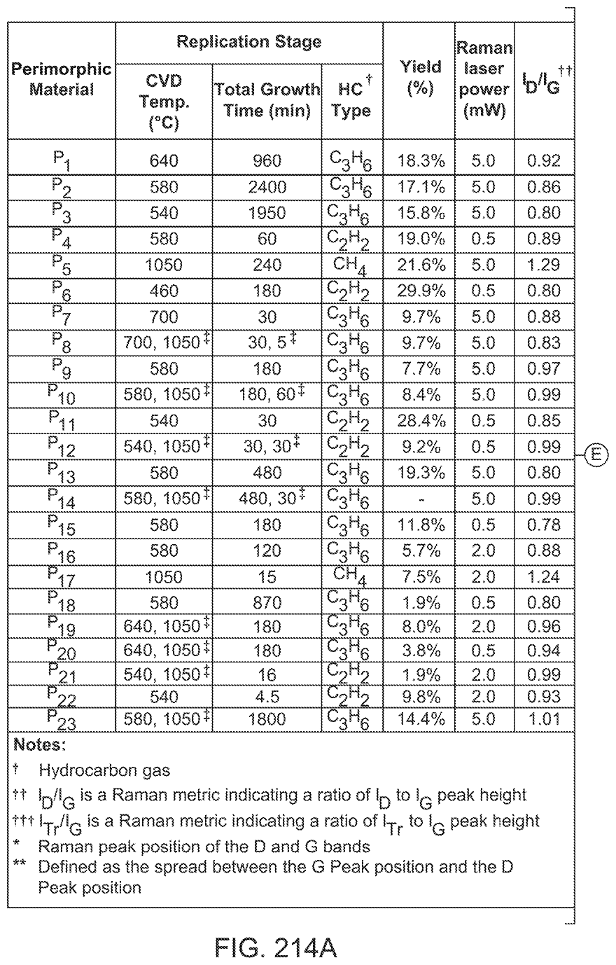

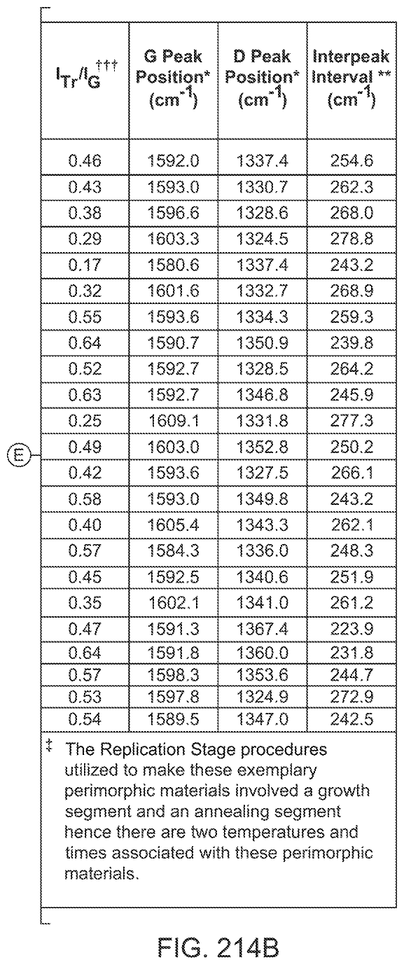

FIG. 214 summarizes the Raman metrics of the carbon frameworks generated in this disclosure. FIG. 214 details the sample names of the template precursor, template and PC materials from which the frameworks are generated. The CVD growth temperatures, hydrocarbons used, and procedure times during the Replication Stage are detailed. The yield obtained from TGA analysis of the PC is also detailed in FIG. 214. The Raman laser power used to take spectral measurements is also listed in FIG. 214. The Raman metrics presented in FIG. 214 include the I_{D}/I_{G} and I_{Tr}/I_{G} peak ratios along with the G peak position, D peak position and spread between the G and D peak positions. These Raman metrics, taken together, convey information about the level of order and disorder in the samples.

The I_{D}/I_{G} peak intensity ratios for the carbon perimorphs in the PC materials range between 0.78-1.27, indicating that these samples comprise disordered carbons. This disorder is corroborated by the generally high I_{Tr}/I_{G} peak intensity ratios, which range between 0.17-0.64 as shown in FIG. 214. It is also confirmed by the non-planarity of the graphenic lattices, which can be discerned in high-resolution TEM micrographs, such as the magnified inset of FIG. 22B.

For crystalline sp²-hybridized carbons like graphite, the G band is expected to be centered around ˜1580 cm⁻¹. It has also been shown that the G band can be red-shifted for carbons under compressive strain and blue-shifted under tensile strain. For sp² carbons, the D band, if present, should be centered around ˜1350 cm⁻¹(for 532 nm laser). Red-shifting of the D band position, as seen in some of the samples, is indicative of sp³ defect states present within the disordered sp² carbons.

For the samples described herein, the G band peak positions range between 1581-1609 cm⁻¹, and the D band peak positions range between 1324-1358 cm⁻¹, as shown in FIG. 214. The spread of the G band peak position and D band peak position may lie between 239-279 cm⁻¹, with bigger spreads indicating more strain and disorder. Some of the samples have been annealed, and annealing may be desired to reduce this disorder.

VI. Reference B: Detailed Description from the '37435 Application

This section is organized according to the following outline:

### I** Basic Terms & Concepts

We provide basic definitions and establish foundational concepts for describing structures.

### II** Surface Replication

We introduce basic concepts related to templating, and in particular, related to surface replication. These concepts are handled more comprehensively in the '918 and '760 Applications.

### III** Free Radical Condensate Growth & Tectonics

We discuss how graphenic networks are nucleated and grown as free radical condensates. We discuss the tectonic interactions between graphenic domains during growth.

### IV** Surfaces in Three Dimensions

We discuss curved surfaces and establish certain conventions to orient ourselves when discussing complex structures in three-dimensional space.

### V** Clarifying Examples

We analyze and discuss exemplary structures in order to clarify definitions and foundational concepts.

### VI** Notes on Metrology and Characterization

We provide details on metrology employed in the present disclosure and discuss Raman spectral features of disordered carbons.

### VII** Procedures

We explain the detailed procedures used to synthesize carbon samples for Experiments A through G.

VIII** Study A—Analysis Study A includes: (i) synthesis of synthetic anthracitic networks; (ii) synthesis of sp^{x} networks; (ii) modeling of sp² and sp³ grafting; (iii) modeling of formation of diamondlike seams and chiral columns; (iv) modeling of multilayer growth; and (v) discussion of free radical condensates.

### IX** Study B—Analysis

Study B includes: (i) synthesis of sp^{x} and x-sp^{x} networks; (ii) modeling of various tectonic interfaces; (iii) ex post facto analysis of prior art and discussion of limitations.

### X** Study C—Analysis

Study C includes: (i) demonstration of incomplete dehydrogenation during free radical condensate growth; and (ii) spectral analysis of hydrogenated and dehydrogenated carbon phases.

### XI** Study D—Analysis

Study D includes a demonstration of improved grafting via increased hydrogen during free radical condensate growth.

### XII** Study E—Analysis

Study E includes: (i) maturation of x-sp^{x} networks and z-sp^{x} networks to form mature x-networks and mature z-networks; (ii) modeling of structural changes during maturation; and (iii) analysis of mature networks

### XIII** Study F—Analysis and Discussion

Study F includes: (i) demonstration of particle-to-particle crosslinking by maturation; (ii) demonstration of macroscopic sheet-like and block-like forms comprising mature x-networks and z-networks; and (iii) discussion of crosslinking by maturation

### XIV** Study G—Analysis and Discussion

Study G includes: (i) demonstration of microwave-induced resistive heating; (ii) demonstration of diamagnetism and room-temperature superconductivity in synthetic, anthracitic networks under reduced pressure; and (iii) demonstration of diamagnetism and room-temperature superconductivity in other disordered pyrolytic carbons under reduced pressure; and (iv) discussion of theoretical basis for observations.

### XV** Study H—Analysis and Discussion

Study H includes: (i) demonstration of ambient superconductivity in an evacuated anthracitic macroform; and (ii) discussion of theoretical basis for observations.

### XVI** Other Anthracitic Networks

We discuss synthetic anthracitic networks of non-carbon chemical compositions, including BN and BCₓN.

### I**. Basic Terms & Concepts

The term “graphenic,” as used herein, describes a two-dimensional, polycyclic structure of sp²-hybridized or sp³-hybridized atoms. While graphene denotes a form of carbon, we utilize the term “graphenic” herein to describe a variety of graphene polymorphs (including known or theorized polymorphs such as graphene, amorphous graphene, phagraphene, haeckelites, etc.), as well as to describe other two-dimensional graphene analogues (e.g. atomic monolayers of BN, BCₓN, etc.) Hence, the term “graphenic” is intended to encompass any hypothetical polymorph meeting the basic criteria of two-dimensionality, polycyclic organization and sp² or sp³ hybridization.

“Two-dimensional” herein describes a molecular-scale structure comprising a single layer of atoms. A two-dimensional structure may be embedded or immersed in a higher-dimensional space to form a larger-scale structure that, at this larger scale, might be described as a three-dimensional. For instance, a graphenic lattice of subnanoscopic thickness might curve through three-dimensional space to form the atomically thin wall of a nanoscopically three-dimensional cell. This cell would still be described two-dimensional at the molecular scale.

A “ring” is defined herein as a covalent chain of atoms that together comprise a closed, polyatomic polygon of fewer than 10 atomic vertices. Each of the cyclic structures in a polycyclic arrangement comprise a ring. Each of the atoms comprising a given ring may be described as an atomic member belonging to that ring, and the ring may be described accordingly (i.e. a “6-member” ring describes a hexagonal ring formed by 6 atomic members).

An “sp² ring” is herein defined as a ring comprising all sp²-hybridized atomic members.

An “sp^{x} ring” is herein defined as a ring comprising atomic members that do not all share the same orbital hybridization.

A “chiral ring” is defined herein as an sp^{x} ring in which the covalent chain of atomic members comprises one or more chiral segments, wherein the two atomic termini of these chiral segments are sp³-hybridized atoms connected to each other via sp³-sp³ bonds. Chiral rings occur at tectonic zone transitions.

A “chiral column” is defined herein as a series of z-adjacent chiral rings connected to one another via one or more z-directional chains of sp³-sp³ bonds. A chiral column tends to form over a base-layer chiral ring and represents the lateral terminus of a diamondlike seam. A chiral column may contain one or more sp^{x} helices.

An “sp^{x} helix” is defined herein as a type of helical, one-dimensional chain constructed from both sp²-hybridized and sp³-hybridized atomic members. The axis of an sp^{x} helix is z-oriented.

An “sp^{x} double helix” is defined herein as the structure formed by two sp^{x} helices sharing the same chirality and the same axis.

An “sp² helix” is defined herein as a type of helical, one-dimensional chain constructed from only sp²-hybridized atomic members. The axis of an sp^{x} helix is z-oriented.

An “sp² double helix” is defined herein as the structure formed by two sp² helices sharing the same chirality and the same axis.

“Adjacent rings” herein describes two rings that have at least two common atomic members, and thus share at least one common side. In organic chemistry these rings might comprise fused or bridged rings, but not spirocyclic rings. Two adjacent rings may be described as “ring-adjacent.”

“Ring-connected” herein describes a structure that is connected via a “ring pathway,” or path of adjacent rings. We may speak of ring-connectedness according to two usages. In the first usage, we may say that one part of a structure is ring-connected to some other part of the structure. This means that there is a ring pathway that connects the two referenced parts. For example, a ring R₁ within a graphenic structure is ring-connected to another ring R₂ within the structure if there exists a path of adjacent rings starting at R₁ and ending at R₂. In the second usage, we may say that a referenced structure is itself ring-connected. This means that any part of the referenced structure can be reached from any other part via at least one ring pathway. We may also describe structures that are not ring-connected as ring-disconnected.

A “ring pathway” herein describes a pathway of adjacent rings that connects two referenced structures.

A “ring connection” herein describes a single ring that ring-connects two referenced structures.

“Sp² ring-connected” herein describes a structure that is connected via an “sp² ring pathway,” or pathway of adjacent sp² rings. Like ring-connectedness, we may speak of sp² ring-connectedness according to two usages. In the first usage, we may say that one part of a structure is sp² ring-connected to some other part of the structure. This means that there is an sp² ring pathway that connects the two referenced parts. In the second usage, we may say that a referenced structure is itself sp² ring-connected. This means that any part of the referenced structure can be reached from any other part via at least one sp² ring pathway. Since sp² ring-connectedness is a specific case of ring-connectedness, it implies ring-connectedness, while ring-connectedness does not imply sp² ring-connectedness. In certain cases we may describe certain ring-connected structures as “sp² ring-disconnected,” meaning that while they are ring-connected, they are not ring-connected by an sp² ring pathway.

An “edge atom” is defined as an atom that (i) belongs to a ring, and (ii) is not surrounded on all sides by rings. An edge atom always has multiple nearest neighbors that are also edge atoms, forming a chain.

An “edge” is defined as a chain of edge atoms. Starting from any given edge atom, it is possible to trace from this first atom a chain of nearest-neighbor edge atoms, wherein any given pair of nearest-neighbor edge atoms within the chain are co-members of exactly one ring. Some edges may form a closed circuit, where the first atom and last atom traced are nearest neighbors to each other.

An “edge segment” is defined as a chain of nearest-neighbor edge atoms contained within a larger edge.

An “interior atom” is defined herein as an atom that (i) belongs to a ring, and (ii) is surrounded on all sides by rings.

A “graphenic structure” is defined herein as a polycyclic, ring-connected group of two or more rings. Every ring in a graphenic structure is ring-connected to every other ring, although not necessarily sp² ring-connected. Each atom belonging to a graphenic structure may be classified as either an interior atom or an edge atom.

A “graphenic region” or “region” is herein defined as a subsidiary portion of some larger graphenic structure that itself fulfills all the requirements of a graphenic structure.

“Ring disorder” is herein defined as the presence of non-hexagonal rings in a graphenic structure. Ring-disordered graphenic structures include amorphous, haeckelite, pentagonal, or other molecular tilings. The presence of non-hexagonal rings creates regions of nonzero Gaussian curvature in ring-disordered graphenic structures. If inserted into a hexagonally tiled lattice, a 5-member ring incudes positive Gaussian curvature, while a 7-member ring induces negative Gaussian curvature. For example, a fullerene comprises a curved graphenic structure formed by 20 hexagons and 12 pentagons.

“Ring order” is herein defined as a substantially hexagonal molecular tiling. Ring-ordered graphenic structures may be flexed or wrinkled due to their low bending stiffness.

A “system” is herein defined as some polyatomic physical structure comprising a group of atoms cohered via either chemical bonds or van der Waals interactions. A system may contain any number of graphenic structures, including none. It is a general term for describing some physical structure under consideration.

A “graphenic system” is herein defined as a system consisting of one or more distinct graphenic structures. A graphenic structure belonging to a graphenic system may be described as a “graphenic member” or “member” of the graphenic system. A graphenic system does not include any elements other than its graphenic members.

A “graphenic singleton” or “singleton” is herein defined as a graphenic system comprising a single, distinct graphenic structure.

A “graphenic assembly” or “assembly” is herein defined as a graphenic system comprising two or more distinct graphenic structures.

A “van der Waals assembly,” or “vdW assembly,” is herein defined as a multilayer graphenic assembly in which the graphenic structures are cohered principally or substantially by intermolecular forces. The graphenic structures in a vdW assembly may also be cohered via other mechanisms.

A “double screw dislocation” is herein defined as a dislocation formed by two screw dislocations sharing the same chirality and the same dislocation line. A double screw dislocation in a graphenic system forms a graphenic double helicoid. The braid-like geometry of double helicoids may physically interlock the two helicoids.

A “multilayer” graphenic system is herein defined as a graphenic system comprising more than one layer in vdW contact, on average. A multilayer graphenic system may possess monolayer regions. Analytically, we may define a multilayer graphenic system as one possessing an average BET surface area no more than 2,300 m²/g, as measured by N₂ adsorption.

A “Y-dislocation” is herein defined as a ring-connected, Y-shaped graphenic region formed by a layer's bifurcation into a laterally adjacent bilayer. The two “branches” of the Y-shaped region comprise z-adjacent sp^{x} rings, which together comprise a diamondlike seam situated at the interface between the laterally adjacent layer and bilayer. The characteristic Y-shaped geometry is associated with a cross-sectional plane of the layers and the diamondlike seam.

A “diamondlike seam” or “seam” is herein defined as a two-dimensional sheet of z-adjacent sp^{x} rings forming a z-oriented interface between xy-oriented layers to either side. A cubic diamondlike seam comprises chair conformations, while a hexagonal diamondlike seam comprises chair, boat, and potentially other conformations. A diamondlike seam may terminate in chiral columns.

A “bond line” is a linear arrangement of 2 or more side-by-side bonds possessing a generally parallel (but not necessarily a perfectly parallel) orientation.

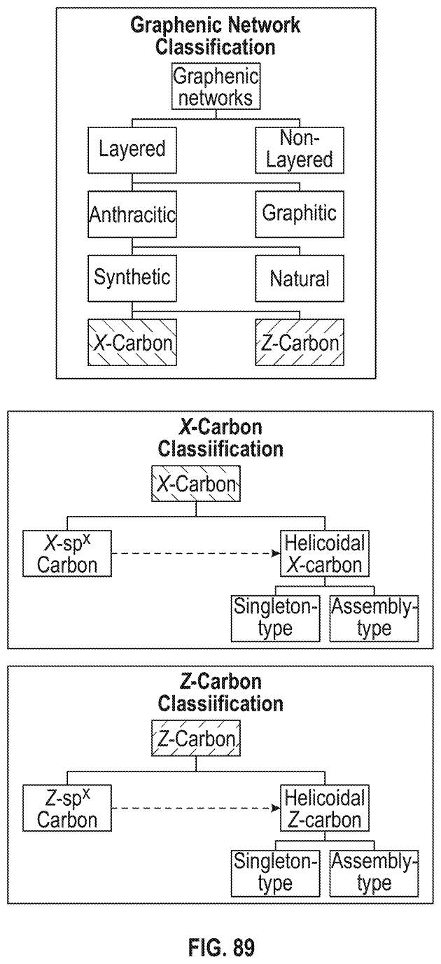

A “graphenic network” herein describes a structure with a two-dimensional molecular-scale geometry that is at some larger scale three-dimensionally crosslinked. As a function of a graphenic network's crosslinking and network geometry, it cannot be broken without breaking some portion of its two-dimensional molecular structure. Graphenic networks comprise the broadest category of networks constructed from graphenic structures, as shown by this category's position at the apex of the classification chart in FIG. 89. The requirement of three-dimensional crosslinking over some scale of evaluation excludes from this definition graphenic systems that cannot be said to be three-dimensionally crosslinked at any scale (such as a simple polyaromatic hydrocarbon). In the present disclosure, the term “graphenic network” follows our usage of the term “graphenic” in that it will be used generally to apply to networks comprising two-dimensional molecular structures of various polymorphs and chemistries. In the specific case of carbon graphenic networks, we can further describe the network in terms of the anisotropy of its molecular-scale crosslinking:
“Highly anisotropic,” if the average I_{2D}_{ᵤ}/I_{G}_{ᵤ} ratio is higher than 0.40
“Moderately anisotropic,” if the average I_{2D}_{ᵤ}/I_{G}_{ᵤ} ratio is between 0.20 and 0.40
“Minimally anisotropic,” if the average I_{2D}_{ᵤ}/I_{G}_{ᵤ} ratio is below 0.20

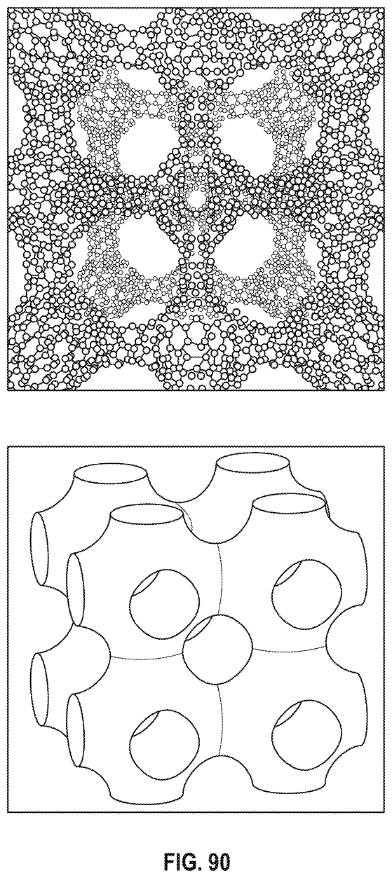

A “layered” network is herein defined as a multilayer graphenic network comprising z-adjacent layers with either graphitic or nematic xy-alignment. Layered graphenic networks are shown as a subcategory of graphenic networks in the classification chart in FIG. 89. Schwarzite, as shown in FIG. 90, does not comprise a layered graphenic network.

A “graphitic network” is herein defined as a type of layered graphenic network in which z-adjacent layers exhibit graphitic xy-alignment—i.e. they are substantially parallel. Graphitic networks may be characterized by an average <002> interlayer d-spacing of 3.45 Å or less, with no significant presence of interlayer spacings larger than 3.50 Å. Graphitic networks are shown as a subcategory of layered graphenic networks in the classification chart in FIG. 89.

An “anthracitic network” is herein defined as a type of layered graphenic network comprising two-dimensional molecular structures crosslinked via certain characteristic structural dislocations, described herein as “anthracitic dislocations,” which include Y-dislocations, screw dislocations, and mixed dislocations having characteristics of both Y-dislocations and screw dislocations. Z-adjacent layers in anthracitic networks exhibit nematic alignment. Anthracitic networks may be characterized by a significant presence of <002> interlayer d-spacings larger than 3.50 Å. Anthracitic networks are shown as a subcategory of graphenic networks in the classification chart in FIG. 89 and may be further classified as natural (i.e. anthracite coal) vs. synthetic, with synthetic anthracitic networks being much more diverse in architecture and chemistry.

“Nematic alignment” is herein used to describe a molecular-scale, general xy-alignment between z-adjacent layers in a multilayer graphenic system. This term is typically used to denote a type of consistent but imperfect xy-alignment observed between liquid crystal layers, and we find it useful herein for describing the imperfect xy-alignment of z-adjacent layers in anthracitic networks. Nematic alignment may be characterized by a significant presence of <002> interlayer d-spacings larger than 3.50 Å.

An “sp^{x} network” is herein defined as a type of synthetic anthracitic network comprising a single, continuous graphenic structure, wherein the network is laterally and vertically crosslinked via diamondlike seams and mixed dislocations (e.g. chiral columns). In the context of maturation processes, an sp^{x} network may be described as an “sp^{x} precursor.”

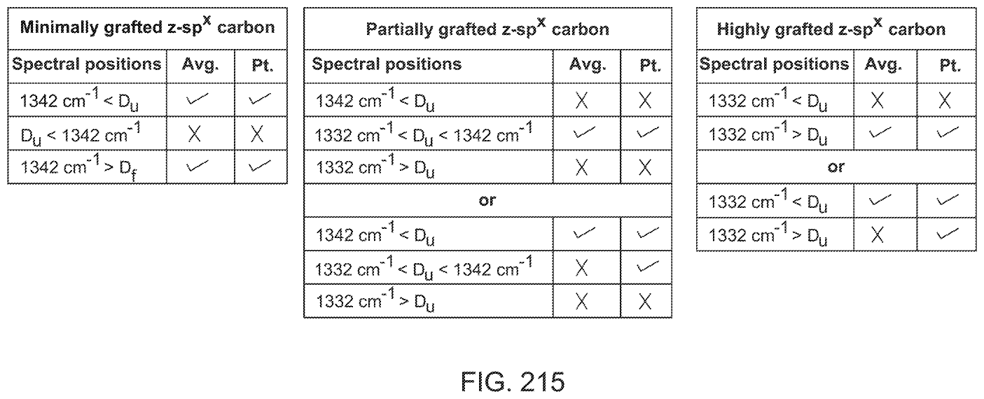

Carbon sp^{x} networks can be further classified based on the extent of their internal grafting, which can be determined by the prevalence of its sp²-hybridized edge states prior to maturation. With respect to the extent of this grafting, a carbon sp^{x} network can be described as:
“Minimally grafted” if (a) its average Dᵤ position is located above 1342 cm⁻¹, (b) its average D_{f} peak position is located below 1342 cm⁻¹ and (c) no point spectra exhibit Dᵤ peak positions below 1342 cm⁻¹
“Partially grafted” if (a) its average Dᵤ peak position is located between 1332 cm⁻¹ and 1342 cm⁻¹ and (b) no point spectra reveal Dᵤ peak positions below 1332 cm⁻¹; or alternatively if (a) its average Dᵤ peak position is located above 1342 cm⁻¹ and (b) point spectra exhibit Dᵤ peak positions between 1332 cm⁻¹ and 1340 cm⁻¹.
“Highly grafted” if its average Dᵤ peak position is located below 1332 cm⁻¹, or alternatively if (a) its average Dᵤ peak position is located above 1332 cm⁻¹ and (b) some point spectra exhibit localized Dᵤ peak positions below 1332 cm⁻¹.
   These conditionals are summarized in FIG. 215.

A “helicoidal network” is herein defined as a type of synthetic anthracitic network comprising screw dislocations. These screw dislocations may be formed via the maturation of chiral columns present in sp^{x} networks. Hence, an sp^{x} network may be described as an “sp^{x} precursor” of a helicoidal network. The derivation of helicoidal networks from sp^{x} precursors is indicated by the dashed arrow labeled “maturation” in the classification chart in FIG. 89.

“Maturation” is herein defined as a structural transformation that accompanies the sp³-to-sp² rehybridization of sp³-hybridized states in an sp^{x} precursor. Maturation of an sp^{x} precursor ultimately forms a helicoidal network; the extent of maturation is determined by the degree to which the sp³-to-sp² rehybridization is completed. Maturation is progressive, so networks in intermediate states comprising both sp^{x} and helicoidal network features may be formed. Additionally, maturation may be localized; for instance, heating certain locations of the network, such as by laser, might cause localized maturation of the affected area.

A “highly mature” carbon helicoidal network is defined herein as a carbon helicoidal network having an average Dᵤ peak position that is at least 1340 cm⁻¹ and is at least 8 cm⁻¹ higher than that of its sp^{x} precursor.

An “x-carbon” is herein defined as a category of synthetic anthracitic networks constructed from graphene and comprising one of the following:
an “x-sp^{x} network,” defined herein as a highly grafted sp^{x} network
a “helicoidal x-carbon” formed by maturing an x-sp^{x} precursor to either an intermediate or highly mature state

A “z-carbon” is herein defined as a category of synthetic anthracitic networks constructed from graphene and comprising one of the following:
a “z-sp^{x} network,” defined as a minimally or partially grafted sp^{x} network
a “helicoidal z-carbon” formed by maturing a z-sp^{x} precursor to either an intermediate or highly mature state.
   When used in the context of identifying a z-carbon, the z- prefix does not relate to z-directionality.

A “helicoidal singleton” is herein defined as a singleton-type helicoidal network, wherein the helicoidal network comprises a single, ring-connected graphenic structure, and wherein the network is laterally and vertically crosslinked by screw dislocations.

A “helicoidal assembly” is herein defined as an assembly-type helicoidal network, wherein the helicoidal network comprises an assembly of multiple, helicoidal graphenic structures that are physically interlocked with one another via braid-like double helicoids (i.e. double screw dislocations).

An “sp^{x} preform” is a macroscopic assembly of distinct, sp^{x} precursors, referred to in this context as “sp^{x} microforms.” Various forming techniques may be used to impart a desired shape to an sp^{x} preform, such as an elongated, flat, or equiaxed shape.

A “macroform” is herein defined as a macroscopic, cohesive structure.

A “singleton-to-singleton” maturation is herein defined as a maturation process in which an sp^{x} precursor is matured to form a helicoidal singleton.

“A singleton-to-assembly” maturation is herein defined as a maturation process in which an sp^{x} precursor is disintegrated into a helicoidal assembly.

“Disintegration” is herein defined as the division of a singleton-type graphenic network into two or more distinct, ring-disconnected graphenic structures.

A “primordial domain” is defined herein as a graphenic domain nucleated and grown over a substrate prior to any tectonic encounters. When primordial domains are grown over a common surface toward one another, their edges may have a tectonic encounter.

A “primordial region” is defined herein as a region of a graphenic network generally coinciding with the network's primordial domains. We generally refer to a primordial region when describing some region of a graphenic system that was originally a primordial domain.

A “tectonic encounter” is a state of lateral near-contact between two edge segments during growth of a two-dimensional lattice. A tectonic encounter creates a tectonic interface between the two participating edge segments. The numerous tectonic encounters that may occur during the nucleation and growth of a graphenic system may be described as “tectonic activity.”

A “tectonic interface” is defined herein as the edge-to-edge interface formed by a tectonic encounter between two graphenic structures or regions.

A “zigzag-zigzag interface” is herein defined as a tectonic interface in which both of the edge segments are in the zigzag configuration.

A “zigzag-armchair interface” is herein defined as a tectonic interface in which one of the edge segments is in the zigzag configuration, while the other is in the armchair configuration.

An “offset zone” is herein defined as an interfacial zone within a tectonic interface in which one of the two participating edge segments are vertically offset—i.e. one of the edge segments is located above the other.

A “level zone” is herein defined as an interfacial zone within a tectonic interface in which the two participating edge segments are substantially level with each other and sufficiently aligned such that a bond line of two or more laterally adjacent sp²-sp² bonds may be formed across the interface, resulting in one or more sp² ring-connections.

A “crossover point” is herein defined as a location in a tectonic interface where the two participating edge segments crisscross, and where their alignment is inadequate to form a bond line of two or more laterally adjacent sp²-sp² bonds. This may be because the 2p_{z} orbitals of the opposing sp² edge atoms are too misaligned for 7c bonds to form.

“Sp² grafting” is herein defined as the formation of a sp²-sp² bond line between two edge atoms. Sp² grafting creates sp² ring-connections that may cause distinct graphenic structures to become ring-connected and coalesce into a larger graphenic structure. Sp² grafting across a tectonic interface is favored in level zones.

“Sp³ grafting” is herein defined as the formation of sp³-sp³ bonds between two edge atoms. This may involve the sp²-to-sp³ rehybridization of sp² edge atoms. Sp³ grafting creates sp^{x} rings that may cause distinct graphenic structures to become ring-connected and coalesce into a larger graphenic structure. Sp³ grafting across a tectonic interface is favored in offset zones.

A “base” or “base layer” is herein defined as the first graphenic layer formed by grafting across the tectonic interfaces between primordial domains during pyrolytic growth.

“Mesoscale” is used herein to describe a hierarchical level or feature (e.g. crosslinking, porosity) pertaining to a relatively larger size-scale than the molecular features. For example, a perimorphic framework's mesoscale crosslinking is a function of its crosslinking over size-scales more relevant to a discussion of its particle morphology than to a discussion of its molecular bonding structure.

A “micropore” is herein defined as a pore with a diameter of less than 2 nm, following IUPAC convention. A “microporous” structure or phase is characterized by the presence of micropores.

A “mesopore” is herein defined as a pore with a diameter between 2 nm and 50 nm, following IUPAC convention. A “mesoporous” structure or phase is characterized by the presence of mesopores.

A “macropore” is herein defined as a pore with a diameter of greater than 50 nm, following IUPAC convention. A “macroporous” structure or phase is characterized by the presence of macropores.

An “ambient superconductor” is herein defined as a material or article capable of entering a superconducting state at a temperature above 0° C. and an external pressure between 0 and 2 atm. “Ambient superconductivity” is herein defined as a superconducting state at a temperature above 0° C. and an external pressure between 0 and 2 atm.

### II**. Surface Replication

Pyrolysis involves the decomposition of a gas, liquid, or solid carbonaceous material and may be used to form graphenic structures. In some pyrolysis procedures, this decomposition occurs over a substrate surface. The substrate may comprise the simple, flat surface of a foil or the more complex surfaces of particles. The graphenic systems synthesized on particles may inherit some of the particles' morphological attributes. In the '918 and '760 Applications, we define a number of terms related to template-directed synthesis. These terms are defined below.

A “template,” as defined herein, is a potentially sacrificial structure that imparts a desired morphology to another material formed in or on it. Of relevance for surface replication techniques are the template's surface (i.e. the “templating surface”), which is positively replicated, and its bulk phase (i.e. the “templating bulk”), which is negatively replicated. The template may also perform other roles, such as catalyzing the formation of the perimorphic material. A “templated” structure is one that replicates some feature of the template.

A “perimorph” or “perimorphic” material is a material formed in or on a solid-state or “hard” template material.

“Surface replication,” as defined herein, comprises a templating technique in which a template's surface is used to direct the formation of a thin, perimorphic wall of adsorbed material, the wall substantially encapsulating and replicating the templating surface upon which it is formed. Subsequently, upon being displaced, the templating bulk is replicated, in negative, by an endocellular space within the perimorphic wall. Surface replication creates a perimorphic framework with a templated pore-and-wall architecture.

A “perimorphic framework” (or “framework”), as defined herein, is the nanostructured perimorph formed during surface replication. A perimorphic framework comprises a nanostructured “perimorphic wall” (or “wall”) that may range from less than 1 nm to 100 nm in thickness but is preferably between 0.6 nm and 5 nm. Insomuch as it substantially encapsulates and replicates the templating surface, the perimorphic wall can be described as “conformal.” Perimorphic frameworks may be made with diverse architectures, ranging from simple, hollow architectures formed on nonporous templates to labyrinthine architectures formed on porous templates. They may also comprise different chemical compositions. A typical framework may be constructed from carbon and may be referred to as a “carbon perimorphic framework.”

An “endomorph,” as defined herein, comprises a template as it exists within a substantially encapsulating perimorphic phase. Therefore, after the perimorphic phase has been formed around it, the template may be described as an endomorph, or as “endomorphic.”

A “perimorphic composite,” as defined herein, is a composite structure comprising an endomorph and a perimorph. A perimorphic composite material may be denoted x@y, where x is the perimorphic element or compound and y is the endomorphic element or compound. For example, a perimorphic composite comprising a carbon perimorph on an MgO endomorph might be denoted C@MgO.

Numerous template elements or compounds may be employed, including carbon, metal oxides, oxyanionic salts, boron nitride, metal halides, and more. In particular, magnesium oxide (MgO) templates are often employed in chemical vapor deposition (“CVD”) processes due to their stability at high temperatures. Many of these templates are described in the '918 Application and the '154 Application. All that is required for many surface replication procedures involving CVD is a surface and the nucleation of a lattice that can be grown via autocatalysis or as a free radical condensate.

### III**. Free Radical Condensate Growth & Tectonics

In the free radical condensate theory of growth, a free radical condensate (i.e. “condensate” or “FRC”) is formed during pyrolytic decomposition of a reactive vapor. A carbon FRC is a charged, hydrogenated precursor to the graphenic structure that can rapidly rearrange its carbon skeleton without breaking covalent bonds; hence it can be envisioned as a kind of charged, covalent liquid. A carbon FRC grows in the presence of a reactive vapor via radical addition reactions at its edges. As the condensate releases molecular hydrogen, its concentration of radicals diminishes, its self-rearrangement ceases, and it becomes an uncharged carbon structure. A gradual release of molecular hydrogen provides the FRC more time to rearrange itself into an energy-minimizing configuration-typically one that eliminates high-energy edge defects. This has been shown to promote edgeless graphenic structures like fullerenes. A sudden loss of hydrogen, by contrast, does not provide sufficient time for these energy-minimizing rearrangements to occur, which promotes the formation of graphenic structures with more edges.

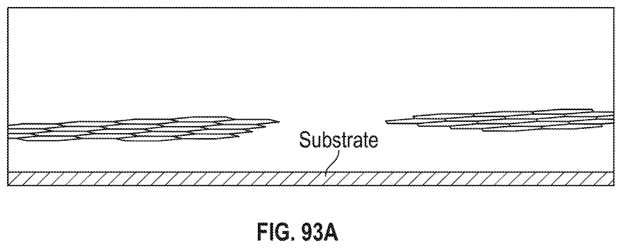

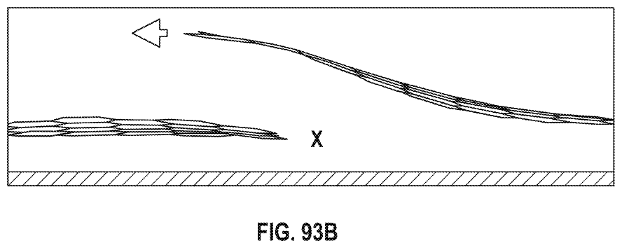

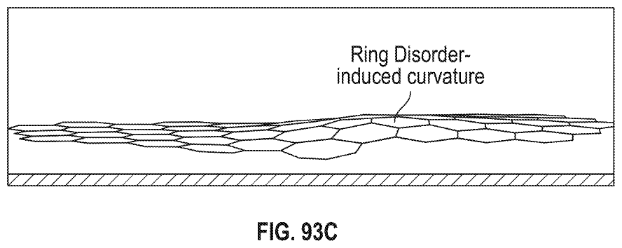

If grown over a common substrate surface, graphenic structures may come into lateral contact with one another. These tectonic encounters, and the underlying factors that determine how they are resolved, have been the subject of scant research. In one case we have found, researchers observing the growth of ring-ordered, crystalline graphenic structures on copper foil found that a tectonic encounter could be resolved in one of two ways, as illustrated in FIG. 93A.

In the first scenario, the edge of one of the graphenic structures is subducted by the edge of the other—an event described herein as a “subduction event.” A subduction event allows continued growth of the subducting region over the subducted region, as illustrated in FIG. 93B. The subducting region's continued growth is indicated by the black arrow in FIG. 93B, whereas the subducted region's growth is quenched, as indicated by the black “x” in FIG. 93B. A subduction event forms an edge dislocation comprising two overlapping, z-adjacent graphenic structures weakly cohered via van der Waals interactions.

In the second scenario described by the researchers, the edge of one of the graphenic structures may graft to the edge of the other via sp²-sp² bond formation between the opposing edge atoms. This sp² grafting causes the two graphenic structures to coalesce to form a larger graphenic structure. The outcome of this event is illustrated in FIG. 93C. The researchers showed that sp² grafting between laterally or rotationally misaligned edges may result in the formation of non-hexagonal rings in the new graphenic structure. It follows that the regional presence of these non-hexagonal rings within the sp²-grafted domain may induce local lattice curvature, as indicated in FIG. 93C.

The complexity of tectonics between graphenic structures is increased when the substrate surface becomes more topologically and topographically complex. It is further increased if we postulate edge disorder. We surmise herein that these factors are important in determining the outcomes of tectonic encounters. Lastly, it is increased if the tectonics occur in a substantially unconfined space, where steric effects of surrounding structures can be ignored. This may not be the case when pyrolysis occurs in certain microporous template particles, like Zeolite Y, where sp² grafting between graphenic structures (as opposed to subduction) may be forced due to the z-directional confinement in these templates' micropores—i.e. a lack of overhead clearance.

### IV**. Surfaces in Three Dimensions

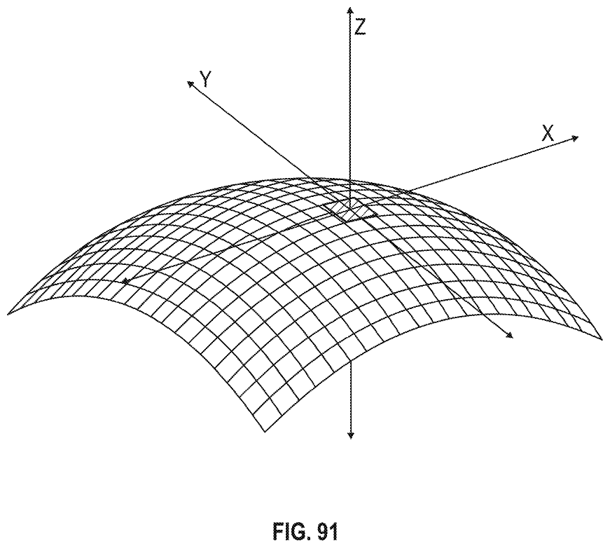

To describe the local space around curved, two-dimensional graphenic structures, it is helpful to establish an intuitive orientation. On a curved surface, there exists some tangent plane at any given point that we can think of as an xy plane. FIG. 91 illustrates a hypothetical structure and the tangent xy plane at a given point. A z-axis normal to this xy-plane is also illustrated in FIG. 91. While the orientations of the tangent plane and z-axis will vary across a curved surface, we find it helpful to describe the local space generally above or below a graphenic region as the “z-space,” and to describe the direction of the local z-space as “vertical.” We also find it helpful to describe the direction perpendicular to the local z-axis as “lateral.”

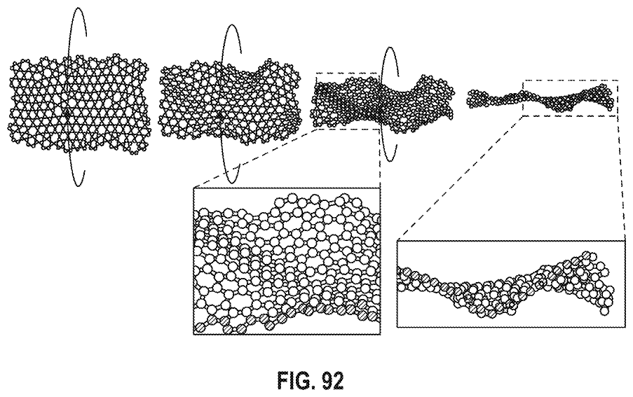

An example of a ring-disordered graphenic domain with nonzero curvature is modeled in FIG. 92. This model was constructed using Avogadro 1.2.0 software and relaxed to obtain a rough approximation of the actual molecular geometry that might exist in free space. The resulting domain is rotated as indicated by the arrows in FIG. 92 in order to facilitate visualization from different perspectives. One segment of its edge is pattern-filled to provide orientation.

From the vertical perspective in FIG. 92, the ring disorder can be observed. The domain incorporates a randomized tiling of 5-member, 6-member, and 7-member rings. From the diagonal perspectives, regions possessing positive and negative curvature can be observed. From the horizontal perspective, we can trace the pattern-filled edge segment, which provides a sense of the z-directional lattice deflections (i.e. “z-deflections”) created by the ring disorder. The domain's z-deflections impart an undulating shape to the edge, which z-deflects alongside the local lattice. As ring disorder increases, the amplitude and frequency of the edge's z-deflections may increase.

### V**. Clarifying Examples

Analysis of exemplary systems may provide helpful clarification of these concepts. Unless stated otherwise, the models all depict sp²-hybridized or sp³-hybridized carbon atoms and do not show hydrogen atoms.

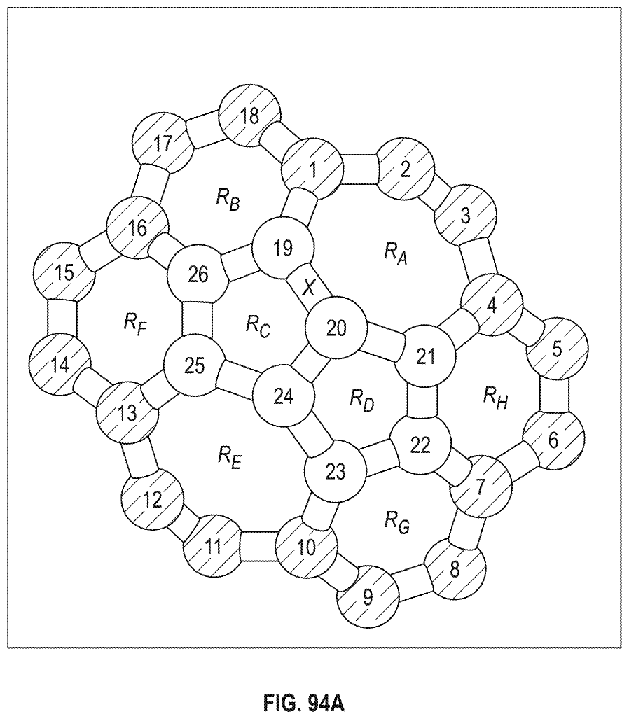

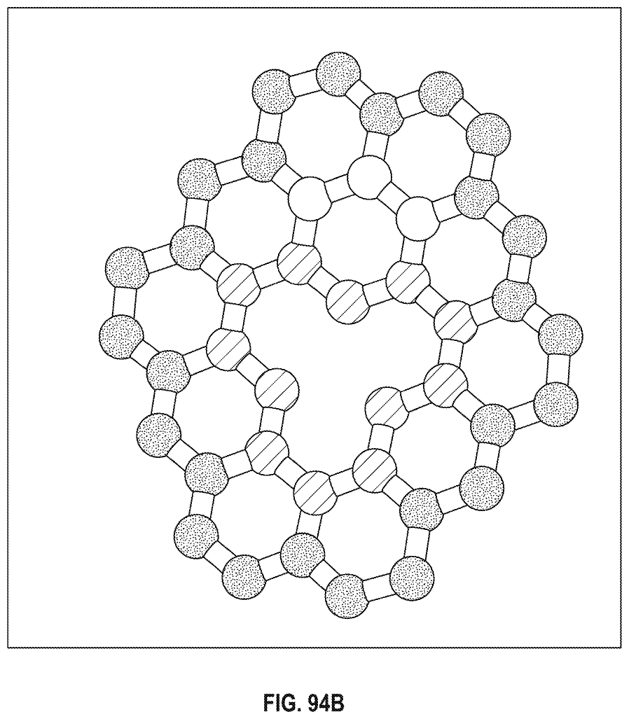

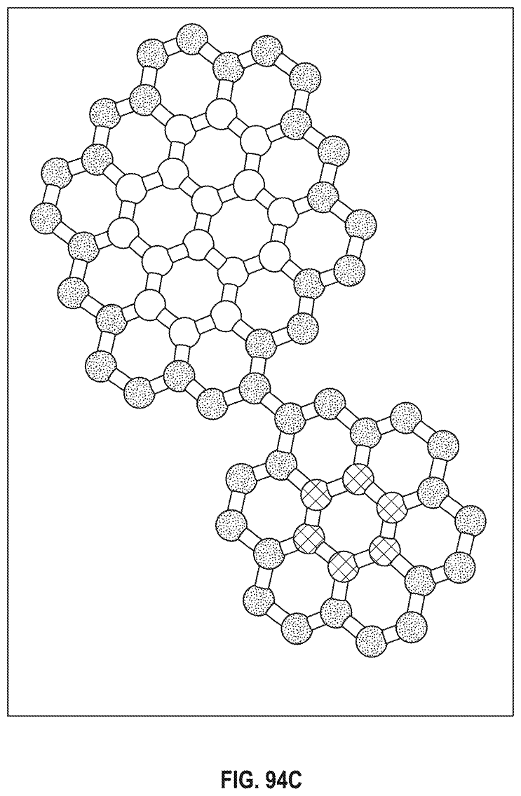

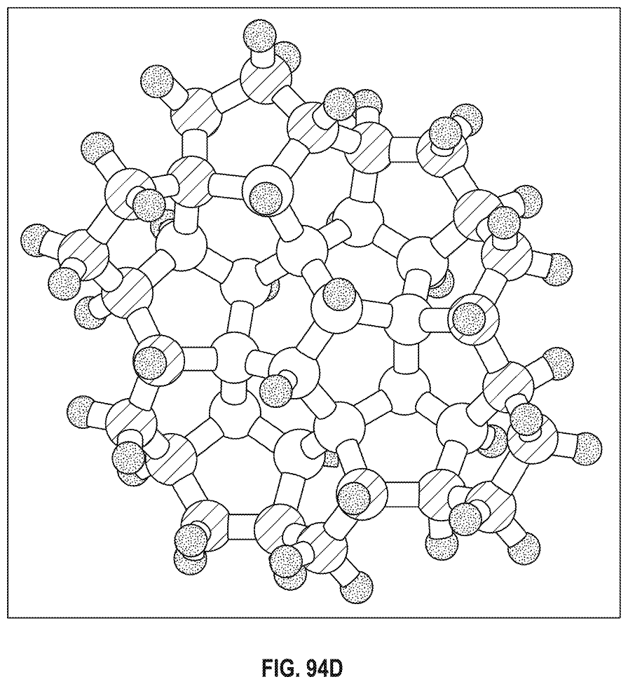

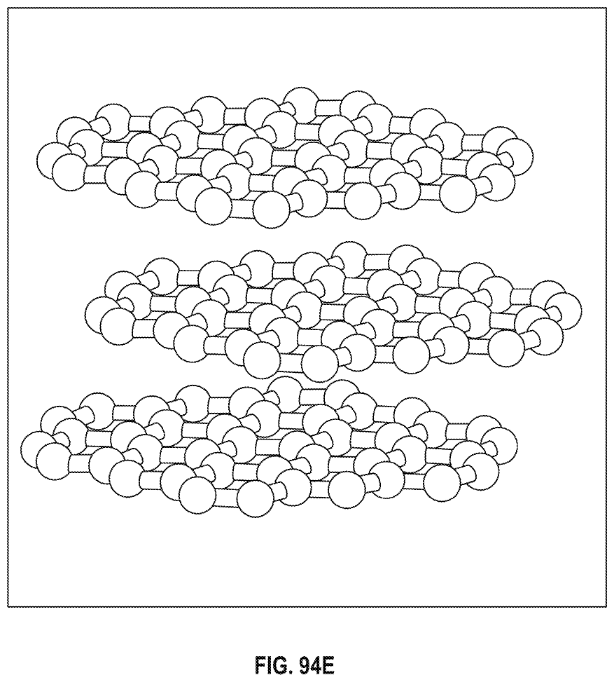

FIG. 94A is a system of 26 carbon atoms, each of which are numbered, and 8 cyclic structures labeled R_{A}, R_{B}, R_{C}, . . . , R_{H}. The cyclic structure labeled R_{A} consists of 7 carbon atoms (i.e. atoms 1, 2, 3, 4, 19, 20, and 21) bonded to one another in a covalent chain, together forming a closed heptagon. Hence, R_{A} meets the definition of a ring. All of the other cyclic structures in the molecule in FIG. 94A also meet the definition of a ring and may be expressed as sets of their atomic members.

The side of R_{A} labeled x in FIG. 94A is also shared by the pentagonal ring R_{C}. Because R_{A} and R_{C} share a common side, it is also true that they share at least two atomic members. Therefore, rings R_{A} and R_{C} meet the definition of adjacent rings.

In the system in FIG. 94A, every atom belongs to a ring, and every ring is path-connected to every other ring by at least one path of adjacent rings. For example, ring R_{A} is connected to ring R_{E} by many paths of adjacent rings (e.g. R_{A}→R_{C}→R_{E}, or R_{A}→R_{H}→R_{G}→R_{E}). Therefore, the system may be described as ring-connected and as a graphenic structure.

Next, we evaluate the atoms of the graphenic structure in FIG. 94A to determine whether they are interior or edge atoms. Atom 19 belongs to rings R_{A}, R_{B}, and R_{C}, which surround it on all sides. Therefore, 19 meets the definition of an interior atom. Atoms 20 through 26 also meet this definition. Each interior atom is white in FIG. 94A.

Atom 1 belongs to rings R_{A} and R_{B}, which do not completely surround it. Therefore, 1 meets the definition of an edge atom. Atoms 2 through 18 also meet this definition. Edge atoms are indicated by diagonal patterning in FIG. 94A. Starting from any given edge atom, we can from this first atom trace a chain of nearest neighbors such that any two nearest neighbors within the chain are both edge atoms and also co-members of exactly one ring. By continuing this trace to its terminus, we define an edge.

For instance, starting from 1, we find that 2 is a nearest neighbor, an edge atom, and a co-member (along with 1) of exactly one ring (R_{A}). Continuing this trace from 2 to 18, a circuit is formed that is closed by the bond between 18, the last atom in the chain, and 1, its nearest neighbor and the first atom in the chain. Together, these atoms represent the edge of the graphenic structure.

In FIG. 94B, a system of 41 carbon atoms and 12 cyclic structures is illustrated. Rather than numbering all of the atoms, we characterize them as groups, based on their patterning-white, diagonally pattern-filled, and speckled. Of the 12 cyclic structures, 11 meet the definition of rings; the cyclic structure surrounded by the 12 diagonally pattern-filled atoms comprises more than 9 atomic members and therefore is not a ring. All 11 rings are ring-connected, and there are no atoms that are not members of a ring, so the entire system comprises a graphenic structure.

Next the atoms of the graphenic structure in FIG. 94B are analyzed. Only 3 atoms belong to a ring and are also surrounded by rings on all sides. These interior atoms are white in FIG. 94B. Since all of the remaining 38 atoms of the graphenic structure belong to a ring and are incompletely surrounded by rings, they are all edge atoms. Starting from any given edge atom, we trace a chain of nearest neighbors such that any two nearest neighbors within the chain are both edge atoms and co-members of exactly one ring. This results in a traced edge. Following this tracing rule, we find that we cannot perform a trace that includes all of the 38 edge atoms in the graphenic structure. So, once an edge has been traced, we select any edge atom that remains unassigned to an edge and trace a new edge, and this process is continued until all edge atoms have been assigned to an edge. Following this procedure for the system in FIG. 94B, we can trace exactly two edges. The edge atoms comprising the 12-member edge are diagonally pattern-filled, and the edge atoms comprising the 26-member edge are speckled.

In FIG. 94C, a system comprising 66 carbon atoms and 21 cyclic structures is illustrated. Edge-located carbons are speckled, and interior atoms are white in one graphenic structure and crosshatched in the other. All 21 cyclic structures are rings, but not all of the rings are ring-connected to all of the other rings. Instead, there is a first group of 14 ring-connected rings, and a second group of 7 ring-connected rings, but the first group and the second group are not ring-connected to each other.

Therefore, the system in FIG. 94C comprises a 42-member, ring-connected graphenic structure, as well as a separate 24-member graphenic structure. Because all 66 atoms in the system in FIG. 94C are members of some graphenic structure, the whole system can be represented as a graphenic system, and because the system comprises two distinct graphenic member structures, it represents an assembly. Because the principal cohesion between the two members is provided by the covalent bond connecting them, the assembly comprises a bonded assembly.

In FIG. 94D, a system comprising 38 carbon atoms (all sp³-hybridized), 44 hydrogen atoms, and 17 cyclic structures is illustrated. Hydrogen atoms are speckled, edge-located carbon atoms are diagonally pattern-filled, and interior-located carbon atoms are white. Each of the 17 cyclic structures comprises a 5-member carbon ring, and all 38 carbon atoms are members of one of the 17 rings. Every 5-member ring is ring-connected to every other 5-member ring by a path of adjacent rings, making the group of 17 rings a ring-connected, graphenic structure.

Since the system in FIG. 94D includes atoms that are not members of rings, and a graphenic structure comprises polyatomic rings of carbon atoms, the system in its totality does not comprise a graphenic structure. However, the system contains a graphenic structure. Because most graphenic structures will be bonded to hydrogen, oxygen, or other atoms, most graphenic structures will be subsystems of larger systems that include non-graphenic structural elements. In the present disclosure, however, we mostly limit our consideration to the polycyclic carbon arrangements that define graphenic structures.

In FIG. 94D, the graphenic structure contains 15 carbon atoms that both belong to a ring and are surrounded by rings on all sides. These interior atoms are white. The remaining 23 atoms within the graphenic structure belong to a ring and are incompletely surrounded by rings. These edge atoms, and the 23-member edge they comprise, are diagonally pattern-filled.

In FIG. 94E, a graphenic system is illustrated. The graphenic system comprises 3 distinct, z-adjacent graphenic member structures. Each graphenic member structure is ring-disconnected with respect to the other two graphenic member structures but is cohered via interlayer vdW interactions. Therefore, the graphenic system in FIG. 94E represents a vdW assembly.

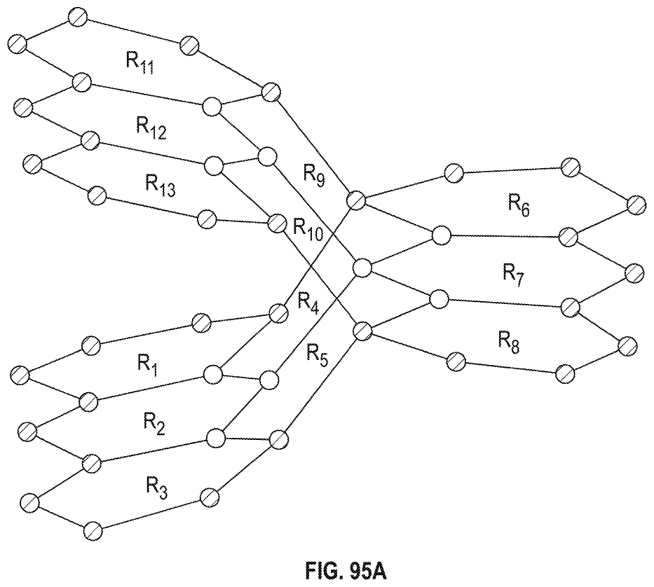

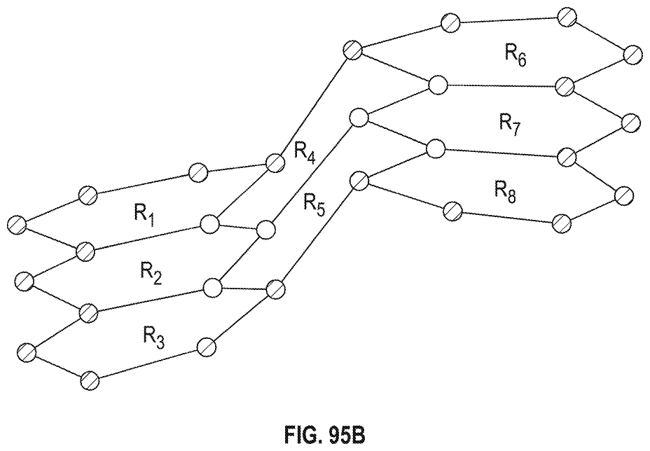

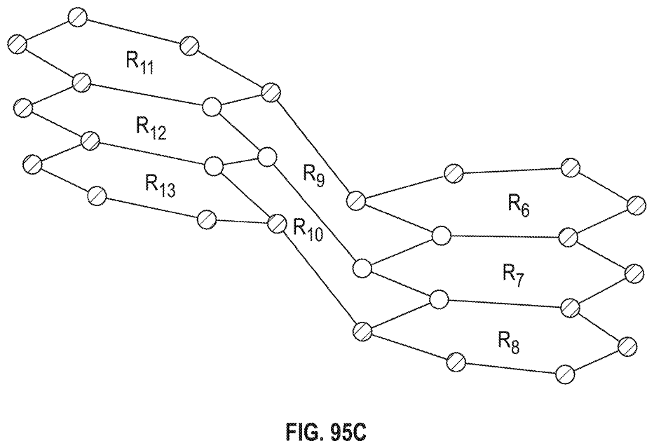

In FIG. 95A, a system comprising 42 carbon atoms and 15 cyclic structures is illustrated. FIG. 95B and FIG. 95C illustrate isolated portions of this same system. The 15 cyclic structures in the system comprise 13 6-member rings (designated as R₁, R₂, R₃, . . . , R₁₃). All of the system's carbon atoms are members of rings, and all of the rings are path-connected to one another via at least one path of adjacent rings. Therefore, the entire 42-atom system comprises a single, ring-connected graphenic structure. This graphenic singleton includes a Y-dislocation, at the intersection of which is a cubic diamondlike seam, crosshatched in FIG. 95D.

### VI**. Notes on Metrology & Characterization

A number of different instruments were employed to characterize the materials synthesized in the present disclosure. The following discussion provides information on these instruments and context for how we analyzed the related data.

All Raman spectroscopic characterization was performed using a ThermoFisher DXR Raman microscope equipped with a 532 nm excitation laser and Omnic profile-fitting software. Specific laser powers were used and are specified where applicable.

Raman spectroscopy is commonly used to characterize the molecular structure of carbon, and a prolific literature exists on this subject. Two main spectral features are typically associated with optical excitation of sp²-hybridized carbon: the G band (typically exhibiting a peak intensity value at approximately 1580 cm⁻¹ to 1585 cm⁻¹ in graphitic sp² carbon), and the D band (exhibiting a peak intensity value at approximately 1350 cm⁻¹ under optical excitation). The “2D” band representing a second order of the D band is also observed in some graphitic carbons, and its peak intensity value is typically located at approximately 2700 cm⁻¹. The G band is assigned to the vibrations of sp²-sp² bonds. The D band is assigned to the radial breathing mode of sp²-hybridized carbon atoms arranged in rings, and for Raman observation this requires back-scattering of electrons at a defect site.

Researchers have described an amorphization trajectory in the spectra of graphitic carbon showing a progression in disorder from graphite to amorphous carbon that is helpful to understand the dynamics of the D band. In graphite, no D peak is present due to the absence of activating defects. In carbons comprising smaller graphenic domains, the density of edge states is increased, and as edge states increase the D peak is activated by backscattering at the edge defects. The D peak intensity increases toward a maximum, corresponding to a nanocrystalline graphite. Further amorphization in the form of ring disorder diminishes the intensity of the D peak. Lastly, the D peak disappears as further amorphization eliminates a polycyclic, sp²-hybridized structure altogether.

The Raman spectral peaks associated with sp³-hybridized carbon include a peak at 1306 cm⁻¹ (associated with hexagonal diamond), a peak at 1325 cm⁻¹ (associated with hexagonal diamond) and a peak at 1332 cm⁻¹ (associated with cubic diamond). Cubic diamond comprises 100% chair conformations, whereas hexagonal diamond comprises both chair conformations and boat conformations, giving it a lower Raman frequency and lower thermodynamic stability.

Raman-active phonons are known to be strain-dependent. Because the presence of strain within a lattice causes the lattice's vibrational frequencies to shift, Raman spectroscopy can be utilized to understand the strain states within a lattice. However, strain can also shift spectral peaks from their normally identified positions to new positions, making identification more ambiguous. The primary indicator of strain in a ring-ordered graphene structure is the position of the G peak and 2D peak, both of which are sensitive to tension and compression. The G peak has been shown to shift to lower frequencies (i.e. a “red-shift”) when the sp²-sp² bonds are stretched and to higher frequencies (i.e. a “blue-shift”) when they are compressed. In graphenic structures with non-uniform strain fields, multiple modes of the G band may be present.

In disordered carbons, several Raman spectral features have been observed in addition to the D peak. A broad Raman peak (sometimes referred to as D”) often fitted between 1500 cm⁻¹ and 1550 cm⁻¹ in amorphous sp²-hybridized carbons is generally observed to increase with ring disorder. It is herein attributed to low-correlation, red-shifted modes of the G band associated with stretched, weakened sp²-sp² bonds, which proliferate as ring disorder and lattice distortion increase in sp²-hybridized graphenic structures. Ferrari & Robertson have shown that the G peak red-shifts into this range in Stage II of the amorphization trajectory. In graphene oxide, this red-shifted mode of the G peak may be found alongside the normal G peak, indicating the presence of weaker sp² bonds alongside normal sp² bonds within the lattice. This is in good agreement with the customary interpretation of graphene oxide as a non-uniform lattice with both ring-disordered and ring-ordered regions.

Another feature (referred to as the D′ peak) observed in disordered carbons is fitted at 1620 cm⁻¹, where it may appear as a shoulder on the G peak. This feature is often observed to accompany the D peak in sp²-hybridized carbons with a high density of edge states, and its intensity relative to the D peak has been shown to increase in proximity to lattice edges.

Another feature observed in disordered carbons, sometimes referred to as the D* peak, is a broad band fitted between 1100 cm⁻¹ and 1200 cm⁻¹. A peak intensity value at 1175 cm⁻¹ within this range has been attributed to the sp²-sp³ bonds formed between sp² and sp³ atoms at the transitions between sp² and sp³ networks found within soot. It has also been attributed to hexagonal diamond. The assignment of this peak to sp³ carbon in nanodiamond and diamondlike materials by some researchers has been disputed by Ferrari & Robertson, who provided evidence that it should be assigned, along with a broad peak at ˜1240 cm⁻¹, to trans-polyacetylene, a protonated aliphatic sp² chain arguably present in those carbons.

In the present disclosure, Raman spectral analysis may involve reference to unfitted or fitted spectral features. “Unfitted” spectral features pertain to spectral features apparent prior to deconvolution via profile-fitting software. Unfitted features may therefore represent a convolution of multiple underlying features, but their positions are not subjective. “Fitted” spectral features pertain to the spectral features assigned by profile-fitting software. Imperfect profile fitting indicates the potential presence of other underlying features that have not been deconvoluted.

For clarity, features pertaining to the unfitted Raman profile are labeled with a subscript “u”—e.g. the “Gᵤ” band. In the present disclosure, profile fitting is performed using OMNIC Peak Resolve software to deconvolute features contributing to the overall spectral profile. These fitted features are labeled with an “f”—e.g. the “D_{f}” band. The software's Gaussian-Lorentzian lineshape setting was used by default, allowing a fitted band to adopt a Gaussian and Lorentzian character, with the fractional Gaussian character being determined by the software in order to optimize the fit. Other profile-fitting methods may change the locations, intensities, and trends of fitted peaks.

An additional unfitted feature defined within the present disclosure is the trough (“Tr”), a region of lower Raman intensity values located between the Dᵤ and Gᵤ bands in the overall spectral profile. The Trᵤ intensity is defined as the minimum intensity value occurring between the Dᵤ peak and the Gᵤ peak. The trough intensity value indicates underlying spectral dynamics such as red-shifting of the G band corresponding to ring disorder and lattice distortion and can be analyzed without resorting to subjective profile-fitting judgments, making it a practically useful feature.

Averaged Raman spectra, where utilized herein, represent the average of multipoint spectral measurements made of the sample over a rectangular grid. The distinct point spectra are normalized and then averaged to create a composite spectrum.

X-Ray Diffraction of the carbon powders was performed by EAG Laboratories. XRD data was collected by a coupled Theta:2-Theta scan on a Rigaku Ultima-III diffractometer equipped with copper x-ray tube with Ni beta filter, parafocusing optics, computer-controlled slits, and a D/teX Ultra 1D strip detector. Profile fitting software was used to determine the peak positions and widths.

Thermogravimetric (TGA) analysis of the carbon powders was performed on a TA Instruments Q600 TGA/DSC. Thermal oxidation studies were performed by heating the powder samples in air.

Transmission Electron Microscope (TEM) imaging was performed on an FEI Tecnai F20 operated at 200 kV. A 300mesh Copper Grid with lacey carbon was used. All samples were prepared in ethanol and allowed to dry at room temperature.

Gas adsorption data may be collected by a Micromeritics Tristar II Plus, measuring nitrogen adsorption at 77 K between pressures of 0.005<p/p⁰<0.30, with increments ranging from

$$\frac{p}{{p}^{0}} = 0.009$$

up to

$$\frac{p}{{p}^{0}} = 0.05 .$$

Micromeritics MicroActive software may be used to calculate the BET specific surface area, derived from the BET monolayer capacity assuming the cross-sectional area of 0.162 nm². All samples were preconditioned by degassing with continuously flowing dry nitrogen gas at 100° C. prior to analysis except samples F2 and F3 which were degassed at 200° C. prior to analysis.

The pore size distribution (PSD) and cumulative volume of pores is another technique that may be performed from gas adsorption data to lend insight into the sintering behavior of particles. The data was collected by a Micromeritics Tristar II Plus, measuring nitrogen adsorption and desorption at 77 K between pressures of

$$0.009 < \frac{p}{{p}^{0}} < 0.99 ,$$

with increments ranging from

$$\frac{p}{{p}^{0}} = 0.009$$

up to

$$\frac{p}{{p}^{0}} = 0.05 .$$

Samples were preconditioned by degassing with continuously flowing dry nitrogen gas at 100° C. prior to analysis.

Micromeritics MicroActive software may be used to calculate adsorption-desorption PSD and cumulative volume of pores by applying the Barrett, Joyner and Halenda (BJH) method. This method provides a comparative assessment of mesopore size distributions for gas adsorption data. For all BJH data, the Faas correction and Harkins and Jura thickness curve may be applied. The cumulative volume of pores may be measured for both adsorption and desorption portions of the isotherm.

### VII**. Procedures

The following discussion summarizes the procedures used to complete each study (i.e. Study A through Study G). We generally endeavor to label samples according to the Study with which they are most associated—i.e. Sample A1 is the first sample associated with Study A. Within a single experiment, multiple samples may be evaluated, and multiple procedures may have been performed to create the samples. The procedures and samples are labeled the same—e.g. “Sample B2” is made via “Procedure B2”.

The present disclosure employs exemplary procedure. Other procedures, including those employing pyrolysis of alternative solid- or liquid-state carbonaceous precursor materials, the use of alternative substrates or catalysts, or other basic parameters, might be used as substitutes for those described herein without deviating from the inventive concept. In order to establish the versatility of the method, the mechanics of synthesis, and certain observable trends that might be exploited, a number of exemplary x-carbon synthesis procedures have been performed.

### Procedures—Study A

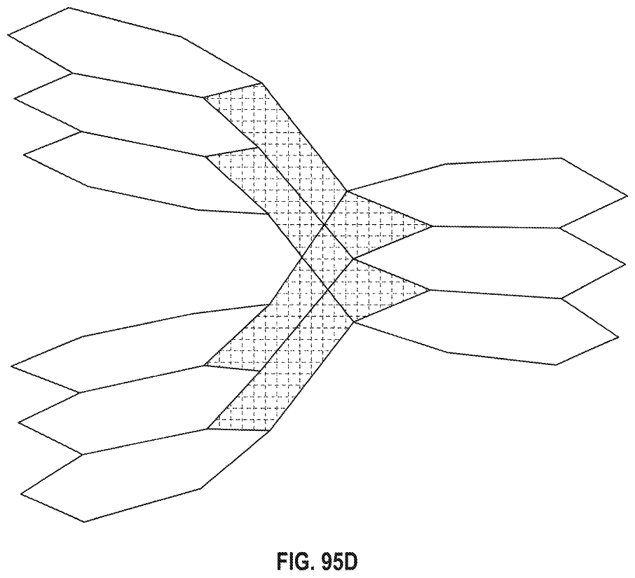

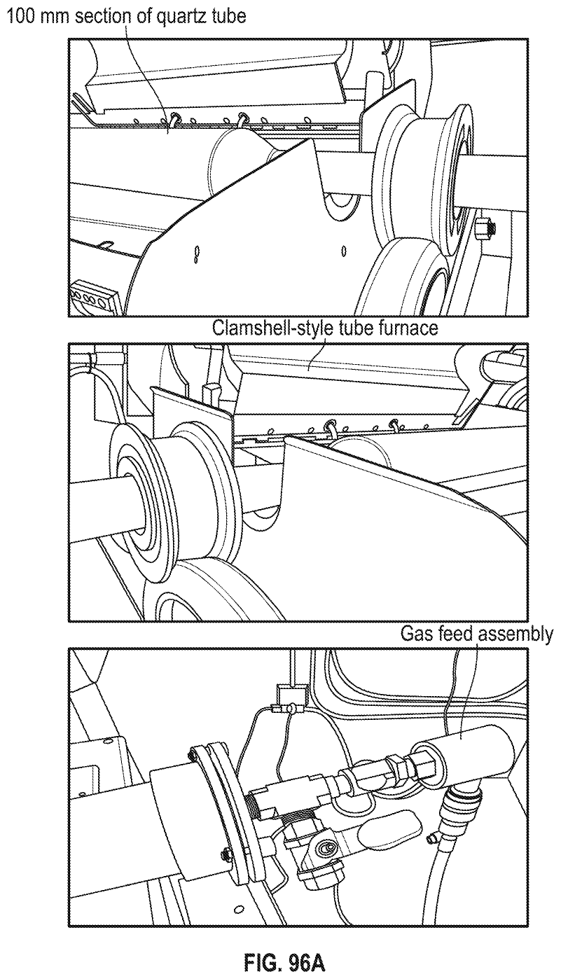

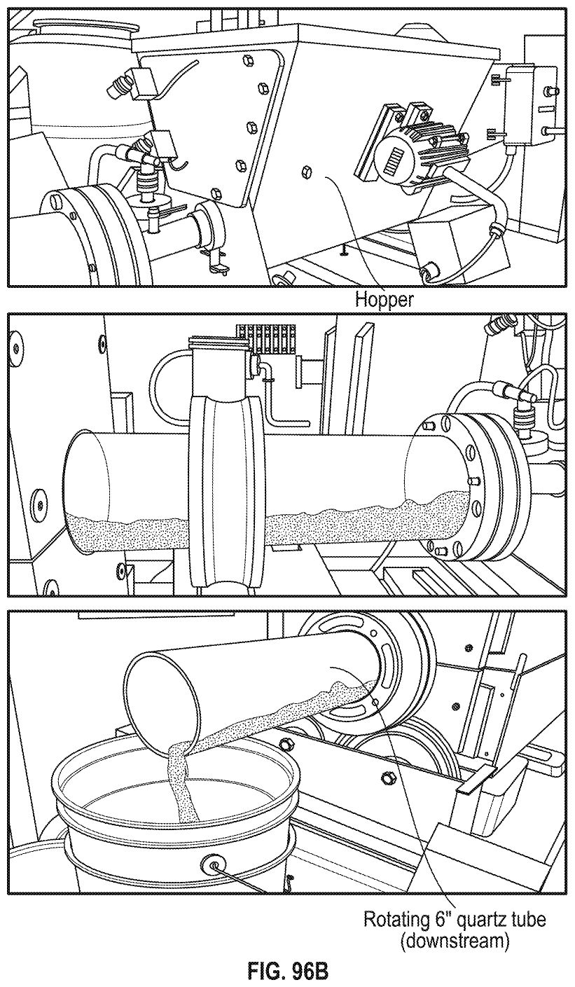

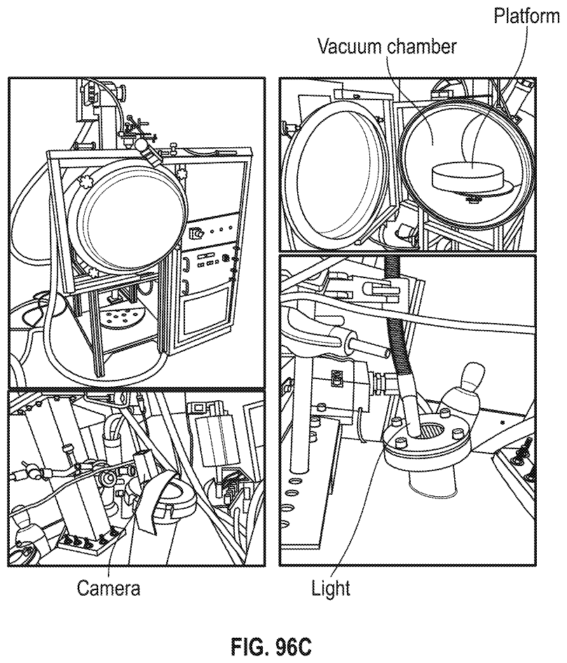

For Procedures A1, A2, and A3, a rotary tube furnace may be employed with a quartz tube. The quartz tube may be a 60 mm OD quartz tube containing a middle 12″ section of 100 mm OD tube (the “belly”) positioned within the furnace's heating zone as shown in FIG. 96A. Quartz baffles inside the belly may facilitate agitation of the powder. The furnace may be kept level (i.e. not tilted). Ceramic blocks may be inserted on each side of the furnace's heating zone (with the powder sample being placed between the blocks and inside the heating zone). Glass wool may be used to fix the position of the ceramic blocks. The powder sample may be placed in the tube without the use of ceramic boats. The tube may be fitted with two stainless steel flanges. Gas may be flowed in through a gas inlet on one flange and out through a gas outlet in the other flange.

For Procedures A4 and A5, a tube furnace may be employed with a quartz tube. The quartz tube may be a 60 mm OD tube. The furnace may be kept level (i.e. not tilted). Ceramic blocks may be inserted on each side of the furnace's heating zone (with the powder sample being placed between the blocks and inside the heating zone). The powder sample may be placed in open ceramic boats inside the tube. The tube may be fitted with two stainless steel flanges. Gas may be flowed in through a gas inlet on one flange and out through a gas outlet in the other flange.

Using the furnace configurations described above, five carbon samples may be synthesized utilizing the following procedures:

Procedure A1: A 500 g sample of “Elastomag 170” (a commercial magnesia powder supplied by Akrochem) magnesium oxide template precursor powder may be loaded into the quartz tube inside the tube furnace's heating zone. The rotary tube furnace may be set to a non-rotating mode. While under 500 sccm flow of argon (Ar) gas, the furnace may be heated from room temperature to a temperature setting of 1,050° C. over 50 minutes. Under sustained Ar gas flow, the furnace may then be allowed to cool to 750° C. over the next 30 minutes. During this period, the MgO template precursor morphology may be changed due to calcination into the desired template morphology. This condition may be held for an additional 30 minutes, after which a 250 sccm flow of propylene (C₃H₆) gas may be initiated, while holding the Ar flow unchanged, and this condition may be held for 60 minutes. The C₃H₆ flow may then be discontinued and the furnace allowed to cool to room temperature under sustained Ar flow. At this point, the C@MgO perimorphic composite powder as synthesized may be analyzed via Raman spectroscopy or thermogravimetric analysis (TGA). The MgO template may then be selectively extracted from the C@MgO perimorphic composite powder by acid-etching with hydrochloric acid (HCl) under magnetic stirring conditions, resulting in a mixture of carbon in an aqueous MgCl₂ solution. The carbon may then be filtered from the solution, rinsed with deionized water three times, and dried to form a carbon powder. A carbon powder made via such a procedure is herein referred to as “Sample A1.”

Procedure A2: A 500 g sample of Elastomag 170 (a commercial magnesia powder supplied by Akrochem) magnesium oxide (MgO) template precursor powder may be loaded into the quartz tube inside the tube furnace's heating zone. The rotary tube furnace may be set to a non-rotating mode. While under 500 sccm flow of Ar gas, the furnace may be heated from room temperature to a temperature setting of 1,050° C. over 50 minutes, and then held at this condition for 30 minutes. During this period, the MgO template precursor morphology may be changed due to calcination into the template morphology desired. Next, a 500 sccm flow of methane (CH₄) gas may be initiated while holding Ar flow unchanged, and this condition may be held for 30 minutes. The CH₄ flow may then be discontinued and the furnace allowed to cool to room temperature under sustained Ar flow. At this point in the procedure, the C@MgO perimorphic composite powder as synthesized may be analyzed via Raman spectroscopy or thermogravimetric analysis (TGA). The MgO template may then be selectively extracted from the C@MgO perimorphic composite powder by acid-etching with HCl under magnetic stirring conditions, resulting in a mixture of carbon in an aqueous MgCl₂ solution. The carbon may then be filtered from the solution, rinsed with deionized water three times, and dried to form a carbon powder. A carbon powder made via such a procedure is herein referred to as “Sample A2.”

Procedure A3: An MgO powder may be generated by calcining Light Magnesium Carbonate (a commercial hydromagnesite powder supplied by Akrochem) for 2 hours at a temperature of 1,050° C. for 2 hours. A 300 g sample of the pre-calcined powder may be loaded into the quartz tube inside the tube furnace's heating zone. The rotary tube furnace may be set to rotate at 2.5 RPM. While under 500 seem flow of Ar gas, the furnace may be heated from room temperature to a temperature setting of 650° C. over 30 minutes, and then held at this condition for 30 minutes. Next, a 270 seem flow of C₃H₆ gas may be initiated while holding Ar flow unchanged, and this condition may be held for 60 minutes. The C₃H₆ flow may then be discontinued and the furnace allowed to cool to room temperature under sustained Ar flow. At this point in the procedure, the C@MgO perimorphic composite powder as synthesized may be analyzed via Raman spectroscopy or thermogravimetric analysis (TGA). The MgO template may then be selectively extracted from the C@MgO perimorphic composite powder by acid-etching with HCl under magnetic stirring conditions, resulting in a mixture of carbon in an aqueous MgCl₂ solution. The carbon may then be filtered from the solution, rinsed with deionized water three times, and dried to form a carbon powder. A carbon powder made via such a procedure is herein referred to as “Sample A3.”

### Procedures—Study B

For Procedures B1-B3, an MgO powder may be generated by calcining a template precursor powder comprising rhombohedral magnesite (MgCO₃) crystals. The precursor powder may be calcined in a Vulcan 3-550 Muffle Furnace at a temperature of 580° C. for an hour followed by 1,050° C. for 3 hours with heating ramp rates of 5° C./min.

For Procedure B4, an MgO powder may be generated by calcining a template precursor powder comprising light magnesium carbonate crystals. The precursor powder may be calcined in a Vulcan 3-550 Muffle Furnace at a temperature of 750° C. for an hour with a heating ramp rate of 5° C./min.

For Procedures B1-B3, an MTI rotary tube furnace may be employed with a quartz tube. The quartz tube may be a 60 mm OD quartz tube containing a middle 12″ section of 100 mm OD tube (the “belly”) positioned within the furnace's heating zone as shown in FIG. 96A. Quartz baffles inside the belly may facilitate agitation of the powder. The furnace may be kept level (i.e. not tilted). Ceramic blocks may be inserted on each side of the furnace's heating zone (with the powder sample being placed between the blocks and inside the heating zone). Glass wool may be used to fix the position of the ceramic blocks. The powder sample may be placed in the tube without the use of ceramic boats. The tube may be fitted with two stainless steel flanges. Gas may flowed in through a gas inlet on one flange and out through a gas outlet in the other flange.

For Procedure B4, a tube furnace may be employed with a quartz tube. The quartz tube may be a 60 mm OD tube. The furnace may be kept level (i.e. not tilted). Ceramic blocks may be inserted on each side of the furnace's heating zone (with the powder sample being placed between the blocks and inside the heating zone). The powder sample may be placed in open ceramic boats inside the tube. The tube may be fitted with two stainless steel flanges. Gas may be flowed in through a gas inlet on one flange and out through a gas outlet in the other flange.

Procedure B1: The CVD procedure may be performed for 16 hours at a temperature of 640° C. under flowing gas conditions. The flowing gas may comprise 1,220 sccm CO₂ and 127 sccm C₃H₆. The quartz tube may be rotated at 1 rpm. After cooling the resulting C@MgO powder to room temperature under flowing CO₂, the MgO template may be selectively extracted from the C@MgO perimorphic composite powder by acid-etching with HCl under magnetic stirring conditions, resulting in a mixture of carbon in an aqueous MgCl₂ solution. The carbon may then be filtered from the solution, rinsed with deionized water three times, and dried to form a carbon powder. A carbon powder made via such a procedure is herein referred to as “Sample B1.”

Procedure B2: The CVD procedure may be performed for 20 hours at a temperature of 580° C. under flowing gas conditions. The flowing gas may comprise 1,220 sccm CO₂ and 127 sccm C₃H₆. The quartz tube may be rotated at 1 rpm. After cooling the resulting C@MgO powder to room temperature under flowing CO₂, the MgO template may be selectively extracted from the C@MgO perimorphic composite powder by acid-etching with HCl under magnetic stirring conditions, resulting in a mixture of carbon in an aqueous MgCl₂ solution. The carbon may then be filtered from the solution, rinsed with deionized water three times, and dried to form a carbon powder. A carbon powder made via such a procedure is herein referred to as “Sample B2.”

Procedure B3: The CVD procedure may be performed for 32.5 hours at a temperature of 540° C. under flowing gas conditions. The flowing gas may comprise 1,220 sccm CO₂ and 127 sccm C₃H₆. The quartz tube may be rotated at 1 rpm. After cooling the resulting C@MgO powder to room temperature under flowing CO₂, the MgO template may be selectively extracted from the C@MgO perimorphic composite powder by acid-etching with HCl under magnetic stirring conditions, resulting in a mixture of carbon in an aqueous MgCl₂ solution. The carbon may then be filtered from the solution, rinsed with deionized water three times, and dried to form a carbon powder. A carbon powder made via such a procedure is herein referred to as “Sample B3.”

Procedure B4: The CVD procedure may be performed for 1 hour at a temperature of 580° C. under flowing gas conditions. The flowing gas may comprise 1,138 sccm CO₂ and 276 sccm C₂H₂. After cooling the resulting C@MgO powder to room temperature under flowing CO₂, the MgO template may be selectively extracted from the C@MgO perimorphic composite powder by acid-etching with HCl under magnetic stirring conditions, resulting in a mixture of carbon in an aqueous MgCl₂ solution. The carbon may then be filtered from the solution, rinsed with deionized water three times, and dried to form a carbon powder. A carbon powder made via such a procedure is herein referred to as “Sample B4.”

### Procedures—Study C

For Procedures C₁ and C₂, an MgO powder may be generated by treating a template precursor powder comprising sodium doped elongated nesquehonite template precursor crystals. The sodium doped nesquehonite template precursor may be precipitated from a solution stock of magnesium bicarbonate solution. First, in a 57 liter pressure vessel a mixture of concentration 0.62 mol kg⁻¹ Mg comprised of magnesium hydroxide (Akrochem Versamag) and deionized water may be prepared. This mixture may be recirculated while carbonated with CO₂ up to 60 psig to form a solution stock of magnesium bicarbonate (Mg(HCO₃)₂). After approximately 22 hours, the solution may be filtered to remove undissolved solids. The resulting solution stock may have a concentration of 0.29 mol kg⁻¹ Mg. Then, sodium bicarbonate (NaHCO₃) may be added to the solution stock to bring the concentration of sodium in the system to 1.7·10⁻³ mol kg⁻¹Na. Additional CO₂ may be added to the vessel for 20 minutes to digest any unwanted precipitant. The system may be heated up to 34° C. and depressurized to allow for crystallization over 25.5 hours. The mixture generated from crystallization of sodium doped elongated nesquehonite template precursor crystals may then be filtered, rinsed with deionized water and acetone, and dried in a 45° C. in a forced air recirculation oven. The template precursor may be used as is in the CVD Replication step and conversion to MgO occurs in-situ during the heating ramp stage.

For Procedures C1 and C2, a tube furnace may be employed with a quartz tube. The quartz tube may be a 60 mm OD tube. The furnace may be kept level (i.e. not tilted). Ceramic blocks may be inserted on each side of the furnace's heating zone (with the powder sample being placed between the blocks and inside the heating zone). The powder sample may be placed in open ceramic boats inside the tube. The tube may be fitted with two stainless steel flanges. Gas may be flowed in through a gas inlet on one flange and out through a gas outlet in the other flange.

Procedure C1: A 1.6 g sample of sodium doped elongated nesquehonite template precursor may be loaded into the quartz tube inside a tube furnace's heating zone. While under 1271 sccm flow of Ar gas, the furnace may be heated from room temperature to a temperature setting of 460° C. over 20 minutes, and then held at this condition for 15 minutes to equilibrate. Next, a 42 sccm flow of C₂H₂ gas may be initiated while holding Ar flow unchanged, and this condition may be held for 3 hours. The C₂H₂ flow may then be discontinued and the furnace allowed to cool to room temperature under sustained Ar flow with the resulting C@MgO powder may be collected. The MgO template may be selectively extracted from the C@MgO perimorphic composite powder by acid-etching with HCl under magnetic stirring conditions, resulting in a mixture of carbon in an aqueous MgCl₂ solution. The carbon may then be filtered from the solution, rinsed with deionized water three times, and dried to form a carbon powder. A carbon powder made via such a procedure is herein referred to as “Sample C1.”

Procedure C2: A 1.9 g sample of sodium doped elongated nesquehonite template precursor may be loaded into the quartz tube inside a tube furnace's heating zone. While under 1,271 sccm flow of Ar gas, the furnace may be heated from room temperature to a temperature setting of 400° C. over 20 minutes, and then held at this condition for 15 minutes to equilibrate. Next, a 105 sccm flow of C₂H₂ gas may be initiated while holding Ar flow unchanged, and this condition may be held for 3 hours. The C₂H₂ flow may then be discontinued and the furnace allowed to cool to room temperature under sustained Ar flow with the resulting C@MgO powder may be collected. The MgO template may be selectively extracted from the C@MgO perimorphic composite powder by acid-etching with HCl under magnetic stirring conditions, resulting in a mixture of carbon in an aqueous MgCl₂ solution. The carbon may then be filtered from the solution, rinsed with deionized water three times, and dried to form a carbon powder. A carbon powder made via such a procedure is herein referred to as “Sample C2.”

### Procedures—Study D

For Procedures D1 and D2, an MgO powder may be generated by calcining a template precursor powder comprising light magnesium carbonate crystals. The precursor powder may be calcined in a Vulcan 3-550 Muffle Furnace at a temperature of 750° C. for an hour with a heating ramp rate of 5° C./min.

For Procedures D1 and D2, a tube furnace may be employed with a quartz tube. The quartz tube may be a 60 mm OD tube. The furnace may be kept level (i.e. not tilted). Ceramic blocks may be inserted on each side of the furnace's heating zone (with the powder sample being placed between the blocks and inside the heating zone). The powder sample may be placed in open ceramic boats inside the tube. The tube may be fitted with two stainless steel flanges. Gas may be flowed in through a gas inlet on one flange and out through a gas outlet in the other flange.

Procedure D1: A 0.9 g sample of a magnesium oxide template precursor may be loaded into the quartz tube inside a tube furnace's heating zone. While under 1,271 sccm flow of Ar gas, the furnace may be heated from room temperature to a temperature setting of 700° C. over 30 minutes, and then held at this condition for 15 minutes to equilibrate. Next, a 20 sccm flow of C₃H₆ gas may be initiated while holding Ar flow unchanged, and this condition may be held for 30 minutes. The C₃H₆ flow may then be discontinued and the furnace allowed to cool to room temperature under sustained Ar flow with the resulting C@MgO powder may be collected. The MgO template may be selectively extracted from the C@MgO perimorphic composite powder by acid-etching with HCl under magnetic stirring conditions, resulting in a mixture of carbon in an aqueous MgCl₂ solution. The carbon may then be filtered from the solution, rinsed with deionized water three times, and dried to form a carbon powder. A carbon powder made via such a procedure is herein referred to as “Sample D1.”

Procedure D2: A 0.9 g sample of a magnesium oxide template precursor may be loaded into the quartz tube inside a tube furnace's heating zone. While under 1,271 sccm flow of argon (Ar) gas, the furnace may be heated from room temperature to a temperature setting of 700° C. over 30 minutes, and then held at this condition for 15 minutes to equilibrate. Next, a combination of 20 sccm flow of propylene (C₃H₆) gas along with 60 sccm of hydrogen (H₂) gas may be initiated while holding Ar flow unchanged, and this condition may be held for 30 minutes. The C₃H₆ flow may then be discontinued and the furnace allowed to cool to 150° C. under sustained Ar and H₂ flow. The H₂ flow may be discontinued below 150° C. and the furnace was allowed to cool to room temperature and the resulting C@MgO powder may be collected. The MgO template may be selectively extracted from the C@MgO perimorphic composite powder by acid-etching with HCl under magnetic stirring conditions, resulting in a mixture of carbon in an aqueous MgCl₂ solution. The carbon may then be filtered from the solution, rinsed with deionized water three times, and dried to form a carbon powder. A carbon powder made via such a procedure is herein referred to as “Sample D2.”

### Procedures—Study E

For Procedures E1 and E2 an MgO powder may be generated by calcining Light Magnesium Carbonate (a commercial hydromagnesite powder supplied by Akrochem) in a rotating kiln in 2 stages in an air atmosphere as shown in FIG. 96B. The first stage of thermal treatment may be performed at 400° C. for a powder residence time of 9 minutes followed by a second stage thermal treatment at 750° C. at a powder residence time of 3 minutes.

For Procedures E1A and E2A a tube furnace may be employed with a quartz tube. An MTI rotary tube furnace with a 60 mm OD quartz tube may be employed for CVD. The furnace may be kept level (i.e. not tilted). Ceramic blocks may be inserted on each side of the furnace's heating zone (with the powder sample being placed between the blocks and inside the heating zone). Glass wool may be used to fix the position of the ceramic blocks. The tube may be fitted with two stainless steel flanges. Gas may be flowed in through a gas inlet on one flange and out through a gas outlet in the other flange. Powder samples may be placed in ceramic boats, and the boats may be placed in the heating zone prior to initiating the procedure. For Procedures E2 and E4 a similar setup may be employed with minor modifications to allow rapid heating and/or cooling of the samples. These modifications will be described in their respective exemplary procedures.

Procedure E1: A 50 mm OD quartz tube, serving as a boat, containing 62 grams of this pre-calcined MgO powder may be loaded into the tube. After initiating a 2,000 sccm flow of Ar gas, the furnace may be heated from room temperature to a temperature setting of 700° C. over 20 minutes and held at this condition for 15 minutes. Next, a 1,274 sccm flow of C₃H₆ gas may be initiated while maintaining Ar flow, and this condition may be held for 30 minutes. The C₃H₆ flow may then be discontinued and the furnace allowed to cool to room temperature under sustained Ar flow. The C@MgO perimorphic composite powder may be collected.

The MgO template may be selectively extracted from the C@MgO perimorphic composite powder by acid-etching with HCl under magnetic stirring conditions, resulting in a mixture of carbon in an aqueous MgCl₂ solution. The carbon may then be filtered from the solution, rinsed with deionized water three times, and dried to form a carbon powder. A carbon powder made via such a procedure is herein referred to as “Sample E1.”

Procedure E1A: This procedure involves rapidly heating and cooling a perimorphic composite material from room temperature to the desired temperature setting. In a ceramic boat, a 3.0 g quantity of the perimorphic composite powder described in Procedure E1 may be loaded and placed in a quartz tube outside the heated zone of the furnace. After initiating a 4,000 sccm flow of Ar gas, the furnace may be heated from room temperature to a temperature setting of 900° C. over 45 minutes and held at this condition for 15 minutes. Until the temperature setting has been achieved the sample may be kept outside the heat zone. Once the desired temperature has been attained the boat is pushed in with the introduction of minimal additional air and left in the heat zone for 30 minutes followed by moving it back outside the heat zone in the quartz tube. This may serve to expose the sample to the desired temperature only for a short period of time. The furnace may be allowed to cool to room temperature under sustained Ar flow. The C@MgO perimorphic composite powder may be collected at room temperature.

The MgO template may be selectively extracted from the C@MgO perimorphic composite powder by acid-etching with HCl under magnetic stirring conditions, resulting in a mixture of carbon in an aqueous MgCl₂ solution. The carbon may then be filtered from the solution, rinsed with deionized water three times, and dried to form a carbon powder. A carbon powder made via such a procedure is herein referred to as “Sample E1A.”

Procedure E2: A 50 mm OD quartz tube, serving as a boat, containing 74 grams of this pre-calcined MgO powder may be loaded into the tube. After initiating a 2,000 sccm flow of Ar gas, the furnace may be heated from room temperature to a temperature setting of 580° C. over 20 minutes and held at this condition for 15 minutes. Next, a 1,274 sccm flow of C₃H₆ gas may be initiated while maintaining Ar flow, and this condition may be held for 3 hours. The C₃H₆ flow may then be discontinued and the furnace allowed to cool to room temperature under sustained Ar flow. The C@MgO perimorphic composite powder may be collected.

The MgO template may be selectively extracted from the C@MgO perimorphic composite powder by acid-etching with HCl under magnetic stirring conditions, resulting in a mixture of carbon in an aqueous MgCl₂ solution. The carbon may then be filtered from the solution, rinsed with deionized water three times, and dried to form a carbon powder. A carbon powder made via such a procedure is herein referred to as “Sample E2.”

Procedure E₂A: This procedure involves gradually heating and rapidly cooling a perimorphic composite material from room temperature to the desired temperature setting and back to room temperature again. In a ceramic boat, a 3.0 g quantity of the perimorphic composite powder described in Procedure E3 may be loaded and placed in a quartz tube in the heated zone of the furnace. After initiating a 4,000 sccm flow of Ar gas, the furnace may be heated from room temperature to a temperature setting of 1,050° C. over 50 minutes and held at this condition for 15 minutes. The furnace may be held at this temperature for an hour. The furnace may then be allowed to start to cool under sustained Ar flow and the ceramic boat may be pulled out of the heat zone as soon as the heaters power off. The C@MgO perimorphic composite powder post may be collected once at room temperature.

The MgO template may be selectively extracted from the C@MgO perimorphic composite powder by acid-etching with HCl under magnetic stirring conditions, resulting in a mixture of carbon in an aqueous MgCl₂ solution. The carbon may then be filtered from the solution, rinsed with deionized water three times, and dried to form a carbon powder. A carbon powder made via such a procedure is herein referred to as “Sample E2A.”

### Procedures—Study F

For Procedures F1, an MgO powder may be generated by calcining a template precursor powder comprising light magnesium carbonate crystals. The precursor powder may be calcined in a Vulcan 3-550 Muffle Furnace at a temperature of 750° C. for an hour with a heating ramp rate of 5° C./min.

For Procedure F1, a Thermcraft tube furnace modified to be a rotary furnace may be employed with a quartz tube. The quartz tube may be a 60 mm OD quartz tube containing an expanded middle 577 mm section of 130 mm OD tube (the “belly”) positioned within the furnace's heating zone. Quartz baffles inside the belly may facilitate agitation of the powder. The furnace may be kept level (i.e. not tilted). The template sample may be placed inside the belly in the heating zone, with ceramic blocks inserted outside the belly on each side of the furnace's heating zone. Glass wool may be used to fix the position of the ceramic blocks. The template sample may be placed in the tube without the use of ceramic boats such that it allowed to rotate freely within the belly. The tube may be fitted with two stainless steel flanges. Gas may be flowed in through a gas inlet on one flange and out through a gas outlet in the other flange.

For Procedures F2, F3, F4, F5, F6 and F7 a tube furnace may be employed with a quartz tube. An MTI rotary tube furnace with a 60 mm OD quartz tube may be employed for CVD. The furnace may be kept level (i.e. not tilted). Ceramic blocks may be inserted on each side of the furnace's heating zone (with the powder sample being placed between the blocks and inside the heating zone). Glass wool may be used to fix the position of the ceramic blocks. The tube may be fitted with two stainless steel flanges. Gas may be flowed in through a gas inlet on one flange and out through a gas outlet in the other flange. Powder samples may be placed in ceramic boats, and the boats may be placed in the heating zone prior to initiating the procedure.

Procedure F1 and F2: A 150 g quantity of a magnesium oxide template powder may be loaded into the belly of the quartz tube. After initiating a 1,379 seem flow of CO₂ gas and a tube rotation speed of 1 RPM, the furnace may be heated from room temperature to a temperature setting of 580° C. at a ramp-rate of 20° C./min and held at this condition for 15 minutes. Next, a 276 seem flow of C₂H₂ gas may be initiated while maintaining CO₂ flow, and this condition may be held for 180 minutes. The C₂H₂ flow may then be discontinued and the furnace allowed to cool to room temperature under sustained CO₂ flow. The powder may be collected. The C@MgO perimorphic composite powder may be further processed to create a carbon powder. The MgO template may be selectively extracted from the C@MgO perimorphic composite powder by acid-etching with HCl under magnetic stirring conditions, resulting in a mixture of carbon in an aqueous MgCl₂ solution. The carbon may then be filtered from the solution, rinsed with deionized water three times, further rinsed with ethanol three times and dried to obtain a carbon powder herein referred to as “Sample F1”.

A 50 mg quantity of the Sample F1 carbon powder may be compacted in a 7 mm die set (Pike Technologies 161-1010) under 105 ksi hydraulic pressure. Under pressure the carbon may form a pellet herein referred to as “Sample F2” that may be stable enough to handle.

Procedure F3: Sample F2 may be placed in a ceramic boat and loaded into the quartz tube of a furnace. After initiating a 4,000 sccm flow of Ar gas, the furnace may be heated from room temperature to a temperature setting of 1,050° C. over 50 minutes and held at this condition for 30 minutes. The furnace may then be allowed to cool to room temperature under sustained Ar flow. The pellet may be collected once at room temperature and is herein referred to as “Sample F3”.

Procedure F4: A 100 mg quantity of Sample F1 powder may be placed in a ceramic boat and loaded into the quartz tube of a furnace. After initiating a 4,000 sccm flow of Ar gas, the furnace may be heated from room temperature to a temperature setting of 1050° C. over 50 minutes and held at this condition for 30 minutes. The furnace may then be allowed to cool to room temperature under sustained Ar flow. The powder may be collected once at room temperature.

A 50 mg quantity of this powder may then be compacted in a 7 mm die set (Pike Technologies 161-1010) under 105 ksi hydraulic pressure. Under pressure the perimorphic carbon frameworks do not form a pellet and remain a powder, herein referred to as Sample F4.

Procedure F5: A potassium carbonate (K₂CO₃) template precursor may be spray dried using an Sinoped LPG-5 spray dryer. A room temperature solution composed of 250.35 g of K₂CO₃ and 1,667.2 g of deionized water (DI) was pumped at a rate of 23 mL/min into a rotary atomizer set to 24,000 RPM. The inlet temperature of the spray dryer was set to 195° C., which produced an outlet temperature of 139° C. The powder collected after spray drying was a K₂CO₃ template precursor.

A 100 g quantity of this K₂CO₃ template precursor powder may be loaded into a ceramic boat and placed in a quartz tube to generate a perimorphic composite powder using an MTI tube furnace. After initiating a 1,220 sccm flow of CO₂ gas, the furnace may be heated from room temperature to a temperature setting of 640° C. at a ramp-rate of 20° C./min and held at this condition for 15 minutes. Next, a 162 sccm flow of C₃H₆ gas may be initiated while maintaining CO₂ flow, and this condition may be held for 2 minutes. The C₃H₆ flow may then be discontinued and the furnace allowed to purge with Ar at a flow rate of 2,000 sccm for 30 minutes to clear all the CO₂ present in the tube. The furnace may then be cooled to room temperature under sustained Ar flow. The powder may be collected. The C@K₂CO₃ perimorphic composite powder may be further processed to create a carbon powder. The K₂CO₃ template may be selectively extracted from the C@K₂CO₃ perimorphic composite powder by acid-etching with HCl under magnetic stirring conditions, resulting in a mixture of carbon in an aqueous KCl₂ solution. The carbon may then be filtered from the solution, rinsed with deionized water three times to obtain an aqueous paste. This paste may be rinsed three times with ethanol to obtain an ethanol paste.

An ethanol paste of this carbon may be diluted with additional ethanol to create a very dilute mixture of 0.003 wt % carbon. This mixture may then be agitated with a high shear rotor stator homogenization processor, IKA T-25 digital Ultra-Turrax (UT), run at 12,000 RPM for 5 minutes. The mixture after agitation may be immediately poured over a glass frit vacuum filtration setup having a 47 mm diameter nylon filter (0.45 m pore size) as the filtration medium. The vacuum filtration may be allowed to proceed undisturbed until all the liquid has been drained out. The vacuum is turned off and the filter with carbon may be dried in air in the vacuum filtration setup itself. Once dry, a flexible vdW assembly may release itself from the filter. This vdW assembly is herein referred to as “Sample F5”.

Procedure F6: Sample F5 may be placed in a ceramic boat and loaded into the quartz tube of a furnace. After initiating a 4,000 sccm flow of Ar gas, the furnace may be heated from room temperature to a temperature setting of 1,050° C. over 50 minutes and held at this condition for 30 minutes. The furnace may then be allowed to cool to room temperature under sustained Ar flow. The assembly may be collected once at room temperature and is herein referred to as “Sample F6”.

Procedure F7: Nesquehonite (MgCO₃·3H₂O) may be precipitated from lansfordite (MgCO₃·5H₂O) to produce elongated particles. A 45 g/L MgO equivalent magnesium bicarbonate (Mg(HCO₃)₂) solution may be prepared by high pressure dissolution of magnesium hydroxide (Akrochem Versamag) in carbonic acid at 720 psig. Lansfordite may be precipitated from this magnesium bicarbonate solution in a continuously stirred tank reactor (CSTR). The solution may be chilled to ˜14° C. and depressurized from 720 psig to 0 psig over 5 minutes while agitated at ˜700 RPM with a down pumping marine style impeller. Air may be continuously purged through the headspace at 4 SCFMₐᵢᵣ while chilled to ˜12° C. for 8 hrs. The solution may be allowed to stir at ˜350 RPM for an additional 18.5 hrs. The CSTR may then be heated to 34.5° C. while stirred at ˜720 RPM for 82 minutes. The solution may then be diluted with approximately 5 L of deionized water while continued heating to 43.8° C. for an additional 61 minutes. The contents of the CSTR may then by removed, filtered, and dried in a forced air circulation oven at 40° C. The resulting powder, identified herein as N₂, are acicular crystals of nesquehonite.

An MgO powder may be generated by calcining N₂ at 640° C. for 2 hours in an N₂ gas flow of 2,000 sccm with a heating ramp-rate of 5° C./min in an MTI tube furnace with a 60 mm dia. quartz tube. A 2.4 g quantity of this MgO powder may be loaded into a ceramic boat and placed in the quartz tube to generate C@MgO using an MTI tube furnace. After initiating a 815 sccm flow of CO₂ gas, the furnace may be heated from room temperature to a temperature setting of 540° C. at a ramp-rate of 5° C./min and held at this condition for 15 minutes. Next, a 812 seem flow of C₂H₂ gas may be initiated while maintaining CO₂ flow, and this condition may be held for 2 minutes. The C₂H₂ flow may then be discontinued and the furnace allowed to purge with Ar at a flow rate of 1,698 sccm for 30 minutes to clear all the CO₂ present in the tube. The furnace may then be heated to 900° C. at a ramp-rate of 20° C./min and held at this condition for 30 minutes. The furnace may then be cooled to room temperature under sustained Ar flow. The powder may be collected. The C@MgO perimorphic composite powder may be further processed to create a carbon powder. The MgO template may be selectively extracted from the C@MgO perimorphic composite powder by acid-etching with HCl under magnetic stirring conditions, resulting in a mixture of carbon in an aqueous MgCl₂ solution. The carbon may then be filtered from the solution, rinsed with deionized water three times to obtain an aqueous paste. This paste may be rinsed three times with ethanol to obtain an ethanol paste.

An ethanol paste of this carbon may be diluted with additional ethanol to create a very dilute mixture of 0.003 wt % carbon. This mixture may then be agitated with a high shear rotor stator homogenization processor, IKA T-25 digital Ultra-Turrax (UT), run at 12,000 RPM for 5 minutes. The mixture after agitation may be immediately poured over a glass frit vacuum filtration setup having a 47 mm diameter nylon filter (0.45 m pore size) as the filtration medium. The vacuum filtration may be allowed to proceed undisturbed until all the liquid has been drained out. The vacuum is turned off and the filter with carbon may be dried in air in the vacuum filtration setup itself. Once dry, a cohesive flexible buckypaper may release itself from the filter, herein referred to as “Sample F7.”

### Procedures—Study G

Procedure G₁: Magnesite (MgCO₃) particles may be crystallized from a solution of magnesium bicarbonate to yield a powder of equiaxed template precursor particles.

An MTI rotary tube furnace may be employed with a quartz tube. The quartz tube may be a 60 mm OD quartz tube containing a middle 12″ section of 100 mm OD tube positioned within the furnace's heating zone. Quartz baffles inside the belly may facilitate agitation of the powder. The furnace may be kept level (i.e. not tilted). Ceramic blocks may be inserted on each side of the furnace's heating zone (with the powder sample being placed between the blocks and inside the heating zone). Glass wool may be used to fix the position of the ceramic blocks. The tube may be fitted with two stainless steel flanges. Gas may be flowed in through a gas inlet on one flange and out through a gas outlet in the other flange.

A 177 g quantity of the precipitated magnesite powder may be calcined to MgO at 640° C. for 10 min under Ar flow of 5 ft³/hr with heating ramp-rate of 20° C./min. The MgO powder already present in the quartz tube may be used to generate C@MgO using the furnace described. After initiating a 1,918 sccm flow of CO₂ gas and a tube rotation speed of 1 RPM, the furnace may be heated from room temperature to a temperature setting of 640° C. at a ramp-rate of 20° C./min and held at this condition for 15 minutes. Next, a 127 sccm flow of C₃H₆ gas may be initiated while maintaining CO₂ flow, and this condition may be held for 360 minutes. The C₃H₆ flow may then be discontinued and the furnace allowed to cool to room temperature under sustained CO₂ flow.

The C@MgO perimorphic composite powder may be placed back in the tube in the same identical furnace/tube configuration for a second growth cycle. After initiating a 1,918 sccm flow of CO₂ gas and a tube rotation speed of 1 RPM, the furnace may be heated from room temperature to a temperature setting of 640° C. at a ramp-rate of 20° C./min and held at this condition for 15 minutes. Next, a 127 sccm flow of C₃H₆ gas may be initiated while maintaining CO₂ flow, and this condition may be held for 120 minutes. The C₃H₆ flow may then be discontinued and the furnace allowed to cool to room temperature under sustained CO₂ flow.

The C@MgO perimorphic composite powder may be placed back in the tube in the same identical furnace/tube configuration for a third growth cycle. After initiating a 1,918 sccm flow of CO₂ gas and a tube rotation speed of 1 RPM, the furnace may be heated from room temperature to a temperature setting of 640° C. at a ramp-rate of 20° C./min and held at this condition for 15 minutes. Next, a 127 sccm flow of C₃H₆ gas may be initiated while maintaining CO₂ flow, and this condition may be held for 180 minutes. The C₃H₆ flow may then be discontinued and the furnace allowed to cool to room temperature under sustained CO₂ flow.

The powder may be collected. The C@MgO perimorphic composite powder may be further processed to create a carbon powder. The MgO template may be selectively extracted from the C@MgO perimorphic composite powder by acid-etching with HCl under magnetic stirring conditions, resulting in a mixture of carbon in an aqueous MgCl₂ solution. The carbon may then be filtered from the solution, rinsed with deionized water three times followed by a triple rinse with ethanol to obtain an ethanol paste. This paste may be dried to form a carbon powder.

This carbon powder may then be utilized for further CVD growth. An MTI rotary tube furnace may be employed with a quartz tube. The quartz tube may be a 60 mm OD quartz tube containing a middle 12″ section of 100 mm OD tube positioned within the furnace's heating zone. Quartz baffles inside the belly may facilitate agitation of the carbon powder. The furnace may be kept level (i.e. not tilted). Ceramic blocks may be inserted on each side of the furnace's heating zone (with the powder sample being placed between the blocks and inside the heating zone). Glass wool may be used to fix the position of the ceramic blocks. The tube may be fitted with two stainless steel flanges. Gas may be flowed in through a gas inlet on one flange and out through a gas outlet in the other flange. This assembly is shown in FIG. 96A.

After initiating a 1,918 sccm flow of CO₂ gas and a tube rotation speed of 1 RPM, the furnace may be heated from room temperature to a temperature setting of 640° C. at a ramp-rate of 20° C./min and held at this condition for 15 minutes. Next, a 127 sccm flow of C₃H₆ gas may be initiated while maintaining CO₂ flow, and this condition may be held for 180 minutes. The C₃H₆ flow may then be discontinued and the furnace allowed to cool to room temperature under sustained CO₂ flow. The final mass of carbon powder collected, net of losses from migration into the glass wool, may be approximately 43.2 g. The carbon powder made via this procedure is herein referred to as “Sample G_{1.”}

### Procedures—Study H

Procedure H: An aqueous Mg(HCO₃)₂ solution may be produced by mixing 16 kg deionized water and 1.39 kg of a commercial-grade MgO powder (Versamag) in a pressure vessel equipped with an overhead stirring system and gas-inducing impeller. The mixture may be mixed at 700 RPM and cooled to 5° C. while being fed CO₂ gas up to 850 psi for 2 hours. The resulting solution may be withdrawn from the pressure vessel at atmospheric pressure and fed at a rate of 56 mL/min into a BETE XA air atomizing nozzle comprising an FC7 Fluid Cap and AC1802 Air Cap. Compressed air for droplet atomization may be delivered into the nozzle at a flow rate of 5 SCFH air at 54 psi. The inlet temperature of the spray dryer may be set to 200° C., producing an outlet temperature ranging between 108° C. and 109° C. The ambient conditions during the spray drying process may be 28.4° C. and 48% R_{H}. Approximately 1400 mL of solution may be sprayed, and 208 g of spray-dried, hydrous magnesium carbonate (Mg(CO₃) xH₂O) template precursor powder with a hollow-spherical morphology may be collected via a cyclonic separator.

Next, the template precursor powder may be converted into a template via thermal treatment using a muffle furnace (Vulcan 3-550 Model, 1440 W max). Approximately 10 g of the template precursor powder may be placed in ceramic boats and heated to 580° C., then held at this temperature for 13.5 hours, followed by heating to 1050° C. and holding for another 1 hour to yield approximately 3.9 g of MgO powder. The heating ramp rates for both steps may be 5° C./min and the cool-down was allowed to happen naturally overnight over 8 hours. Approximately 0.47 g of the MgO powder may be pelletized in a 15.7 mm ID hydraulic press by applying 7.8 ksi of uniaxial compression for 1 minute. The resulting disc-shaped template may have a diameter of 15.7 mm and thickness of 2.5 mm.

Next, a Thermcraft tube furnace with a 60 mm OD quartz tube may be employed in a template-directed CVD procedure. The furnace may be kept level (i.e. not tilted), with the 0.47 g pelletized template sample being placed in a ceramic boat in the heating zone prior to initiating the procedure. Ceramic blocks may be inserted outside each side of the furnace's heating zone, and glass wool may be used to fix the position of the ceramic blocks. The tube may be fitted with two stainless steel flanges. Gas may be flowed in through a gas inlet on one flange and out through a gas outlet in the other flange. After initiating a 815 sccm flow of CO₂ gas, the furnace may be heated from room temperature to a temperature setting of 540° C. at a ramp-rate of 20° C./min and held at this condition for 5 minutes. Next, a 144 sccm flow of C₂H₂ gas may be initiated while maintaining CO₂ flow, and this condition may be held for 90 minutes. The C₂H₂ flow may then be discontinued, and the furnace allowed to cool to room temperature under sustained CO₂ flow. During cooling, the clam-shell furnace lid may be opened completely, exposing the quartz tube to the outside air. A perimorphic composite pellet obtained after cooling may be characterized. Finally, the same CVD growth procedure may be repeated twice more, with the pellet being again cooled, for a total of 3 CVD growth steps with the pellet being allowed to cool between each step. The resulting perimorphic composite pellet comprises a macroscopic, perimorphic carbon that may be tested for ambient superconductivity.

A vacuum chamber like the one associated with the Cober-Muegge microwave system utilized in Study G (FIG. 96C) may be utilized, but without any microwave irradiation. The vacuum chamber may be equipped with a 4-point probe (Lucas/SignatoneSP4-40045TFJ) for measuring sheet resistance without lead and contact resistance. The probe specifications may be 40 mil spacing between the Tungsten Carbide tips, a 5 mil tip radius, and a 45 gram spring pressure. The 4-point probe may be placed inside the vacuum chamber and wired to a Keithley Series 2400 Sourcemeter located outside the vacuum chamber. The Keithley Sourcemeter may be set to 4 wire mode with the auto-ohms method selected and operates as a conventional constant-current source ohmmeter with a starting current of 10 mA. The auto-range function was selected and the current stepped up to 100 mA if the measured resistance dropped below 20 Ohms/sq. The chamber pressure may be measured concurrently with the sheet resistance of the sample using a convection-enhanced Pirani vacuum gauge module (CVM201 Super Bee) capable of reading down to 0.1 mTorr with an accuracy of 0.1 mTorr resolution and a repeatability of 2% of the reading. Lastly, the chamber may be equipped with a vacuum pump. This setup should enable the vacuum chamber to be pumped down while the chamber pressure and sheet resistance are read concurrently.

The points of the 4-point probe may be placed into static contact with the flat surface of the macroform as lightly and delicately as possible to obtain a steady, continuous sheet resistance reading. This delicate placement should be done to avoid compressing the macroform surface with the probe tips, which may be necessary due to the apparent pressure-sensitivity of the sp^{x} macroforms we tested. We theorize that this pressure-sensitivity is attributable to localized mechanical compression reducing the interlayer distance and thereby inducing interlayer electronic coupling near the voltage-sensing points of contact. Additionally, a soft, non-conductive backing underneath the carbon macroform may be utilized in order to minimize local compression. To make contact, the Sourcemeter may be turned on to get an initial reading at ambient conditions, and the chamber may then be closed and evacuated. During the evacuation of the chamber, readings of the chamber pressure and the sample's sheet resistance may be noted.

### VIII** Study A—Analysis

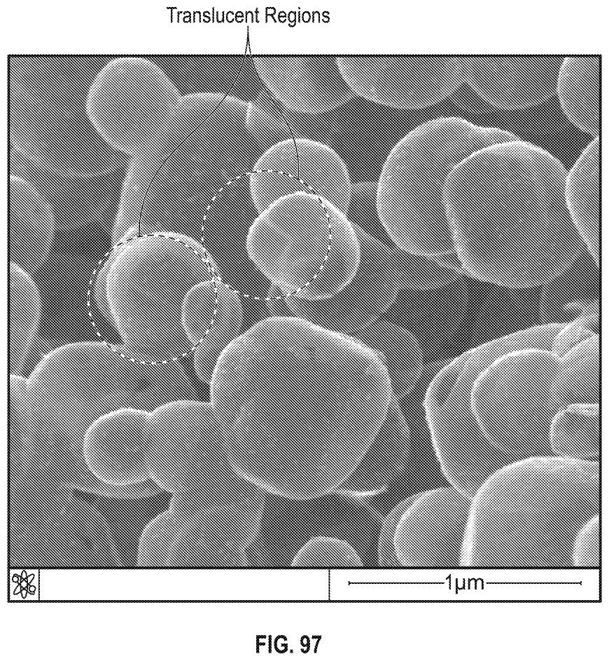

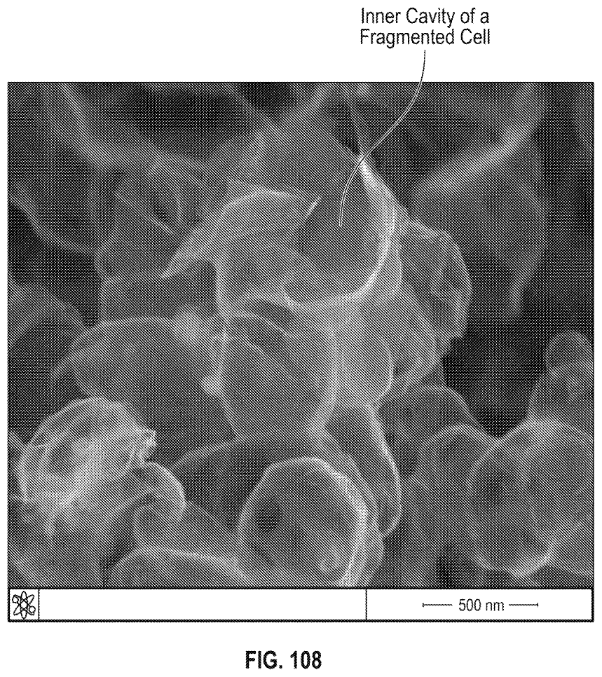

SEM images of Sample A1 confirms the presence of perimorphic frameworks. FIG. 97 is an SEM micrograph of Sample A1 after removal of the endomorphic phase of the perimorphic composite powder. It is unclear if there is one or more distinct perimorphic frameworks in this SEM micrograph. The morphology appears to consist of conjoined, macroporous subunits (labeled in FIG. 97). This mirrors the template, which was a partially sintered powder. Unlike the frameworks that will be studied in Sample A2, which appeared fragmented and deformed (as shown in FIG. 108) after liquid-phase processing and evaporative drying, the frameworks in FIG. 97 appear largely intact and mostly unaffected by the processing and drying. This shows that the perimorphic walls in Sample A1 were better able to withstand the stresses encountered during processing.

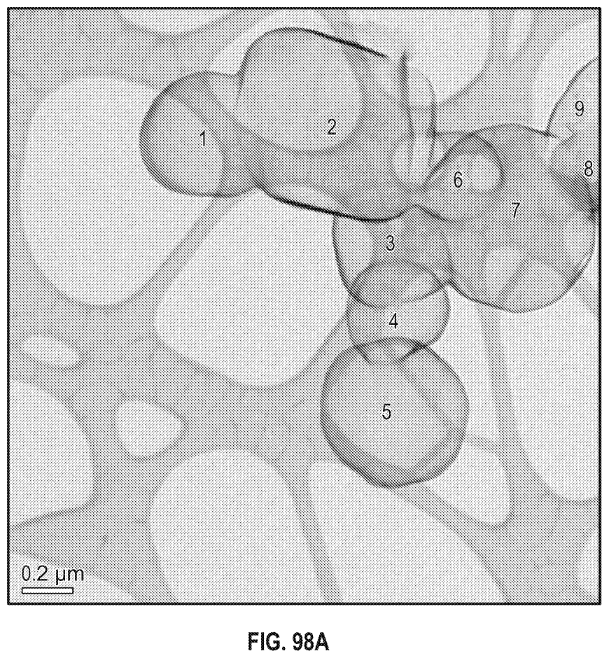

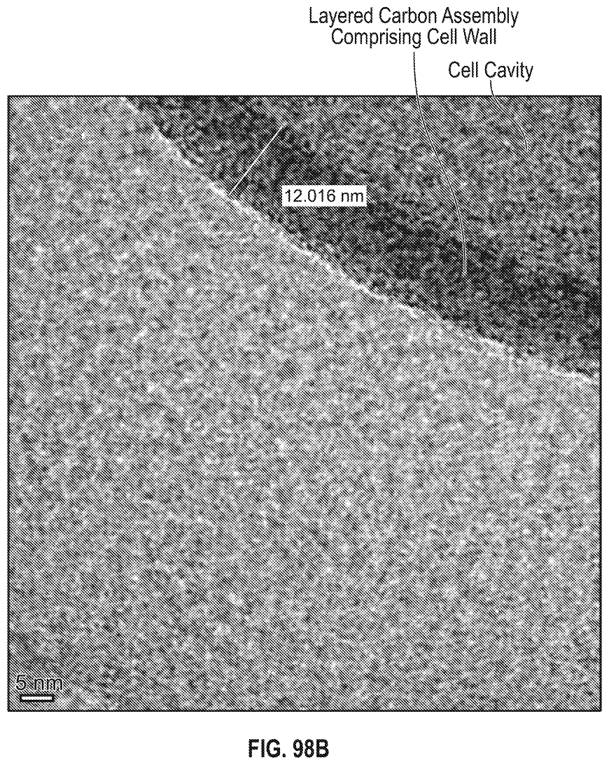

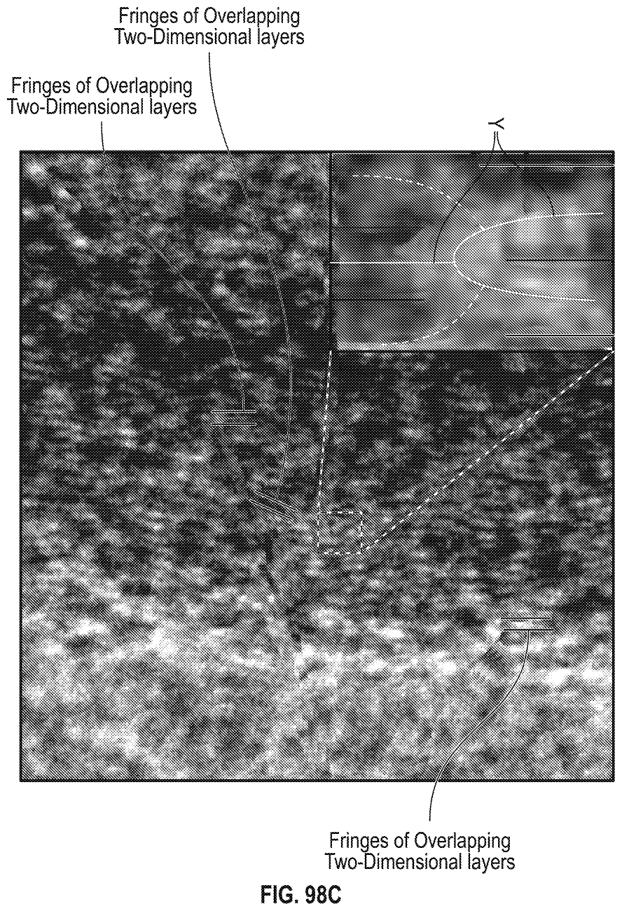

To achieve better transparency, and to study the smaller-scale structure of the perimorphic wall in Sample A1, TEM analysis was also performed. FIG. 98A is a TEM micrograph in which we can observe a typical framework against the background grid of lacy carbon (this grid is used to support TEM samples and is not the carbon of interest). The framework in this micrograph appears to comprise at least 9 macroporous subunits, which are numbered in FIG. 98A. The cavities match the morphology of the displaced endomorph (not imaged) in both size and shape. No signs of buckling or wrinkling are present within the wall.

Closer examination of the perimorphic wall is possible in a higher-magnification view, shown in FIG. 98B. This image shows a cross-section of the wall. Some walls observed in Sample A1 were consistently as thick as ˜12 nm (or ˜30-35 layers), indicating that the growth of graphenic structures was not terminated by occlusion of the catalytic template surface, but rather by cessation of CVD. This is evidence of the contribution of an autocatalyzed growth mechanism, without which we could not expect so many layers, no matter how long CVD might be continued. N₂ gas adsorption was performed to obtain the BET surface area of 142 m²g⁻¹ and BJH porosity of 0.35 cm³g⁻¹. This BJH porosity value was undoubtedly less than the real specific porosity given the inability to measure larger macropores using the N₂ adsorption method.

In the highest magnification view, shown in FIG. 98C, the perimorphic wall's layered structure can be discerned. It comprises a multilayer stack of overlapping, z-adjacent graphenic regions, which are evidenced by the alternating dark and bright fringes. Each fringe line either represents a two-dimensional graphenic region or the z-interval between two z-adjacent regions.

Care must be taken during HRTEM analysis that the fringe lines corresponding to the actual positions of the graphenic layers are not confused with the fringe lines corresponding to the z-intervals between these layers. Depending on the defocus value, the fringes associated with the actual atomic positions may be either dark or bright. Whichever color they are, the lines associated with the z-intervals will be the opposite color. In the literature, we can find examples of either dark or bright fringes being associated with graphenic layers. In order to make a confident assignment of the exact atomic positions in HRTEM images, it helps to have corroborating information about the actual molecular structure.

The presence of fringe lines indicates that this section of the perimorphic wall in Sample A1 comprises a stacked arrangement of z-adjacent graphenic regions. In the main frame of FIG. 98C, a few dark fringe lines are traced. As shown by the tracings, while z-adjacent fringe lines appear to be generally xy-aligned over distances up to several nanometers, the fringe lines are not parallel throughout the entire perimorphic wall. Due to the local xy-alignment of z-adjacent graphenic regions, however, the wall in FIG. 98C exhibits nematic alignment. The layers in all sections of the wall that were imaged exhibited nematic alignment.

An xy-alignment between z-adjacent graphenic regions allows smaller z-intervals and higher-density arrangements, which should in turn increase interlayer coupling and vdW cohesion. We consider this a desirable feature of a layered graphenic system as opposed to the lower-density, nonlayered network architecture exhibited by schwarzite. If density reduction is desired, this can be accomplished by introducing larger-scale modes of porosity (such as the macropores in Sample A1), while preserving a high-density layered organization at smaller scales.

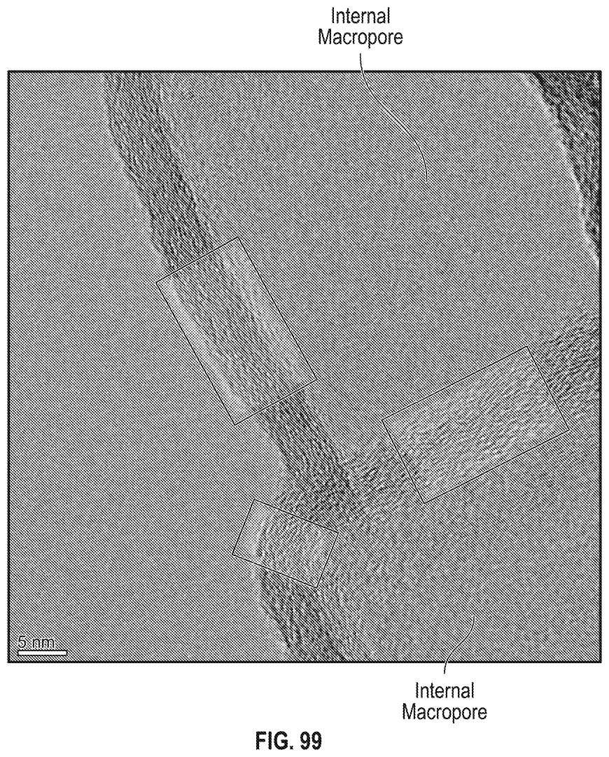

Another helpful example of nematic alignment is shown in FIG. 99, which is an HRTEM image of a perimorphic wall with nematically aligned layers (from a different sample). We include this example here because the fringe lines were clearer in the HRTEM images taken of this sample. Different sections of the wall are boxed. In each boxed region, the fringe pattern exhibits a nematic alignment with that section of the wall. This likely arises from the conformal growth of the graphenic structures over the templating surface and then over each other.

While the layers throughout Sample A1 are nematically aligned, it is visually difficult to trace dark fringe lines in FIG. 98C for more than a few nanometers. An exemplary portion of the perimorphic wall is designated by the white square of FIG. 98C, which is magnified in FIG. 98C's inset. While the diffraction contrast and focus of this image are not sharp, the fringe lines can be discerned and traced. The dark fringe lines from the HRTEM micrograph are traced black lines. The bright fringe lines from the HRTEM micrograph are traced with white lines in high-contrast bright areas and with dashed lines in lower-contrast bright areas.

In addition to the z-intervals between the black tracing segments, there appear to be lateral discontinuities separating the black tracing segments in the magnified inset of FIG. 98C. This pattern could be observed throughout the HRTEM images of Sample A1. If the black tracing within the magnified inset represented the location of the graphenic regions, then each lateral discontinuity in the black tracing would indicate an edge. If this interpretation were correct (we shall demonstrate that it is not), the ubiquitousness of this fringe pattern throughout the perimorphic wall would suggest that the wall comprises a vdW assembly of small graphenic domains-no larger than 3 nm on average, perhaps, since these lateral discontinuities were frequent. Additionally, if this interpretation were correct, we would have to conclude that the graphenic edges of z-adjacent layers were aligned. This might be explained if the edges were caused by a fracture; however, this possible explanation is implausible based on the ubiquitousness of the fringe pattern throughout the wall.

The alternative (and correct) explanation is that the bright fringes (corresponding to the white tracing in the magnified inset of FIG. 98C) represent the actual atomic positions. The solid white lines in the center of the inset form a distinct, horizontal “Y” shape, as labeled by the horizontal Y in FIG. 98C. This bright Y indicates that the bilayer on the branched side of the Y and the graphenic monolayer on the stem side of the Y were just different regions of the same ring-connected graphenic structure. Additionally, in this scenario, the bright fringes traced with dashed white lines, while lower in diffraction contrast than the fringes traced with solid white lines, also indicate some presence of atoms. Together, these solid and dashed white tracings indicate ring-connectedness throughout the magnified region—the opposite of the disconnectedness of the black tracings.

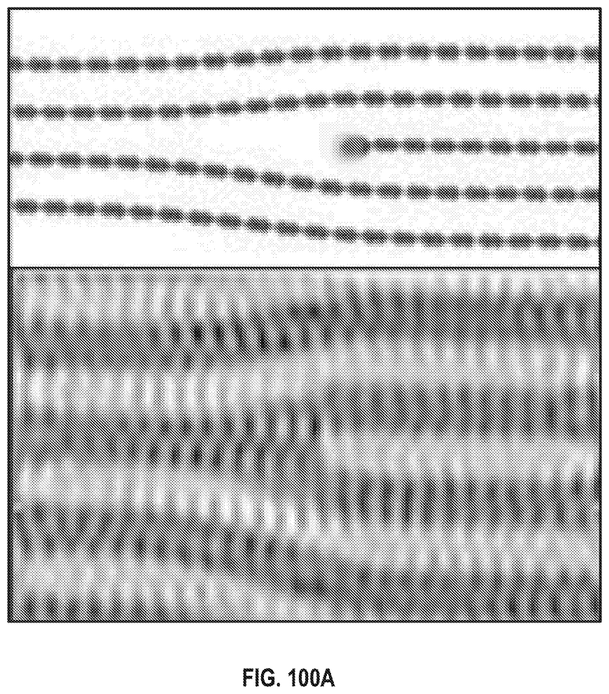

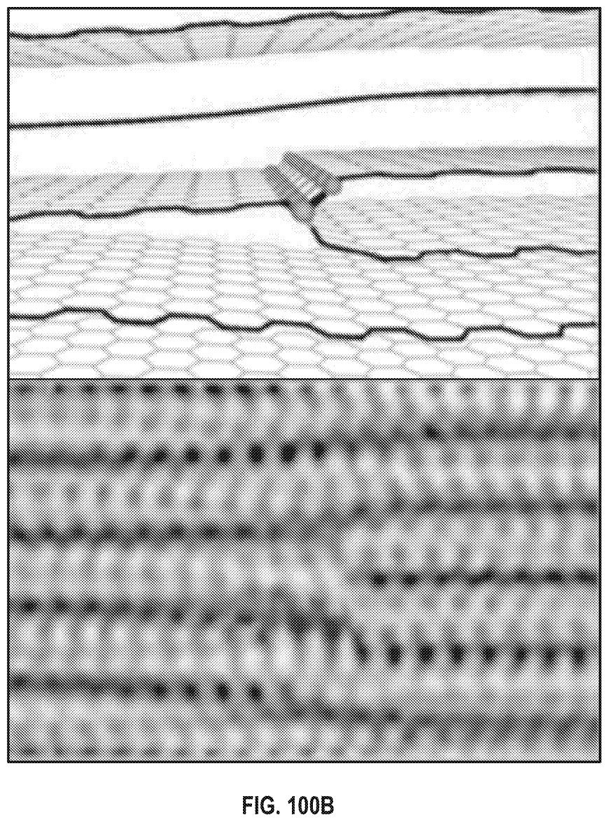

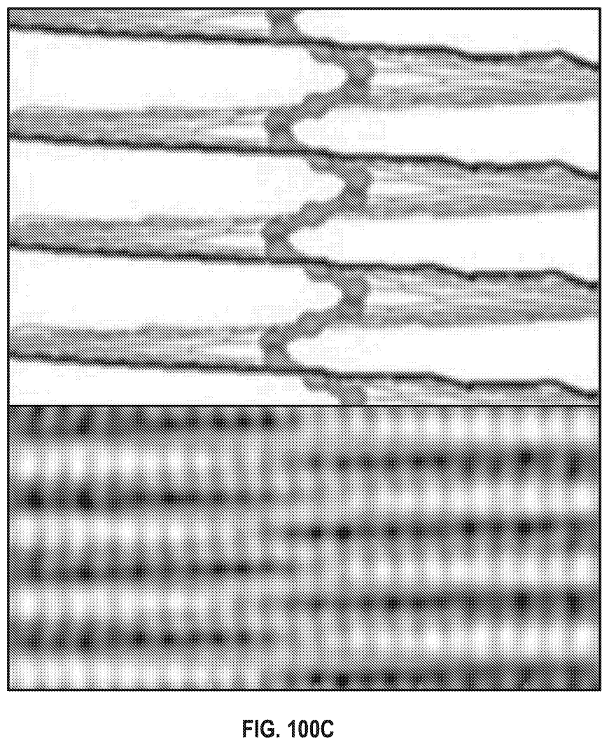

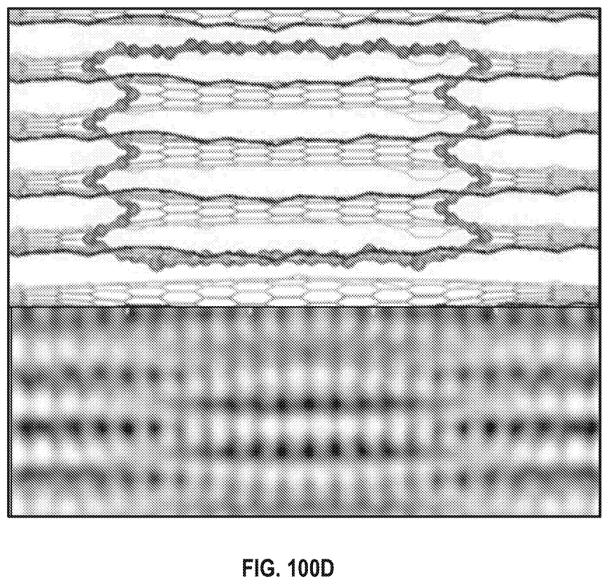

This observation has a precedent in the anthracite literature. HRTEM fringes of anthracite have been analyzed to generate a model of anthracite's structural dislocations. FIG. 100A-100D are borrowed from this HRTEM analysis. Each figure contains a model representing a structural dislocation found in anthracite and, below the model, the simulated HRTEM fringe pattern associated with it. These simulated fringe patterns are consistent with the actual fringe patterns observed in anthracite, validating the dislocation models. In each simulated fringe pattern, the bright fringe lines represent the graphenic regions, and the dark fringe lines represent the space between layers.

FIG. 100A is an illustration, drawn from the anthracite literature, of an edge dislocation, wherein a graphenic region is trapped between two z-adjacent regions-one above and one below. The edge of the trapped region represents the local terminus of some graphenic structure, and its members may comprise sp² radicals. In a van der Waals assembly formed primarily by subduction events (typical of carbons formed by template-directed CVD), the edge of a subducted region—and the z-adjacent regions between which it is trapped-together comprise an edge dislocation. The simulated HRTEM fringe pattern formed by an edge dislocation is also shown in FIG. 100A. The pattern is characterized by a bright fringe line, representing the position of the trapped region, terminating between a dark, Y-shaped fringe line, which represents the interlayer spacing.

FIG. 100B is an illustration, drawn from the anthracite literature, of a Y-dislocation, which can be thought of as the horizontal Y-shaped structure that would be formed if the edge atoms of the trapped graphenic region in FIG. 100A were bonded covalently to one of the z-adjacent regions. The geological conversion of an edge dislocation (e.g. FIG. 100A) into a Y-dislocation (e.g. FIG. 100B) reduces the dislocation energy. This would occur via a radical addition reaction that results in a line of sp³ atoms at the junction between the three layers in the Y-dislocation. It has been suggested by researchers that anthracite's Y-dislocations are evolved in this way.

The simulated HRTEM fringe pattern formed by a Y-dislocation is shown below the dislocation in FIG. 100B. The pattern is the inverse of the simulated pattern in FIG. 100A i.e. a dark fringe line terminates between a bright, Y-shaped fringe line. The bright, Y-shaped fringe line represents the location of the Y-shaped graphenic structure, a small version of which was illustrated by the molecular model in FIG. 95D. The simulated fringe pattern looks very similar to the Y-shape traced in the magnified inset of FIG. 98C.

Geologically-formed anthracitic networks are a natural demonstration of how structural dislocations can create a three-dimensional graphenic network. Substantially all of the carbon atoms in anthracite are members of the graphenic network resulting from these crosslinking dislocations, with the exception of an occasional CH, CH₂ or CH₃ group (which solid state C NMR has indicated are present only in very small quantities) attached to a ring. It is this crosslinking of the graphenic network that lends anthracite its hardness and that prevents its exfoliation or solubilization. NMR spectroscopy has been used to show that dodecylation of anthracite only affects the edge atoms of this singleton, wherein “the graphenic layers appear to merge.”

Returning to the fringe pattern shown in the magnified inset of FIG. 98C, we can conclude that this pattern is associated with crosslinking dislocations. The solid white tracing indicates a Y-dislocation. The lower-contrast fringes traced by the white dashed lines likely indicate Y-dislocations that are less in focus or more disordered. The black line segments represent the spaces between graphenic layers. Since Y-dislocations are constructed from a diamondlike seam that preserves lateral and vertical ring-connectedness, we can conclude that the magnified inset of FIG. 98C represents a ring-connected region within the perimorphic wall. Furthermore, the ubiquitous occurrence of Y-dislocations like this throughout the wall indicates that the perimorphic frameworks in Sample A1 comprise anthracitic networks.

The case for this is further reinforced by our comparative analysis of Samples A2 and A3. Namely, if the perimorphic frameworks in Sample A1 comprised vdW assemblies, the conspicuously superior robustness of Sample A1's less crystalline particles vs. Sample A2's more crystalline particles (their relative crystallinity being ascertained by HRTEM, Raman, and XRD analysis) would conflict with findings reported in the literature. Researchers have shown that vdW assemblies of small graphenic domains are more fragile—not more robust—than vdW assemblies of larger, more crystalline domains. For example, “amorphous graphene nanocages” that possess a similar morphology to the particles in Sample A1 and comprise assemblies of small, overlapping graphenic domains (often smaller than 10 nm), are easily broken and deformed. Their fragility is explained by the weakness of the vdW interactions between these assemblies' small graphenic domains, which are easily sheared apart. Researchers' side-by-side comparison of amorphous graphene nanocages with more crystalline graphene nanocages constructed from larger domains have demonstrated the superior cohesion of the latter. However, what we actually see is a dramatic improvement in mechanical robustness in every particle throughout Sample A1 compared to the more fragile, nanocrystalline particles found in Sample A2.

Based on this, we can state that the perimorphic framework in FIG. 98A comprises an anthracitic network of approximately 18.5 layers, on average (a figure arrived at by dividing the theoretical specific surface area of graphene, 2630 m²g⁻¹, by the BET surface area of Sample A1, which was 142 m²g⁻¹). The observable portion of the anthracitic network in FIG. 98A comprises 9 spheroidal, macroporous subunits. In total, this represents a graphenic network with a significant amount of lattice area in vdW contact. A conservative estimate of this area is 48 μm², which is arrived at based on the following. First, for this estimate, we ignore the 8^{th} and 9^{th} subunits that are only partially observable in FIG. 98A. The average radius of the remaining subunits, while difficult to calculate exactly, is definitely larger than 200 nm (for reference, spheroid #4 in FIG. 98A has a radius of approximately 200 nm, as indicated by the dashed black line), but we use this radius for our conservative estimate. The theoretical surface area of 7 spheres with a radius of 200 nm would be approximately 3.5×10⁶ nm² (i.e. 7×4πr², where r=200 nm). We note that this would be reduced if the spheres were conjoined, as they are in FIG. 98A, so we reduce our theoretical surface area by 25%, resulting in a value of 2.6×10⁶ nm². Lastly, based on the estimated average wall thickness at 18.5 layers, we might estimate the total lattice area throughout the wall as approximately 4.8×10⁷ nm² (i.e. 18.5 layers×2.64×10⁶ nm²), or 48 μm².

Since all of this networked lattice area is organized in nematically aligned layers, substantially all of this lattice area is subject to interlayer vdW interactions. For the same reason that crystalline graphene nanocages constructed from large-area domains exhibit better vdW cohesion relative to amorphous graphene nanocages constructed from small-area domains, we can infer that as we construct progressively larger anthracitic networks, we can begin to derive a considerable vdW contribution to system cohesion. This is one of the reasons that we find the anthracitic networks more appealing than schwarzite-like graphenic networks (illustrated in FIG. 90) like those synthesized on zeolite templates. Shorter, more consistent z-intervals and better vdW cohesion may be obtained with a denser, layered architecture. The increased local density incurred may then be offset by introducing larger-scale modes of porosity, such as the templated pores in perimorphic frameworks.

More information about the bonding within the frameworks in Sample A1 can be derived from the sample's Raman spectrum. A single-point Raman spectrum, taken using a 532 nm laser at 2 mW power, is shown in FIG. 101. No smoothing has been performed. For reference, the full spectrum is shown in the inset of FIG. 101. The Dᵤ band appears centered between 1345 cm⁻¹ and 1350 cm⁻¹, which is typical for 532 nm (˜2.33 eV) excitation. On this basis, The Gᵤ band is centered between 1590 cm⁻¹ and 1595 cm⁻¹, compared to the usual 1585 cm⁻¹, indicating the presence of some compressive strain in the sp² bonds. Additionally, there is a high Trᵤ peak between the Dᵤ and Gᵤ bands, corresponding to an I_{Tr}_{ᵤ}/I_{G}_{ᵤ} peak intensity ratio of approximately 0.50 and indicating the possible presence of an underlying peak to be examined via profile fitting. The I_{D}_{ᵤ}/I_{G}_{ᵤ} peak intensity ratio is less than 1.0.

Another unfitted peak that is apparent in FIG. 101 appears as a weak shoulder on the Dᵤ band located between 1100 cm⁻¹ and 1200 cm⁻¹. This feature's position coincides with the D* peak found in the 1150 to 1200 cm⁻¹ region. Researchers in the field have attributed this peak to sp²-sp³ bonds at the transitions between sp² and sp³ regions in soot-like carbons. Such an assignment is therefore in good agreement with the sp^{x} rings from which the diamondlike seams are constructed.

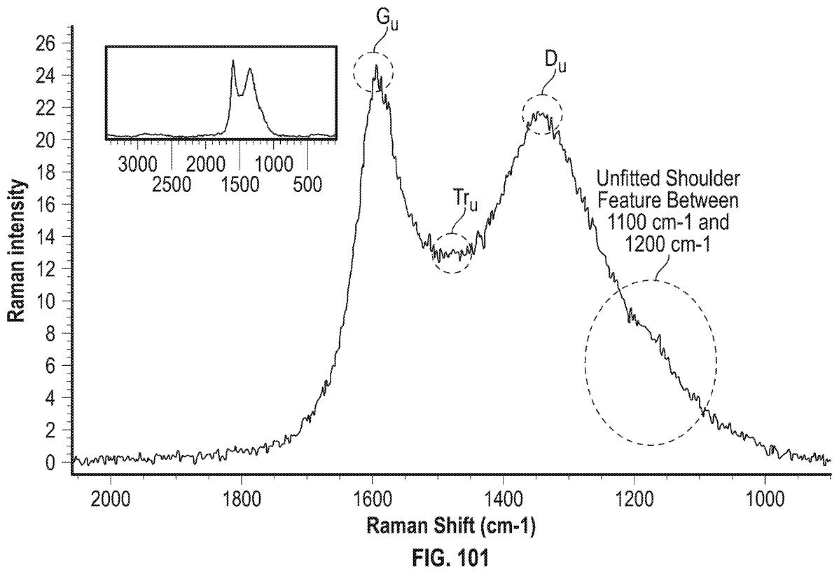

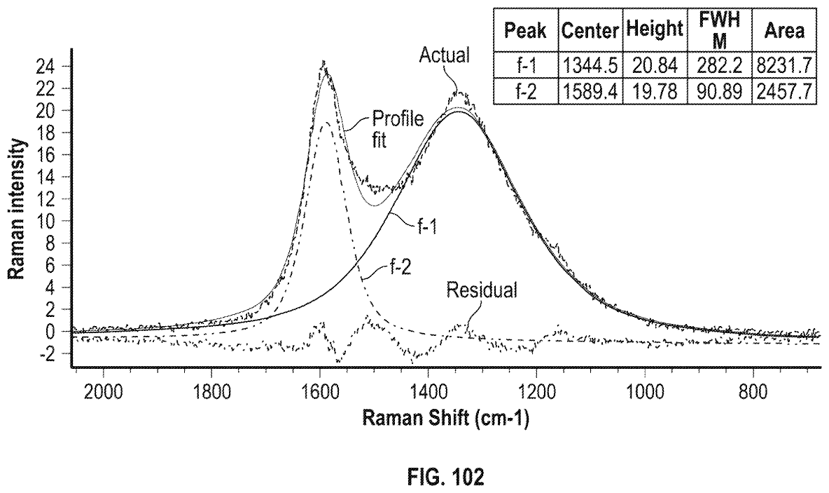

In order to elucidate the underlying features of the Raman profile in FIG. 101, the OMNIC Peak Resolve software was used. Initially, the software was restricted to the use of only two peaks. FIG. 102 shows the two fitted peaks, the fitted profile, the actual profile, and the residual representing the difference between the fitted profile and the actual profile. The residual at the bottom of the chart indicates the ranges where the fitted profile deviates from the actual profile, and the magnitude of the deviations. A flat residual (taking into account that the noise in the unsmoothed actual will also be reflected in the residual) is indicative that the fitted profile is good and coincides with the actual profile. For only two peaks, the fitted profile is still poor, with large residuals occurring between approximately 1150 cm⁻¹ and 1650 cm⁻¹. Of note are the especially poor fits at the peaks, in the trough region, and at the shoulder around 1150 cm⁻¹.

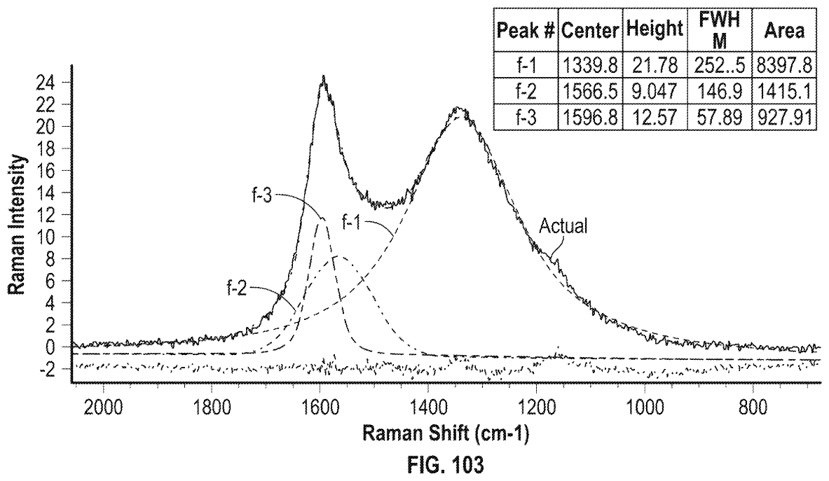

Next, the OMNIC Peak Resolve software was allowed a third peak, which was manually placed at a starting position of 1500 cm⁻¹ prior to re-running the profile-fitting routine. FIG. 103 shows the three fitted peaks, the fitted profile, the actual profile, and the residual representing the difference between the fitted profile and the actual profile. This fitted profile, which incorporates a broad fitted peak at 1566 cm⁻¹, appears significantly better than the fit obtained with only two fitted peaks. However, a significant residual is still present between 1150 cm⁻¹ and 1200 cm⁻¹.

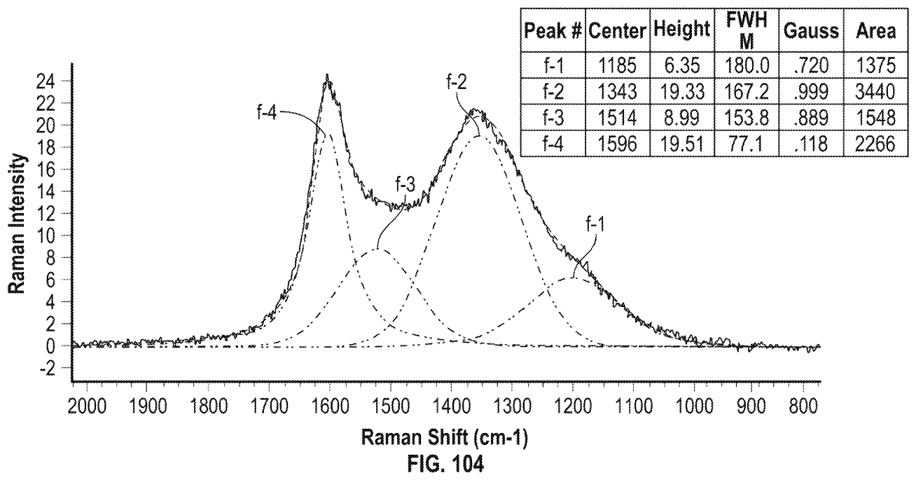

Next, the OMNIC Peak Resolve software was allowed a fourth peak, which was manually placed at a starting position of 1150 cm⁻¹ prior to re-running the fitting routine. FIG. 104 shows the four fitted peaks (labeled f-1 through f-4). This fitted profile, which further incorporates a broad fitted peak at 1185 cm⁻¹, appears significantly better than the fitted profiles obtained with either two or three fitted peaks. The f-1 peak at 1185 cm⁻¹ reduces the residual associated with the shoulder feature in this range. With these 4 fitted peaks, a satisfactory fitted profile is obtained.

Analysis of the four fitted bands indicate a split in the G band (usually found at approximately 1585 cm⁻¹ in unstrained sp² lattices) into the f-4 peak at 1596 cm⁻¹ and a broad f-3 peak at 1514 cm⁻¹. The f-4 band represents a blue-shifted mode of the G band. The increased frequency of these blue-shifted phonons is caused by compressive strain in some sp²-sp² bonds. The much broader f-3 peak at 1514 cm⁻¹ coincides with the D″ peak found in graphene oxide and represents a red-shifted mode of the G band. The lower frequency of these red-shifted phonons is caused by the stretching and weakening of sp²-sp² bonds in ring-disordered regions, as described by Ferrari & Robertson. In addition to inducing tensile strain, the ring disorder of these regions disallows a uniform strain field, which broadens the f-3 band. From the split of the G band into the f-3 and f-4 peaks, we can therefore discern the presence of certain regions of compressed sp²-sp² bonds, and certain ring-disordered regions of stretched sp²-sp² bonds.

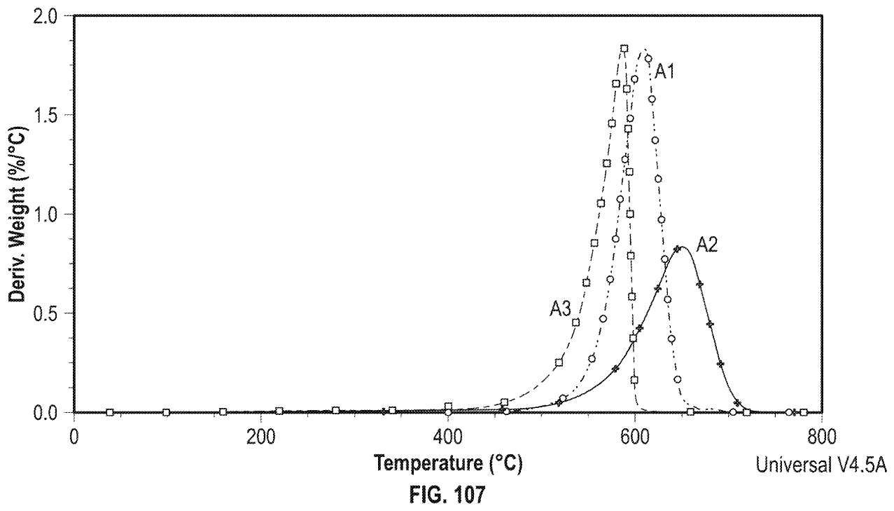

A blue-shifted band like f-4 is not observed in graphene oxide, in which the G peak, in addition to its normal mode at 1585 cm⁻¹, is also present in the red-shifted mode (called the D″ peak and characterized herein by the trough height). This, in conjunction with Sample A1's lack of oxygen moieties (evidenced by the near-zero rate of mass loss below 400 C in FIG. 107) and the layered architecture of its graphenic systems, establishes that its Raman spectrum arises from a different structure than graphene oxide.

The f-2 peak in FIG. 104 represents a slightly red-shifted D_{f} peak located at 1343 cm⁻¹. While the D band of sp² carbons is dispersive, and the D peak position can change based on excitation, 1343 cm⁻¹ is somewhat lower than the D peak position typically associated with sp² carbon under 532 nm excitation (around 1350 cm⁻¹). This red-shifting indicates some underlying interpolation of the sp² vibrational density of states (VDOS) with lower-frequency bands found in the sp³ VDOS.

Interpolation of the VDOS in an alloy structure occurs when there is strong coupling between the phases. Interpolation between the D band (associated with sp² hybridization) and lower-frequency bands indicates the strong coupling of sp³ states and sp² states in their immediate proximity. These regions of strong coupling activate the radial breathing mode (“RBM”) phonons found throughout the graphenic system's entire sp² ring structure. Hence, even a trace-level presence of sp³ carbon states can be discerned in the Raman spectrum due to their activation of RBM phonons that are found throughout the much larger sp² component. In other words, RBM phonons in grafted singletons are activated by backscattering from the sp³ states in sp^{x} rings, where the sp² and sp³ phases are strongly coupled, and therefore the D band associated with RBM phonons is interpolated. Conversely, the preponderance of sp² states comprising the sp² layers between diamondlike seams are neither immediately proximal to the sp³ states, nor strongly coupled to them, and accordingly the G band, associated with sp²-sp² vibrations, is not interpolated. Based on this analysis, the red-shifted position of the f-2 (i.e. the D_{f} peak) in FIG. 104 corroborates the observations of ubiquitous Y-dislocations throughout the anthracitic networks comprising Sample A1.

What dictates the degree of D band interpolation is not the fraction of sp³ states within the graphenic systems, but instead the fraction of RBM phonons activated by sp³ states vs. the fraction of RBM phonons activated by sp² edge states. Even a trace level of sp³ states may activate a majority of the RBM phonons if there are even fewer sp² edge states. This may cause the D band to interpolate, and the degree of interpolation may be expected to increase with an increasing prevalence of sp³ states and decreasing prevalence of sp² edge states. Of course, the respective prevalence of these two states is negatively correlated, since the sp^{x} rings are formed by the conversion of sp² edges states into sp² interior states or sp³ states.

Therefore, interpolation of the D band in Sample A1 can be viewed as evidence of the conversion of sp² edge states into sp³ states associated with diamondlike seams. The conversion of the sp² edge states into sp³ states associated with diamondlike seams also hints at a tectonic mechanism behind the formation of the seams, and this causal mechanism is explored further in connection with Sample A3 and the samples pertaining to Study B.

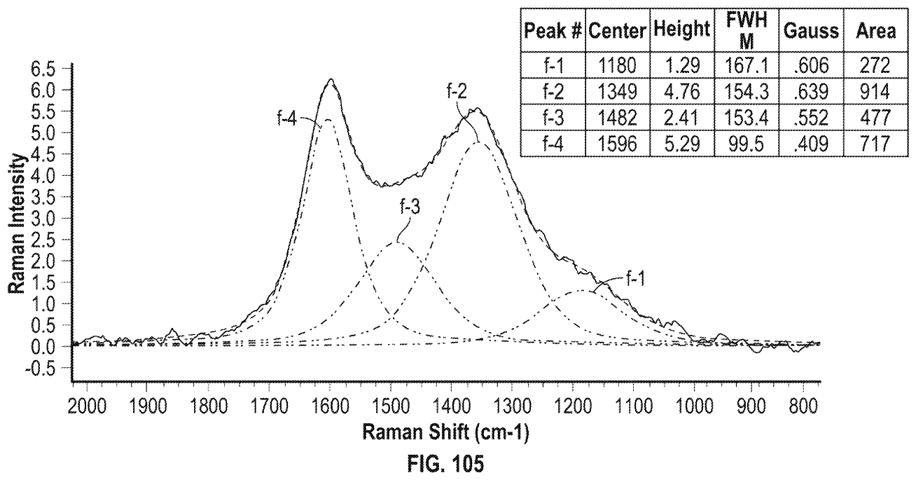

Outside of the f-2 peak position, another possible indication of the presence of sp³ states in the Raman spectrum is the shoulder feature associated with the Dᵤ peak. This shoulder, which appears between 1100 cm⁻¹ and 1200 cm⁻¹ in FIG. 101, is fitted by the broad f-1 peak in FIG. 104 and is centered at 1185 cm⁻¹. A broad peak between 1150 cm⁻¹ and 1200 cm⁻¹ has been assigned by previous researchers to sp²-sp³ bonds and would therefore be consistent with the transitions that occur at diamondlike seams. To demonstrate that this feature was not related to trans-PA, we annealed Sample A1 at 1050° C. for 30 minutes. The fitted Raman spectrum of the sample after annealing is shown in FIG. 105 for comparison. The shoulder feature is reduced in intensity and shifted slightly from 1185 cm⁻¹ to 1180 cm⁻¹ but not eliminated. This shows that it is not trans-PA. However, the annealing has reduced the f-1 peak's area ratio (i.e. the ratio of its area vs. the total area of all 4 fitted peaks) from 0.16 to 0.11. This reduction indicates a reduction of sp²-sp³ bonding and likely a reduction of the sp³ content. Hence, the f-1 peak may also corroborate the diamondlike seam in Sample A1.

A review of the anthracite literature shows red-shifted D bands in the optical Raman spectra in some grades of natural anthracite-unfitted D peaks can be occasionally found with positions below 1340 cm⁻¹ while in other less mature or more mature grades the D band appears un-interpolated. In the less mature grades, it may be reasoned that this is because diamondlike seams have not yet been geologically formed. In more mature grades (e.g. meta-anthracites), it may be reasoned that diamondlike seams have been formed and subsequently destabilized, eliminating sp³ states and evolving screw dislocations.

To our knowledge, the basis for the D peak's occasional red-shift has neither been investigated, nor assigned to the diamondlike seams. In optical Raman, the I_{D}_{ᵤ}/I_{G}_{ᵤ} ratio in anthracite tends to be below 1.0, like Sample A1's. Additionally, anthracite often exhibits a blue-shifted G peak, positioned between 1595 cm⁻¹ and 1605 cm⁻¹, as well as a broad underlying peak that can be fitted between 1500 cm⁻¹ to 1550 cm⁻¹, consistent with a red-shifted mode of the G peak. Additionally, some grades of anthracite exhibit a shoulder in the range of 1100 cm⁻¹ to 1200 cm⁻¹. Therefore, the spectrum of Sample A1, along with its HRTEM fringe patterns, are consistent with a synthetic anthracitic network.

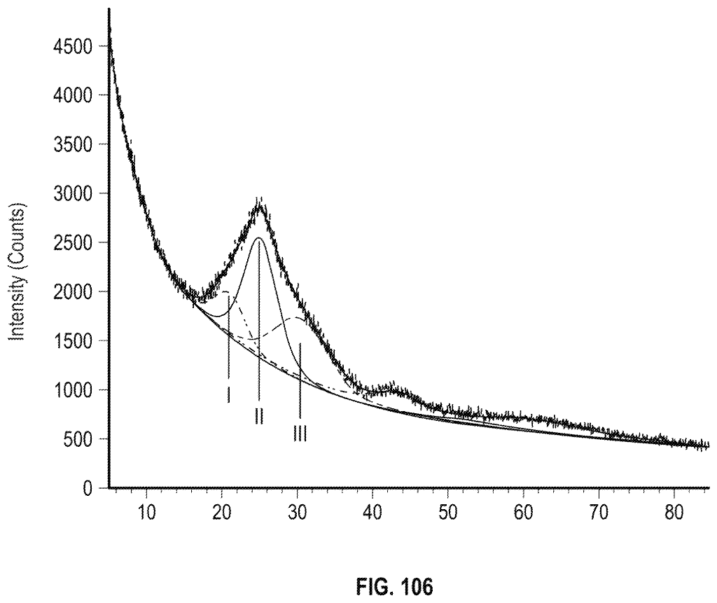

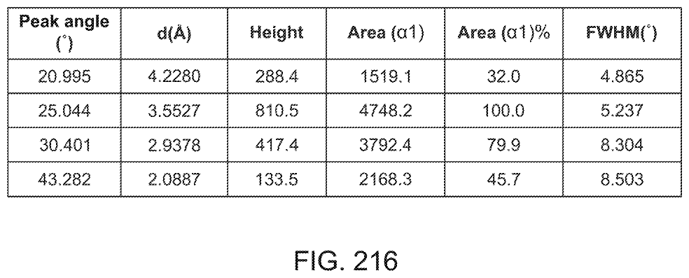

Further characterization of the anthracitic networks in Sample A1 was obtained via XRD analysis. XRD analysis was done for a sample synthesized using a procedure similar to Procedure A1, but from a magnesium carbonate feedstock powder. This feedstock powder was calcined to obtain an MgO powder with template particles indistinguishable from Sample A1's. As such, the XRD results from this carbon were analyzed to understand the crystal structure of anthracitic networks like Sample A1. FIG. 106 shows the overall XRD profile. FIG. 216 contains the XRD peak angles, d-spacings, areas, area percentages (normalized to the area of the dominant peak at 2θ=25.044°), and full-width half max values (without correction for instrument broadening).

Three peaks were fitted in the range of interlayer periodicities. The three fitted peaks are referred to as Peaks I, II, and III, and are labeled in FIG. 106. FIG. 106 also includes reference lines showing the 20 values associated with graphite's indices. For Sample A1, the largest fitted peak, as measured by the area under the peak, is Peak II. Peak II obtains a maximum height at 2θ=25.044°, corresponding to a d-spacing of 3.55 A. The area under Peak II is set to a value of 100% for comparison with the other peak areas. Peak II's FWHM value is 5.237°, indicating a relatively broad range of interlayer spacings. The d-spacing and FWHM values of Peak II together indicate an interlayer spacing within Sample A1 that is more varied and larger than the interlayer spacing in graphitic carbon.

Peak I has a maximum height at 2θ=20.995°, equivalent to a d-spacing of 4.23 Å. Like Peak II, Peak I is also broad, with a FWHM value of 4.865°. The area under Peak I is 32% of the area under Peak II, making it a significant phase of interlayer spacing. A d-spacing of 4.23 Å is too large to be associated with the interlayer phase in graphitic carbon. This peak may reflect the presence of z-adjacent, curved graphenic regions where the curvature is not in phase. Out-of-phase z-deflections disrupt the uniformity of the interlayer spacing and create expanded spaces between the curved regions. This curvature is consistent with anthracitic networks.

Peak III indicates the presence of a phase of smaller interlayer spacing, as well. With a maximum height at 2θ=30.401°, equivalent to a d-spacing of 2.93 Å, the interlayer spacing represented by Peak III is smaller than any interlayer phase in a graphitic carbon. Like Peaks I and II, Peak III is broad, with a FWHM value of 8.304°. The area under Peak III is 80% of the area under Peak II, making it a nearly equivalent phase of interlayer spacing. D-spacing values in the range of 2.93 Å are not found in graphitic carbons, which typically have a <002> d-spacing value of 3.36 Å and no other d-spacings larger than graphite's <100> d-spacing value of 2.13 Å. Heated compression of glassy carbons causes buckling of sp² regions, sp²-to-sp³ rehybridization, and the formation of sp²/sp³ alloys with interlayer spacings between 2.8 Å and 3 Å. Sample A1's Peak III, with a d-spacing of 2.93 Å, is consistent with this, further corroborating the presence of sp³ states in Sample A1.

Consistent with Sample A1's blue-shifted mode of the G peak, its XRD profile reflects <100> compression. In the intralayer peak range, a <100> fitted peak is fitted with a maximum height at 2θ=30.401°, equivalent to a d-spacing of 2.09 Å. The peak is broad, indicating a broad range of <100> d-spacing values. A <100> d-spacing of 2.09 Å represents a compressive strain of ˜2% in the xy-plane compared to the 2.13 Å d-spacing of graphite.

The thermal oxidation profile of Sample A1 is shown in FIG. 107. The derivative of the sample's mass loss with respect to temperature is plotted. Sample A1's onset of thermal oxidation occurs between 450 C and 500 C. This is higher than Sample A3, and approximately the same as Sample A2. This indicates that compared to oxidized carbons like graphene oxide, there is a negligible amount of labile mass in Sample A1. The temperature of peak mass loss, at roughly 608 C, is lower than Sample A2's and higher than Sample A3's. Overall, these results are consistent with the temperature at which the CVD was performed; higher-temperature pyrolysis processes will typically create carbons with higher-temperature onset of thermal oxidation and peak mass loss due to increased crystallinity. The only exception in the trend is the early onset of thermal oxidation for Sample A2, which can be attributed to a minor presence of soot that was observed in certain regions of the sample. This soot-like phase was non-conformal to the substrate and presumably formed via gas-phase pyrolysis in free space due to the higher-temperature pyrolysis in Procedure A2. The remainder of Sample A2 exhibits more thermal oxidation stability than other samples, leading to the highest temperature of peak mass loss of all three samples.

FIG. 108 is an SEM image of Sample A2. Analysis of the image reveals the presence of carbon particles that appear to be fragmented perimorphic frameworks. Like Sample A1, the frameworks' templated morphology is apparent, and the perimorphic walls appear to have encapsulated and replicated the templating surface. Unlike Sample A1, however, the frameworks appear broken and deformed in many cases. This loss of their native morphology evidences the perimorphic walls' diminished ability to withstand the mechanical stresses encountered during liquid-phase template extraction and drying. This breakage, in view of the mildness of the extraction procedure, which involved gentle stirring and subsequent drying, suggests that the perimorphic frameworks do not comprise complete anthracitic networks, but instead vdW assemblies that can be easily broken and deformed by shear-related failure.

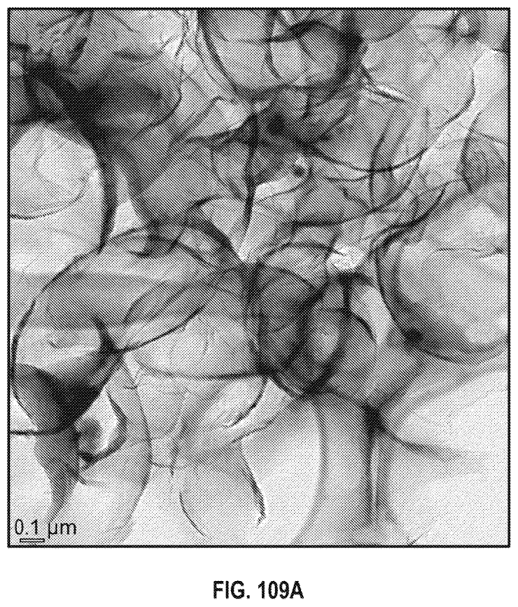

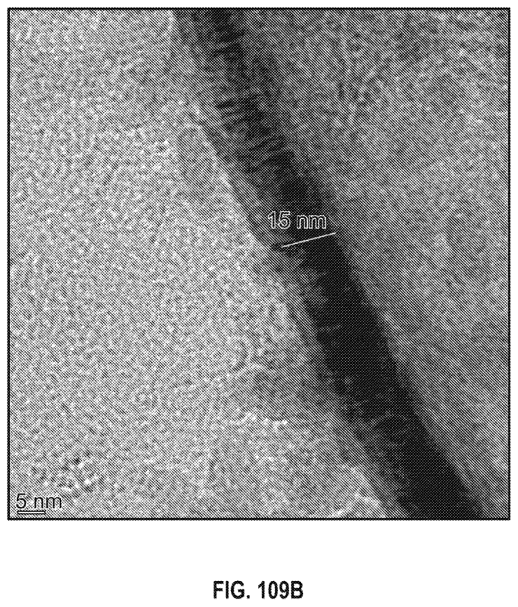

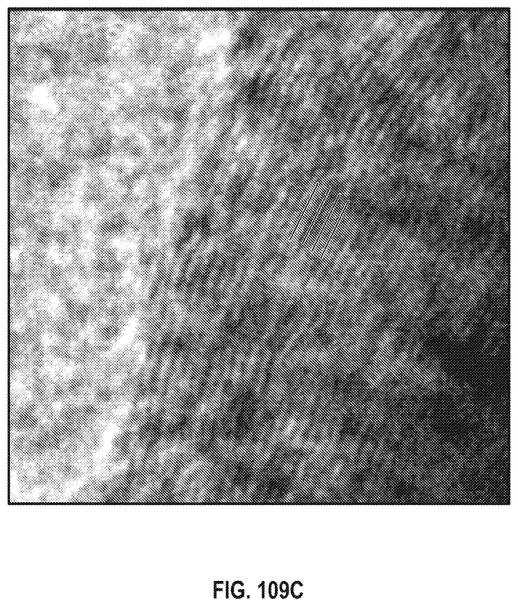

TEM analysis of Sample A2 corroborates the deformed, fragmented appearance of the frameworks in the SEM imagery. FIG. 109A is a TEM image revealing the extent of the damage incurred during template extraction. The appearance is very different compared to the largely intact, undeformed particles observed in Sample A1 (as shown in FIG. 98A). In FIG. 109B, the perimorphic walls are revealed to be of comparable thickness to the walls of Sample A1. The BET specific surface area of Sample A2 was measured at 127 m²g⁻¹, which was approximately 100% lower than Sample A1's (142 m²g⁻¹), suggesting that Sample A2's average wall thickness is between 20 and 21 layers—slightly thicker than Sample A1. The BJH specific porosity of Sample A2, at 0.37 cm³g⁻¹, was also similar to Sample A1's (0.35 cm³g⁻¹), although we again note that this measurement underestimates the contribution of larger macropores.

In FIG. 109C, the fringe lines associated with the layered architecture can be observed. In spite of the long-range curvature of the perimorphic wall, both dark and bright fringe lines are generally linear. This indicates the reduced ring-disorder and Gaussian curvature of these graphenic regions compared to the regions observed in Sample A1. The fringe lines, as traced in FIG. 109C, are substantially parallel, and we can therefore describe the layers as nematically aligned. While a few potential instances of fringe patterns associated with crosslinking dislocations could be identified, these were considerably scarcer than in Sample A1. While occasional crosslinking dislocations are present in these perimorphs, they were insufficient to form an anthracitic network.

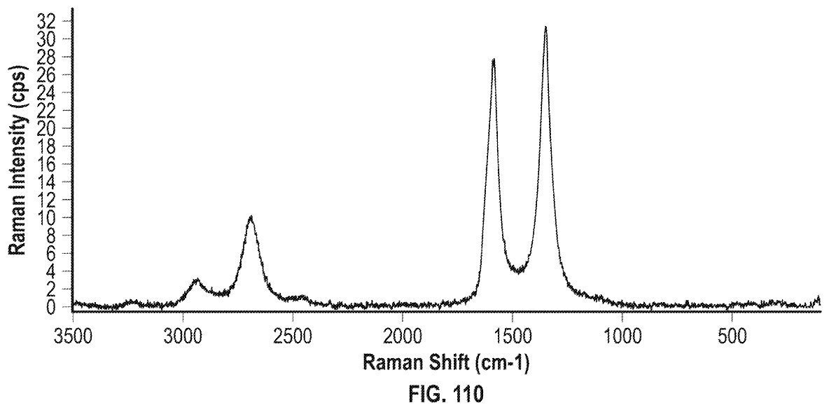

More information about the bonding structure of Sample A2 can be derived from its Raman spectra. A single-point Raman spectrum, taken using a 532 nm laser at 2 mW power, is shown in FIG. 110. No smoothing has been performed. The three dominant features of the profile are the Dᵤ peak at approximately 1349 cm⁻¹, the Gᵤ peak at approximately 1587 cm⁻¹, and the 2Dᵤ peak at approximately 2700 cm⁻¹.

Compared to Sample A1, Sample A2 has a much lower intensity Trᵤ feature, with an I_{Tr}_{ᵤ}/I_{G}_{ᵤ} ratio of less than 0.15. This is consistent with less contribution from an underlying, red-shifted mode of the G peak and the absence of ring disorder-induced tensile strain. The lack of ring disorder and associated stretching is in good agreement with the observation of less Gaussian curvature in FIG. 109C. Additionally, the Gᵤ peak's natural position at 1587 cm⁻¹ signifies an absence of the compressed regions that were present in Sample A1. The prominent presence of the 2Dᵤ peak indicates a turbostratic stacking arrangement of hexagonally-tiled layers in Sample A2.

Compared to Sample A1's average Dᵤ peak, Sample A2's average Dᵤ peak exhibits a higher intensity, with an average I_{Du}/I_{Gu} ratio is greater than 1.0. This, along with the emergence of a 2Dᵤ peak (with an average I_{2Du}/I_{Gu} ratio of 0.265) reflects the increased crystalline order of Sample A2 compared to Sample A1. While an increase in D band intensity in the spectrum of crystalline carbons corresponds to a decrease in crystallinity (e.g. in the amorphization of graphite to nanocrystalline graphite), Sample A1 is nanocrystalline, and so its higher D band intensity indicates increased crystalline order compared to Sample A2.

The Gᵤ peak is slightly asymmetrical due to the presence of a shoulder at approximately 1620 cm⁻¹. This originates from an underlying D′ peak at 1620 cm⁻¹, which becomes conspicuous due to Sample A2's high density of sp² edge states. The prevalence of sp² edge states is also indicated by the narrow Dᵤ peak centered at 1349 cm⁻¹. This D band does not appear to be significantly interpolated with any lower-frequency sp³ bands, indicating that most RBM phonons are being activated by sp² edge states, not by sp³ states associated with diamondlike seams. The D* peak observed in Sample A1 is also absent or negligible.

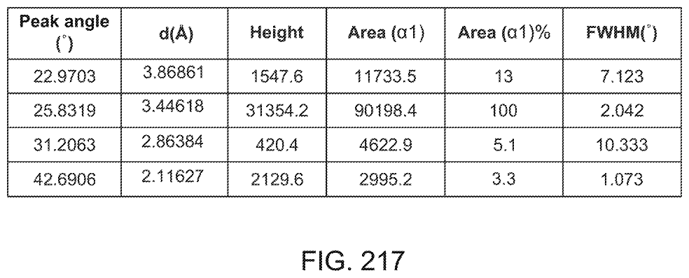

FIG. 217 contains the XRD peak angles, d-spacings, areas, area percentages (normalized to the area under the dominant peak at 2θ=25.8319°), and FWHM values (without correction for instrument broadening) for a sample synthesized using a procedure similar to Procedure A2, but from a magnesium carbonate feedstock powder. This powder was calcined to obtain an MgO powder with template particles indistinguishable from Sample A2's. As such, the XRD results from this carbon were analyzed to understand the crystal structure of assemblies like Sample A2.

Three peaks were fitted in the range of interlayer periodicities. The three fitted peaks are referred to as Peaks I, II, and III, where the ascending numbers correspond to the ascending 2θ values at which the peaks obtain their maximum intensity values. The largest fitted peak, as measured by the area under the peak, is Peak II, which obtains a maximum height at 2θ=25.8319° and a corresponding d-spacing of 3.45 Å. The area under Peak II is set at a value of 100%. The d-spacing value of Peak II is consistent with the <002> d-spacing of turbostratic graphitic carbon, and the peak is considerably sharper than Sample A1's Peak II.

Peak I has a maximum height at 2θ=22.9703°, equivalent to a d-spacing of 3.87 Å—a contraction from the corresponding d-spacing of 4.23 Å in Peak I of Sample A1. The area under Peak I is only 13% of the area under Peak II, making it a significant, but smaller phase, whereas the Peak I phase in Sample A1 was 32% of the area of Peak II. The presence of Peak I may reflect larger z-intervals at edge dislocations, or a reduced but not eliminated presence of non-hexagonal rings. The diminishing presence of large, irregular <002> d-spacings is again consistent with the appearance of Sample A2's more aligned, planar fringe lines, as shown in FIG. 109C.

Peak III indicates a minor presence of a contracted phase of interlayer spacing. With a maximum height at 2θ=31.2063°, equivalent to a d-spacing of 2.86 Å, the interlayer spacing represented by Peak III is significantly smaller than any interlayer spacing in a graphitic carbon. Peak III is also exceptionally broad, with a FWHM value of 10.33°. The area under Peak III is only 5.1% of the area under Peak II, making it a fairly insignificant phase. This is consistent with the scarcity of Y-dislocations observed in Sample A2.

Lastly, the intralayer periodicity at 2θ=42.6906° corresponds to a <100> d-spacing of 2.12 Å, which is close to the graphitic d-spacing of 2.13 Å. This corroborates the lack of compressive strain reflected in the Gᵤ peak's natural position at 1587 cm⁻¹. This may indicate that compressive strain is tied somehow to the formation of crosslinking dislocations and the xy-intervals over which they occur.

The thermal oxidation profile of Sample A2 is shown in FIG. 107. The derivative of the sample's mass loss with respect to temperature is plotted. The onset of thermal oxidation for Sample A2 occurs between 450° C. and 500° C., which is higher than Sample A3, and approximately the same as Sample A1. Sample A2's temperature of peak mass loss, at 650° C., is higher than both Sample A1's and Sample A3's, reflecting the increased stability of its nanocrystalline graphite structure. The greater breadth of temperature over which Sample A2 is thermally oxidized corresponds to the presence of easily oxidized soot, which causes an early onset of thermal oxidation.

A further practical demonstration of the degraded mechanical properties in Sample A2 vs. Sample A1 was obtain via a uniaxial compression test. In this test, the Sample A1 and Sample A2 powders were each uniaxially compressed to the same pressure. After compression, Sample A1 retained its powder form, suggesting a lack of compaction, while the Sample A2 powder was compacted into a firm, monolithic pellet.

SEM was performed to obtain a better understanding of the powders under compression. FIG. 111 is an SEM image of the Sample A1 perimorphic frameworks post-compression. The frameworks can be observed to have retained their porous morphology. While breakage of the perimorphic wall can be observed in many of the particles, other perimorphic walls exhibit linear features that were not present prior to compression. These linear features are indicated in FIG. 111 and magnified in the inset. In the inset, the perimorphic wall can be observed to have buckled inward, creating an internal fold that results in a linear surface feature. Many of the Sample A1 particles after compression exhibit local buckling, indicating that their perimorphic walls were able to bend locally. The retention of the frameworks' porous morphology indicates the walls' ability to resist inelastic shear yielding and to store elastic potential energy, springing back upon release of the uniaxial compression. This elasticity, owing to the anthracitic networking within the walls, prevents the frameworks from compacting irreversibly into a paper-like pellet.

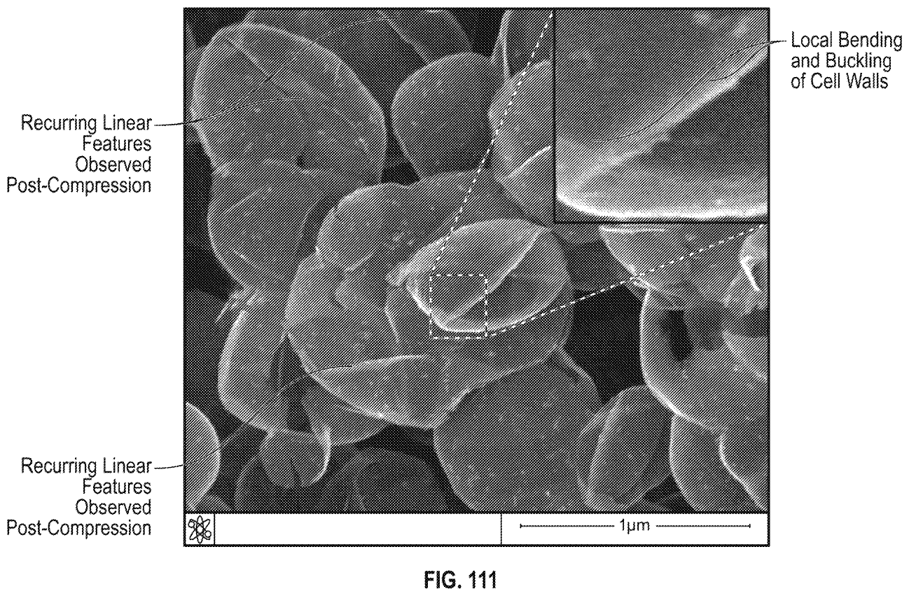

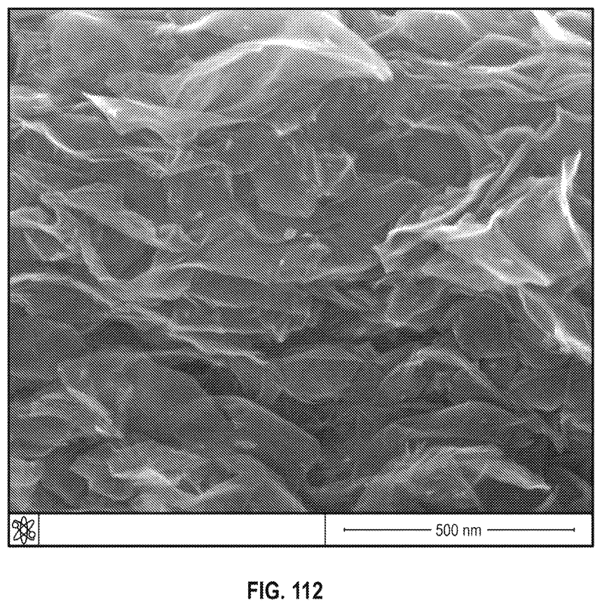

By contrast, FIG. 112 is an SEM image of the Sample A2 perimorphic frameworks after compression. The porous morphology of the Sample A2 frameworks have been destroyed. The resulting paper-like assembly of sheets is consistent with the observation of these frameworks' increased tendency to deform plastically and fragment during liquid-phase processing and drying. During compression, the layers within the perimorphic walls are able to shear apart due to the lack of anthracitic networking. The frameworks' lost porosity and compaction into a laminated structure is what creates the pellet, which cannot spring back upon release of the uniaxial compression due to a lack of stored elastic potential energy. Hence, the lack of anthracitic networking in the walls prevents the perimorphic frameworks in Sample A1 from being able to rebound.

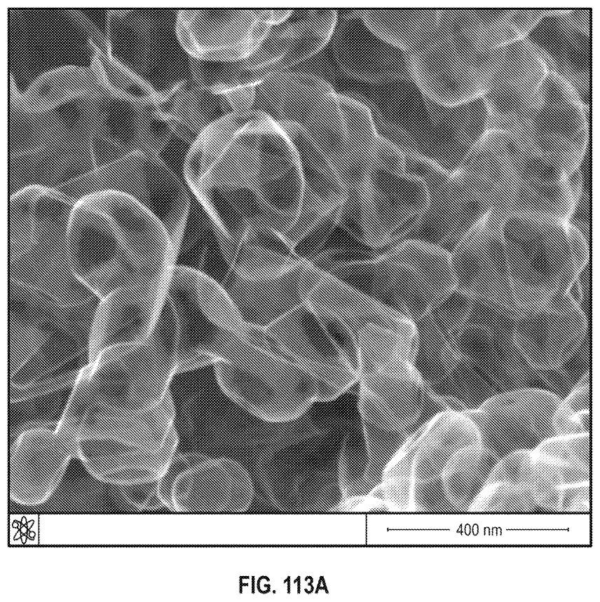

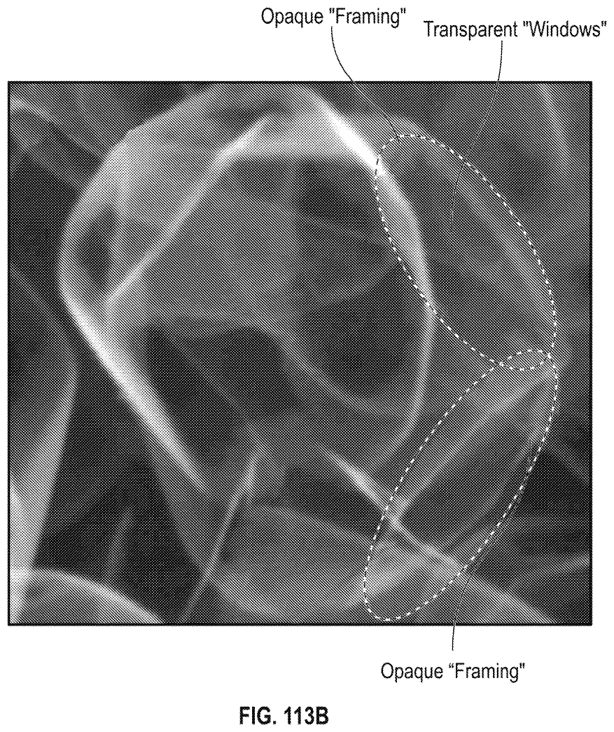

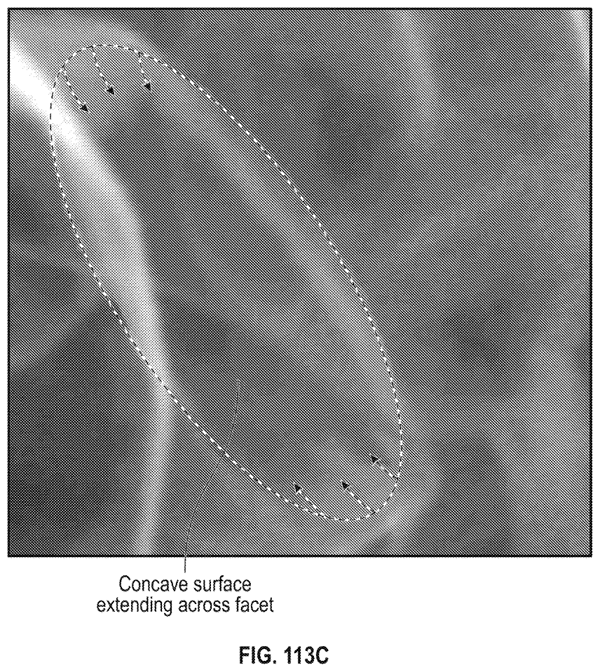

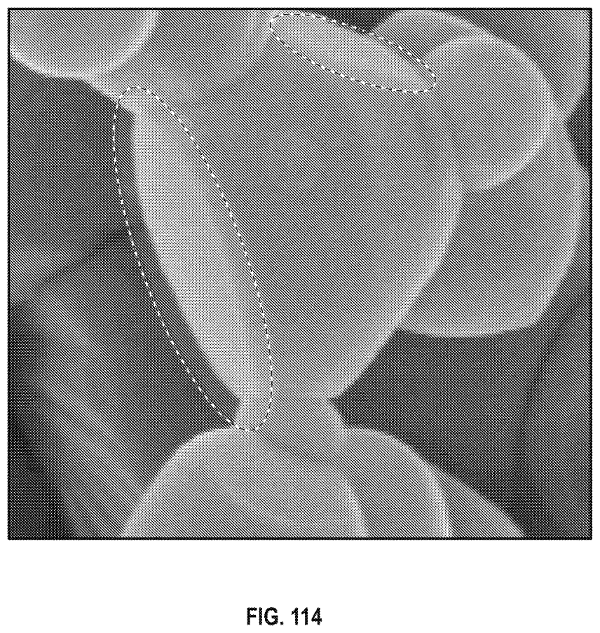

FIG. 113A is an SEM image of Sample A3. Like the particles in Samples A1, the perimorphic frameworks in Sample A3 retain their native pore-and-wall morphology without much sign of deformation. This morphology mirrors the template, which comprises a partially sintered powder of conjoined, polyhedral MgO crystals, as shown in FIG. 114. The conjoined subunits of the perimorphic frameworks possess large, flat facets and appear more polyhedral than those in Sample A1. In the SEM micrograph of FIG. 113A, it is unclear where individual frameworks begin or end, or how many distinct frameworks there might be in this image.

Compared to the perimorphic walls in Samples A1 and A2, which exhibited a consistent appearance, the walls in Sample A3 have regions that are transparent and regions that are opaque. The transparent regions are found within the flat facets of the frameworks and at first glance appear to be holes in the perimorphic wall. FIG. 113B is a magnified view of a polyhedral, perimorph present in FIG. 113A. Two transparent areas (“windows”) are circled. The windows are located in the central area of flat facets, as labeled in FIG. 113B, and they are ringed by a narrow, more electron-opaque strip running around the perimeter of the facet. These strips are referred to herein as “framing,” because they give the windows a framed appearance, as shown in FIG. 113B. The framing on a facet typically hugs the facet's edges, although occasional, more electron-opaque tendrils can be observed extending inward.

As shown by the arrows in FIG. 113C, the framing around a window generally points across the window toward the framing on the opposing side, as though the framing were cohered to a transparent surface. In the facet shown in FIG. 113C, and in many other instances that were readily identified, the gentle, inward (i.e. toward the cell's interior) curvature of the framing could be extrapolated to extend across a slightly concave, transparent surface. This slight concavity is indicated by the curvature of the arrows. This is the first indication that the windows are not physical holes in the perimorphic walls.

If no such transparent surface were in fact present to guide the framing, we would expect to see it bent, frayed, or curled irregularly by the mechanical stresses of template removal and drying. These irregularities would not be expected, however, if the framing were supported by a transparent region of the wall stretching across the facet, like a connective tissue. Instead, it would indicate the geometry of the transparent surface, which might be expected to be slightly concave due to the inward pull of the receding water during evaporative drying of the framework, creating a slight concavity. Indeed, this was the appearance of all of the framing. The conclusion from SEM analysis is that the windows observed in Sample A3 are not holes, but a more electron-transparent phase of the wall.

A phase change in the carbon from the edges of a flat facet to the central area of the facet has been observed by previous researchers. When performing CVD growth of perimorphic frameworks on NaCl cubes, a distinct phase of the wall was identified at the edges and corners of the NaCl facets (where nucleation occurred due to localized melting of the NaCl in these areas). Based on Raman analysis, these regions comprised a multilayer vdW assembly of small graphenic domains. A second phase of larger, more crystalline domains within the perimorphic wall was found in the central area of each facet—i.e. the area where there was less melting and nucleation. These perimorphic walls were broken during dissolution of the template and drying, creating platelet-like fragments. The degeneration of these frameworks stands in contrast to the intactness of the perimorphic frameworks in Sample A3, where no observable platelet-like fragments were observed in the dried carbon powder. The observation that the windows in Sample A3 do not break away and become independent platelet-like particles is a compelling indication that the walls in Sample A3 comprise an anthracitic network rather than a vdW assembly.

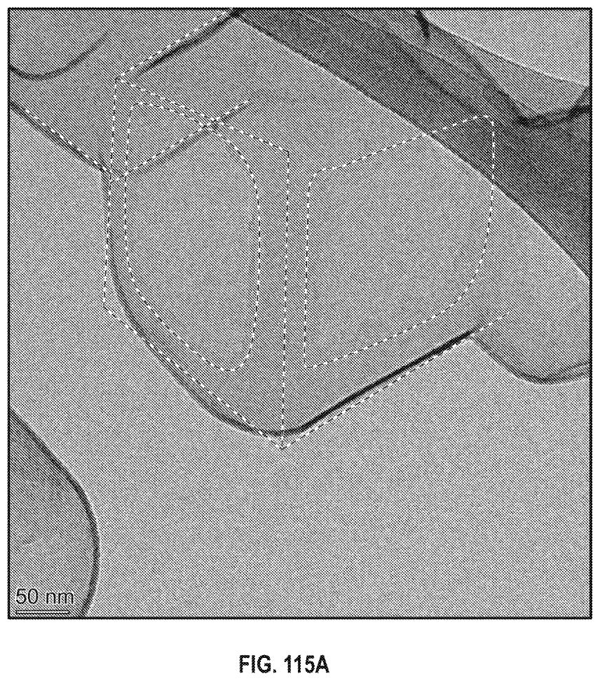

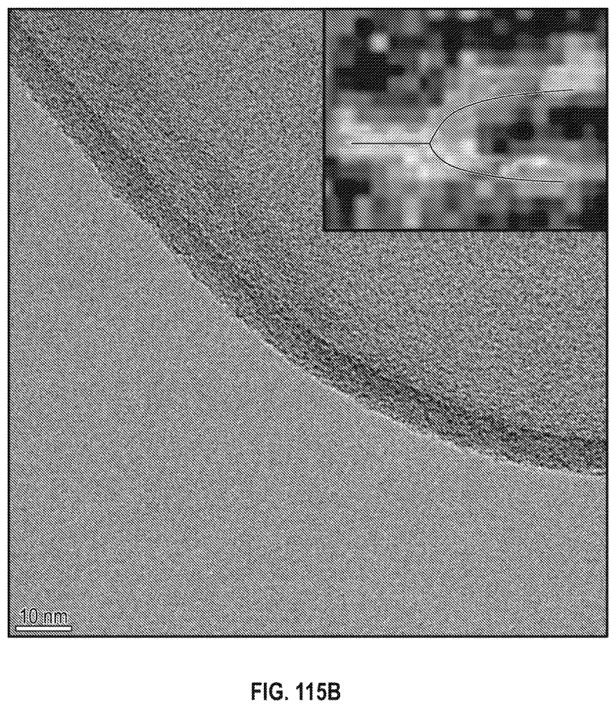

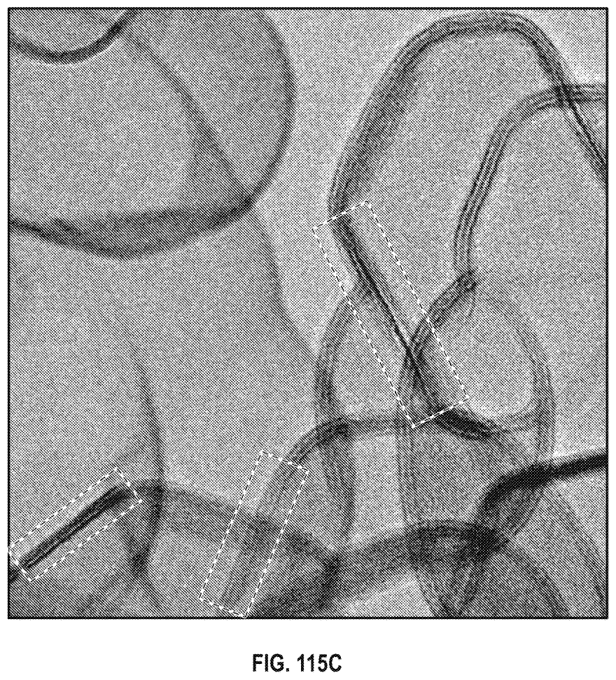

FIG. 115A is an HRTEM image of Sample A3 that shows its overall microstructure. The macroporous subunits of the perimorphic framework shown in FIG. 115A are cuboidal, and dashed lines are used to facilitate a visualization of their cuboidal shape. The more electron-transparent windows on the flat facets of the subunits have been circled with dashed lines in FIG. 115A. Sintering of the MgO template crystals, upon displacement of the template, imparts the endocellular passages that can be observed between the subunits.

The perimorphic walls in Sample A3 are somewhat thinner than the walls in Samples A1 and A2. Consistent with this, Sample A3 has a higher BET specific surface area of 328 m²g⁻¹. This BET measurement suggests an average wall thickness of approximately 8 layers (2630 m²g⁻¹/328 m²g⁻¹=8.0). Cross-sections of the perimorphic walls reveal that they are fairly uniform in thickness and do not exhibit any discontinuities, even in the central regions of flat facets. This is shown in FIG. 115C, where the cross-section of the cell wall across several flat facets (indicated by the dashed rectangles) is uniformly thick and uninterrupted. This was confirmed by observation of numerous facets from many different angles and is another indication that the windows are not holes, but simply transparent regions of the perimorphic wall.

Like Sample A1, Sample A3 exhibits numerous Y-dislocations. A typical fringe pattern drawn from Sample A3 and associated with a Y-dislocation is shown in the magnified inset of FIG. 115B. The ubiquitous presence of Y-dislocations is another indication of the anthracitic networking responsible for the robustness of the Sample A3 frameworks. Additionally, the layering within Sample A3's walls, like the layering in Sample A1's walls, exhibits nematic alignment. However, distinct fringe lines in Sample A3 are more difficult to trace visually over any distance greater than 1-2 nm, suggesting a more crosslinked anthracitic network.

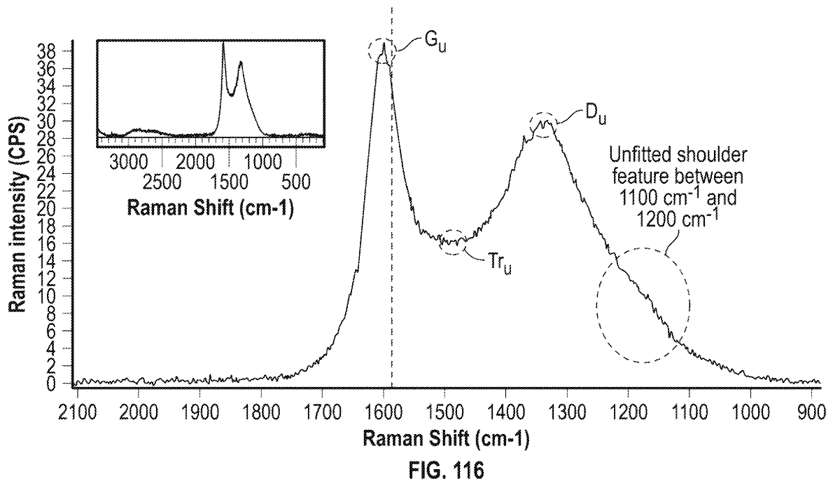

These observations are corroborated by Sample A3's Raman spectra. A single-point Raman spectrum, taken using a 532 nm laser at 2 mW power, is shown in FIG. 116. No smoothing has been performed. For reference, the full spectrum is shown in the inset of FIG. 116. The overall Raman profile of Sample A3 looks similar to Sample A1 and to anthracite. No 2Dᵤ peak is present. The Dᵤ peak is centered at approximately 1340 cm⁻¹, reflecting more D band interpolation than was observed in Sample A1 (A1's Dᵤ peak was centered between 1345 and 1350 cm⁻¹). This increased interpolation of the D band reflects an increasing prevalence of RBM phonons activated by sp³ states vs. sp² edge states. Like Sample A1, Sample A3 has a shoulder between 1150 cm⁻¹ and 1200 cm⁻¹, indicating an underlying D* peak that is consistent with the transitions that occur at sp^{x} diamondlike seams. This shoulder is labeled in FIG. 116.

Also similar to Sample A1, Sample A3 exhibits a relatively sharp, blue-shifted Gᵤ peak (the usual G peak position at 1585 cm⁻¹ is marked with a dashed line in FIG. 116). This blue-shifted mode implies compressive strain. Compared to Sample A1, Sample A2 exhibits a slightly lower trough (I_{Tr}_{ᵤ}/I_{G}_{ᵤ} peak=0.40). However, the trough is still high enough to indicate the presence of a broad, underlying peak. We again assign this to a red-shifted mode of the G band, associated with the presence of ring-disordered regions.

The I_{D}_{ᵤ}/I_{G}_{ᵤ} peak intensity ratio is approximately 0.77, indicating a lower Dᵤ peak intensity in Sample A3 compared to Sample A1. This downward trend in the Dᵤ peak intensity (A2>A1>A3) is positively correlated with the CVD temperature (1050° C.>750° C.>650° C.) and also positively correlated with D band interpolation (i.e. with the increasing prevalence of RBM phonons activated by sp³ carbon). This decreasing Dᵤ peak intensity in disordered carbons is attributable to the progressive loss of sp² ring structure; in the case of Sample A3, this occurs as sp² rings are replaced with sp^{x} rings. The D band's intensity falls as the density of diamondlike seams increases. Therefore, this is consistent with the appearance of a more crosslinked anthracitic network in HRTEM images of Sample A3.

From our characterizations of Samples A1, A2, and A3, we can deduce the tectonic pathway by which diamondlike seams are formed during growth. We begin this discussion with the observation that the window regions of the perimorphic wall are electron-transparent, whereas the surrounding framing, and curved regions of the perimorphic wall, are not. We then connect this to an analysis of nucleation and growth of primordial domains over a templating surface. Finally, we model tectonic encounters between these primordial domains, and show how, under the right circumstances, diamondlike seams are evolved from these encounters.

The non-uniformity of electron transparency in Sample A3, as shown in FIG. 113A-113C, arises due to different charging behaviors in different regions of the perimorphic wall. During imaging, more charging occurs in areas of the perimorphic wall that are more electrically insulating. This charging behavior is clearly tied to the geometry of the templating surface. The more conductive windows are associated with atomically flat templating surfaces, such as the facets labeled in FIG. 114, where nucleation of primordial domains was minimal or absent. The less conductive framing and rounded regions of the perimorphic wall are associated with more defective regions of the templating surface, where nucleation of primordial domains was comparatively dense.

Next, we recall that, based on the interpolation of Sample A3's Dᵤ peak, a significant fraction of Sample A3's RBM phonons are activated by sp³ states, which we have associated with diamondlike seams throughout the anthracitic network. In regions of the wall with a greater density of diamondlike seams, and therefore a greater density of sp³ states, we would expect charging to increase due to discontinuities in the R cloud, through which conduction occurs. In regions of the wall with a lesser density of diamondlike seams, and therefore a lesser density of sp³ states, we would expect less charging should occur. Tying these observations together, it appears that regions of the perimorphic wall associated with higher nucleation density appear to charge more, and we attribute this to a greater density of sp³ states associated with diamondlike seams. We further attribute the greater density of sp³ states and diamondlike seam in these regions to their origin in the grafting that occurs at the tectonic interfaces of primordial domains growing over a common substrate surface. Dense, localized nucleation causes the primordial domains to proliferate, leading to increased tectonic interactions, more grafting, and therefore more sp³ states and diamondlike seams.

Next, we analyze the tectonic encounters between these primordial domains. Ring-disordered lattices possess nonzero Gaussian curvature, and their edges have an undulating geometry determined by the local lattice curvature. The ring disorder of primordial domains grown via pyrolysis at temperatures below 900° C. has been evidenced by several examples in the prior art, including the growth of ring-disordered domains on single-crystal MgO <100> wafers and single-crystal germanium <100> wafers. When two such primordial domains are grown over a common substrate surface, a tectonic encounter may occur between their edges. Since the domains' local lattice curvatures and undulating edges are not in phase, this tectonic encounter creates a stochastic, incoherent tectonic interface between the nearby edge segments. Adding to this complexity, the edges of the primordial domains can be conceptualized as a constantly self-rearranging fluid of free radicals. The incoherence of the interface, where the edge atoms of one primordial domain are not consistently above, below, or level with the edge atoms of the other domain, prevents resolution via simple subduction or sp² grafting.

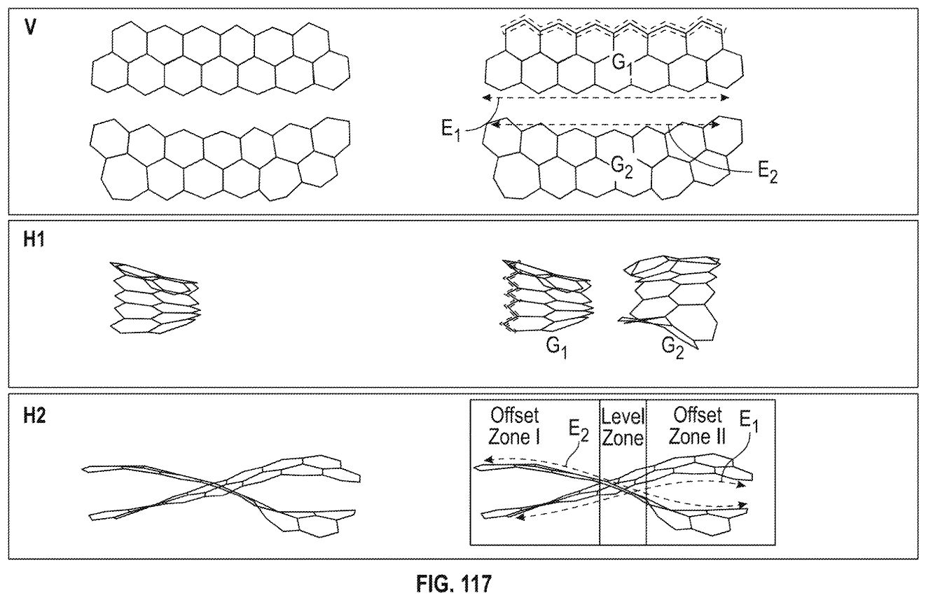

In FIGS. 117-124, we provide a stepwise illustration of how sp² and sp³ grafting at an incoherent tectonic interface may lead to the sp³ states and diamondlike seams that cause local charging in perimorphic regions associated with dense tectonic activity, as observed in Sample A3. In reference to the molecular models provided in these figures, and also in reference to all of the other molecular models that follow throughout the remainder of the disclosure, a few comments are in order. First, while we must represent these systems statically, our molecular models should be understood as static representations of dynamic, self-rearranging structures. Second, all such illustrations, which were made using molecular models constructed using Avogadro 1.2.0 software, should be considered as representing only rough, geometric approximations of actual systems. They are meant to provide a helpful, visual illustration of the phenomena described herein. Third, while we do not illustrate the substrates, the pyrolytic growth processes with which we are most concerned in the present disclosure are directed by substrates, and the absence of the substrate in the system is not intended to imply that no substrate is present. Fourth, we do not represent hydrogen atoms in these illustrations because our primary focus is on the evolution of the graphenic structures, which exclude hydrogen by definition. However, in actuality, we understand that hydrogenation and dehydrogenation of these graphenic structures is theorized to be occurring dynamically throughout pyrolytic carbon formation. Fifth, we provide multiple perspectives in order to facilitate visual inspection and understanding of these systems in three dimensions. Sixth, while for purposes of explanation we often represent a sequential evolution of the systems under consideration, we do not mean to imply that the sequences, as illustrated, are strict or universal. Seventh, what we intend to demonstrate is how diamondlike seams, chiral columns, and screw dislocations are derived from sp² grafting and sp³ grafting across tectonic interfaces. We attempt to model how this happens using the simplest models possible for the purposes of communicating the basic concepts.

In the illustration of FIG. 117, an incoherent tectonic interface is shown. The interface is formed by the tectonic encounter between two edge segments (E₁ and E₂), each of these participating edge segments belonging to a different ring-disordered graphenic structure (G₁ and G₂, respectively). These edge segments and graphenic structures are labeled in FIG. 117. The tectonic interface between them is described as the E₁-E₂ interface. We can think of G₁ and G₂ as primordial domains nucleated on a common substrate surface.

The E₁-E₂ tectonic interface in FIG. 117 comprises a zigzag-zigzag interface—i.e. an interface in which both of the participating edge segments are in the zigzag orientation. This configuration may evolve as the growing, graphenic structures rearrange themselves, in keeping with free radical condensate growth. From the H2 perspective in FIG. 117, we can see that the primordial domains G₁ and G₂ are both curved. Accordingly, their edges have an undulating geometry. The incoherence of the edges' z-deflections at the tectonic interface results in three distinct interfacial zones-two offset zones, labeled as “Offset Zone I” and “Offset Zone II,” which are located to the sides of the E₁-E₂ tectonic interface, and a level zone between them. These tectonic zones are labeled in FIG. 117.

The vertical offset within an offset zone is such that opposing edge atoms cannot form sp²-sp² bonds to their counterparts without severe lattice distortion subduction. Subduction of one edge by the other is also unfavorable. In an offset zone, under the right pyrolytic conditions, edge atoms may undergo sp²-to-sp³ rehybridization and form a sp³-sp³ bond line, grafting the primordial domains together is edge-to-edge. The formation of sp³ states to form bonds in offset zones is herein described as “sp³ grafting.”

In a level zone, the vertical offset between the two edges is small enough and the 2p_{z} orbitals of opposing sp² edge atoms are sufficiently aligned to allow π bonds to be formed between the edge atoms. In these zones, under the right pyrolytic conditions, the edge atoms may form a line of sp²-sp² bonds to one another. This is similar to the sp² grafting that has been observed between ring-ordered domains in the prior art, except that sp² grafting at incoherent interfaces is localized at level zones.

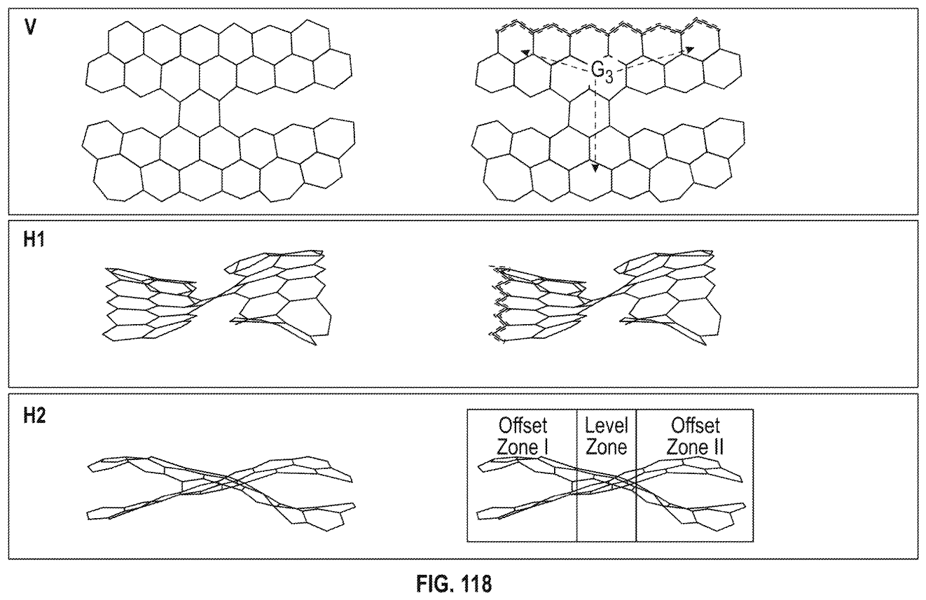

In the illustration of FIG. 118, the system has been modified by sp² grafting within the level zone, which is premised upon the minimal vertical offset between opposing sp² atomic members of E₁ and E₂ and sufficient alignment of their 2p_{z} orbitals. The resulting line of 2 sp²-sp² bonds forms a new 6-member ring that ring-connects the primordial domains E₁ and E₂, which thereby coalesce into a new graphenic structure, designated G₃. The new graphenic structure G₃ is labeled in the vertical perspective of FIG. 118. The formation of the new sp² ring, as represented in FIG. 118, causes some aligning distortion of the resulting G₃ domain. It is worth noting that in some cases, grafting events may distort the original interface, extending or shortening the interfacial zones dynamically.

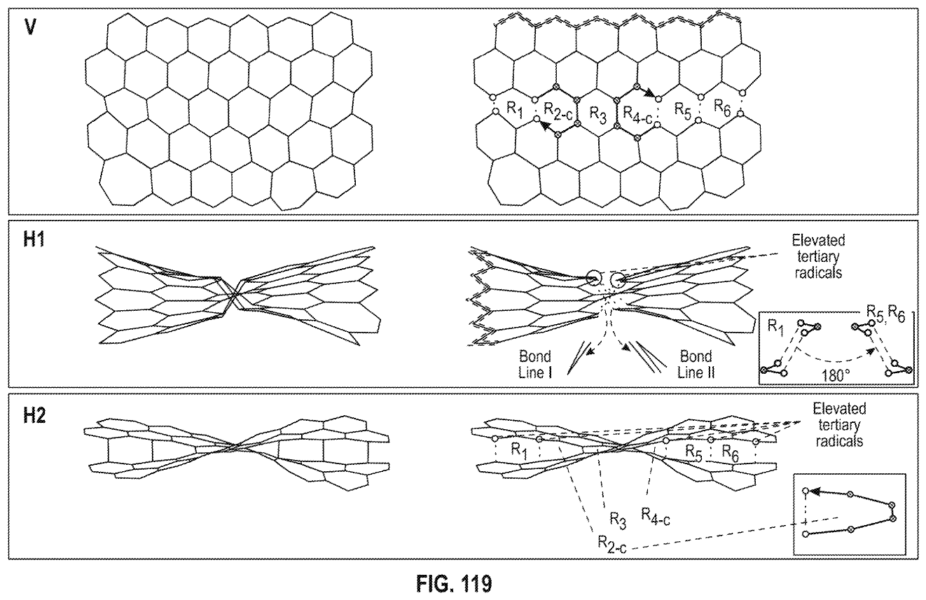

In the illustration of FIG. 119, the graphenic structure G³ illustrated in FIG. 118 has been structurally modified by sp³ grafting within the 2 offset zones, which is premised upon the substantial vertical offset between the edge atoms in these zones. This involves the sp²-to-sp³ rehybridization of 10 B₃ edge atoms and the associated formation of 5 sp³-sp³ bonds (indicated by dashed lines in FIG. 119), which are organized into 2 distinct sp³-sp³ bond lines. From the vertical perspective, we can see that the formation of the 5 sp³-sp³ bonds create 5 new sp^{x} rings across the original E₁-E₂ tectonic interface. From the H₁ perspective, we can see that the 2 sp³-sp³ bond lines (Bond line I, corresponding to Offset Zone I, and Bond line II, corresponding to Offset Zone II) have opposite orientations.

The 6 rings formed via sp² grafting and sp³ grafting are labeled in FIG. 119. On each side of the 6-member sp² ring associated with the level zone (designated R₃), there is a 6-member sp^{x} ring (designated R_{2-C} and R_{4-C}). In both R_{2-C} and R_{4-C}, the 6-member sp^{x} ring contains a chiral chain. The chiral chain contains the sp^{x} ring's 4 sp² atoms and is terminated at each end by the ring's 2 sp³-hybridized atoms. These sp³ sites are bonded to each other via a sp³-sp³ bond, closing the ring. This is diagrammed in the H₂ perspective of FIG. 119, where R₂-c's chiral chain is indicated by an arrow, where the direction of the arrow coincides with the direction of increasing z-directional elevation. The sp² atoms within the chiral chain are represented as pattern-filled circles, whereas the sp³ atoms at the chiral chain's termini are represented as white circles. The sp³-sp³ bond between these two terminal sp³ atoms is indicated by a dashed line. These two sp^{x} rings containing chiral segments represent chiral rings and are designated R_{2-C} and R_{4-C} in FIG. 119.

Due to the chiral geometry imposed by their chiral chains, the sp^{x} rings R_{2-C} and R_{4-C} represent chiral rings. Both of these chiral rings in FIG. 119 are formed at a transition between a level zone and a laterally adjacent offset zone. It is this tectonic zone transition, and the associated change in edge elevations, that creates the chiral chain. Consequently, chiral rings are formed at interfacial zone transitions, and their chirality is determined by the zone transitions where they are formed.

In FIG. 119, the remaining 3 sp^{x} rings (R₁, R₅, and R₆) are in the chair conformation. They exhibit two distinct orientations, as diagrammed in the H1 perspective of FIG. 119. Each orientation represents a point reflection of the other orientation in the xy-plane. These orientations are predetermined based on the geometry of the offset zones in which R₁, R₅, and R₆ are formed. R₁ was formed by grafting across Offset Zone I, where E₂ was elevated over E₁; therefore, R₁ is elevated on what was originally the E₂ side. On the other hand, R₅ and R₆ were formed by grafting across Offset Zone II, where E₁ was elevated over E₂; therefore, R₅ and R₆ are elevated on what was originally the E₁ side. This reversal in edge elevation is the reason for the point-reflected orientations of these sp^{x} rings (and the opposite orientations of the two sp³-sp³ bond lines).

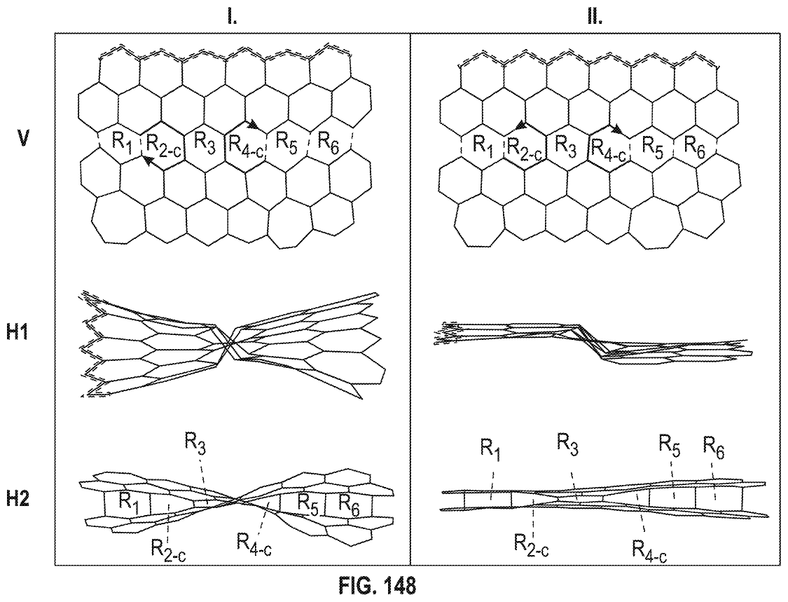

The inversion of the edge elevations between the two offset zones also imposes the same chirality on the chiral rings R_{2-C} and R_{4-C} formed at the zone transitions to either side of the level zone. If the edge elevations had not been inverted between Offset Zone I and Offset Zone II, R_{2-C} and R_{4-C} would have had opposite chirality. This alternative scenario is illustrated in Frame II of FIG. 148.

Following sp³ grafting within the offset zones, the sp³ atoms in FIG. 119 are only threefold-coordinated and represent tertiary radicals. Associated with the 5 sp³-sp³ bonds in FIG. 119 are 5 sp³ atoms that represent elevated tertiary radicals. These elevated tertiary radicals are circled in the H1 perspective of FIG. 119 and are indicated in the H2 perspective by white circles. Each of these 5 elevated radicals have an unpaired electron extending into the z-space above.

The graphenic structure G₃ shown in FIG. 119 represents a “base”—i.e. a base-layer formed by the grafting of primordial domains during pyrolytic growth. After grafting, a base may exhibit tertiary radical sites, such as those in FIG. 119, extending into the z-space. Formation of the base eliminates the sp² edge states associated with the disconnected primordial domains. In regions of the base corresponding to offset zones, the primordial domains' sp² edge atoms are transformed into sp³ interior atoms. In regions of the base corresponding to level zones, the sp² edge atoms are replaced with sp² interior atoms. These replacements change the Raman spectrum of the base—specifically, there are fewer sp² edge atoms to activate RMB phonons, while sp³ states proliferate.

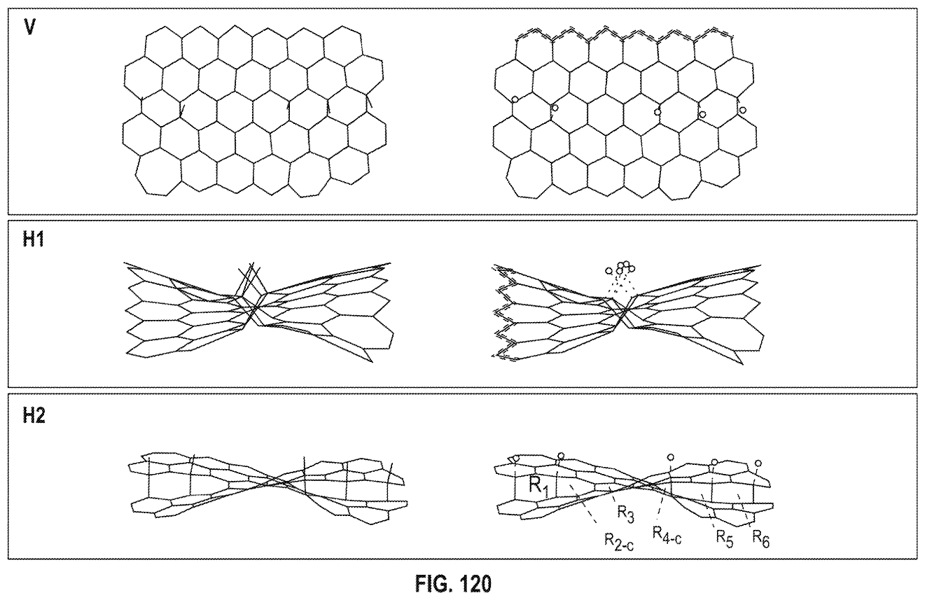

In the illustration of FIG. 120, radical addition reactions at the 5 elevated tertiary radicals of the base G₃ have occurred, bonding 5 z-adjacent sp³ carbon atoms to G₃. The 5 z-adjacent sp³ atoms are represented by white circles in FIG. 120. Their addition creates a second tier of sp³-sp³ bond lines above the base-layer tier (i.e. Bond Lines I and II). These new sp³-sp³ bonds are indicated by dashed lines in FIG. 120.

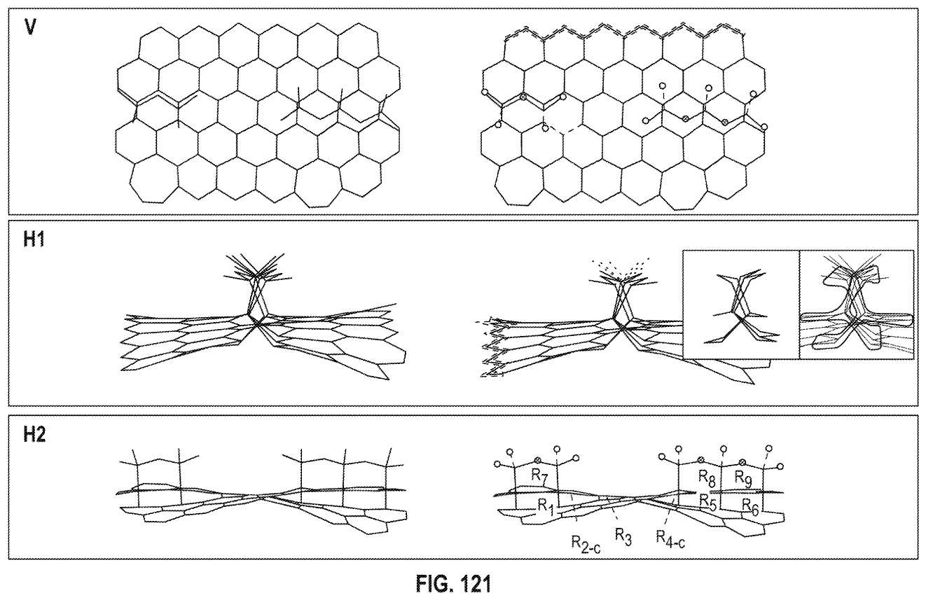

In the illustration in FIG. 121, continued radical addition reactions above the base have resulted in the addition of 9 sp³ atoms (indicated by the 9 white circles in the V and H2 perspectives of FIG. 121) and 3 sp² atoms (indicated by the 3 pattern-filled circles in the V and H2 perspectives of FIG. 121). These atomic additions result in the formation of a third tier of sp³-sp³ bond lines (indicated by dashed lines in the V and H2 perspectives of FIG. 121) above the second tier of sp³-sp³ bond lines. We note now that the orientations of each successive tier of sp³-sp³ bond lines is a point-reflection of the orientations in the tier above or below.

The addition reactions also result in the formation of 3 additional 6-member sp^{x} rings (designated as R₇, R₈, and R₉ and labeled in FIG. 121) located z-adjacent to the 3 sp^{x} rings R₁, R₅, and R₆, respectively. Because each of the new sp^{x} rings shares more than 1 atomic member with an sp^{x} ring in the base below it, each of these sp^{x} rings is ring-adjacent to the sp^{x} ring below it. A new, augmented graphenic structure is created by the vertical addition of these 3 sp^{x} rings; we can designate this new graphenic structure as G₄.

Like the sp^{x} rings R₁, R₅, and R₆ located below them, the sp^{x} rings R₇, R₈, and R₉ are in the chair conformation, and each has an orientation representing a point-reflection of the sp^{x} ring below it. Together, the z-adjacent sp^{x} rings R₁ and R₇ comprise a first diamondlike seam, and the other 4 sp^{x} rings (R₅, R₆, R₈, and R₉) comprise a second, distinct diamondlike seam, with the 2 diamondlike seams (isolated in the magnified inset of the H1 perspective of FIG. 121) creating nascent Y-dislocations oriented in opposite directions (as indicated by the circling of the Y-dislocations in the magnified inset of the H1 perspective). The diamondlike seams terminate internally with chiral rings (or, as the seams expand vertically, in chiral columns). In the H2 perspective of FIG. 121, we can see that the chiral rings R_{2-C} and R_{4-C} are located at the inner termini of the diamondlike seams.

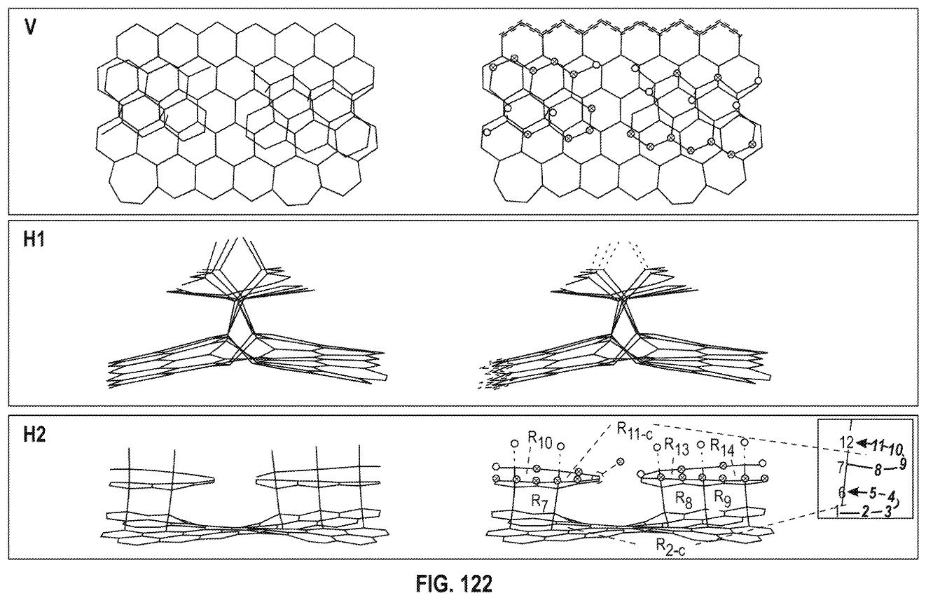

In the illustration of FIG. 122, continued radical addition reactions above the base have resulted in the addition of 9 sp³ atoms (indicated by the 9 white circles in the V and H2 perspectives of FIG. 122) and 18 sp² atoms (indicated by the 22 pattern-filled circles in the V and H2 perspectives of FIG. 122). Meanwhile, some primary carbon atoms from the previous stage have become three-fold coordinated sp² atoms. In this illustration, we begin to see that continued radical addition reactions are driving both vertical sp³ growth and lateral sp² growth above the base. A fourth tier of sp³-sp³ bond lines above the third tier of sp³-sp³ bonds are indicated by dashed lines in the V and H2 perspectives of FIG. 122.

Located directly above and ring-adjacent to the 3 sp^{x} rings R₇, R₈, and R₉ in FIG. 122 are 3 new 6-member sp^{x} rings, designated as R₁₀, R₁₃, and R₁₄. Located above the chiral ring R_{2-C} is a new 6-member chiral ring, designated R_{11-C}. This new chiral ring is labeled in the H2 perspective. To facilitate visual discernment of the z-adjacent chiral rings R_{2-C} and R_{1-C}, they are isolated in the magnified inset in the H2 perspective. The atomic members of R_{2-C} and R_{11-C} are labeled 1, 2, 3, . . . , 6 and 7, 8, 9, . . . , 12, respectively, with sp² members being depicted with bolded numbers and sp³ members being depicted with plain numbers. From this, we can see that, like R_{2-C}, R_{11-C} contains a chiral chain. The chiral chains of both rings are indicated by arrows in the magnified inset of the H2 perspective in FIG. 122, where the direction of the arrows coincides with increasing elevation in the z-direction. The chiral chain of R_{2-C} includes the atoms 1 through 6, where the atomic termini 1 and 6 comprise sp³ atoms connected to each other via a sp³-sp³ bond. The chiral chain of R_{11-C} includes the atoms 7 through 12, where the atomic termini 7 and 12 comprise sp³ atoms connected to each other via a sp³-sp³ bond.

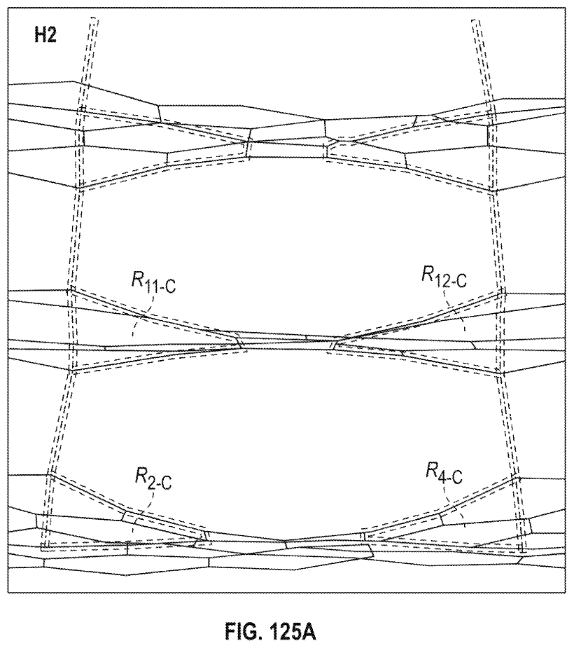

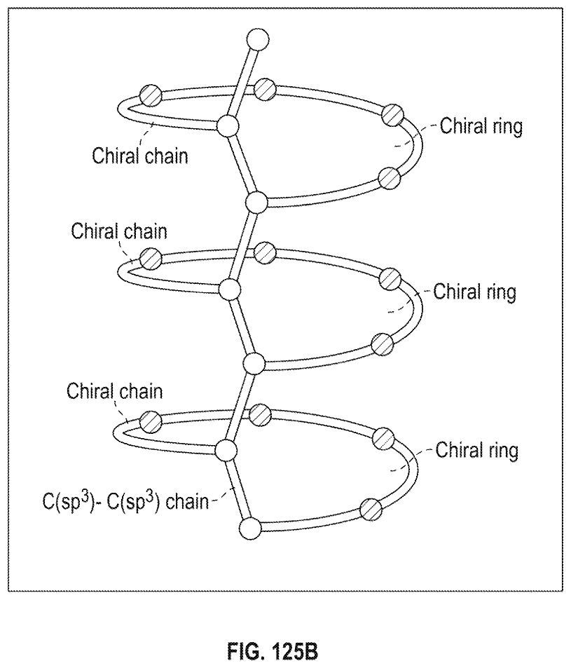

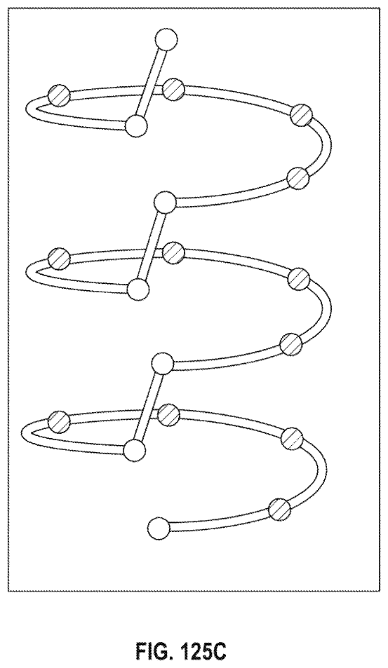

These 2 z-adjacent chiral rings are connected via a z-directional chain of sp³-sp³ bonds (comprising the sp³ member atoms labeled 1, 6, 7, and 12). Together, the chiral rings and the z-directional chain of sp³-sp³ bonds comprise a chiral column. Chiral columns, like chiral rings, are found at the inner termini of diamondlike seams in anthracitic networks. The basic architecture of a chiral column may be elucidated by comparing the magnified inset of the H₂ perspective in FIG. 122, in which the R_{2-C}-R_{11-C} chiral column is isolated, with the diagram of a chiral column in FIG. 125B. Within the chiral column is a helical, one-dimensional chain of sp² and sp³ atoms (i.e. an “sp^{x} helix”) comprising atoms 1 through 12. The basic architecture of an sp^{x} helix is diagrammed in FIG. 125C.

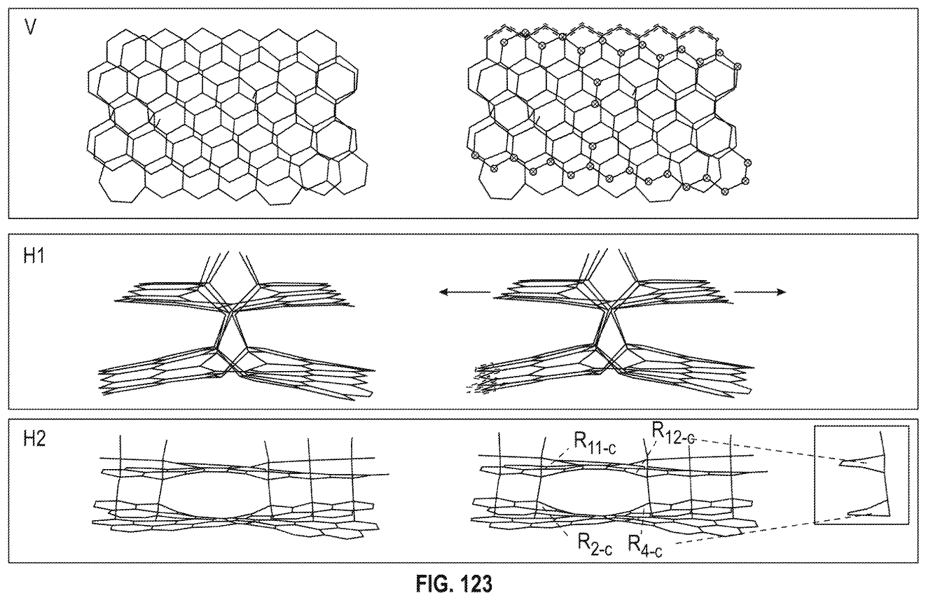

In the illustration of FIG. 123, continued growth above the base had resulted in the addition of 32 new sp² atoms (indicated by the 32 pattern-filled circles in the V and H₂ perspectives of FIG. 123). Meanwhile, some primary carbon atoms from the previous stage have become three-fold coordinated sp² atoms. In this illustration, we see that the rings above the base have coalesced into a second-layer nucleus that is substantially xy-aligned with the base and has zigzag edge segments substantially parallel to the original tectonic interface. Further sp² growth can proceed laterally from this higher-layer nucleus, as indicated by the black arrows in the H1 perspective of FIG. 123. From the vertical perspective of FIG. 123, we can see that the second layer is slightly twisted with respect to the first. This is known as Eshelby twist and is produced by chiral defects, such as chiral columns.

The continued growth reflected in FIG. 123 has formed another chiral ring, R_{12-C}, above the base-layer chiral ring, R_{4-C}. As shown in the magnified inset of the H2 perspective in FIG. 123, these two z-adjacent chiral rings are connected via a z-directional chain of sp³-sp³ bonds, creating a second chiral column (and within it, a second sp^{x} helix). Because of the common chirality of the chiral chains in the base-layer rings R_{2-C} and R_{4-C}, the two chiral columns formed above R_{2-C} and R_{4-C} also have a common chirality. The common chirality of these two chiral columns increases the angle of Eshelby twist.

The multilayer graphenic system illustrated in FIG. 123 is classified herein as an anthracitic network. Laterally and vertically crosslinked by Y-dislocations and chiral columns constructed from sp^{x} rings, the entire anthracitic network comprises a single, ring-connected graphenic structure and is described herein as an “sp^{x} network.” We can begin to see that as sp^{x} networks grow, sp³ states are continually proliferated.

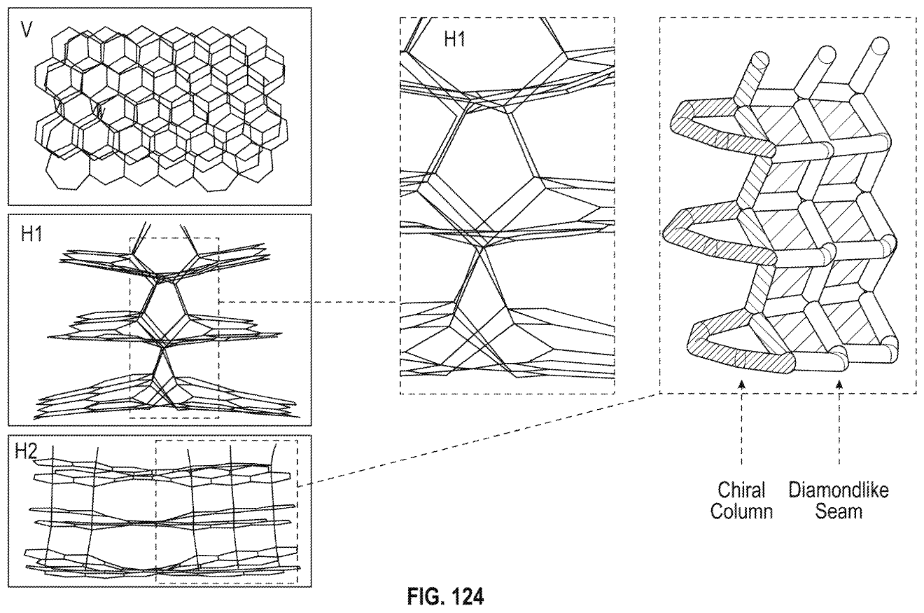

In the illustration of FIG. 124, continued growth above the original G₃ base has added a third layer to the sp^{x} network. As illustrated in the vertical perspective, the third layer exhibits the same Eshelby twist as the second. So long as the chiral columns continue to propagate vertically, each higher layer formed will be rotationally misaligned with the z-adjacent layers above or below it. In FIG. 125A, which is a magnification of the H2 perspective from FIG. 124, we can see that each higher-layer region continues the chiral columns. In FIG. 125A, the chiral chains in chiral rings are indicated by solid lines traced with dashed lines, while the z-directional chains of sp³-sp³ bonds connecting z-adjacent chiral rings are indicated by dash-dotted lines traced with dashed lines. A simplified representation of each chiral column of z-adjacent chiral rings is illustrated in FIG. 125B. The sp^{x} helix within each of these chiral columns is isolated in FIG. 125C.

We can see in FIG. 124 that continued growth above the original G₃ base has created two distinct diamondlike seams. One of these seams, comprising a two-dimensional ribbon of 4 z-adjacent sp^{x} rings in the chair conformation, is shown in the magnified inset of the H1 perspective. The other seam, comprising a two-dimensional sheet of 10 z-adjacent sp^{x} rings in the chair conformation, is shown in the other magnified inset of FIG. 124. Each of these seams comprise a two-dimensional cubic diamond surface running transverse to the layers. These seams represent a laterally and vertically ring-connecting interface between the adjoining layers. The rings belonging to a seam are pattern-filled in the right-hand inset of FIG. 124. Diamondlike seams in sp^{x} networks are terminated to either side by chiral columns, as shown in the right-hand inset by the chiral column. The chiral column's sp³-sp³ bonds are indicated by low-density diagonal patterning, while the chiral chains are indicated by more dense diagonal patterning in FIG. 124. In FIG. 125A, both of the chiral columns from FIG. 124 are illustrated and traced with dashed lines. The traced sp³-sp³ bonds are represented by dash-dotted lines, and the traced chiral chains are represented by solid lines. In FIG. 125B, a chiral column is diagrammed, with sp³ atoms represented by white circles and sp² atoms represented by pattern-filled circles. In FIG. 125C, the sp^{x} helix within the chiral column of FIG. 125B is diagrammed in isolation.

The sp^{x} network illustrated in FIG. 124 represents a singleton-type graphenic system. The only atoms not belonging to the singleton are the 5 primary carbon atoms in the z-space above the third layer. Since these atoms are not members of rings, they cannot be members of a graphenic structure or a graphenic system.

The pyrolytic growth sequence modeled in FIGS. 117-124 ties together all of our observations from Study A. First, the non-uniform charging observed in Sample A3's perimorphs (FIGS. 113 and 115) is attributed to localization of sp³ grafting and diamondlike seams at tectonic interfaces. These interfaces are densest in areas of heavy nucleation, which correspond to rounded or near-defect regions of the templating surfaces. On the other hand, regions of the perimorphic walls formed on flatter templating surfaces exhibit fewer sp³ states and less charging. Second, because sp² and sp³ grafting across incoherent tectonic interfaces eliminates many sp² edge states, and because sp³ grafting leads to strong sp²-sp³ coupling at the defect sites that activate the RBM phonons throughout the sp² rings, sp³ grafting leads to interpolation of the sp² Raman D band. Lastly, because the grafted base contains elevated radicals in sp³-grafted regions, higher layers are readily nucleated without growth being quenched even when access to the template/substrate is unavailable. This forms a multilayer sp^{x} network that comprises a ring-connected singleton, which exhibits superior mechanical robustness when compared to vdW assemblies.

In Study A, we observe that the Raman D band's interpolation increases as the temperature at which pyrolysis occurs is reduced. This is consistent with the slower release of hydrogen at lower temperatures, which gives the dynamic, self-rearranging condensate at tectonic interfaces more time to relax into an energy-minimizing configuration. Sp² or sp³ grafting, which eliminates high-energy sp² edge states at the tectonic interfaces, is therefore promoted by lower temperatures.

In Procedure A1, the 750° C. CVD temperature allows gradual dehydrogenation and carbonization of the condensates. This facilitates some sp² and sp³ grafting at tectonic interfaces, and as sp² edge states are eliminated via grafting, the D band begins to show underlying, interpolated modes, as evidenced by difference between its average Dᵤ peak, which is positioned above 1345 cm⁻¹, and its average D_{f} peak, which positioned at 1343 cm⁻¹. On this basis, we classify the perimorphic frameworks in Sample A1 as minimally grafted z-sp^{x} networks.

In Procedure A2, the 1050° C. CVD temperature accelerates dehydrogenation and carbonization of the condensates. High-energy edge dislocations get locked in, creating a vdW assembly. RBM phonons are activated by these sp² edge states, and the D band of Sample A2 is therefore not interpolated. On this basis, we classify the perimorphic frameworks in Sample A1 as vdW assemblies.

In Procedure A3, a further reduction in temperature to 650° C. allows the growing condensates more time to rearrange and relax into energy-minimizing, grafted configurations that eliminate sp² edge states. Consequently, Sample A3's Dᵤ peak, positioned at 1340 cm⁻¹ reflects the most D band interpolation of any of the samples in Study A, and is located between the sp² edge-activated D band at ˜1350 cm⁻¹ and the cubic diamond peak at 1332 cm⁻¹. On this basis, we classify the perimorphic frameworks in Sample A3 as partially grafted z-sp^{x} networks.

### IX**. Study B—Analysis

The samples produced and evaluated in Study B comprise perimorphic frameworks synthesized via surface replication on mesoporous or macroporous MgO templates. These samples, like Samples A1 and A3, exhibit superior mechanical properties and comprise anthracitic networks.

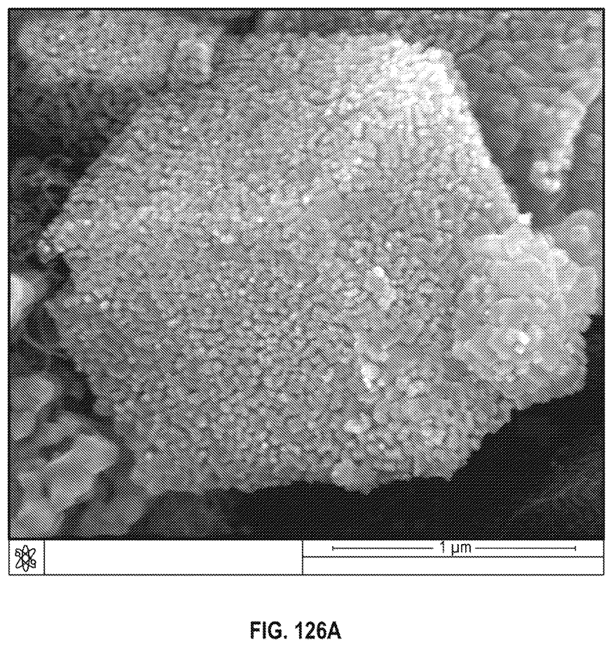

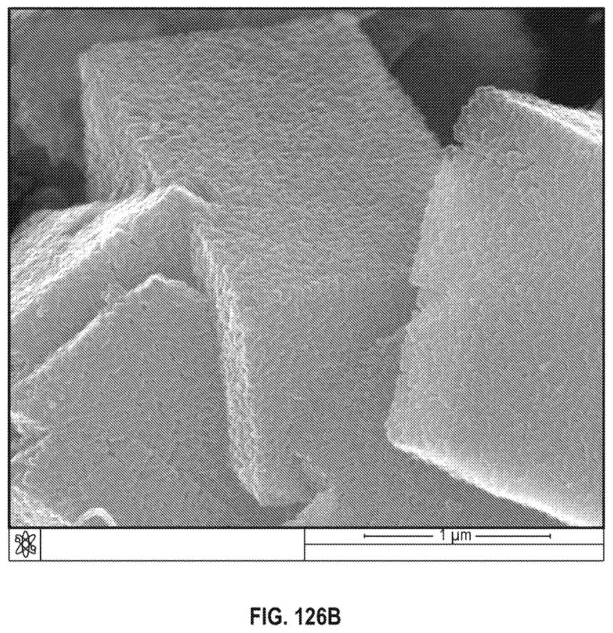

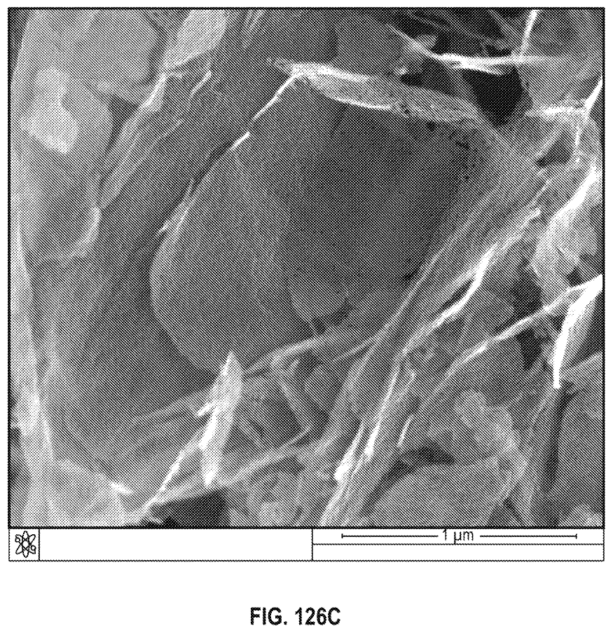

FIG. 126A is an SEM image of perimorphic composite material associated with Procedure B1 prior to extraction of the MgO template. Here, the endomorphic template can still be seen beneath the perimorphic framework. The template comprises equiaxed particles with a porous substructure of conjoined, nanocrystalline subunits formed from the thermal decomposition of a template precursor compound (magnesite, or MgCO₃). FIG. 126B is an SEM image of perimorphic frameworks from Sample B1, which shows both the absence of the displaced template and the frameworks' retention of their native, templated morphology. The appearance of the frameworks shown in FIG. 126B is representative of the appearance of the frameworks found in Samples B2 and B3, which were made on similar template particles.

FIG. 126C is an SEM image of perimorphic frameworks from Sample B4. Sample B4 was synthesized via surface replication on a different template than Samples B1 through B3. This template comprised flat, plate-like particles with a porous substructure of conjoined, nanocrystalline subunits derived from the thermal decomposition of a hydromagnesite template precursor. Therefore, the perimorphic frameworks in Sample B4 exhibit a “sheet-of-cells” morphology-similar to the frameworks in Samples B1-B3 in terms of their porous substructure, but dissimilar in terms of their overall geometry.

In Study B, lower pyrolysis temperatures were explored to demonstrate the effects of slower dehydrogenation of the free radical condensates, which it was theorized might facilitate the condensates' ability to relax into energy-minimizing grafting configurations at tectonic interfaces. Based on Study A, it was expected that this would lead to fewer sp² edge states, which could be discerned spectroscopically via progressive interpolation of the D band. The temperature setting of the CVD furnace was varied between 640° C. and 540° C.

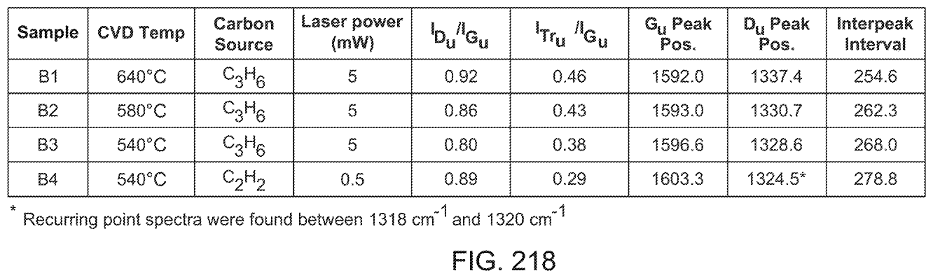

FIG. 218 shows the sample, the pyrolysis temperature (i.e. the set point on the CVD furnace), the carbon source gas, the average I_{D}_{ᵤ}/I_{G}_{ᵤ} and I_{Tr}_{ᵤ}/I_{G}_{ᵤ} peak ratios, the average Gᵤ and Dᵤ peak positions, and the interval between the Gᵤ and Dᵤ peaks. The averages in FIG. 218 were derived from an average spectrum representing a composite of 9 point spectra. To generate the average, the raw data from each point spectrum was first smoothed using a moving average technique over a wavenumber interval of +/−5 cm⁻¹ in order to minimize noise. After smoothing, the intensity values from each point spectra were normalized to a common scale, and the normalized intensity values were then averaged to create an average intensity value for each wavenumber.

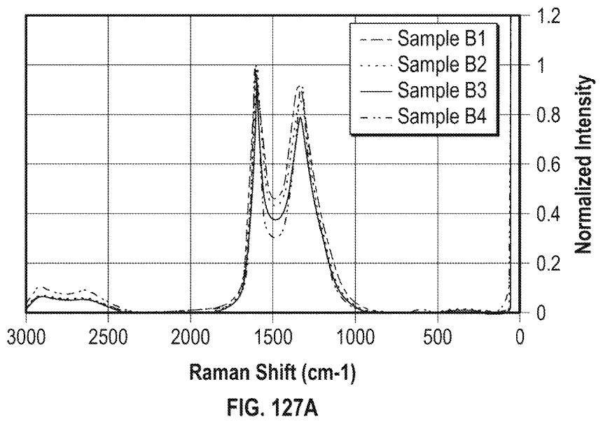

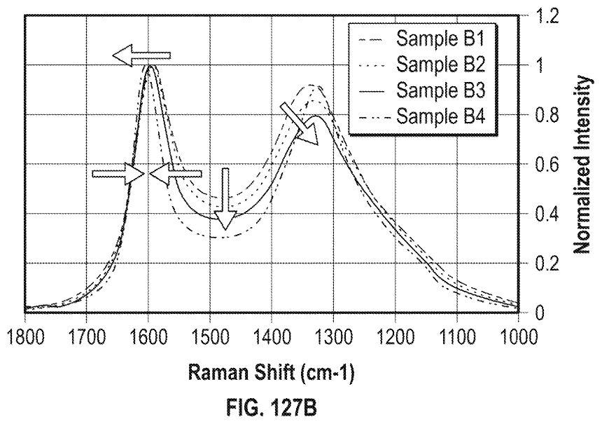

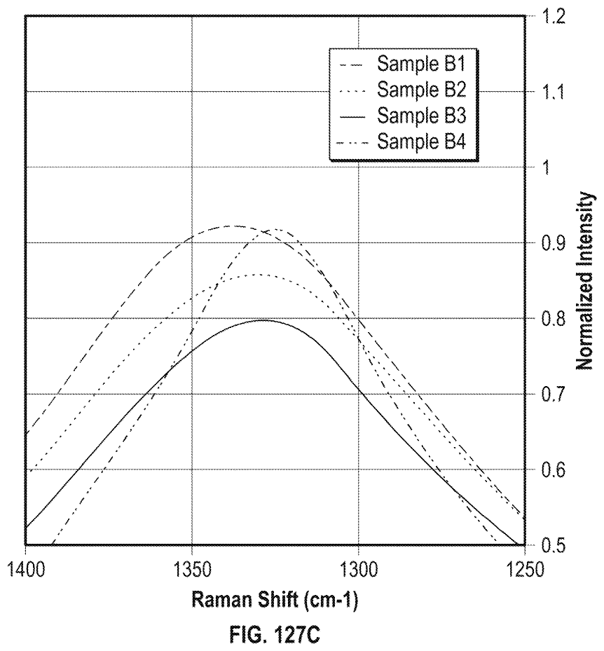

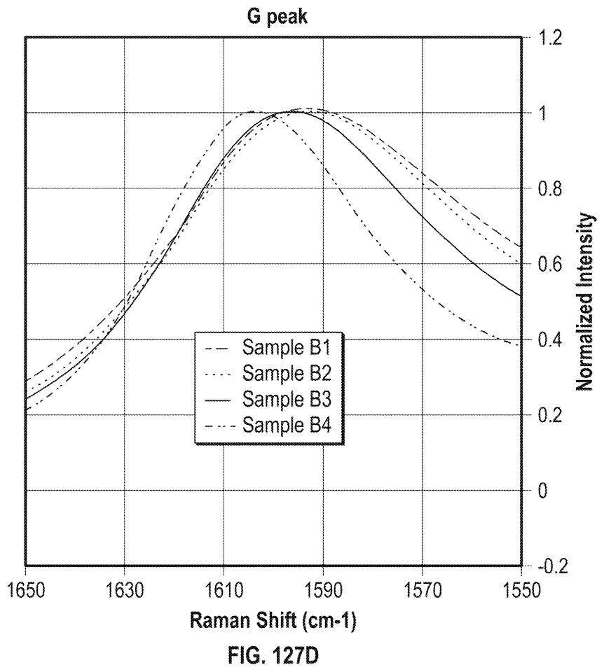

FIG. 127A shows the average Raman spectra of Samples B1 through B4. FIG. 127B shows a magnification of the averaged Dᵤ, Trᵤ, and Gᵤ features. The black arrows in FIG. 127B indicate the direction of corresponding spectral trends as the CVD temperature is decreased for Procedures B1-B3. FIG. 127C shows a magnification of the Dᵤ peak, and FIG. 127D shows a magnification of the Gᵤ peak.

Evaluation of the Raman spectra of Samples B1-B3 indicates a downward tendency of the Dᵤ peak intensity (as well as the peak area) as the pyrolysis temperature is decreased. The peak FWHM does not appear drastically changed. This trend of reducing peak intensity and area signifies an overall reduction in the RBM phonons associated with sp² rings. This is known to occur as sp³ content increases in disordered carbons—in diamondlike carbons with no sp² rings, the D feature disappears entirely. The decreasing Dᵤ peak intensities observed in Study B can therefore be assigned to a progressive decrease in the presence of sp² rings, which are transformed into sp^{x} rings by the sp²-to-sp³ rehybridization associated with sp³ grafting. As the pyrolysis temperature is reduced, not only do condensates have more time to relax into lower-energy sp³-grafted configurations at tectonic interfaces, but the primordial domains' ring disorder is increased, which should promote offset zones at the expense of level zones. Both of these should increase sp³ grafting and sp^{x} rings.

Evaluation of Samples B1-B3 also shows that as the CVD temperature is reduced in Study B, the Dᵤ peak also becomes progressively more interpolated with lower-frequency sp³ bands. This indicates a decreasing prevalence of sp² edge states. As discussed in Study A, this establishes that sp² edges are increasingly being eliminated at tectonic interfaces, consistent with the adoption of lower-energy, grafted configurations. Interestingly, the interpolation trend observed in Samples B1-B3 does not stop at the cubic diamond peak position of 1332 cm⁻¹ but progresses to even lower frequencies.

Surprisingly, as temperature drops and grafting is promoted, it also appears that the overall level of lattice distortion in sp² clusters is reduced. This is evidenced by the trend in the trough height for Samples B1-B3-a trend that was not observed in Study A, where it was found that Samples A1 and A3, while being synthesized at lower temperatures than Sample A2, exhibited higher troughs. This trend in Study B can potentially be explained by compression arising from the increasing prevalence of sp³ grafting and, in particular, from the increasing prevalence of more strained sp^{x} ring conformations, such as boat conformations.

Another trend observed in of Samples B1-B3 is that with decreasing pyrolysis temperatures, the Gᵤ peak position gradually blue-shifts from its usual position at 1585 cm⁻¹ up to 1596.6 cm⁻¹. This indicates an overall increase in the compressive strain of sp²-sp² bonds, and this compression is also attributed to increasing grafting. Additionally, the G band becomes narrower, indicating less variance in the strain states. Hence, Study B corroborates the correlation observed in Study A of grafting and compression. This compression also helps to explain the declining height of the trough. We can see in FIG. 127B that as the Gᵤ peak position increases, the I_{Tr}_{ᵤ}/I_{G}_{ᵤ} ratio decreases, indicating that tensile strain states are being reduced as the sp^{x} networks become more compressed.

Another spectral observation in Study B is that the progressive interpolation of the Dᵤ peak position to below 1328.6 cm⁻¹ (in Sample B3) under 532 nm excitation. Because of the proximity of Sample B3's Dᵤ peak position of 1328.6 cm⁻¹ to the cubic diamond peak position at 1332 cm⁻¹, and because anthracitic networks are known to be prone to beam-induced heating, which could affect the Dᵤ peak position, Sample B4 was evaluated at a lower laser power setting of 0.5 mW. The Raman spectrum gathered for Sample B4 at the 0.5 mW laser power setting demonstrates conclusively that the D band is red-shifted below the 1332 cm⁻¹ cubic diamond peak position. This interpolation below 1332 nm⁻¹ indicates the presence of sp^{x} rings in hexagonal diamond arrangements. Hexagonal diamond has been shown to have an intense Raman peak at 1324.4 cm⁻¹ by some workers, whereas in other instances it has been shown to have peaks between 1318 cm⁻¹ and 1325 cm⁻¹. Hence, Sample B4's average Dᵤ peak position of 1324.5 cm⁻¹, and multiple point spectra with Dᵤ peak positions between 1318 cm⁻¹ and 1320 cm⁻¹, is strong evidence of sp^{x} rings in non-chair conformations.

In addition to its greater degree of interpolation, the Dᵤ band in Sample B4 is also conspicuously narrower than the Dᵤ bands in Samples B1-B3. This indicates that a higher fraction of its RBM phonons is being activated by backscattering at sp^{x} interfaces, and that RBM phonons activated by backscattering at sp² edge states are being eliminated. The more these sp² edge atoms are eliminated, and the more highly grafted the sp^{x} network becomes, the narrower this peak should become. This improvement in grafting in Sample B4 may be attributed to three factors: (i) the increased stability at lower pyrolysis temperatures of strained sp^{x} conformations required for grafting across certain tectonic interfaces; (ii) slower dehydrogenation at lower pyrolysis temperatures, allowing condensates more time to finding grafting configurations; and (iii) the use of smaller, less sterically hindered C₂H₂ gas molecules.

We start with the first factor, which is premised upon the idea that certain tectonic interfaces may not allow chair conformations, i.e. cubic diamond. This premise would be consistent with previously published graphene-to-diamond bonding research. In this work, it was found that for a graphene domain's edge to bond to a diamond surface, it was necessary for the atomic positions of the graphene's dangling bonds to be matched as closely as possible to the atomic positions of some line of sp³ atoms present on the diamond surface. For certain graphenic edge configurations, lonsdaleite (i.e. hexagonal diamond) surfaces offered a better-matching line of sp³ atoms than cubic diamond surfaces.

In our discussion of FIGS. 117-124, we illustrated diamondlike seams comprising sp^{x} rings in the chair conformation—i.e. cubic diamondlike seams. Extrapolating from the logic of the prior art, wherein graphene-diamond bonding required a match between a graphenic edge configuration and a line of sp³ atoms on a diamond surface, we theorize that in order for two graphenic edges at a tectonic interface to be sp³-grafted, each must be grafted to a matching line of sp³ atoms, and then these two lines of sp³ atoms must be sufficiently matched to form a sp³-sp³ bond line. Sometimes this requires a non-cubic polymorph of diamond.

In a hypothetical zigzag-zigzag interface in which the edges are sufficiently close to bond directly, such as the E₁-E₂ interface presented in FIG. 117, the two lines of sp³ atoms can be generated via sp²-to-sp³ rehybridization of the graphenic edges themselves, which may then bond directly to each other due to their close proximity. This effectively matches each of the two graphenic structures to a line of sp³ atoms, then forms a sp³-sp³ bond line between them, generating two-dimensional cubic diamondlike seams.

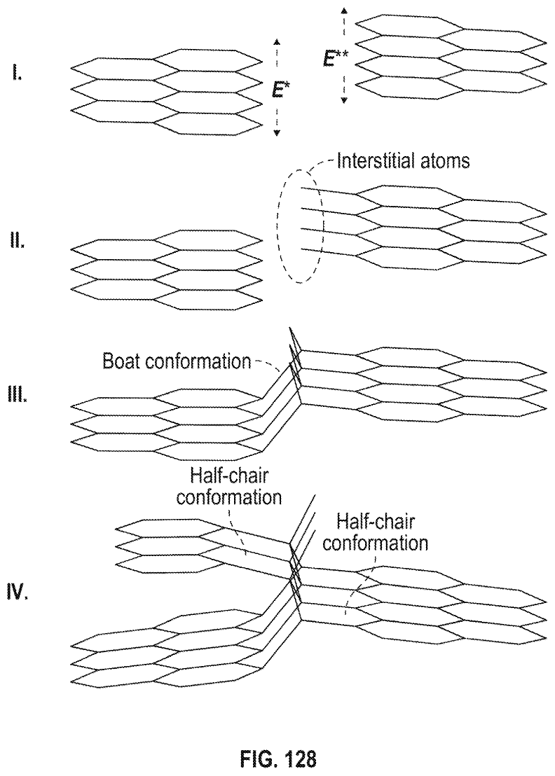

Since the spacing between participating edge atoms in a tectonic interface is stochastic in nature, though, we must consider that in some interfaces, opposing edge atoms may be too far apart to bond directly to each other. To illustrate this, in Frame I of FIG. 128 we model an offset zone of a zigzag-zigzag tectonic interface involving two edges, E* and E**, where E** is elevated over E*. For simplicity, no hydrogen atoms are represented. The spacing between the sp² edge atoms in Frame I of FIG. 128 is too large for sp³ grafting to occur. However, there is still room remaining between the edges for interstitial atoms to be inserted via continued radical addition.

In Frame II of FIG. 128, we insert a line of sp³ interstitial atoms (circled in FIG. 128) at the elevated edge E**. This line of sp³ interstitial atoms is matched to the E** edge and is close enough to the sp² edge atoms of E* for bonding, but the vertical offset inhibits sp² grafting.

In Frame III, the opposing line of sp² edge atoms in E* undergoes sp²-to-sp³ rehybridization, forming a line of sp³ atoms, and these are bonded to the line of interstitial atoms via sp³-sp³ bonds. This line of sp³-sp³ bonds ring-connects the graphenic structures. The elevated sp³ radicals on the E** side allow continued radical addition, resulting in the formation of sp^{x} rings in the boat conformation (since chair conformations are geometrically disallowed). With continued growth, a seam may be evolved, as shown in Frame IV of FIG. 128. Such a seam will no longer comprise cubic diamond, but instead an amorphous, hexagonal polymorph that can be expected to have lower-frequency Raman spectral peaks.

Hence, the lateral spacing at tectonic interfaces play an important role in determining the conformations of the sp^{x} rings evolved by sp³ grafting. If the spacing between zigzag edges is close enough, opposing sp² edge atoms may be able to rehybridize and sp³-graft directly to each other, resulting in sp^{x} rings in chair conformations. If the spacing between zigzag edges is too far, an interstitial line of atoms may be inserted, and sp² edge atoms may be rehybridized, forming two lines of sp³ atoms that can then form a sp³-sp³ bond line. This will result in less thermodynamically stable conformations that may not be stable at higher temperatures, meaning that complete grafting of tectonic interfaces may not be possible at higher temperatures. We may confidently conclude that, based on the inevitability of these interfacial configurations and their necessitation of sp^{x} rings in boat conformations, if an sp^{x} network does not exhibit D peak interpolation with sp³ modes below 1332 cm⁻¹, it is incompletely grafted.

The insertion of interstitial atoms, as modeled in FIG. 128, increases the local atomic packing density—in many interfaces, the interstitial atoms may be packed or wedged into an interface, compressing the sp² regions around the interface. The fineness of this spacing, and the need for molecular rearrangement during dissociative adsorption, suggests that smaller gas-phase species, like C₂H₂, will be less sterically hindered from reacting and inserting atoms at these interfaces, facilitating more grafting and compression. We suspect this is a major reason why, although produced at the same temperature of 580° C., Sample B4 (produced from C₂H₂ pyrolysis) had a significantly lower Dᵤ peak position than Sample B2 (produced from C₃H₆ pyrolysis).

The logic of tight atomic “packing” at tectonic interfaces applies not only to offset zones, where sp³ grafting occurs, but also to level zones, where sp² grafting occurs. The insertion of interstitial atoms at tectonic interfaces explains the progressively higher G peak positions observed in Study B, with Sample B4 reaching an average position of 1603.3 cm⁻¹ and point positions of 1604.2 cm⁻¹. In procedures utilizing C₂H₂ feedgas at pyrolysis temperatures below 580° C., we have observed average Gᵤ peak positions of greater than 1606 cm⁻¹, with point positions of up to 1610 cm⁻¹.

Other stochastically-formed tectonic interfaces may easily be envisioned, and sp³ grafting at these interfaces may evolve other sp^{x} ring morphologies. These may include 5-member rings, 7-member rings, 9-member rings, and potentially others, all of which ring-connect the participating graphenic structure. Any sp³ grafting event that evolves these sp^{x} rings may, upon further addition, form a diamondlike seam.

As an example of this, in Frame I of FIG. 129 we illustrate a tectonic interface formed by a zigzag edge segment and an armchair edge segment (i.e. a “zigzag-armchair” interface). For simplicity, we illustrate only an offset zone of the zigzag-armchair interface, and hydrogen atoms are again excluded. In Frame I of FIG. 129, the interfacial spacing is such that opposing sp² edge atoms are close enough to graft directly.

Sp³ grafting therefore proceeds via sp²-to-sp³ rehybridization of these opposing sp² edge atoms, forming two lines of sp³ atoms with atomic positions that allow the formation of a sp³-sp³ bond line between the two graphenic structures. This is illustrated in Frame II of FIG. 129, with sp² and sp³ atoms being represented in the magnified inset by pattern-filled circles and white circles, respectively. The sp³-sp³ bond line forms alternating 5-member and 7-member sp^{x} rings (designated Rₐ, R_{b}, and R_{c} and in the magnified inset in Frame II of FIG. 129) that ring-connect the two graphenic structures.

As shown in Frame III of FIG. 129, continued pyrolytic growth from tertiary radicals may evolve a second, z-adjacent line of 5-member and 7-member rings (designated R_{d}, Rₑ, and R_{f} in FIG. 129) and a third line of sp³ atoms (indicated by white circles in the magnified inset of Frame III). The atomic positions within this line of sp³ atoms, like the z-adjacent line of sp³ atoms below it, can be incorporated in a zigzag edge of sp² and sp³ atoms, which is circled in the magnified inset in Frame III of FIG. 129. In this way, a diamondlike seam is formed at the zigzag-armchair interface.

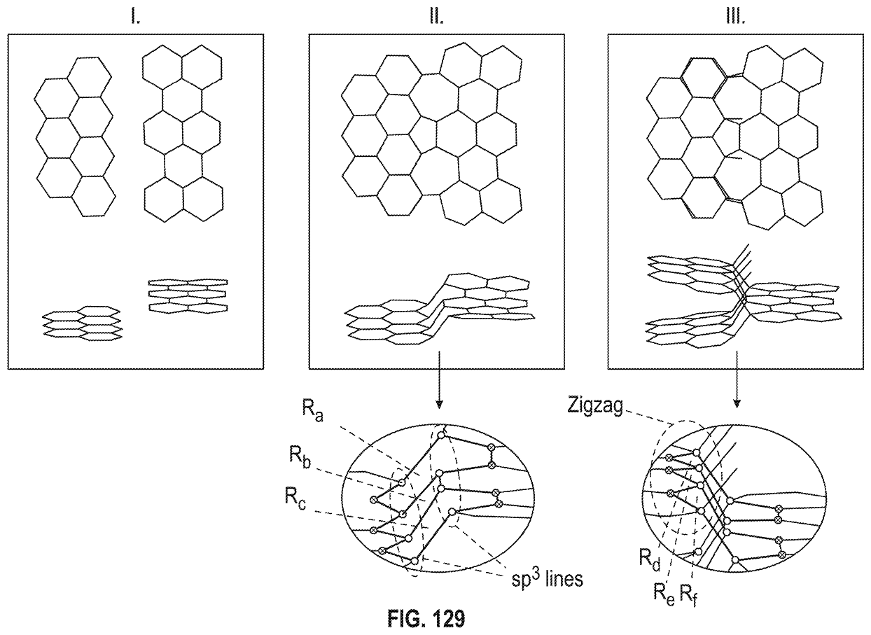

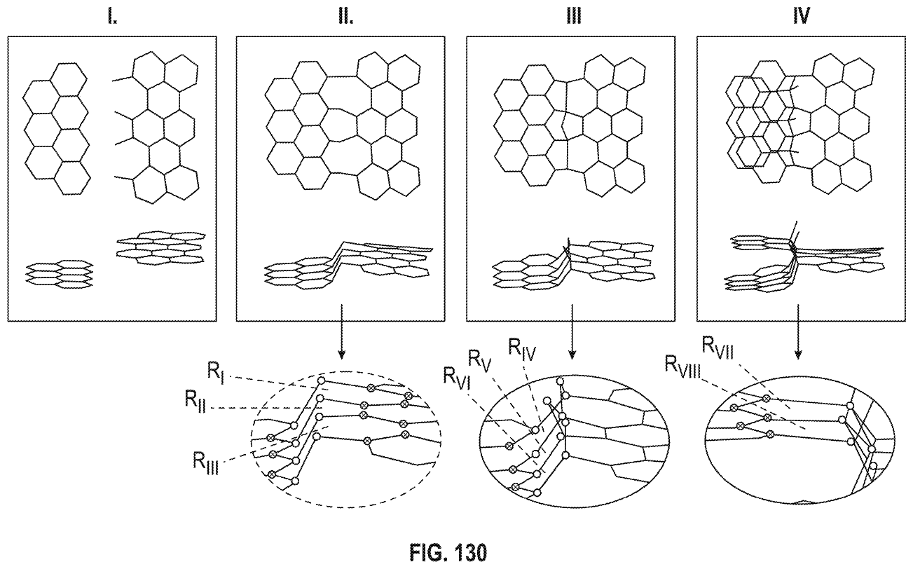

If the spacing of a zigzag-armchair interface is too large for bond formation between opposing edge atoms, interstitial atoms may need to be inserted. In such cases, sp³ grafting may lead to the formation of boat and half-chair conformations just as it does in zigzag-zigzag interfaces with interstitial atoms. In Frame I of FIG. 130, the edge atoms of the two domains are not sufficiently close to graft directly to one another, and a line of interstitial sp³ atoms has been bonded to the armchair edge. The line of interstitial sp³ atoms is close enough to the opposing sp² edge atoms to form bonds, but the vertical offset inhibits sp² grafting.

In Frame II of FIG. 130, sp³ grafting proceeds via sp²-to-sp³ rehybridization of the sp² edge atoms, creating a second line of sp³ atoms across from the interstitial line, and the formation of a sp³-sp³ bond line between the two lines. Sp² and sp³ atoms are represented in the magnified inset in Frame II of FIG. 130 by pattern-filled circles and white circles, respectively. The sp³-sp³ bonds form alternating 7-member and 9-member sp^{x} rings (designated R_{I}, R_{II}, and R_{II} in the magnified inset in Frame II of FIG. 130) that ring-connect the two domains.

As shown in Frame III of FIG. 130, continued pyrolytic growth may evolve a line of 6-member rings (designated R_{IV}, R_{V}, and R_{VI} in the magnified inset of Frame III) in the boat conformation. Further growth, as illustrated in Frame IV, may form a line of sp^{x} rings in the half-chair conformation (designated R_{VII}, R_{VIII}, and R_{IX} in the magnified inset of Frame IV of FIG. 130), creating a Y-dislocation. In this way, a Y-dislocation and hexagonal diamondlike seam are formed from the zigzag-armchair interface with interstitial atoms.

The stochastic nature of the processes makes it inevitable that there will be a variety of tectonic interfacial configurations, sp^{x} rings, and diamondlike seams, but the exemplary models detailed herein suffice to illustrate the governing principles underlying these varied, specific scenarios. They also explain the observation of Raman spectral features that are consistent with cubic and hexagonal diamond motifs.

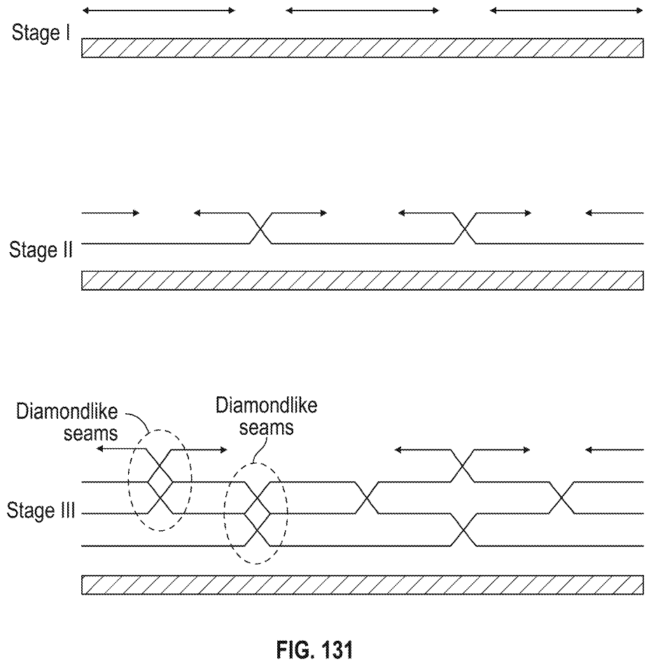

Next, we consider more broadly the tectonic interactions and pyrolytic growth of a larger population of primordial domains, which gives rise to higher-layer tectonic activity that we have not yet considered. To illustrate this, we diagram the formation of an sp^{x} network in FIG. 131. The diagram is drawn from a horizontal perspective. Growth is divided into three stages.

In Stage I of FIG. 131, independently nucleated primordial domains grow toward one another over a common substrate. The substrate is diagonally pattern-filled, and the black lines above the substrate represent the growing domains. The arrows indicate that the primordial domains are growing radially outward based on radical addition at their edges. If growth is terminated during Stage I, before much grafting has occurred, the sp² radial breathing modes will be predominately activated by sp² edge states associated with these isolated, ring-disconnected domains.

In Stage II of FIG. 131, the domains are grafted to form the base and begin to nucleate higher layers over the base. Diamondlike seams (each seam is represented by an “X” in Stage II of FIG. 131) are formed, and associated with them, an anthracitic sp^{x} network. The tectonic interfaces are stochastic and dynamic in nature, with the hydrogenated condensates self-rearranging and relaxing into energy-minimizing grafted configurations. Some tectonic interfaces allow opposing edge atoms to be directly grafted to one another, while others require the insertion of interstitial atoms (as illustrated in FIG. 128 and FIG. 130) to enable grafting. This increases the atomic packing and causes compression in the sp^{x} network. If growth is terminated during Stage II, the activation of RBM phonons will occur via some concert of sp² edge states (left in place when growth is terminated) and sp³ states. Therefore, we may expect some interpolation of the D band, and different modes of the D band.

In Stage III of FIG. 131, a steady state of vertical and lateral growth of the sp^{x} network drives higher-layer tectonic encounters and associated grafting. As with the tectonic activity between primordial domains, this proceeds stochastically. Dislocations tend to replicate z-periodically, creating transverse diamondlike seams, but this z-periodicity is not deterministic. Meanwhile, new seams may be nucleated from higher-layer tectonic encounters, as these too can be expected to create incoherent interfaces. This may help to distribute the dislocations more evenly throughout the sp^{x} network. If growth is terminated during Stage III of FIG. 131, the activation of RBM phonons may be dominated by sp³ states (depending on the efficiency of grafting at interfaces), and we may see more interpolation of the D band than we would if growth were terminated in Stage I or II.

Our staged depictions of vertical and lateral growth in FIGS. 117-124 notwithstanding, lateral growth is expected to be far more rapid than vertical growth mode. In other words, nucleation of higher layers is likely rate-limiting. Since higher-layer nucleation occurs at tectonic interfaces, overall growth may be accelerated by measures that increase tectonic activity and sp³ grafting. Faster lateral growth enables uniform coverage of the substrate and the formation of perimorphic walls of consistent thickness, so long as gas-phase species are abundant. This explains our observation in FIG. 115C of uniformly thick perimorphic walls-even in the “window” regions where nucleation of primordial domains would have been inhibited. We have seen signs that on many substrates, the carbon yielded over extended periods of time remains linear, indicating a steady-state of higher-layer nucleation. This “evergreen” kinetic model is a fundamental advantage of anthracitic networks over graphenic networks in which the only mode of growth is lateral.

The Gᵤ peak position (as a relative indicator of compressive strain), the Dᵤ peak position (as a relative indicator of the elimination of sp² edge states), and therefore the spectral interval between them (as an indicator of both compressive strain and the elimination of sp² edge states) may provide a useful metric for characterizing the extent to which different sp^{x} networks have been able to form grafting bonds across the various stochastically-formed tectonic interfaces created during growth. This interpeak interval—defined herein as the distance in wavenumbers between the Gᵤ and Dᵤ peak positions—is commonly used in the anthracite literature to determine the vitrinite reflectance via the Raman spectrum. The vitrinite reflectance, in turn, is a measure of the maturity of a coal. As coal matures, its interpeak interval expands, corresponding to increasing vitrinite reflectance. For an immature to mature coal, using 532 nm excitation, previous workers have calculated the vitrinite reflectance as: vR₀%=0.0537(Gᵤ−Dᵤ)−11.21, where vR₀% is the vitrinite reflectance (as calculated by Raman parameters).

In Sample B4, the interpeak interval is 278.8 cm⁻¹, corresponding to a vitrinite reflectance of 3.76. This vitrinite reflectance is typical of anthracite. Beyond this value, the interpeak interval saturates at approximately 280 cm⁻¹ (varying a bit with excitation due to dispersion of the D peak), whereupon the interval begins to shrink again as anthracite matures into meta-anthracite and finally graphite. As this maturation happens, the I_{D}_{ᵤ}/I_{G}_{ᵤ} peak intensity ratio begins to increase, and the interpeak interval ceases to be useful for calculating vitrinite reflectance. For a mature anthracite or meta-anthracite, using 532 nm excitation, previous workers have calculated vitrinite reflection using the I_{D}_{ᵤ}/I_{G}_{ᵤ} peak intensity ratio according to the equation vR₀%=1.1659 (I_{D}_{ᵤ}/I_{G}_{ᵤ})+2.7588.

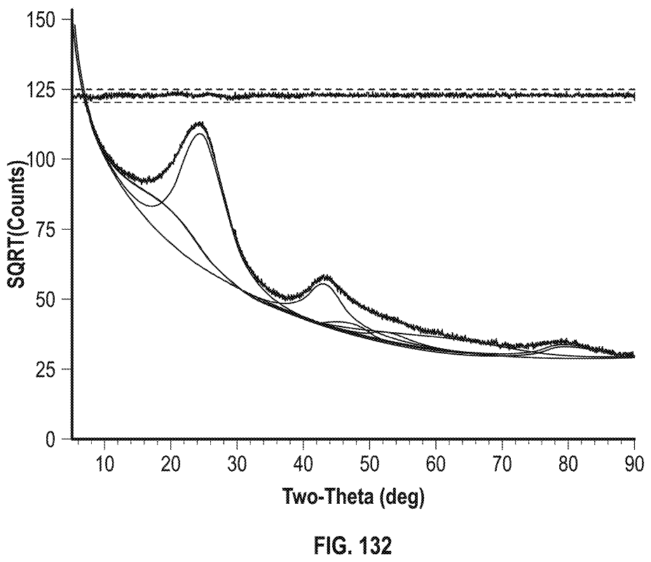

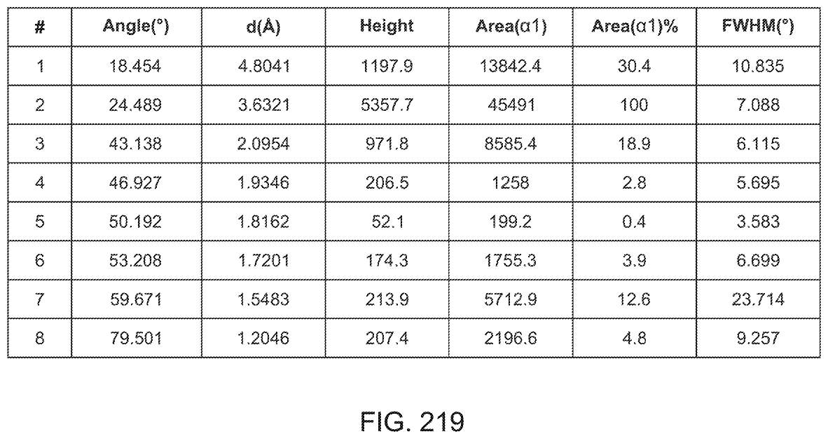

Next, we characterized Sample B4 via XRD analysis. FIG. 132 shows the overall XRD profile. FIG. 219 contains the XRD peak angles, d-spacings, areas, area percentages (normalized to the area of the dominant peak at 2θ=24.489°), and full-width half max values (without correction for instrument broadening). The XRD profile of Sample B4 comprises broad peaks, indicating a range of interlayer and in-plane periodicities. In particular, we note the broad fitted peak at 2θ=43.138°, which is equivalent to a <100> d-spacing of 2.095 Å. This reflects an average in-plane compressive strain of around 2% based on graphite's <100> d-spacing of 2.13 Å. We can also see signs of in-plane compressive strain at 2θ=79.501°, which is equivalent to a <110> d-spacing of 1.21 Å. This again reflects a compressive strain of around 2% based on graphite's <110> d-spacing of 1.23 Å. This is in good agreement with the blue-shifted Gᵤ peak position exhibited by Sample B4.

The most prominent feature of the XRD profile of Sample B4 is its main peak at 2θ=24.489°, which reflects a <002> d-spacing of 3.63 Å. This is significantly larger than the 3.35 Å<002> d-spacing associated with AB-stacked graphite or the 3.45 Å<002> d-spacing associated with turbostratic graphite. We attribute this expansion to forced AA-stacking at a large number of the cubic diamondlike seams distributed throughout the sp^{x} network. In AA-stacked regions, Pauli repulsion produced by alignment of the π electron orbitals can be expected to increase the minimum interlayer spacing. Indeed, the interlayer spacing of AA-stacked layers has been predicted to have 3.6-3.7 Å, which is in good agreement with the main interlayer peak at 2θ=18.454°. Additionally, we observe a related, minor <004> peak at 2θ=50.192°, reflecting a d-spacing of 1.82 Å—one-half of the <002> d-spacing of 3.63 Å.

A second interlayer peak is fitted at 2θ=18.454°, reflecting an interlayer d-spacing of 4.80 Å. These values, and the breadth of the peaks, indicate a broad range of large interlayer spacings-larger than we observed in Study A. This is explained as follows. Increased atomic packing as a result of grafting in a highly grafted x-sp^{x} network causes in-plane compressive strain that exceeds the critical buckling strain. Regions that are compressed beyond this critical buckling strain are forced to buckle in the positive z-direction, this direction representing their only degree of freedom. For this to occur requires them to overcome their vdW attraction to the underlying layer. If they are sufficiently strained, this occurs, and they bow out from the z-adjacent layer below, reaching a maximum z-deflection amplitude somewhere near the geometric center between the lateral seams anchoring their periphery. This z-deflection relieves these regions' in-plane compressive strain but also increases their interlayer d-spacing. We would expect bowing to create a broad continuum of interlayer d-spacings, and this is exactly what we observe in FIG. 219 and FIG. 132, where the broad peak centered at 2θ=18.454° reflects a significant phase of interlayer d-spacings larger than 7 Å. Therefore, we assign this second interlayer peak at 2θ=18.454° to z-directional bowing of xy-compressed graphenic regions between the diamondlike seams that pin them peripherally.

With this association established, we can see signs of bowing even in the interlayer d-spacings of Sample A1 (a minimally grafted z-sp^{x} network) and Sample A2 (a vdW assembly), and we can see that these samples also exhibit states of in-plane compression based on their <100> peaks, which indicate d-spacings below 2.13 Å. From this, we can that similar phenomena are occurring in these less-grafted systems. In Sample A2, specifically, it is likely that localized sp^{x} networks are being constructed, but these do not extend throughout the whole perimorphic wall. In other words, the sp^{x} networks formed within the perimorphic walls in Sample A2 are too poorly grafted to extend the ring-connected network throughout the whole perimorphic wall.

Based on our findings presented in Experiments A and B, it is possible to speculate ex post facto about instances within the prior art where sp² and sp³ grafting may have occurred in graphitic networks.

In one such instance, Cui employed a template-directed CVD procedure using methane (CH₄) and MgO template particles at 950° C., which produced a monolayer graphenic structure that, as synthesized on the template, possessed a Dᵤ peak position of 1322 cm⁻¹ (under 633 nm excitation). Barring any interpolation of the D band, under 633 nm excitation we would have expected the Dᵤ peak of this graphenic monolayer to be found around 1332 cm⁻¹. As we have discussed, this would be consistent with sp³ grafting and the formation of sp^{x} rings in the chair conformation. Therefore, the reported D peak position of 1322 cm⁻¹ reported might represent a red-shift caused by interpolation.

However, we note a few points. First, in order to satisfy ourselves on whether or not Cui's procedure produced an sp³-grafted system, we attempted to replicate the reported results. We were pleased by the close agreement in the BET and TGA characterizations of the replicated sample we were able to synthesize with these characterizations of the sample reported by Cui. Furthermore, our Raman spectral analysis (performed under 532 nm excitation) revealed a very similar Raman spectrum in terms of the I_{D}_{ᵤ}/I_{G}_{ᵤ} peak intensity ratio. However, it did not reveal any obvious interpolation of the D peak position. Our attempt did not replicate the interpolation of the D peak.

Second, irrespective of the of the D band interpolation in the sample reported by Cui, the sample could not be described as an anthracitic network or an sp^{x} network insomuch as the graphenic particles generated were natively monolayer, as synthesized on the template, and as such any crosslinking was lateral. The case for this was made convincingly in the prior art based on extensive BET, TGA, and XRD characterization. Hence, the vertical crosslinking between layers afforded by an anthracitic network was not realized, as these dislocations require a native, multilayer structure. It is true that the monolayer network, upon removal of the template, were reported to collapse into a bilayer structure. However, these bilayers would not have been crosslinked by dislocations, sacrificing this important third dimension of molecular-scale crosslinking present in anthracitic networks. The lack of dislocations was apparent in HRTEM imagery of the bilayers, where the fringe lines were uninterrupted, visually distinct and traceable over distances of 10 nm or more.

In another work within the prior art, Chung flame-synthesized carbon nano-onions at measured temperatures of 700° C. or less (the measured temperatures varied based on where measurements were taken). This process involved rapid chemical vapor deposition over metallic catalyst nanoparticles, creating graphitic carbon nano-onions via precipitation. Based on our ex post facto analysis, it appears that these graphitic carbon nano-onions comprised diamondlike seams. However, the mechanisms and patterns of crosslinking would have been different, given the graphitic alignment of the layers comprising the layered network (this graphitic alignment was evident in HRTEM analysis and also established by the reported <002> interlayer d-spacing of 3.45 Å). In particular, there would have been far fewer chiral rings and columns in these graphitic networks, due to the scarcity of zone transitions at tectonic interfaces between their highly ring-ordered domains. These transitions are directly related to the undulating edge geometry associated with ring-disordered domains grown via a free radical condensate growth mechanism. Additionally, these carbon nano-onions offer less versatility and diminished control over important morphological attributes compared to the growth procedures demonstrated herein. Nevertheless, it is foreseeable that certain aspects of this flame-synthesis process, such as partial oxidation, could be employed in tandem with the use of non-metallic catalysts and free radical condensate-based growth.

### X**. Study C—Analysis

In exploring other pyrolytic procedures capable of synthesizing sp^{x} networks, we found that employing template-directed CVD temperatures similar to those employed in Study B, but at lower temperatures (between 325° C. and 500° C.), produced carbons with increasingly brown coloration. At 400° C. and below, incomplete dehydrogenation of the condensate during growth resulted in carbons possessing a bright brown coloration. At a temperature of 460° C., the carbons produced appeared gray with a faint brown hue.

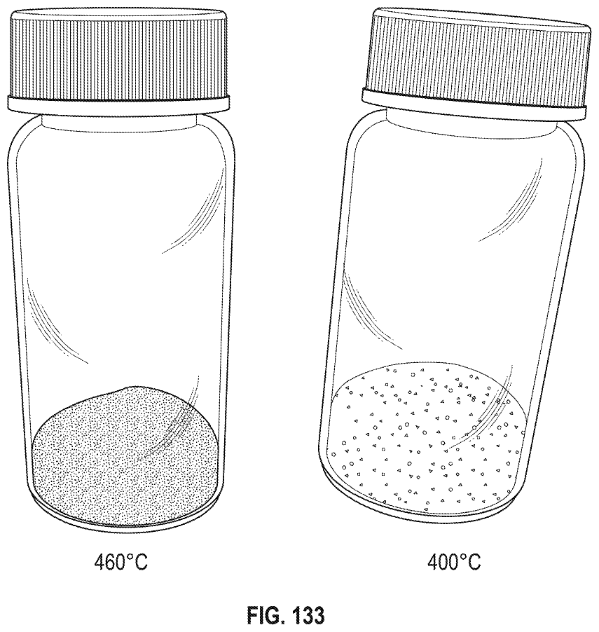

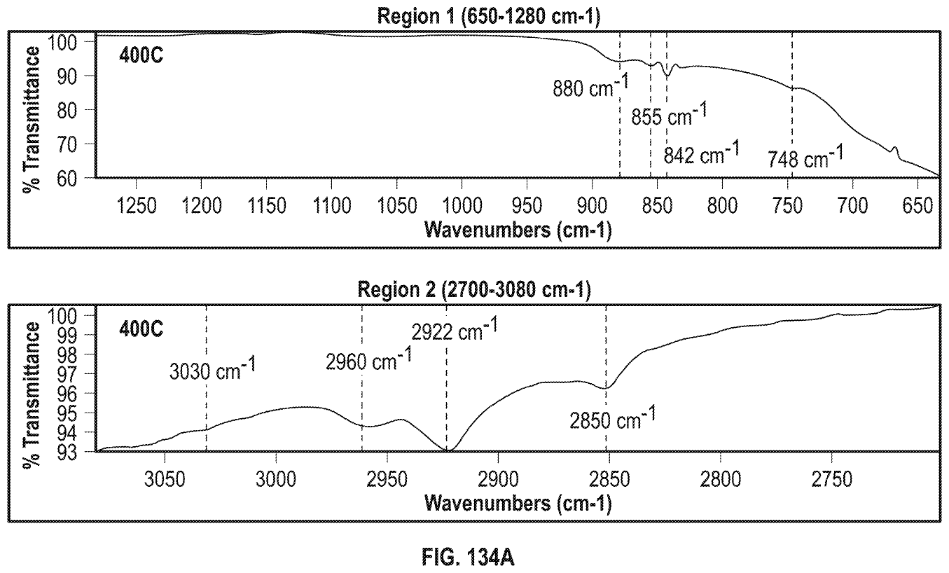

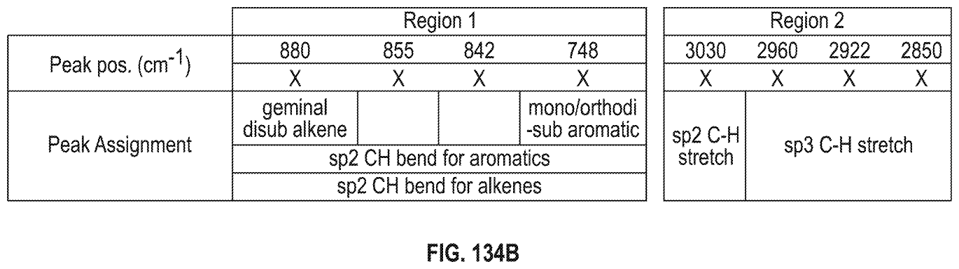

A comparison of two samples (Samples C1 and C2) synthesized at these temperatures is shown in the drawing of FIG. 133. The color differences (gray vs. bright brown) are analogous to the difference between high-maturity coals (black coloration, low hydrogen) and low-maturity coals (brown coloration, high hydrogen). Residual hydrogen of the 400° C.-carbon sample illustrated in FIG. 133 was confirmed via FTIR analysis, as shown by the peaks in FIG. 134A. The peak assignments are shown in FIG. 134B.

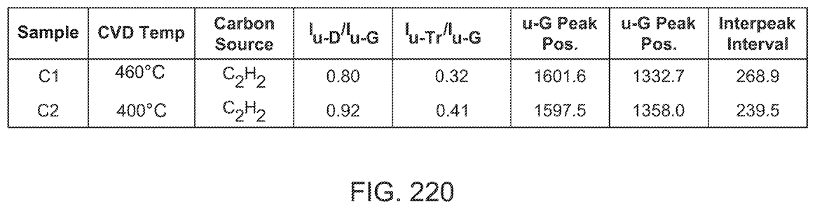

Raman characterization of Samples C1 and C2 was performed using a 532 nm laser at 0.5 mW power under an Ar blanket. This lower laser power was deemed appropriate due to the thermal instability of the samples at higher power. FIG. 220 shows the sample, the CVD temperature (i.e. the set point on the CVD furnace), the carbon source, the average I_{D}_{ᵤ}/I_{G}_{ᵤ} and I_{Tr}_{ᵤ}/I_{G}_{ᵤ} peak intensity ratios, the average Gᵤ and Dᵤ peak positions, and the interval between the Gᵤ and Dᵤ peak positions. The Raman spectral data in FIG. 220 is derived from an average spectrum representing a composite of 16 point spectra. To generate the average, the raw data from each point spectrum was first smoothed using a moving average technique over an interval of +/−5 cm⁻¹. After smoothing, the intensity values from each point spectra were normalized to a common scale, and the normalized intensity values were then averaged to create an average intensity value for each wavenumber.

Samples C1 and C2 both exhibit a decreased interpeak interval compared to the samples in Study B, which is consistent with more hydrogenation and less grafting. In Sample C1, the Dᵤ peak was interpolated, as shown in FIG. 220, and based on its Dᵤ peak position at 1332.7 cm⁻¹, the particles in Sample C1 comprise partially grafted z-sp^{x} networks. In Sample C2, the Dᵤ peak did not exhibit interpolation.

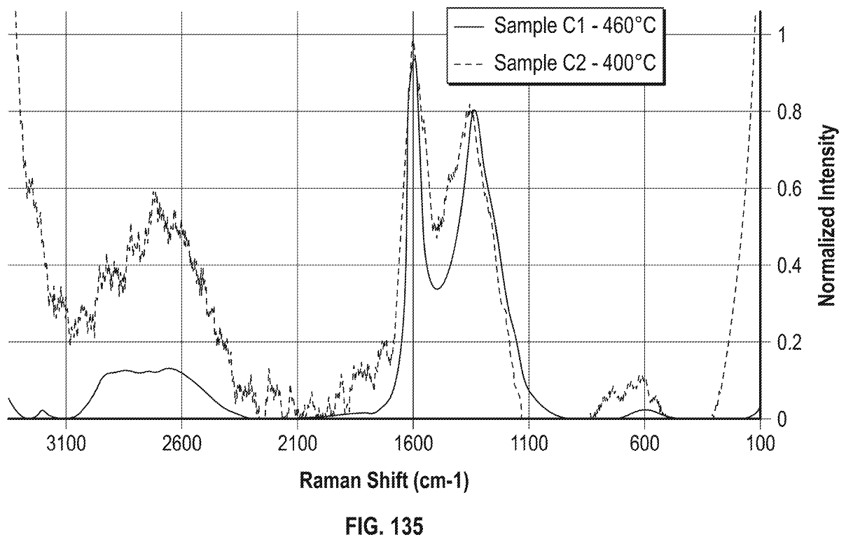

As shown in the averaged spectrum of FIG. 135, Samples C1 and C2 both exhibit a broad, weak peak at 600 cm⁻¹. This peak at 600 cm⁻¹ has been attributed to dehydrogenated nanodiamond-type carbons and was also present in Sample B4. Thus, in addition to the hydrogenated phases of Samples C1 and C2, which are associated with the decomposition products of an uncarbonized free radical condensate, there were signs of a non-hydrogenated, nanoscopic diamond phase.

The coexistence of hydrogenated and dehydrogenated phases may correspond to phases grown inside and outside of the porous template, respectively. Namely, in addition to the increased stability of C—H bonds at lower CVD temperatures, inside the porous template, where gas-exchange is diffusion-limited, we would expect an increased proportion of H₂. Unable to carbonize due to the inability to release molecular hydrogen, the free radical condensate in such regions would ultimately relax back into neutral, smaller molecular weight hydrocarbon species. Workers in the field of free radical condensates have shown this phenomenon via time-of-flight mass spectroscopy. To corroborate this, Sample C2 was immersed in ethanol under gentle stirring conditions. This created a stable, amber-colored dispersion that passes through filters, indicating the dissolution of an oily phase of hydrocarbons.

### XI** Study D—Analysis

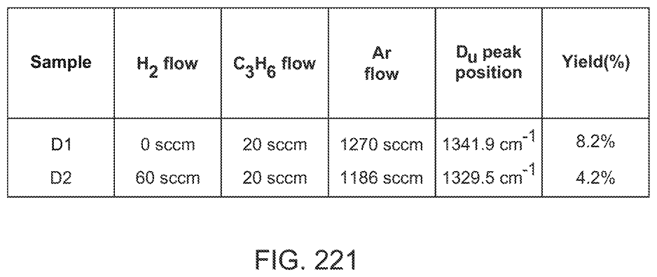

Study D was performed to confirm the role of H₂ gas in throttling the release of molecular hydrogen during free radical condensate growth. Procedures D1 and D2 were substantially the same, with the exception that in Procedure D1, only C₃H₆ and Ar were flowed into the reactor, whereas in Procedure D2, a low flow of H₂ was incorporated in addition to the C₃H₆ and Ar. It was hypothesized that the presence of H₂ should slow down the carbonization process and facilitate the condensate's relaxation into energy-minimizing, grafted configurations at tectonic interfaces. Raman analysis was performed using a 532 nm laser at 5 mW power. FIG. 221 shows the Sample I_{D}, Raman Dᵤ peak position, and the approximate yield of carbon in the C@MgO perimorphic composite powder.

The increased interpolation of the Dᵤ peak position in Sample D2 confirms that increasing the presence of H₂ promoted the elimination of sp² edge states in Procedure D. Based on Sample D1's Dᵤ peak position of 1341.9 cm⁻¹, the perimorphic frameworks in Sample D1 comprise partially grafted z-sp^{x} networks. Based on Sample D2's Dᵤ peak position of 1329.5 cm⁻¹, the perimorphic frameworks in Sample D2 comprise highly grafted x-sp^{x} networks.

From the approximately 50% reduction in carbon growth, we can also see that by slowing the condensate's carbonization, the rate of carbon growth was slowed. Hence, we find that H₂ partial pressure may be used to throttle carbonization and to improve grafting—particularly at higher temperatures where carbonization is hastened. Based on this, we can infer that, in addition to the pyrolysis temperature, the C:H ratio of the carbon source gas, the rate of H₂ release and diffusion from growth, the presence of an H₂ feedgas, the morphology and pore structure of the substrate, the size of template particles, the activity of the substrate surface, the presence of H₂ scavenging species, and numerous other factors are significant insomuch as they will all affect the dynamic equilibrium of the free radical condensate's hydrogenation and dehydrogenation.

Understanding this may allow faster kinetics to be obtained by rationally balancing these many factors. As a simple example, we have observed that we could simultaneously achieve a lower Dᵤ peak position (consistent with better elimination of sp² edge states) and faster carbon growth kinetics when using a 700° C. CVD temperature and a 30 sccm of H₂ feedgas compared to when we used a 580° C. CVD temperature without H₂ as a feedgas.

### XII** Study E—Analysis

Study E was performed to demonstrate the formation of helicoidal x-networks and z-networks from sp^{x} networks (in this context referred to as “sp^{x} precursors”). Samples E1 and E2 were generated using the same template material and comprised the sp^{x} precursors. Samples E1A and E2A were generated by maturing the Sample E1 and E2 sp^{x}precursors, respectively. This maturation, or sp³-to-sp² rehybridization-induced transformation, was obtained by annealing the sp^{x} precursors prior to the removal of the MgO endomorphs—i.e. by annealing the C@MgO perimorphic composite.

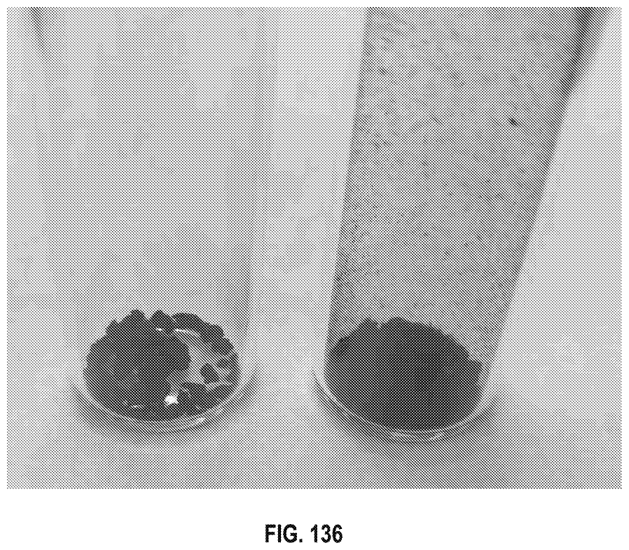

Equivalent masses of the Sample E1 and E1A are shown side-by-side in FIG. 136, with Sample E1 on the left and Sample E2 on the right. Sample E1 consisted of large, hard granules, whereas Sample E1A had a finer, softer consistency. The Sample E1 granules occupied considerably less volume than the Sample E1A powder and clicked audibly against the glass walls of the vial when shaken, whereas the Sample E1A powder was silent when shaken. Sample E1A occupied a conspicuously larger volume.

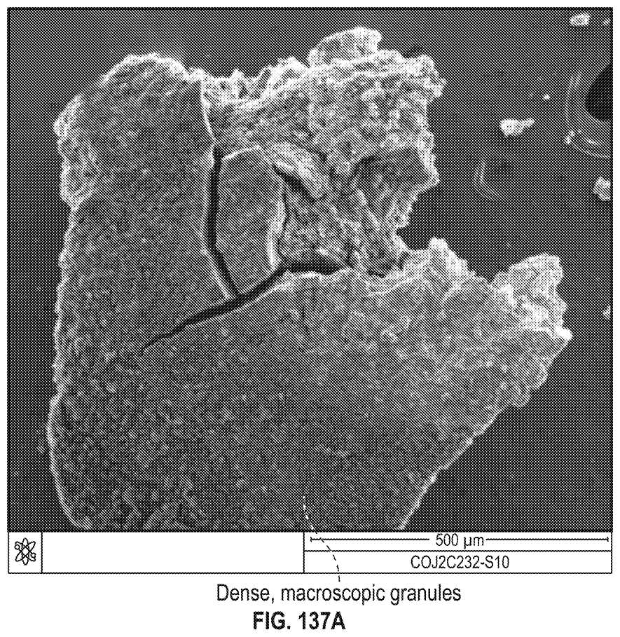

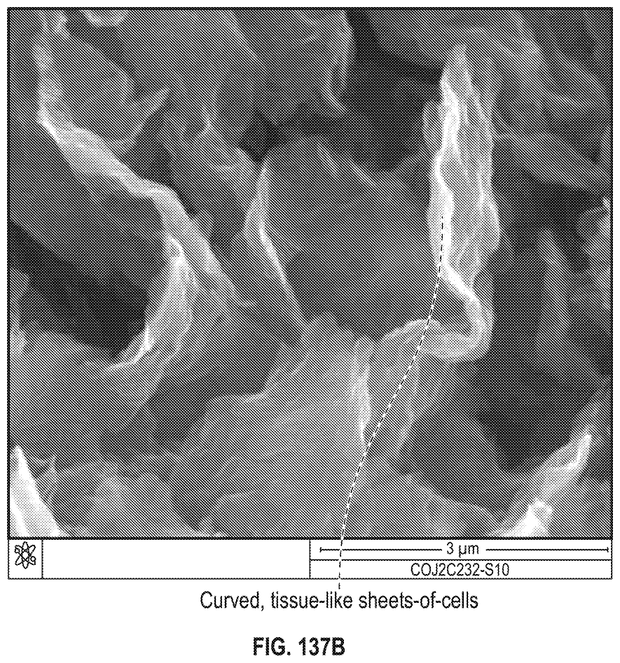

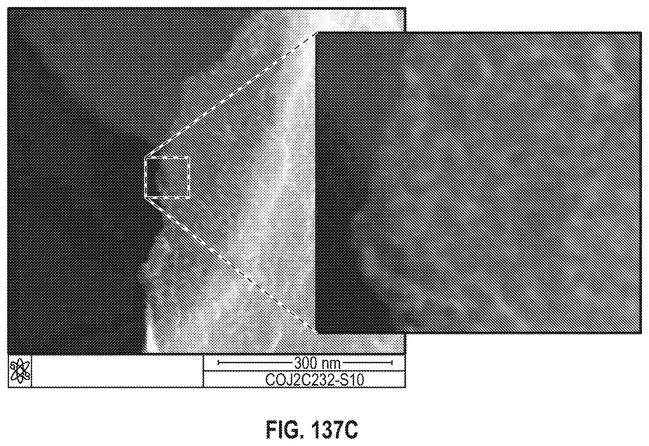

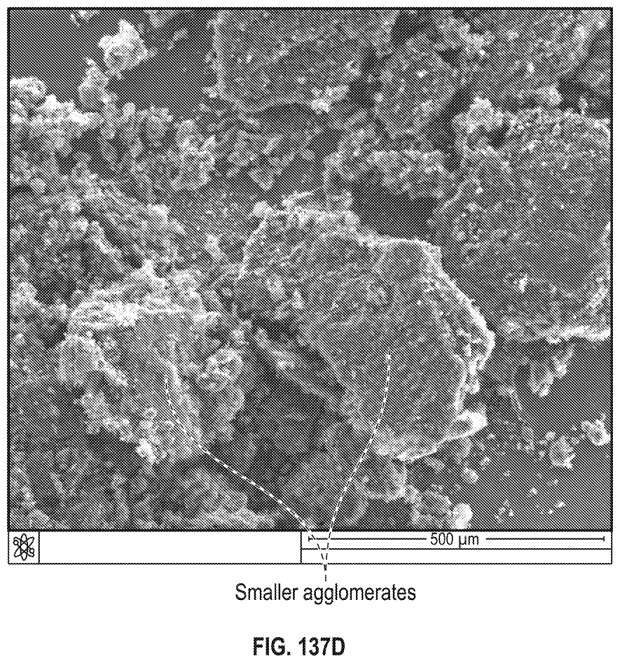

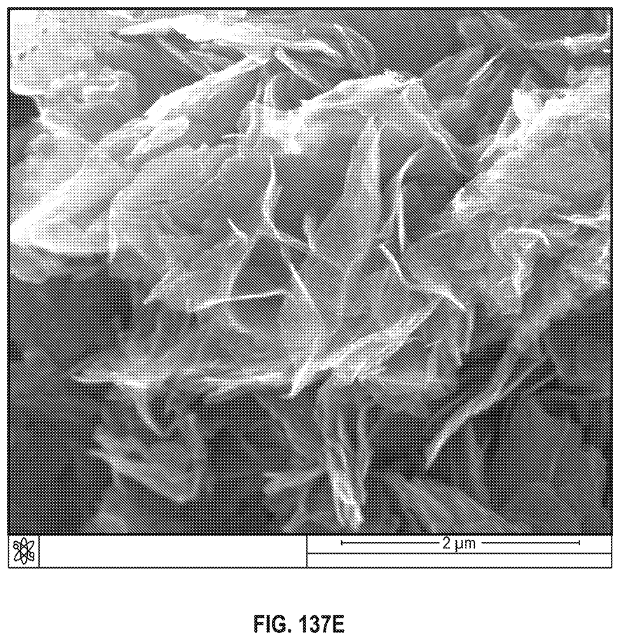

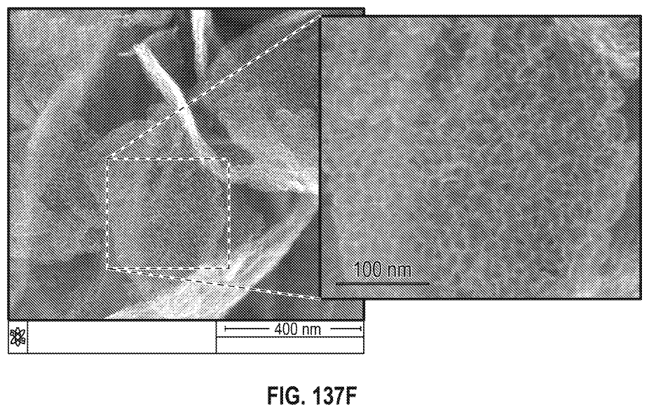

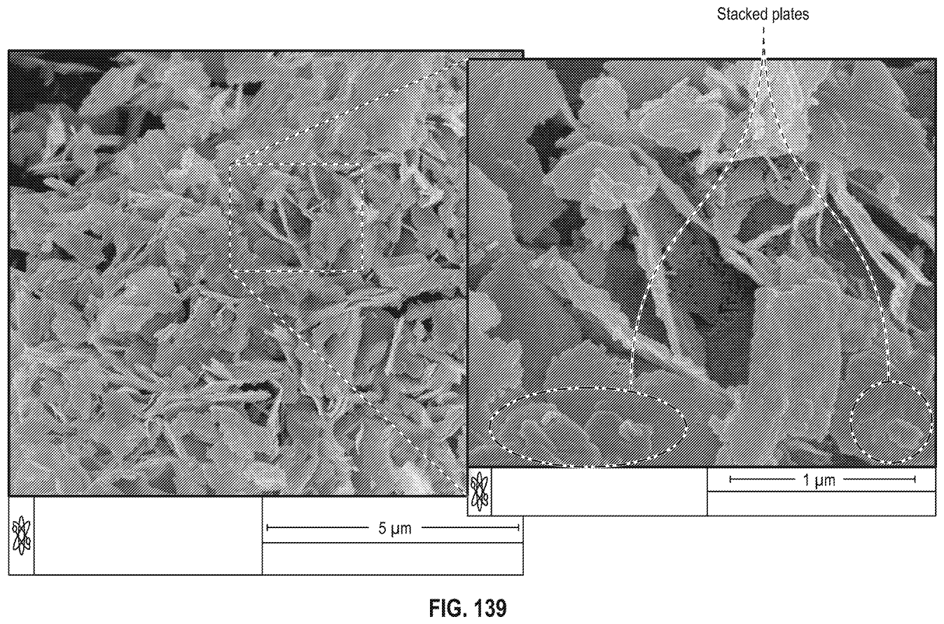

FIG. 137A is an SEM image showing a granule from Sample E1. As shown at higher magnifications in FIG. 137B-137C, the individual perimorphs within the macroscopic granules in Sample E1 exhibit a sheet-of-cells morphology similar to Sample B4. The template utilized to generate the samples in Study E comprised flat, plate-like particles, as well as stacks of plate-like particles. The templates particles comprised a porous substructure of conjoined, nanocrystalline subunits derived from the thermal decomposition of a hydromagnesite template precursor. These template particles (coated with iridium for imaging) are shown in the SEM image of FIG. 139.

The flexibility of the perimorphic walls in Sample E1 and the surface tension of the water during drying cause the endocellular pores to collapse, so that only the sheet-like superstructure, shown clearly in FIG. 137B, and an indistinct substructure, magnified in the inset of FIG. 137C, are apparent. The local flexibility of the perimorphic walls in Sample E1 renders the particles flexible, as shown in FIG. 137B, creating a wavy, tissue-like appearance. Visually tracing the edges of the sheet-like particles in the SEM images, it is difficult to find any straight lines. The flexibility of the perimorphic frameworks in Sample E1 allows particles to conform to one another, increasing their contact area and reducing the spacing between particles. It is the frameworks' flexibility and improved packing that forms the dense, hard granules during evaporative drying.

FIG. 137D is an SEM showing the finer consistency of the Sample E1A powder compared to Sample E1. While agglomerates were still present in Sample E1A, they were not as dense or hard as the granules in Sample E1, and many smaller agglomerates were present. Comparison of FIG. 137E, which shows the particles in Sample E1A, and FIG. 137B, which shows the particles in Sample E1, reveals that significant changes have occurred. The particles in Sample E1A appear straighter than the wavy particles in Sample E1, indicating rigidification. Whereas the particles in Sample E1 appear tissue-like, the rigidified particles in Sample E1A are more angular, bending by buckling. This increased rigidity reduces the Sample E1A particles' ability to bend and conform to one another, thereby preventing the degree of densification exhibited by Sample E1.

We can see in the magnified inset of FIG. 137F that the rigidification of the Sample E1A particles is also clear at the local level, wherein the porous subunits have been preserved in their native morphology vs. collapsed. This renders the porous substructure of Sample E1A well-defined and recognizable in FIG. 137F clearly more faithful to the native, templated morphology than the comparatively indistinct substructure of Sample E1 in FIG. 137C.

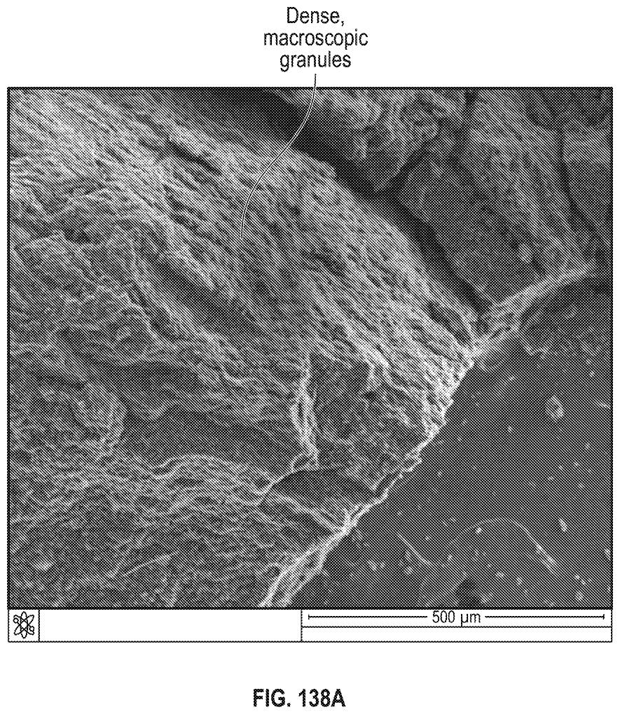

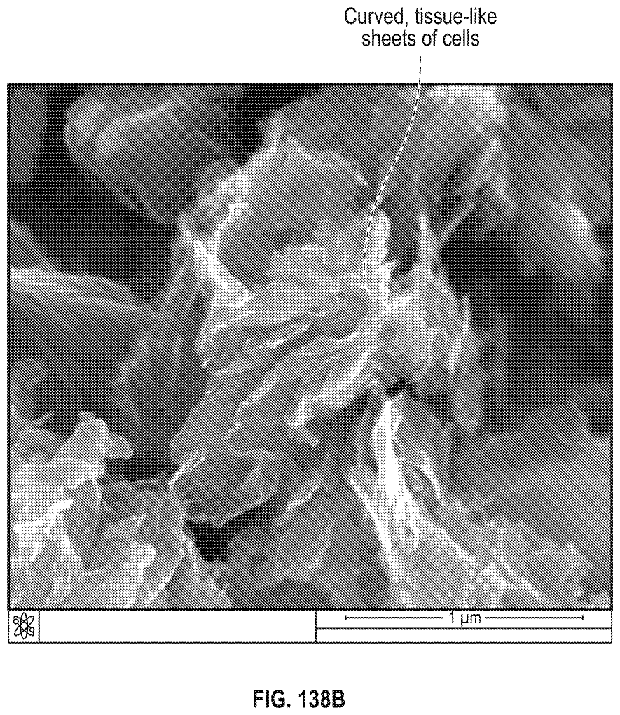

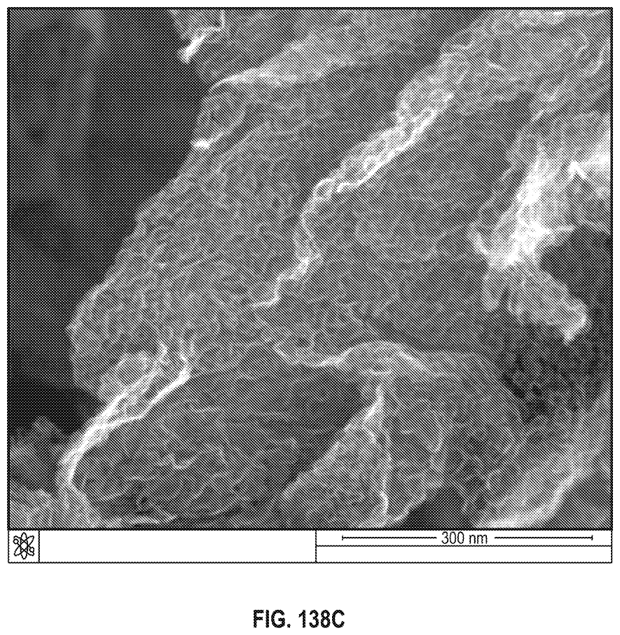

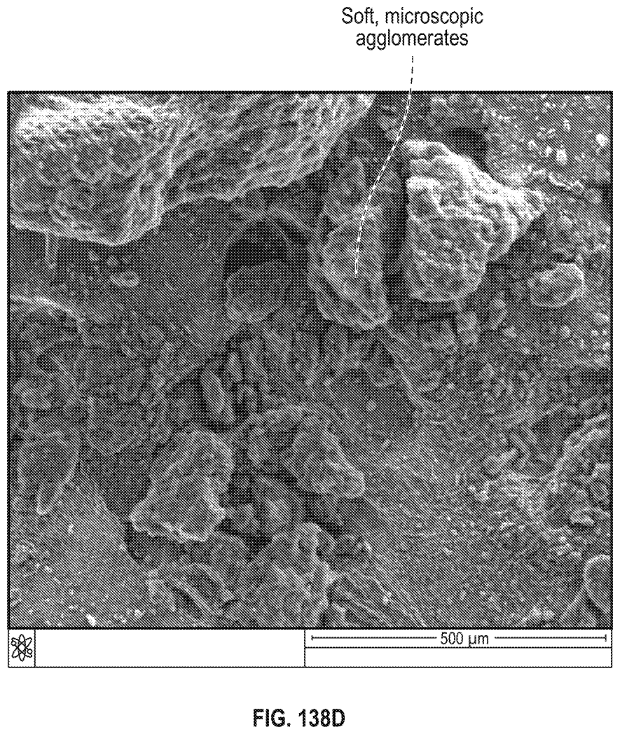

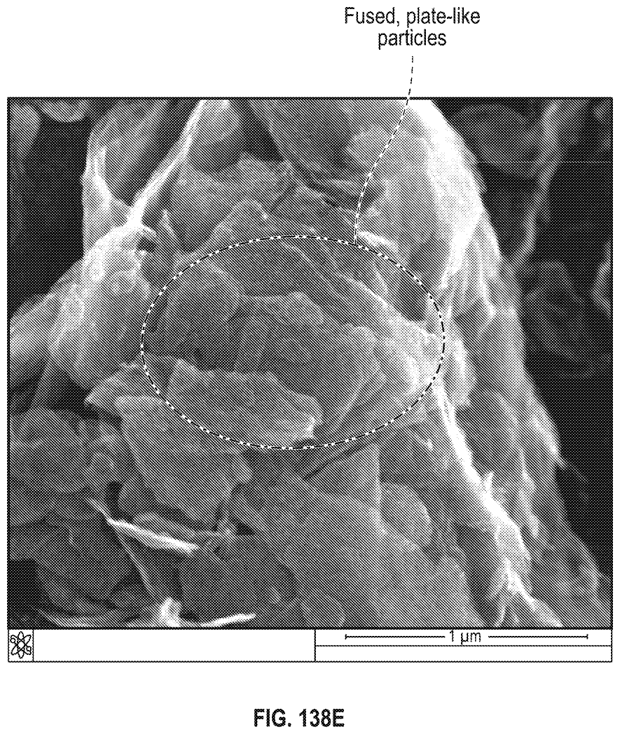

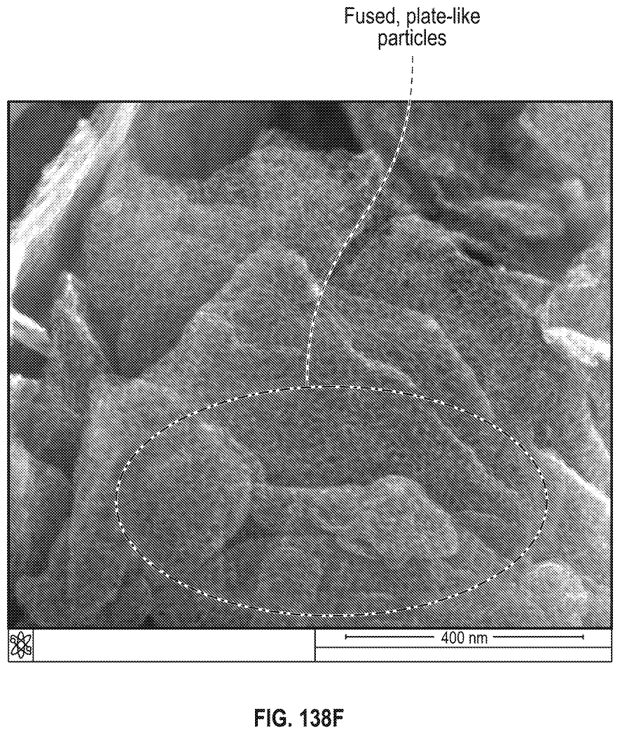

A similar comparison was made between Sample E2 and E2A. Like Sample E1, Sample E2 densified into hard, macroscopic granules, like the one shown in FIG. 138A. At higher magnifications, the Sample E2 particles can be seen within these granules. Like Sample E1's particles, Sample E2's particles appear wavy and flexible, as shown in FIG. 138B-138C.

Sample E2A occupied a conspicuously larger volume and was finer in consistency than the Sample E2 powder. Compared to the larger, harder granules in Sample E2, the Sample E2A powder consisted of smaller, softer agglomerates, as shown in FIG. 138D. The annealed particles in Sample E2A again exhibited rigidification effects-both at the particle level and locally. The annealed Sample E2A particles were more rigid and straight than the unannealed particles in Sample E2, as shown in FIG. 138E-138F. Also, as shown in FIG. 138F, the flush plate-to-plate stacking observed in the template powder was retained in the Sample E2A powder, possibly indicating that the plate-like particles had fused together during annealing, such that they were not broken apart during liquid-phase extraction of the endomorph. Particle-to-particle fusing effects are discussed more in connection with Study F.

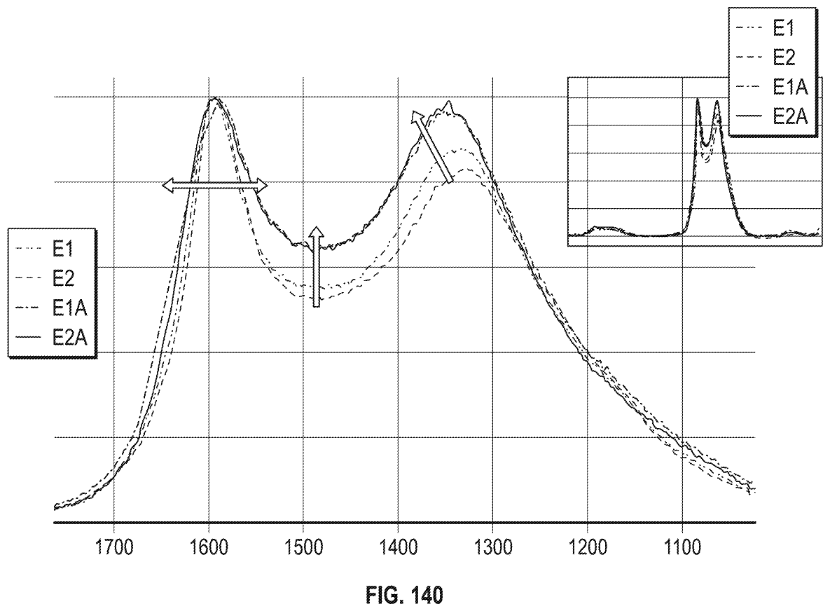

To understand the changes in the bonding structure created by annealing, Raman analysis was performed using a 532 nm laser at 5 mW power. FIG. 140 shows the average spectra in the range of the Gᵤ and Dᵤ peaks, with the spectral changes associated with annealing indicated via black arrows. FIG. 222 summarizes the average I_{D}_{ᵤ}/I_{G}_{ᵤ} and I_{Tr}_{ᵤ}/I_{G}_{ᵤ} peak intensity ratios, the average Gᵤ and Dᵤ peak positions, and the interval between the Gᵤ and Dᵤ peak positions.

The interpolated Dᵤ peak positions in Samples E1 and E2 indicate the presence of sp³ states associated with diamondlike seams. Based on Sample E1's Dᵤ peak position of 1335 cm⁻¹, a perimorphic framework from Sample E1 comprises a partially grafted z-sp^{x} network. Based on Sample E2's Dᵤ peak position of 1328 cm⁻¹, a perimorphic framework from Sample E2 comprises a highly grafted x-sp^{x} network. Their interpeak intervals are typical for anthracite.

By comparison, the Dᵤ peak positions of the matured Samples E1A and E2A are 1352 cm⁻¹ and 1347 cm⁻¹, respectively. These fall into the sp² D band's normal range under 532 nm Raman excitation; as such, maturation has eliminated the strong coupling of sp² and sp³ phases in the perimorphic frameworks of Samples E1A and E2A. This indicates that the sp³ states associated with diamondlike seams have been substantially reduced or eliminated in Samples E1A and E2A. Their increased I_{D}_{ᵤ}/I_{G}_{ᵤ} peak intensity ratios and reduced interpeak intervals reflect the maturation of the anthracitic networks. Based on Sample E1A's Dᵤ peak position, its frameworks comprise highly matured, helicoidal z-carbons, and based on Sample E2A's Dᵤ peak position, its frameworks comprise highly mature, helicoidal x-carbons.

Given the elimination of diamondlike seams, which provide a crosslinking mechanism to the sp^{x} networks in Samples E1 and E2, it is surprising that the particles and the perimorphic walls in the mature samples are rigidified. If these mature particles were not ring-connected, such thin-walled carbons should not have survived extraction of the templates, much less have been conspicuously rigidified compared to their sp^{x} precursors. We can therefore conclude that the mature particles are crosslinked via crosslinking structures that are more rigid than the precursors' atomically thin diamondlike seams.

Aside from the reversion of their Dᵤ peaks back to the normal D band range, Samples E1A and E2A also exhibit increased Dᵤ and Trᵤ peak intensities (relative to their Gᵤ peak), as shown in FIG. 140. The increase in the Dᵤ peak intensity (and area) reflects a proliferation of sp² rings. The deinterpolation of the Dᵤ peak, together with the increased sp² ring structuring, evidence an sp³-to-sp² rehybridization that transforms sp^{x} rings into sp² rings. The increased trough heights of the annealed samples indicate a red-shifted mode of the G peak consistent with the creation of sp² lattice distortion. Taken together, the elimination of sp³ states, the lattice distortion, and the increased rigidity of the particles' crosslinking, are evidence that sp³-to-sp² rehybridization is eliminating diamondlike seams and forming sp²-hybridized screw dislocations. These screw dislocations provide both vertical and lateral crosslinking and impose a helicoidal geometry on the mature network. This helicoidal network architecture can be conceptualized as a mesh formed by numerous screw dislocation loops like the one illustrated in FIG. 100D.

To demonstrate the maturation of the sp^{x} precursor into a helicoidal network, we start by modeling the effect of sp³-to-sp² rehybridization on diamondlike seams. Frame I of FIG. 141 illustrates a multilayer singleton traversed vertically by a cubic diamondlike seam. The illustrated system can be thought of as a small region within a much larger sp^{x} precursor system. The seam comprises sp²-sp³ bonds, and sp³-sp³ bonds.

During annealing, as shown in Frame II of FIG. 141, the sp³-to-sp² rehybridization of each of the structure's sp³ members requires scission of one of its bonds. Two bonds cannot be broken without creating a high-energy sp² radical. The sp³-sp³ bonds are the least stable and are destabilized first during annealing (these broken bonds are indicated by dashed lines in Frame II of FIG. 141). Because the sp³ atoms and the sp³-sp³ bond lines between them comprise lateral lines, the rehybridization of one sp³ atom, and the scission of one of its sp³-sp³ bonds, destabilizes the xy-adjacent sp³-sp³ bonds along the bond line, resulting in a linear unzipping. The unzipping of entire lines leads to an ABAB pattern of scission and retention-if a sp³-sp³ bond line is broken, the two z-adjacent bond lines are preserved in order to avoid forming high-energy sp² radicals.

In this way, the diamondlike seams via lateral unzipping, and the associated ring-connections between z-adjacent layers are also eliminated. The singleton from Frame I of FIG. 141 is therefore disintegrated into a vdW assembly of distorted, disconnected layers. This is illustrated in Frame III of FIG. 141. This clarifies the diamondlike seams' role in laterally and vertically ring-connecting an sp^{x} network. During scission, as illustrated in FIG. 141, the lateral mode of crosslinking is retained, but the vertical mode of crosslinking is eliminated. Based on this, we can conclude that the maturation of an sp^{x} network eliminates the vertical crosslinking associated with diamondlike seams. If no other vertical crosslinking mechanism were present, maturation would transform the sp^{x} precursor into a vdW assembly, which, deprived of vertical crosslinking, would be less rigid than its three-dimensionally crosslinked precursor.

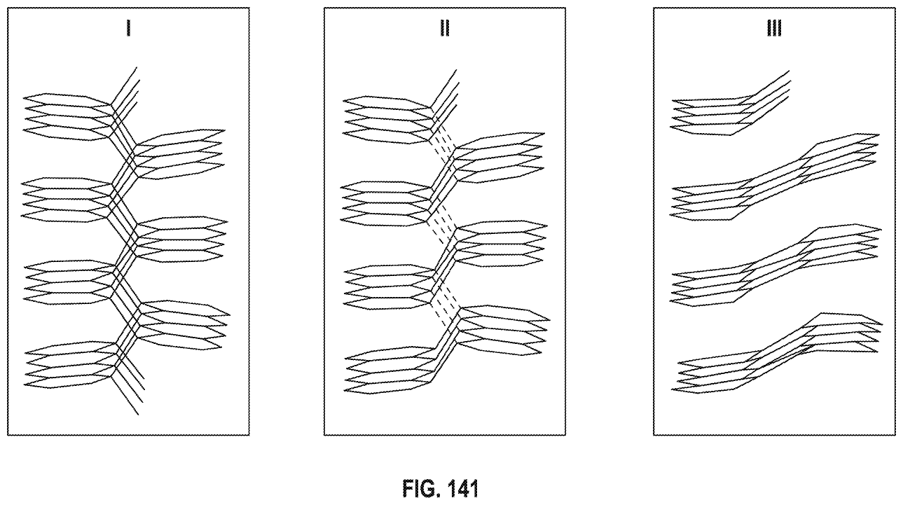

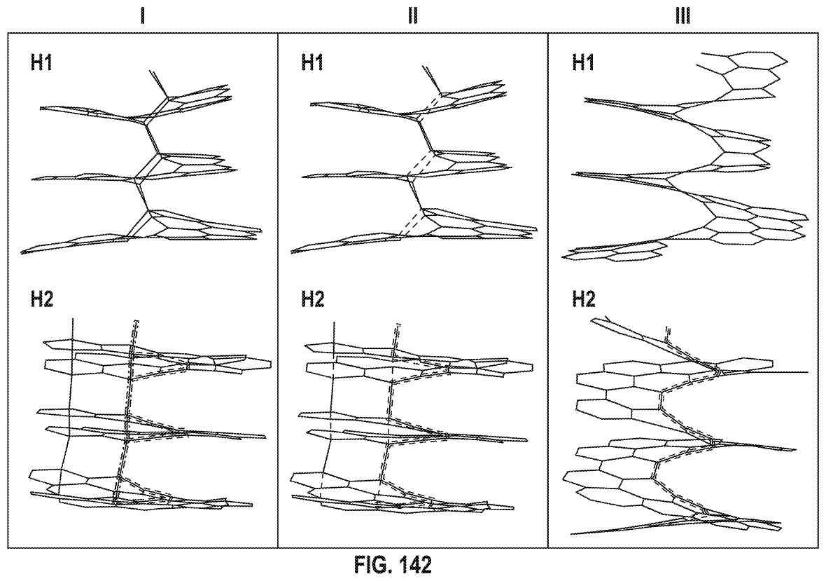

Next, we consider the effects of maturing an sp^{x} precursor with chiral rings and chiral columns. Since we already modeled the formation of such a system (FIG. 124) in Study A, we appropriate this model as an exemplary sp^{x} precursor. However, in order to improve visualization of its maturation, we consider only half of the system from FIG. 124, which is shown from two perpendicular horizontal perspectives (H1 and H2) in Frame I of FIG. 142. Similar to the precursor we modeled in FIG. 141, this new precursor in Frame I of FIG. 142 comprises a diamondlike seam. However, unlike the precursor modeled in FIG. 141, this precursor's diamondlike seam terminates in a chiral column. The chiral column is traced in the H2 perspective of Frame I of FIG. 142, with the chiral chains being traced by dashed lines and the sp³-sp³ bonds connecting the z-adjacent chiral chains being traced with dash-dotted lines.

During maturation, sp³-to-sp³ rehybridization of the sp³ sites results in bond scission. The sp³-sp³ bonds are the least stable and are destabilized first. The sp³-sp³ bonds between the two terminal atomic members of each chiral chain are broken. Each such bond represents the terminus of a lateral sp³-sp³ bond line, and its scission destabilizes the rest of the sp³-sp³ bond line. Accordingly, the linear unzipping of sp³-sp³ bond lines (previously illustrated in Frame II of FIG. 141) occurs in Frame II of FIG. 142. These broken bonds are indicated by the dashed lines in Frame II of FIG. 142. To avoid the creation of high-energy sp² radicals, an ABAB pattern of sp³-sp³ bond scission and retention is formed.

In the H1 perspective of Frame II of FIG. 142, we can see that the system's diamondlike seams are eliminated as these sp³-sp³ bond lines are unzipped. As they are eliminated, the vertical crosslinking associated with them is also eliminated, while the lateral crosslinking remains. If there were no chiral rings or columns, this loss of vertical crosslinking would again result in a vdW assembly of disconnected z-adjacent layers, as it did in the system demonstrated in FIG. 141. However, in this case, a chiral column is present, and the ABAB scission leaves intact the bonds comprising the sp^{x} helix within the chiral column. This occurs because, as the sp³-sp³ bonds between the terminal atomic members of each chiral chain are broken, the z-adjacent sp³-sp³ bonds between the chiral rings are retained, in keeping with the ABAB pattern of scission and retention. These retained bonds are transformed into sp²-sp² bonds due to sp³-to-sp² rehybridization. This transforms the one-dimensional sp^{x} helix into a one-dimensional sp² helix comprising sp² atoms and sp²-sp² bonds. These bonds are traced with dashed lines in the H2 perspective in Frame II of FIG. 142. Despite the loss of vertical crosslinking associated with diamondlike seams, the system retains vertical crosslinking associated with the chiral columns due to the retention of this sp² helix, which ring-connects the z-adjacent layers. Hence, both lateral and vertical crosslinking are retained during maturation. Chiral rings (and the associated chiral columns of connected chiral rings) are the key to the retention of vertical crosslinking during maturation.

This retention of lateral and vertical crosslinking is shown in Frame III of FIG. 142, which represents the relaxed system illustrated in Frame II. From Frame III, we can see that the helicoidal, ribbon-like graphenic structure formed by maturation has, at its center, a z-directional screw dislocation. The atoms in the central sp² helix are all members of a ring both before and after sp³-to-sp² rehybridization. Because of this, the formation of an sp² helix during maturation is accompanied by the formation of a helicoidal path of adjacent sp² rings to which the sp² helix belongs as an edge segment. Therefore, from the formation of an sp² helix, we can infer the formation of a graphenic helicoid to which the sp² helix belongs, and from the retention of vertical crosslinking by virtue of the sp² helix, we can infer the retention of vertical ring-connectedness.

We can see from Frame III of FIG. 142 that, in order to preserve vertical ring-connectedness, the helicoidal graphenic structure must be distorted. Graphenic screw dislocations have been shown to exhibit torsional strain, and along with this torsional strain, we would expect to see a proliferation of lower-frequency, strain-induced phonon states. The higher troughs of Samples S1A and S2A are evidence of this lattice distortion caused by this helicoidal geometry. Additionally, we can see from Frame III of FIG. 142 that the sp³ states are exchanged for sp² edge states. The elimination of sp³ states and proliferation of sp² edge states is reflected by the deinterpolation of the Dᵤ peak position in Samples E1A and E2A. The proliferation of sp² rings associated with the conversion of sp^{x} rings into sp² rings is reflected in the increased Dᵤ peak intensity in Samples E1A and E2A. Hence, the formation of helicoids around chiral columns explains a number of spectral changes associated with maturation.

The edge segment comprising the sp² helix represents an interesting structure. While it comprises a zigzag edge configuration, it is unique in that every atomic member of the segment is bonded to three nearest-neighbor carbon atoms, whereas in a normal zigzag edge configuration only half of the edge atoms are bonded to three carbon atoms. This unique attribute of a helical zigzag results from the fact that it represents the chain of atoms created by a broken-open polygon, in which the internal angles of the broken-open polygon are all less than 180°, and thus 3 carbon neighbors are allowed at every edge site (as opposed to a normal zigzag edge, which comprises reflex angles that prevent every edge site from being bonded to three carbon atoms). This novel edge configuration may yield novel electromagnetic and thermal properties, which are known to be dependent on edge configuration in graphenic nanoribbons.

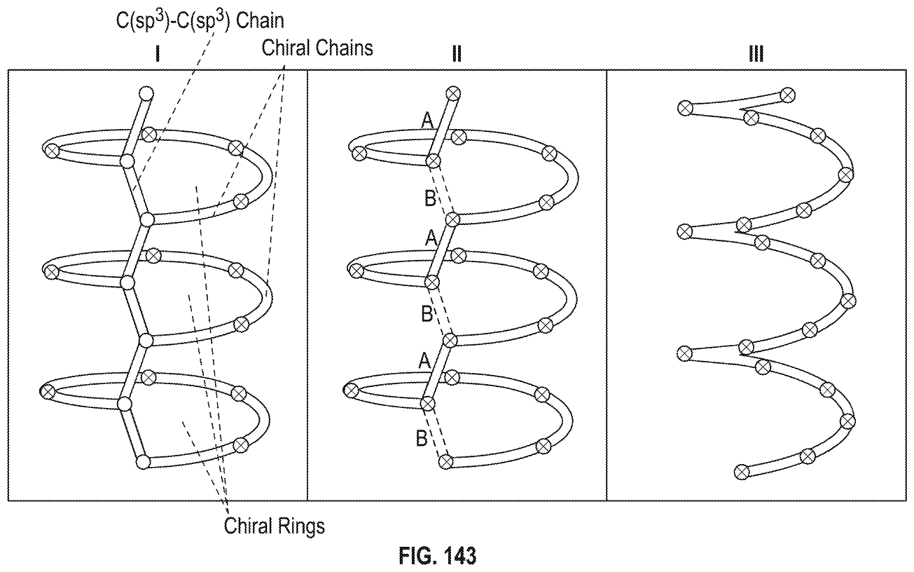

To further clarify the process by which an sp² helix is evolved from an sp^{x} helix, we illustrate the transformation diagrammatically in FIG. 143. In Frame I of FIG. 143, a chiral column of 3 z-adjacent chiral rings is represented. Pattern-filled circles in FIG. 143 represent sp² atoms, while white circles represent sp³ atoms.

During maturation, the sp³-sp³ bond within each of the chiral rings is broken, as we previously discussed in connection with Frame II of FIG. 142, producing the ABAB pattern of sp³-sp³ bond scission and retention. The broken sp³-sp³ bonds, representing the “B” phase of the ABAB pattern, are represented as dashed lines and labeled “B” in Frame II of FIG. 143. Meanwhile, the retained sp³-sp³ bonds, representing the “A” phase of the ABAB pattern, are transformed via rehybridization into sp²-sp² bonds. Accordingly, these are represented as solid lines and labeled “A” in Frame II of FIG. 143. The result is a one-dimensional, helical chain of sp² atoms connected via sp²-sp² bonds. Upon relaxation, this sp² helix's curvature becomes more uniform, as shown in Frame III of FIG. 143.

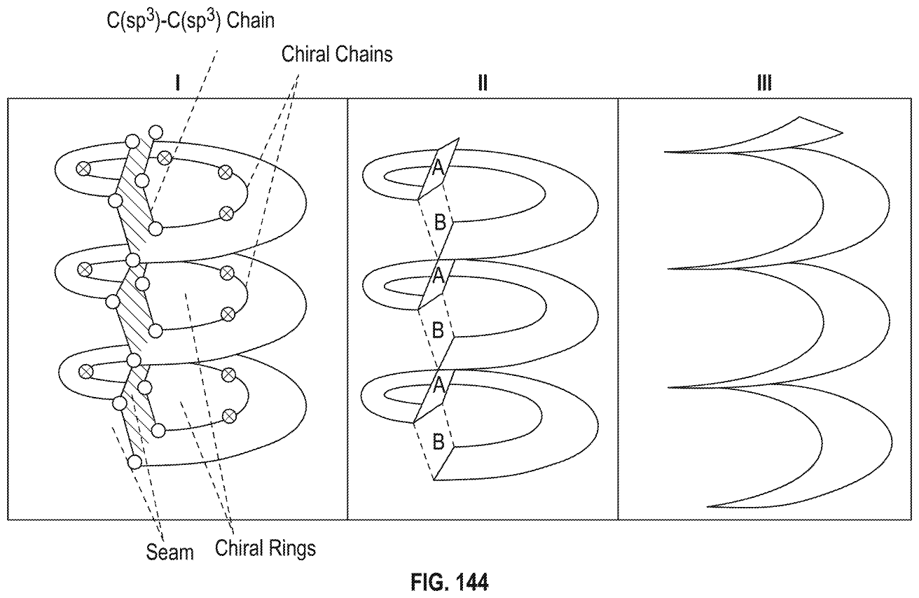

Next, we consider the transformation of the two-dimensional graphenic structure surrounding these one-dimensional helices. As we have established, the formation of an sp² helix is necessarily accompanied by the formation of a graphenic helicoid, within which the sp² helix represents an edge segment. The diagram in FIG. 144 mirrors the diagram of FIG. 143, except that in FIG. 144 we attempt to represent the ring-connected structure surrounding the sp^{x} and sp² helices, such that we can diagram the formation of the helicoidal geometry. In Frame I of FIG. 144, we illustrate a diamondlike seam (extending into the foreground, as indicated by the translucent portion of the diagram) that terminates in the same chiral column we diagrammed in Frame I of FIG. 143. In keeping with our established convention, the pattern-filled circles in Frame I of FIG. 144 represent sp² atoms and the white circles represent sp³ atoms. However, in FIG. 144 we use white and diagonally pattern-filled areas to represent ring-connected spaces. The white space surrounding the chiral chains, for instance, represents a ring-connected sp² space surrounding the chiral chains. The diagonally pattern-filled spaces indicate the ring-connected sp³ space associated with the diamondlike seam.

During maturation, the central sp^{x} helix in Frame I of FIG. 144 undergoes the same transformation that we diagrammed in FIG. 144. Namely, the sp³-sp³ bond within each of the chiral rings is broken, and followed by this, as represented in Frame II of FIG. 144, the associated sp³-sp³ bond line is unzipped. This eliminates the fraction of ring-connected sp³ space associated with the “B” phase of the ABAB pattern. In Frame II of FIG. 144, we label this eliminated space “B,” and we can imagine it extending into the foreground of the diagram, like the diamondlike seam illustrated in Frame I. Meanwhile, the retained sp³-sp³ bond line representing the “A” phase of the ABAB pattern is transformed via rehybridization into a sp²-sp² bond line. This “A” phase of retained, ring-connected space is labeled “A” in Frame II of FIG. 144. We can also imagine it extending into the foreground of the diagram, like the diamondlike seam illustrated in Frame I.

Upon relaxation, a single, helicoidal graphenic structure is produced, as shown in Frame III of FIG. 144, with the same one-dimensional sp² helix (i.e. screw dislocation) from Frame III of FIG. 143 at its center. The parametric equations approximating this helicoid are x=u cos(v), y=u sin(v), z=cv, where the value of u is greater than or equal to the radius of the one-dimensional sp² helix evolved from the central sp^{x} helix.

These diagrams illustrate how maturation of an sp^{x} network with diamondlike seams and chiral rings can generate a laterally and vertically ring-connected mature network. To illustrate the principles of this transformation, we utilized a simple sp^{x} precursor comprising a single diamondlike seam and a single sp^{x} helix. However, reasonably large sp^{x} networks might comprise countless seams and chiral rings formed via tectonic interactions and grafting. In many cases, as we showed in FIG. 124, a single tectonic encounter between two edge segments may evolve multiple seams and chiral rings.

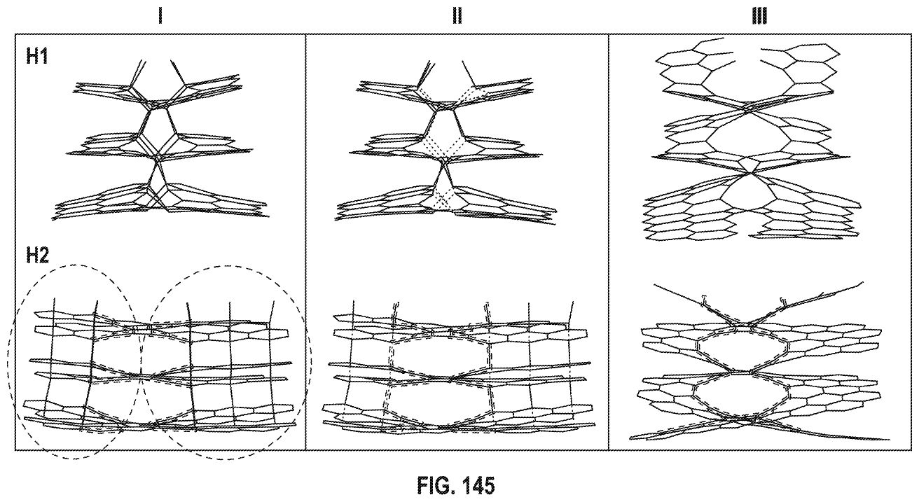

For this reason, it is desirable to model the transformation of a simple, exemplary sp^{x} precursor that comprises multiple seams and chiral rings. Since we already modeled the formation of such a system (FIG. 124) in Study A, we return to it for this present purpose. We derived this hypothetical sp^{x} network from the tectonic encounter and subsequent pyrolytic growth that were illustrated in FIGS. 117-124. In order to facilitate visual evaluation of the system's transformation, we illustrate it from two perpendicular horizontal perspectives (H1 and H2) in FIG. 145.

In Frame I of FIG. 145, we can see that the sp^{x} precursor comprises two distinct diamondlike seams (each seam is circled in the H2 perspective), as well as chiral columns representing the lateral termini of those seams (in the H2 perspective, the chiral chains within the chiral columns are traced with dashed lines). During maturation, sp³-to-sp² rehybridization leads to scission of the sp³-sp³ bond within each of the chiral rings, as discussed in connection with the transformation of the system in FIG. 142 (itself a subsystem of the system under consideration in FIG. 145, as may be recalled). This is illustrated in Frame II of FIG. 145, where dashed lines are again used to represent broken sp³-sp³ bonds. The ABAB pattern of scission and retention of sp³-sp³ bond lines proceeds according to the sequence already discussed in connection with the system transformation of FIG. 142. Retained bonds are transformed into sp²-sp² bonds (traced with dashed lines in the H2 perspective in Frame II of FIG. 145). The only significant difference between the transformations illustrated in FIGS. 142 and 145 is that the transformation in FIG. 145 extends across the larger sp^{x} precursor's multiple seams and chiral rings.

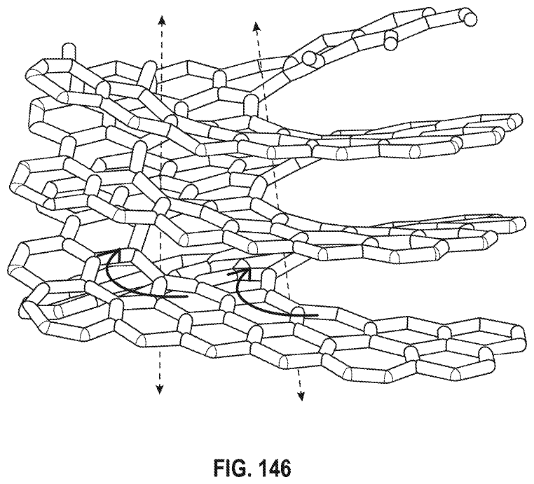

Relaxation of the system illustrated in Frame II of FIG. 145 creates the helicoidal network illustrated in Frame III of FIG. 145. This singleton comprises a network of two conjoined helicoidal regions formed by the system's two distinct screw dislocations. The helicoidal regions are ring-connected to each other, although the horizontal perspectives in FIG. 145 are not ideal for visual discernment of the ring-connections (a better perspective for discerning the ring-connectedness is offered in FIG. 146). The two sp² helices associated with the screw dislocations are traced with dashed lines in Frame III of FIG. 145. Together, the two screw dislocations comprise a loop. Both of the screws have a common chirality.

To better observe the ring-connections between the two helicoids in Frame III of FIG. 145, FIG. 146 illustrates the singleton from a diagonal angle and uses a stick-model visualization to help with depth perception. The solid arrows indicate the common chirality of the two helicoids, while the dashed arrows approximate the two helicoids' axes—i.e. the dislocation lines. The entire loop shown in FIG. 146 comprises a ring-connected singleton akin to the graphenic screw dislocation loops that have been observed in regions of anthracite (FIG. 100D).

From these simple models, the spectral data from Study E, and the changes in mechanical behavior observed in Study E, we can conclude that the changes in bonding structure between Samples E1 and E1A, and between Samples E2 and E2A, are driven by sp³-to-sp² rehybridization, which transforms sp^{x} networks into helicoidal networks.

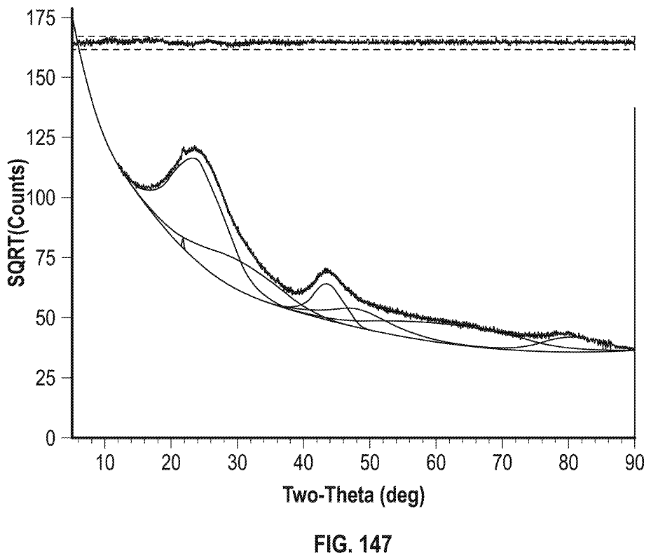

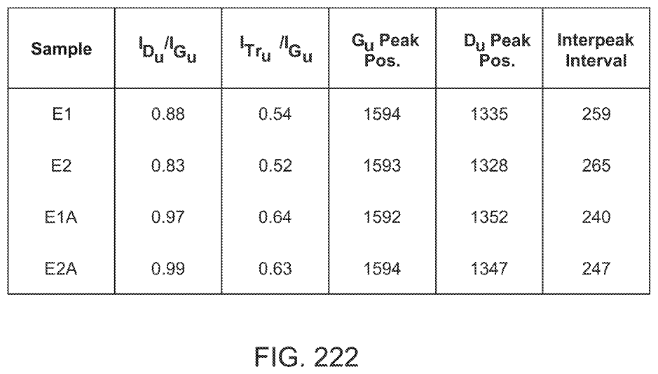

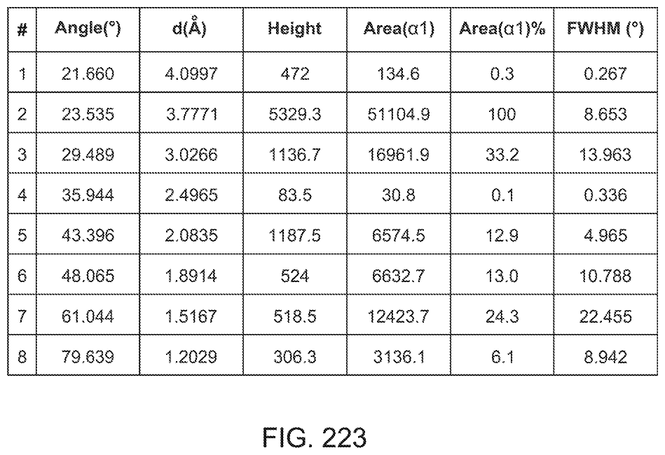

This is further corroborated by XRD analysis. For this analysis, we annealed Sample B4, a powder of x-sp^{x} networks, at a temperature of 1,050° C. for 30 minutes under flowing Ar, creating Sample B4A. This matured the x-sp^{x} networks into helicoidal x-networks. FIG. 147 shows the overall XRD profile of Sample B4A. FIG. 223 contains the XRD peak angles, d-spacings, areas, area percentages (normalized to the area of the dominant peak at 2θ=23.5350), and full-width half max values (without correction for instrument broadening).

Sample B4A's XRD profile contains significant changes. First, the broad peak fitted at 2θ=18.454° in Sample B4, which accounted for 30.4%, is not fitted in this range in Sample B4A's profile. We attributed this peak in Sample B4 to a phase of expanded interlayer spacing caused by z-directional bowing of graphenic regions due to intralayer compression beyond their critical buckling strain. At the same time, in Sample B4A, we see the emergence of an even broader fitted peak at 2θ=29.489°, corresponding to a d-spacing of 3.03 Å, with a peak area of 33.2%. These spectral changes suggest an overall shift toward smaller interlayer d-spacings, and the peak center at 2θ=29.489° indicates potential interlayer compression.

Additionally, comparing Sample B4 to Sample B4A, we note a shift in the <100> peak from 2θ=43.138° to 2θ=43.396°, respectively, corresponding to a reduction in <100> d-spacing from 2.10 Å to 2.08 Å. We also see an increase in the main <002> peak at 2θ=23.535°, corresponding to an increase in the average interlayer d-spacing from 3.63 Å to 3.78 Å.

These changes are explained by the transformed crosslinking structure. The cross-section of a diamondlike seam in the <100> plane is a line (i.e. one-dimensional), whereas the cross-section of a screw dislocation in the <100> plane is a point (i.e. zero-dimensional). Therefore, the elimination of one-dimensional pins during maturation leaves only zero-dimensional pins coinciding with the endpoints of the eliminated one-dimensional pins. With the diamondlike seams unzipped, the bowed layers are only pinned at points, instead of along entire lines, and they have more freedom to relax.

The lateral relaxation of these bowed regions has the effect of reducing the amplitude of their z-deflections (thereby eliminating Sample B4's broad peak at 2θ=18.454°, which was attributed to bowing), but obtains this by distributing intralayer compressive strain and lattice distortion more globally. This increases the average interlayer d-spacing (the d-spacing associated with the main <002> peak increases from 3.78 Å to 3.63 Å). It also is reflected in the shift of the broad interlayer peak from 2θ=18.454° to 2θ=29.489°. We see increased compressive strain in the <100> peak, the d-spacing of which is reduced by maturation from 2.10 Å to 2.08 Å.

Unlike the other fitted peaks, which are broad and represent low correlations, the peaks at 2θ=21.660° and 2θ=35.944° are sharp, suggesting features with high periodicity. The most likely cause for these are interlayer periodicities that are consistently formed at the screw dislocation cores of the helicoids.

Having now explored the formation of sp^{x} networks and their maturation into helicoidal networks and having understood the basic features of these anthracitic networks, we now turn to understanding tectonic zone transitions and their effect on mature, helicoidal networks, and we demonstrate how tectonic zone transitions can lead to the formation of structural variants, including sp^{x} double helices, sp² double helices, and double helicoids.

First, we return to the helicoidal network illustrated in FIG. 146, wherein the two conjoined helicoids, and the screw dislocations from which they derive, have the same chirality. This reflects a preservation of the common chirality of the chiral chains within the two base-layer chiral rings (R_{2-C} and R_{4-C}) formed at the E1-E2 tectonic interface that was modeled in FIG. 117. We previously attributed the common chirality of these chiral rings to the inversion of the edge elevations between Offset Zone I and Offset Zone II in the E1-E2 interface modeled in FIG. 117.

In an alternative scenario, where the edge elevations between Offset Zone I and Offset Zone II are not inverted, the chiral chains in the two base-layer chiral rings possess opposite chirality. In FIG. 148, we compare the original scenario with this alternative scenario. In Frame I, corresponding to the original scenario, we show the base resulting from sp² and sp³ grafting across an interface in which the edge elevations are inverted between Offset Zone I and Offset Zone II. In this scenario, we have already seen that the chiral rings R_{2-C} and R_{4-C} are formed at the transitions between each of the two offset zones and the level zone between them. The common chirality of the chiral chains is indicated by the direction of the arrows in the vertical perspective in Frame I of FIG. 148.

In Frame II of FIG. 148, corresponding to the new scenario, we show the base resulting from sp² and sp³ grafting across an interface in which the edge elevations are not inverted between Offset Zone I and Offset Zone II. In this alternative scenario, the chiral rings R_{2-C} and R_{4-C} are still formed at the transitions between each of the two offset zones and the level zone between them. However, since the edges do not crisscross, and the edge elevations do not invert, the chiral chains have opposite chirality. This opposite chirality is indicated by the direction of the arrows in the vertical perspective in Frame II of FIG. 148.

If an sp^{x} network were subsequently grown over this base, the sp^{x} helices would have opposite chirality, and associated with this, less Eshelby twist between z-adjacent layers. If this singleton were then transformed into a helicoidal network via sp³-to-sp² rehybridization, the screw dislocation loop formed by the two sp² helices of opposite chirality would be less strained. From initial formation of the base-layer chiral rings to the intermediate formation of an sp^{x} network with mixed dislocations, to the ultimate formation of the helicoidal network, chirality is preserved. Anthracite researchers have observed that screw dislocation loops often involve two xy-adjacent screw dislocations with opposite chirality. We find that loops may also involve two nearby screw dislocations with common chirality.

Another potential interfacial configuration is created when the opposing edge segments crisscross without forming a level zone between the two offset zones to either side. This configuration may occur when, in spite of having similar elevations where the crisscrossing occurs, the 2p_{z} orbitals of opposing sp² edge atoms are too misaligned for R bonds to form. The point at which the edges crisscross in this way is referred to as a “crossover point.” Edge atoms at a crossover point may form sp³-sp³ bonds in order to eliminate high-energy sp² edge states, but they cannot form a sp²-sp² bond line. We find that at these crossover points, sp³ grafting leads to the formation of chiral columns comprising sp^{x} double-helices, which upon maturation form sp² double helices associated with double helicoids.

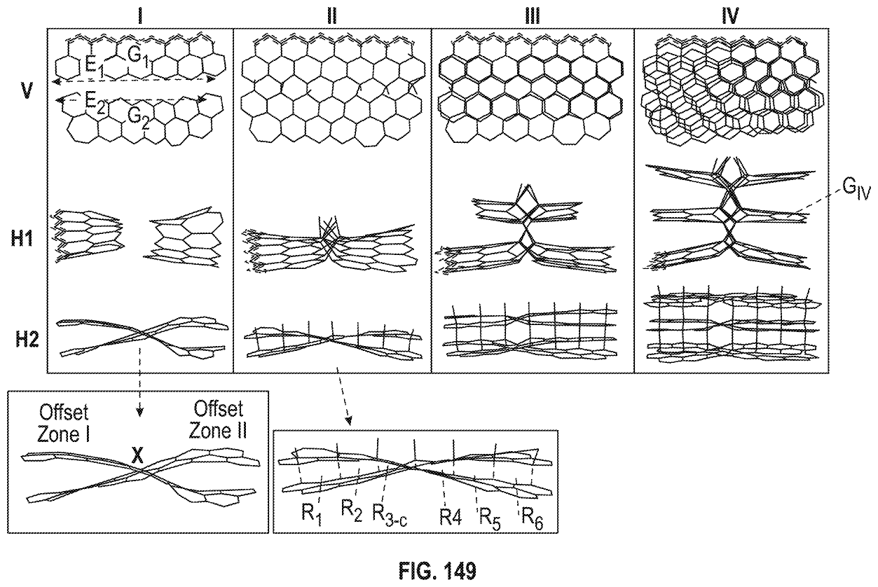

The pyrolytic synthesis of an sp^{x} network over a tectonic interface with a crossover point is illustrated in FIG. 149. The sequence is broken into 4 stages in FIG. 149. In Stage I of FIG. 149, we illustrate the E₁-E₂ interface from FIG. 117, but in the current analysis, we will postulate that the edges' crisscrossing disallows sp² grafting i.e. that there is a crossover point between Offset Zone I and Offset Zone II. Although the interface illustrated is unchanged, we will refer to it as the E₁-E₂^{c} interface to indicate that, in lieu of the level zone, we have postulated a crossover point. In Stage I of FIG. 149, the interfacial zones associated with the E₁-E₂^{c} interface are illustrated in the magnified inset of the H2 perspective. The adjacent offset zones are divided by a crossover point, indicated with an X in the magnified inset.

In Stage II of FIG. 149, we model the grafting of G₁ and G₂ and the nucleation of vertical growth via radical addition above the grafted base. The grafting and subsequent growth are consistent with the mechanisms previously discussed in connection with the pyrolytic growth modeled in FIGS. 117-124. However, in the current analysis, no sp² grafting of E₁ and E₂ occurs due to the misalignment of the edges. Instead, only sp³ grafting occurs. The two sp³-sp³ bond lines across the E₁-E₂^{c} interface are represented by dashed lines (each an sp³-sp³ bond) in the magnified inset of Stage II of FIG. 149.

The two sp³-sp³ bond lines form 6 laterally adjacent sp^{x} rings, each comprising 6 atomic members. Five of the sp^{x} rings (R₁, R₂, R₄, R₅, and R₆) are in the chair conformation, with the orientation of R₁ and R₂ comprising a point reflection of the orientation of R₄, R₅, and R₆. As established in the analysis of FIGS. 117-124, this point reflection is due to the inversion of the edge elevations between the two offset zones. The other sp^{x} ring (R_{3-C}) is a chiral ring established at the crossover point, in keeping with our previous finding that chiral rings form at interfacial zone transitions. However, we shall establish that chiral rings like R_{3-C} that are formed at crossover points may incorporate 2 chiral chains, while chiral rings formed at tectonic zone transitions involving level zones incorporate only 1 chiral chain.

In Stages III and IV of FIG. 149, we model the formation of an sp^{x} network by continued vertical and lateral growth. This proceeds according to the same principles and mechanisms previously established in the discussion and analysis of FIGS. 117-124. Ring-connectedness is extended laterally and vertically throughout the higher layers via diamondlike seams. Eshelby twist between each of the z-adjacent layers can be observed in the vertical perspective of both Stage III and IV. The sp^{x} network (G_{IV}) modeled in Stage IV comprises two distinct diamondlike seams.

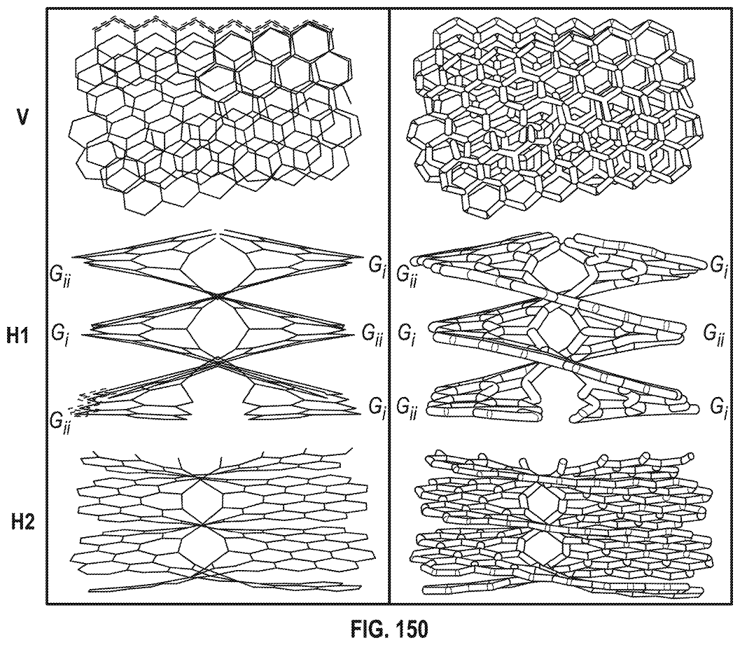

In FIG. 150, we model a double helicoid formed by the maturation of the sp^{x} precursor G_{IV}. The double helicoid comprises two disconnected, helicoidal graphenic structures Gᵢ and Gᵢᵢ that are created by the maturation-driven disintegration of G_{IV}. Based on its plural membership of distinct graphenic structures, the double helicoid in FIG. 150 comprises an assembly-type system. This assembly is illustrated from a vertical perspective and two perpendicular horizontal perspectives, and using two molecular visualizations, in FIG. 150. The cause of disintegration is the ABAB pattern of bond scission and retention, arising from sp³-to-sp² rehybridization. As previously established, the sp³-sp³ bonds in chiral rings are broken, causing lateral unzipping of the associated sp³-sp³ bond lines. At the center of the double helicoid is a double screw dislocation. Double screw dislocations have been observed in protein crystals and we find that the geometry of an interfacial crossover point may force their formation upon maturation.

The maturation of the sp^{x} precursor G_{IV} causes disintegration because its base is not sp² ring-connected. The G_{IV} base is sp² ring-disconnected because of the absence of a level zone and sp² grafting across the E₁-E₂° interface from which the base was derived. Instead, only sp³ grafting occurred across the E₁-E₂° interface, so the primordial domains G₁ and G₂ were only ring-connected by virtue of the sp^{x} ring-connections (R₁, R₂, R₃-c R₄, R₅ and R₆) formed from these sp³-sp³ bonds. After its formation, the base layer remains sp² ring-disconnected while G_{IV} is constructed over it. As a result, during maturation, the base layer of G_{IV} is completely unzipped along this sp³-grafted interface, such that the primordial regions associated with G₁ and G₂ become once again disconnected at the base. For the system to remain ring-connected, these two primordial regions of the base must be ring-connected via some path of adjacent rings across the higher layers. However, each higher layer, like the base, is completely unzipped, eliminating any such path. The result is that the sp^{x} precursor is completely disintegrated into two graphenic structures, Gᵢ and Gᵢᵢ where the primordial region G₁ is within Gᵢ and the primordial region G₂ is within Gᵢᵢ.

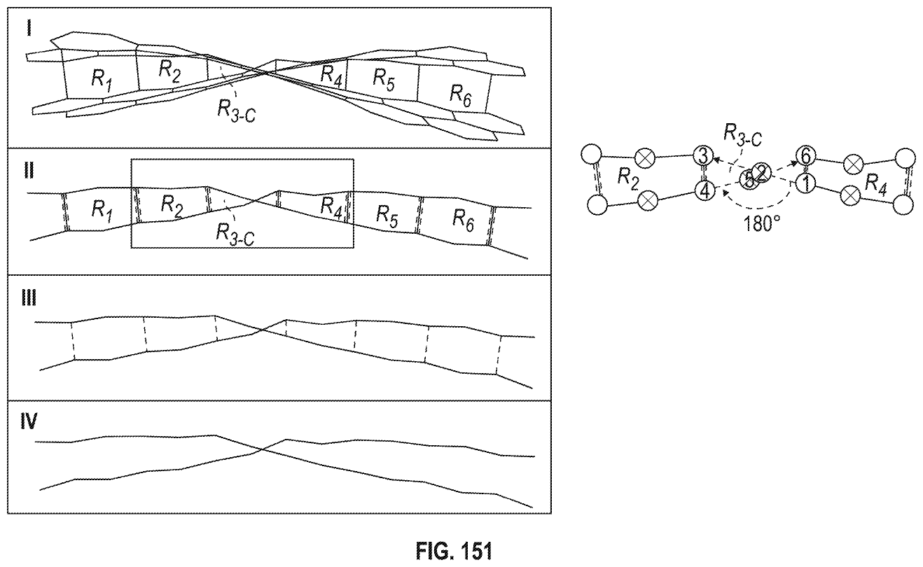

The unzipping of the sp² ring-disconnected base in FIG. 149 is more closely analyzed in FIG. 151. The base is illustrated in Frame I of FIG. 151. The sp^{x} ring connections (R₁, R₂, R_{3-C}, R₄, R₅ and R₆) formed via sp³ grafting are labeled. In Frame II of FIG. 151, we further isolate the portion of the base comprising the primordial E₁ and E₂ edge atoms from which the sp^{x} ring connections are constructed. These atoms comprise a zigzag-zigzag interface, which is grafted via two sp³-sp³ bond lines (traced with dashed lines in Frame II). Each of the 6 sp^{x} rings comprises 2 sp³-sp³ bonds. In Frame II, we can see the crossover point, where the edge elevations invert, and corresponding with the crossover point, the chiral ring R_{3-C}. With the exception of the chiral ring R_{3-C}, the other sp^{x} rings in FIG. 151 are in the chair conformation. As shown in the magnified diagram of Frame II, the rings in the chair conformation each comprise 4 sp³ atoms (represented as white circles) and 2 sp² atoms (represented as pattern-filled circles). In each of these rings, the 2 sp³-sp³ bonds have a common orientation.

Like the other sp^{x} rings formed via sp³ grafting, the chiral ring R_{3-C} comprises 4 sp³ members and 2 sp² members. In R_{3-C}, however, the 2 sp³-sp³ bonds are not parallel instead, they are point-reflected with respect to each other. This point reflection is due to the inversion of edge elevations that happens at the crossover point where R_{3-C} is located. The 6 atomic members of R_{3-C} are labeled 1 through 6 in Frame II of FIG. 151. The ring's point-reflected sp³-sp³ bonds result in 2 distinct, point-reflected chiral chains comprising 1-2-3 and 4-5-6. In the magnified diagram in Frame II of FIG. 151, the 1-2-3 chiral chain in the foreground is indicated by a dashed arrow, and the 4-5-6 chiral chain in the background is indicated by a second dashed arrow. The direction of these arrows coincides with increasing elevation in the z-direction.

As with other chiral rings we have modeled, the termini of the chiral chains in the chiral ring R_{3-C} are connected via sp³-sp³ bonds. In the magnified diagram in Frame II of FIG. 151, we can see that the termini of the 1-2-3 chiral chain (i.e. the terminal atoms 1 and 3) are connected to the termini of the 4-5-6 chiral chain (i.e. the terminal atoms 4 and 6) via the ring's 2 sp³-sp³ bonds (traced with dashed lines). During sp³-to-sp² rehybridization, these sp³-sp³ bonds in R_{3-C} are broken. This destabilizes and unzips the two sp³-sp³ bond lines extending out laterally in either direction from R₃-c. The broken sp³-sp³ bonds are indicated by dashed lines in Frame III of FIG. 151. Their scission eliminates the sp^{x} rings along the original E₁-E₂^{c} interface from which the base was formed, leading to the base's complete unzipping along this interface, as illustrated in Frame IV of FIG. 151.

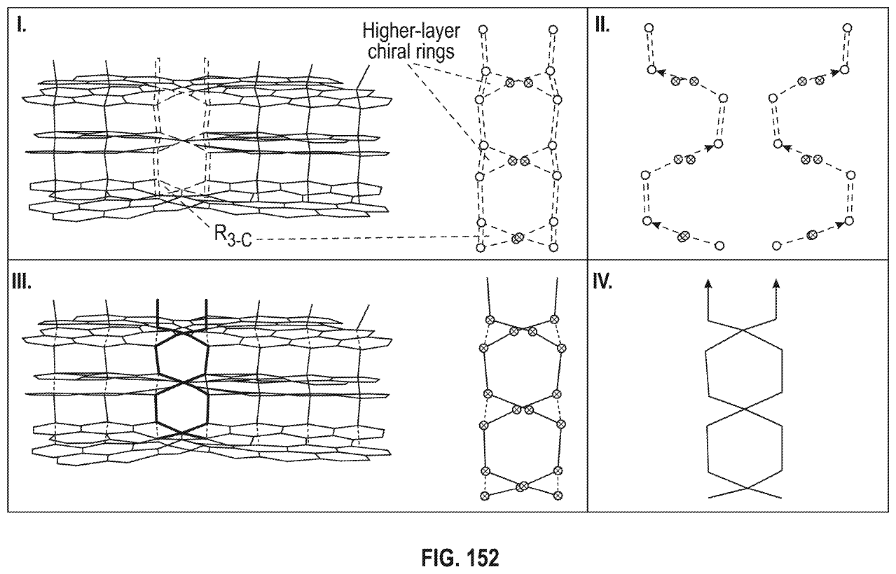

Next, we consider the effects of unzipping throughout the sp^{x} precursor G_{IV} built over this sp² ring-disconnected base. In Frame I of FIG. 152, we illustrate G_{IV} from the H2 perspective (cf. the H2 perspective of Frame IV of FIG. 149). We have previously established (FIG. 125) that chiral columns may be formed over chiral rings in the base. In Frame I of FIG. 152, we observe that G_{IV} contains a chiral column of 3 z-adjacent chiral rings, including the base-layer chiral ring R_{3-C} over which the column is constructed. Each of the chiral rings in the higher layers, like R_{3-C}, comprise 2 point-reflected chiral chains. The 3 z-adjacent chiral rings are connected via 2 z-oriented sp³-sp³ chains. In Frame I of FIG. 152, the chiral chains are dashed lines and the sp³-sp³ chains are dashed double lines. We also illustrate the chiral column in isolation in Frame I, representing the sp³ atoms with white circles and the sp² atoms with pattern-filled circles.

In Frame II of FIG. 152, we illustrate how the column of chiral rings shown in Frame I comprises 2 distinct sp^{x} helices spiraling around each other, together comprising an sp^{x} double helix. In the left-hand diagram of Frame II, we trace one of the sp^{x} helices. Dashed lines indicate a chiral chain and dashed double lines indicate the sp³-sp³ bonds within the sp^{x} helices. Sp² and sp³ atoms are represented by pattern-filled circles and white circles, respectively.

In Frame III of FIG. 152, we illustrate the systemwide unzipping associated with scission of the sp³-sp³ bonds in the 3 z-adjacent chiral rings. These broken bonds are indicated by dashed lines in the chiral column illustrated in Frame III, while the surviving bonds are bolded. Following the ABAB pattern of bond scission and retention, the sp³-sp³ bonds that connect the z-adjacent chiral rings to one another are retained, being transformed into sp²-sp² bonds as the sp³ atoms undergo sp³-to-sp² rehybridization (the resulting sp² atoms are represented as pattern-filled circles in the diagrammed column). As a result, the sp^{x} double helix is transformed into an sp² double helix (as illustrated in Frame IV of FIG. 152). As previously discussed, the scission of the sp³-sp³ bonds within each chiral ring propagates laterally along the sp³-sp³ bond lines to either side. These unzipped sp³-sp³ bond lines are represented by dashed lines in Frame III of FIG. 152. Relaxation of the system in Frame III creates the double helicoid illustrated in FIG. 150.

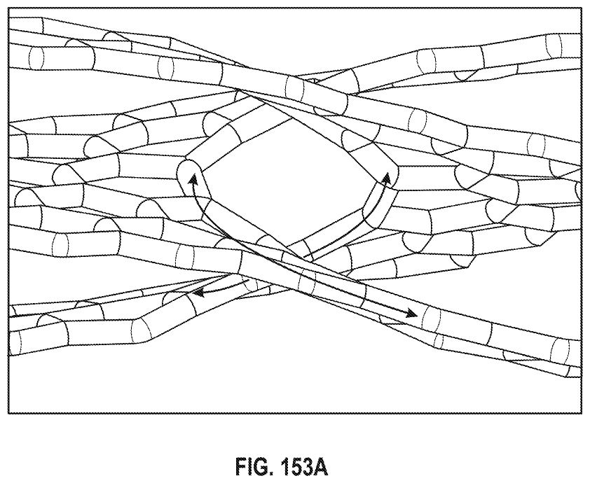

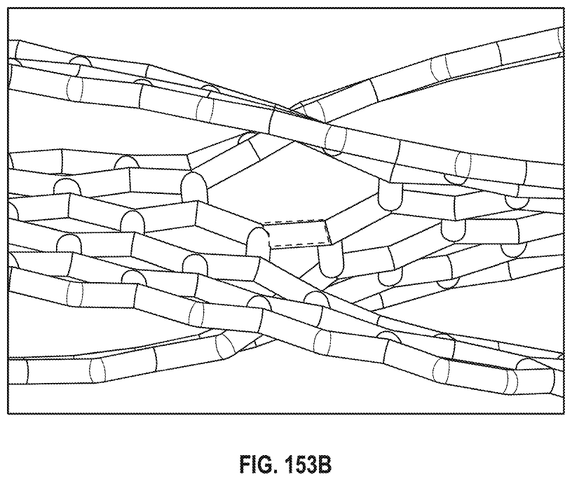

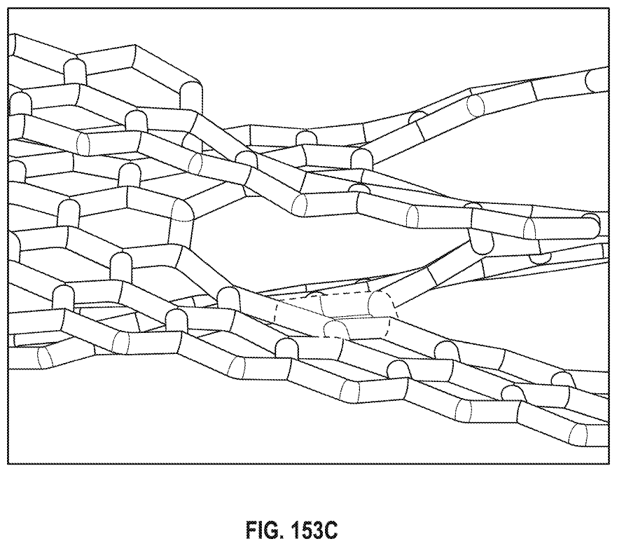

We illustrate the fundamental link between the interfacial zone transitions and the ultimate connectedness of a matured system in FIG. 153A-153C. In FIG. 153A, a disconnected double-helicoid is shown. The two arrows trace the helical edges, and we can recognize in this geometry the crisscrossing of the primordial domains' edges at a crossover point. Without a level zone between the offset zones, only sp³ grafting occurs, and the resulting sp³-sp³ bonds are unzipped during sp³-to-sp² rehybridization. Hence, maturation results in a disconnected double helicoid in FIG. 153A.

In FIG. 153B, a covalently connected (but ring-disconnected) double-helicoid is shown. This variant might be expected if the crossover point allowed a single sp²-sp² bond to form. If this strained sp²-sp² bond (traced with dashed lines in FIG. 153B) is stable to be retained during maturation, it creates a lone covalent connection between the two helicoids.

In FIG. 153C, a ring-connected helicoidal loop is shown. This variant might be expected if the hypothetical primordial interface included a level zone where a sp²-sp² bond line comprising 2 adjacent bonds were formed. The two adjacent sp²-sp² bonds form an sp² ring-connection (traced with dashed lines in FIG. 153C) between the primordial domains, resulting in an sp² ring-connected base. Retention of sp² rings during maturation results in an sp² ring-connection between the two primordial regions in the base. This sp² ring-connection is traced with dashed lines in FIG. 153C. In addition to ring-connecting the two helicoids, sp² ring-connections spread the screw dislocations apart, forming a loop that gets progressively looser as the sp²-sp² bond line between the offset zones is lengthened. The result of this sp² ring-connection between the primordial domains in the base of the sp^{x} network is a helicoidal singleton.

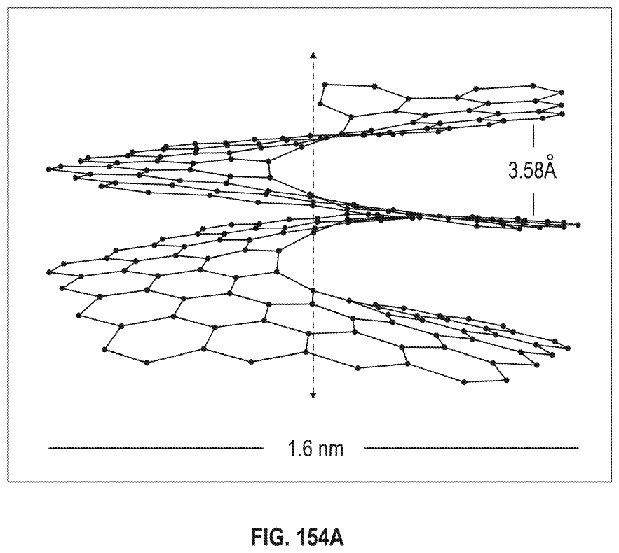

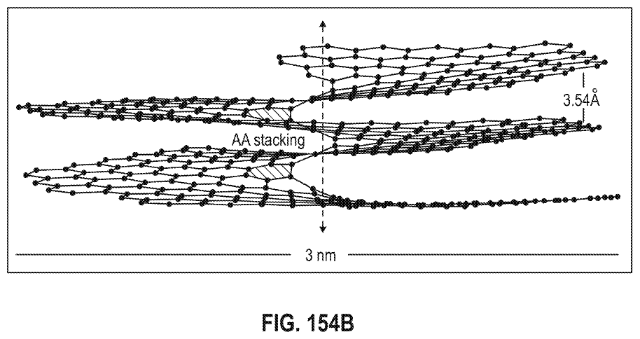

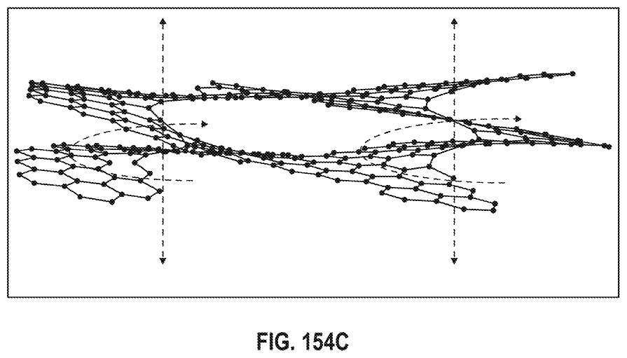

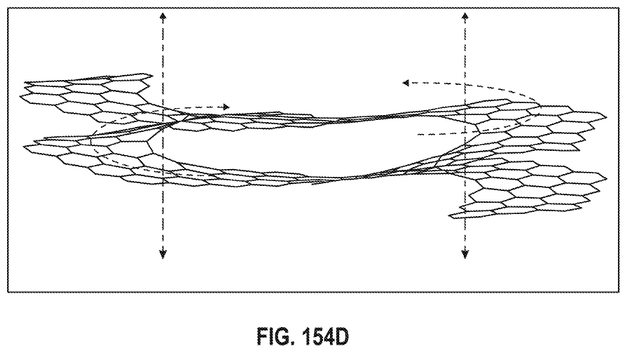

Lattice distortion in a helicoidal network is dependent upon distance from an sp² helix. This is illustrated by comparing the structures in FIG. 154A and FIG. 154B. Moving radially outward from the sp² helix at the center of the helicoid, the lattice becomes more planar. In helicoidal networks, the closer the sp² helices are to one another, the more overall lattice distortion the network will exhibit. In screw dislocation loops wherein two nearby sp² helices share a common chirality (as illustrated in FIG. 154C), increased lattice distortion may be expected compared to screw dislocation loops wherein two nearby sp² helices have opposite chirality (as illustrated in FIG. 154D).

Having established the phenomena associated with maturation using simple, small-scale conceptual models, we next extrapolate what happens during maturation of an arbitrarily large sp^{x} precursor, which may be formed from numerous tectonic interfaces and grafting of numerous primordial domains. Grafting across these stochastic interfaces and subsequent higher-layer growth leads to the formation of complex, arbitrarily large sp^{x} networks. Maturation of these sp^{x} precursors forms helicoidal networks of comparable size, comprising numerous screw dislocations. The geometry of these mature networks can be intuited as networks of seamlessly conjoined helicoids-similar to a class of parametric surfaces that have been described as “rheotomic surfaces” in the field of architectural design.

A natural question to ask is whether or not a mature, screw-dislocation network comprises a singleton or an assembly—i.e. whether its membership of graphenic structures is singular or plural. This determination may be straightforward if the mature system is derived in silico from a small-scale, hypothetical precursor with a precisely defined molecular structure. However, to make this determination for a larger-scale, macromolecular precursor system would require mapping its exact molecular structure, which we cannot practically accomplish. What we can establish generally—i.e. for any real sp^{x} precursor, without having mapped its exact molecular structure—is that its maturation will result in the formation of a helicoidal network comprising either a helicoidal singleton or a helicoidal assembly. We can also establish that each outcome is consistent with our empirical observations in Study E (i.e. observations of generalized, system-level rigidification and strengthening after maturation).

The first possibility is an outcome herein described as a “singleton-to-singleton” maturation. In this type of maturation, a sp^{x} network, which comprises a singleton, is matured into a helicoidal singleton. This type of maturation would be consistent with the empirical observations in Study E (i.e. observations of increased system-level rigidity and strength after rehybridization). A singleton-to-singleton transformation is produced from sp^{x} precursors constructed upon an sp² ring-connected base. To illustrate how a singleton-to-singleton maturation might occur in a reasonably large, complex system, we describe a first scenario in which this outcome is favored. We shall refer to this scenario as “Scenario A.”

In Scenario A, we firstly postulate that, during pyrolytic nucleation and growth of an sp^{x} precursor, a multitude of tectonic encounters occur between ring-disordered primordial domains, resulting in a multitude of tectonic interfaces. Due to the out-of-phase edge deflections of the ring-disordered primordial domains, the interfaces are incoherent and stochastic in nature. Wherever level zones occur between two primordial domains, sp² grafting creates sp² ring-connections between the participating domains, and wherever offset zones or crossover points occur between two primordial domains, sp³ grafting creates sp^{x} ring-connections between the participating domains.

In Scenario A, we secondly postulate that all tectonic interfaces include at least one level zone. From this it follows that, after grafting, all of the primordial domains under consideration will be sp² ring-connected to one another, such that there will exist a path of adjacent sp² rings connecting every primordial domain to every other primordial domain. Hence, the base itself will be sp² ring-connected. It also follows that any tectonic interfaces that include an offset zone in addition to the level zone(s) will comprise at least one interfacial zone transition where a chiral ring will be formed. Lastly, it follows that any higher layers grown over the base will also themselves be sp² ring-connected (by virtue of sp² grafting across higher-layer interfaces).

In Scenario A, we thirdly postulate that continued vertical and lateral growth over the base layer forms an sp^{x} network comprising the base layer and some number of higher layers that are ring-connected to the base via diamondlike seams (formed over sp³-grafted offset zones) and via chiral columns (formed over tectonic zone transitions between sp³-grafted offset zones and sp²-grafted level zones). As we have already established, these chiral columns formed over level-to-offset zone transitions will comprise a single sp^{x} helix and will each be positioned at the terminus of a seam.

In instances consistent with Scenario A, we have already observed (FIGS. 117-124 and FIG. 145) that, so long as the underlying base formed by grafting is sp² ring-connected, an sp^{x} network constructed over it will not disintegrate into multiple distinct graphenic structures during maturation but will instead remain ring-connected. Since sp²-sp² bonds (and therefore sp² rings) are retained during sp³-to-sp² rehybridization, the sp² ring-connected base will remain sp² ring-connected via base-layer sp² ring pathways. Furthermore, any sp² ring-connected higher layers that are sp^{x} ring-connected to the base via diamondlike seams and chiral columns will remain ring-connected to the base as the sp^{x} helices within the chiral columns are transformed into sp² helices. Hence, higher layers will remain ring-connected with respect to the base layer, and the base layer will remain itself ring-connected, creating a helicoidal singleton.

The other possible type of maturation for a sp^{x} precursor is a “singleton-to-assembly” maturation. In this type of maturation, the sp^{x} precursor, which comprises a singleton, is matured into an assembly of multiple graphenic structures. A singleton-to-assembly maturation is associated with a ring-connected, sp² ring-disconnected base. To illustrate how a singleton-to-assembly maturation might occur in a reasonably large system, we describe a second scenario in which this outcome could theoretically occur. We shall refer to this scenario as “Scenario B.”

In Scenario B, we firstly postulate that, during pyrolytic nucleation and growth of an sp^{x} precursor, a multitude of tectonic encounters occur between ring-disordered primordial domains, resulting in a multitude of tectonic interfaces. Due to the out-of-phase edge deflections of the ring-disordered primordial domains, the interfaces are incoherent and stochastic in nature. Wherever level zones occur between two primordial domains, sp² grafting creates sp² ring-connections between the participating domains, and wherever offset zones or crossover points occur between two primordial domains, sp³ grafting creates sp^{x} ring-connections between the participating domains.

In Scenario B, we secondly postulate that none of the tectonic interfaces pertaining to some subset of primordial domains include a level zone. Instead, their tectonic interfaces include only offset zones and crossover points formed via the stochastic crisscrossing of the participating edges. During grafting, these primordial domains are only able to undergo sp³ grafting due to the total absence of level zones in their tectonic interfaces. It follows that only sp^{x} rings are formed at their interfaces and that this subset of domains is therefore sp² ring-disconnected with respect to the surrounding base, of which they are part. It also follows that the base itself is sp² ring-disconnected.

In Scenario B, we thirdly postulate that continued vertical and lateral growth over the base layer forms an sp^{x} network comprising the base layer and some number of higher layers that are ring-connected to the base via diamondlike seams (formed over sp³-grafted offset zones) and via chiral columns (formed over crossover points). As we have already established, these chiral columns formed over crossover points will each contain an sp^{x} double helix and will each be positioned at the terminus of a seam.

In a scenario like Scenario B, we have already observed (FIGS. 149-150) that if the underlying base form by grafting is sp² ring-disconnected, then it is possible for the base—and an sp^{x} network constructed over it—to disintegrate into a helicoidal assembly during rehybridization. Specifically, it follows from our second postulate in Scenario B—i.e. that some subset of the primordial regions are exclusively grafted to the surrounding base layer via sp³-sp³ bonds—that sp³-to-sp² rehybridization may lead to the complete unzipping of the sp³-sp³ bonds and severing of these primordial regions' sp^{x} ring connections to the surrounding base. Additionally, as illustrated in FIGS. 149-150, this unzipping, extended into higher layers, may eliminate any higher-layer pathways that might preserve the ring-connectedness of the severed primordial regions, resulting in the singleton's disintegration into a helicoidal assembly comprising multiple, distinct graphenic structures.

Therefore, in Scenario B, where an sp^{x} network is constructed over an sp² ring-disconnected base, it is theoretically possible for a singleton-to-assembly maturation to occur. However, for this outcome to be consistent with the empirical observations in Study E (i.e. observations of increased system-level rigidity and strength after rehybridization), the resulting assembly must be able to resist the shear failure observed in a typical vdW assembly. The creation of an assembly of disconnected members seems inconsistent with these observations. However, we can in fact conclude that even in the instance of a singleton-to-assembly maturation, resulting in disintegration, the resulting assembly will be interlocked so that it cannot shear apart.

This conclusion follows from our third postulate in Scenario B—i.e. that the sp^{x} network comprises at least one higher layer. So long as an sp^{x} network comprises at least one higher layer, even if a singleton-to-assembly maturation occurs, such that disintegration results in double helicoids of distinct graphenic members, the double helicoids will result in a where double helicoids are formed, even if disintegration occurs, the braid-like geometry of the double helicoids will create an open, interlocking chain preventing the individual, disconnected helicoids from being separated.

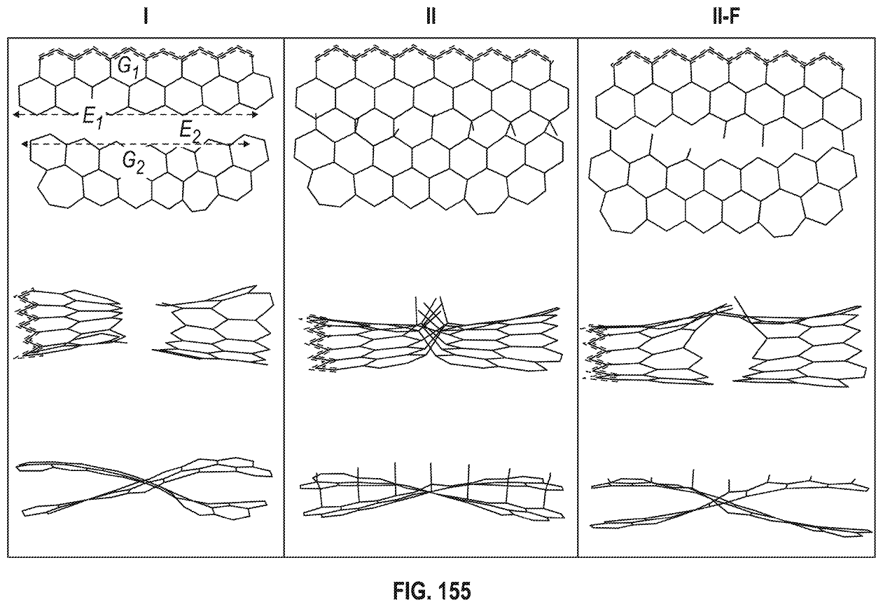

The dependency on this interlocking mechanism on the presence of higher layers is demonstrated in FIG. 155. In FIG. 155, for helpful reference, we show again Stages I and II of FIG. 149, wherein the hypothetical E₁-E₂^{c} interface comprised a crossover point in the center, such that only sp³ grafting occurred and an sp² ring-disconnected base was formed. In Stages III and IV of FIG. 149, we modeled the growth of a multilayer sp^{x} network G_{IV} over this base, and in FIG. 150, we modeled the singleton-to-assembly maturation associated with G_{IV}. In this maturation, the precursor G_{IV} disintegrated into the two graphenic structures Gᵢ and Gᵢᵢ, which together comprised a double helicoid possessing an interlocking, braid-like geometry.

In Frame 11-F of FIG. 155, we illustrate what the final result would have been if the sp² ring-disconnected base in Frame II was matured prior to any further growth. As shown in Frame II-F, the unzipping of sp³-sp³ bonds along the original E₁-E₂^{c} tectonic interface causes the base to disintegrate, but without any higher layers in the sp^{x} precursor, the two resulting graphenic structures do not interlock with each other. Instead, the assembly comprises a truncated double-helicoid in which neither of the constituent helicoids complete a turn around the axis.

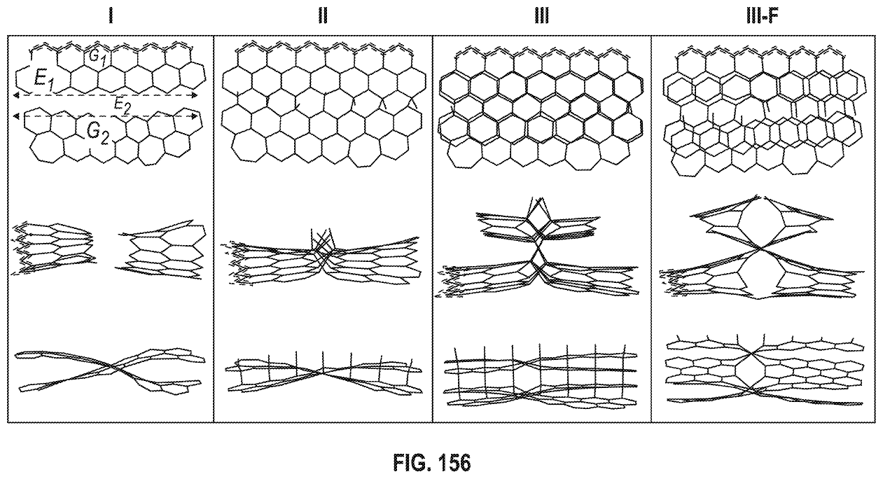

For interlocking to occur, at least one higher layer is needed in the sp^{x} precursor, such that the double-helicoid formed during maturation is not so truncated. This is illustrated in FIG. 156, wherein Frames I, II and III from FIG. 149 are shown again for helpful reference. In Frame III, a sp^{x} network comprising Y-dislocations and a nucleated second layer has been formed over the base. In Frame III-Fe of FIG. 156, we illustrate what the final result might have been if the sp^{x} network in Frame III was matured. In this case, the double-helicoid is elongated enough for the two graphenic structures to form an interlocking braid. This demonstrates the need for higher layers above the tectonic interfaces of the base. A monolayer base, when matured, cannot form these interlocking braids.

While the graphenic structures in an individual double helicoid could theoretically shear apart via differential rotation around their common axis, this rotational mobility is impossible in a network of multiple double-helicoids. Returning to Scenario B, it follows from our postulates that the helicoidal assembly formed via a singleton-to-assembly maturation would comprise a network of many double-helicoids. Even those primordial domains postulated in Scenario B to be sp² ring-disconnected with respect to the surrounding base would have crossover points distributed along their incoherent tectonic interfaces—a feature that we have established would create double helicoids. These arrays of double helicoids lack the rotational mobility to be sheared apart, making it necessary to break a graphenic structure in order to break the assembly.

Scenarios A and B are not intended to be limiting, but rather to demonstrate the only two theoretically possible outcomes of sp³-to-sp² rehybridization of an sp^{x} precursor—i.e. a singleton-to-singleton maturation or a singleton-to-assembly maturation—and furthermore to demonstrate how, regardless of which outcome might pertain to a given precursor, the mature system evolved might be expected to exhibit increased rigidity and strength. Either outcome is accompanied by the formation of a helicoidal network that cannot fail via shear, but only via breakage of some graphenic region. This is consistent with our observations of the superior mechanical properties of the mature perimorphic frameworks in Samples E1A and E2A compared to the frameworks in Samples E1 and E2.

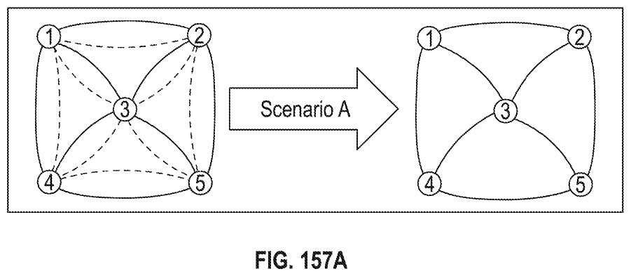

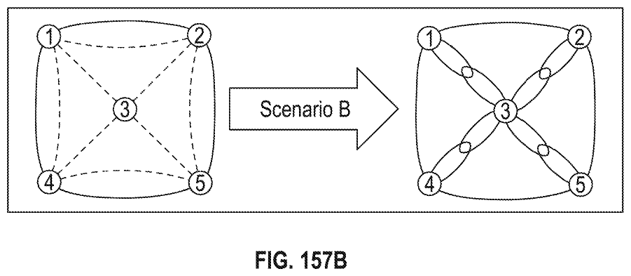

To conclude our discussion of singleton-to-singleton and singleton-to-assembly maturations, in FIG. 157A-157B we represent these potential outcomes with graph theoretic diagrams (multigraphs) that permit us to analyze ring-connectedness of the base before and after maturation. Each of the 5 nodes in one of these multigraphs represents a primordial domain, and the multigraph as a whole represents the base constructed from grafting between these 5 primordial domains (although the base in most real systems may comprise many more primordial domains). A link connecting two nodes indicates the ring-connectedness of the two associated primordial domains with respect to each other. The patterning of the link indicates the type of ring-connectedness. A solid link represents a path constructed exclusively from sp² rings. Two nodes that are reachable from each other by a path of one or more solid links are therefore sp² ring-connected with respect to each other. A dashed link represents a path that includes an sp^{x} ring.

In FIG. 157A, we represent a singleton-to-singleton maturation. In the left-hand multigraph, the 5 nodes represent a hypothetical base formed via the grafting and coalescence of 5 primordial domains. Every node in the multigraph is reachable from every other node via a path of one or more solid links or, alternatively, a path of one or more dashed links. The reachability of any node from any other node via a path of solid links indicates that each of the 5 primordial domains grafted to form the base are sp² ring-connected to one another. Therefore, the base itself is sp² ring-connected. The reachability of any node from any other node via a path of dashed links indicates that the 5 primordial domains are also ring-connected to one another via at least one path of adjacent rings that includes an sp^{x} ring.

In the right-hand multigraph of FIG. 157A, we represent the base after the singleton-to-singleton maturation of the sp^{x} network grown over the base. The elimination of sp^{x} rings during sp³-to-sp² rehybridization is indicated in this right-hand multigraph by the absence of dashed links between the nodes. This occurs because the sp^{x} rings in the system are either eliminated or transformed into sp² rings during rehybridization. Every node remains reachable from every other node via a path of one or more solid links, indicating the persistence of the base's sp² rings, and therefore the retention of its sp² ring-connectedness. Any higher layers grown over this base become sp² ring-connected to it via conversion of sp^{x} helices to sp² helices and the associated formation of helicoids. Therefore, by showing the retention of the base's sp² ring-connectedness, we show the sp² ring-connectedness of the mature network constructed on it. FIG. 157A therefore represents a singleton-to-singleton maturation.

In FIG. 157B, we represent a singleton-to-assembly maturation. In the left-hand multigraph, the 5 nodes represent a hypothetical base formed via the grafting and coalescence of 5 primordial domains. In this multigraph, every node is reachable from every other node via a path of links. This indicates that each of the 5 primordial domains are ring-connected to one another, and that the base itself is ring-connected. Additionally, four nodes (Nodes 1, 2, 4 and 5) are reachable from one another via a path of one or more solid links, indicating that these four primordial domains are sp² ring-connected with respect to one another. However, Node 3 is not reachable from the other nodes by a path of solid links. Node 3 therefore represents a primordial domain that is sp² ring-disconnected with respect to the other primordial domains. Accordingly, the base itself is sp² ring-disconnected.

In the right-hand multigraph of FIG. 157B, we represent the base after the singleton-to-assembly maturation of the sp^{x} network grown over the base. The elimination of sp^{x} rings during sp³-to-sp² rehybridization is indicated in this right-hand multigraph by the absence of dashed links between the nodes. This occurs because the sp^{x} rings in the system are either eliminated or transformed into sp² rings during rehybridization. Four nodes remain reachable from each other via a path of one or more solid links, indicating the persistence of sp² rings and therefore the retention of sp² ring-connectedness between the primordial domains that were sp² ring-connected prior to maturation. Node 3, however, is no longer linked to the surrounding nodes by either solid or dashed links, indicating that this primordial domain has been disconnected from the surrounding base, and that a disintegration into multiple distinct graphenic domains has occurred.

However, while the primordial domain associated with Node 3 is represented as disconnected in the right-hand multigraph of FIG. 157B, we know that, so long as a multilayer precursor was grown over the base, this primordial domain will be physically interlocked with the four other domains. This interlocking geometry is indicated by the ovaline links, each of which represent the existence of at least one path of sp² rings extending from the primordial domain associated with Node 3 into higher layers and interlocking in a braidlike chain with an analogous, higher-layer path extending from the other primordial domains. FIG. 157B therefore represents singleton-to-assembly maturation, wherein a disconnected region of the base may be physically interlocked with the surrounding regions of the base.

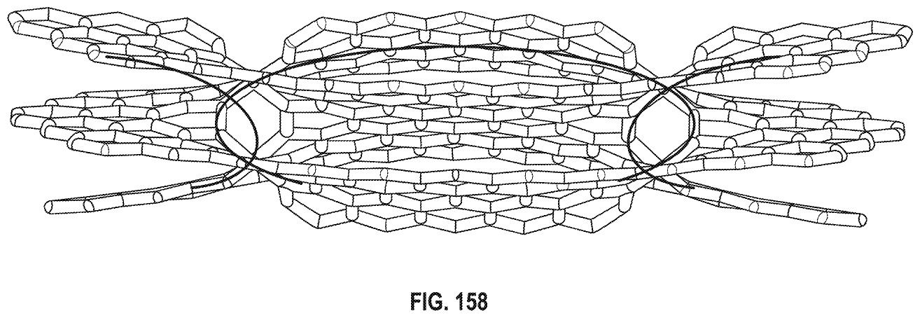

This concept is illustrated in FIG. 158, an helicoidal assembly of two graphenic structures comprising two double-helicoids. Two higher-layer paths of sp² rings extend up from the same base-layer region, connecting to form a closed loop. This closed loop formed by these paths is traced in FIG. 158. These higher-layer paths interlock with other higher-layer paths (also traced in FIG. 158) extending up from nearby regions. These other high-layer paths may also form closed loops.

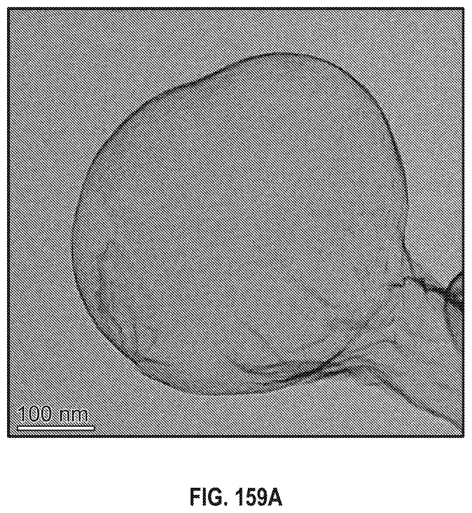

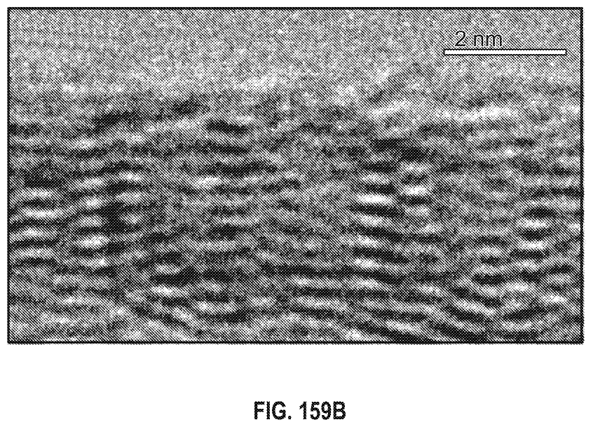

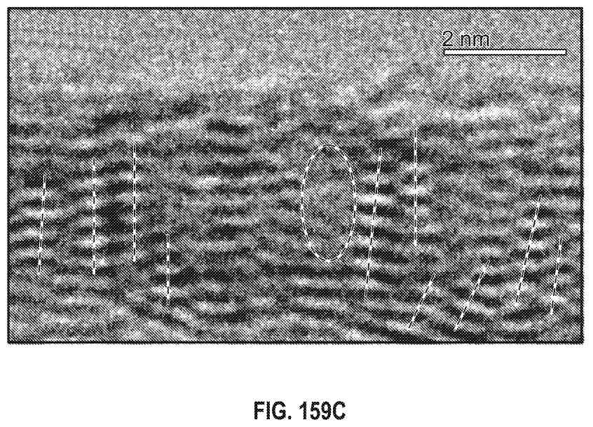

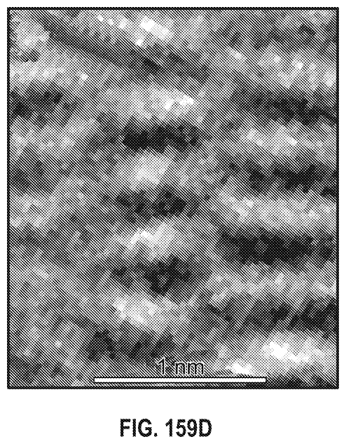

Irrespective of whether the helicoidal network formed by maturation comprises a helicoidal singleton or a helicoidal assembly, the network geometry is analytically similar. Helicoidal networks produce very characteristic fringe patterns in HRTEM. FIG. 159A-159D is a series of HRTEM micrographs of a helicoidal z-network synthesized by annealing a z-sp^{x} precursor (similar to Sample A1: synthesized at 750° C. using C₃H₆ over a similar MgO template) at 1200° C. for 4 hours.

FIG. 159A shows a macroporous perimorphic framework from this sample. FIG. 159B shows a cross-section of the perimorphic wall. The fringe lines exhibit a distinctive “sliced” pattern, as indicated by the dashed lines in FIG. 159C, with the slices cutting across the nematically aligned layers. This sliced appearance is due to a regular vertical offset in the positions of laterally adjacent fringe segments. The vertical offset corresponds to the z-displacement of a helicoidal graphenic lattice over each 1800 turn around the dislocation line. In other locations, the fringe lines are blurred, as indicated by the circled region; these regions likely correspond to curved regions between screw dislocations. One helicoid stretches across more than 10 layers of the helicoidal network. In FIG. 159D, a loop of conjoined helicoids from the cell wall is magnified. By analyzing the HRTEM image in FIG. 159D, we can see that the sp² helices at the centers of these two nearby helicoids were less than 1 nm apart. These images show that the screw dislocations at the center of the graphenic helicoids can extend across numerous layers, and that they can be arranged in xy-periodic, z-aligned arrays oriented transverse to the perimorphic wall. Because the screw dislocations are formed from the chiral columns at the end of diamondlike seams, their density reflects the density of the diamondlike seams and the spacing between chiral columns.

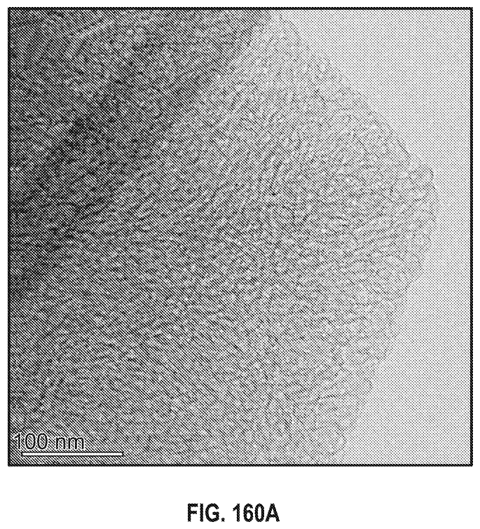

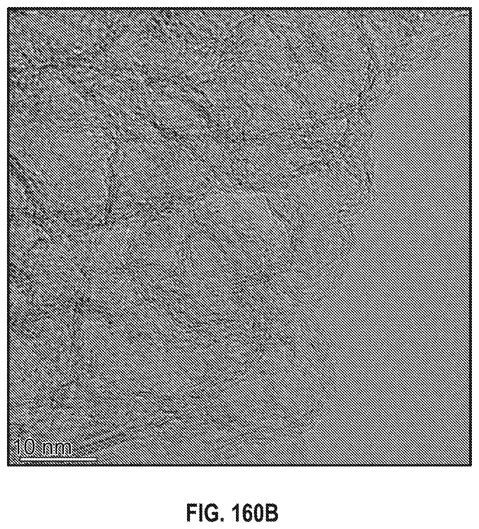

A preferred variant of a helicoidal network is one that averages between 2 and 5 layers. FIG. 160A shows a helicoidal x-network comprising a perimorphic framework with an equiaxed, cuboidal morphology (synthesized from 1050° C. annealing of x-sp^{x} frameworks formed via 580° C. pyrolysis of C₃H₆ over porous MgO template particles derived from precipitated magnesite template precursor particles). In FIG. 160B, the controlled mesoporous architecture of the perimorphic framework is shown, with a highly consistent perimorphic wall thickness. In FIG. 160B, the perimorphic wall is shown at higher magnification. It averages 2-3 layers and appears more kinked than thicker walls because of its increased flexibility. For some applications, a flexible anthracitic network may be preferred. This is an example of how synthetic anthracitic networks can be rationally engineered to have properties unavailable from natural anthracitic networks.

The various anthracitic networks described in the present disclosure share certain generic attributes as a function of their layered architecture and nematic alignment. First, they provide more interlayer coupling than non-layered architectures, and we expect system cohesion to benefit substantially from π-π interactions. Compared to schwarzite or other non-layered geometries, we intuit that a denser, layered architecture at the nanometer-scale is preferred due to its combination of covalent and non-covalent modes of cohesion. Density reduction may be obtained by coupling this denser, layered architecture with mesoscale, density-reducing pore phases, following hierarchical design principles. Mesoporous and macroporous perimorphic morphologies constructed from helicoidal networks represent a way to obtain controllable density without sacrificing subnanometer-scale interlayer spacing.

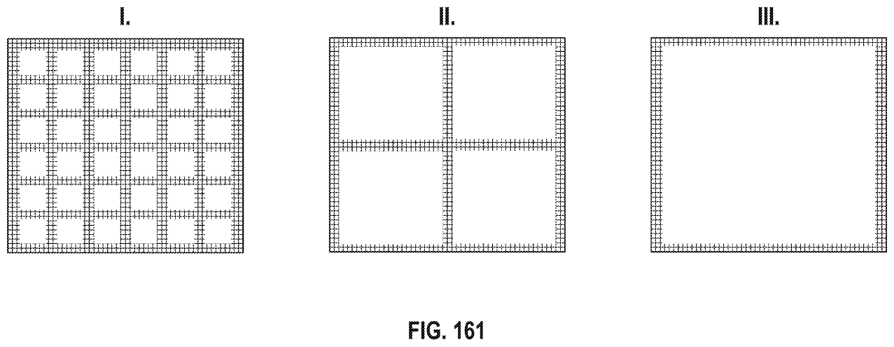

Analogous to the hierarchical approach to density reduction, a hierarchical approach to crosslinking density is also appealing. With respect to the perimorphic frameworks represented in FIG. 161, each system's crosslinking can be conceptualized as occurring at two distinct scales, both of which are engineerable. At the local scale, the crosslinking derives from dislocations. Local crosslinking is represented by the crosshatching in the diagram of FIG. 161. At this scale, crosslinking density is determined by dislocation density, which is in turn determined by the areal density of tectonic interfaces and linear density of interfacial zone transitions along the interfaces. However, the system also possesses mesoscale crosslinking deriving from the topology of the perimorphic wall and even more primordially from the templating surface, and its density may be modulated independently of the local crosslinking. Mesoscale crosslinking is diagrammed in FIG. 161, where mesoscale crosslinking density descends (i.e. I>II>III), while local crosslinking density is constant, as indicated in FIG. 161 by the crosshatching. The modulation of mesoscale crosslinking density (i.e. “compactness”) is described in the '760 and '918 Applications.

Other benefits may be derived specifically from the helicoidal network geometry. The superelasticity and spring-like nature of graphenic helicoids has been established, with in silico studies showing a single helicoid sustaining tensile deformation of 1500% without fracture. Failure of a helicoidal network would likely initially occur via covalent breakage of network locations, following by a plastic yielding and unravelling. The mesh-like architecture should offer good toughness properties.

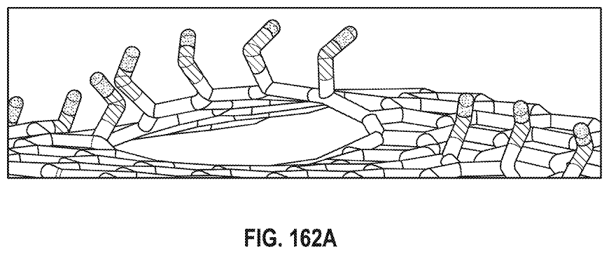

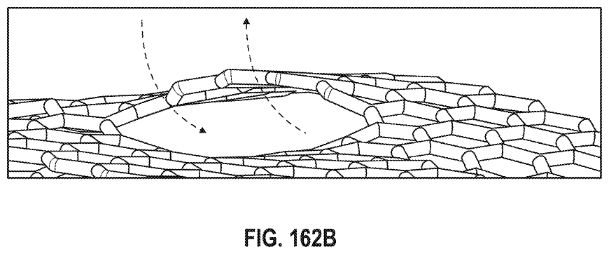

Helicoidal networks (and also sp^{x} networks) contain numerous edges on the surface that may be easily chemically functionalized—a fundamental requirement in many applications. Both helicoidal networks and sp^{x} networks are easily oxidized with mild oxidants (e.g. sodium hypochlorite, hydrogen peroxide) in line with the procedures described in the '580 Application. These surface edges represent the tops of the conjoined and interlocking helicoids. This is illustrated in FIG. 162A, which shows the hydroxylated edge formed by the vertical terminus of two conjoined helicoids. Additionally, sp^{x} networks can be expected to have numerous edge sites on the surface, left behind when their higher-layer growth is terminated. Edge sites on anthracitic surfaces have the added benefit of promoting phenolic hydroxyl groups with increased thermal stability. Upon oxidation of these edges (as well as reactive basal plane sites) a rich variety of secondary phases may be applied to the surface of the anthracitic networks, including inorganic, preceramic oligomers and polymers.

Another appealing surface feature of helicoidal networks is the ubiquitous presence of mouths representing entrances into the network's interlayer labyrinth. One such mouth is shown in FIG. 162B. These mouths offer ubiquitous access points for infiltration or exfiltration of fluids, as indicated in FIG. 162B. This make helicoidal networks an appealing architecture for electrodes where rapid mass transfer into and out of an interlayer pore space is desired for charging and discharging. Additionally, the expanded interlayer d-spacing observed in helicoidal networks should increase their storage capacity compared to graphitic electrodes. In particular, helicoidal networks should be highly appealing for high-rate, high-capacity battery electrodes.

In systems where the primordial level zones are longer (perhaps due to less lattice curvature), longer rows of xy-adjacent sp²-sp² bonds are formed, increasing the number of xy-adjacent sp² rings between sp³-grafted offset zones. This will increase the average distance between the helicoids, creating a less densely crosslinked helicoidal network. In systems where the primordial level zones are shorter (perhaps due to more lattice curvature and more frequent crisscrossing), shorter rows of xy-adjacent sp²-sp² bonds are formed, decreasing the number of xy-adjacent sp² rings between sp³-grafted offset zones. This will reduce the average distance between helicoids, creating a more densely crosslinked helicoidal network.

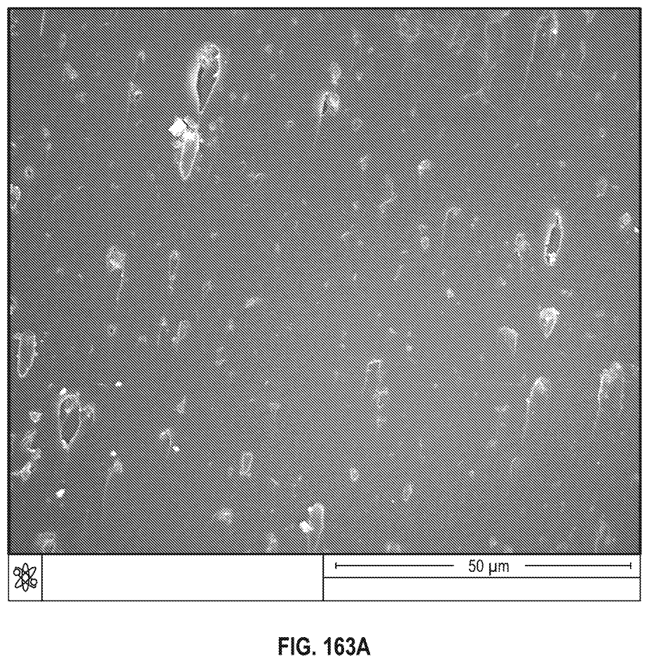

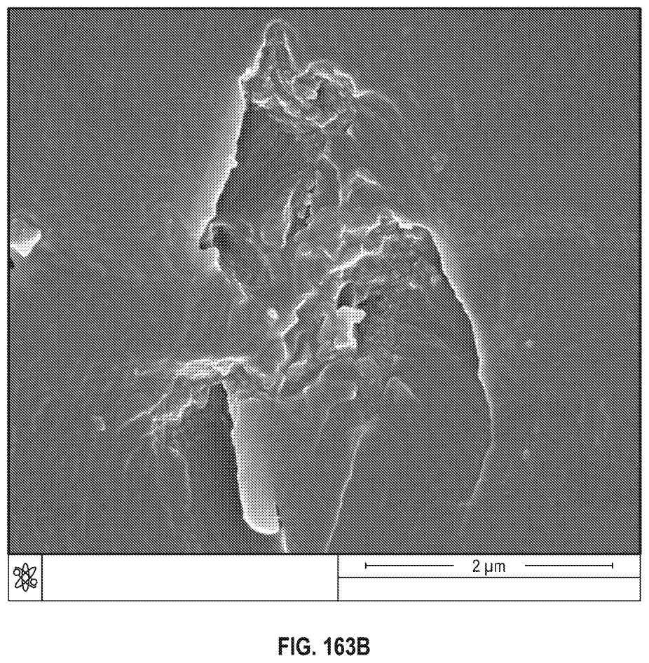

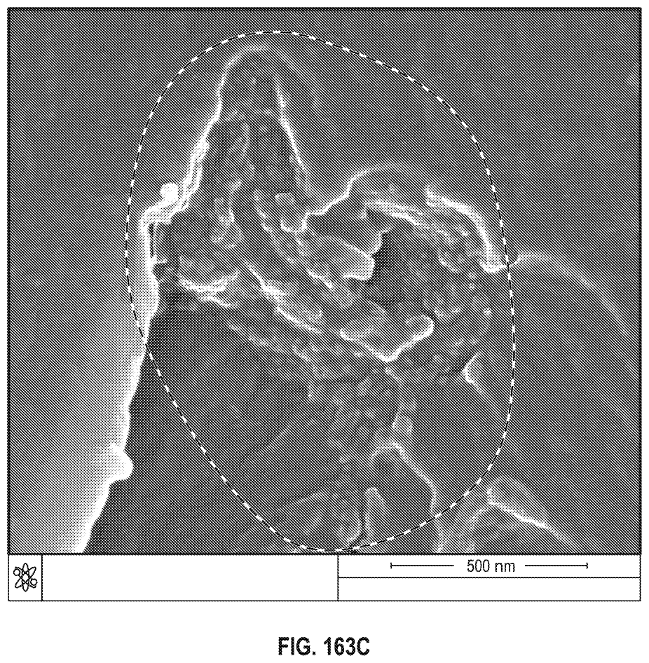

Helicoidal networks comprise the preferred variant of synthetic anthracitic frameworks. They generally exhibit superior mechanical properties compared to sp^{x} networks. The difference is readily observed in applications. For example, FIG. 163A is the fracture surface of an epoxy specimen containing a 0.5% weight loading of an sp^{x} network. Similar to Samples E1 and E3, each particle comprises a perimorphic framework with a sheet-of-cells morphology and an sp^{x} network. The pyrolytic formation of these sp^{x} networks was directed by the same hydromagnesite-derived MgO templates utilized in Samples E1 and E3. Pyrolysis of C₃H₆ was utilized to create a few-layer sp^{x}network on the template particles. After extraction of the template, the singletons were lightly oxidized and dispersed into a DGEBA-type epoxy resin, which was then cured using an aliphatic amine.

FIG. 163B and FIG. 163C are higher-resolution images of the same epoxy fracture surface. In FIG. 163C, a wavy cluster of sheet-like frameworks are embedded in the surrounding epoxy matrix. The cluster is indicated by a circle. Close examination of the texture of the clusters reveals the nanocellular subunits within the sheet-of-nanocells particle morphology. The waviness indicates the sheets' flexibility. No significant epoxy debris was observed around the frameworks embedded throughout the fracture plane, and it appears that the fracture was at the interface between the epoxy and the frameworks.

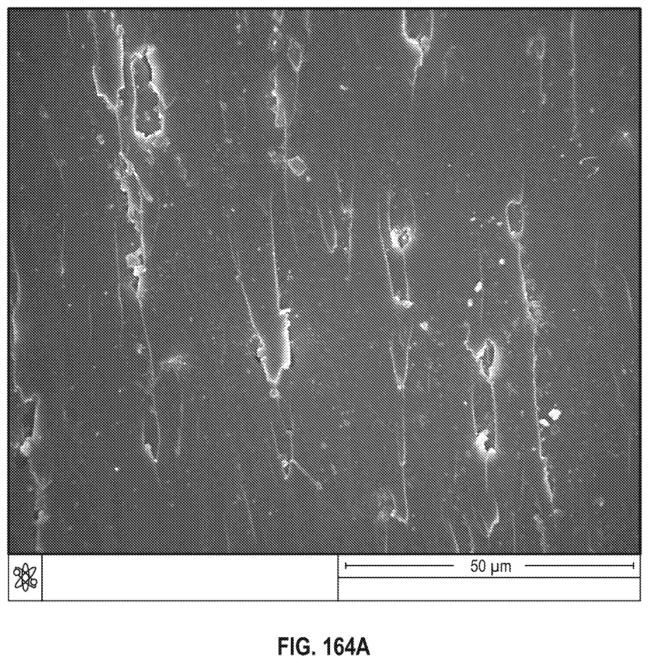

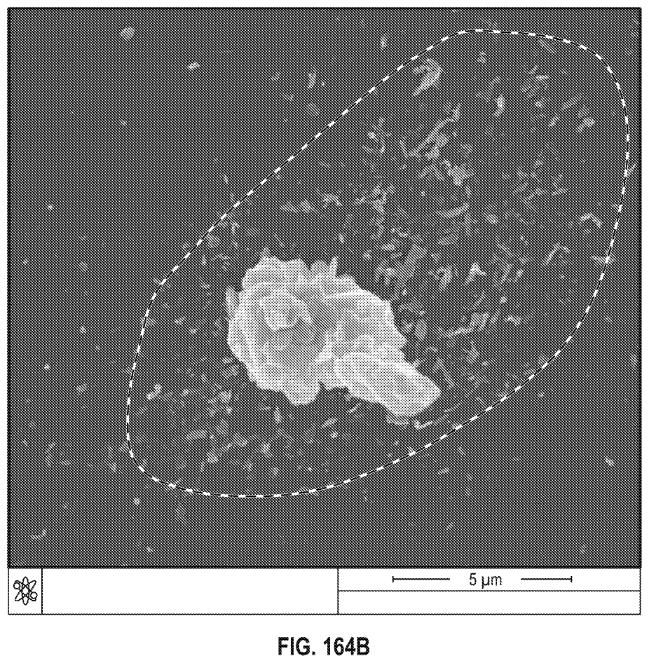

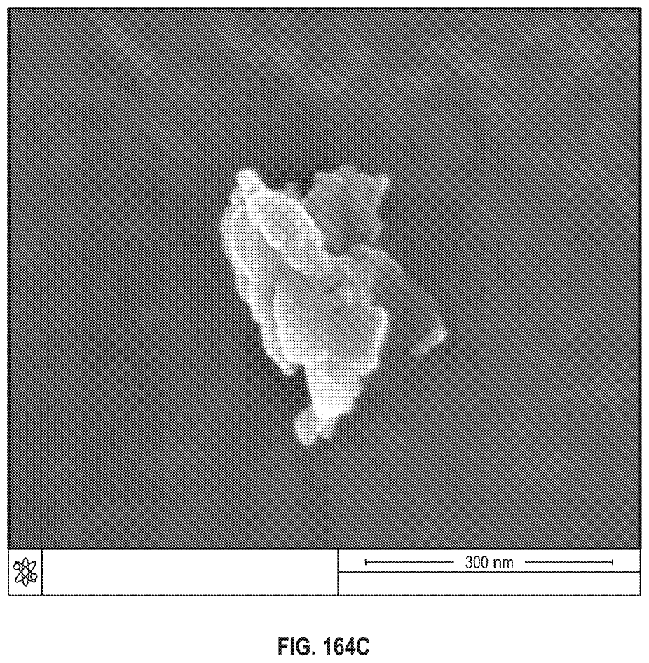

By comparison, FIG. 164A is the fracture surface of an epoxy specimen containing a similar loading of perimorphic frameworks of the same derivation and morphology, but in this case the frameworks represent helicoidal networks, matured on the template. Unlike the clean fracture surface in FIG. 163A, the fracture surface in FIG. 164A appears to be covered with debris (the debris appears as bright spots scattered across the fracture surface). This debris was not removable from the fracture surface by any amount of cleaning with compressed air. Upon examination at higher magnification, we can deduce that the debris is produced by explosive failure of the cured epoxy nanocomposite in the vicinity of the perimorphic frameworks. In FIG. 164B, we can see the result of one such explosive failure. The perimorphic framework cannot be distinguished at the point of failure, which comprises a brightly charged composite structure, and it does not appear that the failure occurred at the interface. This point of failure and the surrounding debris field are circled. At yet higher magnification, as shown in FIG. 164C, we can observe that the fragments are fragments of epoxy, and that they are not just resting on the fracture surface but are physically embedded in the surface, explaining why they could not be removed. It was also confirmed that a corresponding debris field was present on the opposing fracture surface in the same location. This embedding of the epoxy fragments in the fracture surfaces suggests the force of these explosive failures.

This demonstrates the utility of synthetic anthracitic networks in composite applications. In [Multifunctional Nanocomposites Reinforced w/Impregnated Cellular Carbons] and [Multifunctional Nanocomposites Reinforced w/Unimpregnated Cellular Carbons], the use of “cellular carbons” comprising perimorphic frameworks is shown to be advantageous compared to non-perimorphic morphologies. These applications are herein incorporated by reference. We observe in Study E that perimorphic frameworks comprising anthracitic networks may be especially advantageous in these nanocomposites.

### XIII**. Study F—Analysis

It was demonstrated in Experiments A through E that it is possible, via directed pyrolysis reactions, to synthesize arbitrarily large sp^{x} and helicoidal networks. However, practical considerations might still restrict the size of the objects that could be made. To fabricate macroscopic anthracitic networks, it would be appealing to be able to fuse smaller, individual anthracitic networks. We now demonstrate how this may be done by creating a macroscopic preform comprising an assembly of distinct sp^{x} networks (i.e. an “sp^{x} preform”), then maturing the sp^{x} preform to ring-connect the distinct sp^{x} networks during maturation. In particular, we explore how static, non-native bilayers formed between the surfaces of adjacent sp^{x} networks may become ring-connected during maturation, extending and enlarging the anthracitic network.

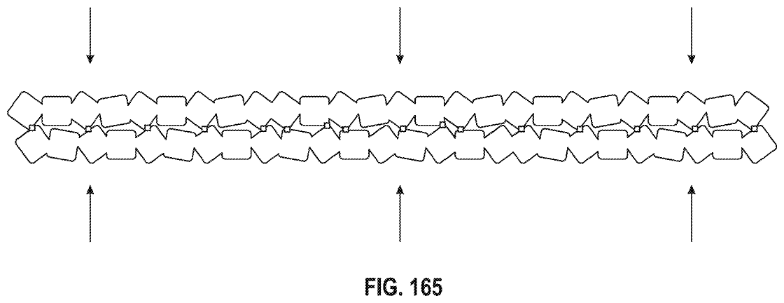

We begin with two hypothetical sp^{x} networks comprising graphenic singletons, designated G_{A} and G_{B}. Each of these sp^{x} networks comprises a microscopic sp^{x} network, such as those demonstrated in Experiments A through E. We press G_{A} and G_{B} into contact with one another, such that some regions of their outermost surface layers are in static vdW contact. FIG. 165 is a cross-sectional representation of what this might look like for two perimorphic frameworks, like those described in Study E, possessing a sheet-of-cells morphology. Pressed together, these particles come into vdW contact at a number of sites comprising non-native bilayers (these regions are darkened in FIG. 165). The more flexible the perimorphic walls are, and the more packable the frameworks' overall microscopic geometry, the more non-native bilayers may be created, and the more crosslinking may occur.

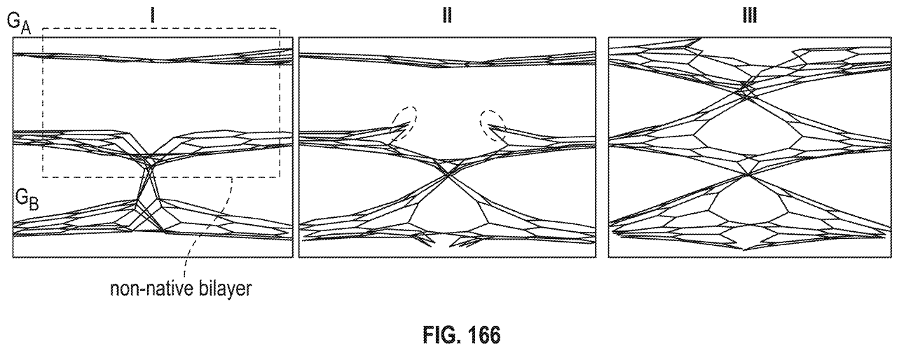

Next, we postulate an individual non-native bilayer between two sp^{x} networks in static vdW contact, G_{A} and G_{B}. This is represented in Frame I of FIG. 166. The outermost layer of the sp^{x} precursor G_{A} is represented (above in FIG. 166). This layer is in vdW contact with the outermost layer of the sp^{x} precursor G_{B} (below in FIG. 166). The non-native bilayer shown in Frame I includes two lines of sp³ atoms in G_{B}. These sp³ states, which represent the z-directional termini of diamondlike seams, are potential reaction sites during maturation.

While in static contact, the sp^{x} networks G_{A} and G_{B} are heated and matured, during which the two lines of tertiary sp³ atoms in G_{B} are dehydrogenated and rehybridized, becoming sp² radicals as the underlying diamondlike seams are unzipped. The geometry of the underlying helicoids pushes G_{B}'S sp² radicals toward G_{A}, as we attempt to illustrate in Frame II of FIG. 166, where the radicals are circled. A radical cascade reaction bonds G_{B}'S lines of sp² radicals with z-adjacent atoms in G_{A}, forming sp² rings. This reaction extends the helicoids across the non-native bilayer, as shown in Frame III of FIG. 166, and pushes radical-terminated edge dislocations to surfaces.

In this way, an assembly-to-singleton or an assembly-to-assembly maturation occurs, depending on whether the sp^{x} precursors disintegrate during maturation. However, in either scenario, a larger helicoidal network is formed that extends across the bilayer contacts of the sp^{x} precursors. The non-native bilayers are cinched together by the helicoidal geometry. If this larger helicoidal network comprises a helicoidal assembly, its graphenic member structures are interlocked with one another in braidlike double helicoids.

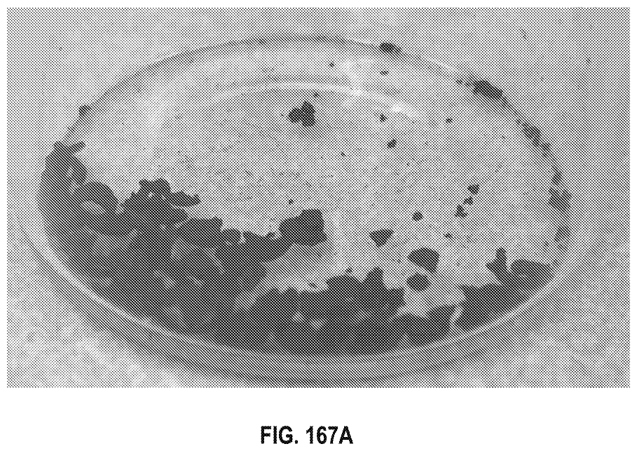

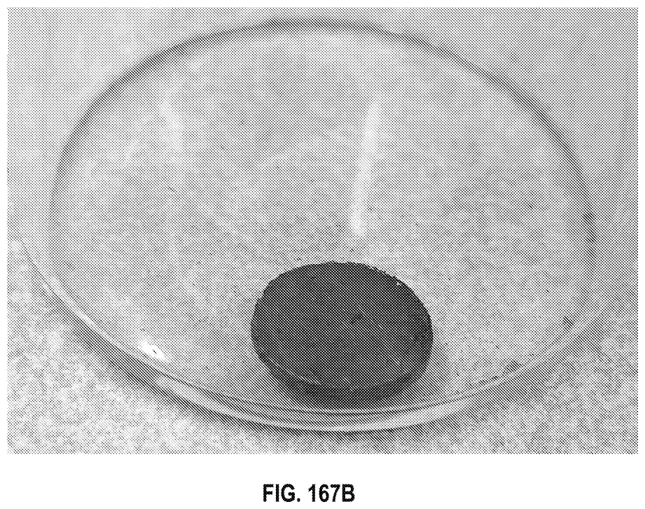

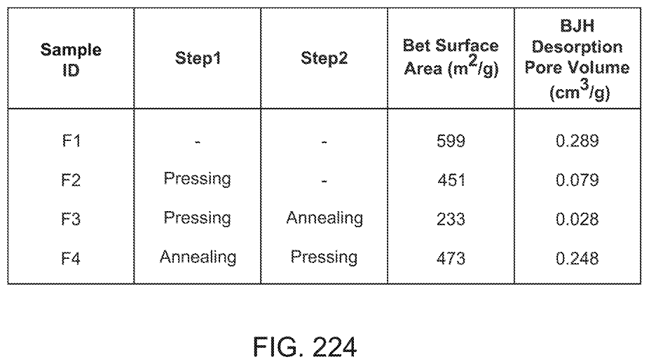

Sample F1 comprises perimorphic x-sp^{x} networks with a sheet-of-cells morphology similar to the samples in Study E. As observed in Study E, these frameworks' combination of flexibility and flatness causes them to dry into hard, macroscopic granules after extraction of the template. These granules are shown in FIG. 167A. The BJH specific porosity of the Sample F1 granules (as measured during desorption) and BET surface area are shown in FIG. 224.

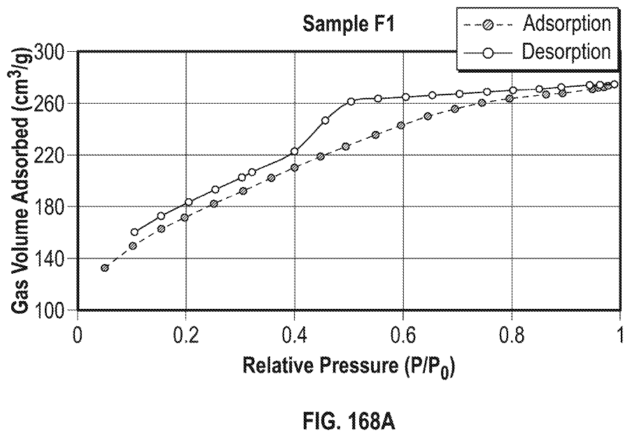

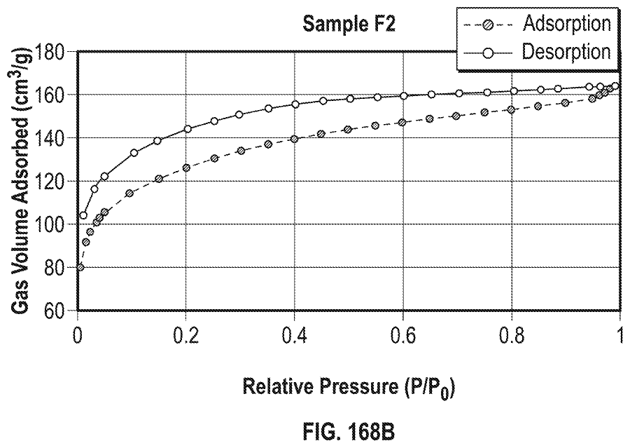

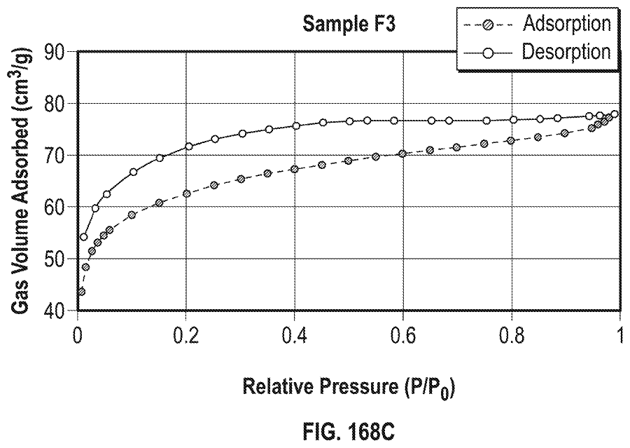

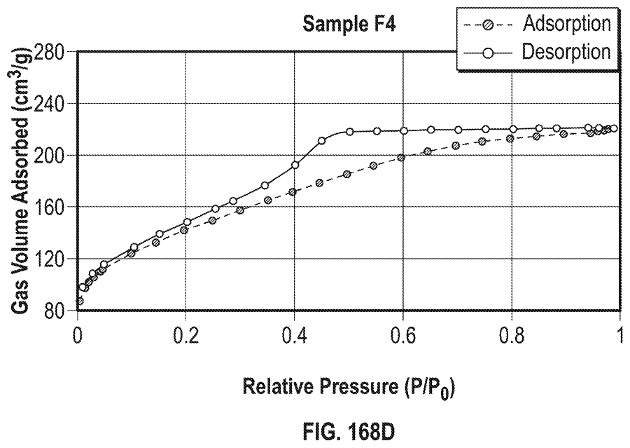

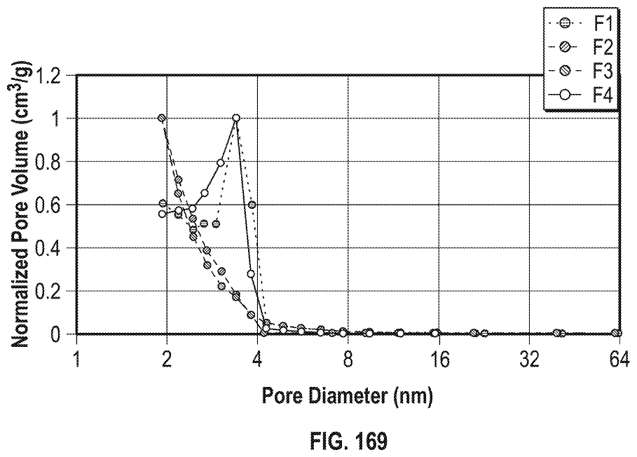

The BJH of Sample F1 was 0.289 cm³g⁻¹, and the BET specific surface area measured, also shown in FIG. 224, was 599 m²g⁻¹. The Sample F1 adsorption isotherm is shown in FIG. 168A, and the pore distribution chart is shown in FIG. 169. The pore distribution chart shows a phase of mesopores in the size range of 3 to 4 nm, with a peak at 3.4 nm.

Sample F2 comprises a pellet shown in FIG. 167B made from pressing the Sample F1 granules. Pressing these granules pushed the sheet-like frameworks further together, removing the majority of the interstitial pores between frameworks. This densification increases the alignment and contact area of the frameworks, creating a vdW assembly. The densification is reflected in Sample F2's reduced porosity of 0.079 cm³g⁻¹ and surface area of 451 m²g⁻¹, as shown in FIG. 224. The Sample F2 adsorption isotherm is shown in FIG. 168B, and the pore distribution chart is shown in FIG. 169. The reduced specific porosity of Sample F2 is accompanied by an elimination of most of the mesopores in the range of 3 to 4 nm and an increase in the mesopores in the 2 to 2.5 nm, demonstrating compaction and deformation of the perimorphic walls of the cellular subunits. The increased formation of non-native bilayers, and associated vdW cohesion, causes pelletization, as observed in FIG. 167B. A 4-pt conductivity probe was used to measure the surface resistivity of the sample, which was 16 Ω/sq.

Sample F3 comprises the Sample F2 pellet after being annealed at 1050° C. for 30 minutes. During annealing, the specific porosity and specific surface area is reduced to 0.028 cm³g⁻¹ and 233 m²g⁻¹, respectively, as shown in FIG. 224. This represents a 65% reduction in the pore volume. The pellet thickness is reduced by 6.7%. Assuming an isotropic reduction the pellet's overall shrinkage would only be 19%. Together, the 65% reduction in pore volume, as measured by N₂ adsorption, and the pellet's shrinkage of only 19%, indicate that some of the pore structures have been sealed with respect to the N₂ gas during adsorption.

This indicates that, during maturation, the lines of sp² ring connections formed between the layers at bilayer contacts not only cinch the non-native bilayers together, but have a zipper-like effect, drawing together surrounding regions of the layers. This zipping effect occurs via the same mechanism at both inter-network and intra-network non-native bilayers. The zipped regions cause bottlenecking of a fraction of the mesopores (i.e. pores over 2 nm) behind micropores (i.e. pores under 2 nm), as shown in the pore distribution in FIG. 169. These mesopores become inaccessible to N₂. This indicates the formation of a macroscopic helicoidal x-network. This is corroborated by Sample F3's reduced surface resistivity of 0.06 Ω/sq—a 2 to 3 order of magnitude reduction from Sample F2. This reflects the sp³-to-sp² rehybridization associated with maturation, an elimination of junction resistance (due to transport requiring interlayer tunneling) between microscopic anthracitic networks, and the associated formation of a macroscopic x-carbon.

Sample F4 comprises the Sample F1 granules after a two-step sequence of annealing and then pressing (in that sequence). Unlike Sample F2, Sample F4 did not comprise a pellet-despite having been pressed under the same conditions as Sample F3, the annealed granules would not form a pellet. The BJH specific porosity and BET specific surface area for Sample F4 was 0.249 cm³g⁻¹ and 473 m²g⁻¹, respectively, as shown in FIG. 224. The Sample F4 adsorption isotherm is shown in FIG. 168D, and the pore distribution chart is shown in FIG. 169.

Sample F4 did not form a pellet because maturation caused the anthracitic networks to rigidify (as observed in Study E) prior to pressing them together. In other words, the annealed granules that were pressed in Procedure F4 had already matured into macroscopic, equiaxed helicoidal x-networks. The granules were densified and broken during pressing, so Sample F4 had a mixed granular-powdery consistency. However, the rigidified perimorphic walls could not obtain adequate vdW contact and cohesion, so the pressed system was not pelletized like Sample F2. Additionally, they were not collapsed to the same degree during pressing, as evidenced by the retention of the 3 to 4 nm mesopores of Sample F1.

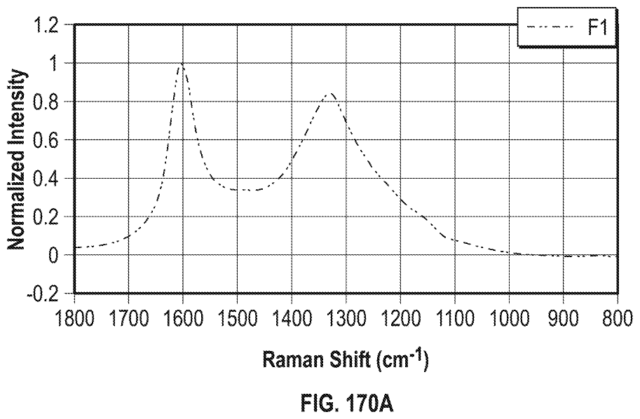

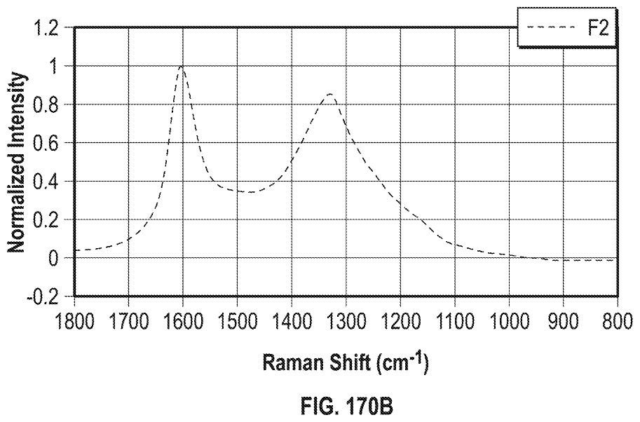

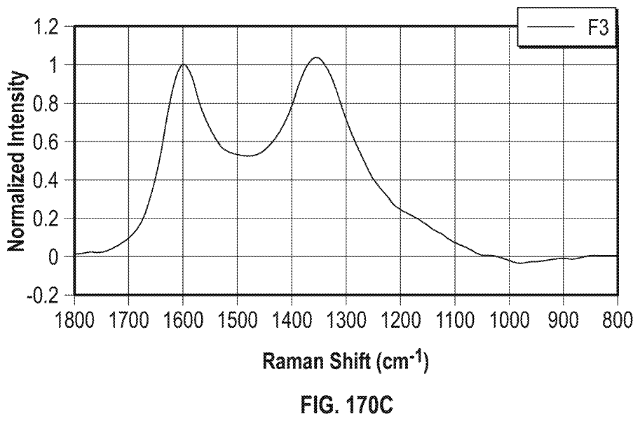

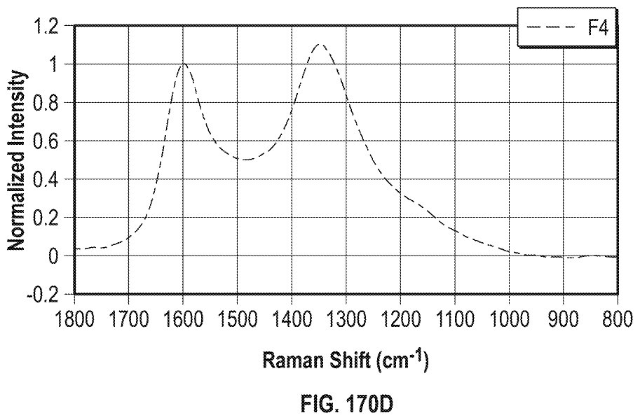

Raman spectra of Samples F1, F2, F3 and F4 averaged over 16 points are shown in FIG. 170A, FIG. 170B, FIG. 170C, and FIG. 170D, respectively, for the range of the Gᵤ and Dᵤ peaks (no 2D peak feature was observed). The Raman spectra for the Sample F1 powder and Sample F2 pellet are very similar to each other, indicating that pelletization of the granules caused no changes in the bonding structure. The spectra for the Sample F3 pellet and the Sample F4 powder are also similar, although Sample F4 exhibits a somewhat higher I_{D}_{ᵤ}/I_{G}_{ᵤ} peak intensity ratio. This is likely due to the breakage of the graphenic structures that must occur for the macroscopic anthracitic granules to be densified in the press. In other words, the failure of the helicoidal networks is associated with breakage of the graphenic sp² ring structure and conversion of sp² interior atoms to sp² edge atoms.

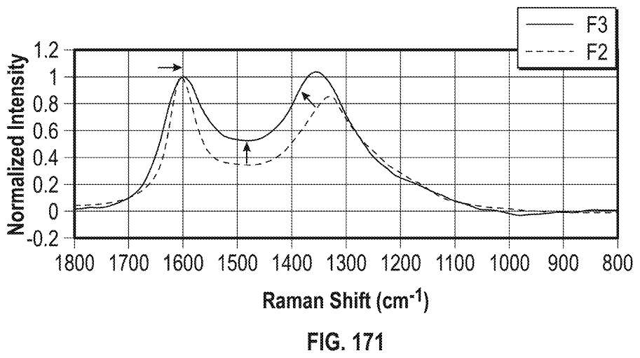

FIG. 171 shows the overlay of the Sample F2 and Sample F3 spectra. The spectral changes associated with maturation are indicated via black arrows. As we established in Study E, the D peak of mature, helicoidal networks produced from sp^{x} precursors is deinterpolated by the proliferation of sp² edge states and the reduction in sp³ edge states. The trough increases with the increased lattice distortion of the helicoidal networks. The interpolated Dᵤ peak positions in Samples F1 and F2 indicate the presence of sp³ states associated with diamondlike seams. Based on the Dᵤ peak position of 1331 cm⁻¹, the frameworks from Sample F1 and Sample F2 comprise highly grafted x-sp^{x} precursors. By comparison, the Dᵤ peak positions of Samples F3 and F4 are above 1348 cm⁻¹ and fall into the D band's normal range under 532 nm Raman excitation. As such, Sample F3 and F4 comprise highly mature, helicoidal x-networks.

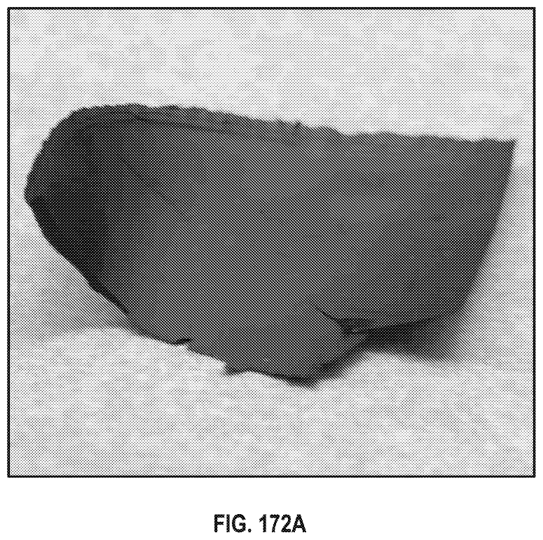

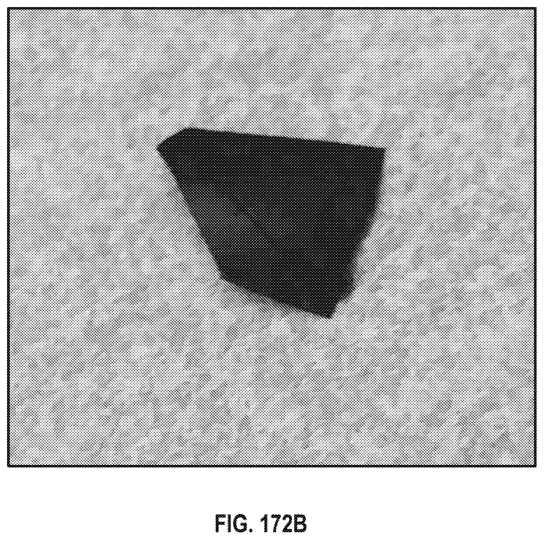

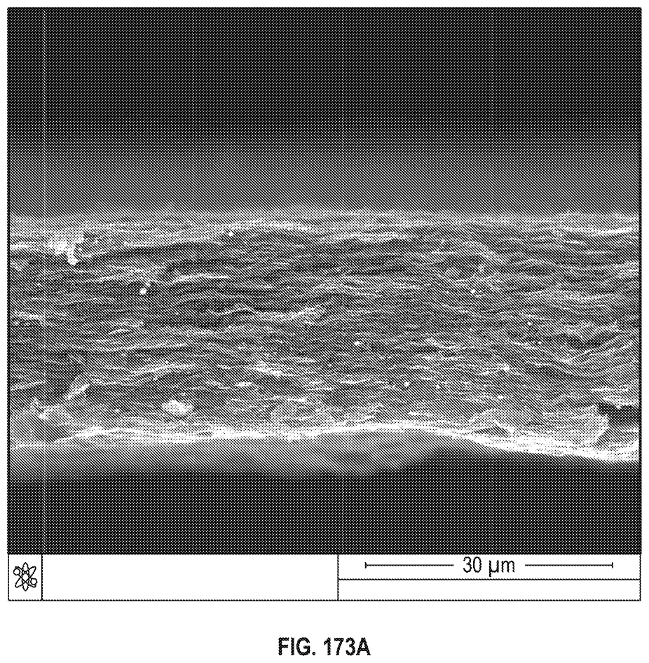

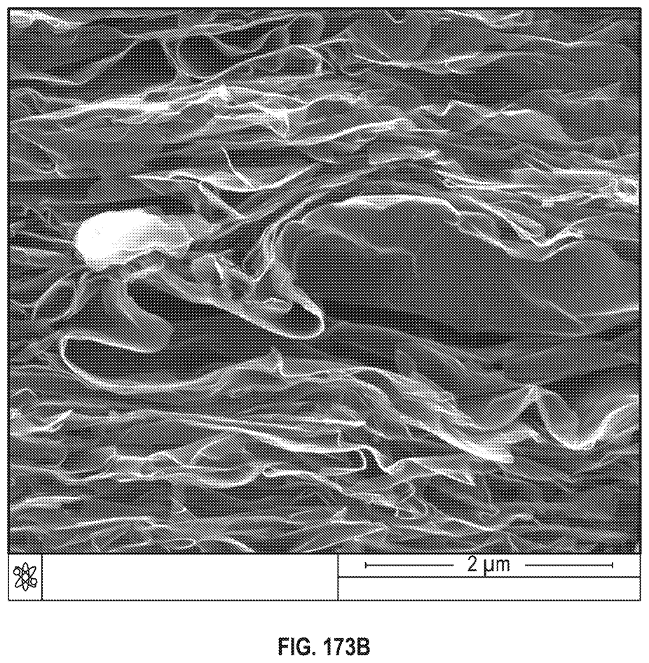

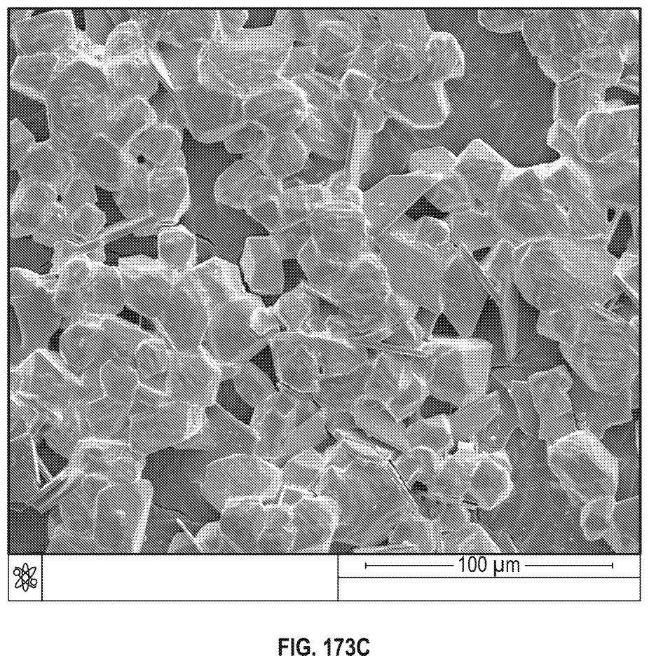

Sample F5 is another example of a flat macroform, comprising a helicoidal network, being constructed from flat microforms. To fabricate Sample 5, non-compact perimorphic frameworks with hollow architectures similar to diagram III shown in FIG. 161 were vacuum-filtered. This collapsed the frameworks, creating a buckypaper of sp^{x} networks. Buckypapers are thin, paper-like vdW assemblies made from filtration of flexible carbon nanomaterials like graphene nanoplatelets or nanotubes that may be useful in numerous applications, including energy storage, filtration, and structural composites. The sp^{x} networks were grown on a powder comprising K₂CO₃ microcrystals with large, atomically flat facets. FIG. 172A is an image of the freestanding buckypaper macroform. FIG. 173A is an SEM micrograph of the entire cross-section of the macroform. FIG. 173B is a magnified image showing the individual, collapsed frameworks comprising the microforms. FIG. 173C is an SEM micrograph of the K₂CO₃ microcrystals with large, atomically flat facets.

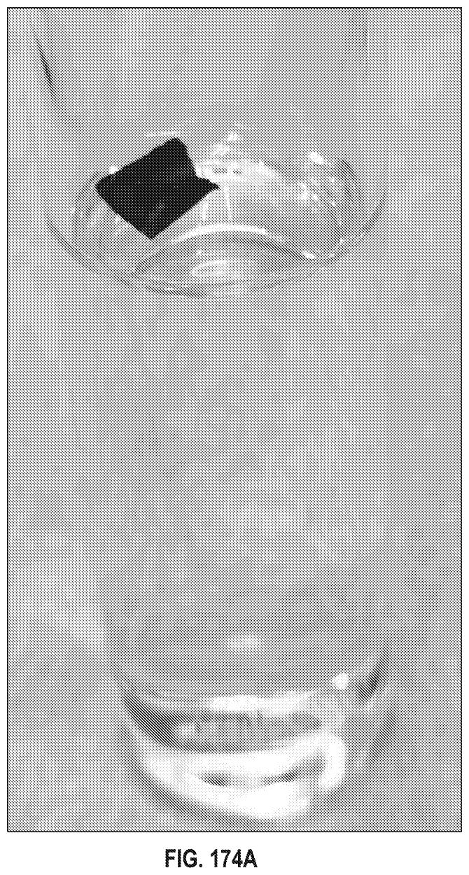

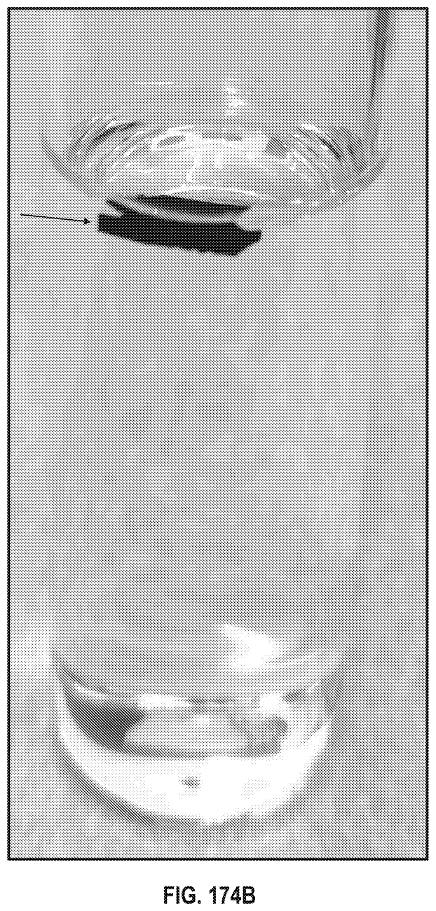

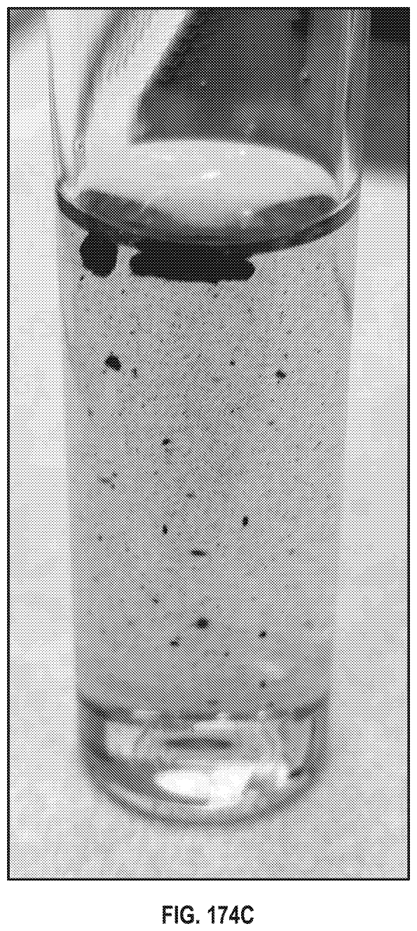

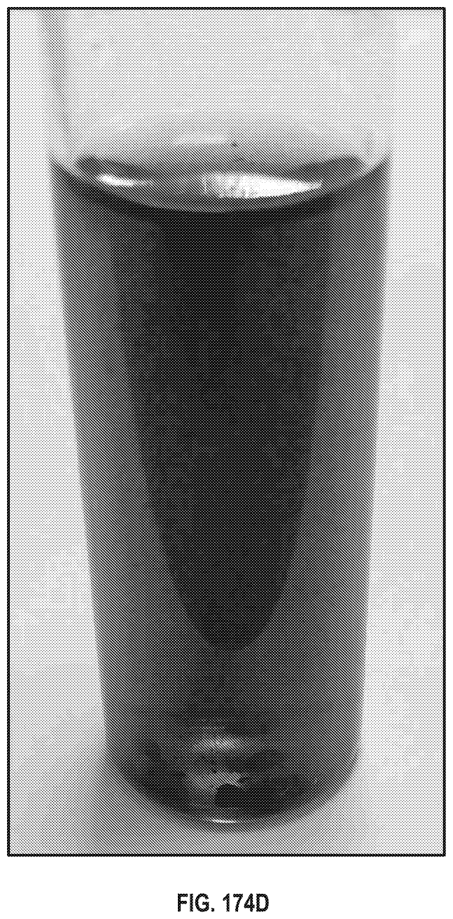

Sample F6 comprises a section of the Sample F5 macroform that was cut out and annealed at 1050° C. for 30 minutes. FIG. 172B is an image of Sample 5 after annealing. Visually, there was no apparent change before and after annealing. While mechanically handling sample F6 it was more brittle and less flexible than F5, indicating the integration of the microforms during maturation. Next, Samples F5 and F6 were immersed in isopropyl alcohol. As shown in FIG. 174A, when Sample F5 was immersed in solvent, the paper seemed stable and remained close to the surface of the solvent. After 2 minutes, it was observed to swell, increasing in thickness to over a millimeter, while continuing to stay close to the liquid surface. The increased thickness is indicated in FIG. 174B by the arrow. After 15 minutes the paper started to disintegrate, and the debris started to sink to the bottom as shown in FIG. 174C. After leaving it overnight to soak, the vial was shaken by hand, and the paper seemed to have completely disintegrated, as shown by the dispersion of the sp^{x} microforms in FIG. 174D. This degeneration confirmed that the Sample F5 macroform represented a vdW assembly, which the solvent intercalated and destabilized.

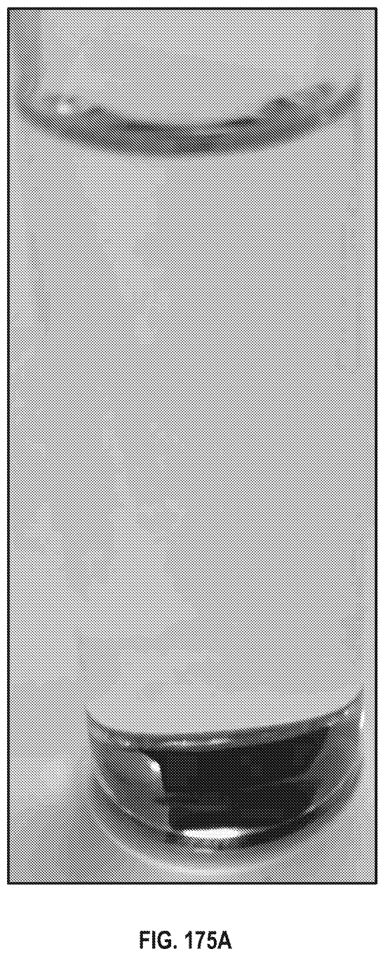

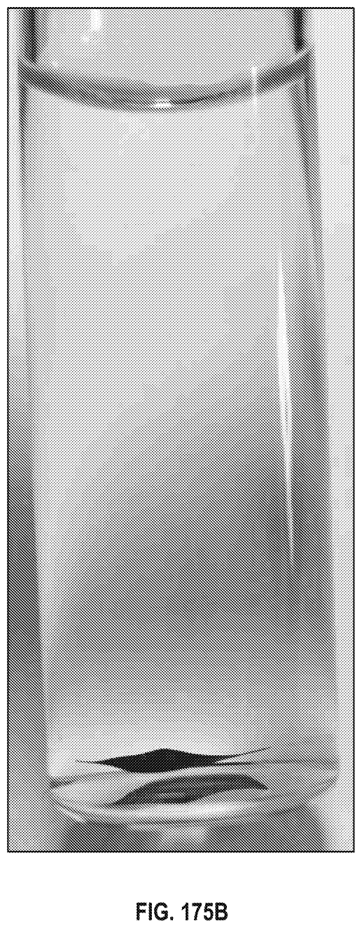

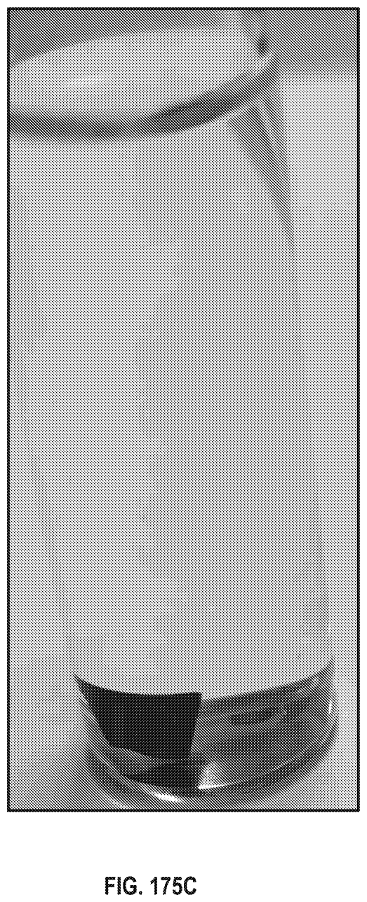

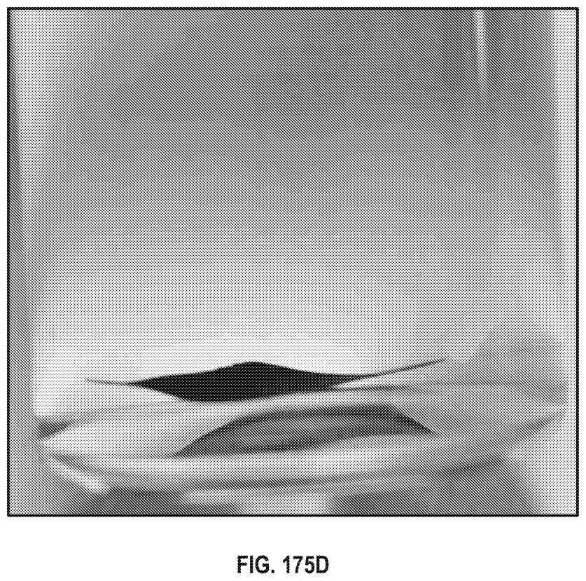

A similar test was performed on Sample F6 by soaking a portion of it in isopropyl alcohol. As shown in FIG. 175A, the sample upon immersion seemed stable. Unlike Sample F5, it sank to the bottom. After 15 minutes there was no noticeable change and no indication of swelling, as shown in FIG. 175B. Shaking the vial by hand had no impact on the sample integrity. The sample was left immersed overnight, then shaken again the next morning, without any changes. This is shown in FIG. 175C. A higher magnification image was taken at this stage and is shown in FIG. 175D. The thickness was unchanged. The stability of Sample F6 is another indication that it has been crosslinked and comprises a macroscopic helicoidal network.

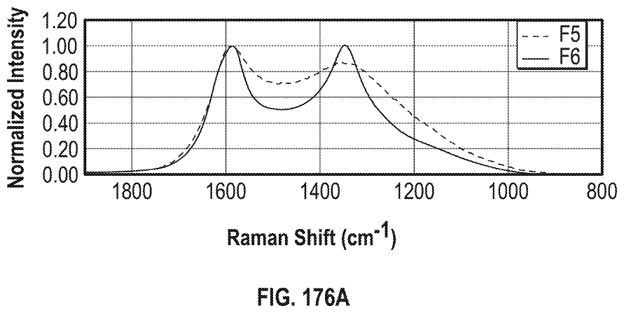

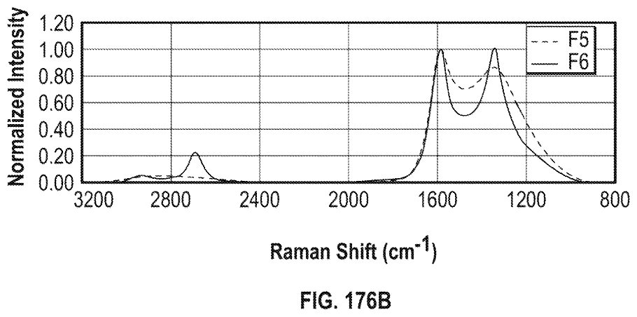

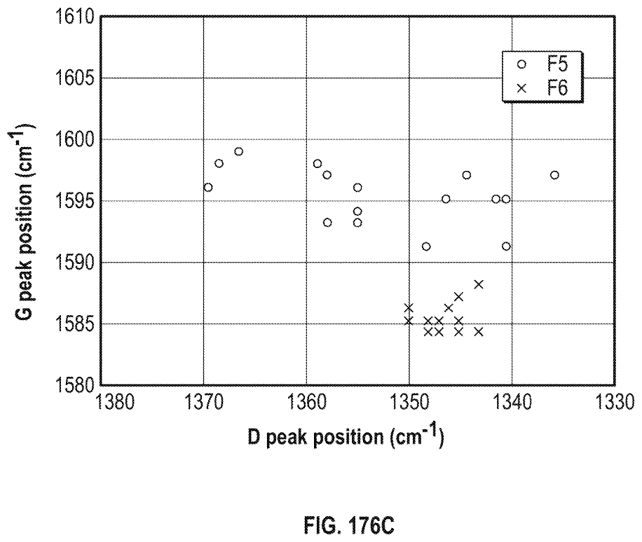

This was confirmed via Raman analysis was performed (at 2 mW power). FIG. 176A shows the average spectra for Sample F4 and Sample F5 in the range of the Gᵤ and Dᵤ peaks, with the spectral changes associated with annealing indicated via black arrows. FIG. 176B shows the average spectra for the entire range with the spectral changes associated with annealing indicated via black arrow. FIG. 176C shows the Gᵤ and Dᵤ peak positions for all 16 points individually.

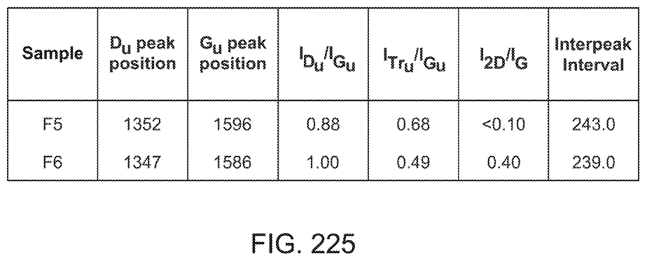

FIG. 225 summarizes the average I_{D}_{ᵤ}/I_{G}_{ᵤ}, I_{Tr}_{ᵤ}/I_{G}_{ᵤ} and I_{2D}_{ᵤ}/I_{G}_{ᵤ} peak intensity ratios, the average Gᵤ and Dᵤ peak positions, and the interval between the Gᵤ and Dᵤ peak positions. The average Dᵤ peak position for Sample F5 is 1352 cm⁻¹, and from this it is not immediately evident that Sample F5 comprises an sp^{x} network. However, the point spectra shown in FIG. 176C reveal Dᵤ peak positions as low as 1336 cm⁻¹, which is indicative of localized sp³ states and diamondlike seams. The localized D band interpolation is consistent with the microcrystalline K₂CO₃ template particles on which the perimorphic frameworks were grown. The atomically flat surfaces of these crystals minimize nucleation of primordial domains, which grow over the surfaces with few tectonic interactions. Because the formation of sp³ states and diamondlike seams arise from tectonic interfaces, the RBM phonons in regions with few tectonic interfaces are predominately activated by sp² edge states-point defects within the basal plane. In these regions, there is no obvious interpolation in the Dᵤ peak. In other, more nucleated regions, tectonic activity creates the sp³ states and diamondlike seams that cause interpolation of the D band. This explains the breadth of the scatter in Dᵤ peak positions in FIG. 176C. Additionally, it means that Sample F5 comprises an sp^{x} network.

The presence of large regions with minimal tectonic activity also explains other spectral features. The high I_{Tr}_{ᵤ}/I_{G}_{ᵤ} value of 0.68 in Sample F5 is indicative of ring disorder-induced lattice curvature, which seems to increase in the absence of diamondlike seams. This may be related to the lack of compressive stress created by sp³ grafting at tectonic interfaces. Sample F5 exhibits a slightly red-shifted Gᵤ peak, as indicated by the scatter plot in FIG. 176C, which is consistent with ring-disorder. All of this is consistent with the previous observations that progressive D peak interpolation was accompanied by progressive reduction in the trough height and blue-shifting of the Gᵤ peak.

The lack of tectonic activity during the formation of Sample F5 explains why its I_{Tr}_{ᵤ}/I_{G}_{ᵤ} value (0.68) is much higher than Sample B2's I_{Tr}_{ᵤ}/I_{G}_{ᵤ} value (0.46), despite the pyrolysis temperature for these two samples being the same (640° C.). The most primordial cause is the substrate-defect-rich substrates cause dense nucleation, tectonic activity, and sp³ formation, while defect-poor substrates suppress it.

The local absence of sp³ states also explains the spectral changes that occur during maturation of Sample F5. Thus far, we have observed that maturation leads to increased lattice distortion and increased trough height. However, in Sample F6, the trough height is considerably reduced compared to Sample F5. This is because of the local absence of screw dislocations in the resulting helicoidal network—in other words, the helicoids are so large that the dominant spectral effect of maturation is the elimination of ring disorder, which reduces lattice distortion and therefore reduces the trough. The combination of the increased ring order and the absence of screw dislocations is also reflected by the emergence of a 2Dᵤ peak in the Sample F6 spectra. The emergence of a 2D peak is indicative of longer-range, in-plane sp² crystallinity. Based on Sample F6's I_{2D}_{ᵤ}/I_{G}_{ᵤ} peak intensity ratio, which is slightly higher than 0.40 Å, and its Dᵤ peak position of 1347 cm⁻¹, the Sample F6 macroform comprises an example of a minimally crosslinked, highly mature helicoidal z-network.

So far in Study F, we have demonstrated a process for creating macroscopic anthracitic networks. This involves creating a static, macroscopic vdW assembly from distinct, smaller-scale anthracitic networks (i.e. “microforms”) and ring-connecting them to one another via an assembly-to-assembly or assembly-to-singleton maturation. We have demonstrated this process using flat microforms, which we have used to create both flat and equiaxed macroforms. This basic approach of cohering perimorphic microforms to create a macroform is described in the '308 Application, where the macroforms are described as “peritactic macroforms.” Study F therefore demonstrates that a peritactic macroform can comprise a single anthracitic network.

However, these are only exemplary variants of the inventive concept, which can encompass different densification techniques (e.g. mechanical compaction, evaporative drying, etc.) and forming techniques (printing, 3-D printing, molding, extrusion, injection, drawing, spinning, etc.), without limitation. These and other techniques may be used to create a peritactic macroform of any arbitrary size, geometry and aspect ratio, including elongated, flat, and equiaxed shapes. In particular, we foresee the fabrication of continuous helicoidal networks in the form of yarns, ropes, sheets, and coatings. The only requirements are to bring the sp^{x} microforms together into a vdW assembly of the desired geometry and to hold the assembly in a substantially static configuration during maturation. Maximum flexibility and contact between the sp^{x} microforms are preferred for obtaining maximum interconnectivity in the final macroform. For this reason, natively few-layer sp^{x} precursors are preferred.

The inventive concept also includes the use of microforms of different geometries. A large variety of potential microforms are described and envisioned in the '918 and '760 Applications, and these can be utilized to make different peritactic macroforms, as described in the '308 Application. These microforms may include perimorphic frameworks comprising elongated fibers, flat sheets, or equiaxed prisms, as well as more complex, hierarchical geometries (e.g. rosette-like structures). The rosette-like structures may be especially attractive due to their ability to flex and flatten into aligned plates during densification. This list of microform variants is not exhaustive—other variants may be readily envisioned. Microforms may also be used in combinations of different sizes and geometries.

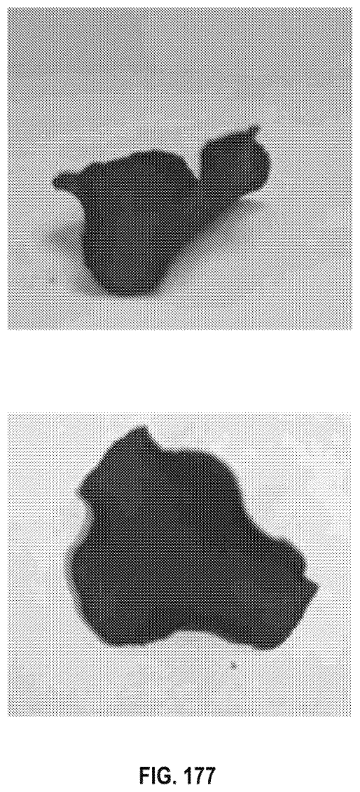

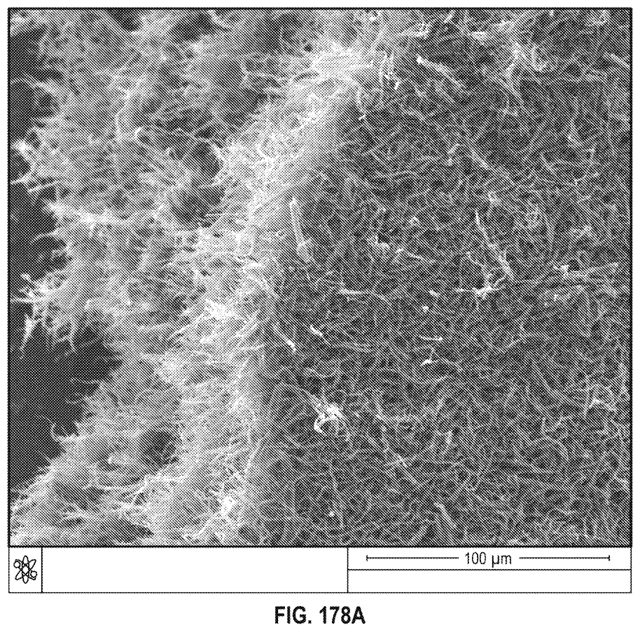

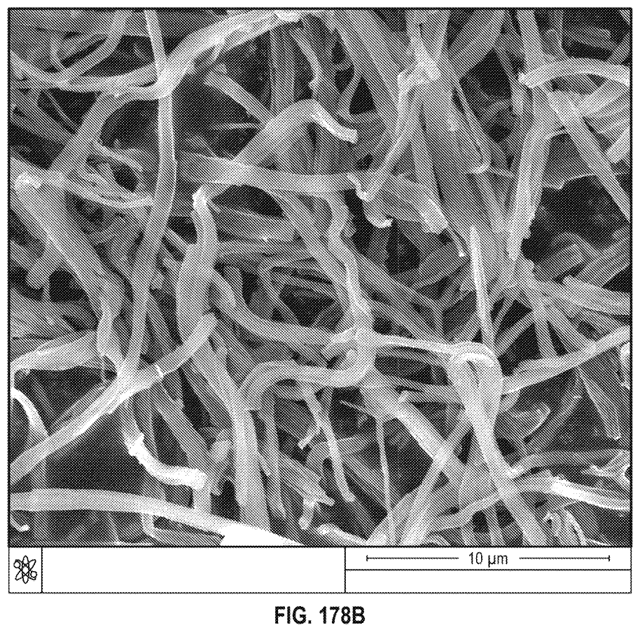

As an example of one such variant, Sample F7, which is shown in FIG. 177, comprises a flat macroform constructed from elongated microforms. These microforms comprise flexible fibers with diameters ranging from submicron to micron-scale, with lengths ranging from 10 μm to 100 μm. These were chosen for their enhanced flexibility and ability to entangle with one another, creating a textile. A broken portion of the textile of these elongated microforms is shown in the SEM micrograph of FIG. 178A, and the entangled structure is shown in FIG. 178B. This textile was densified via drying but might be further densified using a roll press in order to increase the contact area between the microforms.

Other perimorphic frameworks that might be used as microforms are detailed in this disclosure and in the '918 and '760 Applications. These microforms, in addition to varying based on their overall particle geometry, may vary based on their compactness—i.e. their mesoscale crosslinking. This can be seen in a comparison of the elongated microforms shown in FIG. 83A-83B and FIG. 85. In FIG. 83A-83B, two magnifications of a sample of perimorphic frameworks are shown. These frameworks comprise comparatively dense mesoscale crosslinking-analogous to diagram I of FIG. 161. Accordingly, when these frameworks are dried, the crumpled cellular subunits create a smooth, indistinct surface, as can be observed in FIG. 83B. In FIG. 85, two magnifications of another sample of perimorphic frameworks, the frameworks comprise less dense mesoscale crosslinking-analogous to diagram II of FIG. 161. Accordingly, when these frameworks are dried, the crumpled cellular subunits have a more coarsely crumpled appearance, as shown in FIG. 85.

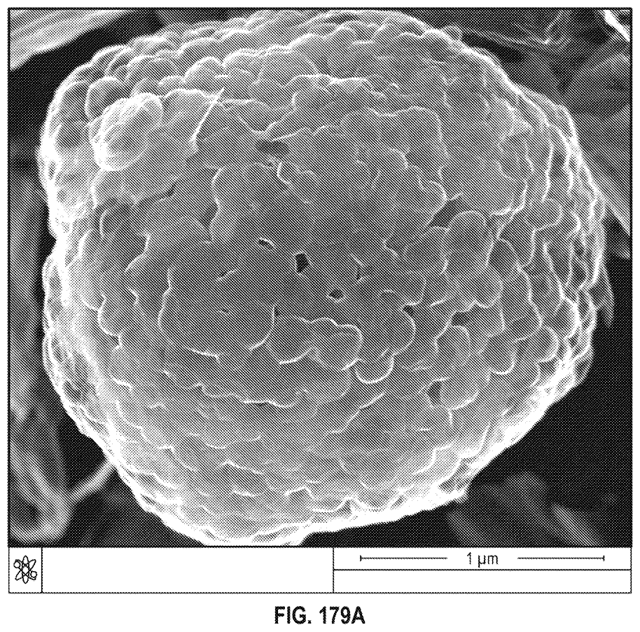

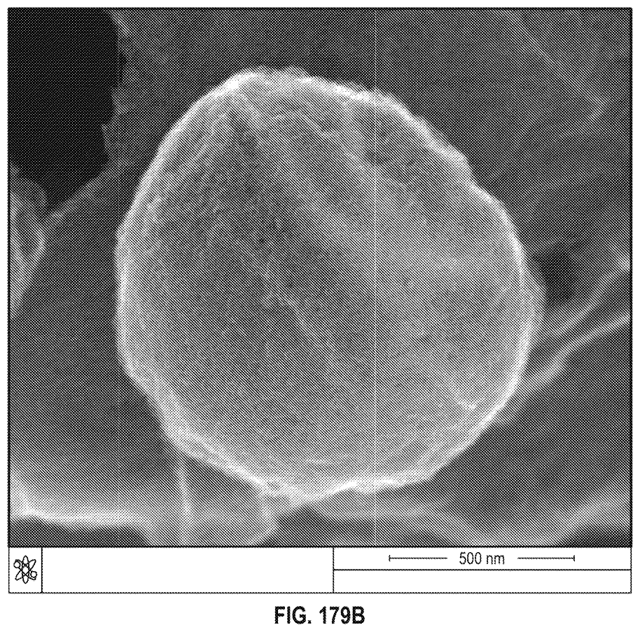

Other microform variants may comprise rosette-like sp^{x} networks, like the one shown in FIG. 78C, comprising petaloid arrangements of the sheets-of-cells morphology. These petals may be densified such that they stack upon each other, forming non-native bilayers and fusing into a lamellar stack during maturation. Lamellar stacking arrangements are also possible from collapsing and densifying flexible, hollow-spherical microforms. A rigid version of this type of structure is shown in FIG. 179A, and a flexible version is shown in FIG. 179B. These hollow-spherical microforms may be synthesized using spray-dried hollow spheroid templates, as described in the '760 and '918 Applications. The use of either natively flat perimorphic frameworks, or flat-upon-collapse petaloid or hollow frameworks, allows for a high degree of interconnectivity in the matured network due to the high intra-network and inter-network contact area in the lamellar macroform.

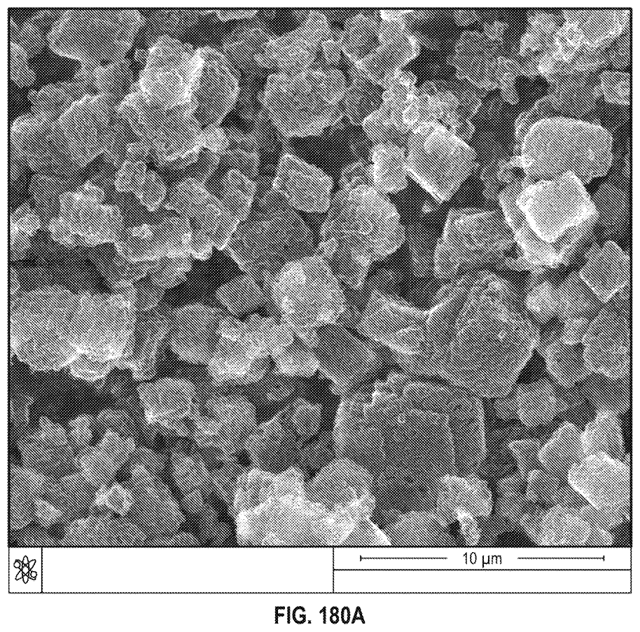

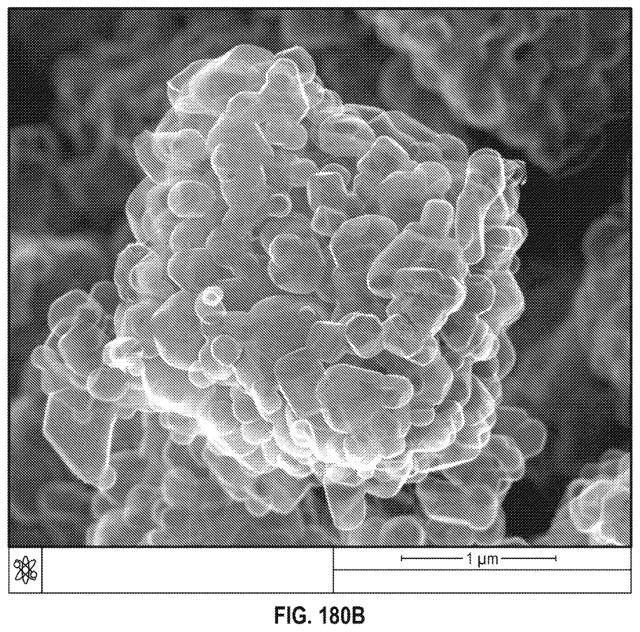

Other microforms comprise equiaxed perimorphic frameworks. In one variant, the microforms may comprise hollow spheres. These may be especially useful if a low-density, macroporous anthracitic network is desired. In another variant, the microforms may comprise perimorphic frameworks with a prismatic or polyhedral superstructure, like those shown in FIG. 180A (at lower magnification) and 180B (at higher magnification). Where equiaxed perimorphic frameworks are utilized, the mature, macroscopic network may benefit from packing efficiency and flexibility.

### XIV**. Study G—Analysis

Study G was performed to ascertain whether microwave irradiation could be utilized as a rapid technique for maturing sp^{x} precursors. It was hypothesized that a combination of high temperature, short annealing time, and rapid cooling was desired to mature the sp^{x} network fully, while preserving a high density of dislocations. A rapid microwave treatment, it was theorized, would offer this combination.

In Test I of Study G, a Cober-Muegge microwave system was utilized to perform a microwave treatment on the G₁ carbon sample. The system consisted of a 2.45 GHz magnetron, 3000W power supply, steel vacuum chamber, and vacuum pump. The vacuum chamber was outfitted with a rotating platform to facilitate uniform sample exposure and a gas inlet/outlet. The rotating platform could be switched on or off. A quartz viewing window located near the top of the vacuum chamber allowed video observation of the sample during the microwave treatment. The microwave assembly is shown in FIG. 96C.

A 101.0 mg quantity of Sample G₁ powder was placed in a medium quartz beaker (“A”). A 100.4 mg quantity of another carbon powder was placed in a small quartz beaker (“B”). The powder bed in each beaker was leveled to a uniform thickness. Beakers A and B were both then placed within a large quartz beaker in case the smaller beakers shattered from rapid heating during the microwave treatment. The large beaker was placed in the vacuum chamber in a centrally located position to maximize microwave exposure. The vacuum chamber was then sealed and vacuumed down to approximately 2 torr, at which point the chamber was refilled to −710 torr with nitrogen gas. This was repeated two more times to remove any remaining oxygen in the nitrogen atmosphere.

Microwave irradiation was commenced at a power level of 2400 W. This condition was held for 2 minutes and then the magnetron was switched off. The samples were then permitted to cool back down to room temperature prior to opening the vacuum chamber. The mass of the carbon collected from Beaker A was 95.2 mg and the mass collected from Beaker B was 98.5 mg.

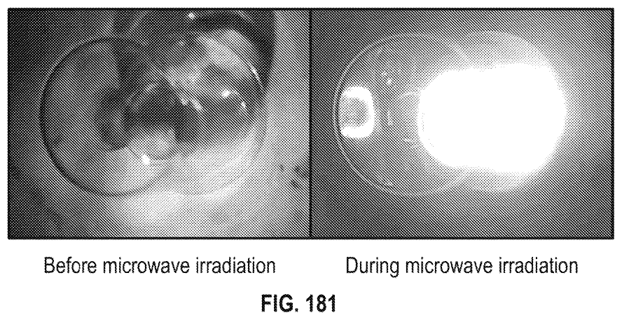

During the 2-minute microwave irradiation treatment, the samples were observed via a video feed. This treatment occurred at approximately 1 atm. Within a few seconds of the commencement of the microwave treatment, Sample G₁ began to glow red, and within 10 seconds from commencement, the red glow became bright white. This was likely the period over which rehybridization was occurring. From this point, the brightness continued to grow in intensity, with the video camera auto-adjusting its brightness settings several times to accommodate the growing intensity of light. FIG. 181 shows a frame from the video feed during the treatment. Sample G₁ is radiating such an intense white light that the sample cannot be discerned; the entire beaker appears bright white.

While temperature data was not gathered for this experiment, similarly intense white light was emitted in other treatments in which carbon sublimation and re-condensation above the sample as soot could be observed by video. This should only happen at temperatures significantly higher than 3,000° C. Some of the mass loss observed in Samples G₁ and the other carbon powder can be attributed to vaporization of oxidized carbon sites (some oxidized sites are retained, despite the lack of an oxidation procedure, due to the nucleation of the carbon lattices on the template's oxygen anions) and adsorbed water. The increased mass loss in Sample G₁ may be attributable to some sublimation occurring in this sample.

The remarkably intense Joule heating demonstrated by Sample G₁ during microwave irradiation indicates the formation of high-density electrical currents in the carbon particles. Study G demonstrates that microwave heating may be utilized for annealing. It also demonstrates that helicoidal networks may be utilized for resistive heating applications.

In Test II of Study G, a new (i.e. not previously subjected to microwave irradiation) portion of the Sample G₁ powder was subjected to microwave irradiation under a lower N₂ pressure and power level. The microwave system utilized was the same as the one utilized in Test I. As before, the experiment was performed at room temperature. The lower power setting was selected in order to avoid the formation of a sustained plasma inside the vacuum chamber during microwave irradiation. A small mound of 0.103 mg of Sample G₁ carbon powder was placed centrally in a quartz boat, which was placed centrally on the platform. The vacuum chamber was then sealed and vacuumed down to approximately 2 torr, at which point the chamber was refilled to ˜710 Torr with nitrogen gas. This was repeated two more times to remove any remaining oxygen in the nitrogen atmosphere. Finally, the chamber was vacuumed down to 32.5 Torr.

Microwave irradiation was commenced at a power level of 450 W. Surprisingly, the G₁ carbon powder did not grow visibly hot, as it had in Test I, but instead remained black, exhibiting no signs of heating. Additionally, almost immediately upon commencement of irradiation, the carbon powder was observed to spread, adopting an extremely fine, smoky appearance that slowly filled the quartz boat. Throughout the irradiation, the powder never showed any signs of heating. Upon terminating the irradiation, the particles collapsed back into a pile at the bottom of the boat.

The absence of resistive heating, coupled with the spreading of the particles in a vacuum, may be explained by a strong diamagnetic response consistent with a resistanceless, superconducting state. Without resistance, Joule heating does not occur. The strong diamagnetic response in this superconducting state is a phenomenon known as the Meissner Effect. In a typical demonstration of the Meissner Effect, a permanent magnet is used to levitate a superconducting compound that has been cooled below its critical temperature (T_{c}). This occurs due to the formation of screening currents formed near the surface of the superconductor in the presence of an applied magnetic field.

In the case of Test II, we conclude that, under reduced pressure and at approximately 300K, Sample G₁ enters a superconducting state, wherein microwave-induced supercurrents flow without resistance through the π electron cloud of electronically decoupled, graphenic monolayers. These supercurrents generate an opposing magnetic field, according to Lenz's law, causing the superconducting particles to repel one another and to spread out into a fine smoke. In effect, each particle becomes a superconducting magnet, and each particle repels the particles around it. This repulsion levitates particles and pushes them outward. Upon terminating the microwave irradiation, the particles stabilize back into a pile at the bottom of the boat.

While it is well-known that pyrolytic carbon is strongly diamagnetic, a diamagnetic response of this strength could not be observed at ambient pressure, nor does the diamagnetism of pyrolytic carbons explain the extraordinary lack of resistive heating under slightly reduced gas pressure. These combined phenomena demonstrate the formation of a resistanceless, superconducting state that is dependent upon gas pressure—in other words, dependent upon reduced gas-surface collisions. Test II occurred at approximately 300 K. Hence, Sample G₁ comprises a demonstrated room-temperature superconductor, making it potentially the first among a theorized class of superconductors with T_{c} of 300 K or higher.

Without being bound by theory, we propose the following explanation for the observed superconducting state. First, as we have already demonstrated, the diamondlike seams present in sp^{x} networks force AA-stacking (and also bowing), increasing the <002> distance and reducing the electronic coupling between z-adjacent graphenic layers. It has been shown that at the atomic two-dimensional limit, correlation effects become more pronounced, and superconductivity may be achieved with far lower carrier density than in bilayers and bulk structures. Electronically decoupling the layers via AA stacking therefore enables a superconducting state with fewer charge carriers. Second, we propose that the sp³ states within Sample G₁ may act as dopants that increase carrier density. This concept of doping via sp³ defects has been explored in connection with carbon nanotubes. Third, we propose that gas-surface collisions at ambient pressures lead to out-of-plane phonon perturbations that break the electronically decoupled state of the atomic monolayer superconductor. This is indicative of a phonon-electron coupling mechanism that, while integral to conventional BCS superconductivity, has not heretofore been conclusively determined for high-T_{c} superconductors. At the atomic two-dimensional limit, we are able to observe the phonon-electron coupling mechanism experimentally. The superconducting state should be enhanced with further suppression of gas-surface collisions achieved at progressively lower pressures. It may also be enhanced with further doping.

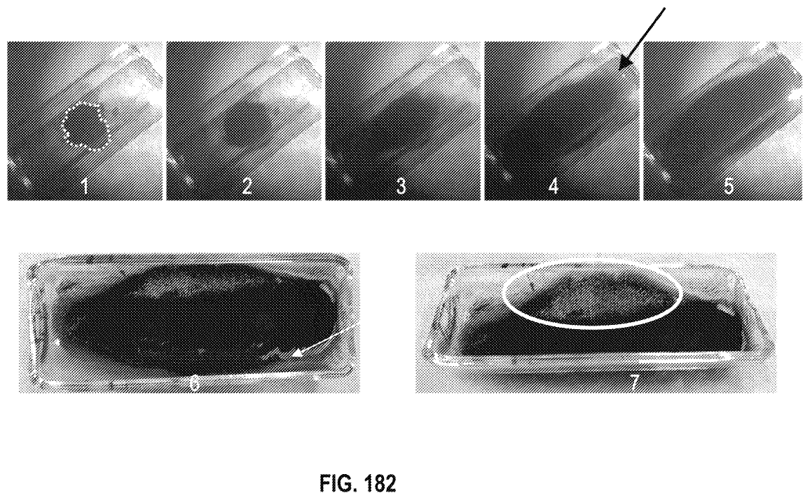

In Test III of Study G, the Sample G₁ carbon powder was exposed to microwave irradiation at low pressure in order to demonstrate superconductivity. The microwave system utilized was the same as the one utilized in Tests I and II. As before, the experiment was performed at approximately 300 K. A small mound of 0.1027 mg of Sample G₁ powder was placed in a quartz boat. The powder was pushed into a small pile located in the center of the boat, as shown Frame 1 of FIG. 182. An approximate outline of the pile is traced in Frame 1. The boat was then placed centrally in the vacuum chamber. The vacuum chamber was then sealed and vacuumed down to approximately 2 torr, at which point the chamber was refilled to ˜710 torr with nitrogen gas. This was repeated two more times to remove any remaining oxygen in the nitrogen atmosphere. Finally, the vacuum chamber was vacuumed down to 32 torr.

Microwave irradiation was commenced at a 300 W power setting. Immediately (within 1 second of commencement) the pile of carbon powder began migrating outward, visible in the camera as a slight change in the outline of the pile. This migration was continued for a couple of seconds, whereupon the magnetron was switched off and the pile stopped moving. The G₁ carbon powder remained black, exhibiting no signs of heating. The pile after this initial irradiation is shown in Frame 2 of FIG. 182. The movement was most visible in the upper-right and lower-left corners of the pile as it began migrating along the length of the boat.

At this point, irradiation was again commenced—this time at an increased power setting of 750 W. Again, within just 1-2 seconds of microwave exposure, the carbon powder was observed to levitate, this time migrating down the length of the boat as a black, particulate cloud. This migration, which occurred over a period of approximately 10 seconds, is shown in Frames 3 through 5 in FIG. 182. During this time, the powder both expanded along the length of the boat and pushed upward along its walls, especially at the center, where it nearly reached the lip of the boat, as indicated by the circle in FIG. 182. The progress along the length of the boat appeared as the steady drift of a fine smoke, which is indicated by the black arrow in Frame 4 at the upper-right end of the boat. After stabilizing in the configuration shown in Frame 5, the powder did not move at all. Throughout the procedure, it never showed any signs of heating, although a few occasional microplasmas were observed within the bed. In Frame 6 and 7 of FIG. 182, photographs of the boat upon removal from the microwave chamber reveal the final shape of the powder. The white arrow indicates where, upon turning off the magnetron, the powder fell back down.

In Test IV of Study G, four commercial carbon powders were exposed to microwave irradiation at higher pressure. The multiwall carbon nanotube variant of the commercial carbon powder was Elicarb MW PR0940 (Thomas Swan) herein referred to as Sample G₂. The multilayer graphene nanoplatelet variant was xGnP Grade C-750 (XG Sciences) herein referred to as Sample G₃. The conductive carbon black variant was Vulcan XC72R (Cabot) herein referred to as Sample G₄. The flake graphite variant was Microfyne (Asbury Carbons) herein referred to as Sample G₅.

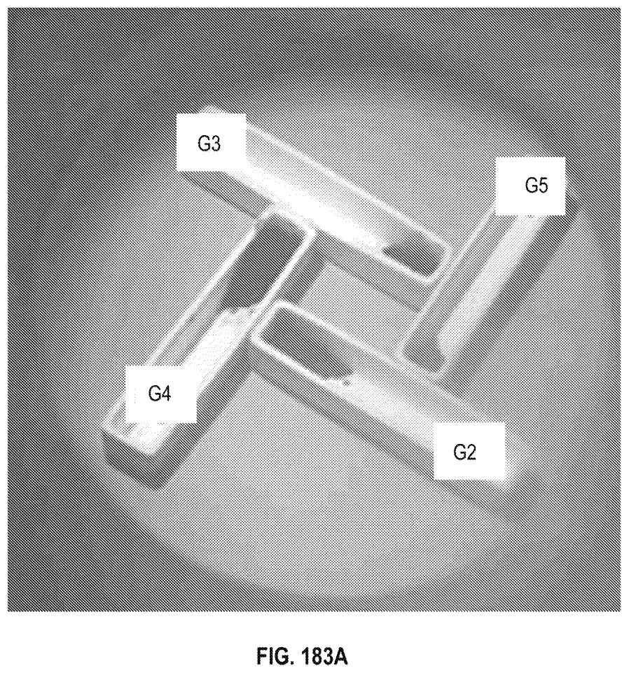

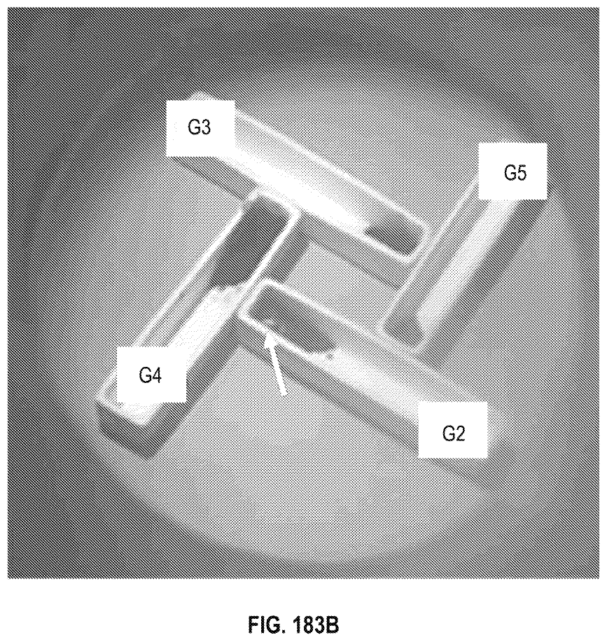

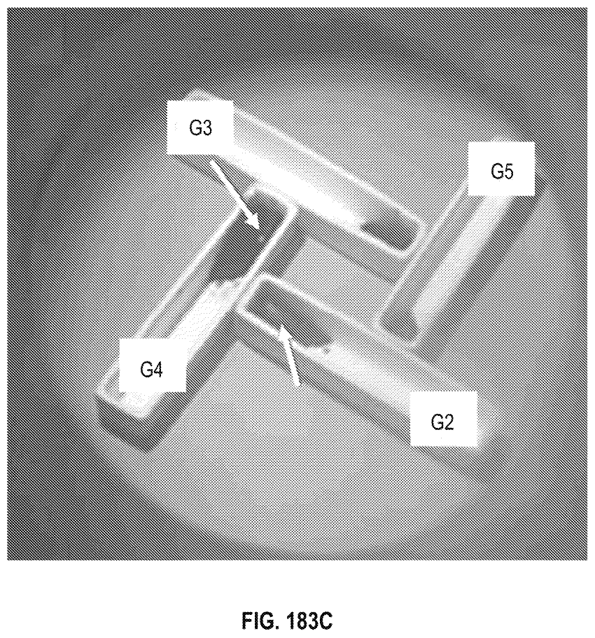

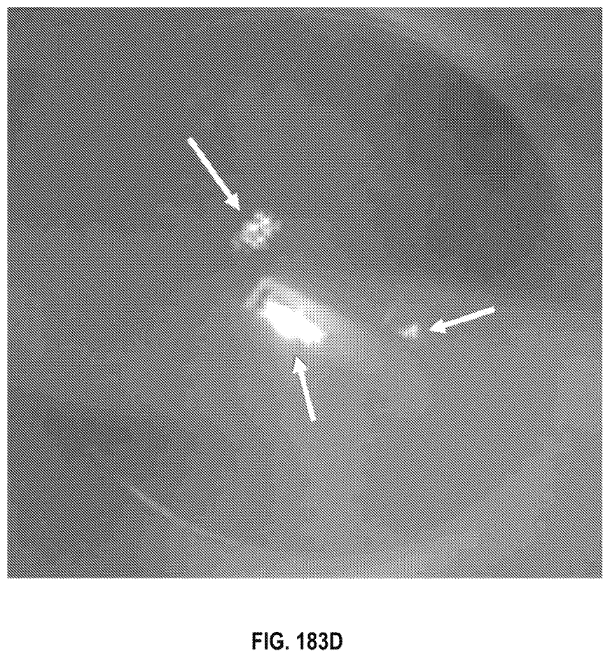

The microwave system utilized was the same as the one utilized in Tests I, II, and III. As before, the experiment was performed at room temperature. Piles of 101 mg, 101 mg, 101 mg and 130 mg of Samples G₂, G₃, G₄ and G₅, respectively, were placed in separate ceramic boats. The powder was pushed into a small pile located in the corner of their respective boats as shown and labeled in FIG. 183A. The boats were then placed centrally in the vacuum chamber, which was sealed and vacuumed down to approximately 2 torr, at which point the chamber was refilled to ˜750 torr with nitrogen gas. This was repeated two more times to remove any remaining oxygen in the nitrogen atmosphere, and the vessel was brought to a final N₂ pressure of ˜720 Torr.

The initial power setting was at 300 W. Upon commencing microwave irradiation at this power setting, Sample G₂ grew visibly hot, turning a dull orange, as seen in FIG. 183B, where an arrow point to the orange glow. This was accompanied by low-level microplasma formation of the powder. The other three samples G₃, G₄ and G₅ did not grow visibly hot, but remained black, exhibiting no signs of heating. No physical movement of the particles for any sample was observed. The microwave power setting was then increased to 600 W. At this power setting, Samples G₂ and G₄ both grew visibly hot, turning a dull orange, as seen in FIG. 183C, where arrows point to the orange glow. Sample G₂ retained the low-level sparking phenomenon observed previously. Samples G₃ and G₅ exhibited no signs of heating.

The microwave power setting was finally increased to 1500 W. At this power setting, Sample G₂ was the hottest, displaying a bright orange-yellow glow as seen in FIG. 183D, as well as low-level sparking. Samples G₄ and G₅ both grew visibly hot, turning a dull orange as seen in FIG. 183D, where arrow point to the orange glow. Sample G₃ exhibited no signs of heating. External illumination was turned off for the image seen in FIG. 183D to have better visibility of the heated samples.

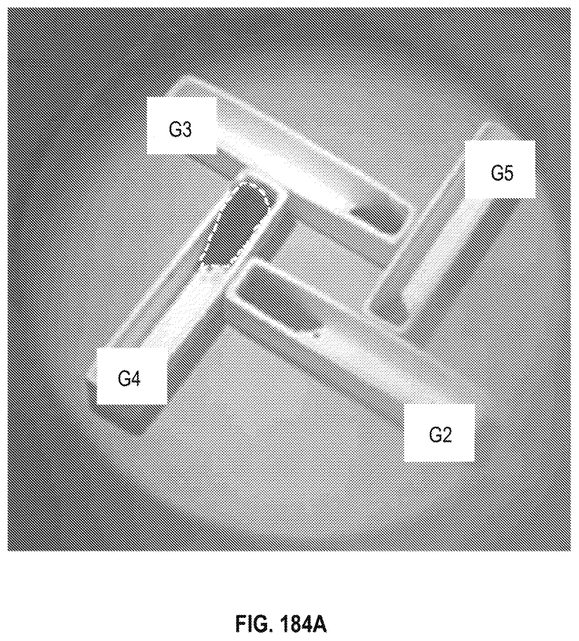

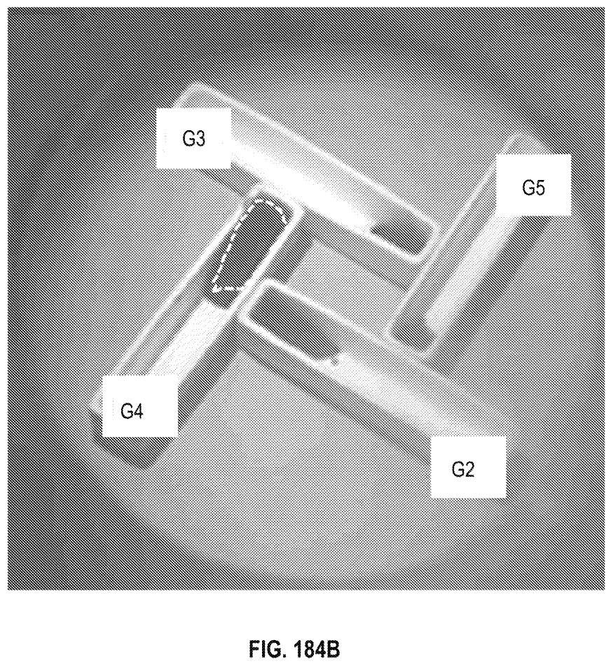

In Test V, the response of Samples G₂ through G₅ to microwave irradiation under reduced gas pressure were investigated. The sample arrangement was unchanged—the chamber was simply pumped down to 32 torr. In Test V, Samples G₂ through G₅ powders were irradiated again but at 32 torr. The traced outline in FIG. 184A indicates the original shape of the pile for Sample G₄. The vacuum chamber was vacuumed down to 32 torr.

Microwave irradiation was commenced at a 300 W power setting. Immediately (within 1 second of commencement), Sample G₄ migrated clearly, visible in the camera as a change in the outline of the pile. Minor migration also occurred in Sample G₅, although it was barely distinguishable. After a couple of seconds of migration, the magnetron was switched off and all migration stopped. The samples after this initial irradiation are shown in FIG. 184B. Compared to the original shape of the Sample G₄ pile, as indicated by the traced outline, the pile has extended along the length of the boat. None of the samples showed signs of heating.

Test V showed that a strong, pressure-dependent diamagnetic response was also observed in carbon black (Sample G₄). This pyrolytic carbon also exhibits large <002> interlayer spacing, with an XRD report in the literature reporting the <002> peak position at 2θ=25°, equivalent to an interlayer d-spacing value of 3.56 Å. We suspect that the same dislocation structures that force AA stacking faults in sp^{x} networks are adequately present in carbon black to force electronic decoupling, and that this electronic decoupling is again improved by reducing out-of-plane acoustic phonon perturbations.

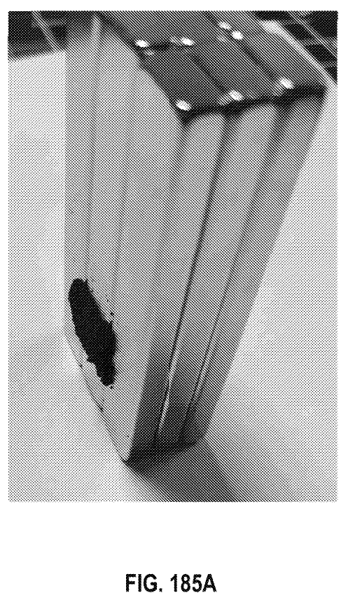

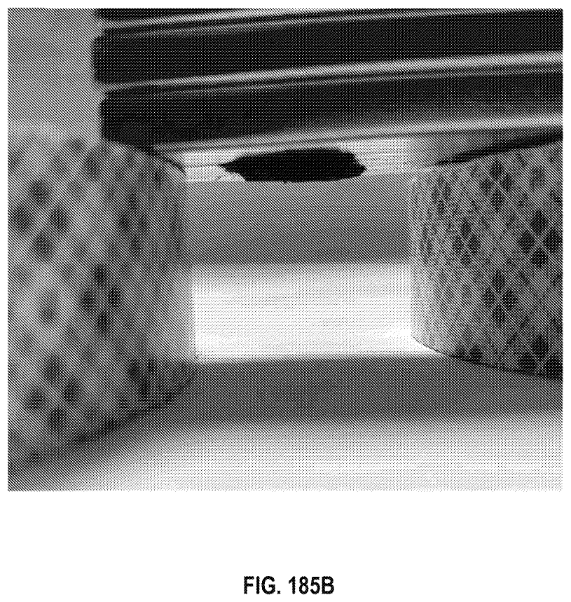

In Test VI, the response of sp^{x} networks to a strong neodymium magnet under low pressure conditions were investigated to demonstrate flux pinning. A mound of powder of Sample G₁ was placed on top of a “magnetic base” made from 9 neodymium bar magnets (N52 Grade with dimensions of each bar 60 mm×10 mm×5 mm). The 9 bars were arranged in a 3×3 formation to create the magnetic base. This magnetic base along with the sample was located centrally on the platform within the vacuum chamber of the microwave system. Microwave irradiation was not used in Test VI; the chamber was only used to achieve low pressure. The vacuum chamber was vacuumed down to 10 torr. After maintaining 10 torr with the sample on the magnetic base for 2 minutes the chamber was backfilled with air to gradually bring it up to atmospheric pressure. Once at atmospheric pressure, the chamber was opened, and the sample and magnetic base were taken out. On inclining the magnetic base to allow the sample to be collected it was observed the sample did not move. The magnetic base and powder were oriented vertically as shown in FIG. 185A and the sample remained in place. The magnetic base and powder were oriented as shown in FIG. 185B with the sample completely unsupported and the sample continued to remain flux-pinned to the magnetic base. Even at approximately 1 atm and a temperature of approximately 300 K, flux pinning is observed. This indicates penetration of the magnetic field and Type II superconductivity under ambient conditions of temperature and pressure.

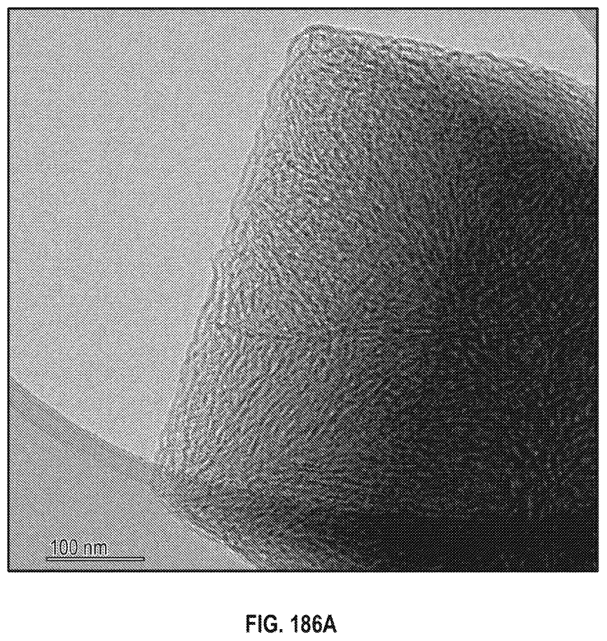

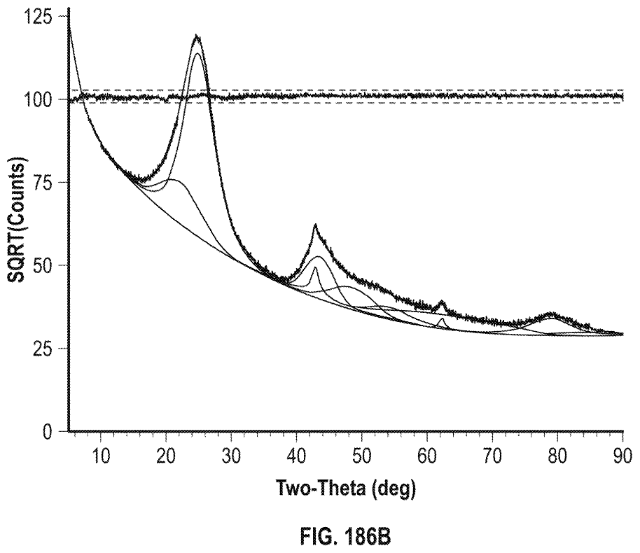

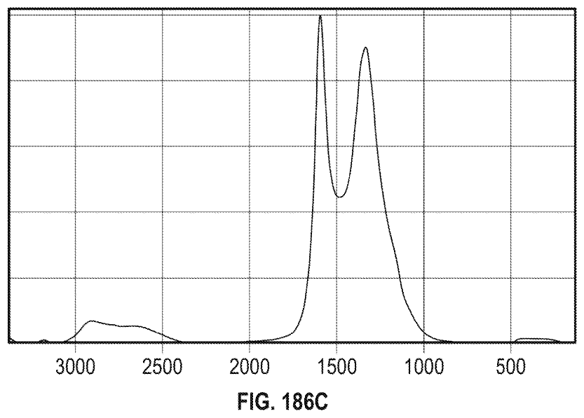

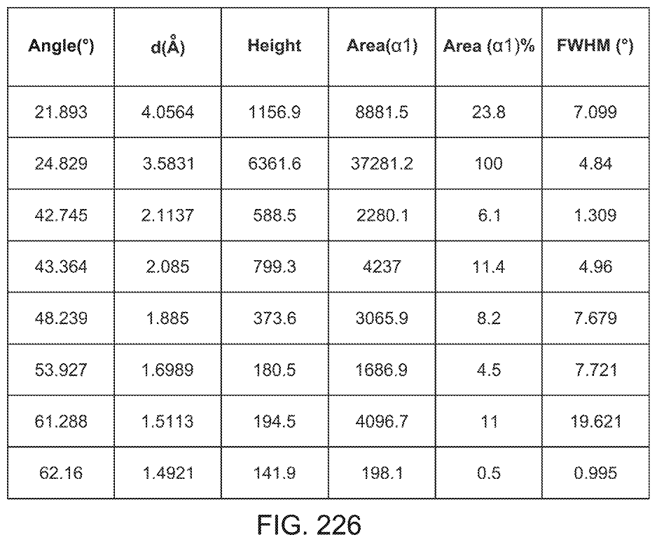

A TEM micrograph demonstrating a typical perimorphic framework from Sample G₁ is shown in FIG. 186A. The multilayer walls were rigid, and the native mesoporous architecture was retained throughout processing. The XRD profile of Sample G₁ is shown in FIG. 186B. FIG. 226 contains the XRD peak angles, d-spacings, areas, area percentages (normalized to the area of the dominant peak at 2θ=24.829°), and full-width half max values (without correction for instrument broadening). Like the other anthracitic networks we have described, Sample G₁ exhibits nematically aligned layers. The main peak at 2θ=24.829° corresponds to a <002> interlayer d-spacing value of 3.58 Å. Additionally, we see a fitted peak at 2θ=21.893°, corresponding an expanded interlayer spacing of 4.06 Å. This is likely a result of slight bowing, given the indications of intralayer compression in the <100> peak position at 2θ=43.364°.

Intralayer compressive strain was also in the Sample G₁'s red-shifted Gᵤ peak position of 1594 cm⁻¹. Its average Dᵤ peak position was 1333 cm⁻¹, with point spectra exhibiting Dᵤ peaks as low as 1327 cm⁻¹, indicative of a highly grafted x-sp^{x} network with predominately cubic diamondlike seams, from which we can conclude AA stacking. The average Raman spectrum is shown in FIG. 186C.

Hence, in Study G, we demonstrate ambient superconducting powders comprising pyrolytic carbons with electronically decoupled layers, and we demonstrate that the superconducting state at the atomic monolayer limit is disrupted under ambient conditions by gas-surface collisions. We theorize that the out-of-plane acoustic phonons created by these collisions disrupt the electronic decoupling of the atomic monolayers in these pyrolytic carbons, whereas this decoupling is otherwise obtained by AA stacking faults forced by the diamondlike crosslinks. The same crosslinks pin the layers together and enforce these high-energy stacking faults, which persist where otherwise they might be minimized upon relaxation of the bilayers.

In Study G, an ambient superconducting powder exhibits both diamagnetic and flux-pinning responses to magnetic fields, indicating a Type II superconductivity. Testing at different pressures ranging from 720 to 10 torr indicate a continuum of strengthened superconductivity as gas-surface collisions are reduced and superconducting pathways are lengthened. The persistence of flux-pinning responses upon returning the powders to ambient pressure indicates that the process of evacuation has modified the particles. In Study H, we observe a similar phenomenon, which is temporary and appears related to the persistence of an internally evacuated state in some nearly impermeable regions of the porous particles for some minutes after evacuation. Reduced permeability in some regions inside the particles and granules is to be expected especially in those samples in which template-directed CVD was utilized, the endomorphic templates were extracted, and carbon-catalyzed CVD growth was then performed again on the porous perimorphic frameworks. We expect that this would begin to close many of the framework's internal pores.

### XV**. Study H—Analysis

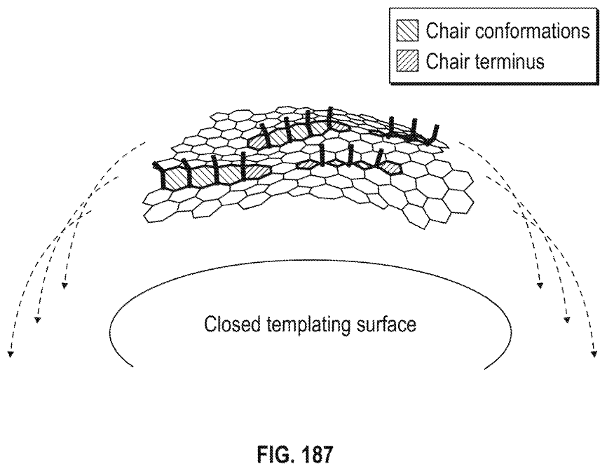

Study H was performed to demonstrate that practical, macroscopic ambient superconductors could be made. Guiding Study H was our hypothesis that the size of superconducting grains in pyrolytic carbons was correlated with the size of their sp² ring-connected regions. In Study G, the sp² ring-connected graphenic regions of the microscopic particles in Sample G₁ were likely on the same size scale as the particles themselves. In other words, the templating surface of a microscopic template being a closed surface, the sp^{x} network formed around that templating surface should comprise a ring-connected network with sp^{x} layers that would be similarly closed and sp² ring connected with respect to themselves. FIG. 187 is a model of the lateral cross-section of a hypothetical sp^{x} network. The sp^{x} rings are diagonally pattern-filled, while the sp² rings are white. As shown in this model, if growth of an sp^{x} layer around the templating surface is completed, the layer will be laterally crosslinked around the whole templating surface and will itself represent a closed surface.

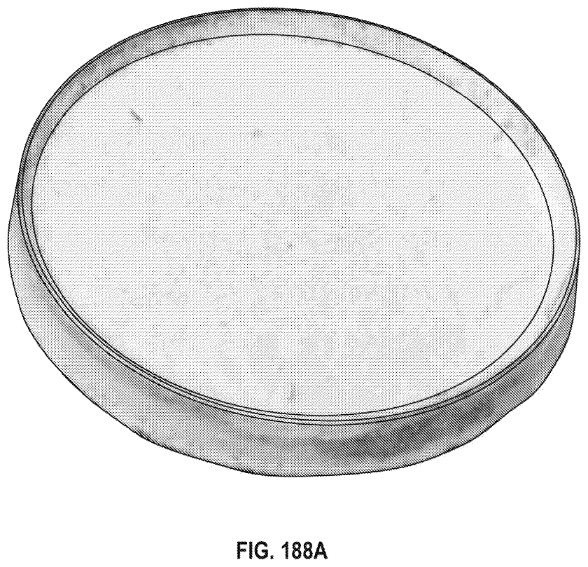

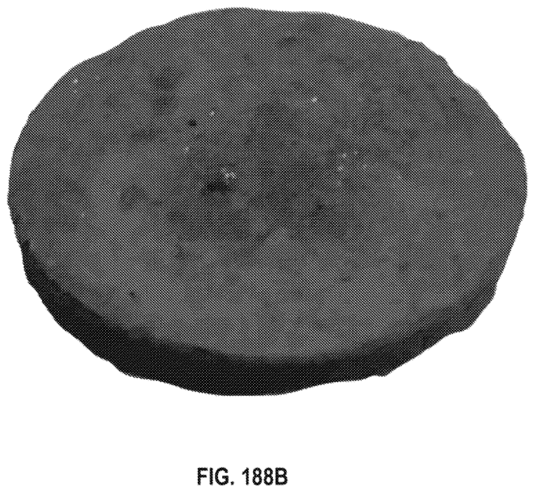

In Study H, our objective was to generate a macroform approximating a single ring-connected sp^{x} network, with each completed sp^{x} layer of this network exhibiting sp² ring-connectedness with respect to itself over macroscopic lengths. Complicating this was the possibility of fracturing the macroscopic sp^{x} network after its creation, which would introduce sp² edge states in the sp^{x} layers. Based on concerns that this might happen during template extraction, we did not extract the endomorphic MgO, but simply created the mesoporous perimorphic composite according to Procedure H and then tested it. The endomorphic MgO pellet is shown in FIG. 188A, while the associated perimorphic composite is shown in FIG. 188B.

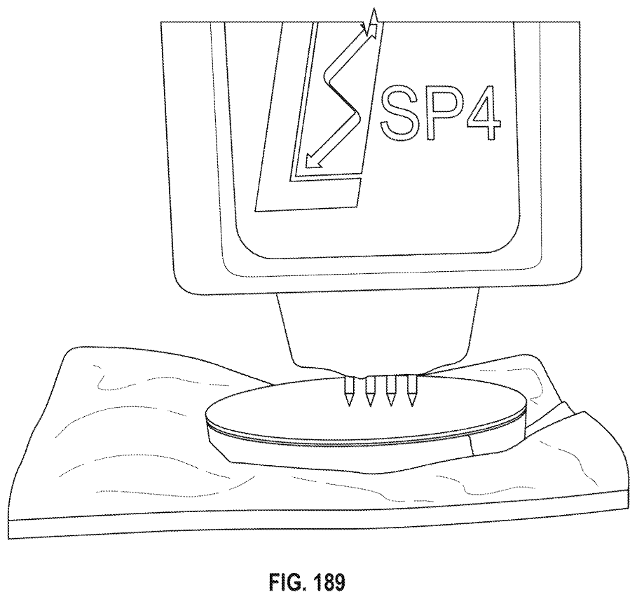

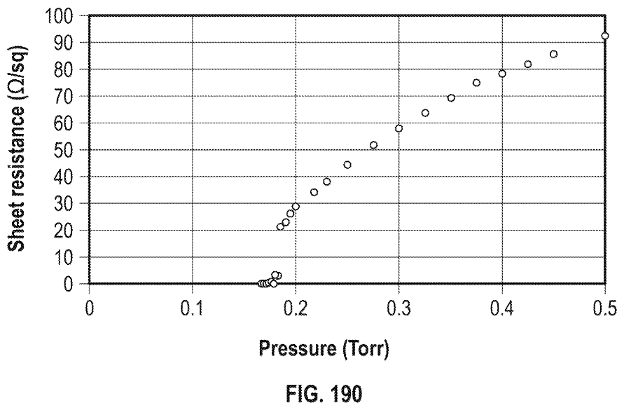

In Test I of Study H, the macroform's initial sheet resistance upon stabilizing the 4-point probe measurement was 157 Ω/sq. The basic setup of the 4-point probe with a sample and a non-conducting pad beneath the sample is shown in FIG. 189. The temperature in the laboratory was approximately 17° C. and the relative humidity was 38%. The vacuum chamber was then sealed and evacuated to a final pressure of 167 mTorr, with continuous monitoring of the sample's sheet resistance. It was observed that the sample's sheet resistance fell according to the natural logarithm of the chamber pressure. At several points, instantaneous, large drops in resistance were observed, including a drop from 21 Ω/sq to approximately 3 Ω/sq between 185 and 183 mTorr, followed by another sudden drop from 3 Ω/sq to approximately 0.004 Ω/sq at 178 mTorr. This may indicate the growth and percolation of superconducting grains, or it may have been triggered by the Sourcemeter automatically increasing the current as the measured resistance fell below 20 Ω/sq. The pressure vs. resistivity data and the natural logarithm function fitting the data are shown in FIG. 190. The sheet resistivity stabilized temporarily at 0.004 Ω/sq before rising back to approximately 0.20 Ω/sq and fluctuating between 0.20 Ω/sq and 0.22 Ω/sq. During repressurization of the vacuum chamber to 1 atm, which occurred over a period of several minutes, the sheet resistance remained stable at 0.22 Ω/sq.

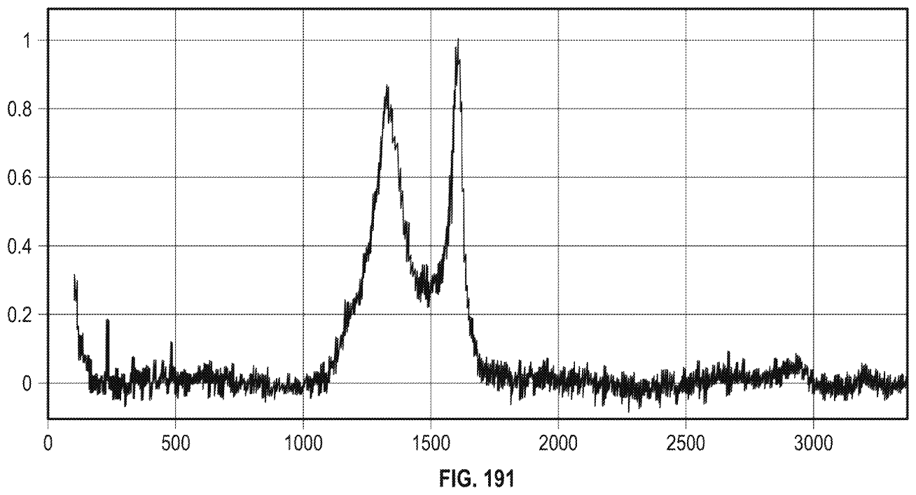

Following this, the door of the chamber was opened, and the 4-point probe was removed from the sample. Upon removal of contact, the multimeter showed an “Overflow” reading. The 4-point probe was then placed back into contact with the sample, and the reading was again 0.22 Ω/sq. Next, the sample was left for 20 to 30 minutes, after which the sheet resistance measured via the 4-point probe had returned to 157 Ω/sq. This indicates a temporal dependence of the sheet resistance. Raman spectral analysis of the sample revealed no changes from prior to the test. The Raman spectrum is shown in FIG. 191. The Dᵤ peak position of 1326 cm⁻¹ indicates an x-sp^{x} network with diamondlike seams crosslinking the layers.

Performing a number of tests like this on different macroforms, we found that the sheet resistance consistently decreased according to the natural logarithm of the pressure. However, we expect that the sheet resistance's dependency was actually on the pump-down time, which was unmeasured. During pump-down of the vacuum chamber, any diffusion constraints on the outgassing of the porous macroform would be expected to create a temporal dependence of the sheet resistance. This temporal dependence was verified other in experiments by pausing the pump-down and observing that sheet resistance continued to fall even with constant or increasing vessel pressure. This is strong evidence that, for a mesoporous pyrolytic carbon or anthracitic network, the room-temperature ability to form a Bose-Einstein condensate is determined by the pressure inside the particles' pores—i.e. the collision frequency of gas molecules with surfaces inside the macroform.

When growing pyrolytic carbons on an MgO template—and especially when growing on a macroscopic template, as we did in Study H—the differential contractions of the perimorphic carbon and endomorphic MgO phases during cooling can lead to mechanical stresses and either nanoscopic or microscopic fracturing of the sp^{x} network. Indeed, it is likely that fine fractures from cooling of perimorphic composites synthesized at high temperatures may be what facilitates endomorphic extraction for template-directed CVD processes in general. Performing a second deposition procedure appears to mend any fractures originating from the first cooling. Damaged sites in the sp^{x} network with sp² edge states become the nuclei for new FRC growth and are healed via sp² and sp³ re-grafting of these regions, or “mending.” Other possible ways to reduce the present of fractures from cooling is to grow a thicker perimorphic phase and to cool the macroscopic perimorphic composite slowly and uniformly.

Utilizing this “mending” technique, other types of pyrolytic carbon particles most notably carbon black particles, glassy carbons derived from organic precursors, anthracite, coal, activated carbon, or some combination thereof-could similarly be grafted to one another to create sp^{x} macroforms. These disordered seeds act as nuclei for FRC growth, which leads to the ring-disordered lattice formation, tectonic encounters and associated grafting structures that have been demonstrated throughout the present disclosure. This mending technique should eliminate sp² edge states and ring-connect the individual pyrolytic carbon particles or networks, causing them to coalesce. Mending these particles or networks at reduced pressure with no inert carrier gases may minimize any trapped gas left behind in sealed-off pores.

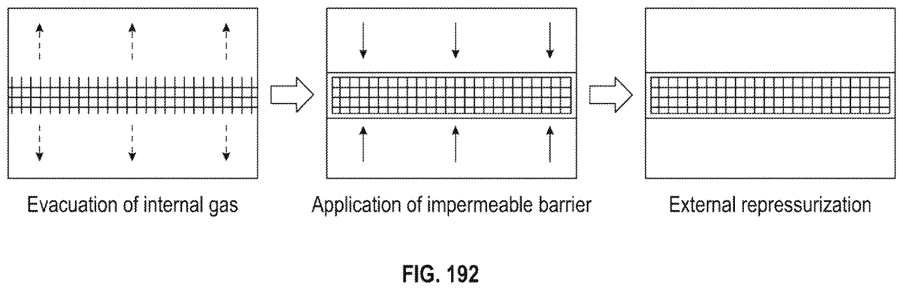

Having established the importance of evacuating any internal gases, and the ability of an internally evacuated sample to form a Bose-Einstein condensate at ambient temperature and pressure, a barrier phase may be applied to the outside of the evacuated macroform in order to prevent reentry of gas molecules. Utilizing an approach like this, ambient superconducting articles of arbitrary macroscopic length, such as filaments, may be fabricated. FIG. 192 demonstrates the basic approach to producing such an article, which can be divided into three stages. First, a porous article (FIG. 192 represents a filament-type article) is generated via a pyrolysis procedure. Next, any gas present within the porous article is outgassed. Lastly, while still in the evacuated state, the article can be sealed via application of an impermeable barrier phase. The barrier phase may be applied via deposition, spray-coating, or some other conventional method. The evacuated and sealed article can then be utilized at ambient external pressure and temperature. This capability is demonstrated in Study H by the persistent superconducting state of the temporarily evacuated article even after opening the vacuum chamber.

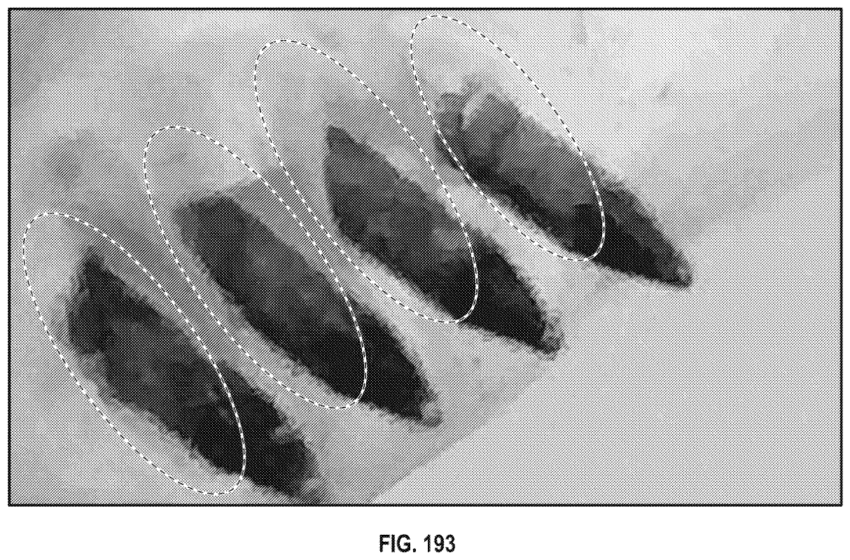

Study H corroborated the observations in Study G, wherein particle-scale, ambient superconductivity was achieved. However, in Study H we were able to measure directly the decline in resistance with reducing pressure, directly corroborating the Meissner Effect and flux-pinning observed in the pyrolytic carbons of Study G. Moreover, Study H showed that at room temperature, it is possible for a porous, ambient superconductor to remain superconducting at ambient temperature and pressure conditions, so long as its pores are evacuated. We strongly suspect that the measured resistance of 0.004 Ω/sq and then subsequently 0.22 Ω/sq may not have actually been attributable to the sample as produced but may have instead been related to massive heating of the probe tips, thereby heating the contact region of the sample above its critical temperature. Other signs of heating caused by the probe tips were observed, including melting of the plastic housing (FIG. 193, with observed melted areas near the probe tips circled) next to the tips. This heating might have resulted from the increasing current being supplied by the Sourcemeter as the sheet resistance of the sample fell. Joule heating in the probe tips under vacuum appears to have led to extreme heating precisely at the point of resistance measurement.

Further improvements to the material should be readily achieved via techniques known to those skilled in the art. For example, doping the material to increase the charge carrier density should be readily achievable. Using an organic precursor, such as a polymeric binder, to bind the individual graphenic networks to one another, followed by pyrolyzing the binder and “mending” the networks may improve the ring-connectedness of macroforms. Importantly, the fabrication of infinite, sheet-like or filament-like ambient superconducting articles using roll-to-roll techniques should be possible via the basic approach of evacuated and then sealing the articles with a barrier phase, as we have described.

### XVI**. Other Anthracitic Networks

In the '760 Application we demonstrated the formation of perimorphic frameworks comprising graphenic structures such as hexagonal BN and BCₓN. HR-TEM analysis of these networks reveals that they comprise anthracitic networks that are cohered via crosslinking dislocations, including Y-dislocations, screw-dislocations, and mixed dislocations. These materials, which are formed in a way analogous to the FRC growth of carbon, undergo the same mechanics of tectonic encounters and grafting, which in turn lead to the same anthracitic networks.

FIG. 13C is an HR-TEM image of a perimorphic framework comprising BN, which was produced according to a procedure described in the '760 Application. The close retention of the templated morphology after extraction of the endomorphic MgO template indicates good structural integrity of the perimorphic wall. At closer magnifications, we are able to observe the individual graphenic layers. Y-dislocations are present, as shown in the HR-TEM image in FIG. 13D. The Y-dislocations are traced. In FIG. 13E, we can also observe screw dislocations, again traced. The presence of these sp^{x} Y-dislocations and sp² screw dislocations indicates that the BN comprises an anthracitic network in an intermediate state of maturation, where screw dislocations have formed from some of the less stable Y-dislocations. The structural similarities between the BN anthracitic network shown here and the carbon anthracitic networks shown elsewhere in the present disclosure demonstrate the generality of the methods and materials described herein.

Reference C: Detailed Description from the '154 Application

This disclosure explores how two features (i.e. catalytic activity and solid-state stability) that make refractory metal oxide templates desirable for CVD surface replication procedures can be fulfilled by novel templates that are more soluble. Specifically, we demonstrate templates in which a more soluble “templating bulk” phase and a catalytically active, substantially solid-state “templating surface” phase (as both terms are defined in the '918 Application) are combined.

The following detailed description is organized according to the following sections:
I***. Terms and Concepts
II***. Analytical Techniques & Furnace Scheme
III***. Experiments and Analysis

### I***. Terms and Concepts

“High-solubility,” as defined herein, describes a material that can be either dissolved in deionized water to form a solution with a concentration of 5 g per liter, or reacted with deionized water to form a compound that can be dissolved in deionized water to form a solution with a concentration of 5 g per liter.

A “high-solubility template” is defined herein as a template structure that fulfills the following requirements: (1) the “templating surface” (as defined in the '918 Application and the '760 Application) remains substantially solid-state during vapor deposition growth of a perimorphic wall; (2) the templating surface comprises a catalytic component that enables the growth of a perimorphic wall; and (3) the template material is a high-solubility material.

A “catalytic component” is defined herein as a component of or on the templating surface capable of catalyzing the decomposition of a reactive gas and enabling the conformal growth of a perimorphic wall over the templating surface. Without a catalytic component, no perimorphic wall may be formed over the templating surface during vapor deposition. The catalytic component may be defects (e.g. step sites on metal oxide templating surfaces). A catalytic component may also comprise an adsorbate on the templating surface.

“Oxyanionic templates” are defined herein as templates that are solid-state under CVD conditions and comprise an oxyanionic compound. It is noted that an oxyanionic template may also be referred to as a “basic oxyanionic template” if it contains oxygen anions. Basic oxyanionic templates may result from partial decomposition of an oxyanionic precursor material.

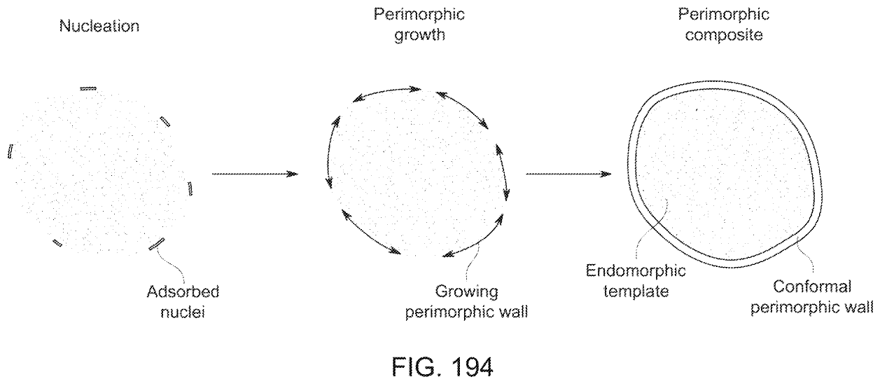

FIG. 194 is an illustration of a perimorphic growth sequence on a seeded template. Initially, as illustrated on the left, a seeded template structure comprises a noncatalytically active compound and seeds decorated on the template surface. From these seeds, the perimorphic wall is grown to completion during CVD surface replication.

CVD growth using high-solubility templates proceeds in a similar fashion to CVD growth on metal oxide templates. Namely, the perimorphic wall grows via dissociative adsorption of reactive gas molecules at catalytic sites on the templating surface. The perimorphic wall may then grow over the templating surface, substantially encapsulating the endomorphic template and resulting in surface replication, as described in the '918 Application and the '760 Application. Optionally, the perimorphic wall may have a layered architecture comprising two-dimensional lattices. The endomorphic template may then be extracted via dissolution in a liquid. Endomorphic extraction may result in a perimorphic framework with a simple or complex cellular morphology, depending on the geometry of the templating surface.

It is to be understood that, in practice, just like the template variants that have been described in the '918 Application and the '760 Application, high-solubility templates may take on a number of different shapes and sizes, these shapes and sizes often being determined by the process used to create the template material or a template precursor material form which the template is derived. The template's morphology may be retained after endomorphic extraction by the perimorphic framework formed around it, provided the framework is sufficiently rigid and strong. Such a framework is said to have retained its native morphology, as described in the '918 Application and the '760 Application. Alternatively, the framework may be deformed or fragmented after endomorphic extraction, resulting in a non-native morphology. In either case, the template's morphology may be an important consideration.

### High-Solubility Template Considerations

A template initiates perimorphic growth over the templating surface via adsorption. From the initial adsorbate, the perimorphic wall may be grown via deposition. Perimorphic growth via deposition may beneficially occur via “autocatalyzed” or free radical condensate growth, wherein the perimorphic material itself reacts with gas-phase adsorbates during deposition, and therefore it is desirable for the template to remain solid-state under conditions in which this mode of perimorphic growth occurs.

Once the perimorphic wall has been formed, the endomorphic template should be able to be extracted. It is beneficial if this can be accomplished using aqueous liquid-phase processing. It can be beneficial for the template to be reacted with water or dissolved in water to form solutions of reasonably high concentrations of the solute. It is further beneficial if these solutions may then be used to form new template structures with acceptable and well-controlled morphological features, as discussed in the '918 Application and the '760 Application.

To meet these many requirements for each of the many applications that might be encountered, it is helpful to have a diverse portfolio of template materials. A new category of solid-state, high-solubility templates are especially useful members of a portfolio due to the ease with which they may be dissolved in water during endomorphic extraction and reconstituted in well-controlled morphologies via precipitation processes.

### Mechanisms for Catalyzing Perimorphic Growth

In this section, we explore nucleation and growth mechanisms for perimorphic carbons from hydrocarbon gases on metal oxide templates, a specific type of surface replication for which a literature exists, and use this literature as a basis for understanding surface replication phenomena in the high-solubility templates disclosed herein. It is to be understood that the following discussion is not meant to be exhaustive. Nucleation and growth mechanisms are not comprehensively characterized even in the case of perimorphic carbons grown on metal oxide templates. Several different nucleation mechanisms may occur simultaneously, further complicating analysis. Any nucleation or growth mechanism, whether fully characterized herein or not, should be considered within the scope of the present disclosure.

It has been found that nucleation on metal oxide surfaces occurs at high-energy surface defects (e.g. step-sites). On other templates, nucleation mechanisms are different. For example, nucleation on metallic templates may require carbon to be dissolved into the metal, then precipitated. Nucleation on metal halide templates may require molten surfaces where inelastic collisions with gaseous molecules occur. Surface defects on the solid-state surfaces of NaCl templates, for instance, have been observed to be catalytically inactive. Therefore, it has been demonstrated that the surface defect-catalyzed mechanism is not universal; in fact, other than our own recent work in the '916 Application, where perimorphic growth was accomplished on oxyanionic templates, the surface defect mechanism has only been observed on metal oxides or metalloid oxides.

### II***. Analytical Techniques and Furnace Scheme

Thermogravimetric analysis (TGA) was used to analyze the thermal stability and composition of materials. All TGA characterization was performed on a TA Instruments Q600 TGA/DSC. A 90 μL alumina pan was used to hold the sample during TGA analysis. All analytical TGA procedures were performed at 20° C. per min unless otherwise mentioned. Either air or Ar (Ar) was used as the carrier gas during analytical TGA procedures unless otherwise mentioned.

Raman spectroscopy was performed using a ThermoFisher DXR Raman microscope equipped with a 532 nm excitation laser. For each sample analyzed, 16 point spectra were generated using measurements taken over a 4×4 point rectangular grid. The normalized point spectra were then averaged to create an average spectrum, with a rare point spectrum being excluded from the average due to a poor signal at that location. The Raman peak intensity ratios and Raman peak positions reported for each sample all derive from the sample's average spectrum. No profile fitting software was utilized, so the reported peak intensity ratios and peak positions relate to the unfitted peaks pertaining to the overall Raman profile.

The furnace scheme utilized for all experiments was as follows. The furnace used was an MTI rotary tube furnace with a maximum programmable temperature of 1200° C. The furnace had a 60 mm quartz reactor tube with a gas feed inlet. The opposite end of the tube was left open to the air. The furnace was kept level throughout deposition. Experimental materials in powder form were placed in ceramic boats, and the boats were placed in the center of the quartz tube (in the furnace's heating zone). The quartz tube was not rotated during deposition.

### III***. Experiments and Analysis

Five experiments are described below. For each of these experiments there are unique template precursor materials, template materials, perimorphic composite materials, and perimorphic materials. For exemplary purposes, perimorphic carbons were formed on these templates.

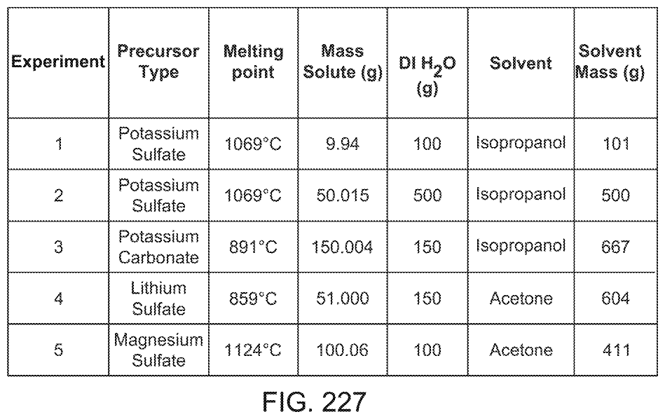

The template precursor materials include potassium carbonate (Experiments 1 and 2), potassium sulfate (Experiment 3), lithium sulfate (Experiment 4), and magnesium sulfate (Experiment 5). To produce these precursor materials, commercially sourced potassium carbonate, potassium sulfate, lithium sulfate, and magnesium sulfate powders were first dissolved in H₂O. Either isopropanol or acetone was then added dropwise while stirring to induce precipitation of the solute. The precipitate was filtered and then dried. FIG. 227 presents the specific details of each run.

Note that the template precursor materials in Experiments 1 and 2 comprise the same compound (K₂SO₄). These precursor samples differed only with respect to the batch size, with the batch size in Experiment 2 being roughly 5 times larger than the batch size in Experiment 1.

In the next stage of the experiments, each of the template precursor samples was placed in a furnace according to the furnace scheme described in Section II. Each precursor powder was then heated to the CVD temperature under a 1100 sccm flow of Ar, whereupon C₃H₆ flow was commenced. The powder at this temperature, and under this atmosphere of flowing Ar and C₃H₆, comprised the template material.

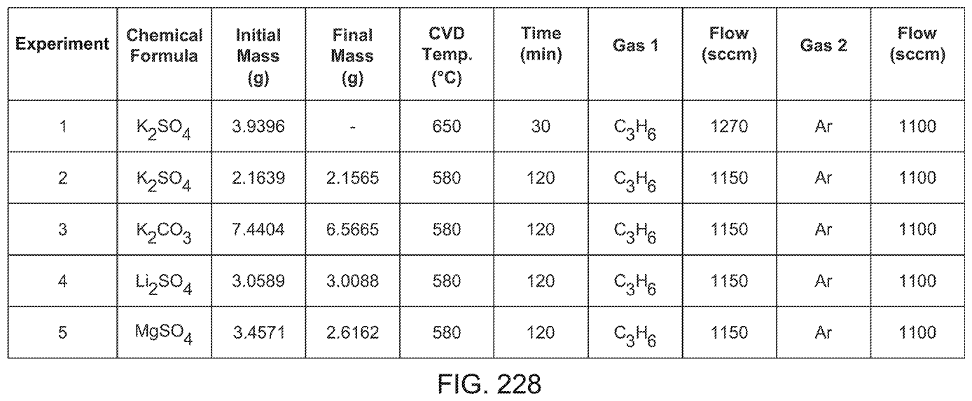

During CVD, perimorphic composite materials were formed by nucleating and growing perimorphic carbon on the templating surfaces. Similar CVD surface replication procedures have been described in the '918 Application. In each case, the CVD temperature was at least 279° C. below the melting point of the template precursor material, and no signs of melting were observed at any time. Therefore, we can conclude that each of the templates was substantially solid-state throughout CVD. Experimental parameters during CVD were according to FIG. 228.

As shown in FIG. 228, CVD parameters were similar for all experiments except Experiment 1 (K₂SO₄). For Experiment 1, the flow rate for C₃H₆ is significantly higher (1270 sccm) than it was for Experiments 2 through 5. The flow rates were changed to test deposition conditions under different chemical environments and different exposures. Experiment 1 was also run at a higher temperature (650° C.), but for a shorter duration (i.e., 30 minutes, as opposed to 120 minutes). Experiments 2 through 5 were run at 580° C. for 120 minutes, using a C₃H₆ flow rate of 1100 sccm. The resulting perimorphic composite powders, comprising both an endomorphic template phase and a perimorphic carbon phase, were weighed for comparison with the initial mass of the template precursor powder prior to heating. The final mass is the mass of the perimorphic composite, comprising both the endomorphic template and the perimorphic carbon.

In each experiment, the powder retrieved from the furnace had nucleated and grown a carbon perimorphic wall. This confirms that nucleation occurred. Since each of the templates was solid-state, any nucleation that occurred on the templating surface was unrelated to melting. Nucleation due to absorption or dissolution of carbon in these non-metallic templates can also be ruled out. We therefore attribute nucleation to surface defects, as has been observed for metal oxide templates.

The exact nature of the surface defect sites in these oxyanionic templates is not well characterized at this point, and the precise degree to which the templates were purely oxyanionic in chemical composition or may have been basic oxyanionic templates due to minor levels of decomposition is not fully characterized. However, given the extremely small mass losses that were recorded for the anhydrous sulfate samples in Experiments 1, 2, and 4, some of which loss can be attributed to adsorbed water, and given additionally that some of these sulfates melt prior to thermally decomposing (e.g. Li₂SO₄), and lastly given the almost negligible mass contribution of perimorphic carbon (the perimorphic wall comprising only a few graphenic layers), we can conclude that the extent of any decomposition was minor. For instance, K₂SO₄ thermally decomposes around 750° C. in the presence of a carbon reducing agent. While it possible that some minor decomposition occurred at 580° C., the templates in Experiment 1 and 2 were substantially K₂SO₄ in terms of chemical composition.

Endomorphic extraction of the templates from the perimorphic composite structures was performed in each experiment by dissolving the template in water, which was accomplished easily in small volumes of water, further corroborating the high-solubility composition of the oxyanionic templates. The resulting perimorphic frameworks were then rinsed to minimize residual ions upon drying. At this stage, an immiscible solvent might also be utilized to separate the perimorphic carbon from the aqueous process liquid in order to reduce or eliminate the need for rinsing, as described in the '918 Application and '760 Application.

SEM analysis was performed to provide a general understanding of the template and perimorphic carbon materials. Specifically, we analyze the template precursor material, perimorphic composite material, and perimorphic carbon material from Experiments 1 and 5. For the sake of brevity, and because the present disclosure focuses on the ability to synthesize the perimorphic material on the template, rather than on each template's specific morphological features (which will vary substantially not only based on the precipitation process, but also based on the thickness of the perimorphic walls), we do not report SEM analysis for all of the samples.

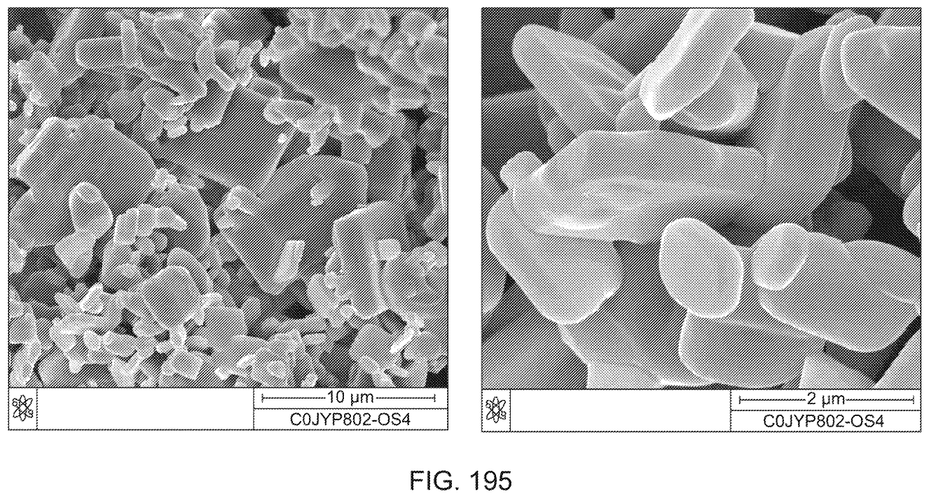

FIG. 195 includes SEM images showing the template precursor powder used in Experiment 1. The powder comprises some morphological variety, with some crystals adopting a cuboidal morphology, others adopting an equiaxed polyhedral morphology, and still others adopting a slab-like, nearly platelike morphology. Many of the particles are polycrystalline agglomerates.

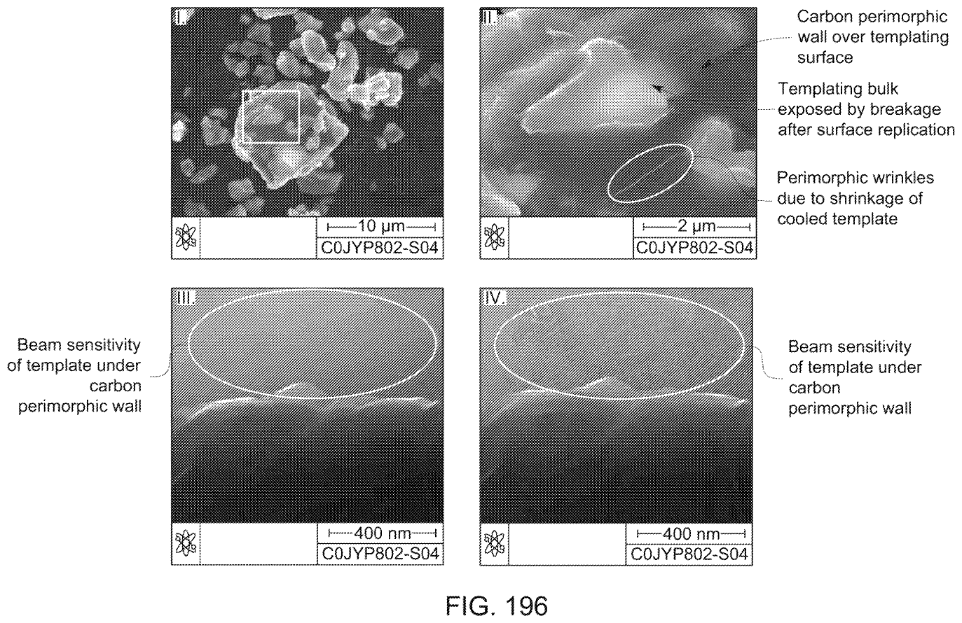

FIG. 196 includes SEM images showing the perimorphic composite material from Experiment 1 prior to endomorphic extraction. In Frame I, an SEM image shows the perimorphic composite particles. Many of the particles appear to have broken at junctions after the CVD procedure. In these regions, where the underlying oxyanionic template is not covered with a carbon perimorphic wall, more charging under the electron beam occurs due to the insulating behavior of the template. The inset in Frame I is shown in the SEM image in Frame II. An exposed region of the underlying template at a broken junction can be distinguished from the surrounding regions due to its flat, charging surface. The darker areas around this exposed region represent areas in which the template is covered by the perimorphic wall. The presence of a flexible perimorphic wall can also be distinguished in Frame II by wrinkling, which can be attributed to shrinkage of the underlying template during cooling. At higher magnifications, the template underneath the perimorphic wall becomes beam sensitive, and this sensitivity with prolonged exposure can be seen in the SEM images in Frames III and IV. This beam sensitivity has never been observed in metal oxide templates and may be attributable to decomposition on or near the templating surface.

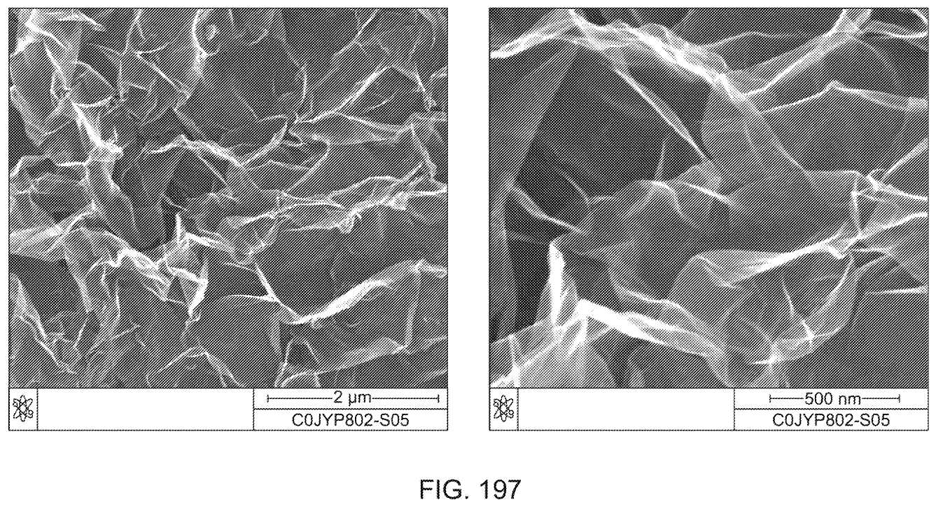

FIG. 197 includes SEM images at two high-magnification levels of the perimorphic frameworks from Experiment 1 after endomorphic extraction, rinsing, and drying. Consistent with the flexibility evident in the wrinkles in the carbon perimorphic walls shown in Frame II of FIG. 196, the perimorphic frameworks appear to have crumpled and adopted a non-native morphology after endomorphic extraction. It is noted, however, that many of the frameworks appear substantially unbroken and do not show extensive fragmentation. Therefore, they are likely “deflated” frameworks. Over numerous experiments we have observed that many such deformed frameworks are deformed elastically and may relax back into their native, “inflated” morphology when filled with liquids. This is a useful attribute for many applications (e.g. absorption). Alternatively, these structures may be subjected to milling or high shear to produce large, sheet-like fragments, similar to nanoplatelets.

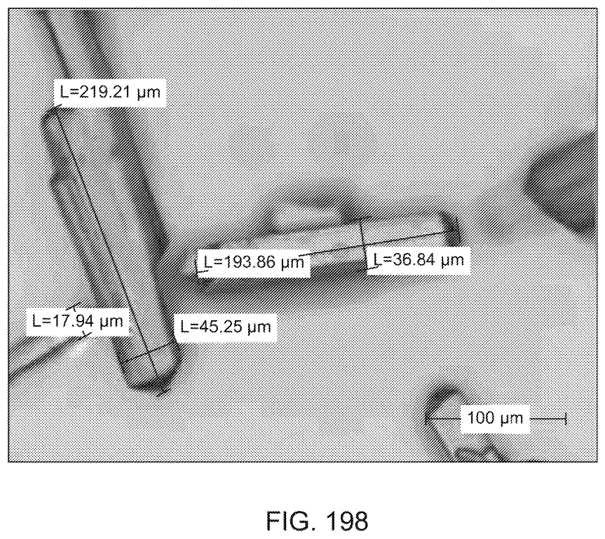

FIG. 198 shows the precipitated template precursor structures produced in Experiment 5 under optical microscope. These have also been reported in the '918 Application. The morphology is elongated and crystalline. Many of the particles are polycrystalline agglomerates.

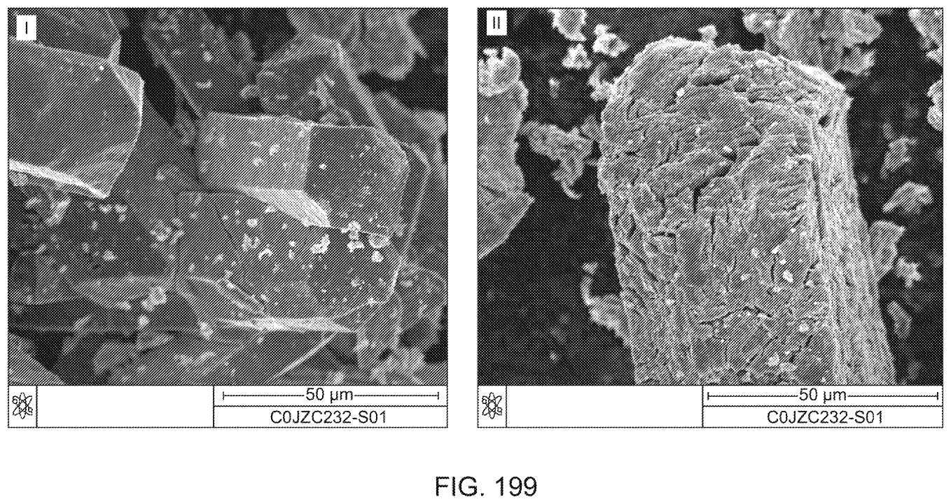

FIG. 199 includes SEM images showing the perimorphic composite material from Experiment 5 prior to endomorphic extraction. In Frame I, an SEM image shows the perimorphic composite particles. Debris can be seen on the surface of the perimorphic composite particles. This may be a result of shattering during dehydration. Dehydration of epsomite has been shown to cause fractures as crystalline water is evacuated. Based on SEM analysis of this perimorphic composite material, the epsomite template precursor (MgSO₄·7H₂O) particles precipitated in Experiment 5 fractured during dehydration. While most particles were fractured to some extent, some particles appear more fractured than others. One such highly fractured particle is shown in Frame II of FIG. 199.

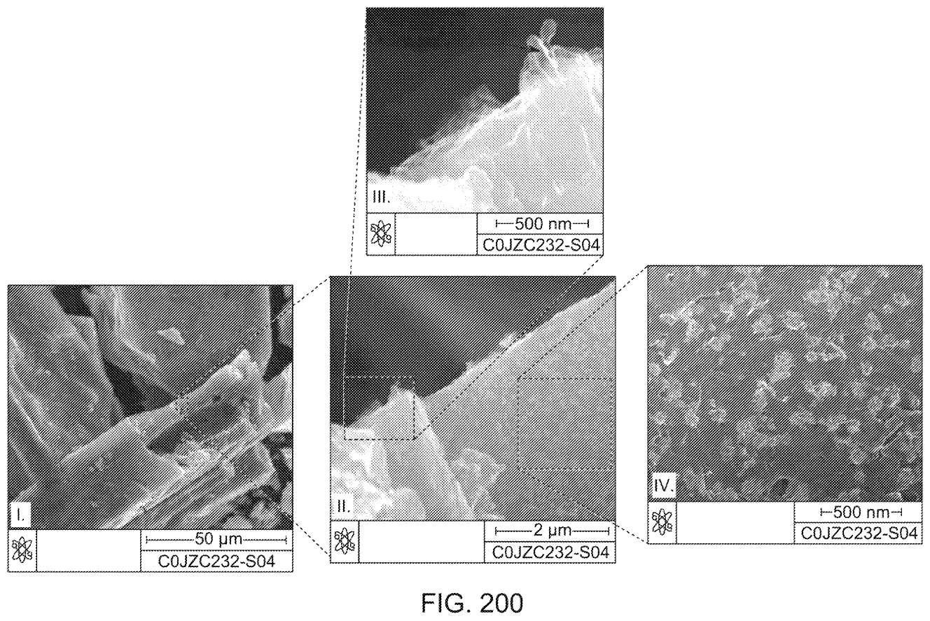

FIG. 200 includes SEM images showing the perimorphic frameworks from Experiment 5 after endomorphic extraction, rinsing, and drying. Unlike the frameworks produced in Experiment 1, these frameworks have substantially retained their native morphology and resemble the perimorphic composite structures. This can be discerned in the elongated carbon structures shown in Frame I of FIG. 200.

The inset of Frame I of FIG. 200 is shown at higher magnification in the SEM image in Frame II. Here, two phases are apparent. The first phase is the perimorphic carbon, the porosity of which can be discerned at higher magnification in Frame III. The translucent appearance of the perimorphic walls indicates a thickness of no more than several nanometers.

The second phase, which can be discerned at higher magnification in Frame IV, is residual MgSO₄ on the surface of the perimorphic frameworks. The MgSO₄ residue charges under the electron beam. The presence of this residue can be explained by the high solute concentration of the aqueous solution created during endomorphic extraction of the high-solubility oxyanionic template, as well as the large amount of retained water in the three-dimensional perimorphic frameworks. Even after rinsing, the framework contained a significant amount of dissolved MgSO₄ that left a ubiquitous residue upon drying. This residue was not observed in Experiment 1 since the voluminous pores with in the perimorphic frameworks were collapsed and less water was retained in them.

Rinsing problems and the voluminous liquid waste streams associated with endomorphic extraction were noted previously in the '918 and '760 Applications. To alleviate this, a solvent-solvent separation was demonstrated to displace the detained aqueous solution held within the perimorphic carbons with an immiscible solvent. This separation technique may be especially beneficial when using a high-solubility template like MgSO₄ that can form concentrated solutions (up to 35 g dissolved per 100 mL at room temperature) upon endomorphic extraction.

The perimorphic frameworks produced in Experiment 5, while their walls were only a few nanometers in thickness, demonstrated a superior ability to retain their native morphology than the frameworks produced in Experiment 1. This is attributable to the compactness and associated rigidity of the cellular substructures of the frameworks produced in Experiment 5. Namely, surface replication techniques that utilize nonporous templates, or templates with no nanoscopic pores, will result in a less compact architecture than surface replication techniques that utilize templates with finer pore structures. In the case of Experiment 5, the MgSO₄ templates had finer internal pore structures due to the escape of crystalline water from the epsomite template precursor particles during heating. This is reflected in the substantial mass loss observed after thermal exposure, as shown in FIG. 228. In the case of Experiment 1, the K₂SO₄ was anhydrous, and no internal pore structure was evolved during thermal exposure.

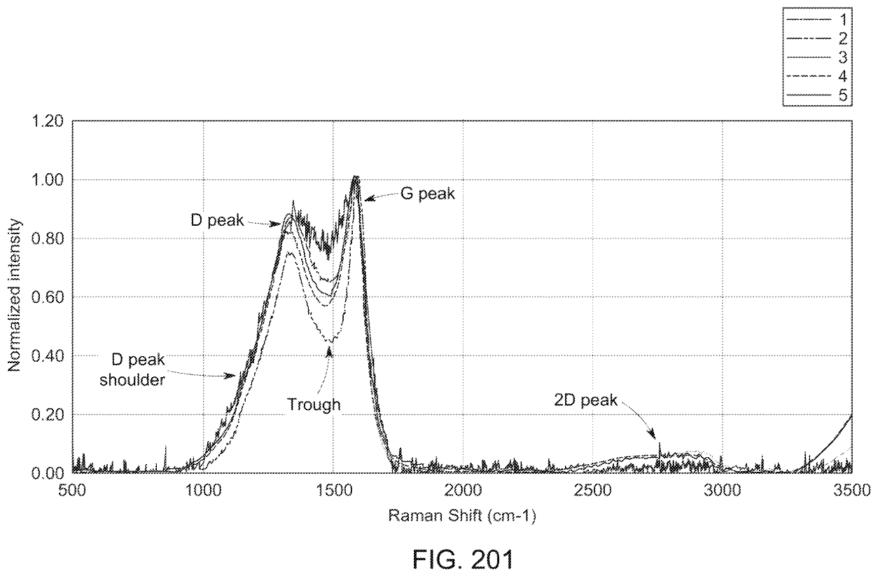

FIG. 201 presents the averaged Raman spectra for each of the perimorphic carbon materials synthesized using the oxyanionic templates in Study A. The perimorphic carbon samples are labeled 1 through 5 according to the experiment to which they pertain (i.e. Experiments 1 through 5).

The spectra in FIG. 201 confirm the presence of disordered sp²-hybridized carbon in each of the samples. Sp² hybridized carbon is indicated by the presence of the G peak (between 1580 cm⁻¹ and 1610 cm⁻¹) and the D peak (between 1320 cm⁻¹ and 1360 cm⁻¹). Disorder is indicated by various spectral features, including the absence of a significant 2D peak and a broad D peak with a lower intensity than the G peak and the height of the trough. While the D peak intensity is not by itself an indication of disorder, since low D peaks can also be found in crystalline graphitic carbons, in the context of these other features, it indicates a high degree of disorder. The trough, which is herein attributed to strained modes of the G peak, reflects the stretching and twisting of C(sp²)-C(sp²) bonds in lattices with a high degree of sp² ring disorder.

Thus, these spectra are consistent with each of the perimorphic carbon samples comprising a lattice-engineered carbon, which has been shown to exhibit increased reactivity and to be more easily chemically functionalized. Additionally, this ring disorder can be expected to change the electronic band structure of the sp² carbon, with sufficient disorder leading to insulating carbon structures.

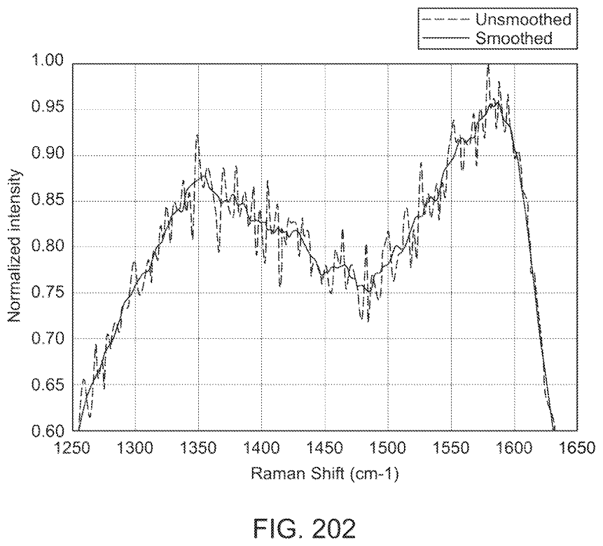

Data was extracted from the average Raman spectrum of each of the samples for summary reporting. The average spectra were generated as described in Section II. In the case of Sample 3, the spectral data reported was derived from smoothing the average spectrum, which remained quite noisy, and both the smoothed and unsmoothed spectrum are shown for comparison in FIG. 202.

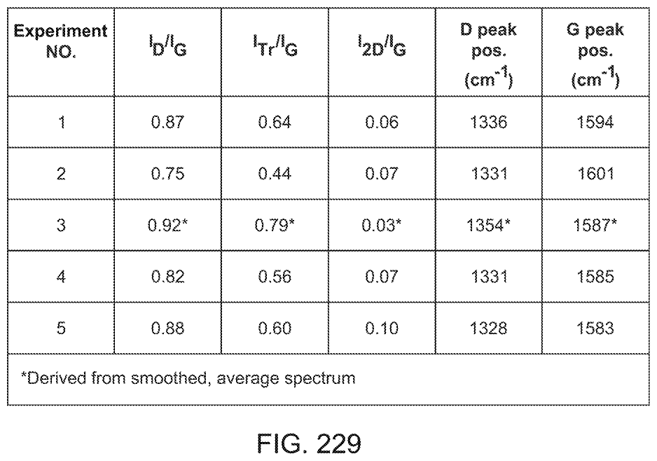

FIG. 229 shows that the perimorphic carbon samples produced in Experiments 1, 2, 4, and 5 exhibit a red-shifted D peak position of 1336 cm⁻¹ of less,¹ indicating the presence of lower-frequency sp³ defects activating radial breathing mode phonons in graphenic sp² clusters. For each sample, the I_{D}/I_{G} peak intensity ratio is substantially lower than 1.05. This indicates that each sample has a high defect concentration-higher even than a nanocrystalline sp² carbon. In addition, each sample has a I_{Tr}/I_{G} ratio of at least 0.44, indicating that the trough is nearly half as high as the G peak, which we theorize to indicate tensile and torsional strain states due to ring disorder in the graphenic basal planes. Prolific ring disorder will cause a broad distribution of lower-frequency strain states, and the G peak position is known to be strain-dependent. Since I_{Tr}/I_{G} would be close to zero in relatively defect-free graphite, this result further suggests that each sample has a relatively high defect concentration. ¹ Although the calculated Dₚₒₛ for carbon sample C_3 appears to be relatively high (i.e, 1363 cm⁻¹), this result apparently reflects the relatively high degree of noise in the C_3 spectrum. Because of that noise, sample C_3 does not exhibit a D peak that is sufficiently well defined for comparison with Dₚₒₛ of the other samples.

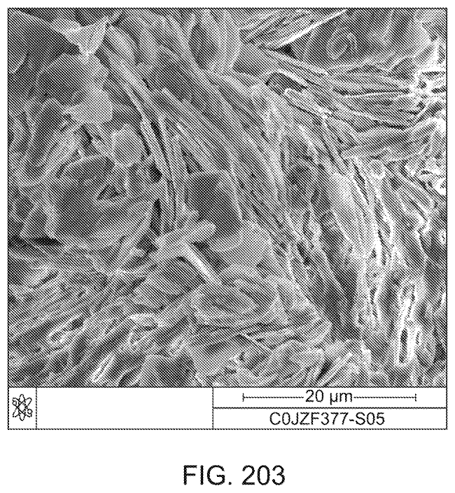

The average spectrum for the perimorphic carbon produced in Experiment 3 is relatively noisy, likely because there was a relatively small amount of carbon within the Raman laser's focal point. This could be explained by uncollapsed perimorphic frameworks' lower-density, three-dimensional morphology, in which microscopic pores nearly as large as the focal point are ubiquitous. In addition to this noise, this sample's spectrum exhibits a substantially higher trough and a higher D peak position than the other samples. These features are associated with much fewer sp³ states, and we theorize herein that this is attributable to the large, atomically flat facets characterizing the K₂CO₃ surfaces. These nearly defect free surfaces may offer fewer nucleation sites. These flat facets can be seen in FIG. 203, an SEM image of the perimorphic composite material generated in Experiment 3.

Other oxyanionic templates may also be utilized. For example, in the '918 application, the P₁₈-type perimorphic carbons with a hollow-spherical morphology were grown on spray-dried Li₂CO₃ templates at 580° C. with no signs of melting and minimal mass loss (<1.5%). If the perimorphic walls are grown thinner, crumpled and sheet-like structures can also be formed, and these can be filtered or dried on glass to form lamellar buckypapers.

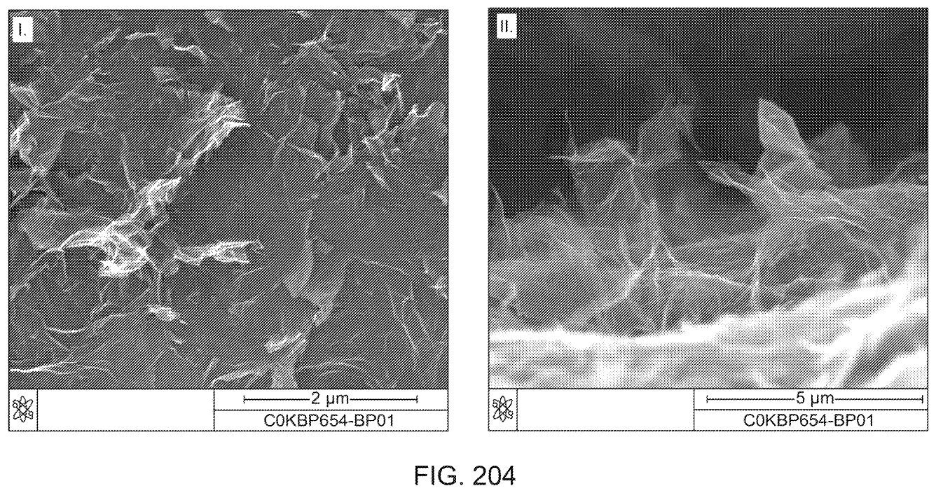

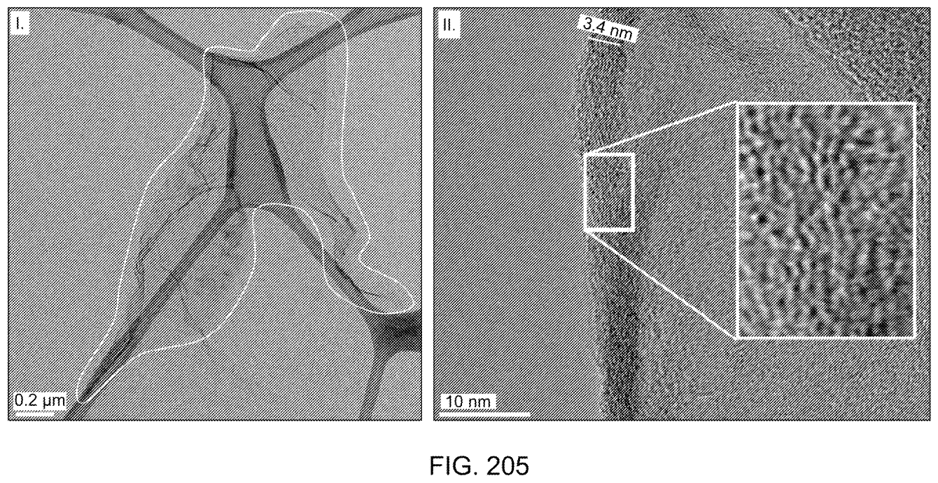

Top-down and horizontal views of one such buckypaper are shown in Frames I and II of FIG. 204, respectively. FIG. 205 includes TEM micrographs of a sheet-like fragment of a perimorphic framework grown on Li₂CO₃. The perimorphic carbon is the translucent, crumpled film labeled via white outline in Frame I. Several wrinkles can be seen in the perimorphic carbon, indicating its thinness and flexibility-both desirable qualities for constructing lamellar buckypapers. Frame II, a higher-resolution micrograph, shows the layered architecture of the perimorphic wall, which measures several nanometers in thickness. The graphenic layers, some of which are traced in the magnified inset, are nematically aligned due to their conformal growth over the templating surface, but the layers are also clearly nonplanar, disordered, and networked. This disordered, layered architecture, which is similar in appearance to those of the perimorphic carbons produced in Study B, is consistent with a lattice-engineered carbon composition.

Using similar CVD surface replication procedures as those described in Experiments 1 through 5, we have also synthesized perimorphic carbons on high-solubility aluminate (NaAlO₂, melting point 1650° C.) and metasilicate (NaSiO₃, melting point 1088° C.) templates at a temperature of 750° C. from propylene (C₃H₆) feedgas. Taken together with the other results in Study B this indicates that oxyanionic templates represent a rich source of potential template materials.

This application discloses several numerical ranges in the text and figures. The numerical ranges disclosed support ranges or values within the disclosed numerical ranges, even though a precise range limitation is not stated verbatim in the specification, since this disclosure can be practiced throughout the disclosed numerical ranges.

The above description is presented to enable a person skilled in the art to make and use the disclosure. Various modifications to the embodiments will be readily apparent to those skilled in the art, and the generic principles defined herein may be applied to other embodiment and applications without departing from the spirit and scope of the disclosure. Thus, this disclosure is not intended to be limited to the embodiments shown but is to be accorded the widest scope consistent with the principles and features disclosed herein. Finally, the entire disclosure of the patents and publications referred to in this application is hereby incorporated herein by reference.

1. A method for producing a stratified perimorphic framework by:
I. Deriving a precursor from a first solution of ions in a process liquid via solventless precipitation; and
II. Forming a template from the precursor; and
III. Using the template to form a stratified perimorphic framework; and
IV. Dissolving the template to form a second solution of ions in the process liquid, such that substantial portions of the ions and the process liquid are conserved and recycled.

2. The method of claim 1, wherein the stratified perimorphic framework comprises at least two perimorphic strata.

3. The method of any one of claims 1 and 2, wherein the stratigraphic arrangement comprises at least one of the following arrangements: AB, ABC, ABCD, BAB, CBABC, DCBABCD, CABC, DABCD.

4. The method of any one of claims 1-3, wherein the stratigraphic arrangement comprises some combination of electrically insulating, conducting, and semiconducting strata.

5. The method of any one of claims 1-4, wherein at least one perimorphic stratum is stratigraphically occluded by at least one other perimorphic stratum.

6. The method of any one of claims 1-5, wherein at least one perimorphic stratum is shielded via stratigraphic occlusion.

7. The method of any one of claims 1-6, wherein a carbon stratum is shielded.

8. The method of any one of claim herein, wherein the carbon stratum is shielded from thermal oxidation.

9. The method of any one of claims 1-8, wherein a portion of the perimorphic framework is stratigraphically encapsulated by at least one perimorphic stratum.

10. The method of any one of claims 1-9, wherein at least one of:
the stratigraphically encapsulated portion of the perimorphic framework is shielded;
the stratigraphically encapsulated portion of the perimorphic framework comprises carbon;
the stratigraphically encapsulated carbon is shielded from thermal oxidation;
the stratigraphically encapsulated portion of the perimorphic framework is evacuated of internal gas;
the evacuation of internal gas is substantially complete;
the evacuation of internal gas is partial;
the encapsulation portion of the perimorphic framework comprises carbon;
the encapsulating stratum is substantially impermeable to air; and
the encapsulating stratum is substantially impermeable to liquid.

11. The method of any one of claims 1-10, wherein at least one of:
at least one perimorphic stratum comprises at least one of: a boron-containing compound, a silicon-containing compound, a carbon-containing compound, a nitrogen-containing compound, a metal-containing compound, and an oxygen-containing compound;
the compound comprises a transition metal dichalcogenide;
the perimorphic framework comprises at least one stratum comprising at least one of: MoS₂, WS₂, WSe₂, MoSe₂, WSe₂, and MoTe₂;
the compound comprises a metal oxide;
the metal oxide comprises TiO₂;
the compound comprises a silica-like compound;
the compound comprises a carbide, a nitride, a carbonitride, an oxycarbide, an oxynitride, an oxycarbonitride;
the compound also comprises silicon; and
the electronic bandgap is engineered by engineering the stoichiometry of the compound.

12. The method of any one of claims 1-11, wherein at least one of:
at least one perimorphic stratum comprises an atomic monolayer;
the atomic monolayer is monoelemental;
the monoelemental atomic monolayer comprises at least one of graphene, borophene, silicene, germanene, stanene, phospherene, arsenene, antimonene, bismuthene, and tellurene;
the atomic monolayer is polyelemental;
the polyelemental atomic monolayer comprises a transition metal dichalcogenide;
the perimorphic framework comprises at least one stratum comprising at least one of MoS₂, WS₂, WSe₂, MoSe₂, WSe₂, and MoTe₂;
the polyelemental atomic monolayer comprises at least one of boron, carbon, and nitrogen; and
the electronic bandgap is engineered by engineering the stoichiometry of the compound.

13. The method of any one of claims 1-12, wherein at least one perimorphic stratum comprises a polymeric preceramic material.

14. The method of any claim herein, wherein at least one of:
at least one perimorphic stratum comprises a metal;
the metal comprises a Group I or II metal; and
the metal comprises at least one of lithium, sodium, and potassium.

15. The method of any one of claims 1-14, wherein at least one of:
at least one perimorphic stratum comprises a metalloid;
the metalloid comprises silicon; and
at least one perimorphic stratum comprises a non-metal.

16. A method for producing a perimorphic framework comprising:
I. Deriving a solid precursor from a first stock solution via a solventless precipitation, the stock solution comprising solvated ions hosted by a process liquid; and
Substantially separating the derived precursor and the process liquid, the process liquid being conserved and comprising a conserved process liquid; and
II. Treating the precursor to form a template, the treating comprising decomposing a portion of the precursor, the template comprising a templating surface and a templating bulk; and
III. Adsorbing an adsorbate on the templating surface to form a perimorphic composite, the perimorphic composite comprising a perimorph and an endomorph, the perimorph comprising the adsorbate and the endomorph comprising the template, the adsorbate comprising at least one non-graphenic atomic monolayer; and
IV. Exposing the endomorph to an extractant solution, the extractant solution comprising an extractant hosted by the conserved process liquid; and
Reacting a portion of the endomorph with the extractant solution to form
solvated ions, the solvated ions hosted by the conserved process liquid, the solvated ions and conserved process liquid together comprising a second stock solution, the second stock solution comprising substantially the same species of ions that comprised the first stock solution; and
Exfiltrating the second stock solution out of the perimorph into the surrounding process liquid, to form a perimorphic framework, the framework comprising:
the adsorbate, the adsorbate comprising a perimorphic wall possessing an average thickness of less than 100 nm, the perimorphic wall substantially replicating a morphology of the templating surface; and
internal pores, a portion of the pores substantially replicating a morphology of the templating bulk.

17. The method of any one of claims 1-16, wherein the deriving of the precursor from the first stock solution comprises at least one of: a solventless precipitation, a dissolution, a decomposition.

18. The method of any one of claims 1-17, wherein the solventless precipitation of a precursor from the first stock solution is facilitated by atomization of the process liquid hosting the solvated ions.

19. The method of any one of claims 1-18, wherein the atomization of the process liquid comprises one of spray-drying or spray-pyrolysis.

20. The method of any one of claims 1-19, wherein at least one of:
the solventless precipitation of a precursor from the first stock solution comprises a change in temperature;
the solventless precipitation of a precursor from the first stock solution comprises a change in pressure;
the deriving of the precursor from the first stock solution comprises a sequence of at least two reactions;
the sequence of at least two reactions comprises precipitating a precipitate from the stock solution via solventless precipitation, re-dissolving the precipitate to form a concentrated solution, and precipitating the precursor from the concentrated solution via solventless precipitation;
the solvated ions in the concentrated solution remain solvated due to an elevated CO₂ pressure;
the concentrated solution is depressurized to a pressure below 1 atm; and
the depressurization of the concentrated solution accelerates the outgassing of CO₂.
